(19) United States
(12) Patent Application Publication
(10) Pub. No.: US 2026/0116718 A1
(43) Pub. Date: Apr. 30, 2026

(54) ELECTRIC TELEHANDLER

(71) Applicant: Oshkosh Corporation, Oshkosh, WI (US)

(72) Inventors: James Rohr, Oshkosh, WI (US); Robert Abrams, Oshkosh, WI (US); Brock Albaugh, Oshkosh, WI (US); Brian Barkley, Oshkosh, WI (US); Brian Green, Oshkosh, WI (US); Mark Hartzler, Oshkosh, WI (US); Michael Indermuhle, Oshkosh, WI (US); Yanming Hou, Oshkosh, WI (US); Fredrick Jabs, Oshkosh, WI (US); Eko Prasetiawan, Oshkosh, WI (US); Mike Sands, Oshkosh, WI (US); Nima Zahabi, Oshkosh, WI (US); Peter Tan, Oshkosh, WI (US)

(73) Assignee: Oshkosh Corporation, Oshkosh, WI (US)

(21) Appl. No.: 19/375,197

(22) Filed: Oct. 30, 2025

Related U.S. Application Data
(60) Provisional application No. 63/714,311, filed on Oct. 31, 2024.
(60) Provisional application No. 63/714,652, filed on Oct. 31, 2024.
(60) Provisional application No. 63/714,441, filed on Oct. 31, 2024.
(60) Provisional application No. 63/714,536, filed on Oct. 31, 2024.
(60) Provisional application No. 63/714,440, filed on Oct. 31, 2024.
(60) Provisional application No. 63/714,755, filed on Oct. 31, 2024.
(60) Provisional application No. 63/714,429, filed on Oct. 31, 2024.
(60) Provisional application No. 63/714,420, filed on Oct. 31, 2024.
(60) Provisional application No. 63/714,271, filed on Oct. 31, 2024.
(60) Provisional application No. 63/714,333, filed on Oct. 31, 2024.
(60) Provisional application No. 63/714,310, filed on Oct. 31, 2024.
(60) Provisional application No. 63/714,323, filed on Oct. 31, 2024.
(60) Provisional application No. 63/714,417, filed on Oct. 31, 2024.
(60) Provisional application No. 63/714,335, filed on Oct. 31, 2024.
(60) Provisional application No. 63/714,202, filed on Oct. 31, 2024.
(60) Provisional application No. 63/714,766, filed on Oct. 31, 2024.
(60) Provisional application No. 63/714,204, filed on Oct. 31, 2024.
(60) Provisional application No. 63/714,428, filed on Oct. 31, 2024.
(60) Provisional application No. 63/714,281, filed on Oct. 31, 2024.
(60) Provisional application No. 63/714,314, filed on Oct. 31, 2024.
(60) Provisional application No. 63/714,319, filed on Oct. 31, 2024.
(60) Provisional application No. 63/714,530, filed on Oct. 31, 2024.
(60) Provisional application No. 63/714,327, filed on Oct. 31, 2024.
(60) Provisional application No. 63/714,357, filed on Oct. 31, 2024.
(60) Provisional application No. 63/714,308, filed on Oct. 31, 2024.
(60) Provisional application No. 63/714,290, filed on Oct. 31, 2024.
(60) Provisional application No. 63/714,407, filed on Oct. 31, 2024.
(60) Provisional application No. 63/714,315, filed on Oct. 31, 2024.
(60) Provisional application No. 63/714,272, filed on Oct. 31, 2024.
(60) Provisional application No. 63/714,258, filed on Oct. 31, 2024.
(60) Provisional application No. 63/714,372, filed on Oct. 31, 2024.
(60) Provisional application No. 63/714,763, filed on Oct. 31, 2024.
(60) Provisional application No. 63/733,240, filed on Dec. 12, 2024.

(51) Int. Cl. B66F 9/065; B60L 50/60; B60L 53/14; B66F 9/075; B66F 9/22

(52) U.S. Cl. CPC B66F 9/0655; B60L 50/60; B66F 9/07531; B66F 9/07572; B66F 9/22; B60L 53/14; B60L 2200/42

(57) ABSTRACT

A telehandler includes a chassis defining a first side area, a second side area, and a central area between the first side area and the second side area, a boom assembly coupled to the chassis and configured to raise an implement relative to the chassis, an axle assembly coupled to the chassis and including a tractive element, an electric motor coupled to the chassis and positioned within the central area, a cabin coupled to the chassis, positioned within the first side area, and configured to support an operator, and a battery coupled to the chassis and positioned within the second side area. the electric motor is configured to drive the axle assembly to propel the telehandler. The battery is configured to supply electrical energy to the electric motor.

### CROSS-REFERENCE TO RELATED PATENT APPLICATIONS

This application claims the benefit of and priority to U.S. Provisional Application No. 63/714,202, filed on Oct. 31, 2024, U.S. Provisional Application No. 63/714,204, filed on Oct. 31, 2024, U.S. Provisional Application No. 63/714,258, filed on Oct. 31, 2024, U.S. Provisional Application No. 63/714,271, filed on Oct. 31, 2024, U.S. Provisional Application No. 63/714,272, filed on Oct. 31, 2024, U.S. Provisional Application No. 63/714,281, filed on Oct. 31, 2024, U.S. Provisional Application No. 63/714,290, filed on Oct. 31, 2024, U.S. Provisional Application No. 63/714,308, filed on Oct. 31, 2024, U.S. Provisional Application No. 63/714,310, filed on Oct. 31, 2024, U.S. Provisional Application No. 63/714,311, filed on Oct. 31, 2024, U.S. Provisional Application No. 63/714,314, filed on Oct. 31, 2024, U.S. Provisional Application No. 63/714,315, filed on Oct. 31, 2024, U.S. Provisional Application No. 63/714,319, filed on Oct. 31, 2024, U.S. Provisional Application No. 63/714,323, filed on Oct. 31, 2024, U.S. Provisional Application No. 63/714,327, filed on Oct. 31, 2024, U.S. Provisional Application No. 63/714,333, filed on Oct. 31, 2024, U.S. Provisional Application No. 63/714,335, filed on Oct. 31, 2024, U.S. Provisional Application No. 63/714,352, filed on Oct. 31, 2024, U.S. Provisional Application No. 63/714,357, filed on Oct. 31, 2024, U.S. Provisional Application No. 63/714,372, filed on Oct. 31, 2024, U.S. Provisional Application No. 63/714,407, filed on Oct. 31, 2024, U.S. Provisional Application No. 63/714,417, filed on Oct. 31, 2024, U.S. Provisional Application No. 63/714,420, filed on Oct. 31, 2024, U.S. Provisional Application No. 63/714,428, filed on Oct. 31, 2024, U.S. Provisional Application No. 63/714,429, filed on Oct. 31, 2024, U.S. Provisional Application No. 63/714,440, filed on Oct. 31, 2024, U.S. Provisional Application No. 63/714,441, filed on Oct. 31, 2024, U.S. Provisional Application No. 63/714,530, filed on Oct. 31, 2024, U.S. Provisional Application No. 63/714,536, filed on Oct. 31, 2024, U.S. Provisional Application No. 63/714,755, filed on Oct. 31, 2024, U.S. Provisional Application No. 63/714,763, filed on Oct. 31, 2024, U.S. Provisional Application No. 63/714,766, filed on Oct. 31, 2024, and U.S. Provisional Application No. 63/733,240, filed on Dec. 12, 2024, the entire disclosures of which are hereby incorporated by reference herein.

### BACKGROUND

Telehandlers are used to transport a payload, such as building materials or equipment. A telehandler may include driven wheels to propel the telehandler and a load.

### SUMMARY

At least one embodiment relates to a telehandler including a chassis defining a first side area, a second side area, and a central area between the first side area and the second side area, a boom assembly coupled to the chassis and configured to raise an implement relative to the chassis, an axle assembly coupled to the chassis and including a tractive element, an electric motor coupled to the chassis and positioned within the central area, the electric motor being configured to drive the axle assembly to propel the telehandler, a cabin coupled to the chassis, positioned within the first side area, and configured to support an operator, and a battery coupled to the chassis and positioned within the second side area. The battery is configured to supply electrical energy to the electric motor.

Another embodiment relates to a telehandler including a chassis including a pair of side plates defining a first side area, a second side area, and a central area between the first side area and the second side area, a tractive element rotatably coupled to the chassis, a boom assembly coupled to the chassis and positioned within the central area, a cabin coupled to the chassis, positioned within the first side area, and configured to support an operator, a battery coupled to the chassis, and a charging port configured to receive electrical energy and supply the received electrical energy to the battery. The charging port is positioned within the first side area.

Another embodiment relates to a vehicle including a chassis including a side plate, a lift assembly configured to raise an implement relative to the chassis, an axle assembly coupled to the chassis and including a tractive element, a cabin coupled to the chassis and configured to support an operator, a battery coupled to the chassis, and a charging port configured to receive electrical energy and supply the received electrical energy to the battery. The lift assembly is positioned on a first side of the side plate. The cabin and the charging port are positioned on a second side of the side plate.

Another embodiment relates to a telehandler including: a chassis including a pair of side plates that extend in a longitudinal direction, a central area being defined between the pair of side plates; an electrical system, including: a high-voltage battery positioned on a first outer side of a first of the pair of side plates; a high-voltage power distribution unit (HVPDU) positioned on top of the high-voltage battery; a drive motor positioned in the central area proximate a front end of the telehandler, an implement motor positioned on the first outer side of the first of the pair of side plates proximate the front end of the telehandler, a first inverter positioned on the first outer side of the first of the pair of side plates, the first inverter positioned longitudinally offset forward of the HVPDU; a second inverter longitudinally offset forward of the first inverter, a first cable electrically coupling the high-voltage battery with the HVPDU; a second cable electrically coupling the HVPDU with the first inverter, a third cable electrically coupling the HVPDU with the second inverter, a fourth cable electrically coupling the first inverter to the implement motor, and a fifth cable electrically coupling the second inverter to the drive motor.

Another embodiment relates to a telehandler including: a chassis including a pair of side plates that extend in a longitudinal direction, a central area defined between the pair of side plates; an electrical system, including: a high-voltage battery positioned on a first outer side of a first of the pair of side plates; a high-voltage power distribution unit (HVPDU) positioned on top of the high-voltage battery; a drive motor positioned in the central area proximate a front end of the telehandler, an implement motor positioned on the first outer side of the first of the pair of side plates proximate the front end of the telehandler, one or more inverters positioned on the first outer side of the first of the pair of side plates, the one or more inverters positioned in a direction toward the front end of the telehandler relative to the HVPDU; a first cable configured to electrically connect the high-voltage battery with the HVPDU; a second cable configured to electrically connect the HVPDU with the one or more inverters; and a third cable configured to electrically connect the one or more inverters with the drive motor. The third cable includes: a first portion that extends from the one or more inverters in an inwards direction toward the first of the pair of side plates, the first portion extending through an opening defined in the first of the pair of side plates and at least partially within the central area defined between the pair of side plates; a second portion that curves in a forwards direction; and a third portion that extends in the forwards direction, the third portion extending to the drive motor.

Another embodiment relates to a telehandler including: a chassis including a pair of side plates that extend in a longitudinal direction, a central area defined between the pair of side plates; an electrical system, including: a high-voltage battery positioned on a first outer side of a first of the pair of side plates; a high-voltage power distribution unit (HVPDU) positioned on top of the high-voltage battery; a drive motor positioned in the central area proximate a front end of the telehandler, an implement motor positioned on the first outer side of the first of the pair of side plates proximate the front end of the telehandler, one or more inverters positioned on the first outer side of the first of the pair of side plates, the one or more inverters positioned in a direction toward the front end of the telehandler relative to the HVPDU; an onboard charger disposed on a second outer side of a second of the pair of side plates; a heater disposed within the central area on an inner surface of the second of the pair of side plates; an electric compressor disposed within the central area on an inner surface of the first of the pair of side plates; a first cable configured to electrically connect the high-voltage battery with the HVPDU; a second cable configured to electrically connect the HVPDU with the one or more inverters; a third cable configured to electrically connect the HVPDU with the one or more inverters; a fourth cable configured to electrically connect the one or more inverters to the implement motor, a fifth cable configured to electrically connect the one or more inverters to the drive motor, a sixth cable configured to electrically connect the HVPDU to the onboard charger, a seventh cable configured electrically connect the onboard charger with a charging port; an eighth cable configured to electrically connect the HVPDU to the heater, and a ninth cable configured to electrically connect the HVPDU to the electric compressor.

Another embodiment relates to a telehandler including a chassis, a drive motor coupled with the chassis and a plurality of tractive assemblies, and an electrical system electrically coupled with the drive motor, the electrical system configured to provide power to the drive motor to drive the plurality of tractive assemblies. The electrical system comprising a high-voltage system including a high-voltage battery and a converter, and a low-voltage system including a low-voltage battery. The telehandler further comprising a connect electrically coupled with the high-voltage system and the low-voltage battery, the connect reconfigurable between a plurality of configurations, where in a first configuration the connect electrically couples the low-voltage battery to a controller, the low-voltage battery configured to supply power to the controller to activate the high-voltage system, and in a second configuration the connect electrically disconnects the low-voltage battery from the controller and the high-voltage system.

Another embodiment relates to a vehicle including a chassis, a driver coupled with the chassis and a plurality of tractive assemblies, and a system electrically coupled with the driver, the system configured to provide power to the driver to drive the plurality of tractive assemblies. The system comprising a high-voltage system including a high-voltage battery and a converter, and a low-voltage system including a low-voltage battery. The vehicle further comprising a connect electrically coupled with the high-voltage system and the low-voltage battery, the connect reconfigurable between a plurality of configurations, where in a first configuration the connect electrically couples the low-voltage battery to a controller, the low-voltage battery configured to supply power to the controller to activate the high-voltage system, and in a second configuration the connect electrically disconnects the low-voltage battery from the controller and the high-voltage system.

Another embodiment relates to a system electrically coupled with a drive motor to selectively drive a plurality of tractive assemblies of a vehicle. The system includes a high-voltage system including a high-voltage battery and a converter, a low-voltage system including a low-voltage battery, and a connect electrically coupled with the high-voltage system and the low-voltage battery. The connect may be reconfigurable between a plurality of configurations, where in a first configuration the connect electrically couples the low-voltage battery to a controller, the low-voltage battery configured to supply power to the controller to activate the high-voltage system, and in a second configuration the connect electrically disconnects the low-voltage battery from the controller and the high-voltage system.

Another embodiment relates to a vehicle, including a chassis extending along a longitudinal axis, a cabin, a charger housing, and a charging pod. The chassis includes a pair of longitudinal frame members each offset from the longitudinal axis. The charger housing is coupled to one of the longitudinal frame members and positioned behind the cabin. The charger housing includes a charger housing body defining a charger housing opening, and a divider assembly configured to divide the charger housing opening into a first portion and a second portion. The charging pod includes at least one onboard charger positioned within the first portion of the charger housing opening, and a charging connector electrically coupled to the at least one onboard charger and configured to electrically couple to an external power source.

Another embodiment relates to a vehicle including a cabin, a charger housing, and a charging pod. The charger housing is positioned behind the cabin. The charger housing includes a charger housing body defining a charger housing opening, a charger recess extending into the charger housing, and a charger aperture extending between the charger recess and the charger housing opening. The charging housing includes divider assembly configured to divide the charger housing opening into a first portion and a second portion. The charging pod includes at least one onboard charger positioned within the first portion of the charger housing opening, and a charging connector electrically coupled to the at least one onboard charger and configured to electrically couple to an external power source, the charging connector positioned within the charger recess. The charger aperture is configured to receive the charging connector.

Another embodiment relates to a vehicle including a chassis, a cabin, a charger housing, and a charger pod. The chassis extends along a longitudinal axis. The chassis includes a pair of longitudinal frame members each offset from the longitudinal axis. The charger housing is coupled to one of the longitudinal frame members and positioned behind the cabin. The charger housing includes a charger housing body defining a charger housing opening, a charger recess extending toward the charger housing opening, a charger aperture extending between the charger recess and the charger housing opening, and an onboard charger aperture extending from the charger housing opening and away from the charger recess. The charger housing includes a divider assembly configured to divide the charger housing opening into a first portion and a second portion, a side panel bracket coupled to the longitudinal frame member, and a side divider bracket. The side panel bracket extends within the onboard charger aperture. The side divider bracket is located within the charger housing opening. The side divider bracket is coupled to the divider assembly. The charging pod includes at least one onboard charger positioned within the first portion of the charger housing opening. The onboard charger is configured to laterally align with the onboard charger aperture. The onboard charger is coupled to the side divider bracket and the side panel bracket. The side divider bracket is coupled to the onboard charger along a first side. The side panel bracket is coupled to the onboard charger along a second side. The first side is opposite the second side. The charging connector is electrically coupled to the at least one onboard charger and configured to electrically couple to an external power source. The charging connector is positioned within the charger recess and the charger aperture.

Another embodiment relates to a vehicle including a chassis; a cabin coupled to the chassis; a low voltage battery coupled to the chassis and configured to supply power to a low-voltage circuit of the vehicle; a high-voltage battery coupled to the chassis and configured to supply power to a high-voltage circuit of the vehicle; a high-voltage power distribution unit (HVPDU) coupled to the high-voltage battery; and a charger housing coupled to the chassis and positioned behind the cabin, the charger housing including a charger housing body defining a charger housing opening; and a charging pod including: a charging connector configured to electrically couple to an external power source, at least one onboard charger electrically coupled to the charging connector and the HVPDU, wherein the onboard charger receives alternating current (AC) power from the external power source and outputs direct current (DC) power to at least the HVPDU; and a DC converter electrically coupled to the at least one onboard charger and the low voltage battery, wherein the DC converter converts the DC power from the at least one onboard charger from a first voltage to a second voltage, the second voltage being lower than the first voltage.

Another embodiment relates to a vehicle including a chassis; a cabin coupled to the chassis; a primary motor, one or more tractive assemblies configured to move the vehicle based on power from the primary motor, a high-voltage battery coupled to the primary motor, a charging connector coupled to the high-voltage battery and configured to couple to an external power source; a first onboard charger coupled to the charging connector and configured to receive power from the charging connector, a second onboard charger coupled to the charging connector and configured to receive power from the charging connector, and a controller, wherein the controller is configured to: receive a power output command; control at least one of the first onboard charger or the second onboard charger to provide a power output based on the power output command.

Another embodiment relates to a vehicle including a chassis; a cabin coupled to the chassis; a primary motor, one or more tractive assemblies configured to move the vehicle based on power from the primary motor, a high-voltage battery coupled to the primary motor, a low-voltage battery coupled to chassis and configured to provide power to a low-voltage circuit of the vehicle; and a charger housing coupled to the chassis and positioned behind the cabin; wherein the charger housing includes: a charging connector coupled to the high-voltage battery and configured to couple to an external power source; a first onboard charger coupled to the charging connector and configured to receive power from the charging connector, a second onboard charger coupled to the charging connector and configured to receive power from the charging connector, a DC converter coupled to at least one of the first onboard charger or the second onboard charger and positioned with the at least one of the first onboard charger or the second onboard charger in an enclosure within the charger housing, wherein the DC converter converts at least a portion of a power output from one of at least one of the first onboard charger or the second onboard charger from a first voltage to a second voltage, the second voltage being lower than the first voltage; and a controller, wherein the controller is configured to: receive a first power output command below a threshold; control, in response to the first power output command, one of the first charger or the second charger to provide a power output; receive a second power output command above the threshold; and control, in response to the second power output command, the first onboard charger and the second onboard charger to provide a combined second power output.

Another embodiment relates to a telehandler. The telehandler includes a chassis, an energy storage device coupled to the chassis, a secondary onboard charger coupled to the chassis and the energy storage device, and a primary onboard charger coupled to the chassis, the energy storage device, and the secondary onboard charger. Each of the primary onboard charger and the secondary onboard charger are configured to selectively couple to an external power source. The primary onboard charger is configured to: provide a wake up command signal to the secondary onboard charger, receive a primary onboard charger command signal; provide electrical energy to the energy storage device according to the primary onboard charger command signal; and provide a secondary onboard charger command signal to the secondary onboard charger, responsive to a current value regarding the external power source being at or above a predetermined threshold, such that the primary onboard charger and the secondary onboard charger provide electrical energy to the energy storage device concurrently.

Another embodiment relates to a telehandler. The telehandler includes chassis, an energy storage device coupled to the chassis, a plurality of onboard chargers coupled to the chassis and the energy storage device, and a controller communicably coupled to the plurality of onboard chargers. At least one of the plurality of onboard charges or the controller is configured to: determine an external power source is coupled to the plurality of onboard chargers; determine the type of electrical energy received from the external power source; and selectively provide the electrical energy to the energy storage device via the plurality of onboard chargers.

Another embodiment relates to a vehicle. The vehicle includes a chassis, an energy storage device coupled to the chassis, a plurality of onboard chargers coupled to the chassis and the energy storage device, and a controller communicably coupled to the plurality of onboard chargers. The plurality of onboard chargers include a primary onboard charger and a secondary onboard charger. The controller is configured to: determine an external power source is coupled to the plurality of onboard chargers; provide a first wake up command signal to the primary onboard charger, determine the type of electrical energy received from the external power source; and selectively provide the electrical energy to the energy storage device via the primary onboard charger.

Another embodiment relates to a method including generating, by a control module, a first low voltage (LV) direct current (DC) rectangular wave signal, transmitting, by the control module via a circuit, the first LV DC rectangular wave signal to one or more devices coupled to the circuit, receiving, by the control module via the circuit, a second LV DC rectangular wave signal from the one or more devices, comparing, by the control module, the first LV DC rectangular wave signal to the second LV DC rectangular wave signal, and adjusting, by the control module, an operation of at least one of the one or more devices responsive to a determination that the first LV DC rectangular wave signal is different from the second LV DC rectangular wave signal.

Another embodiment relates to system that includes a high-voltage power distribution unit, one or more devices configured to receive high-voltage power from the high-voltage power distribution unit, and a control module coupled to the high-voltage power distribution unit and the one or more devices via a circuit. The control module includes a signal generator, one or more processors, and a memory storing instructions that, when executed by the one or more processors, causes the control module to generate, using the signal generator, a first low voltage (LV) direct current (DC) rectangular wave signal, transmit the first LV DC rectangular wave signal to the one or more devices and the high-voltage power distribution unit, receive, via the circuit, a second LV DC rectangular wave signal from the one or more devices, compare, by the control module, the first LV DC rectangular wave signal to the second LV DC rectangular wave signal, and send, based on the comparison, a command to the high.

Another embodiment relates to system that includes a power distribution unit (PDU) comprising a high-voltage (HV) electrical inlet and a plurality of combined electrical outlets coupled to the HV electrical inlet and to an interlock circuit, a battery electronically coupled to the HV electrical inlet, the battery configured to transmit HV electricity to the PDU, a first device configured to transmit a first low voltage (LV) signal to the interlock circuit, a second device coupled to a first combined electrical outlet of the plurality of combined electrical outlet to receive HV electricity and the LV signal, wherein the second device and the PDU are electronically coupled by a first connector, wherein coupling of the second device and the PDU using the connector closes a first opening in the interlock circuit.

At least one embodiment relates to an electric telehandler. The electric telehandler can include a chassis. The electric telehandler can include a boom assembly. The electric telehandler can include an actuator. The actuator can movably couple with the boom assembly. The electric telehandler can include an electric power system. The electric power system can provide electrical power to the actuator to control movement of the boom assembly. The electric telehandler can include a drive motor. The drive motor can drive an axle assembly of the electric telehandler. The electric telehandler can include a battery assembly. The battery assembly can provide power to the drive motor and the electric power system. The battery assembly can include one or more battery cells having an energy capacity. The energy capacity can be larger than an amount of energy consumed by the electric telehandler during an expected usage of the electric telehandler.

At least one embodiment relates to an electric telehandler. The electric telehandler can include a chassis. The electric telehandler can include one or more sensors. The one or more sensors can be disposed on the chassis. The electric telehandler can include a plurality of controllable elements. The plurality of controllable elements can consume energy from one or more battery cells of the electric telehandler. The electric telehandler can include the one or more battery cells. The one or more battery cells can have an energy capacity. The electric telehandler can include one or more processing circuits. The one or more processing circuits can be in communication with the one or more sensors and the one or more battery cells. The one or more processing circuits can receive, from the one or more sensors, information associated with operation of the electric telehandler. The operation of the electric telehandler can include a consumption of a first amount of energy to power the plurality of controllable elements. The one or more processing circuits can determine, based on the consumption of the first amount of energy, an expected usage of the electric telehandler. The one or more processing circuits can configure the one or more battery cells to provide energy in accordance with the expected usage of the electric telehandler such that a maximum amount of energy provided by the one or more battery cells is less than the energy capacity of the one or more battery cells.

At least one embodiment relates to a system. The system can include an electric telehandler. The electric telehandler can include a chassis. The electric telehandler can include a boom assembly. The electric telehandler can include an actuator. The actuator can movably couple with the boom assembly. The electric telehandler can include an electric power system. The electric power system can provide electrical power to the actuator to control movement of the boom assembly. The electric telehandler can include a drive motor. The drive motor can drive an axle assembly of the electric telehandler. The electric telehandler can include a battery assembly. The battery assembly can provide power to the drive motor and the electric power system. The battery assembly can include one or more battery cells. The one or more battery cells can include an energy capacity. The system can include one or more processing circuits. The one or more processing circuits can configure the one or more battery cells to provide an amount of energy that is less than the energy capacity to provide passive cooling of the one or more battery cells.

At least one embodiment relates to an electric telehandler. The electric telehandler can include a battery assembly. The battery assembly can include one or more battery cells. The one or more battery cells can provide power to one or more components of the electric telehandler. The electric telehandler can include a power distribution unit. The power distribution unit can electrically couple the one or more battery cells with an onboard charger of the electric telehandler. The onboard charger can provide electrical energy to charge the one or more battery cells. The electric telehandler can include one or more processing circuits. The one or more processing circuits can receive, from one or more sensors of the electric telehandler, a set of information that corresponds to the one or more battery cells. The one or more processing circuits can determine, based on the set of information, a state of the one or more battery cells. The one or more processing circuits can control, responsive to determination of the state of the one or more battery cells, the onboard charger to adjust (i) a voltage level of a Direct Current (DC) bus of the power distribution unit or (ii) a temperature of the one or more battery cells.

At least one embodiment relates to a control system. The control system can be for an electric telehandler. The control system can include one or more processing circuits. The one or more processing circuits can receive, from one or more sensors of the electric telehandler, a set of information that corresponds to one or more battery cells of the electric telehandler. The one or more processing circuits can determine, based on the set of information, a state of the one or more battery cells. The one or more processing circuits can control, responsive to determination of the state of the one or more battery cells, an onboard charger of the electric telehandler to adjust (i) a voltage level of a Direct Current (DC) bus of a power distribution unit of the electric telehandler or (ii) a temperature of the one or more battery cells.

At least one embodiment relates to a system. The system can include an electric telehandler. The electric telehandler can include a battery assembly. The battery assembly can include one or more battery cells to provide power to one or more components of the electric telehandler. The electric telehandler can include a power distribution unit. The power distribution unit can electrically couple the one or more battery cells with an onboard charger of the electric telehandler. The onboard charger can provide electrical energy to charge the one or more battery cells. The system can include one or more processing circuits. The one or more processing circuits can receive, from one or more sensors of the electric telehandler, a set of information that corresponds to the one or more battery cells. The one or more processing circuits can determine, based on the set of information, a state of the one or more battery cells. The one or more processing circuits can control, responsive to determination of the state of the one or more battery cells, the onboard charger to adjust (i) a voltage level of a Direct Current (DC) bus of the power distribution unit or (ii) a temperature of the one or more battery cells.

At least one embodiment relates to a telehandler, including: a chassis; a lift assembly supported on the chassis; an implement coupled to a distal end of the lift assembly; an axle assembly coupled to the chassis; and a hydraulic system including: a steering pump; an electric motor configured to drive the steering pump; a steering valve configured to control a steering direction of the axle assembly; an accumulator, and a priority valve arranged between the steering pump and the steering valve, wherein the priority valve is configured to selectively provide fluid communication between the steering pump and the accumulator to charge the accumulator, and wherein when a charge pressure of the accumulator is above a pressure threshold, the accumulator supplies fluid though the priority valve and to the steering valve.

At least one embodiment relates to a telehandler, including: a chassis; a lift assembly supported on the chassis; an implement coupled to a distal end of the lift assembly; an axle assembly coupled to the chassis; and a hydraulic system including: a steering pump in fluid communication with a steering supply line; an electric motor configured to drive the steering pump; a steering valve configured to control a steering direction of the axle assembly and in fluid communication with a steering line; an accumulator in fluid communication with an accumulator line; a steering node arranged at an intersection between the steering supply line, the steering line, and the accumulator line; and a priority valve arranged on the steering line between the steering node and the steering valve, wherein the priority valve is selectively movable between a first position where fluid communication is provided between at least one of the accumulator or the steering pump and the steering valve, and a second position where fluid communication is provided between the steering pump and the accumulator.

At least one embodiment relates to a hydraulic system for a telehandler, the hydraulic system including: a steering pump; an electric motor configured to drive the steering pump; a steering valve configured to control a steering direction; an accumulator, and a priority valve arranged between the steering pump and the steering valve, wherein the priority valve is configured to selectively provide fluid communication between the steering pump and the accumulator to charge the accumulator, and wherein when a charge pressure of the accumulator is above a pressure threshold, the accumulator supplies fluid though the priority valve and to the steering valve.

At least one embodiment relates to a telehandler, including: a chassis; a lift assembly supported on the chassis; an implement coupled to a distal end of the lift assembly; an axle assembly coupled to the chassis; and a hydraulic system including: a steering pump; a steering valve configured to control a steering direction of the axle assembly; an accumulator arranged downstream of the steering pump; an implement pump; a main control valve configured to control fluid flow to and from the lift assembly; a first switching valve movable between a first position and a second position; and a second switching valve arranged in series with the first switching valve and movable between a first position and a second position, wherein when the second switching valve is in the first position, fluid communication is provided between the implement pump and the accumulator, and wherein when the first switching valve is in the second position and the second switching valve is in the first position, fluid communication is provided between the accumulator and the main control valve and between the steering pump and the main control valve.

At least one embodiment relates to a telehandler, including: a chassis; a lift assembly supported on the chassis; an implement coupled to a distal end of the lift assembly; an axle assembly coupled to the chassis; and a hydraulic system including: a steering pump in fluid communication with a steering supply line; a steering valve configured to control a steering direction of the axle assembly; an accumulator arranged downstream of the steering pump and in fluid communication with an accumulator line; an implement pump in fluid communication with an implement supply line; a main control valve configured to control fluid flow to and from the lift assembly; a connecting line in fluid communication with the implement supply line, the main control valve, and the accumulator line; a first switching valve arranged on the connecting line and movable between a first position where fluid communication is allowed only in a direction from the first switching valve toward the accumulator line and a second position where fluid communication is allowed along the connecting line; and a second switching valve arranged on the connecting line and movable to selectively provide fluid communication through the second switching valve and along the connecting line to control fluid flow between the steering pump, the accumulator, and the main control valve.

At least one embodiment relates to a hydraulic system for a telehandler, the hydraulic system including: a steering pump; a steering valve configured to control a steering direction; an accumulator arranged downstream of the steering pump; an implement pump; a main control valve; a connecting line in fluid communication with the accumulator, the implement pump, and the main control valve; a first switching valve arranged on the connecting line and movable between a first position where fluid communication is allowed only in a direction from the first switching valve toward the accumulator and a second position where fluid communication is allowed along the connecting line; and a second switching valve arranged on the connecting line and movable to selectively provide fluid communication along the connecting line to control fluid flow between the implement pump and the accumulator, and between the steering pump, the accumulator, and the main control valve.

At least one embodiment relates to a telehandler, including: a chassis; a lift assembly supported on the chassis; an implement coupled to a distal end of the lift assembly; an axle assembly coupled to the chassis; and a hydraulic system including: a tank storing hydraulic fluid; a filter arranged upstream of the tank; a heat exchanger, and a back pressure valve arranged between the filter and the tank, wherein the back pressure valve is configured to raise a pressure downstream of the filter so that hydraulic fluid is forced into the heat exchanger.

At least one embodiment relates to a telehandler, including: a chassis; a lift assembly supported on the chassis; an implement coupled to a distal end of the lift assembly; an axle assembly coupled to the chassis; and a hydraulic system including: a main control valve; a tank storing hydraulic fluid; a heat exchanger, and a filter and return assembly including: an inlet port in fluid communication with the main control valve so that return fluid flow is provided to the inlet port; a return line in fluid communication with the inlet port; a filter arranged on the return line downstream of the inlet port; and a back pressure valve arranged on the return line downstream of the filter, wherein the back pressure valve is configured to raise a pressure downstream of the filter so that fluid flow downstream of the filter is forced through the heat exchanger prior to entering the tank.

At least one embodiment relates to a hydraulic system for a telehandler, the hydraulic system including: a tank storing hydraulic fluid; a filter arranged upstream of the tank; a heat exchanger, and a back pressure valve arranged between the filter and the tank, wherein the back pressure valve is configured to raise a pressure downstream of the filter so that hydraulic fluid is forced into the heat exchanger.

At least one embodiment relates to a telehandler, including: a chassis; a lift assembly supported on the chassis; an implement coupled to a distal end of the lift assembly; an axle assembly coupled to the chassis; a user interface configured to control operation of the lift assembly, the implement, and the axle assembly; a hydraulic system including: a steering pump; a steering valve configured to control a steering direction of the axle assembly; an implement pump; a main control valve configured to control fluid flow to and from the lift assembly; and an electric motor configured to drive the steering pump and the implement pump; and a controller in communication with the user interface and the electric motor, the controller being configured to: sum a fluid flow demand provided to each section of the main control valve to generate an implement pump speed command; compare a steering pump speed command to the implement pump speed command; and control a speed of the electric motor based on which value is greater between the steering pump speed command and the implement pump speed command.

At least one embodiment relates to a method for controlling a hydraulic system of a telehandler, the method including: adding a fluid flow demand provided to each section of a main control valve to generate an implement pump speed command provided to an implement pump; determining a steering pump speed command based on a steering demand provided to a steering pump; comparing the steering pump speed command to the implement pump speed command; and controlling a speed of an electric motor that is coupled to the implement pump and the steering pump based on which value is greater between the steering pump speed command and the implement pump speed command.

At least one embodiment relates to a method for controlling a hydraulic system of a telehandler, the method including: detecting an implement demand provided to an implement pump; in response to detecting the implement demand, adding a fluid flow demand provided to each section of a main control valve to determine a total implement fluid flow demand; correlating the total implement fluid flow demand to an implement pump speed command provided to the implement pump; detecting a steering demand provided to a steering pump; determining a steering pump speed command based on the steering demand provided to a steering pump; comparing the steering pump speed command to the implement pump speed command; and controlling a speed of an electric motor that is coupled to the implement pump and the steering pump based on which value is greater between the steering pump speed command and the implement pump speed command.

At least one embodiment relates to a vehicle that includes a chassis extending along a longitudinal axis, a motor bracket, a battery bracket, a plurality of tabs, and a battery. The chassis includes a pair of longitudinal frame members each offset from the longitudinal axis. The motor bracket extends from one of the longitudinal frame members. The battery bracket extends from the longitudinal frame member. The plurality of tabs extend from the longitudinal frame member. The battery extends between the motor bracket, the battery bracket, and the tabs. The motor bracket and the battery bracket are configured to restrict movement of the battery. The tabs are configured to permit relative movement between the battery and the longitudinal frame member.

At least one embodiment relates to a vehicle that includes a chassis and a battery housing. The chassis extends along a longitudinal axis. The chassis includes a pair of longitudinal frame members each offset from the longitudinal axis. The battery housing is coupled to the longitudinal frame member. The battery housing encloses a battery bracket extending from one of the longitudinal frame members towards the battery housing, a plurality of tabs extending from the longitudinal frame member, and a battery extending between the battery bracket, the tabs, and the battery housing. The battery is coupled to the tabs and the battery bracket. The tabs are configured to permit relative movement between the battery and the longitudinal frame member.

At least one embodiment relates to a vehicle that includes a chassis, a battery bracket, a plurality of tabs, and a battery. The chassis extends along a longitudinal axis. The chassis includes a pair of longitudinal frame members each offset from the longitudinal axis. The battery bracket extends from one of the longitudinal frame members. The battery bracket includes a lateral portion and a flange extending from the lateral portion. The plurality of tabs extends from the longitudinal frame member. The battery extends between the chassis, the battery bracket, and the tabs. The battery bracket is configured to restrict movement of the battery. The tabs are configured to permit relative movement between the battery and the longitudinal frame member. The lateral portion confronts a first side of the battery. The lateral portion is configured to prevent movement of the battery in a direction substantially perpendicular to the lateral portion of the battery bracket. The flange is coupled to a second side of the battery. The flange is configured to prevent movement of the battery in a direction substantially parallel to the lateral portion of the battery bracket. The second side of the battery is substantially perpendicular to the first side of the battery.

Another embodiment relates to a telehandler comprising a chassis, a cabin coupled to the chassis, and a motor configured to power at least one component of the telehandler. The telehandler comprises a first circuit having a radiator configured to transfer thermal energy from a first volume of fluid to a surrounding space, and a first pump configured to drive the first volume of fluid between the radiator and the motor to draw thermal energy from the motor. The telehandler comprises a second circuit having a heater configured to add thermal energy to a second volume of fluid, a heat exchanger configured to draw thermal energy from the second volume of fluid, a second pump configured to drive the second volume of fluid between the heater and the heat exchanger, and a fan configured to direct air to the heat exchanger and the cabin to transfer thermal energy from the heat exchanger to the cabin to heat the cabin. The telehandler further comprises a fluid tank configured to selectively store fluid, and at least one conduit configured to fluidly couple the fluid tank, the first circuit, and the second circuit.

Another embodiment relates to a vehicle comprising a chassis, a cabin coupled to the chassis, and a refrigeration circuit. The refrigeration circuit includes an evaporator configured to transfer thermal energy from a surrounding atmosphere to a fluid, an expansion valve fluidly coupled to the evaporator by at least one conduit, and a condenser fluidly coupled to the expansion valve by the at least one conduit, the expansion valve positioned between the evaporator and the condenser. The refrigeration circuit further comprises a compressor fluidly coupled to and positioned between the evaporator and the condenser, the compressor configured to drive the fluid within the at least one conduit throughout the refrigeration circuit, and a fan configured to direct air across the evaporator and into the cabin to remove thermal energy from the cabin to cool the cabin. The refrigeration circuit also comprises a first port fluidly coupled with the at least one conduit between the compressor and the condenser, the first port configured to provide access to an interior volume defined by the at least one conduit, and a second port fluidly coupled with the at least one conduit between the evaporator and the compressor, the second port configured to provide access to the interior volume defined by the at least one conduit.

Another embodiment relates to a vehicle comprising a chassis, a cabin coupled to the chassis, and a circuit. The circuit comprises a plenum having a heat exchanger and an evaporator, the heat exchanger configured to draw thermal energy from a volume of fluid and the evaporator configured to transfer thermal energy from a surrounding atmosphere to a fluid. The circuit also comprises a heater fluidly coupled with the heat exchanger via at least one conduit, the heater configured to add thermal energy to the volume of fluid, a pump fluidly coupled with the heat exchanger via the at least one conduit, the pump configured to drive the volume of fluid between the heater and the heat exchanger, and a first fan configured to direct air to the heat exchanger and the cabin to transfer thermal energy from the heat exchanger to the cabin to heat the cabin. The circuit also comprises a condenser fluidly coupled with the evaporator via the at least one conduit, a compressor fluidly coupled with the evaporator and the condenser via the at least one conduit, where the compressor is positioned between the evaporator and the condenser and is configured to drive fluid within the at least one conduit, a port fluidly coupled with the at least one conduit between the compressor and the condenser, the port configured to provide access to an interior volume defined by the at least one conduit, and a second fan configured to direct air to the evaporator and into the cabin to remove thermal energy from the cabin to cool the cabin.

Another embodiment relates to a telehandler, including: a chassis; a cabin coupled to the chassis; a climate control system including: an evaporator configured to transfer thermal energy to a fluid; an expansion valve fluidly coupled to the evaporator by a conduit; a condenser fluidly coupled to the expansion valve by the conduit, the expansion valve positioned between the evaporator and the condenser, a compressor fluidly coupled to and positioned between the evaporator and the condenser, the compressor configured to drive the fluid within the conduit; a heater configured to transfer thermal energy to a surrounding atmosphere; and a fan configured to direct airflow across at least one of (i) the evaporator and into the cabin to remove thermal energy from the cabin to cool the cabin or (ii) the heater and into the cabin to add thermal energy to the cabin to heat the cabin; a first input device configured to receive a first input from an operator regarding a state of the compressor, a second input device configured to receive a second input from the operator regarding a temperature of the cabin; and a control system configured to: selectively operate the compressor based on the first input; control an operation of at least one of the compressor or the heater based on the second input to control the temperature of the cabin; and stop operation of the compressor responsive to the temperature of the cabin associated with the second input exceeding a threshold temperature.

Another embodiment relates to a vehicle, including: a climate control system including: an evaporator configured to transfer thermal energy to a fluid; an expansion valve fluidly coupled to the evaporator by a conduit; a condenser fluidly coupled to the expansion valve by the conduit, the expansion valve positioned between the evaporator and the condenser, a compressor fluidly coupled to and positioned between the evaporator and the condenser, the compressor configured to drive the fluid within the conduit; a heater configured to transfer thermal energy to a surrounding atmosphere; and a fan configured to direct airflow across at least one of (i) the evaporator or (ii) the heater, a first user interface including one or more input devices configured to receive an input from an operator, a sensor configured to monitor a position of the one or more input devices; and a control system configured to: in response to a first signal indicative of a first position of the one or more input devices, operate at least one of the compressor, the heater, or the fan to increase a temperature of a cabin of the vehicle to at or above a threshold temperature, and in response to a second signal indicative of a second position of the one or more input devices, operate at least one of the compressor, the heater, or the fan to decrease the temperature of the cabin below the threshold temperature.

Another embodiment relates to a vehicle, including: a chassis; a cabin coupled to the chassis; a climate control system including: an evaporator configured to transfer thermal energy to a fluid; an expansion valve fluidly coupled to the evaporator by a conduit; a condenser fluidly coupled to the expansion valve by the conduit, the expansion valve positioned between the evaporator and the condenser, a compressor fluidly coupled to and positioned between the evaporator and the condenser, the compressor configured to drive the fluid within the conduit; a heater configured to transfer thermal energy to a surrounding atmosphere; and a fan configured to direct airflow across at least one of (i) the evaporator and into the cabin to remove thermal energy from the cabin to cool the cabin or (ii) the heater and into the cabin to add thermal energy to the cabin to heat the cabin; a first input device configured to receive a first input from an operator regarding a state of the compressor, a second input device configured to receive a second input from the operator regarding a temperature of the cabin; a third input device configured to receive a third input from the operator regarding a state of the fan; and a control system configured to: selectively operate the compressor based on at least the first input; control an operation of at least one of the compressor, the heater, or the fan based on the second input to control the temperature of the cabin; and stop operation of the compressor and increase a speed of the fan responsive to the temperature of the cabin associated with the second input exceeding a threshold temperature.

Another embodiment relates to a vehicle including a chassis and a thermal management system coupled to the chassis. The thermal management system includes: a heat exchanger, a sensor fluidly coupled to the heat exchanger, a first fan configured to move air through the heat exchanger, a second fan configured to move air through the heat exchanger, and at least one controller configured to control operation of the first fan and the second fan. The at least one controller is configured to: receive a first signal from the sensor that is indicative of a first operating condition of the heat exchanger, responsive to the first signal, control a speed of the first fan based on the first operating condition while maintaining the second fan in a deactivated state; receive a second signal from the sensor that is indicative of a second operating condition having a greater cooling requirement than the first condition; and responsive to the second signal: control the speed of the first fan based on the second operating condition; and activate the second fan at a fixed operating speed of the second fan that is independent of the second operating condition.

Another embodiment of the present disclosure relates to a thermal management system including: a first heat exchanger, a second heat exchanger, a sensor fluidly coupled to one of the first heat exchanger and the second heat exchanger, a first fan configured to move air through the first heat exchanger and the second heat exchanger, a second fan configured to move air through the first heat exchanger and the second heat exchanger, and at least one controller configured to control operation of the first fan and the second fan. The at least one controller is configured to: receive a signal from the sensor that is indicative of an operating condition of at least one of the first heat exchanger or the second heat exchanger that satisfies a threshold operating condition; control a speed of the first fan based on the operating condition; and responsive to the signal, activate the second fan at a fixed operating speed of the second fan that is independent of the operating condition.

Another embodiment relates to a method of controlling a fan assembly of a thermal management system for a vehicle. The method includes: receiving, from a sensor fluidly coupled to one of a first heat exchanger and a second heat exchanger, a first signal that is indicative of a first operating condition of at least one of the first heat exchanger or the second heat exchanger, controlling a speed of a first fan that is configured to move air through the first heat exchanger and the second heat exchanger responsive to the first signal based on the first operating condition; receiving, from the sensor, a second signal that is indicative of a second operating condition having a greater cooling requirement than the first condition; and responsive to the second signal: controlling the speed of the first fan based on the second operating condition; and activating a second fan that is configured to move air through the first heat exchanger and the second heat exchanger at a fixed operating speed of the second fan that is independent of the second operating condition.

Another embodiment relates to a vehicle including: a chassis; and a cooling pack assembly coupled to the chassis. The cooling pack assembly includes a heat exchanger assembly and a fan assembly. The heat exchanger assembly includes: a first heat exchanger core; and a second heat exchanger core coupled to the first heat exchanger core in a side by side arrangement along a lateral direction. The second heat exchanger core is substantially aligned with the first heat exchanger core along a longitudinal direction that is substantially perpendicular to the lateral direction. The fan assembly includes at least two fans that each extend in the lateral direction across an upper face of both the first heat exchanger core and the second heat exchanger core.

Another embodiment relates to a cooling pack assembly including: a housing; a first heat exchanger core disposed within the housing; a second heat exchanger core disposed within the housing and coupled to the first heat exchanger core in a side by side arrangement along a lateral direction, the second heat exchanger core substantially aligned with the first heat exchanger core along a longitudinal direction that is substantially perpendicular to the lateral direction; a first fan extending in the lateral direction across a first portion of both the first heat exchanger core and the second heat exchanger core; and a second fan extending in the lateral direction across a second portion of both the first heat exchanger core and the second heat exchanger core.

Another embodiment relates to a cooling pack assembly including: a housing; a first heat exchanger core disposed within the housing and extending along a flow direction through the first heat exchanger core; a second heat exchanger core disposed within the housing and coupled to the first heat exchanger core in a side by side arrangement along a lateral direction that is substantially perpendicular to the flow direction; and at least two fans that each extend in the lateral direction across both the first heat exchanger core and the second heat exchanger core in an approximately hashtag profile when viewed substantially perpendicular to the lateral direction and the flow direction.

Another embodiment relates to a vehicle including: a chassis; a first motor coupled to the chassis; a battery coupled to the chassis; at least two chargers electrically coupled to the battery and configured to charge the battery; and a thermal management system coupled to the chassis, the thermal management system including: a heat exchanger, a first cooling loop fluidly coupling the heat exchanger to the at least two chargers and the first motor in series flow arrangement; and a first coolant pump fluidly coupled to the first cooling loop and configured to direct coolant through the first cooling loop.

Another embodiment relates to a vehicle including: a chassis; and a first heat exchanger coupled to the chassis and oriented at an angle relative to a lateral direction extending between a forward end and a rear end of the chassis, the first heat exchanger including: a first heat exchanger core; a first inlet manifold coupled to a first end of the first heat exchanger core, the first inlet manifold including a first plurality of ports; and a first outlet manifold coupled to a second end of the first heat exchanger core at a position vertically above the first inlet manifold, the first outlet manifold including a second plurality of ports.

Another embodiment relates to a telehandler including chassis, an electrical system coupled to the chassis, and a controller electrically coupled to the electrical system. The electrical system includes a high-voltage battery configured to supply power to a high-voltage bus and a low-voltage battery configured to supply power to a low-voltage bus. The controller is configured to detect a shutdown trigger and, in response to the detection of the shutdown trigger, initiate a shutdown sequence of the telehandler.

Another embodiment relates to a telehandler including a chassis, a user interface, an electrical system coupled to the chassis, and a controller electrically coupled to the electrical system and the user interface. The electrical system includes a high-voltage battery configured to transmit power to a high-voltage bus, the high-voltage bus configured to power to the telehandler while operating in a high-voltage mode, and a low-voltage battery configured to transmit power to a low-voltage bus, wherein the low-voltage bus supplies power to the telehandler while operating in a low-voltage mode. The controller is configured to receive instructions from the user interface, send operational commands to one or more high-voltage components of the electrical system in response to the instructions from the user interface, and initiate a standby mode of operation when no instructions are received from the user interface for a first predetermined time, wherein in the standby mode, commands to the one or more high-voltage components of the electrical system are not sent in response to subsequent instructions from the user interface.

Another embodiment relates to a telehandler including a chassis, an electrical system coupled to the chassis, and a controller electrically coupled to the electrical system. The electrical system includes a high-voltage battery configured to transmit power to a high-voltage bus, a low-voltage battery configured to transmit power to a low-voltage bus, and a switch. The controller is configured to receive signals from the switch and selectively transition the telehandler between an off mode, a low-voltage mode, and a high-voltage mode of operation based on the signals.

Another embodiment relates to a telehandler including a chassis, an electrical system coupled to the chassis, a controller, and a user interface. The electrical system includes a high-voltage battery configured to transmit power to a high-voltage bus, wherein the high-voltage bus receives power when the telehandler operates in a high-voltage mode, and a low-voltage battery configured to transmit power to a low-voltage bus, wherein the low-voltage bus receives power when the telehandler operates in a low-voltage mode. The controller is configured to receive a request from the user interface to selectively execute at least one of a drive command, a brake command, or a steer command, wherein the controller is configured to execute the requested command when the telehandler operates in the high-voltage mode, wherein the controller is not configured to execute the requested command when the telehandler operates in the low-voltage mode.

Another embodiment relates to a controller for a telehandler including a user interface, a high-voltage bus, and a low-voltage bus. The controller includes one or more processors and a memory storing instructions that, when executed by the one or more processors, cause the controller to receive a request from the user interface to selectively execute at least one of a drive command, a brake command, or a steer command, determine whether the telehandler is in a high-voltage mode or a low-voltage mode, execute, when the telehandler is in the high-voltage mode, the received command, and not execute, when the telehandler is in the low-voltage mode, the received command.

Another embodiment relates to a telehandler including a chassis, a tractive assembly coupled to the chassis, a motor configured to drive the tractive assembly, a user interface coupled to the chassis, an electrical system coupled to the chassis, and a controller communicatively coupled to the user interface and the motor. The electrical system includes a high-voltage battery configured to transmit power to a high-voltage bus, wherein the high-voltage bus receives power when the telehandler operates in a high-voltage mode, and a low-voltage battery configured to transmit power to a low-voltage bus, wherein the low-voltage bus receives power when the telehandler operates in a low-voltage mode. When the electrical system is in the high-voltage mode, the controller is configured to receive a request to execute a drive command, the request comprising a speed input from the user interface, determine a maximum allowable speed of the telehandler based on at least one operating condition of the telehandler, and provide a speed command to the motor causing the motor to operate at a speed defined by the speed command, wherein the speed command is proportional to the speed input, with a maximum speed input corresponding to the maximum allowable speed.

Another embodiment relates to a lift device. The lift device includes a chassis, axles, tractive elements, a motor, and a user interface. The user interface includes a display. The display is configured to operate a state of charge gauge to provide a real-time indication of a state of charge of a high voltage electrical system of the lift device. The display is configured to operate a battery temperature gauge to provide a real-time indication of a temperature of the high voltage electrical system of the lift device. The display is configured to operate a motor temperature gauge to provide a real-time indication of a temperature of the motor.

Another embodiment relates to a lift device. The lift device includes a chassis, axles, tractive elements, a motor, and a user interface. The user interface includes a display. The display is configured to selectively illuminate a plurality of steer mode indicators to provide a real-time indication of a steer mode of the lift device. The display is configured to selectively illuminate a plurality of operating mode indicators to provide a real-time indication of an operating mode of the lift device.

Another embodiment relates to a user interface for a lift device. The user interface is configured to operate a plurality of operable elements to provide a user with a plurality of real-time indications regarding the operation of the lift device. The user interface includes a left section, a right section, a lower middle section, a middle section, and an upper middle section. The left section includes a high voltage warning indicator configured to indicate that a high voltage power distribution unit (HVPDU) of the lift device is operating outside of a preset threshold and a high voltage critical indicator configured to indicate that the HVPDU is experiencing a critical error in its operation. The right section includes a plurality of steer mode indicators configured to provide a real-time indication of a steer mode of the lift device, a plurality of operating mode indicators configured to provide a real-time indication of one or more operating parameters of the lift device, a low-voltage battery low indicator configured to provide an indication that a state of charge (SOC) of a low voltage battery of the lift device is below a predetermined low voltage battery SOC threshold, and a high-voltage battery low indicator configured to provide an indication that a SOC of a high voltage battery of the lift device is below a predetermined high voltage battery SOC threshold. The lower middle section includes a motor temperature gauge configured to provide a real-time indication of a temperature of a drive motor of the lift device and a battery temperature gauge configured to provide a real-time indication of a temperature of the high voltage battery. The middle section includes a power usage gauge configured to provide a real-time indication of power usage of the lift device. The upper middle section includes a state of charge gauge configured to provide a real-time indication of a SOC of an electrical system of the lift device.

At least one embodiment relates to a telehandler, including: a chassis; a tractive element coupled to the chassis; an electrical energy consumer, a boom assembly coupled to the chassis; a battery configured to supply first electrical energy to the electrical energy consumer, and an auxiliary power unit removably coupled to the chassis and configured to supply second electrical energy to at least one of the electrical energy consumer or the battery.

At least one embodiment relates to a telehandler, including: a chassis; a tractive element coupled to the chassis; a boom assembly coupled to the chassis; a battery; an auxiliary power unit coupled to the chassis and configured to supply electrical energy; and a controller reconfigurable between (a) a first mode in which the controller controls the battery to satisfy a power demand of the telehandler without a power output from the auxiliary power unit, (b) a second mode in which the controller controls the auxiliary power unit to satisfy the power demand of the telehandler without a power output from the battery, and (c) a third mode in which the controller controls the battery and the auxiliary power unit to satisfy the power demand of the telehandler together.

At least one embodiment relates to a telehandler, including: a chassis; a tractive element coupled to the chassis; an electrical energy consumer, a boom assembly coupled to the chassis; a battery configured to supply first electrical energy to the electrical energy consumer, an auxiliary power unit coupled to the chassis; and a controller configured to activate the auxiliary power unit to supply second electrical energy to the electrical energy consumer based on at least one of (a) a state of charge of the battery, (b) a temperature of the battery, or (c) a power demand of the electrical energy consumer.

At least one embodiment relates to a vehicle including: a chassis; a first motor coupled to the chassis; a battery coupled to the chassis; at least two chargers electrically coupled to the battery and configured to charge the battery; and a thermal management system coupled to the chassis. The thermal management system includes: a heat exchanger, a first cooling loop fluidly coupling the heat exchanger to the at least two chargers and the first motor in a series flow arrangement; and a first coolant pump fluidly coupled to the first cooling loop and configured to direct coolant through the first cooling loop.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a front perspective view of a telehandler, according to an exemplary embodiment.

FIG. 2 is a rear perspective view of the telehandler of FIG. 1.

FIG. 3 is a left perspective view of the telehandler of FIG. 1.

FIG. 4 is a right perspective view of the telehandler of FIG. 1

FIG. 5 is a is a block diagram of the telehandler of FIG. 1.

FIG. 6 is a left perspective view of the telehandler of FIG. 1.

FIG. 7 is a right perspective view of the telehandler of FIG. 1

FIG. 8 is a rear perspective view of the telehandler of FIG. 1.

FIG. 9 is a front perspective view of the telehandler of FIG. 1.

FIGS. 10 and 11 are top perspective views of the telehandler of FIG. 1.

FIG. 12 is a left perspective view of the telehandler of FIG. 1.

FIG. 13 is a left side view of the telehandler of FIG. 1.

FIG. 14 is a bottom view of the telehandler of FIG. 1.

FIG. 15 is a top perspective view of the telehandler of FIG. 1

FIG. 16 is a bottom perspective view of the telehandler of FIG. 1.

FIG. 17 is a top view of the telehandler of FIG. 1.

FIG. 18 is a top perspective view of the telehandler of FIG. 1.

FIG. 19 is a left perspective view of a telehandler according to another exemplary embodiment.

FIG. 20 is a front perspective view of the telehandler of FIG. 19.

FIGS. 21 and 22 are top perspective views of the telehandler of FIG. 19.

FIG. 23 is a left perspective view of the telehandler of FIG. 19.

FIG. 24 is a left side view of the telehandler of FIG. 19.

FIG. 25 is a bottom view of the telehandler of FIG. 19.

FIG. 26 is a top perspective view of the telehandler of FIG. 19.

FIG. 27 is a bottom perspective view of the telehandler of FIG. 19.

FIG. 28 is a top view of the telehandler of FIG. 19.

FIG. 29 is a perspective view of the telehandler of FIG. 1.

FIG. 30 is a side view of the telehandler of FIG. 1.

FIGS. 31, 32, and 33 are perspective views of the telehandler of FIG. 1.

FIG. 34 is a perspective view of the telehandler of FIG. 19 including an electrical system, according to an exemplary embodiment.

FIG. 35 is a perspective view of the telehandler of FIG. 19 showing a high-voltage battery and a high-voltage power distribution unit, according to an exemplary embodiment.

FIG. 36 is a top perspective view of a front side of the high-voltage power distribution unit including cables electrically connected with an implement motor and a drive motor, according to an exemplary embodiment.

FIG. 37 is a perspective view of the cables of FIG. 37, with one of the cables extending through a side plate of a chassis assembly of the telehandler of FIG. 19.

FIG. 38 is a top view of one of the cables of FIG. 37 electrically coupled with a drive motor of the telehandler of FIG. 19.

FIG. 39 is atop perspective view the telehandler of FIG. 19.

FIGS. 40 and 41 are perspective views of a rear side of the high-voltage power distribution unit of FIG. 35.

FIG. 42 is atop perspective view of a cable that extends from the rear side of the high-voltage power distribution unit of FIG. 35 and electrically connects with an onboard charger, according to an exemplary embodiment.

FIG. 43 is a perspective view of the onboard charger of FIG. 42.

FIG. 44 is perspective view of cables that electrically connect the high-voltage power distribution unit of FIG. 35 with a heater and a compressor of the telehandler of FIG. 19, according to an exemplary embodiment.

FIG. 45 is a bottom perspective view of the cables of FIG. 44 and the heater and the compressor of the telehandler of FIG. 19.

FIG. 46 is a bottom perspective view of the cables of FIG. 44 electrically connecting with the heater and the compressor.

FIG. 47 is a bottom perspective view of the heater of the telehandler of FIG. 19.

FIG. 48 is a top perspective view of the compressor of the telehandler of FIG. 19.

FIG. 49 is atop perspective view of the onboard charger of FIG. 42 and a charging port of the telehandler of FIG. 1, according to an exemplary embodiment.

FIG. 50 is a block diagram of a disconnect system of the telehandler of FIG. 1.

FIG. 51 is another block diagram of a disconnect system of the telehandler of FIG. 1.

FIG. 52 is another block diagram of a disconnect system of the telehandler of FIG. 1.

FIG. 53 is another block diagram of a disconnect system of the telehandler of FIG. 1.

FIG. 54 is a side perspective view of a cab and a charging pod of the telehandler of FIG. 1.

FIG. 55 is a bottom perspective view of the cab and the charging pod of FIG. 54.

FIG. 56 is a rear perspective view of the cab and the charging pod of FIG. 54.

FIG. 57 is a side view of the charging pod of FIG. 54.

FIG. 58 is a perspective view of the charging pod of FIG. 54.

FIG. 59 is a detail view of the charging pod of FIG. 54.

FIG. 60 is a top view of a portion of the charging pod of FIG. 54.

FIG. 61 is a perspective view of a portion of the charging pod of FIG. 54.

FIG. 62 is another perspective view of a portion of the charging pod of FIG. 54.

FIG. 63 is a detailed perspective view of a portion of the charging pod of FIG. 54.

FIG. 64 is a perspective view of charging modules received by of the charging pod of FIG. 54.

FIG. 65 is a block diagram of a charging pod of the telehandler of FIG. 1 in a first configuration.

FIG. 66 is another diagram of the charging pod of FIG. 65 in the first configuration.

FIG. 67 is a block diagram of the charging pod of the telehandler of FIG. 1 in a second configuration.

FIG. 68 is another diagram of the charging pod of FIG. 67 in the second configuration.

FIG. 69 is block diagram of the charging pod of FIG. 67 in the third configuration.

FIG. 70 is block diagram of the charging pod of FIG. 67 in the fourth configuration.

FIG. 71 is block diagram of the charging pod of FIG. 67 in the fifth configuration.

FIG. 72 is block diagram of the charging pod of FIG. 67 in the sixth configuration.

FIG. 73 is chart showing power coordination of a the charging pod of FIG. 67 according to a first control strategy.

FIG. 74 is chart showing power coordination of a the charging pod of FIG. 67 according to a second control strategy.

FIG. 75 is a schematic block diagram of a portion of the telehandler of FIG. 1.

FIG. 76 is a flow diagram of a method of operating onboard chargers of the telehandler of FIG. 1.

FIG. 77 is a schematic block diagram of a portion of the telehandler of FIG. 1.

FIG. 78 is a flow diagram of a method of activating the onboard chargers of the telehandler of FIG. 1.

FIG. 79 is a side view of a battery housing of the telehandler of FIG. 1, according to an exemplary embodiment.

FIG. 80 is a side perspective view of the battery housing of FIG. 79.

FIG. 81 is a top perspective view of the battery housing of FIG. 79.

FIGS. 82, 83, and 84 are bottom perspective views of the battery housing of FIG. 79.

FIGS. 85 and 86 are top perspective views of the battery housing of FIG. 79.

FIG. 87 is a left side view of the telehandler of FIG. 1.

FIG. 88 is a bottom perspective view of the telehandler of FIG. 1.

FIG. 89 is a top perspective view of the battery housing of FIG. 79 with the battery housing shown as being transparent.

FIG. 90 is a bottom perspective view of the battery housing of FIG. 79 with the battery housing shown as being transparent.

FIG. 91 is a block diagram of a high voltage interlock loop system, according to an exemplary embodiment.

FIG. 92 is a block diagram of a high voltage interlock loop system, according to an exemplary embodiment.

FIG. 93 is a block diagram of a high voltage power distribution unit of FIG. 92.

FIG. 94 is a block diagram of the front frame control module of FIG. 92.

FIG. 95 is a flow diagram depicting a process of monitoring high voltage circuits.

FIG. 96 is a block diagram of an example user interface.

FIG. 97 is a flow diagram for a method of configuring a high voltage interlock loop system.

FIG. 98 is a block diagram for a low voltage monitoring system, according to an exemplary embodiment.

FIG. 99 is a first graph depicting low voltage electricity generated by a battery and a second graphs depicting a low voltage rectangular wave generated by a control module.

FIG. 100A is a graph showing the returned low voltage rectangular wave of FIG. 99 with a break in the circuit.

FIG. 100B is a graph showing the returned low voltage rectangular wave of FIG. 99 with an undesired interaction between the circuit and an external component.

FIG. 100C is a graph showing the returned low voltage rectangular wave of FIG. 99 with a DC offset.

FIG. 100D is a graph showing the returned low voltage rectangular wave of FIG. 99 with a variable frequency.

FIG. 101 is a method for actively monitoring high voltage transmission using a low voltage direct current rectangular wave, according to an exemplary embodiment.

FIG. 102 is a block diagram of a system to control one or more aspects of the telehandler of FIG. 1.

FIG. 103 is a table including information associated with operation of the telehandler of FIG. 1.

FIG. 104 is a table including information associated with operation of the telehandler of FIG. 1.

FIG. 105 is a block diagram of a system to control one or more operations of the telehandler of FIG. 1, according to an exemplary embodiment.

FIG. 106 is a flow diagram of a process to control one or more aspects of a battery of the telehandler of FIG. 1, according to an exemplary embodiment.

FIG. 107 is a flow diagram of a process to control one or more aspects of a battery of the telehandler of FIG. 1, according to an exemplary embodiment.

FIG. 108 is a flow diagram of a process to control one or more aspects of a battery of the telehandler of FIG. 1, according to an exemplary embodiment.

FIG. 109 is a chart illustrating one or more characteristics during charge cycles of a battery, according to an exemplary embodiment.

FIG. 110 is a chart illustrating one or more characteristics during discharge cycles of a battery, according to an exemplary embodiment.

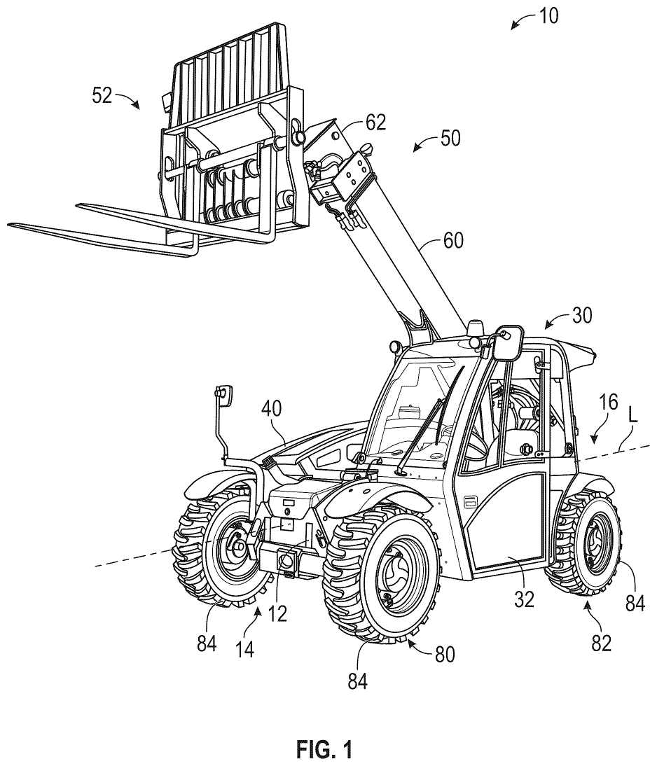

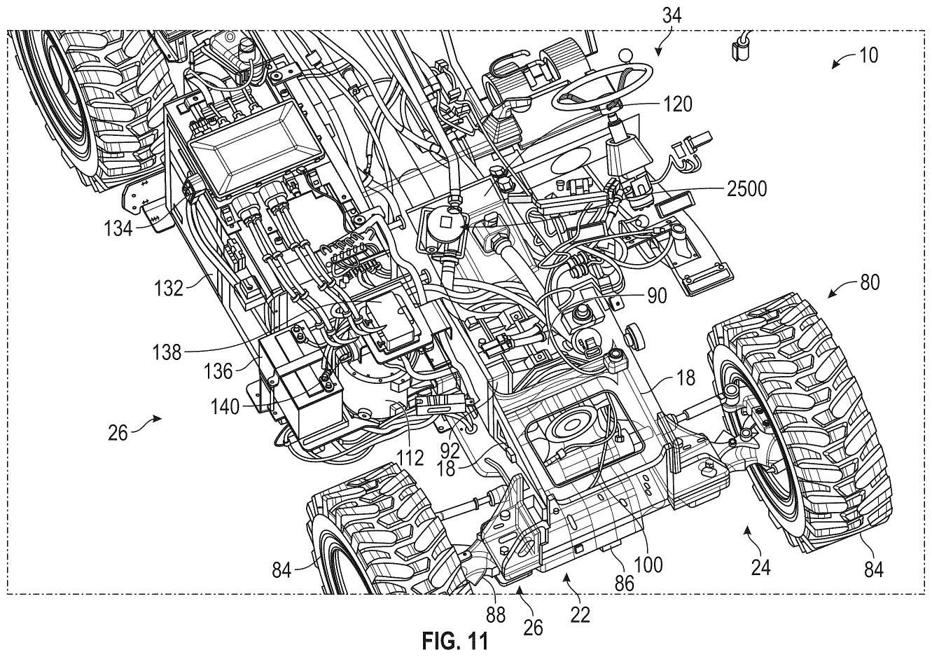

FIG. 11I is a block diagram of a high-voltage battery included in the telehandler of FIG. 1, according to an exemplary embodiment.

FIG. 112 is a schematic illustration of a hydraulic circuit of the telehandler of FIG. 1, according to an exemplary embodiment.

FIG. 113 is an enlarged view of a portion of the hydraulic circuit of FIG. 112, according to an exemplary embodiment.

FIG. 114 is an enlarged view of a portion of the hydraulic circuit of FIG. 112, without a load sense valve, according to an exemplary embodiment.

FIG. 115 is an enlarged view of a portion of the hydraulic circuit of FIG. 112, with a proportional switching valve, according to an exemplary embodiment.

FIG. 116 is a schematic illustration of a control system of the telehandler of FIG. 1, according to an exemplary embodiment.

FIG. 117 is a schematic illustration of a hydraulic circuit of the telehandler of FIG. 1 including a filter and return assembly, according to an exemplary embodiment.

FIG. 118 is a schematic illustration of a hydraulic circuit of the telehandler of FIG. 1 including a bi-directional implement pump and a brake, according to an exemplary embodiment.

FIG. 119 is a schematic illustration of a hydraulic circuit of the telehandler of FIG. 1 including a bi-directional implement pump and a hydraulic velocity fuse, according to an exemplary embodiment.

FIG. 120 is a schematic illustration of a hydraulic circuit of the telehandler of FIG. 1 including a bi-directional implement pump and a flow restricting device, according to an exemplary embodiment.

FIG. 121 is a flowchart showing the steps in a method or process for controlling a hydraulic system the telehandler of FIG. 1, according to an exemplary embodiment.

FIG. 122 is atop perspective view of the telehandler of FIG. 1.

FIG. 123 is a bottom perspective view of the telehandler of FIG. 1.

FIG. 124 is a rear perspective view of the telehandler of FIG. 1.

FIG. 125 is a bottom perspective view of the telehandler of FIG. 1.

FIG. 126 is a side perspective view of the telehandler of FIG. 1.

FIG. 127 is a bottom, side perspective view of the telehandler of FIG. 1.

FIG. 128 is a block diagram of a cooling system and a heating, ventilation, and air-conditioning (HVAC) system of the telehandler of FIG. 1.

FIG. 129 is a perspective view of the cooling system of FIG. 128.

FIG. 130 is a perspective view of a surge tank of the cooling system of FIG. 128.

FIG. 131 is a top perspective view of the cooling system and the HVAC system of FIG. 128.

FIG. 132 is a bottom perspective view of the cooling system and the HVAC system of FIG. 128.

FIG. 133 is a first portion of a block diagram of the telehandler of FIG. 1.

FIG. 134 is a block diagram of refrigeration system of the telehandler of FIG. 1.

FIG. 135 is a top perspective view of the refrigeration system of FIG. 134 and the HVAC system of FIG. 128.

FIG. 136 is a side perspective view of the refrigeration system of FIG. 134.

FIG. 137 is a side perspective view of the refrigeration system of FIG. 134 and the telehandler of FIG. 1.

FIG. 138 is a perspective view of a cabin including a user interface of the telehandler of FIG. 1.

FIG. 139 is a perspective view of the user interface of FIG. 138.

FIG. 140 is a rear perspective view of the telehandler of FIG. 1.

FIG. 141 is a schematic diagram of a hydraulic cooling system implemented by the telehandler of FIG. 1, according to an exemplary embodiment.

FIG. 142 is a schematic diagram of an electrical cooling system implemented by the telehandler of FIG. 1, according to an exemplary embodiment.

FIG. 143 is a top view of a cooling system of the telehandler of FIG. 1.

FIG. 144 is a front perspective view of a pair of onboard chargers of the telehandler of FIG. 1.

FIG. 145 is a front perspective view of a radiator assembly of the telehandler of FIG. 1.

FIG. 146 is a rear perspective view of the cooling system of FIG. 143.

FIG. 147 is a front perspective view of the cooling system of FIG. 143.

FIG. 148 is a top perspective view of a battery case of the telehandler of FIG. 1.

FIG. 149 is a side perspective view of the telehandler of FIG. 1, showing a location of a cooling pack within a battery case of the telehandler.

FIG. 150 is a right perspective view of the cooling pack for use with the telehandler of FIG. 1, according to an exemplary embodiment.

FIG. 151 is a top perspective view of a modular cooling unit of the cooling pack of FIG. 150.

FIG. 152 is a bottom perspective view of the modular cooling unit of FIG. 151.

FIG. 153 is a rear perspective view of the cooling pack of FIG. 150, shown with fluid connections between the cooling pack and other parts of a hydraulic and electrical equipment cooling system, according to an exemplary embodiment.

FIG. 154 is a rear perspective view of a forward end of the cooling pack arrangement of FIG. 153.

FIG. 155 is a front perspective view of the cooling pack arrangement of FIG. 153.

FIG. 156 is a flow diagram of a method for performing continuously variable flow control using a combination of a fixed speed fan and a variable speed fan, according to an exemplary embodiment.

FIG. 157 is a flow diagram of a method of transitioning between off, low-voltage, and high-voltage modes of the telehandler of FIG. 1, according to an exemplary embodiment.

FIG. 158 is a flow diagram of a method of transitioning between off, low-voltage, and high-voltage modes of the telehandler of FIG. 1, according to an exemplary embodiment.

FIG. 159 is a flow diagram of a process of initiating a shutdown sequence of the telehandler of FIG. 1, according to an exemplary embodiment.

FIG. 160 is a flow diagram of a process of initiating a standby mode on the telehandler of FIG. 1, according to an exemplary embodiment.

FIG. 161 is a flow diagram of a process of transitioning between drive, steer, and brake commands in the telehandler 10 of FIG. 1, according to an exemplary embodiment.

FIG. 162 is a front perspective view of a display of the telehandler of FIG. 1, according to a prior embodiment.

FIG. 163 is a back perspective view of the display of the telehandler of FIG. 1.

FIG. 164 is a front view of the display of the telehandler of FIG. 1.

FIG. 165 is a front view of the display of the telehandler of FIG. 1.

FIG. 166 is a block diagram of the telehandler of FIG. 1 coupled to an auxiliary power unit (APU), according to an exemplary embodiment.

FIG. 167 is a front perspective view of the APU of FIG. 166.

FIG. 168 is a rear perspective view of the APU of FIG. 166.

FIG. 169 is a rear perspective view of the APU of FIG. 166 coupled to the telehandler of FIG. 1.

FIG. 170 is a side view of the APU of FIG. 166 coupled to the telehandler of FIG. 1.

FIG. 171 is a rear view of the APU of FIG. 166 coupled to the telehandler of FIG. 1.

FIG. 172 is a rear perspective view of the APU of FIG. 166 coupled to the telehandler of FIG. 1.

FIG. 173 is a side view of the APU of FIG. 166 coupled to the telehandler of FIG. 1.

FIG. 174 is a rear perspective view of the APU of FIG. 166 coupled to the telehandler of FIG. 1, according to another exemplary embodiment.

FIG. 175 is a block diagram of the telehandler of FIG. 1 coupled to an auxiliary power unit (APU), according to another exemplary embodiment.

FIG. 176 is a rear perspective view of the APU of FIG. 175 coupled to the telehandler of FIG. 1.

FIGS. 177 and 178 are side views of the APU of FIG. 175 coupled to the telehandler of FIG. 1.

FIG. 179 is a rear perspective view of the APU of FIG. 175 coupled to the telehandler of FIG. 1.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a telehandler includes a chassis dividing the telehandler into a first side area, a second side area, and a central area between the side areas. The first side area contains a cabin that supports an operator. The second side area contains a high-voltage battery that provides electrical energy to power various functions of the telehandler. The central area contains a boom assembly and a drive motor that receives electrical energy from the high-voltage battery and drives a pair of axle assemblies to propel the telehandler.

Referring generally to the figures, an electric telehandler includes various touchpoints that a user may regularly interact during normal operation of the electric telehandler or maintenance of the electric telehandler. These touchpoints may be positioned to facilitate direct user access, saving time and improving user satisfaction. One such touchpoint includes a charging port for the electric telehandler. This charging port may be positioned immediately behind a cabin of the electric telehandler to facilitate access immediately after exiting the cabin. The height of the charging port may be selected to facilitate access without having to bend over or raise the user's arms to an uncomfortable position. This position of the charging port may be applied to the refueling port of another telehandler that includes an internal combustion engine. A fleet of machines may include both such telehandlers, and a subset of users may operate both machines. By positioning the charging port and the refueling port similarly, a user may switch between the machines without having to refamiliarize themselves with the location of the port.

Referring generally to the figures, an electric telehandler includes an electrical system for powering a variety of electrical components or sub-systems. The electrical system includes a high-voltage battery, and a high-voltage power distribution unit. The electrical system also includes an implement motor, a drive motor, an onboard charger and a charging port, a heater, and a compressor. The high-voltage power distribution unit is disposed on top of the high-voltage battery. The high-voltage battery and the high-voltage power distribution unit are disposed laterally outside of a right one of a pair of plate members of a chassis assembly. The electrical system includes a plurality of cables that are routed to the implement motor, the drive motor, the onboard charger, the heater, and the compressor.

The cables for the implement motor and the drive motor extend from a front side of the high-voltage power distribution unit. The cable that connects the high-voltage power distribution unit with the drive motor extends through a first opening in the right one of the pair of plate members, and bends 180 degrees to connect with the drive motor. The cable that connects the high-voltage power distribution unit with the implement motor extends downwards and inwards towards the implement motor without passing through the right one of the pair of plate members.

The cables that electrically connect the high-voltage power distribution unit with the onboard charger, the heater, and the compressor extend from a rear side of the high-voltage power distribution unit. The cable that connects the high-voltage power distribution unit with the onboard charger extends laterally through openings in both of the pair of plate members to an opposite side of the telehandler at which the onboard charger is disposed. The cables that connects the high-voltage power distribution unit with the heater and the compressor extend through an opening in the right one of the pair of plate members, extend longitudinally through a space defined between the pair of plate members, and extend through openings in a crossmember between the pair of plate members to the heater and the compressor. The heater and compressor are disposed on interior surfaces on opposite ones of the right and left pair of plate members.

Referring generally to the figures, a telehandler may include an electrical system that includes a low-voltage system and a high-voltage system. The low-voltage system and the high-voltage system may be electrically coupled, where the low-voltage system may supply power to controllers and/or other low-voltage power functions, while the high-voltage system may supply power to controllers, motors, compressors, and/or other high-voltage power functions. According to an exemplary embodiment, the telehandler includes a disconnect system (e.g., a low-voltage disconnect system, a low-voltage battery disconnect system, etc.), which selectively disconnects (e.g., isolates, etc.) one or more components of the low-voltage system (e.g., the low-voltage battery, etc.) from one or more components of the high-voltage system. Advantageously, the disconnect system may selectively disconnect (e.g., isolate, etc.) a component of the low-voltage system (e.g., the low-voltage battery, etc.) from components of the telehandler (e.g., the high-voltage system, etc.), for example to prevent and/or limit unauthorized, unintended, and/or undesired uses of one or more functionalities of the telehandler.

As an illustrative example, during a start-up operation the low-voltage system (e.g., the low-voltage battery) may supply power (e.g., low-voltage power) to a controller, for example to start the telehandler and associated components. With the telehandler in an operating or running configuration, the high-voltage system (e.g., the high-voltage battery) may provide low-voltage power to one or more components of the telehandler (e.g., the low-voltage battery to charge the battery, the controller to perform low-voltage functions, etc.), for example through a DC/DC converter. In this sense, the low-voltage system (e.g., the low-voltage battery) may be used to start the telehandler and associated systems (e.g., the high-voltage system, etc.), while the high-voltage system may be used to provide low-voltage power and/or functionalities (e.g., via the DC/DC converter, etc.) once the telehandler is operating and/or running.

With the telehandler operating, the disconnect system may be engaged (e.g., activated, implemented, etc.), for example to disconnect one or more components of the low-voltage system (e.g., the low-voltage battery, etc.) from other components of the telehandler (e.g., the high-voltage system, etc.). While the low-voltage system (e.g., the low-voltage battery) is disconnected, the high-voltage system may continue to provide low-voltage power and/or functionalities (e.g., via the DC/DC converter, etc.), for example so long as the telehandler is operating or running. However, once the telehandler is turned off, or non-operational or not running, the telehandler cannot be restarted or turned on, for example due to the low-voltage system (e.g., the low-voltage battery) being disconnected. Advantageously, once the telehandler is started, the disconnect system may be engaged (e.g., activated, implemented, etc. to disconnect the low-voltage battery, etc.), for example allowing the telehandler to perform standard operations while running, but also preventing and/or limiting unauthorized, unintended, and/or undesired uses of the telehandler once the telehandler is eventually turned off.

Referring generally to the figures, a telehandler includes a charger housing defining a housing opening configured to receive a charging pod of the telehandler. The charger housing may be coupled to a side plate of a frame of the telehandler and be positioned behind a cabin of the telehandler. In some embodiments, the charger housing and the cabin may define a gap such that the charger housing is spaced from the cabin. A bottom surface of the charger housing may be configured to facilitate a portion of a tractive element of the telehandler to be positioned above a lowermost surface of the charger housing. The bottom surface may define a bottom channel aligned with a pin of a lift system of the telehandler such that the pin may be removed through the bottom channel of the charger housing. The charger housing may include a divider assembly configured to divide a housing opening of the charger housing into a high voltage portion and a low voltage portion. The high voltage portion may receive onboard chargers of the charging pod. The onboard chargers may be coupled between the side plate of the frame of the telehandler and the divider assembly.

Referring generally to the figures, a telehandler includes a charger housing defining a housing opening configured to receive a charging pod of the telehandler. The charging pod includes a charging connector configured to electrically couple to an external power source, at least one onboard charger electrically coupled to the charging connector configured to convert AC electrical energy received from the external power source to DC electrical energy, and a DC converter electrically coupled to the at least one onboard charger configured to convert a portion or all of the DC electrical energy outputted from the at least one onboard charger from a first voltage to a second voltage. The DC converter may supply the DC electrical energy at the second voltage to a battery of the telehandler, such as a low-voltage battery, to charge the battery. The onboard charger may also provide the DC electrical energy to another battery, such as a high-voltage battery. The charging pod may be alternated between a first configuration that includes one of the onboard chargers and a second configuration that includes two of the onboard chargers. In the second configuration, the charging pod may receive a higher input current and output a higher charging power than in the first configuration such that the battery may be charged at a faster rate when the charging pod is in the second configuration than when the charging pod is in the first configuration.

Referring generally to the figures, a telehandler includes a pair of onboard chargers that receive electrical energy from an external power source (e.g., a power grid, a generator, etc.) and provide the electrical energy for charging the high-voltage battery or operation of the telehandler. A first onboard charger of the pair (e.g., a primary onboard charger) acts with more authority and controls operation of a second onboard charger (e.g., a secondary onboard charger).

Referring generally to the figures, a telehandler includes a battery housing containing a battery and a variety of other components. An internal volume of the battery housing is divided into a battery area and a hydraulics area by a divider. The hydraulics area includes various hydraulic components that become heated during operation. Because the divider separates the hydraulic components from the battery, the divider prevents thermal energy from the hydraulic components from heating the battery. The housing defines a series of ventilation apertures in communication with the battery area. A set of fans draws in cool air through the ventilation apertures, cooling the battery. This air then passes through a set of radiators that are part of a coolant circuit. Accordingly, the fans contribute to both air cooling of the battery and operation of the coolant circuit.

Referring generally to the figures, embodiments described herein relate to systems and methods of active monitoring of high voltage (HV) circuit components using a low voltage (LV) circuit generated by a control module. In some embodiments, the LV signal is a DC signal at a specific magnitude. A constant LV DC signal may have limitations relating to detecting different types of errors within the circuit. To address these limitations, and to improve robustness and active monitoring capabilities of the circuit, the LV signal may be a DC pulsed rectangular waveform. The control module can include switches or other components capable of generating a DC waveform at a predetermined amplitude, magnitude (e.g., maximum value), frequency, DC offset, and/or duty cycle.

In some embodiments, the control module is configured to compare the generated LV rectangular wave to the returned LV rectangular wave. The control module may compare the generated rectangular wave to the returned rectangular wave based on any of amplitude, magnitude, frequency, DC offset, and/or duty cycle. Based on the comparison of the first and second rectangular wave, the control module may determine a potential cause of an error within the circuit. After determining the potential cause of the error, the control module may process sensor data of a plurality of sensors disposed within the circuit to determine a location of the error. The control module may be configured to adjust operation of the HV circuit components such that the error can be addressed.

Referring generally to the figures, a system architecture to provide temperature regulation for one or more battery cells of an electric vehicle is described herein. The system architecture may include control schemes to monitor the charging and discharging of the battery cells. For example, the system architecture can include a controller that receives data (e.g., temperature measurements, discharge rates, applied loads, etc.) from one or more sensors. The controller can determine or set power levels for the battery cells. For example, the battery cells may include an energy capacity level (e.g., watt-hours, kilowatt-hours, amp-hours, etc.) that dictates a maximum output (e.g., how much power and/or energy the battery cells can provide). The controller can cap or set a capacity level for the battery cells that is less than the energy capacity level (e.g., maximum capacity) of the battery cells.

Advantageously, the controller can reduce the temperature rise (e.g., limit an increase in temperature) of the battery cells such that the battery cells are able to return to an ambient temperature level and/or predetermined temperature without active cooling. For example, the battery cells can return to the ambient temperature level (e.g., an air temperature of an environment) or a setpoint temperature without having to use fans or coolant systems to reduce the temperature of the battery cells. As discussed, or described herein, an ambient temperature may refer to or include a temperature of one or more battery cells and/or a temperature within a housing or battery assembly that includes one or more battery cells.

Some technical solutions of the present disclosure include the oversizing or overfitting of one or more batteries for an electric vehicle. For example, an expected and/or predicted usage of the electric vehicle may correspond to a first amount of energy (e.g., a first amount of watt-hours, a first amount of joules per second, etc.). The electric vehicle can be outfitted with a battery that is larger (e.g., oversized) than the first amount of energy. For example, the first amount of energy may be 5 kilowatt-hours (e.g., 5 kilowatts consumed in one hour, 10 kilowatts consumed in 30 minutes, etc.). In this example, the electric vehicle can be outfitted with a battery that is oversized relative to an expected usage (e.g., average amount of power consumed, average duration of operation, etc.) of the electric vehicle.

As an example, if the expected usage of the electric vehicle is 5 kilowatts per hour (e.g., 5 kilowatt-hours) for a total of four hours, then the electric vehicle would consume a total of 20 kilowatt-hours. In this example, the electric vehicle can be outfitted with a battery that has a usable capacity of 25 kilowatt-hours. To continue this example, the oversizing of the battery can reduce the C-rate of the battery. By reducing the C-rate (e.g., discharge rate, charge rate, etc.), the temperature rise associated with operation of the battery will also be reduced.

The controller can predict or determine the expected usage of the electric vehicle by monitoring operation of the electric vehicle for a first amount of time (e.g., a number of hours, a number of days, a number of weeks, etc.). Additionally, or alternatively, the controller can predict the expected usage of the electric vehicle based on how the electric vehicle will be implemented. For example, the controller can predict the expected usage based on the electric vehicle being utilized at a construction site. As another example, the controller can predict the expected usage based on the electric vehicle being utilized by a utility company.

In some embodiments, nameplate capacity may refer to or include a maximum amount of electrical energy that a battery can store. For example, nameplate capacity may refer to a max kilowatt-hour value for a battery. In some embodiments, usable capacity may refer to or include an amount of energy that an application (e.g., load, consumption device, etc.) can access or receive. For example, the usable capacity can be 80% of a nameplate capacity for a battery. As another example, the usable capacity can be 95% of a nameplate capacity for a battery. In some embodiments, C-Rate may refer to or include a unit of measurement that indicates how quickly a battery can be charged or discharged, relative to the nameplate capacity of the battery. For example, a C-rate of 1C can indicate that a battery is completely charged or discharged in one hour. As another example, a C-rate of 0.5 can indicate that a battery is completed charged or discharged in two hours. Stated otherwise, and as described herein, C-rate may refer to or represent an amount of time fully charge or discharge one or more batteries. In some embodiments, a C-rate of 1C can correspond to a temperature rise of one or more degrees Celsius per unit of time. The temperature rise can be based on battery pack design, battery cell type, battery cell chemistry, or thermal management systems.

Referring generally to the figures, a system architecture to precondition one or more battery cells of an electric vehicle is described herein. The system architecture may include control schemes to monitor the state of charge or the ambient temperature of the one or more battery cells. For example, the system architecture may include a controller that receives information, from one or more sensors, corresponding to the battery cells. The information may include data such as, a state of charge of the battery cells, a Direct Current (DC) bus voltage, an ambient temperature of the battery cells, or other possible information associated with one or more states of the battery cells. As an example, the controller may receive information that indicates if the battery cells are in a Cell Under Voltage (CUV) condition. As another example, the controller may receive information that indicates if the temperature of the battery cells is a Cell Under Temperature (CUT) value.

In power distribution systems, a DC bus or DC link is often pre-charged prior to distribution of power by the power distribution system. The pre-charging of the DC bus may prevent an in-rush of current which otherwise results from a voltage difference between the DC bus a power supply (e.g., charger, power converter, battery cells, battery pack, etc.). The in-rush of current may damage or otherwise result in failure of power electronics. In other systems, the DC bus is often pre-charged using a battery included in the system. However, when the temperature of the battery or the state of charge of the battery drops below a given value, the battery is unable to pre-charge the DC bus.

Some technical solutions described herein include implementation of an onboard charger to pre-charge or precondition the DC bus of a power distribution system. For example, the onboard charger can pre-charge the DC bus to prevent the in-rush of current associated with a voltage difference between one or more batteries and the DC bus. Advantageously, the onboard charger can pre-charge the DC bus while the batteries are unavailable. For example, the onboard charger can pre-charge the DC bus while the cell temperature (of one or more battery cells) is at or below a threshold temperature for which the batteries may discharge power.

In some embodiments, as discussed in the present application, Cell Under Voltage (CUV) condition may refer to or include a voltage level that is below or less than a state of charge of zero (e.g., 0%). For example, an CUV condition may refer to an instance where the voltage level of a battery is 286 volts and an SoC of 0% equates to a voltage level of 302 volts. In some embodiments, as discussed in the present application, Cell Under Temperature (CUT) may refer to or include a minimum temperature value for which a battery may discharge power. For example, a CUT value may be −20 degrees Celsius (e.g., a battery may discharge power if the temperature is greater than or equal to −20 degrees Celsius). In some embodiments, a Cell Under Temperature for Charging (CUTC) may refer to or include a minimum temperature value for which a battery may be charged. For example, a CUTC value may be 0 degrees Celsius (e.g., a battery may be charged if the temperature is greater than or equal to 0 degrees Celsius). In some embodiments, as discussed in the present application, a State of Charge (SoC) may refer to or include a percentage that is indicative a current capacity of battery relative to a maximum capacity. For example, a SoC of 100% may represent a voltage level of 392 volts. As another example, a SoC of 0% may represent a voltage level of 297 volts. In some embodiments, as discussed in the present application, a DC bus may refer to or include a DC link, circuitry, or hardware to provide a voltage level across one or more terminals. In some embodiments, as discussed in the present application, a Vehicle Control Unit (VCU) may refer to or include circuitry, hardware, firmware, software, or executable code for which vehicle control logic is housed.

Referring generally to the figures, a telehandler includes a hydraulic system that provides priority to a steering function (e.g., one or more steering actuators), without requiring that a steering pump be run continuously during operation of the telehandler. According to an exemplary embodiment, the hydraulic system includes an accumulator in fluid communication with a steering line, which supplies fluid flow to a steering valve. The accumulator is configured to selectively supply fluid flow to the steering valve to ensure fluid flow in provided to the steering valve in response to a steering demand, without requiring that the steering pump be the primary source of fluid flow.

Referring generally to the figures, a telehandler includes a hydraulic system that controls operation of one or more implement functions (e.g., implement actuators or motors) and a steering function (e.g., a steering actuator or motor). The hydraulic system includes one or more switching valves that enables an implement pump, which is prioritized to providing fluid flow to the implement functions, to provide fluid flow to the steering function. The switching valves may also enable a steering pump, which is prioritized to providing fluid flow to the implement functions, to provide fluid flow to the implement functions. The switching valves add redundancy to the hydraulic system to ensure that each of the hydraulic functions may be supplied by multiple fluid sources.

Referring generally to the figures, a telehandler includes a hydraulic system that includes a back pressure valve on a return line in fluid communication with a reservoir. The back pressure valve is configured to generate a back pressure that is above a back pressure threshold so that fluid flow downstream of a filter is forced through a heat exchanger, prior to entering the reservoir, without the use of a pump or another powered device.

Referring generally to the figures, a telehandler includes a hydraulic system that is configured to generate electrical energy, for example, from one or more actuators retracting under the force of gravity and store the generated energy within a battery.

Referring generally to the figures, a telehandler includes a hydraulic system that controls operation of one or more implement functions (e.g., implement actuators or motors) and a steering function (e.g., a steering actuator or motor). The hydraulic system includes one or more switching valves that enables an implement pump, which is prioritized to providing fluid flow to the implement functions, to provide fluid flow to the steering function. The switching valves may also enable a steering pump, which is prioritized to providing fluid flow to the implement functions, to provide fluid flow to the implement functions. The switching valves add redundancy to the hydraulic system to ensure that each of the hydraulic functions may be supplied by multiple fluid sources.

Referring generally to the figures, a telehandler includes a frame and a battery configured to supply power to the telehandler. During operation of the telehandler, the frame may deform and sustain vibrations. In some telehandlers, the battery is rigidly mounted to the frame, causing deformation of and damage to the battery.

To counteract the deformation and vibrations from the frame, the telehandler includes a motor bracket, a battery bracket, and a plurality of tabs. The motor bracket, the battery bracket, and the tabs couple to the frame and the battery. The motor bracket and the battery bracket prevent movement of the battery towards or away from a surface that the telehandler traverses and restrict movement towards a rear or front of the telehandler. The tabs include rubber isolators that absorb vibrations from the frame. The tabs also allow for relative motion between the frame and the battery, preventing battery deformation. The tabs are coupled to the frame above the battery instead of below the battery, which further reduces vibrations transferred to the battery. The configuration of the motor bracket, the battery bracket, and the tabs also allows the battery to be contained within the limited space constraints of the battery housing and be mounted lower on the telehandler (e.g., closer to the surface the telehandler traverses, etc.).

In some embodiments, a telehandler includes a battery housing that contains portions of an electrical system including battery and a hydraulic system including a motor, an implement pump, and a steering pump. To efficiently utilized space within the battery housing, the telehandler includes a motor bracket including a lateral portion and a longitudinal portion. Components of the hydraulic system (e.g., pumps, control valves, an accumulator, etc.) are coupled to the motor bracket. Additionally, the motor bracket separates these hydraulic components from the battery. The separation provided by the motor bracket may reduce the potential for a leak of hydraulic fluid to place hydraulic oil in contact with electrical components, such as the battery. The motor bracket also inhibits thermal energy transfer between the hydraulic components and the battery. The separation of the motor bracket permits access to the hydraulic system without requiring direct access to the electrical components, permitting targeted repair of the hydraulic system or the battery. Additional brackets such as an accumulator bracket, a battery bracket, and a control valve bracket also allow for systems of the telehandler to be contained within the limited space of the battery housing while maintaining separation with the battery. Providing the hydraulic system along a vertical pump axis also facilitates a compact placement of the components within the battery housing.

Referring generally to the figures, a telehandler includes a chassis and a cabin coupled to the chassis and configured to support an operator within the cabin. The telehandler includes one or more components such as motors (e.g., drive motors, implement motors, etc.), chargers, current converters, pumps, actuators, among other components, that, during operation of the telehandler, generate thermal energy. The telehandler includes a cooling system configured to circulate a first volume of coolant between a radiator and these components to facilitate cooling the components (e.g., remove thermal energy therefrom and transfer the thermal energy to a surrounding atmosphere). The telehandler further includes an HVAC system including a heating circuit fluidly coupled with the cooling circuit. The heating circuit includes an electric resistance heater configured to add thermal energy to (e.g., heat) a second volume of coolant, a heat exchanger configured to remove thermal energy from (e.g., cool) the second volume of coolant, and a pump configured to drive the second volume of coolant between the heater and the heat exchanger. The HVAC system includes a fan configured to direct airflow across the heat exchanger and into the cabin to transfer thermal energy from the heat exchanger to the cabin to heat the cabin. The HVAC system further includes a refrigeration circuit including an evaporator configured to transfer thermal energy from a surrounding atmosphere to a refrigerant circulating through the refrigeration circuit via a conduit, an expansion valve fluidly coupled to the condenser via the conduit, a condenser positioned between the evaporator and the condenser and fluidly coupled to the expansion valve via the conduit, and a compressor fluidly coupled to and positioned between the evaporator and the condenser. The compressor is configured to drive the refrigerant within the conduit throughout the refrigeration circuit. The fan is configured to direct airflow across the evaporator and into the cabin to remove thermal energy from the cabin to cool the cabin. The refrigerant circuit includes a first charge port fluidly coupled with the conduit between the compressor and the condenser (e.g., at a high pressure side of the compressor), and a second charge port fluidly coupled with the conduit between the compressor and the evaporator (e.g., at a low pressure side of the compressor). The first and second charge ports configured to provide access to an interior volume defined by the conduit to monitor one or more characteristics of the refrigeration circuit such as the pressure within the conduit, a flow rate of the refrigerant, a level of the refrigerant, among other characteristics.

Referring generally to the figures, a telehandler includes a chassis and a cabin coupled to the chassis and configured to support an operator within the cabin. The telehandler includes a heating, ventilation, and air conditioning (HVAC) system configured to control a climate within the cabin. The HVAC system includes a refrigeration circuit including an evaporator configured to transfer thermal energy to a refrigerant, an expansion valve fluidly coupled to the evaporator by a conduit, a condenser fluidly coupled to the expansion valve by the conduit, the expansion valve positioned between the evaporator and the condenser, and a compressor fluidly coupled to and positioned between the evaporator and the condenser and configured to drive the refrigerant within the conduit. The HVAC system further includes a heater configured to transfer thermal energy to a surrounding atmosphere. In some embodiments, the heater is configured to directly heat air surrounding the heater. In other embodiments, the heater is configured to add thermal energy to (e.g., heat) coolant, a heat exchanger is configured to remove thermal energy from (e.g., cool) the coolant, and a pump is configured to drive the coolant between the heater and the heat exchanger. The HVAC system includes a fan configured to direct airflow across (i) the evaporator and into the cabin to remove thermal energy from the cabin to cool the cabin or (ii) the heater/heat exchanger and into the cabin to add thermal energy to the cabin to heat the cabin. The telehandler may include a user interface including an air conditioning switch configured to receive an input from an operator regarding a state of the compressor (e.g., to power the compressor “on” or “off”), a temperature switch configured to receive an input from the operator regarding a temperature of the cabin, and a fan switch configured to receive an input from the operator regarding a speed of the fan. The air conditioning switch, temperature switch, and fan switch may be in communication with a controller configured to control operation of the HVAC system. As such, the air conditioning switch, temperature switch, and fan switch facilitate operator control over the HVAC system. In some embodiments, the controller is configured to stop operation of the compressor (e.g., power the compressor “off”) responsive to the input from the operator to the temperature switch being indicative of a temperature of the cabin that exceeds a threshold temperature. Powering the compressor “off” when the temperature indicated by the temperature switch is greater than the threshold temperature helps to extend the charge duration of the batteries of the telehandler by avoiding unnecessary use of the compressor beyond what is needed (e.g., to clear frost, ice, and/or fog from the cabin).

Referring generally to the figures, a thermal management system including at least two cooling fans for an air-cooled heat exchanger is shown, according to at least one exemplary embodiment. The thermal management system is configured to control operations of the fans independently from one another to vary the air flow provided to the heat exchanger based on operating conditions, such as fluid temperature, heat load, and other conditions associated with the thermal performance of the heat exchanger. According to an exemplary embodiment, the thermal management system is configured to provide continuously variable flow rate control (e.g., between a minimum and a maximum operating speed of the at least two fans) by ramping the operating speed of only one of the fans responsive to changes in operating conditions, and while operating the other fan at one of two fixed conditions. Beneficially, such an arrangement can enable continuously variable flow rate control while eliminating the need for multiple fan speed controllers and/or processing circuits to control the operating speed of each individual fan.

Referring generally to the figures, a cooling pack assembly for cooling hydraulic and electrical equipment onboard a telehandler is shown, according to at least one exemplary embodiment. The cooling pack assembly includes a heat exchanger assembly having heat exchanger cores for both a hydraulic fluid cooling circuit and an electronic equipment cooling circuit. The heat exchanger cores are arranged alongside one another so that liquid flows in substantially the same direction through each of the heat exchanger cores. The cooling pack assembly also includes a fan assembly having fans that are shared between each of the heat exchanger cores. In some embodiments, the fan assembly includes a pair of fans that each extend laterally across an upper face of each of the heat exchanger cores in an approximately hashtag profile when viewed from above so that each of the fans cools an approximately one-half portion of the pair of heat exchanger cores. Beneficially, such an arrangement can reduce hardware requirements and system complexity for both the hydraulic and electrical equipment cooling systems.

Referring generally to the figures, a telehandler includes a controller that is configured to transition into a shutdown sequence. The controller may be configured to initiate the shutdown sequence in response to receiving an input from a user interface. The controller may also be configured to initiate the shutdown sequence in response to a failure within one of the systems of the telehandler.

Referring generally to the figures, a telehandler includes a controller that is configured to transition between drive, steer, and brake commands. The drive, steer, and brake commands may be initiated in response to the controller receiving an input from a user interface, such as an input from an operator of the telehandler.

Referring generally to the figures, a telehandler includes a motor and a battery. The motor and battery are configured to provide power to the telehandler to operate the functions of the telehandler. During operation, the motor and battery may experience changes in power and temperature, which may undesirably impact the function of the telehandler.

To counteract an operator experiencing the adverse effects of these changes in power and/or temperature, the telehandler includes a display. The display includes a series of indicators, the indicators configured to provide an operator with a series of warnings and indications of the current state of operation of the telehandler.

Referring generally to the figures, an electric telehandler includes an onboard battery that supplies electrical energy to power a drive motor and various implement functions. The electric telehandler may equipped with a removable auxiliary power unit (APU) that supplies electrical energy to power functions of the telehandler and/or charge the battery of the telehandler. The electrical energy from the APU may be used to extend the range of the electric telehandler, increase the power output of the electric telehandler, to run accessories, to precondition one or more components of the electric telehandler, or to perform other functions. In some embodiments, the APU is a generator including an engine that consumes fuel to drive a generator and produce the electrical energy. In such an embodiment, the electric telehandler may be considered a hybrid telehandler when the APU is attached. In other embodiments, the APU includes a supplemental battery that stores energy (e.g., chemically) and supplies the stored energy as electrical energy.

### Overall Machine

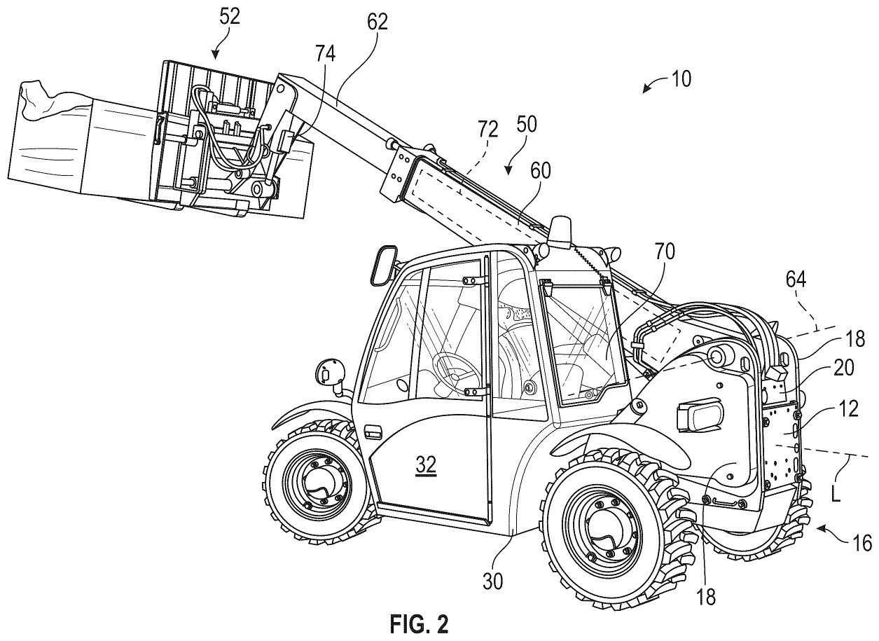

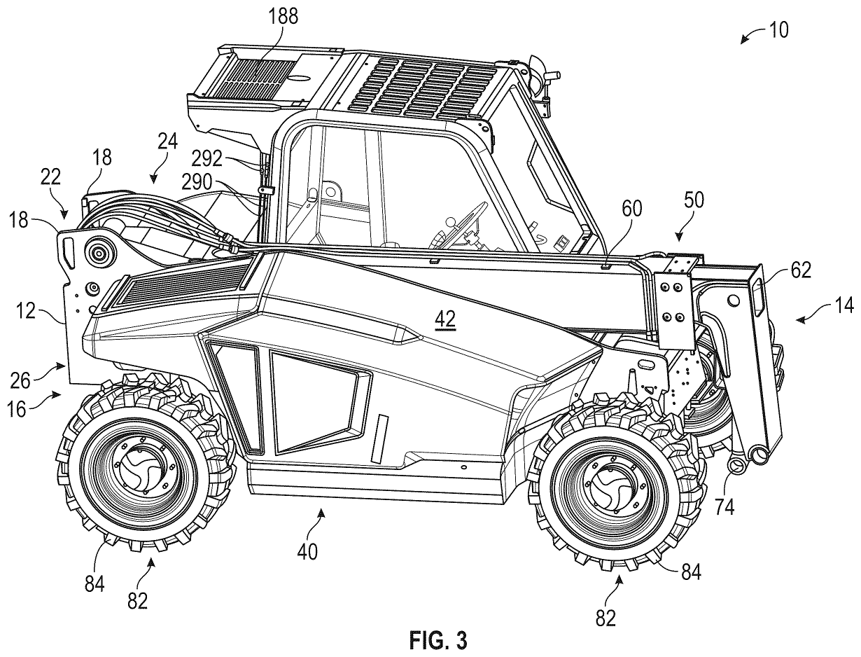

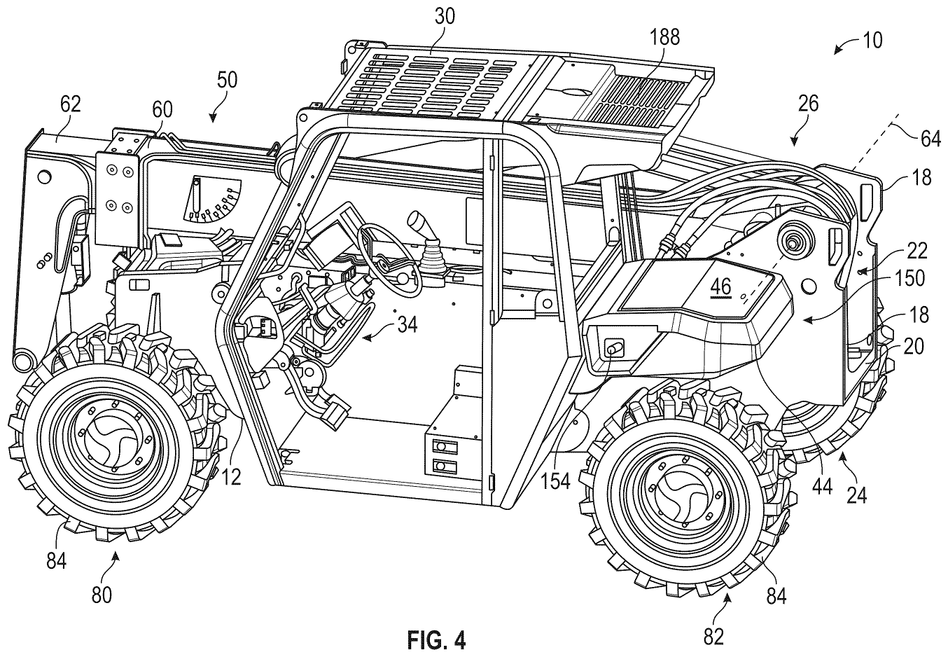

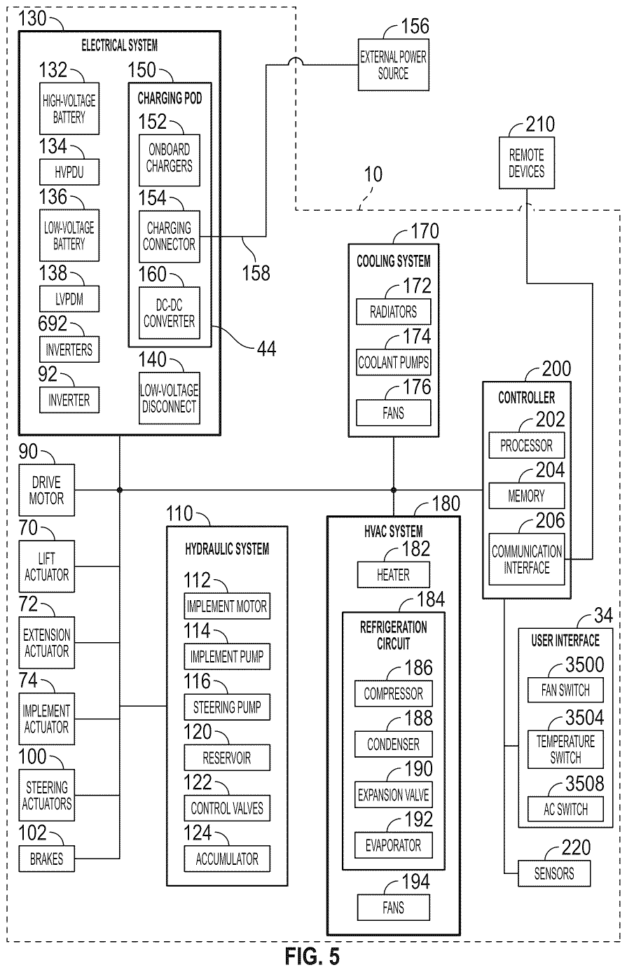

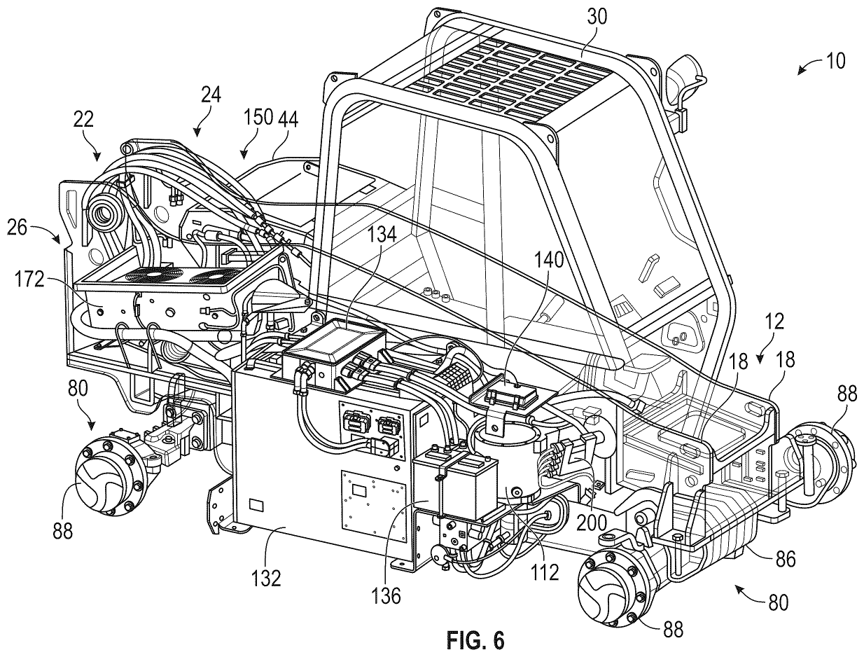

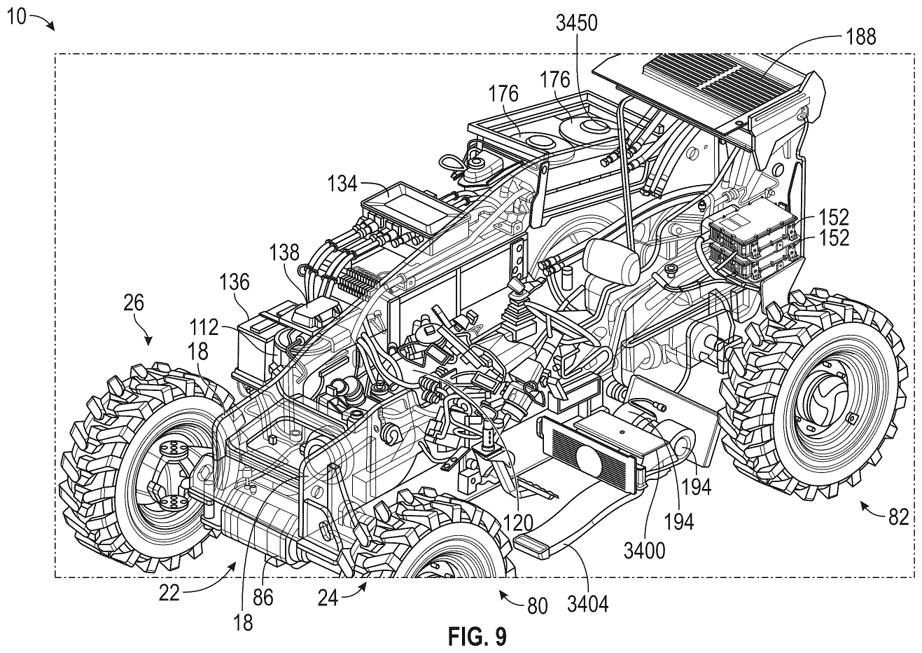

Referring to FIGS. 1-18, a vehicle or work machine (e.g., a lift device) is shown as telehandler 10 according to an exemplary embodiment. FIGS. 1 and 2 illustrate the telehandler 10 in an operating configuration. FIGS. 3 and 4 illustrate the telehandler 10 with certain components omitted for ease of illustration. FIG. 5 schematically illustrates the telehandler 10. FIGS. 6-18 illustrate the telehandler 10 with certain components omitted and other components shown as being transparent for ease of illustration.

In other embodiments, the telehandler 10 is another type of lift device, such as a boom lift, an aerial work platform, a scissor lift, a vertical lift, a compact crawler boom, a forklift, a crane, a bucket truck, or another type of lift device. In yet other embodiments, the telehandler 10 is another type of vehicle or work machine, such as a military vehicle, a cement truck, a refuse vehicle, a fire apparatus (e.g., a fire truck including a deployable ladder, an aircraft rescue and firefighting truck, etc.), a tow truck, a dumper (e.g., a powered dumper), or another type of vehicle or work machine. By way of example, a boom lift may include a similar hydraulic system 110 to the telehandler 10.

As shown in FIGS. 1-4, the telehandler 10 includes a chassis, shown as frame assembly 12, that supports the other components of the telehandler 10. The frame assembly 12 extends lengthwise along a longitudinal central axis, shown longitudinal axis L, between a front end 14 and a rear end 16 of the frame assembly 12. The frame assembly 12 includes a pair of longitudinal frame members, shown as side plates 18, and one or more lateral frame members or connecting members, shown as cross members 20. The side plates 18 each extend longitudinally and vertically and are laterally offset from one another. The longitudinal axis L is positioned between the side plates 18. In some embodiments, the side plates 18 are equidistant from the longitudinal axis L. The cross members 20 extend laterally between the side plates 18, fixedly coupling the side plates to one another.

The side plates 18 of the frame assembly 12 divide the telehandler 10 into a series of volumes, areas, or sections. A first volume, section, or area, shown as central area 22, is positioned between the side plates 18. The central area 22 extends laterally between the side plates 18, and the longitudinal axis L extends through the central area 22. A second volume, section, or area (e.g., a left side area), shown as cabin area 24, is positioned outside of the side plates 18. The cabin area 24 is bounded on one side by a first side plate 18 and extends in a first lateral direction (e.g., left) from the first side plate 18. A third volume, section, or area (e.g., a right side area), shown as battery area 26, is positioned outside of the side plates 18. The battery area 26 is bounded on one side by a second side plate 18 and extends in a second lateral direction (e.g., right) from the second side plate 18.

The telehandler 10 includes an enclosure or cab, shown as cabin 30, that is sized to house an operator of the telehandler 10. The cabin 30 may include a seat to support the operator. The cabin 30 is fixedly coupled to the frame assembly 12 and positioned in the cabin area 24. The cabin 30 includes a door 32 positioned to facilitate selective access into an internal volume of the cabin 30 (e.g., an operator compartment). The door 32 is located on the lateral side of the cabin 30 opposite the frame assembly 12.

The telehandler 10 further includes an input and/or output device or operator interface, shown as user interface 34, positioned within the cabin 30. The user interface 34 may provide information to the operator and/or receive commands from the operator. As shown, the user interface 34 includes a steering wheel, a series of pedals (e.g., a brake pedal and an accelerator pedal), a joystick, switches, knobs, and a display. In other embodiments, the user interface 34 includes more or fewer interface devices. Additionally or alternatively, the user interface 34 may be included as part of a user device (e.g., a smartphone, a tablet, a laptop computer, a desktop computer, etc.) to facilitate remote control over the telehandler 10.

A first enclosure or housing, shown as battery housing 40, is fixedly coupled to the frame assembly 12. The battery housing 40 is positioned in the battery area 26, opposite the cabin 30. A front end of the battery housing 40 may be extended to the same longitudinal position as a front end of the cabin 30. The battery housing 40 includes a repositionable door or panel, shown as door 42, that is pivotably coupled to the frame assembly 12. The door 42 may be raised and lowered to selectively permit access to an inner volume of the battery housing 40. The battery housing 40 contains first components of the telehandler 10 (e.g., the implement motor 112, the implement pump 114, the steering pump 116, the control valves 122, the high-voltage battery 132, the HVPDU 134, the low-voltage battery 136, the LVPDM 138, the low-voltage disconnect 140, the radiators 172, the coolant pumps 174, the fans 176, the controller 200, etc., described hereinafter).

A second enclosure, shown as charger housing 44, is fixedly coupled to the frame assembly 12. The charger housing 44 is positioned in the cabin area 24 and rearward of the cabin 30. The charger housing 44 may engage or contact a rear wall of the cabin 30. The charger housing 44 includes a repositionable door or panel, shown as door 46, that is pivotably coupled to the frame assembly 12. The door 46 may be raised and lowered to selectively permit access to an inner volume of the charger housing 44. The charger housing 44 contains first components of the telehandler 10 (e.g., the onboard chargers 152, the wall adapter 158, etc.).

The telehandler 10 includes a lift assembly, shown as boom assembly 50, having a proximal end that is pivotably coupled to the frame assembly 12 near the rear end 16. The boom assembly 50 is positioned in the central area 22, between the side plates 18. The boom assembly 50 is approximately laterally centered on the longitudinal centerline L. In one embodiment, the longitudinal axis L and a centerline of the boom assembly 50 are disposed within a common plane (e.g., when the boom assembly 50 is stowed, during movement of the boom assembly 50, etc.).

A distal end of the boom assembly 50 supports a tool or manipulator, shown as implement 52. The implement 52 may be any type of mechanism used to support, grab, or otherwise interact with the payload. As shown, the implement 52 includes a pair of lift forks. The implement 52 may be interchangeable with any type of implement including forks (e.g., pallet forks, bale forks, etc.), a bucket, a grapple or grab (e.g., a bale grab, a log grab, a shear grab, a grab for use in combination with a bucket, etc.), a boom (e.g., a boom supporting a cable used to manipulate roof trusses), an auger, a concrete bucket, or another type of implement or manipulator. The telehandler 10 may permit an operator to control the wheels 84 and the boom assembly 50 from within the cabin 30 to manipulate (e.g., move, carry, lift, transfer, etc.) a payload (e.g., pallets, building materials, earth, grain, etc.).

Referring still to FIGS. 1-4, the boom assembly 50 is a telescoping assembly including a series of boom sections that translate relative to one another to vary an overall length of the boom assembly 50. The boom assembly 50 includes a base boom section or base boom 60 and a distal boom section or fly boom section shown as fly boom 62. The base boom 60 is pivotably coupled to the frame assembly 12 and pivotable relative to the frame assembly 12 about a lateral axis, shown as axis of rotation 64. The axis of rotation 64 is positioned near the rear end 16 and passes through both of the side plates 18. The fly boom 62 is received within the base boom 60 and slidable relative to the base boom 60. In some embodiments, the boom assembly 50 includes one or more middle boom sections that couple the base boom 60 and the fly boom 62 and permit further extension of the boom assembly 50.

The boom assembly 50 and the implement are articulated (e.g., selectively repositioned) by a series of actuators, including a first actuator, shown as lift actuator 70, a second actuator, shown as extension actuator 72, and a third actuator, shown as implement actuator 74. The actuators may control the boom assembly 50 to lift or otherwise manipulate various loads. As shown, the actuators are hydraulic cylinders that extend and retract linearly. In such embodiments, the hydraulic cylinders each include a body that defines an interior volume and receives a shaft. A piston is connected to the shaft and engages an interior surface of the body, dividing the interior volume of the body into a pair of chambers. Pressurized hydraulic fluid may be supplied to each of the chambers to selectively expand or contract the hydraulic cylinder. The hydraulic cylinders may include bosses, clevises, or other features to facilitate interfacing with other components (e.g., the frame assembly 12, the boom sections, the implement 52, etc.). In other embodiments, the actuators are another type of linear actuator (e.g., electrical, pneumatic, etc.) or are rotary actuators.

The lift actuator 70 is coupled to the frame assembly 12 and the base boom 60. The lift actuator 70 may raise and/or lower the boom assembly 50 by rotating the base boom 60 about the axis of rotation 64. The extension actuator 72 is coupled to the base boom 60 and the fly boom 62. The extension actuator 72 may vary the length of the boom assembly 50 by causing the fly boom 62 to translate relative to the base boom 60. The implement actuator 74 is coupled to the implement 52 and the fly boom 62. The implement actuator 74 may pivot the implement 52 relative to the fly boom 62 about a lateral axis of rotation.

The telehandler 10 includes a pair of tractive, propulsion, steering, or axle assemblies, shown as front axle assembly 80 and rear axle assembly 82, each coupled to the frame assembly 12. The front axle assembly 80 and the rear axle assembly 82 each include a pair of tractive assemblies (e.g., wheel and tire assemblies), shown as wheels 84, that support the telehandler 10. The front axle assembly 80 and the rear axle assembly 82 may drive the wheels 84 to steer and/or propel the telehandler 10.

The front axle assembly 80 and the rear axle assembly 82 are each positioned beneath the frame assembly 12 and extend laterally through the central area 22, the cabin area 24, and the battery area 26. The front axle assembly 80 is offset longitudinally forward of the rear axle assembly 82. The front axle assembly 80 and the rear axle assembly 82 each include a first wheel 84 (e.g., a left wheel) positioned within the cabin area 24 and a second wheel 84 positioned within the battery area 26. The cabin 30 extends between the wheels 84 of the cabin area 24. The battery housing 40 extends between the wheels 84 of the battery area 26. The charger housing 44 is positioned directly above a wheel 84 of the rear axle assembly 82.

Referring to FIGS. 5-7, 10, 11, and 14, the front axle assembly 80 and the rear axle assembly 82 each include a power transmission, shown as differential 86, and a pair of shafts, shown as half axles 88. Each half axle 88 transfers rotational mechanical energy between the differential 86 and one of the wheels 84. By transferring rotational mechanical energy to the wheels 84, the half axles 88 may drive rotation of the wheels 84 about respective horizontal axes to propel the telehandler 10.

The telehandler 10 includes a primary driver, shown as drive motor 90. As shown, the drive motor 90 is an alternating current (AC) electric motor that supplies rotational mechanical energy in response to receiving AC electrical energy. As shown, the drive motor 90 includes a power converter, shown as inverter 92, that is positioned along a side of a body of the drive motor 90. The inverter 92 may convert direct current (DC) electrical energy to AC electrical energy, which is subsequently used by the drive motor 90. In other embodiments, the drive motor 90 is a DC electrical motor. In yet other embodiments, the telehandler 10 includes another type of primary driver (e.g., in addition to or in place of the drive motor 90). By way of example, the telehandler 10 may include an internal combustion engine (e.g., a gasoline engine, a diesel engine, etc.). In some embodiments, the internal combustion engine drives the front axle assembly 80 and/or the rear axle assembly 82 directly. In other embodiments, the internal combustion engine drives a generator that produces electrical energy to power the drive motor 90 (e.g., as a hybrid drive).

An output shaft of the drive motor 90 is coupled to the front axle assembly 80 and the rear axle assembly 82 through a power transmission (e.g., a gearbox), shown as transmission 94. The transmission 94 is coupled to a front end of the drive motor 90, such that the transmission 94 is positioned forward of the drive motor 90. As shown, the transmission 94 is directly coupled to the differential 86 of the front axle assembly 80. The transmission 94 is coupled to the differential 86 of the rear axle assembly 82 by a shaft, shown as driveshaft 96. The driveshaft 96 extends longitudinally between the front axle assembly 80 and the rear axle assembly 82 below the frame assembly 12. The transmission 94 may introduce an offset such that the drive motor 90 is positioned above the differentials 86 and the driveshaft 96.

During operation, the inverter 92 receives DC electrical energy and supplies AC electrical energy to the drive motor 90. The drive motor 90 provides rotational mechanical energy to the transmission 94. The transmission 94 directly drives the differential 86 of the front axle assembly 80, which in turn drives the wheels 84 of the front axle assembly 80 through the half axles 88. The transmission 94 drives the differential 86 of the rear axle assembly 82 through the driveshaft 96. The differential 86 of the rear axle assembly 82 in turn drives the wheels 84 of the rear axle assembly 82 through the half axles 88. Accordingly, the drive motor 90 drives the front axle assembly 80 and the rear axle assembly 82 to propel the telehandler 10. This flow of rotational mechanical energy may be executed in reverse order to perform regenerative braking using the drive motor 90.

As shown in FIGS. 5 and 14, the front axle assembly 80 and the rear axle assembly 82 each include an actuator, shown as steering actuator 100. In some embodiments, the steering actuators 100 are hydraulic cylinders (e.g., hydraulic linear actuators). The steering actuator 100 of the front axle assembly 80 is coupled to wheels 84 of the front axle assembly 80. The steering actuator 100 of the rear axle assembly 82 is coupled to wheels 84 of the rear axle assembly 82. Each steering actuator 100 may rotate the corresponding wheels 84 to facilitate steering the telehandler 10. Specifically, the steering actuators 100 may cause each wheel 84 to rotate about a corresponding vertical axis to steer the telehandler 10.

The front axle assembly 80 and the rear axle assembly 82 each include one or more braking systems, shown as brakes 102. The brakes 102 may be selectively engaged to oppose rotation of the wheels 84 and slow the telehandler 10 to a stop. In some embodiments, the brakes 102 are friction brakes (e.g., disc brakes, drum brakes, etc.).

Referring to FIGS. 5, 6, and 10-16, the telehandler 10 includes a hydraulic system 110 that facilitates operation of the lift actuator 70, the extension actuator 72, the implement actuator 74, and the steering actuators 100. The hydraulic system 110 includes a driver or electric motor, shown as implement motor 112, having an output coupled to a pair of pumps, shown as implement pump 114 and steering pump 116. In some embodiments, the implement motor 112 is an AC electric motor, and the implement motor 112 includes an inverter that converts DC electrical energy (e.g., from the HVPDU 134) to AC electrical energy for the electric motor. The implement motor 112 is configured to provide rotational mechanical energy to drive the implement pump 114 and the steering pump 116. In some embodiments, one or more clutches selectively couple the implement pump 114 and the steering pump 116 to the implement motor 112 to permit selective operation of the implement pump 114 and the steering pump 116. In other embodiments, each of the implement pump 114 and the steering pump 116 are driven by separate motors.

The hydraulic system 110 further includes a low-pressure sink, vessel, or tank, shown as reservoir 120. The reservoir 120 may store hydraulic fluid at a low pressure for use throughout the hydraulic system 110. The reservoir 120 is fluidly coupled to the implement pump 114 and the steering pump 116. The implement pump 114 and the steering pump 116 may draw fluid at a low pressure from the reservoir 120 and deliver the fluid at an elevated pressure.

The hydraulic system 110 further includes one or more flow control elements, shown as control valves 122. The control valves 122 are fluidly coupled to the other components of the hydraulic system 110. The control valves 122 are configured to control the flow of hydraulic fluid between (a) the implement pump 114 and the steering pump 116 and (b) the lift actuator 70, the extension actuator 72, the implement actuator 74, and the steering actuators 100.

The implement motor 112, the implement pump 114, the steering pump 116, and the control valves 122 are fixedly coupled to the frame assembly 12. The reservoir 120 is positioned between the side plates 18 and within the central area 22. The reservoir 120 is positioned rearward of the drive motor 90. The implement motor 112, the implement pump 114, the steering pump 116, and a first subset of the control valves 122 are positioned within the battery area 26. Specifically, the implement motor 112, the implement pump 114, the steering pump 116, and the first subset of the control valves 122 are contained within the battery housing 40 and between the front axle assembly 80 and the rear axle assembly 82. A second subset of the control valves 122 are positioned within the central area 22 near the rear end 16.

During operation, the implement motor 112 provides rotational mechanical energy to drive the implement pump 114 and the steering pump 116. The implement pump 114 draws hydraulic fluid from the reservoir 120 and provides a first pressurized flow of the hydraulic fluid to the control valves 122. Based on the desired operation of the boom assembly 50, the control valves 122 direct the first pressurized flow of the hydraulic fluid to one or more of the lift actuator 70, the extension actuator 72, or the implement actuator 74 to move the boom assembly 50 and the implement 52. The steering pump 116 draws hydraulic fluid from the reservoir 120 and provides a second pressurized flow of the hydraulic fluid to the control valves 122. Based on the desired steering of the telehandler 10, the control valves 122 direct the second pressurized flow of the hydraulic fluid to one or both of the steering actuators 100 to reposition the wheels 84.

The hydraulic system 110 further includes an energy storage device or pressure vessel (e.g., a bladder accumulator, a piston accumulator, etc.), shown as accumulator 124, in fluid communication with the control valves 122. The accumulator 124 may be charged to store a volume of the pressurized hydraulic fluid. The accumulator 124 may be discharged to dispense the pressurized hydraulic fluid back to the control valves 122. The accumulator 124 may smooth momentary changes in pressure (e.g., due to demand for hydraulic fluid when one of the pumps is not operating).

Referring to FIGS. 5, 12, and 13, the telehandler 10 includes an electrical energy system or power system, shown as electrical system 130. The electrical system 130 is configured to supply electrical energy to power one or more functions of the telehandler 10. The electrical system 130 may receive, store, generate, and/or distribute electrical energy throughout the telehandler 10.

The electrical system 130 includes an energy storage device or battery pack, shown as high-voltage battery 132, fixedly coupled to the frame assembly 12. The high-voltage battery 132 may include a single battery module or pack or multiple battery modules or packs electrically coupled to one another. The high-voltage battery 132 may store and provide electrical energy to power other components of the telehandler 10. The high-voltage battery 132 may provide direct current (DC) electrical energy at a relatively high voltage (e.g., 400V). The high-voltage battery 132 is electrically coupled to a power distribution unit or high-voltage bus, shown as high-voltage power distribution unit (HVPDU) 134. The HVPDU 134 distributes high-voltage electrical energy throughout the telehandler 10 (e.g., to or from the high-voltage battery 132). By way of example, the HVPDU 134 may distribute electrical energy from the high-voltage battery 132 to the drive motor 90 and the implement motor 112.

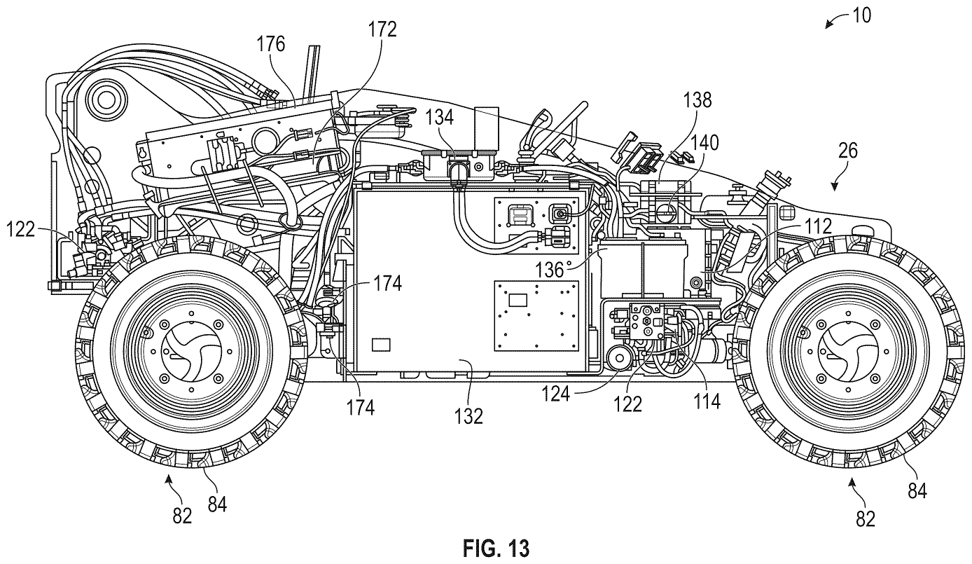

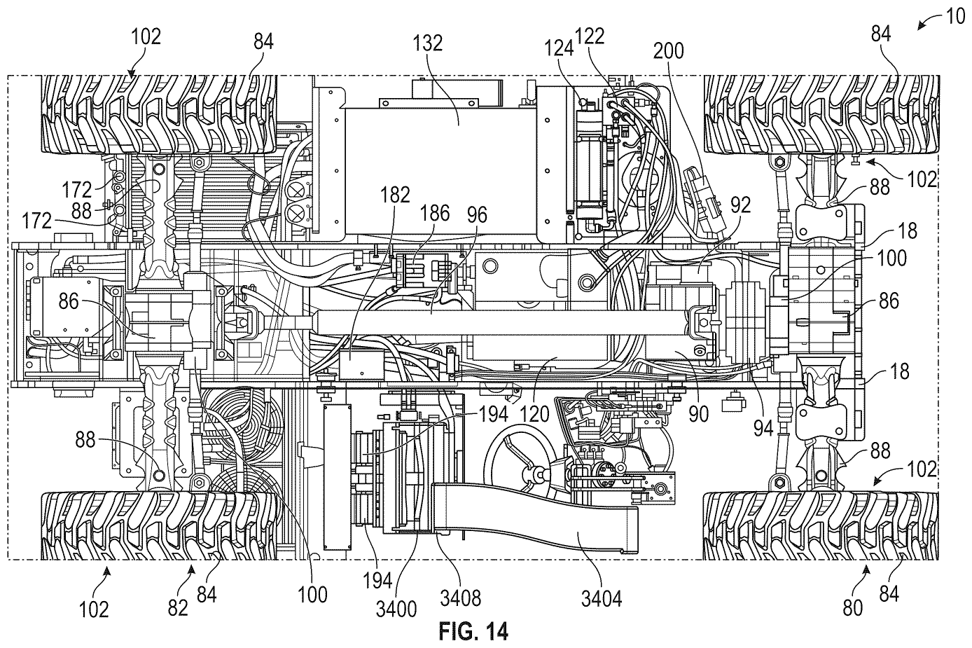

As shown in FIG. 13, the high-voltage battery 132 is positioned along one of the side plates 18 and within the battery area 26. Specifically, the high-voltage battery 132 is positioned within the battery housing 40. The high-voltage battery 132 is positioned between the front axle assembly 80 and the rear axle assembly 82. The high-voltage battery 132 is positioned rearward of the implement motor 112, the implement pump 114, the steering pump 116, and the first subset of the control valves 122. The HVPDU 134 is positioned atop the high-voltage battery 132 and within the battery housing 40.

The electrical system 130 further includes an energy storage device or battery pack, shown as low-voltage battery 136, fixedly coupled to the frame assembly 12. The low-voltage battery 136 may include a single battery module or pack or multiple battery modules or packs electrically coupled to one another. The low-voltage battery 136 may store and provide electrical energy to power other components of the telehandler 10. The low-voltage battery 136 may provide direct current (DC) electrical energy at a relatively low voltage (e.g., 12V). The low-voltage battery 136 is electrically coupled to a power distribution unit or low-voltage bus, shown as low-voltage power distribution module (LVPDM) 138. The LVPDM 138 distributes low-voltage electrical energy throughout the telehandler 10 (e.g., to or from the low-voltage battery 136). By way of example, the HVPDU 134 may distribute electrical energy from the low-voltage battery 136 to the controller 200.

The electrical system 130 further includes a switch, contactor, or electrical disconnect, shown as low-voltage disconnect 140. The low-voltage disconnect 140 is electrically coupled to the low-voltage battery 136. The low-voltage disconnect 140 is selectively reconfigurable between a closed or “on” configuration and an open or “off” configuration. In the “on” configuration, the low-voltage disconnect 140 electrically couples the low-voltage battery 136 to other components of the telehandler 10. In the “off” configuration, the low-voltage disconnect 140 electrically disconnects or isolates the low-voltage battery 136.

As shown in FIGS. 3, 12, and 13, the low-voltage battery 136 is positioned within the battery area 26. Specifically, the low-voltage battery 136 is positioned within the battery housing 40. The low-voltage battery 136 is positioned forward of the HVPDU 134 and laterally outward of the implement motor 112. The low-voltage battery 136 is positioned between the front axle assembly 80 and the rear axle assembly 82. The LVPDM 138 and the low-voltage disconnect 140 are positioned directly above the implement motor 112.

Referring to FIGS. 4, 5, 7-9, and 18, the telehandler 10 further includes a charging module or charging assembly, shown as charging pod 150. The charging pod 150 may receive and distribute electrical energy to charge the high-voltage battery 132 and/or the low-voltage battery 136. The charging pod 150 is supported by and at least partially contained within the charger housing 44.

The charging pod 150 includes one or more chargers or power converters, shown as onboard chargers 152, electrically coupled to a power inlet, port, or electrical connector, shown as charging connector 154. The charging connector 154 may be selectively electrically coupled to source of electrical energy outside of the telehandler 10, shown as external power source 156. Specifically, the charging connector 154 may be electrically coupled to the external power source 156 through a connector, cable, harness, or charging adapter, shown as wall adapter 158.

The external power source 156 may be any source of electrical energy outside of the telehandler 10. By way of example, the external power source 156 may be a connection to a power grid (e.g., a wall outlet). By way of another example, the external power source 156 may be a generator (e.g., a gasoline or diesel generator). By way of another example, the external power source 156 may be a solar panel, a battery bank, a fuel cell, or another source of electrical energy. In some embodiments, the wall adapter 158 electrically couples the charging connector 154 to multiple external power sources 156.

During a charging operation, the external power source 156 provides electrical energy to the onboard chargers 152 through the wall adapter 158 and the charging connector 154. The onboard chargers 152 may exchange signals (e.g., data communication) with the external power source 156 to initiate and control the transfer of electrical energy. The onboard chargers 152 may modify, condition, or otherwise convert the electrical energy for use within the telehandler 10. By way of example, the external power source 156 may provide electrical energy at 120V AC or 240V AC, and the onboard chargers 152 may convert the electrical energy to DC electrical energy at a desired voltage for charging the high-voltage battery 132 and/or operating the high-voltage components of the telehandler 10 (e.g., between 260V and 480V). The onboard chargers 152 may provide the converted electrical energy to the HVPDU 134 for distribution throughout the high-voltage circuit.

The charging pod 150 further includes a power converter or DC to DC converter, shown as DC/DC converter 160. The DC/DC converter 160 may receive DC electrical energy at a first voltage (e.g., a high voltage) and convert the energy to DC electrical energy at a second voltage (e.g., a low voltage). Similarly, the DC/DC converter 160 may receive DC electrical energy at the second voltage (e.g., the low voltage) and convert the energy to DC electrical energy at the first voltage (e.g., the high voltage). The DC/DC converter 160 may permit energy communication between the high-voltage and low-voltage portions of the electrical system 130. By way of example, the DC/DC converter 160 may convert high-voltage electrical energy from the high-voltage battery 132 to low-voltage electrical energy to charge the low-voltage battery 136.

As shown in FIGS. 5, 7, and 18, the onboard chargers 152 and the DC/DC converter 160 are contained within the charger housing 44. The onboard chargers 152 may be accessible by opening the door 46. The charging connector 154 is positioned along an outer surface of the charger housing 44. The charging connector 154 faces laterally outward, away from the frame assembly 12.

As shown in FIGS. 5, 6, 9, 12, 13, and 15, the telehandler 10 includes a thermal management system, shown as cooling system 170. The cooling system 170 may receive thermal energy generated throughout operation of the telehandler 10 (e.g., by the drive motor 90 and the implement motor 112) and reject the thermal energy to the surrounding atmosphere. Accordingly, the cooling system 170 may manage (e.g., reduce, etc.) the temperatures of the components of the telehandler 10 to maintain the temperatures within corresponding desired ranges.

The cooling system 170 includes one or more heat exchangers, shown as radiators 172, that each cool a fluid. The radiators 172 may be in fluid communication with one or more components of the telehandler 10 that generate thermal energy. The first radiator 172 may have a large surface area (e.g., formed by fins) to facilitate transferring thermal energy to the surrounding atmosphere.

The cooling system 170 may include a first radiator 172 in fluid communication with the hydraulic system 110. Hydraulic oil from the hydraulic system 110 may pass through the first radiator 172 (e.g., under power of the implement pump 114 and/or the steering pump 116), such that the first radiator 172 cools the hydraulic oil. The cooling system 170 may include a second radiator 172 in fluid communication with a coolant circuit. Coolant may be circulated between the second radiator 172 and one or more components of the telehandler 10 to remove thermal energy produced during operation of those components. The cooling system 170 includes one or more coolant pumps 174 that drive the circulation of the coolant throughout the cooling circuit. The components cooled by the cooling circuit may include the drive motor 90, the implement motor 112, the onboard chargers 152, the DC/DC converter 160, and/or other components of the telehandler 10.

The cooling system 170 further includes one or more fans 176. The fans 176 may be electric fans (e.g., powered by low-voltage electrical energy). The fans 176 are positioned to direct airflow through the radiators 172 and increase the transfer of thermal energy from the radiators 172 to the surrounding atmosphere.

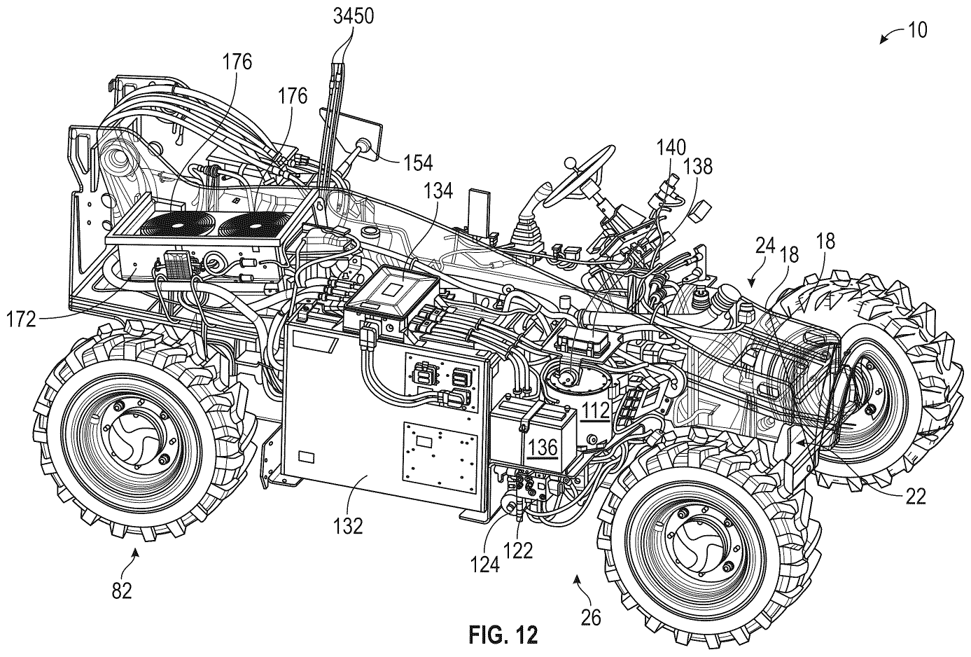

Referring to FIGS. 3 and 12, the radiators 172 are positioned within the battery area 26. Specifically, the radiators 172 are positioned within the battery housing 40. The radiators 172 are positioned rearward of the high-voltage battery 132 and directly above the rear axle assembly 82. The fans 176 are coupled to the radiators 172 and positioned above the radiators 172. Accordingly, the fans 176 direct airflow upward through the radiators 172 and away from the telehandler 10. The coolant pumps 174 are coupled to the high-voltage battery 132. The coolant pumps 174 are positioned below the radiators 172 and between the high-voltage battery 132 and the rear axle assembly 82.

Referring to FIGS. 5, 9, and 14, the telehandler 10 further includes a heating, ventilation, and air-conditioning (HVAC) system, climate control system, heating system, or air conditioning system, shown as HVAC system 180. The HVAC system 180 may heat and/or cool the air within the cabin 30 to facilitate comfortable operation of the telehandler 10 by an operator positioned within the cabin 30. The heating and/or cooling operations of the HVAC system 180 may be specified (e.g., set) by the operator (e.g., using the user interface 34).

The HVAC system 180 includes a thermal energy generator, shown as heater 182. The heater 182 is electrically coupled to the HVPDU 134. The heater 182 may generate thermal energy to heat the cabin 30 in response to receiving electrical energy from the HVPDU 134. In some embodiments, the heater 182 is positioned to heat a portion of the coolant from the cooling system 170, and the heated coolant transfers thermal energy into the cabin 30.

The HVAC system 180 further includes a cooling system or air conditioning circuit, shown as refrigeration circuit 184. The refrigeration circuit 184 may remove thermal energy from the air within the cabin 30 to cool the cabin 30. The refrigeration circuit 184 may reject the removed thermal energy into the atmosphere outside of the cabin 30.

A refrigerant may flow throughout the refrigeration circuit 184 to perform the cooling. The refrigeration circuit 184 includes a compressor 186 that compresses the refrigerant. The compressor 186 may be electrically coupled to the HVPDU 134. The compressor 186 may receive electrical energy from the HVPDU 134 to power an electric motor within the compressor 186. In some embodiments, the electric motor within the compressor 186 is an AC electric motor, and the compressor 186 includes an inverter that converts DC electrical energy from the HVPDU 134 to AC electrical energy for the electric motor.

The refrigeration circuit 184 further includes a heat exchanger or radiator, shown as condenser 188, that is fluidly coupled to an outlet of the compressor 186. The condenser 188 is positioned to transfer thermal energy from the refrigerant to the surrounding atmosphere outside of the cabin 30. The refrigeration circuit 184 further includes a flow control element, shown as expansion valve 190, fluidly coupled to an outlet of the condenser 188. As the refrigerant passes through the expansion valve 190, the refrigerant is permitted to expand. This process decreases the temperature of the refrigerant.

The refrigeration circuit 184 further includes a heat exchanger, shown as evaporator 192, that is fluidly coupled to an outlet of the expansion valve 190 and an inlet of the compressor 186. The evaporator 192 is positioned in fluid communication with the cabin 30 such that the evaporator 192 receives thermal energy from the cabin 30. By way of example, air from the cabin 30 may pass through the evaporator 192 and transfer thermal energy into the refrigerant within the evaporator 192. Refrigerant exiting the evaporator 192 then returns to an inlet of the compressor 186. Accordingly, the refrigeration circuit 184 circulates refrigerant to cool the cabin 30.

The HVAC system 180 further includes one or more fans 194. The fans 194 may be electric fans (e.g., powered by low-voltage electrical energy). The fans 194 are positioned to direct airflow across the heater 182 to heat the air within the cabin 30 and to direct airflow across the evaporator 192 to cool the air within the cabin 30.

Referring to FIGS. 5, 7, 9, and 14, the HVAC system 180 is coupled to the frame assembly 12 at various locations throughout the telehandler 10. The heater 182 is positioned within the central area 22 and coupled to the side plate 18 that is closest to the cabin 30. The heater 182 is positioned rearward of the reservoir 120. The compressor 186 is positioned within the central area 22 and coupled to the side plate 18 that is farthest from the cabin 30. The compressor 186 is positioned rearward of the reservoir 120 and forward of the heater 182. The condenser 188 is coupled to the cabin 30. The condenser 188 is positioned outside of the cabin 30, rearward of the cabin 30, and at a top end of the cabin 30. The evaporator 192 and the fans 194 are coupled to the cabin 30. Specifically, the evaporator 192 and the fans 194 are positioned within the cabin 30 and along a floor of the cabin 30.

Referring to FIG. 5, the telehandler 10 includes a control system configured to control the operation of the telehandler 10. The control system includes a controller 200 including a processor 202 and a memory 204. The processor 202 may issue commands to and process information from other components. The processor 202 may be implemented as a specific purpose processor, an application specific integrated circuit (ASIC), one or more field programmable gate arrays (FPGAs), a group of processing components, or other suitable electronic processing components. The memory 204 may include one or more devices (e.g., RAM, ROM, flash memory, hard disk storage) for storing data and computer code for completing and facilitating the various user or client processes, layers, and modules described in the present disclosure. The memory 204 may be or include volatile memory or non-volatile memory and may include database components, object code components, script components, or any other type of information structure for supporting the various activities and information structures of the inventive concepts disclosed herein. The memory 204 may be communicably connected to the processor 202 and include computer code or instruction modules for executing one or more processes described herein.

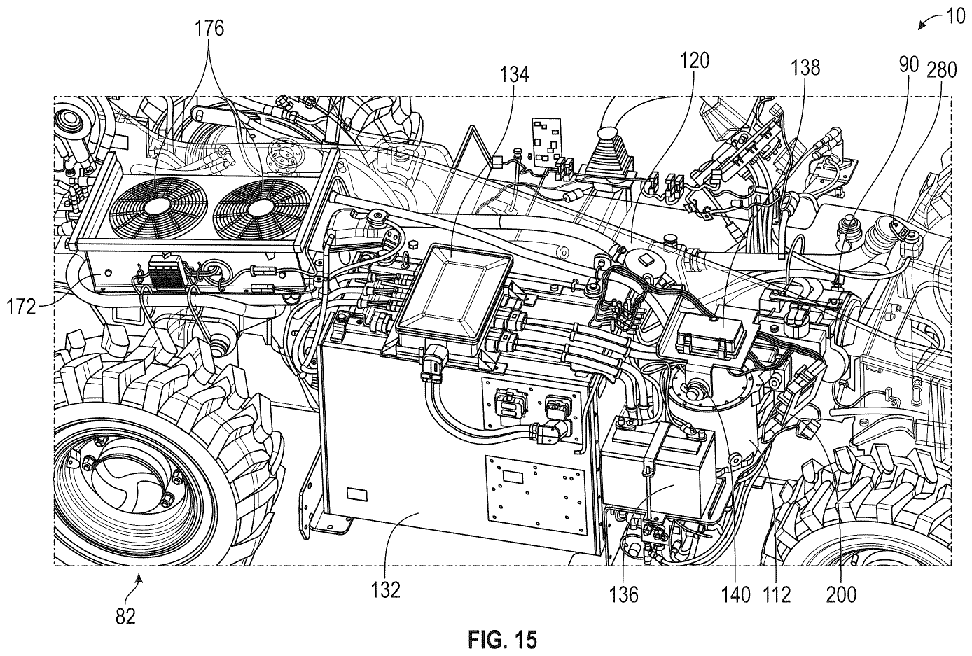

As shown in FIG. 15, the controller 200 is coupled to the frame assembly 12. As shown, the controller 200 is positioned within the battery area 26. Specifically, the controller 200 is positioned within the battery housing 40. The controller 200 is positioned forward of the implement motor 112. In other embodiments, the controller 200 is otherwise positioned.

In some embodiments, the telehandler 10 includes a single controller 200. In other embodiments, the telehandler 10 includes multiple controllers 200. Any functions described as being performed by the controller 200 may be distributed across multiple controllers 200 and/or one or more devices outside of the telehandler 10 (e.g., the remote devices 210). By way of example, one or more components of the telehandler 10 (e.g., the HVPDU 134, the drive motor 90, etc.) may include dedicated controllers 200 in communication with a primary controller 200.

Referring again to FIG. 5, the controller 200 further includes an interface (e.g., a network interface, a wireless connection, a wired connection, etc.), shown as communication interface 206. The communication interface 206 may facilitate communication between the controller 200 and one or more devices outside of the telehandler 10, shown as remote devices 210. The communication interface 206 may facilitate communication over a wired connection and/or a wireless connection (e.g., a cellular connection, an Internet connection, a Bluetooth® connection, a Wi-Fi® connection, etc.). The remote devices 210 may include user devices (e.g., smartphones, tablets, laptop computers, desktop computers, wearable devices, etc.). The remote devices 210 may include servers (e.g., onsite or remote servers). The remote devices 210 may include other vehicles (e.g., another telehandler 10) or other jobsite equipment.

As shown in FIG. 5, the controller 200 is operatively coupled to other components of the telehandler 10 and the remote devices 210. The controller 200 may control operation of one or more components of the telehandler 10 and/or the remote devices 210. By way of example, the controller 200 may (e.g., directly or indirectly, through the application of one or more control signals, etc.) control the operation of the user interface 34, the lift actuator 70, the extension actuator 72, the implement actuator 74, the steering actuators 100, the brakes 102, the hydraulic system 110 (e.g., the implement motor 112, the implement pump 114, the steering pump 116, the control valves 122, etc.), the electrical system 130 (e.g., the high-voltage battery 132, the HVPDU 134, the low-voltage battery 136, the LVPDM 138, the onboard chargers 152, the DC/DC converter 160, etc.), the external power source 156, the cooling system 170 (e.g., the radiators 172, the fans 176, etc.), the HVAC system 180 (e.g., the heater 182, the compressor 186, the fans 194, etc.), other components of the telehandler 10, and/or components outside of the telehandler 10 (e.g., the remote devices 210).

The controller 200 may receive information from various sources, and the controller 200 may vary operation of the telehandler 10 based on the received information. The controller 200 may receive information (e.g., commands) from the user interface 34 in response to a user interaction. The controller 200 may receive information from the remote devices 210.

In some embodiments, the telehandler 10 includes one or more sensors or transducers, shown as sensors 220, that provide information to the controller 200. By way of example, the sensors 220 may include temperature sensors, load cells, pressure sensors, inertial measurement units, gyroscopes, accelerometers, potentiometers, encoders, and/or other types of sensors.

### Alternative Telehandler Configuration

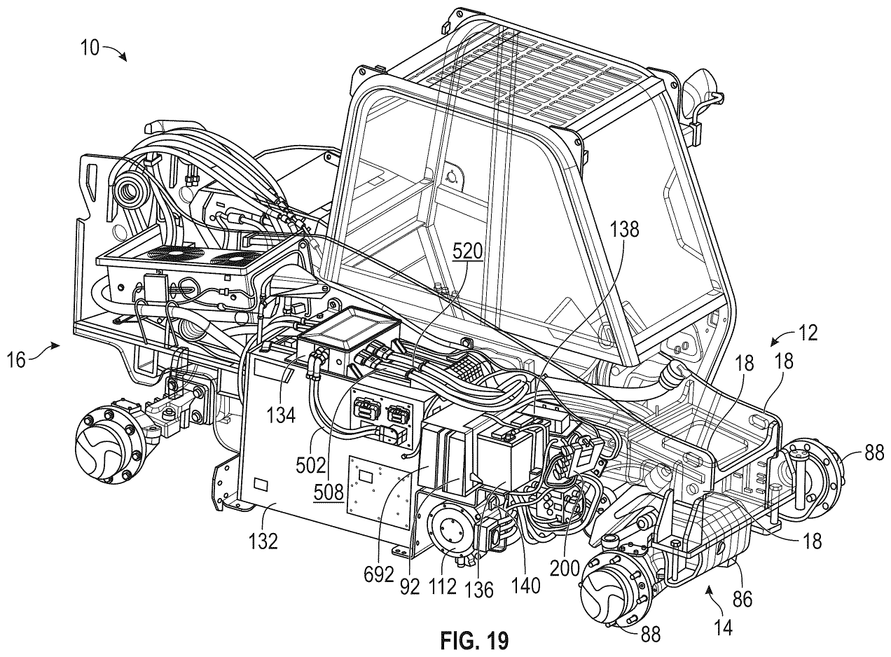

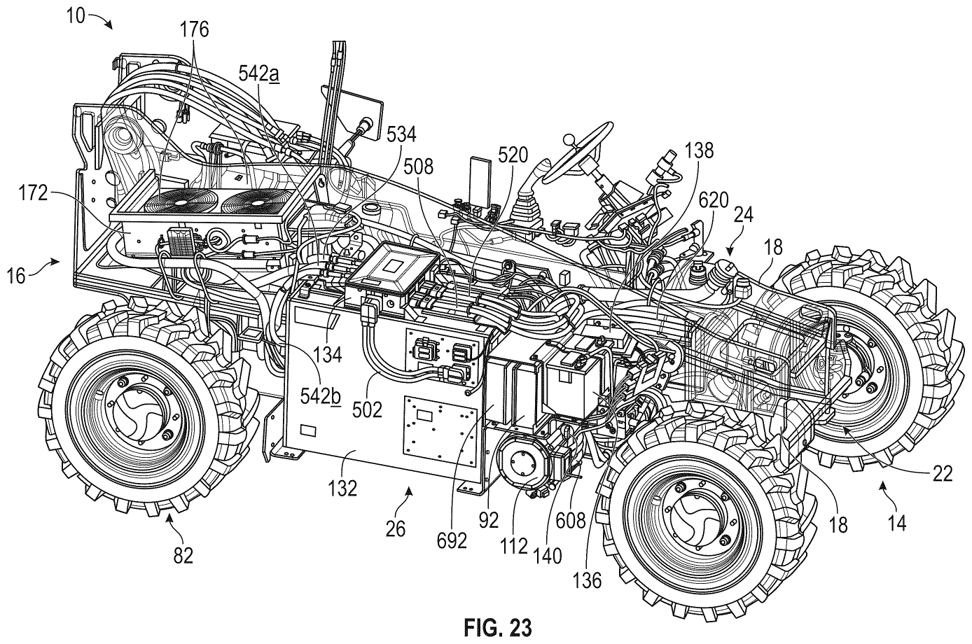

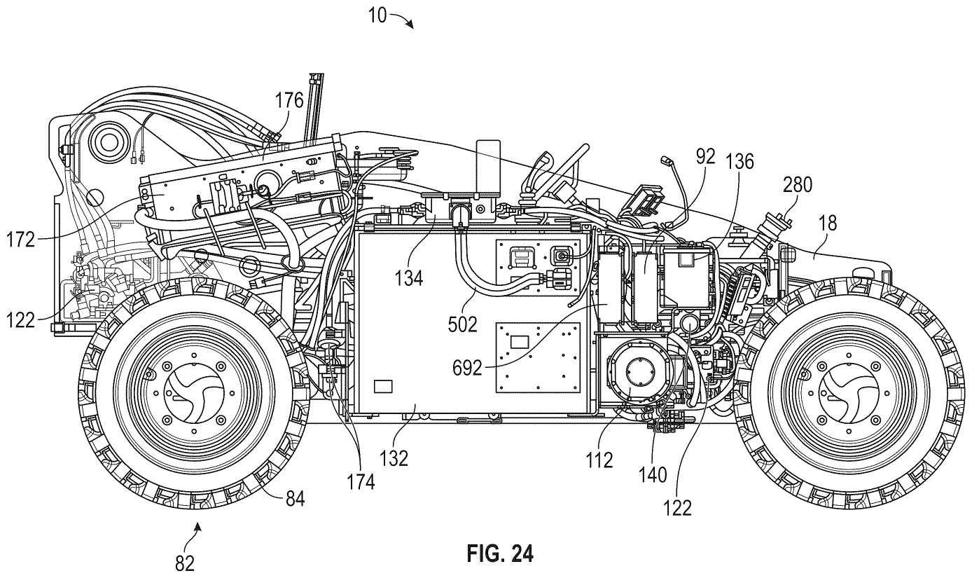

Referring to FIGS. 19-28, the telehandler 10 is shown according to an alternative embodiment. The telehandler 10 of FIGS. 19-28 may be substantially similar to the telehandler 10 of FIGS. 1-18 except as otherwise specified. Accordingly, and description of the telehandler 10 of FIGS. 1-18 may apply to the telehandler 10 of FIGS. 19-28 except as otherwise specified.

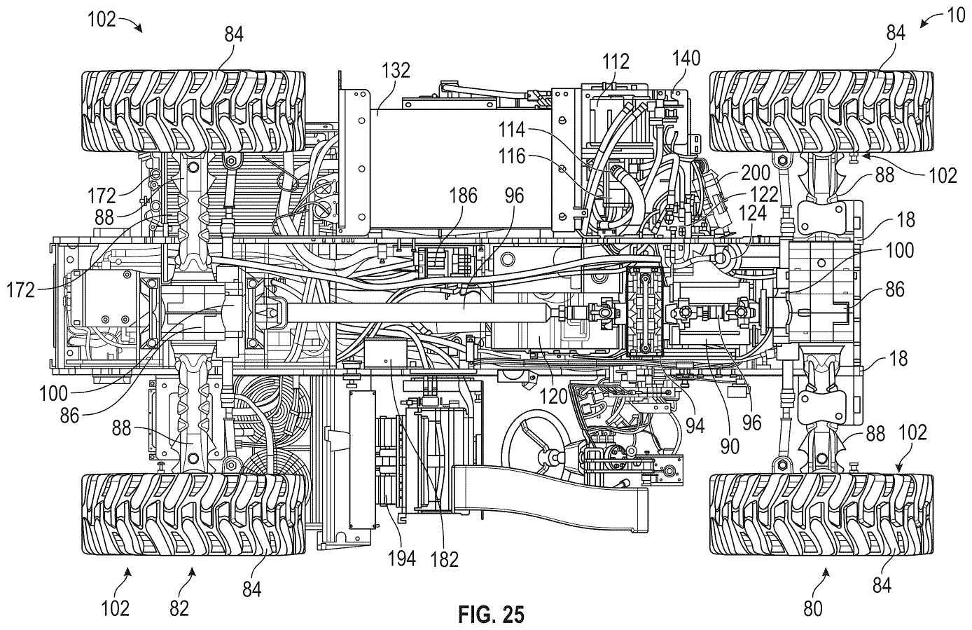

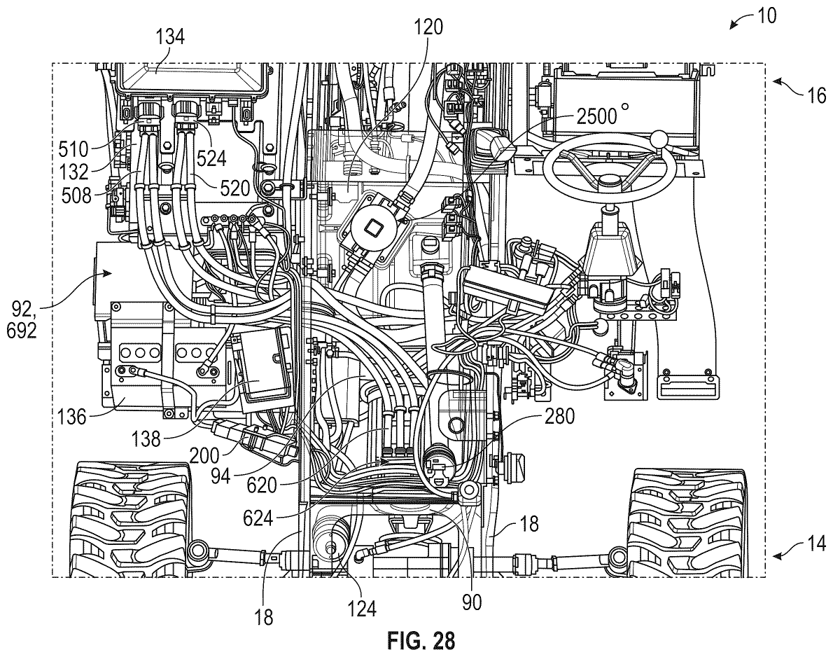

As shown in FIGS. 25 and 28, the drive motor 90 is inverted such that the output shaft of the drive motor 90 extends rearward, and the transmission 94 is positioned rearward of the drive motor 90. This offsets the transmission 94 relative to the differential 86 of the front axle assembly 80. To accommodate this arrangement, a first driveshaft 96 extends forward from the transmission 94 to the differential 86 of the front axle assembly 80. A second driveshaft 96 extends rearward from the transmission 94 to the differential 86 of the rear axle assembly 82.

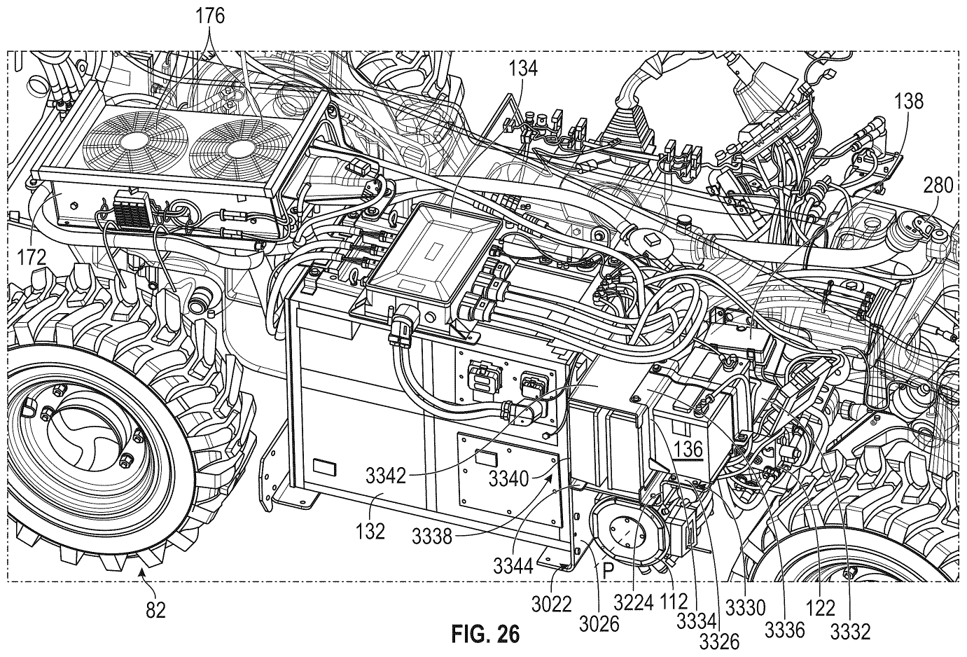

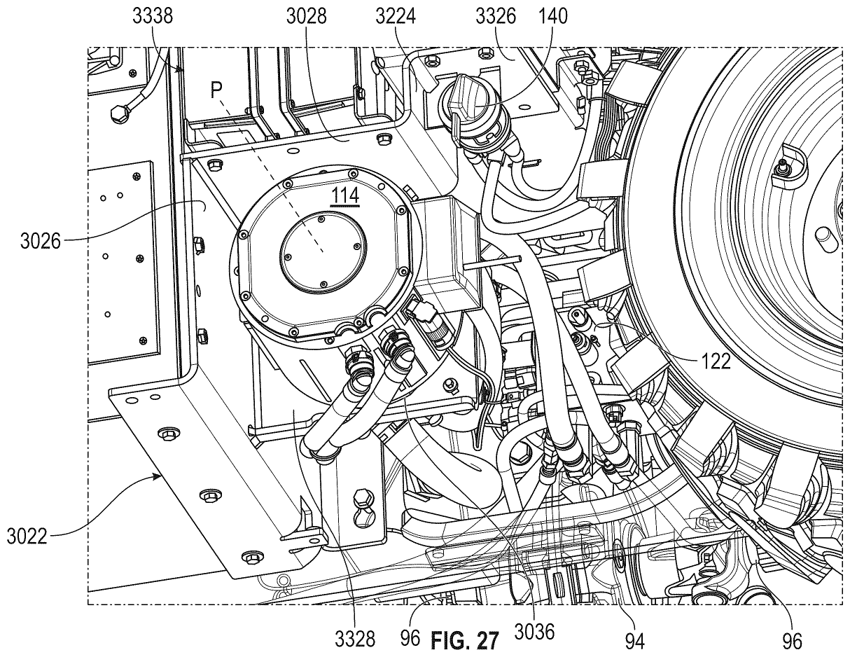

As shown in FIG. 26, the inverter 92 is separated from the drive motor 90, and the inverter of the implement motor 112 is separated from the implement motor 112 and shown as second inverter 692. The inverter 92 and the second inverter 692 are coupled to the high-voltage battery 132 (e.g., by a shelf or bracket). The second inverter 692 is positioned forward of the high-voltage battery 132, and the inverter 92 is positioned forward of the second inverter 692. Accordingly, both the second inverter 692 and the inverter 92 are positioned within the battery area 26.

The low-voltage battery 136 is positioned forward of the inverter 92 and laterally outward from the LVPDM 138. The low-voltage disconnect 140 is positioned beneath the low-voltage battery 136. The low-voltage battery 136, the LVPDM 138, and the low-voltage disconnect 140 are positioned within the battery area 26.

As shown in FIGS. 25-27, the implement motor 112, the implement pump 114, and the steering pump 116 are positioned beneath the inverter 92 and the second inverter 692. The implement motor 112 is oriented such that an output shaft of the implement motor 112 is centered about a pump axis P that extends longitudinally. The implement pump 114 and the steering pump 116 are positioned laterally inward of the implement motor 112 and centered about the pump axis P. A set of control valves 122 are positioned beneath the low-voltage battery 136 and longitudinally forward of the steering pump 116. Accordingly, the implement motor 112, the implement pump 114, the steering pump 116, and the control valves 122 are all positioned within the battery area 26.

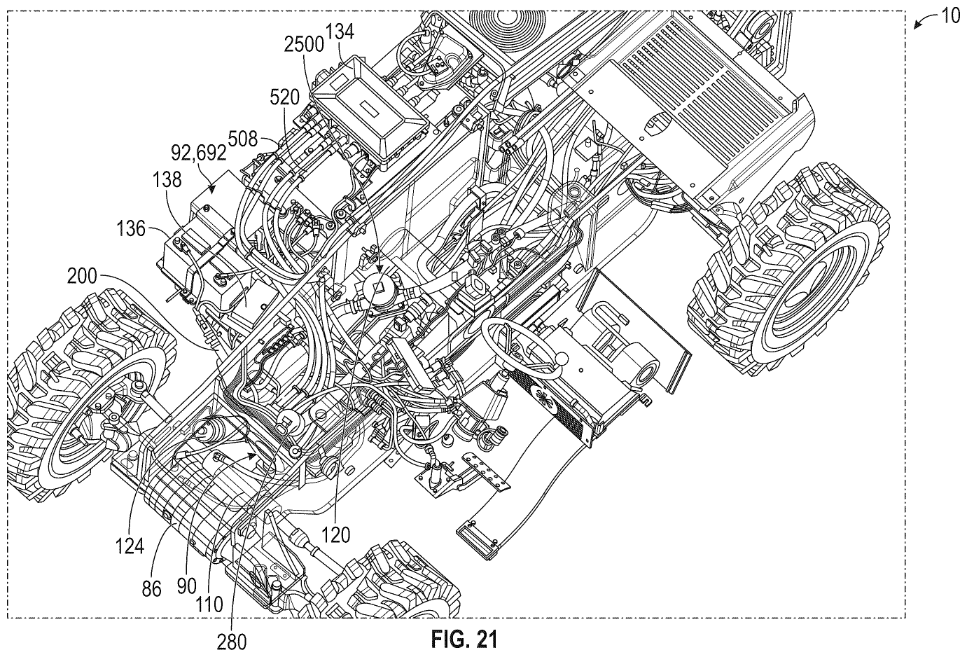

As shown in FIGS. 21, 22, and 28, the accumulator 124 is positioned within between the side plates 18. The accumulator 124 may be fixedly coupled to one of the side plates 18. The accumulator 124 is positioned near a front end of the frame assembly 12, such that the steering actuators 100 extends beneath the accumulator 124. Accordingly, the accumulator 124 is positioned within the central area 22.

### Operator and Maintenance Touchpoints

The telehandler 10 may include various components, connections, or interfaces that serve as touchpoints (e.g., interface locations, points of interaction, etc.) for a user. An operator of the telehandler 10 may regularly interact with these touchpoints to perform various actions during normal operation of the telehandler 10. By way of example, the charging connector 154 may serve as a touchpoint that the operator interacts with each time the telehandler 10 is charged. Maintenance personnel may interact with a different set of touchpoints to perform regular maintenance and troubleshooting. By way of example, the touchpoints may include ports for adding or removing fluids, access points for checking and replacing fuses, and ports through which fluid may be added or removed. Throughout the telehandler 10, these touchpoints have been located in places that are intuitive for the user and offer direct access, improving the user experience in operating and maintaining the telehandler 10.

Referring to FIGS. 4, 5, 7, 29, and 30, the charging connector 154 is positioned to be accessed by an operator of the telehandler 10 when the telehandler 10 requires charging. The charging connector 154 may serve as a connection point for a wall adapter 158 that connects the electrical system 130 to an external power source 156. After operating the telehandler 10 for a period of time and depleting the high-voltage battery 132, the operator may choose to halt operation of the telehandler 10 and charge the high-voltage battery 132. The operator may navigate the telehandler 10 to a location nearby the external power source 156, exit the cabin 30, and connect the wall adapter 158 with the charging connector 154 to initiate charging. In some embodiments, the wall adapter 158 is a removable cable that is stored within the charger housing 44 and transported with the telehandler 10. In such an embodiment, the operator may also connect the wall adapter 158 with the external power source 156 (e.g., before or after connecting the wall adapter 158 to the charging connector 154).

As shown, the charging connector 154 is positioned within the cabin area 24. Specifically, the charging connector 154 is fixedly coupled to the battery housing 40. The battery housing 40 defines a recess or inset area, shown as connector recess 230, that extends laterally inward from an outer surface 232 of the battery housing 40. The connector recess 230, the outer surface 232, and the charging connector 154 all face laterally outward, away from the side plates 18. By positioning the charging connector 154 within the connector recess 230, the charging connector 154 may be shielded from unintentional contact with other objects by the outer surface 232. By way of example, a shovel or other elongated object that falls toward the charger housing 44 would contact the outer surface 232 on opposite sides of the connector recess 230, preventing the object from extending into the connector recess 230 and contacting the charging connector 154. When preparing for charging, a user may align the wall adapter 158 with the charging connector 154 and insert the wall adapter 158 into the connector recess 230, such that placing the charging connector 154 within the connector recess 230 does not have a negative impact on the user experience when charging.

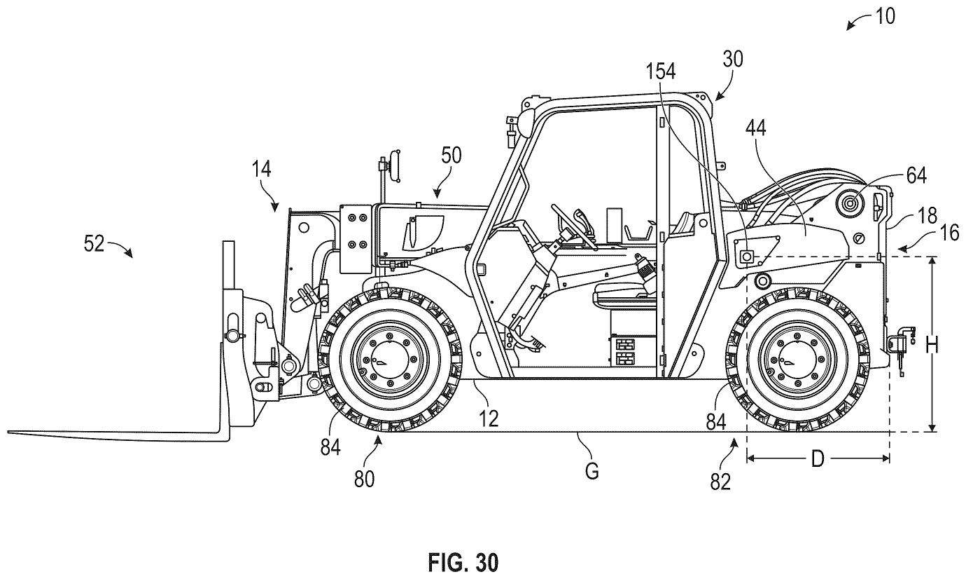

The position of the charging connector 154 within the cabin area 24 is illustrated in FIG. 30. As shown in FIG. 30, the charging connector 154 has a first dimension, shown as height H, that extends between a ground surface G and the charging connector 154. The height H measures the vertical offset distance between the ground surface G and the charging connector 154 when the ground surface G is level and contacted by all four of the wheels 84. Accordingly, the height H may represent a vertical height of the charging connector 154.

The charging connector 154 has a second dimension or longitudinal position, shown as depth D, that extends between the rear end 16 of the frame assembly 12 and the charging connector 154. The depth D measures a longitudinal offset distance between a rearmost portion of the frame assembly 12 and the charging connector 154. Accordingly, the depth D may represent a longitudinal position of the charging connector 154.

The height H and the depth D may be selected to place the charging connector 154 in a specific location relative to other components of the telehandler 10. As shown, the charging connector 154 is positioned immediately rearward of the cabin 30. The charging connector 154 is accordingly positioned rearward of the operator's position when the operator is within the cabin 30. The charging connector 154 is positioned rearward of the door 32 of the cabin 30. The charging connector 154 is positioned above the left wheel 84 of the rear axle assembly 82. The charging connector 154 is positioned forward of the axis of rotation of the wheels 84 of the rear axle assembly 82. The charging connector 154 is positioned forward of the axis of rotation 64 of the boom assembly 50 and below the axis of rotation 64.

In some embodiments, the height H of the charging connector 154 is selected for an optimized user experience (e.g., to optimize ergonomics for a user interacting with the charging connector 154). In some embodiments, the height H is approximately 1015 mm (40.0 in). In some embodiments, the height H is within 100 mm (3.9 in) of 1015 mm (40 in) (e.g., 1015 mm±100 mm (3.9 in); 1015 mm±75 mm (3.0 in); 1015 mm±50 mm (2.0 in); 1015 mm±25 mm (1.0 in)). This placement may facilitate a user interacting with the charging connector 154 (e.g., to connect the wall adapter 158) in a comfortable position. A height H below this range may require the user to bend over to interact with the charging connector 154. A height H above this range may make the charging connector 154 less accessible to shorter users (e.g., requiring such users to raise their arm to an uncomfortable position).

In some embodiments, the depth D of the charging connector 154 is selected for an optimized user experience. In some embodiments, the depth D is approximately 820 mm (32.3 in). In some embodiments, the height H is within 100 mm (3.9 in) of 820 mm (32.3 in) (e.g., 820 mm±100 mm (3.9 in); 820 mm±75 mm (3.0 in); 820 mm±50 mm (2.0 in); 820 mm±25 mm (1.0 in)). The longitudinal length of the frame assembly 12 from the front end 14 to the rear end 16 may be approximately 128.0 in. This placement may locate the charging connector 154 immediately behind the cabin 30. Accordingly, a user exiting the cabin 30 may immediately access the charging connector 154 without having to walk around the telehandler 10. When initiating a charging session, the user may exit the cabin 30 and immediately be in position to connect the charging connector 154 with the wall adapter 158. When terminating a charging session, the user may disconnect the wall adapter 158 from the charging connector 154 and immediately be in position to enter the cabin 30. Accordingly, this longitudinal position of the charging connector 154 may improve the operator experience by reducing the time required to start or end a charging session.

In some embodiments, the charging connector 154 is placed in a similar position to the refueling port of an alternative telehandler utilizing an internal combustion engine. By way of example, the refueling port may be positioned behind a cabin and above a rear left wheel of the alternative telehandler. A user of the alternative telehandler may interact with the refueling port in similar circumstances to how a user of the telehandler 10 would interact with the charging connector 154. By way of example, when the high-voltage battery 132 is depleted, a user of the telehandler 10 may navigate to an external power source 156 and connect the external power source 156 to the charging connector 154 through a wall adapter 158. When the alternative telehandler requires refueling, a user of the alternative telehandler may navigate to a fueling station and connect a fuel nozzle of a fuel source to the refueling port to dispense fuel into a fuel tank of the alternative telehandler.

A single manufacturer or cooperating group of manufacturers may supply both the telehandler 10 and the alternative telehandler. By way of example, an organization may purchase a fleet of vehicles including both (a) at least one of the telehandler 10 and (b) at least one of the alternative telehandler. Accordingly, users of the fleet may regularly switch between operating the telehandler 10 and the alternative telehandler (e.g., based on a work assignment for a given day). By placing the charging connector 154 and the refueling port in a common location, the users may be able to operate both types of vehicles similarly and without having to consciously monitor the position of the charging connector 154 or the refueling port. This reduces the likelihood of a user navigating to an external power source 156 and subsequently having to reposition the telehandler 10 because the wall adapter 158 is unable to reach the charging connector 154.

Referring to FIGS. 3, 12, 13, and 31-33, the telehandler 10 includes several maintenance touchpoints within the battery housing 40. Maintenance personnel may interact with these maintenance touchpoints by lifting the door 42 to access an internal volume of the battery housing 40. When closed, the door 42 may prevent access to these maintenance touchpoints to avoid damage or tampering.

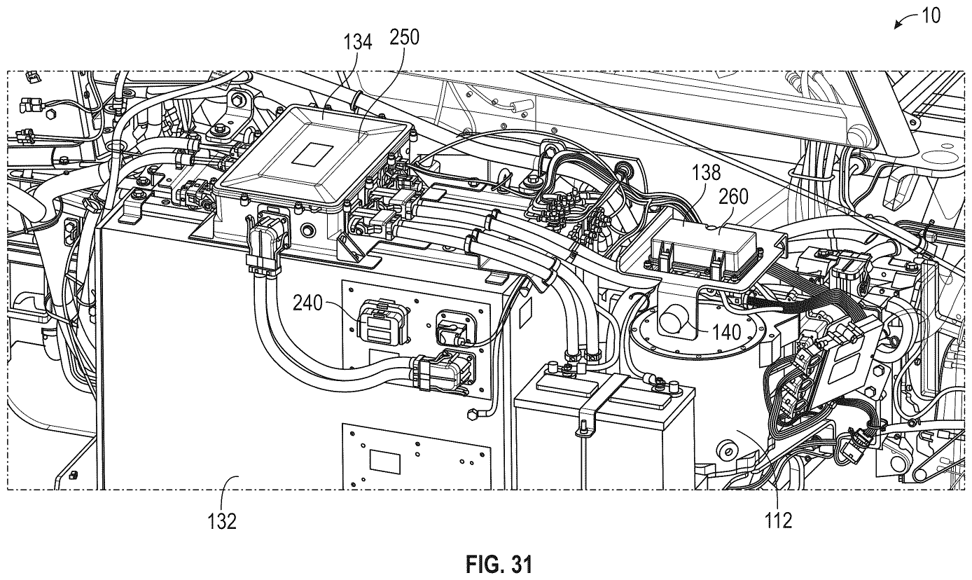

As shown in FIG. 31, the high-voltage battery 132 includes a maintenance touchpoint, switch, contactor, or manual service disconnect (MSD), shown as MSD 240. The MSD 240 may be repositionable or removable between a use configuration and a maintenance configuration. In the use configuration, the MSD 240 electrically couples the high-voltage battery 132 to the other components of the electrical system 130. In the maintenance configuration, the MSD 240 electrically isolates the high-voltage battery 132 from the electrical system 130. Accordingly, a user may remove or otherwise reconfigure the MSD 240 to the maintenance configuration to prevent the transmission of high-voltage electrical energy throughout the electrical system 130 (e.g., preventing a user from encountering high-voltage electrical energy while performing maintenance on the electrical system 130). As shown, the MSD 240 is positioned on a laterally-facing side of the high-voltage battery 132, such that the MSD 240 faces away from the side plates 18 of the frame assembly 12. Due to this placement of the MSD 240, the MSD 240 is immediately and easily accessible to a user after opening the door 42.

As shown in FIG. 31, the low-voltage disconnect 140 is another maintenance touchpoint positioned within the battery housing 40. The low-voltage disconnect 140 is positioned forward of the high-voltage battery 132. The low-voltage disconnect 140 is positioned on a laterally-facing side of a mounting bracket, such that the low-voltage disconnect 140 faces away from the side plates 18 of the frame assembly 12. Due to this placement of the low-voltage disconnect 140, the low-voltage disconnect 140 is immediately and easily accessible to a user after opening the door 42.

As shown in FIGS. 31-33, the HVPDU 134 is another maintenance touchpoint positioned within the battery housing 40. The HVPDU 134 includes a removable door or cover, shown as cover 250, that is removable by a user. The HVPDU 134 contains a series of fusible elements, shown as fuses 252, positioned within the HVPDU 134. The fuses 252 may each be configured to fail (e.g., melt) to interrupt current flow through a corresponding portion of the electrical system 130 in response to a current through the fuse 252 exceeding a threshold current. These fuses 252 may require replacement after failure. Additionally, a maintenance technician may visually inspect the fuses 252 to troubleshoot a failure of the telehandler 10. The fuses 252 may be accessed by removing the cover 250. As shown, the HVPDU 134 is positioned atop the high-voltage battery 132 with the cover 250 facing upward. To access the fuses 252, a user may open the door 42 and remove the cover 250. The user may then be able to inspect the fuses 252 by looking down into the HVPDU 134.

As shown in FIGS. 31-33, the LVPDM 138 is another maintenance touchpoint positioned within the battery housing 40. The LVPDM 138 includes a removable door or cover, shown as cover 260, that is removable by a user. The LVPDM 138 contains a series of fusible elements, shown as fuses 262, positioned within the LVPDM 138. The fuses 262 may each be configured to fail (e.g., melt) to interrupt current flow through a corresponding portion of the electrical system 130 in response to a current through the fuse 262 exceeding a threshold current. These fuses 262 may require replacement after failure. Additionally, a maintenance technician may visually inspect the fuses 262 to troubleshoot a failure of the telehandler 10. The fuses 262 may be accessed by removing the cover 260. As shown, the LVPDM 138 is positioned with the cover 260 facing upward. To access the fuses 262, a user may open the door 42 and remove the cover 260. The user may then be able to inspect the fuses 262 by looking down into the LVPDM 138.

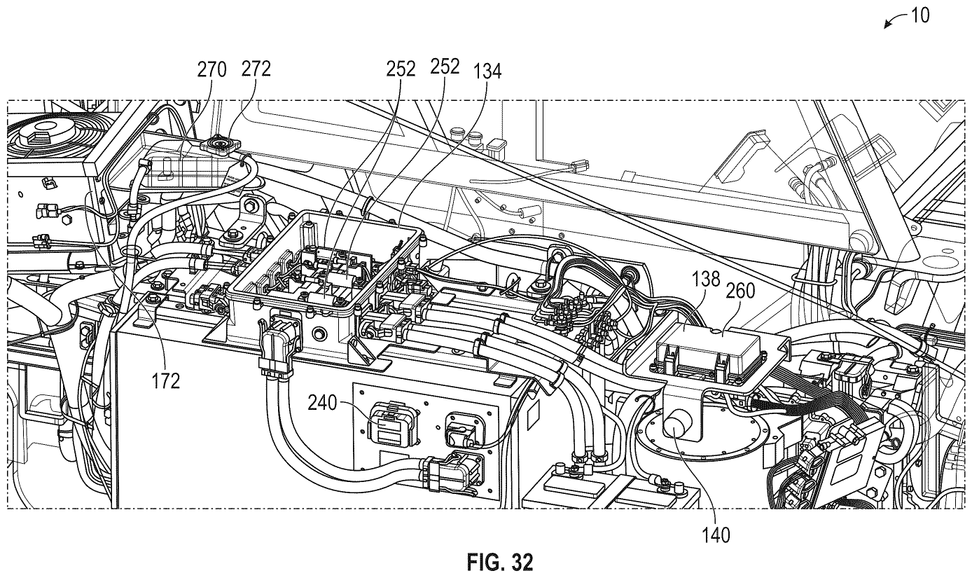

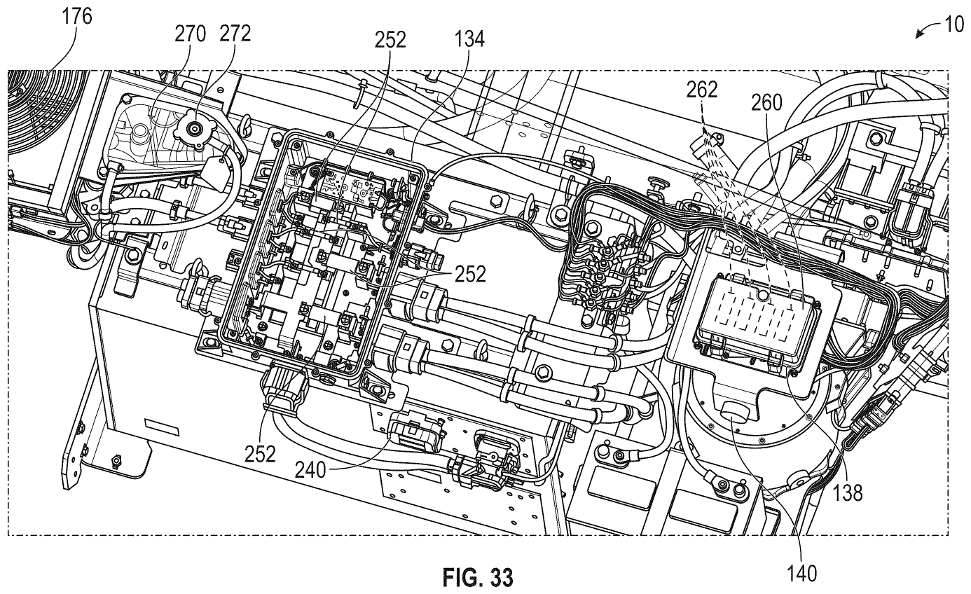

As shown in FIGS. 32 and 33, the cooling system 170 includes a maintenance touchpoint or reservoir, shown as surge tank 270. The surge tank 270 is fluidly coupled to the coolant circuit of the cooling system 170. The surge tank 270 may store a volume of coolant in fluid communication with the rest of the coolant circuit. The surge tank 270 may add or remove coolant from the circuit to ensure a consistent fill level of the coolant circuit (e.g., to accommodate expansion and contraction of the system). A cover, shown as filing cap 272, is removably coupled to the surge tank 270. The filing cap 272 may be removed to permit adding coolant to the surge tank 270. As shown in FIG. 32, the surge tank 270 is positioned at the front end of the radiators 172 with the filing cap 272 facing upward. To fill the coolant circuit, a user may open the door 42 and remove the filing cap 272. The user may pour the coolant into the surge tank 270 through the filing cap 272.

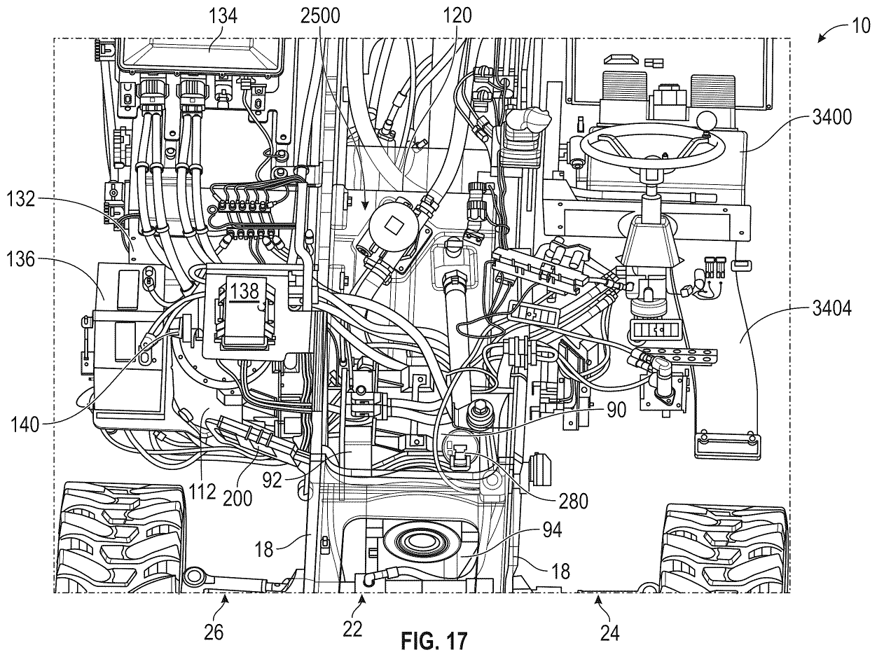

Referring to FIGS. 15 and 17, the reservoir 120 is another maintenance touchpoint of the telehandler 10. The reservoir 120 includes a port or conduit, shown as fill neck 280. The fill neck 280 is fluidly coupled to the reservoir 120. The reservoir 120 may be filled with hydraulic fluid through the fill neck 280. As shown, the fill neck 280 extends forward from the reservoir 120 through the central area 22. Due to the centralized position of the reservoir 120 within the frame assembly 12, the reservoir 120 may be difficult to access directly. By extending the fill neck 280 forward, a user may provide hydraulic oil to the reservoir 120 from the front end 14 of the telehandler 10.

Referring to FIG. 3, the refrigeration circuit 184 includes a pair of conduits, shown as refrigerant lines 290, that form part of the refrigerant circuit. A first refrigerant line 290 extends between the compressor 186 and the condenser 188. A second refrigerant line 290 extends between the condenser 188 and the expansion valve 190. The compressor 186 and the expansion valve 190 may be positioned below the cabin 30, whereas the condenser 188 may be positioned above the cabin 30. Accordingly, the refrigerant lines 290 extend vertically along a rear side of the cabin 30. To facilitate filling and draining the refrigeration circuit 184, each of the refrigerant lines 290 includes a maintenance touchpoint (e.g., a charge port, a drain port, etc.), shown as charge port 292. Refrigerant may selectively be added or removed from the corresponding refrigerant lines 290 through the charge port 292. A shown, the charge ports 292 are positioned along a rear side of the cabin 30, between the charger housing 44 and the condenser 188. Accordingly, a maintenance technician for the refrigeration circuit 184 may easily access the charge ports 292 from behind the cabin 30.

### Cable Routing

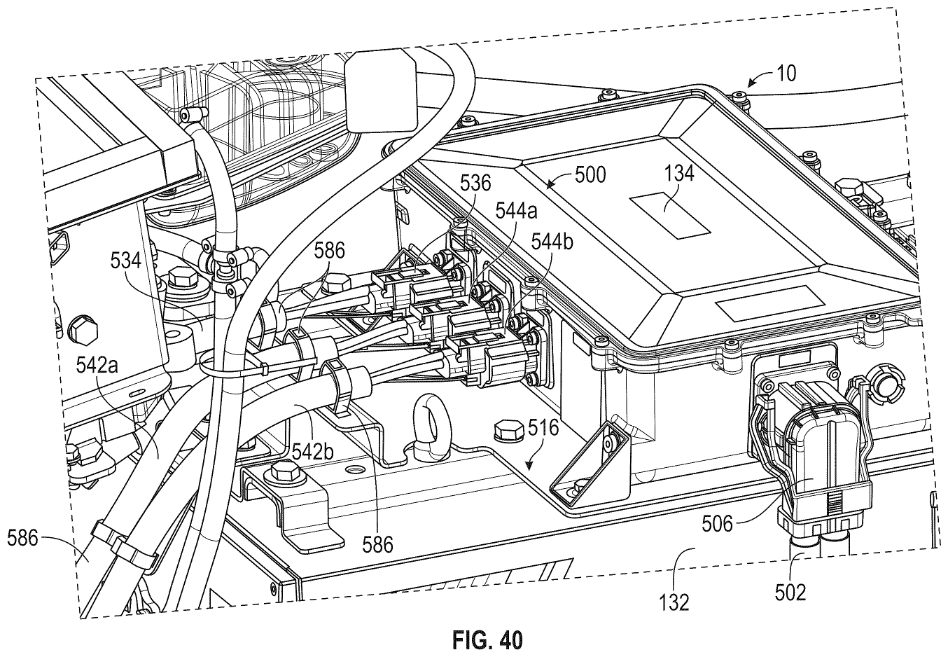

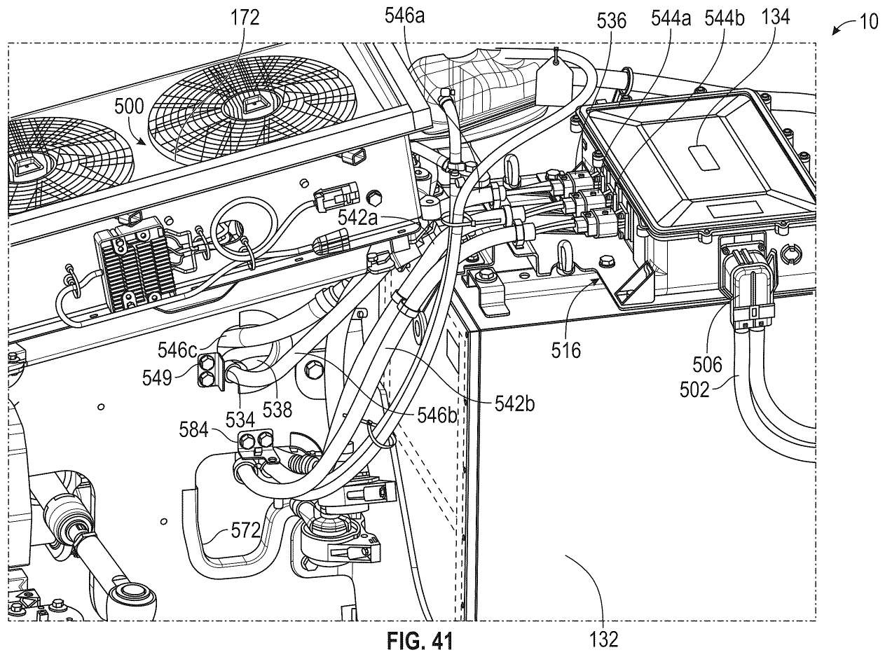

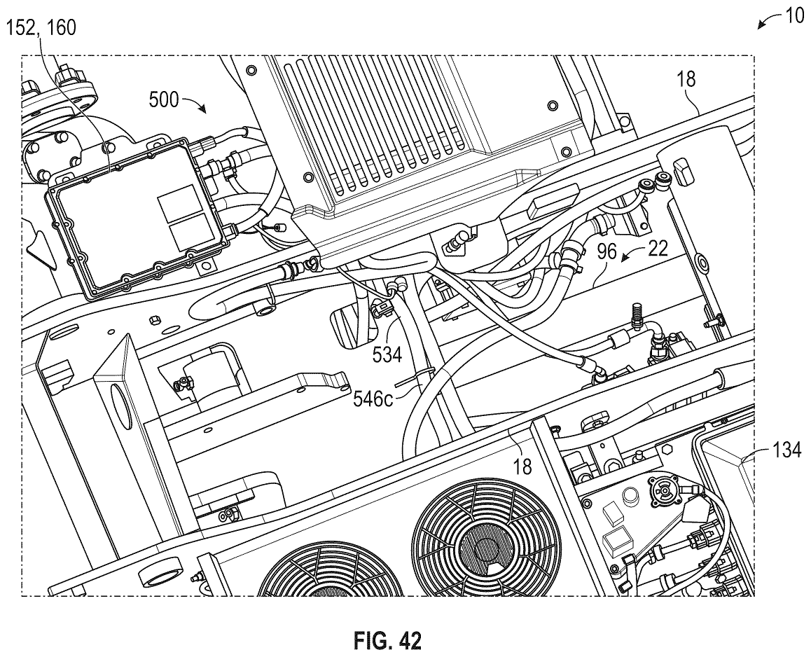

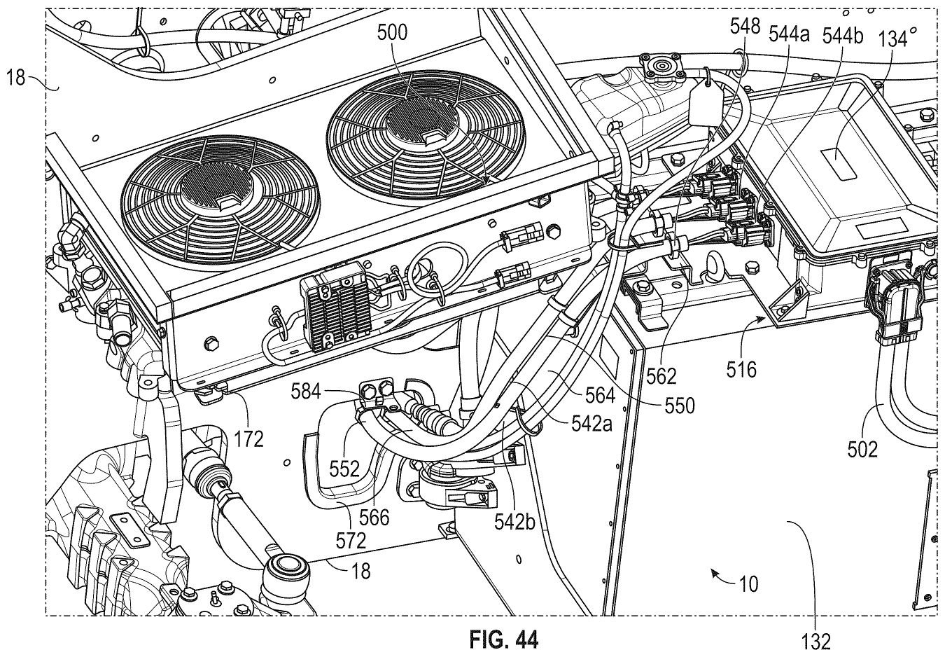

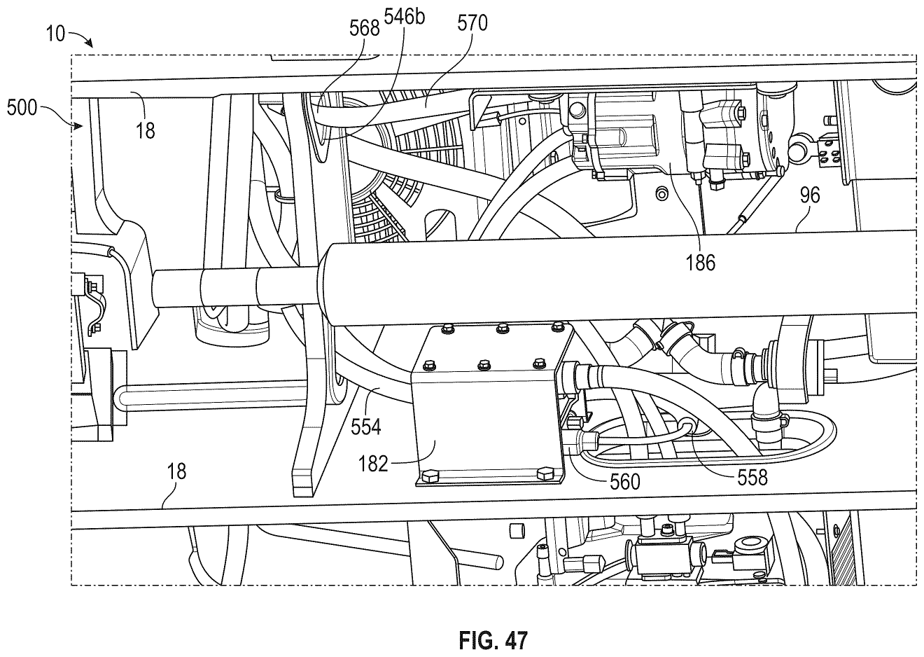

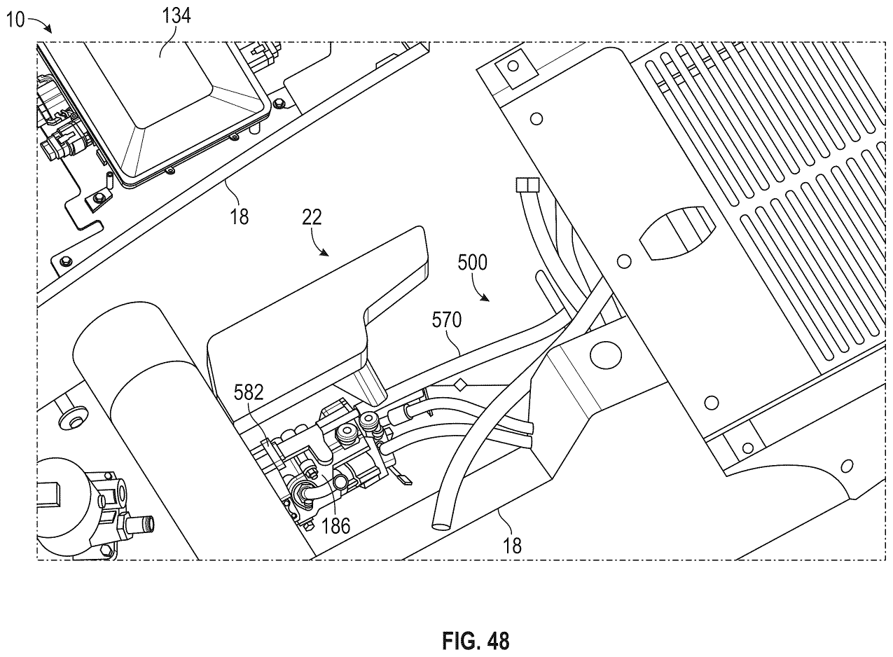

Referring to FIGS. 19-28 and 34-49, the telehandler 10 includes an electrical system, a power distribution system, a cable system, a system of multiple cables, a cable assembly, etc., shown as electrical system 500. The electrical system 500 includes the high-voltage battery 132, the HVPDU 134, the implement motor 112, the drive motor 90 and the inverter 92, the onboard chargers 152, the DC/DC converter 160, the charging connector 154, the compressor 186, and the heater 182. The electrical system 500 includes one or more cables that are configured to distribute discharge power (e.g., electrical energy, a charge, an electrical current, voltage, electricity, etc.) from the high-voltage battery 132 to the HVPDU 134, and from the HVPDU 134 to the implement motor 112, the drive motor 90, the compressor 186, and the heater 182. The electrical system 500 is also configured to distribute charging power (e.g., electrical energy, a charge, an electrical current, voltage, electricity, etc.) from the charging connector 154 to the HVPDU 134, and from the HVPDU 134 to the high-voltage battery 132. The electrical system 500 therefore facilitates discharging electrical power from the high-voltage battery 132 to the various electrical components of the telehandler 10, and charging the high-voltage battery 132 via the charging connector 154 (e.g., via the onboard chargers 152).

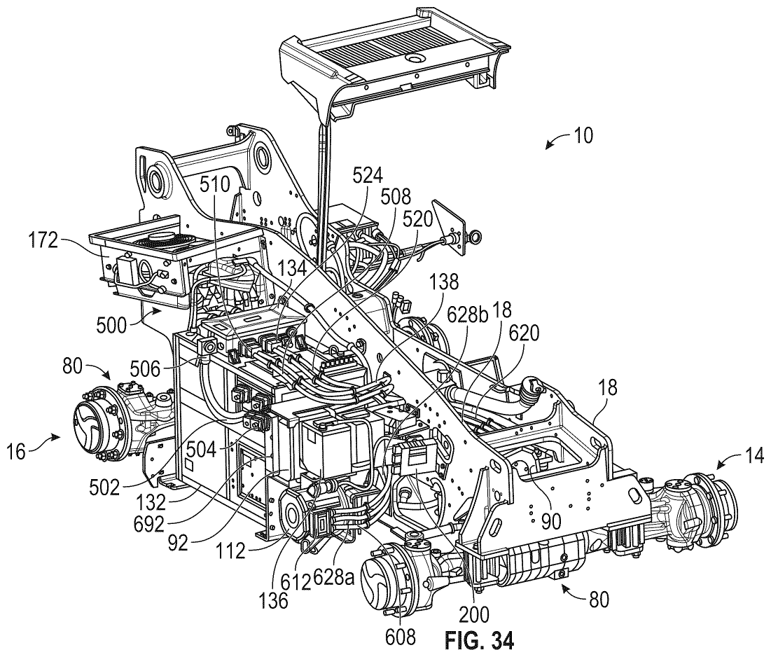

Referring to FIGS. 34-36, the electrical system 500 includes a first cable 502 (e.g., an assembly of two individual cable segments for transferring DC electrical energy). The first cable 502 is electrically coupled at a first end with the HVPDU 134 and at a second end with the high-voltage battery 132. The first cable 502 is configured to facilitate bi-directional exchange of power transfer between the HVPDU 134 and the high-voltage battery 132. The first cable 502 is electrically connected on a first lateral side 518 of the HVPDU 134 via electrical connector 506. The electrical connector 506 protrudes from the first lateral side 518 of the HVPDU 134. The first lateral side 518 of the HVPDU 134 is opposite a second lateral side that faces the side plates 18. The first lateral side 518 faces away from the side plates 18. The electrical connector 506 is disposed on a same side of the high-voltage battery 132 (e.g., the first lateral side that faces away from the side plates 18).

The first cable 502 generally extends in an elbow. In particular, the electrical connector 504 is oriented in a rearward direction such that the electrical connector 504 faces the rear end 16 of the telehandler 10. The electrical connector 506 faces in a downwards direction towards a ground surface. The cable 502 extends in the downwards direction towards the ground from the electrical connector 506, along a bent or elbow path (e.g., curving 90 degrees) and extends forwards to the electrical connector 504.

As shown in FIGS. 19-24, 26, 28, 34-39, and 39, the telehandler 10 includes the inverter 92 and a second inverter 692 (e.g., a power converter). The inverter 92 and/or the second inverter 692 may be separate from the drive motor 90 (e.g., spaced apart, such that the drive motor 90 may not include the inverter 92) and/or the implement motor 112 (e.g., spaced apart, such that the implement motor 112 may not include the second inverter 692). For example, the inverter 92 can be electrically coupled with the drive motor 90 (e.g., to convert DC power to AC power for use by the drive motor 90). The drive motor 90 is configured to receive power from the HVPDU 134 and drive the wheels 84 to rotate to transport the telehandler 10. The second inverter 692 can be electrically coupled with the implement motor 112 (e.g., to convert DC power to AC power for use by the implement motor 112). For example, the implement motor 112 is configured to receive power from the HVPDU 134 that has been converted by the second inverter 692 and operate (e.g., provide rotational energy for) actuators of the hydraulic system 110 onboard the telehandler 10.

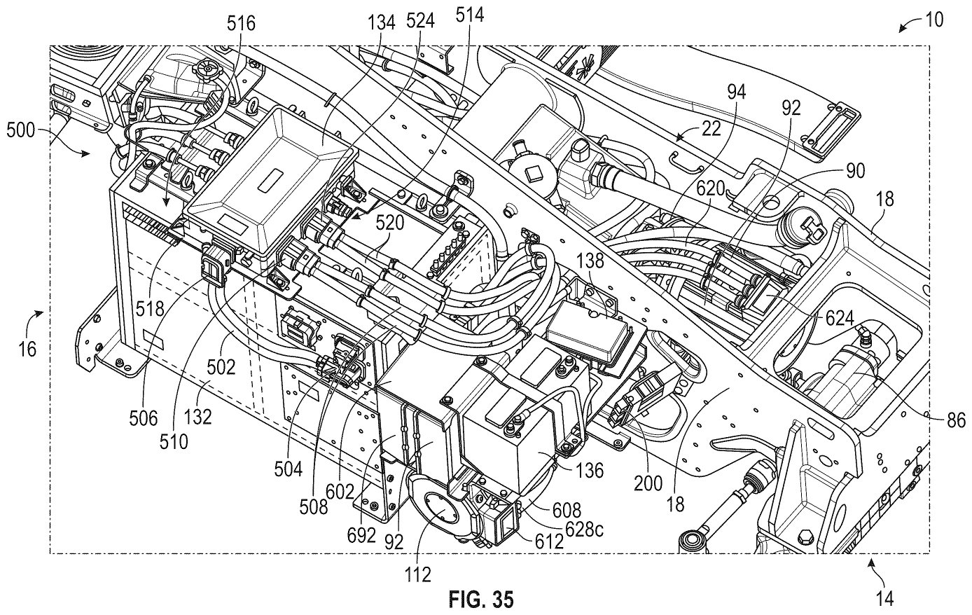

As shown in FIGS. 19 and 35, among others, the second inverter 692 may be positioned proximate (e.g., adjacent to) the inverter 92 (e.g., within a housing, in parallel with each other, stacked relative to each other, etc.). Specifically, the inverter 92 and the second inverter 692 are arranged such that each extend in a vertical and lateral plane. The inverter 92 is offset longitudinally forward from the high-voltage battery, and the second inverter 692 is offset longitudinally forward of the inverter 92. In other embodiments, the inverter 92 and the second inverter 692 may be a singular inverter (e.g., where first or second inverter may refer to a portion of the singular inverter). The inverter 92 and/or the second inverter 692 may be positioned to one side of the telehandler 10 (e.g., outside of the side plates 18, outside the central area 22, laterally offset from the longitudinal axis L of the telehandler 10, etc.). For example, the inverters 92, 692 may be positioned on the same side of the telehandler as the high-voltage battery 132 and/or the HVPDU 134 (e.g., on the right side of the telehandler 10). For another example, the inverters 92, 692 may be positioned toward the front end 14 of the telehandler 10. The inverter 92 and/or the second inverter 692 are positioned forward of the high-voltage battery 132 and/or the HVPDU 134. The inverters 92, 692 may be positioned within a housing 602, for example, to protect and/or provide a barrier (e.g., an electrical barrier, etc.) between the inverters 92, 692 and other components of the telehandler 10. The inverters 92, 692 may be positioned rearward of the low-voltage battery 136. The inverters 92, 692 may be positioned above the implement motor 112. Accordingly, the first cable 502 may be entirely within the battery area 26.

Referring to FIGS. 34-39, the electrical system 500 includes a second cable 508 (e.g., an assembly of two individual cable segments for transferring DC electrical energy). The second cable 508 is configured to electrically couple the HVPDU 134 with the inverter 92 and/or the second inverter 692. The second cable 508 is electrically connected with the HVPDU 134 via an electrical connector 510 on a first longitudinal side 514 of the HVPDU 134 (e.g., at a first end of the second cable 508). The second cable 508 is electrically connected with the second inverter 692 via an electrical connector 588 (e.g., at a second end of the second cable 508). The second cable 508 is electrically connected with the second inverter 692 on a side of the second inverter 692 facing inwards towards the side plate 18. In some embodiments, the second cable 508 is configured to electrically couple the HVPDU 134 to the inverter 92.

The second cable 508 includes a first portion 528a, a second portion 528b, and a third portion 528c. The first portion 528a is defined at the electrical connector 510. The first portion 528a extends in a generally straight direction (e.g., in a forward direction) from the electrical connector 510 on the first longitudinal side 514 of the HVPDU 134. The second portion 528b (e.g., a curved portion) extends from the first portion 528a and curves in a lateral direction (e.g., inward direction, sideways direction) toward the side plate 18 (e.g., forms a 90-degree elbow directed inwards). The second portion 528b extends inwards approximately above the inverter 92 and/or the second inverter 692. For example, the second portion 528b extends inwards between the high-voltage battery 132 and the low-voltage battery 136. The third portion 528c extends from the second portion 528b and form an approximately U-shape, such that the third portion 528c curves toward the second inverter 692. For example, the third portion 528c may extend (e.g., initially) from the second portion 528b in an inwards direction toward the side plate 18, and then curve into (e.g., form) a U-shape and transition into extending in an outwards direction (e.g., sideways, laterally) away from the side plate 18. The third portion 528c may extend from the second portion 528b in a downward direction, so the second cable 508 may be connected to the second inverter 692. The third portion 528c electrically connects with the second inverter 692 via the electrical connector 512. Accordingly, the second cable 508 may be entirely within the battery area 26.

As shown in FIGS. 34-39, the electrical system 500 also includes a third cable 520 (e.g., an assembly of two individual cable segments for transferring DC electrical energy). The third cable 520 is configured to electrically couple the HVPDU 134 with the inverter 92. For example, the inverter 92 may convert DC electrical energy (e.g., provided by the HVPDU 134) to AC electrical energy (e.g., to power the drive motor 90 and/or another electrical component of the telehandler 10). In son embodiments, the third cable 520 is configured to electrically couple the HVPDU 134 to the second inverter 692. The third cable 520 is electrically coupled with the HVPDU 134 at a first end via an electrical connector 524. The electrical connector 524 is disposed on the first longitudinal side 514 of the HVPDU 134. The third cable 520 is electrically coupled (e.g., at a second end thereof) with the inverter 92 via another electrical connector. The third cable 520 is electrically connected with the inverter 92 on the side of the inverter 92 facing inwards towards the side plate 18.

The third cable 520 includes a first portion 526a that couples with the HVPDU 134 via the electrical connector 524. The first portion 526a extends in a forwards direction from the electrical connector 524 (e.g., in a generally straight direction, towards the inverter 92, etc.). The third cable 520 also includes a second portion 526b (e.g., a curved portion) that is connected to the first portion 526a and curves in a lateral direction (e.g., inward direction, sideways direction) toward the side plate 18 (e.g., forms a 90-degree elbow directed inwards). The second portion 526b extends inwards approximately above the inverter 92 and/or the second inverter 692. For example, the second portion 526b extends inward between the HVPDU 134 and the second portion 528b of the second cable 508. The second portion 526b may extend inwards between the high-voltage battery 132 and the low-voltage battery 136. The third cable 520 includes a third portion 526c that is connected to the second portion 526b and extends in a downwards direction and/or curves towards the inverter 92 (e.g., outwards, away from the side plate 18). For example, the third portion 526c loops downward and outward, such that the third portion 526c may be connected to the inverter 92. The third portion 526c may form a U-shape (e.g., inverts) as it curves from the second portion 526b to the inverter 92. The third portion 526c electrically connects with the inverter 92 via an electrical connector. Accordingly, the third cable 520 may be entirely within the battery area 26.

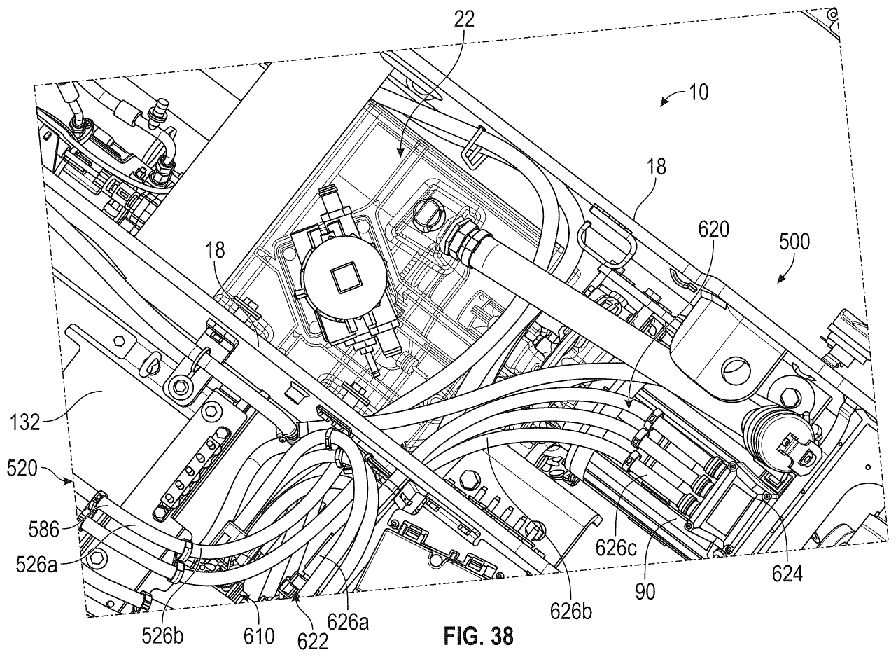

As shown in FIGS. 28 and 34-39, the electrical system 500 also includes a fourth cable 608 (e.g., an assembly of three individual cable segments for transferring three-phase AC electrical energy). The fourth cable 608 is configured to electrically couple the second inverter 692 with the implement motor 112. For example, the implement motor 112 receives power (e.g., electrical energy) from the HVPDU 134 via the second cable 508, the second inverter 692, and the fourth cable 608. The fourth cable 608 is electrically connected with the second inverter 692 via an electrical connector 610 (e.g., at a first end of the fourth cable 608) (see FIG. 38). The fourth cable 608 is electrically connected with the second inverter 692 on the side of the second inverter 692 facing inwards towards the side plate 18. The fourth cable 608 is electrically connected with the implement motor 112 via an electrical connector 612 (e.g., at a second end of the fourth cable 608).

The fourth cable 608 includes a first portion 628a extending away from the electrical connector 610, where the first portion 628a curves in a forwards direction (e.g., forms a 90-degree elbow directed forward, toward the front end 14 of the telehandler 10). For example, the first portion 628a curves towards the implement motor 112. A second portion 628b (see FIG. 34) extends from the first portion 628a in a downwards direction (e.g., towards the implement motor 112). The second portion 628b extends between the inverters 92, 692 and/or the implement motor 112, and the side plate 18. The second portion 628b extends in a forwards direction (e.g., toward the front end 14 of the telehandler 10). For example, the second portion 628b extends past the inverters 92, 692, and/or extends proximate to the implement motor 112. A third portion 628c extends from the second portion 628b and curves in an outwards direction (e.g., a lateral direction) away from the side plate 18 (e.g., forms a 90-degree elbow directed outward). The third portion 628c electrically connects with the implement motor 112 via the electrical connector 612. For example, the third portion 628c of the fourth cable 608 connects with the implement motor 112 on longitudinal side, such as a front side thereof (e.g., a side facing towards the front end 14 of the telehandler 10). Accordingly, the fourth cable 608 may be entirely within the battery area 26.

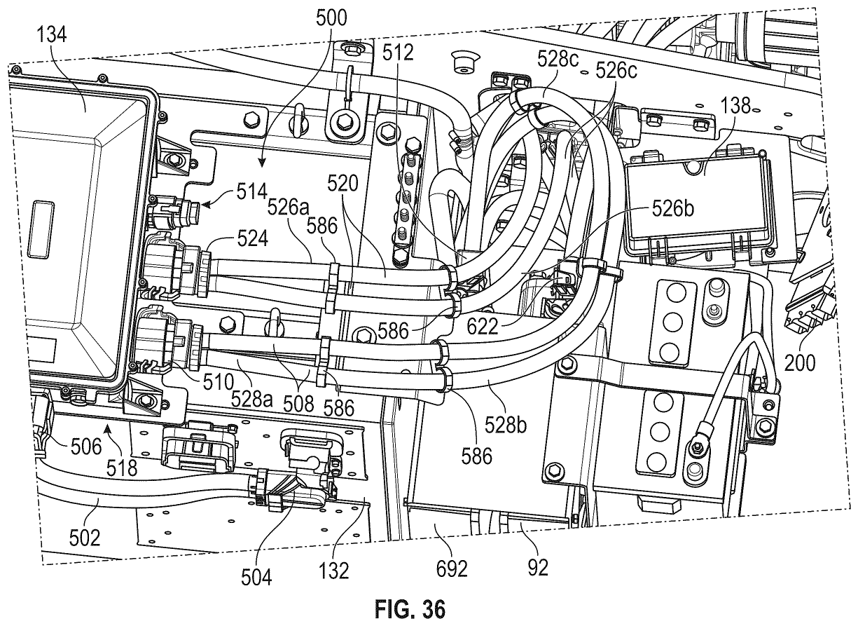

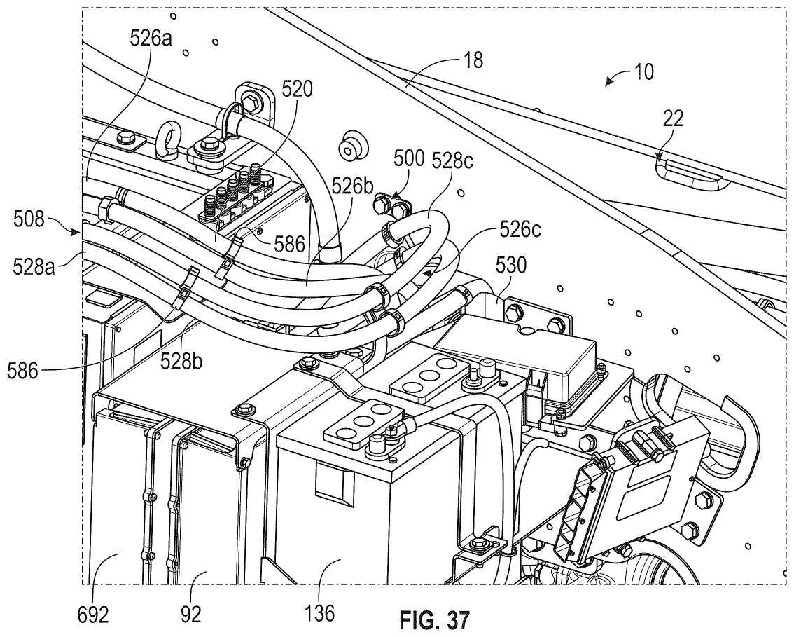

As shown in FIGS. 28 and 34-39, the electrical system 500 also includes a fifth cable 620 (e.g., an assembly of three individual cable segments for transferring three-phase AC electrical energy). The fifth cable 620 is configured to electrically couple the inverter 92 with the drive motor 90. For example, the drive motor 90 receives power (e.g., electrical energy) from the HVPDU 134 via the third cable 520, the inverter 92, and the fifth cable 620. The fifth cable 620 is electrically connected with the inverter 92 via an electrical connector 622 (e.g., at a first end of the fifth cable 620) (see FIGS. 36 and 38). The fifth cable 620 is electrically connected with the inverter 92 on the side of the inverter 92 facing inwards towards the side plate 18. The fifth cable 620 is electrically connected with the drive motor 90 via an electrical connector 624 (e.g., at a second end of the fifth cable 620).

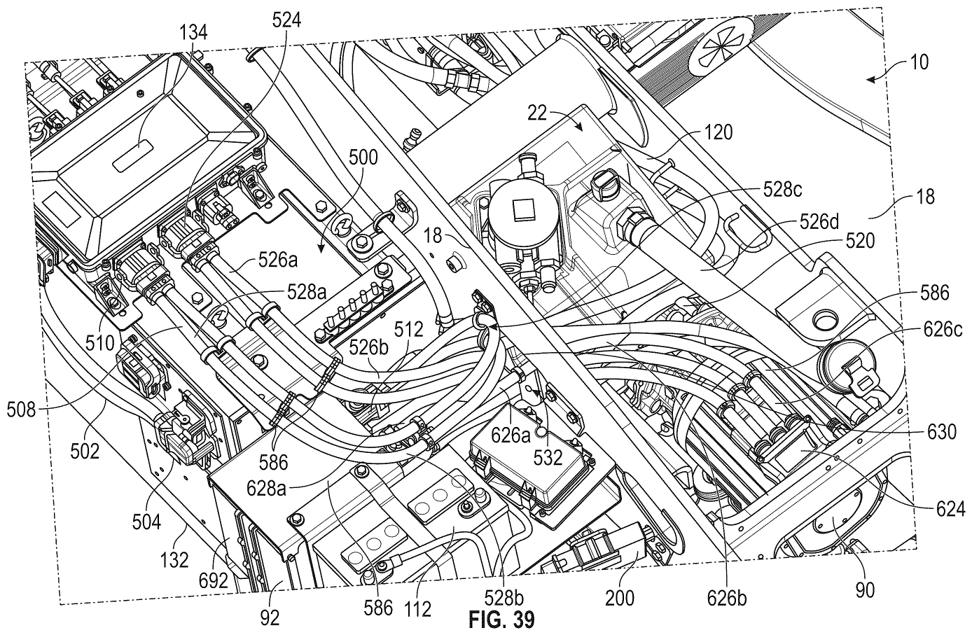

The fifth cable 620 includes a first portion 626a extending away from the electrical connector 622, where the first portion 626a extends in a generally straight direction (e.g., in a lateral direction) inwards toward the side plate 18. A second portion 626b extends from the first portion 626a and curves in a frontwards direction (e.g., longitudinal direction, forward direction) towards the front end 14 of the telehandler 10 (e.g., forms a 90-degree elbow directed forward). As the fifth cable 620 extends from the electrical connector 622, the fifth cable 620 extends through an opening 630 or aperture (shown in FIG. 39) defined in the side plate 18 and within the central area 22 (e.g., between the side plates 18). In some embodiments, the first portion 626a of the fifth cable 620 extends through the opening 630 and into (e.g., within) the central area 22. In some embodiments, the second portion 626b of the fifth cable 620 extends through the opening 630 and into (e.g., within) the central area 22. Accordingly, the fifth cable 620 extends through the opening 630 and into both the battery area 26 and the central area 22

The fifth cable 620 includes a third portion 626c extending from the second portion 626b, where the third portion 626c extends in a generally straight direction (e.g., in a forward direction) toward the front end 14 of the telehandler 10. For example, the third portion 626c extends toward the drive motor 90. The third portion 626c extends within the central area 22. The third portion 626c is electrically connected with the drive motor 90 via the electrical connector 624. For example, the fifth cable 620 may connect to the drive motor 90 on a top side of (e.g., above) the drive motor 90. For another example, the fifth cable 620 may connect to the drive motor 90 proximate a front side of the drive motor 90 (e.g., a side facing towards the front end 14 of the telehandler 10). In some embodiments, the first portion 626a and/or the second portion 626b of the fifth cable 620 may be coupled with the side plate 18 at a connector 532, such that the connector 532 physically couples the fifth cable 620 with an edge of the side plate 18. The connector 532 can be fastened or otherwise coupled to the side plate 18 and provides a space to receive (e.g., route) the fifth cable 620 (e.g., the first portion 626a and/or the second portion 626b thereof) as it passes through the side plate 18 (e.g., via the opening 630). The first cable 502, the second cable 508, the third cable 520, the fourth cable 608, and/or the fifth cable 620 may each have a diameter of approximately 0.5 inches.

Referring to FIGS. 25-28, 34, and 40-49, among others, the electrical system 500 includes a sixth cable 534. The sixth cable 534 is configured to electrically couple the HVPDU 134 (and therefore the high-voltage battery 132) with the on-board chargers 152 and the DC/DC converter 160. The sixth cable 534 is electrically connected with the HVPDU 134 at an electrical connector 536 and is electrically connected with the on-board chargers 152 and the DC/DC converter 160 at an electrical connector 536. The electrical connector 536 is disposed on and protrudes from a second longitudinal side 516 (e.g., a rear side) of the HVPDU 134. The second longitudinal side 516 is opposite the first longitudinal side 514. The second longitudinal side 516 faces the rear end 16 of the telehandler 10.

The sixth cable 534 includes a first portion 546a that electrically connects with the electrical connector 536, a second portion 546b that extends downwards and rearwards towards an opening 538 or aperture, a third portion 546c that extends through the central area 22 between the side plates 18, and a fourth portion 546d that curves from an opening 540 or aperture in the side plate 18 to the onboard charger 152 and DC/DC converter 160. The first portion 546a of the sixth cable 534 extends from the electrical connector 536 in a generally rearward direction (e.g., towards the radiators 172). The second portion 546b of the sixth cable 534 curves downwards and inwards, below the radiators 172, and towards the opening 538 in the side plate 18 (e.g., the right side plate 18). The second portion 546b is fixedly coupled with the side plate 18 at the opening 538 via a connector 549 (e.g., a cable clamp). The connector 549 can be similar to the connector 532.

The third portion 546c of the sixth cable 534 extends through the central area 22 between the side plates 18. In particular, the third portion 546c of the sixth cable 534 extends from the opening 538 in the right side plate 18 to the opening 540 in the left side plate 18. The third portion 546c of the sixth cable 534 is disposed a distance above the driveshaft 96. The fourth portion 546d of the sixth cable 534 extends from the opening 540 in the left side plate 18 to the electrical connector 536. The fourth portion 546d of the sixth cable 534 extends in a curved direction (e.g., forming an elbow) towards the rear end 16 of the telehandler 10. Accordingly, the sixth cable 534 extends from the battery area 26, through the central area 22 and into the cabin area 24.

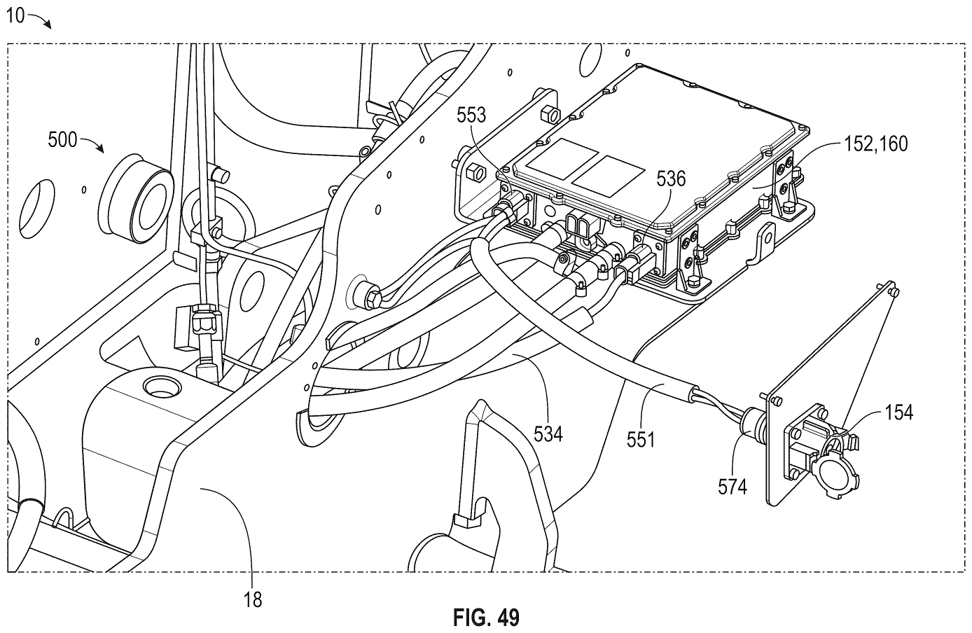

As shown in FIG. 49, the electrical system 500 also includes a seventh cable 551 that electrically couples the onboard chargers 152 and the DC/DC converter 160 with the charging connector 154. The seventh cable 551 has a generally curved shape extending from the electrical connector 553 that is oriented along a direction parallel with the longitudinal axis of the telehandler 10 to an electrical connector 574 (shown in FIG. 34) of the charging connector 154 that is oriented in a direction parallel with the lateral axis (e.g., the axis of rotation 64). Accordingly, the seventh cable 551 is positioned within the cabin area 24.

The electrical connector 553 and the electrical connector 536 are defined on a front longitudinal side of the onboard charger 152 and the DC/DC converter 160 (e.g., a side of the onboard charger 152 and the DC/DC converter 160 that faces the front end 14 of the telehandler 10). The electrical connector 553 is positioned laterally inwards relative to the electrical connector 536 (e.g., the electrical connector 553 is disposed proximate the side plate 18).

The sixth cable 534 passes through the opening 538 and the opening 540 to the onboard chargers 152. In other embodiments, the telehandler 10 is configured within an internal combustion engine in place of the high-voltage battery 132. In such an embodiment, a fuel line supplying fuel to the internal combustion engine may follow a similar path as the sixth cable 534, through the opening 538 and the opening 540. Accordingly, the opening 538 and the opening 540 in the side plates 18 can be provided for either fuel lines or the sixth cable 534. For example, the frame assembly 12 can be configured for use with either an internal-combustion engine embodiment of the telehandler 10 or the electric embodiment of the telehandler 10. The openings 538 and 540 can be provided for either fuel lines (e.g., from the fuel tank at the position where the onboard charger 152 is positioned to the engine at the position of the high-voltage battery 132), or for the sixth cable 534 to electrically couple the high-voltage battery 132 with the onboard charger 152.

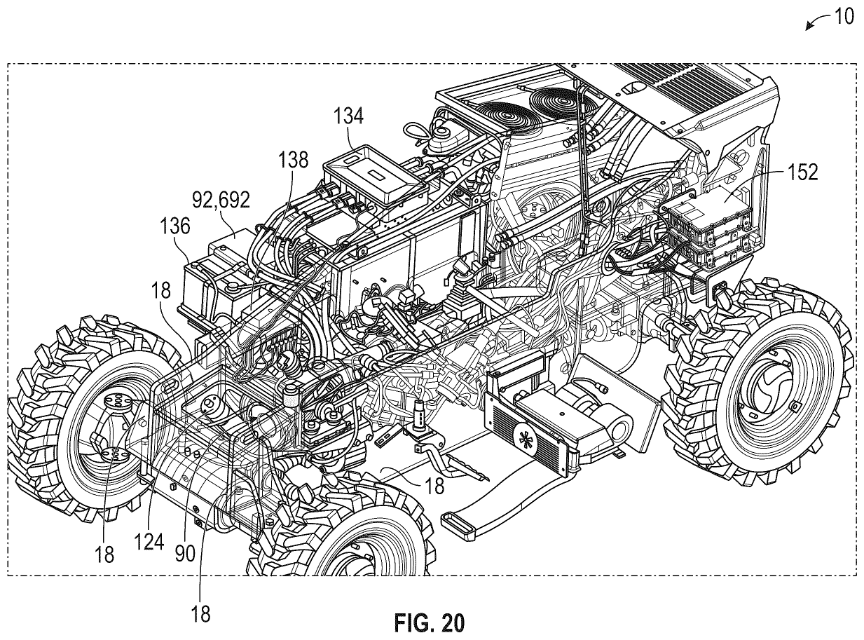

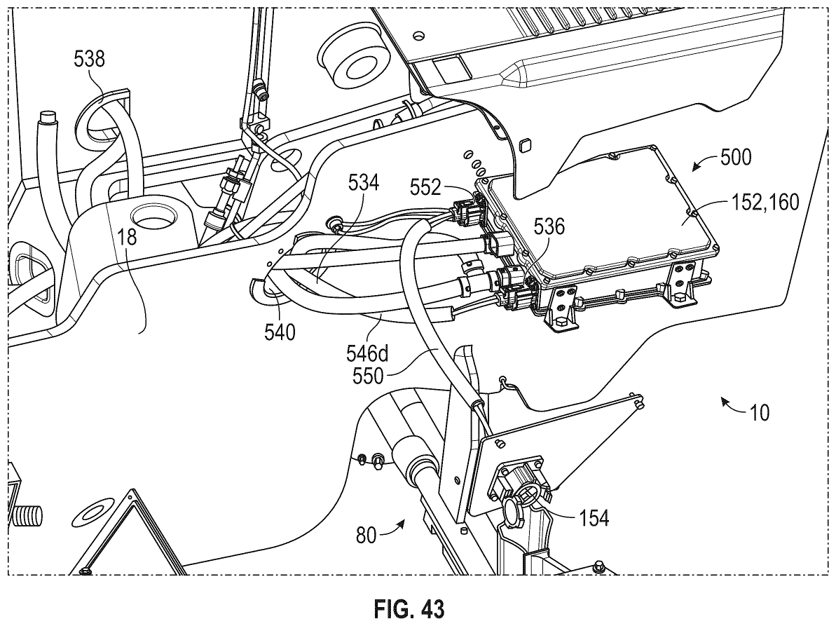

Referring to FIGS. 20 and 43, the telehandler 10 is shown including the onboard charger 152. The telehandler 10 can be configured to include a single onboard charger 152 (e.g., as shown in FIG. 43) or a pair of onboard chargers 152 (e.g., as shown in FIG. 20). In embodiments where the telehandler 10 includes multiple onboard chargers 152, the fourth portion 546d of the sixth cable 534 may split and connect with both of the onboard chargers 152 via a pair of electrical connectors 536.

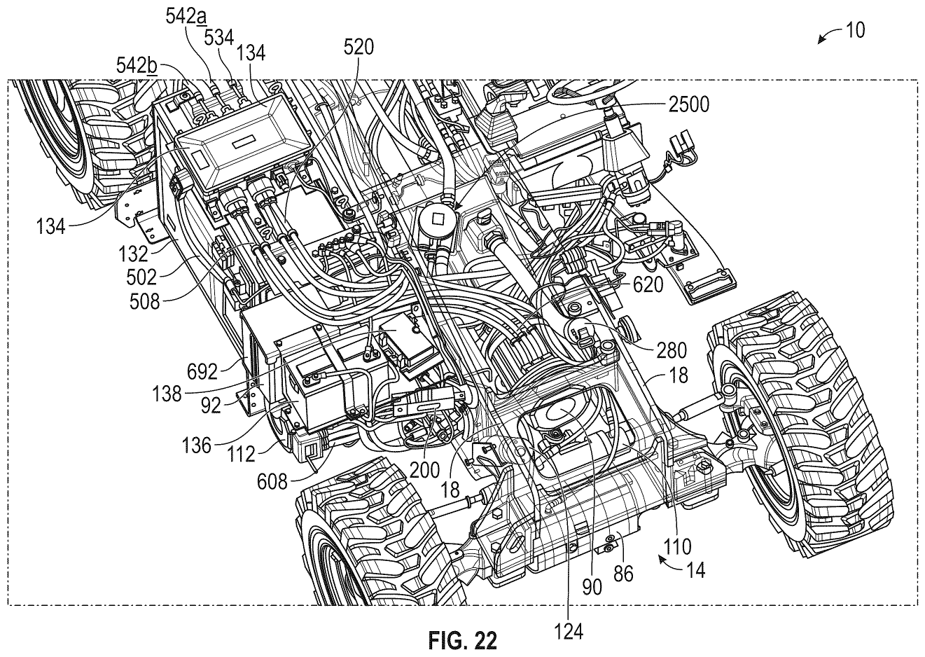

Referring to FIGS. 22-23, and 40-49, the electrical system 500 includes an eighth cable 542a and a ninth cable 542b. The eighth cable 542a is configured to electrically connect the HVPDU 134 with the heater 182. The ninth cable 542b is configured to electrically connect the HVPDU 134 with the compressor 186 (e.g., an electric motor of the compressor 186 that drives the compressor or an inverter that powers the electric motor). The eighth cable 542a is electrically connected with the HVPDU 134 at an electrical connector 544a. The ninth cable 542b is electrically connected with the HVPDU 134 at an electrical connector 544b. The electrical connector 544a and the electrical connector 544b are disposed on and protrude from the second longitudinal side 516 of the HVPDU 134 (e.g., facing the rear end 16 of the telehandler 10).

The eighth cable 542a includes a first portion 548 that protrudes from the electrical connector 544a. The first portion 548 extends in a generally straight direction (e.g., in the rearwards direction towards the rear end 16 of the telehandler 10). The eighth cable 542a includes a second portion 550 that extends in a rearwards and downwards direction. The second portion 550 can include a pair of elbows at opposite ends. The eighth cable 542a includes a third portion 552 that extends through an opening 572 or aperture in the side plate 18. The third portion 552 can extend in a generally lateral direction through the opening 572 into the central area 22 between the side plates 18.

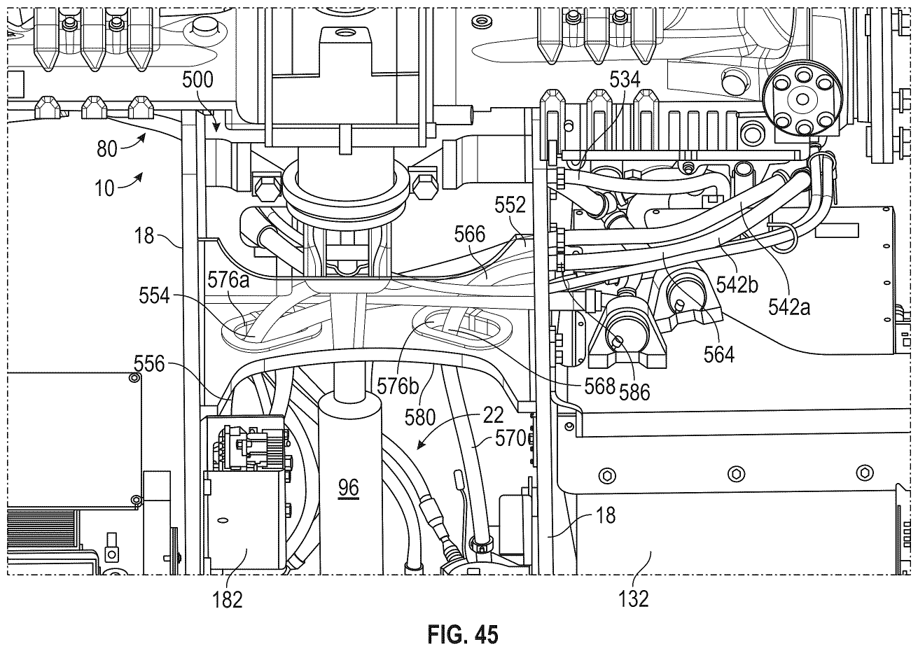

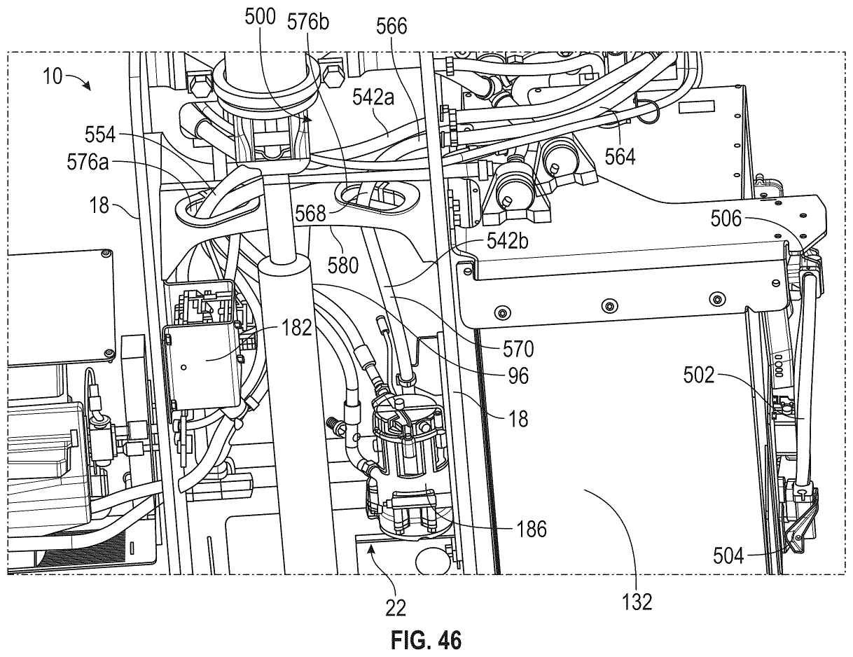

As shown in FIGS. 45-46, among others, the eighth cable 542a includes a fourth portion 554. The third portion 552 extends through the central area 22. The fourth portion 554 extends in a generally longitudinal direction along the central area 22 (e.g., above the driveshaft 96). The fourth portion 554 extends through an opening 576a or aperture in a crossmember 580. The crossmember 580 extends laterally through the central area 22. The crossmember 580 includes the opening 576a and an opening 576b or aperture. The opening 576a and the opening 576b are disposed on opposite lateral ends of the crossmember 580 proximate the side plates 18. The crossmember 580 maintains the eighth cable 542a and the ninth cable 542b a distance away from the driveshaft 96.

The eighth cable 542a includes a fifth portion 556 that extends in the longitudinal direction along the central area 22 from the opening 576a towards the front end 14 of the telehandler 10. The fifth portion 556 can extend past or alongside the heater 182. The eighth cable 542a also includes a sixth portion 558 that forms a 180 degree turn. For example, the sixth portion 558 ends extending in a direction along the longitudinal direction towards the heater 182 (e.g., towards the rear end 16 of the telehandler 10). The sixth portion 558 terminates at an electrical connector 560 of the heater 182. The electrical connector 560 protrudes from the heater 182 on a front side of the heater 182. The electrical connector 560 protrudes towards the front end 14 of the telehandler 10.

As shown in FIGS. 22-23, 28, and 34-49, among others, the ninth cable 542b includes a first portion 562, a second portion 564, a third portion 566, a fourth portion 568, and a fifth portion 570. The ninth cable 542b is configured to electrically connect the compressor 186 with the HVPDU 134 such that the compressor 186 can consume electrical power from the HVPDU 134 and the high-voltage battery 132. The ninth cable 542b is electrically connected with the HVPDU 134 at an electrical connector 544b and is electrically connected with the compressor 186 at an electrical connector 582. The first portion 562 and the electrical connector 544b protrude from the second longitudinal side 516 of the HVPDU 134. The first portion 562 extends in a generally rearwards direction from the electrical connector 544b.

The second portion 564 extends in a rearward and downward direction towards the opening 572. The opening 572 is lower on the side plate 18 than the opening 538. The third portion 566 of the ninth cable 542b extends inwards (e.g., laterally through the opening 572) through the opening 572 and into the central area 22. The ninth cable 542b and the eighth cable 542a are coupled with the side plate 18 at the opening 572 by a connector 584. The connector 584 can be positioned at a top of the opening 572. The connector 584 can be the same as or similar to the connector 530.

As shown in FIG. 45, among others, the fourth portion 568 of the ninth cable 542b extends in the longitudinal direction along the central area 22. The ninth cable 542b extends through the opening 576b. The fourth portion 568 and the third portion 566 define a 90 degree bend therebetween. For example, the third portion 566 extends in a generally lateral direction whereas the fourth portion 568 extends in the longitudinal direction through the opening 576b.

The fifth portion 570 of the ninth cable 542b extends in the longitudinal direction along the central area 22. The fifth portion 570 extends from the fourth portion 568 at the opening 576b to the compressor 186. The fifth portion 570 terminates at the electrical connector 582 on a top of the compressor 186. The compressor 186 is mounted to the side plate 18 opposite the heater 182. The heater 182 and the compressor 186 are both disposed within the central area 22 on opposite sides, coupled to the left and right side plates 18. The compressor 186 can be positioned further forwards along the side plate 18 than the heater 182.

Referring to FIGS. 21-26, 30 and 40-49, one or more of the first cable 502, the second cable 508, the third cable 520, the sixth cable 534, the seventh cable 551, the eighth cable 542a, and the ninth cable 542b can be secured to various components of the telehandler 10 via clamps 586 (e.g., connectors) at regular intervals in order to maintain a tight adherence to the paths described herein. For example, as shown in FIGS. 21-24, the second cable 508 is coupled with the high-voltage battery 132 at multiple locations (e.g., on the top, and down the side) via clamps 586. Similarly, the third cable 520 is coupled with sides of the high-voltage battery 132, the connector 532, the reservoir 120, and the drive motor 90 via clamps 586. As shown in FIGS. 25-26 and 30, the sixth cable 534, the eighth cable 542a, and the ninth cable 542b can be coupled with the high-voltage battery 132 on an opposite side of the high-voltage battery 132.

### Low-Voltage Disconnect System

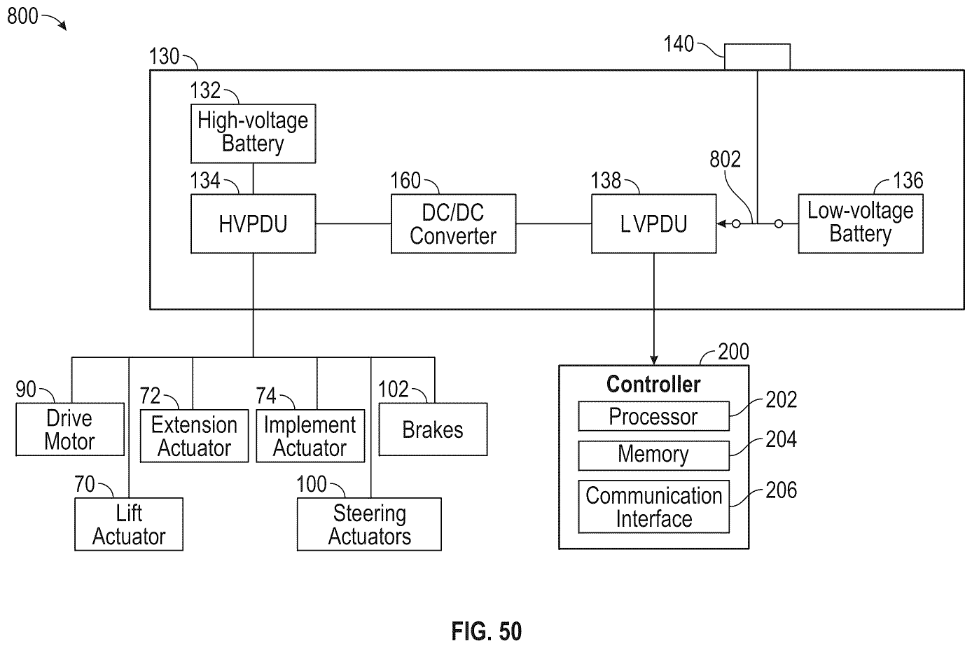

Referring generally to FIGS. 50-53, a low-voltage disconnect system or low-voltage battery disconnect system, shown as disconnect system 800, is shown, according to an exemplary embodiment. The disconnect system 800 may be implemented with a vehicle, work machine, lift device (e.g., the telehandler 10, etc.), and/or another suitable device, vehicle, and/or work machine, as described herein. The disconnect system 800 may be configured to selectively disconnect (e.g., isolate, disengage, detach, de-couple, divide, confine, etc.) one or more components of a vehicle (e.g., the telehandler 10, etc.). For example, the disconnect system 800 may be configured to disconnect (e.g., isolate, etc.) a low-voltage component (e.g., a low-voltage battery, a low-voltage power source, etc.) from another component of the vehicle (e.g., a high-voltage system, a high-voltage power source, a low-voltage distribution system, etc.). According to an exemplary embodiment, the disconnect system 800 is configured to selectively disconnect a low-voltage component of a vehicle from other components of the vehicle (e.g., a low-voltage battery from a high-voltage system, etc.), for example to limit unauthorized, unintended, and/or undesired uses of the vehicle (e.g., the telehandler 10, etc.).

As shown in FIGS. 50-53, the disconnect system 800 includes one or more components of an electrical energy system or power system, shown the electrical system 130. As described herein, the electrical system 130 is configured to supply electrical energy to power one or more functions of the vehicle (e.g., the telehandler 10, etc.). For example, the electrical system 130 may receive, store, generate, and/or distribute electrical energy throughout the telehandler 10.

The electrical system 130 may include one or more energy storage devices or battery packs. For example, the electrical system 130 is shown to include the high-voltage battery 132. According to an exemplary embodiment, the high-voltage battery 132 may provide direct current (DC) electrical energy at a relatively high voltage (e.g., 400V). The high-voltage battery 132 is shown to be electrically coupled to a power distribution unit or high-voltage bus, shown as the HVPDU 134. The HVPDU 134 distributes high-voltage electrical energy throughout the telehandler 10 (e.g., to or from the high-voltage battery 132). By way of example, the HVPDU 134 may distribute electrical energy from the high-voltage battery 132 to the drive motor 90, the lift actuator 70, the extension actuator 72, the implement actuator 74, the steering actuators 100, the brakes 102, and/or any other suitable component of the telehandler 10 (e.g., a component or system powered or driven by a high-voltage power or energy source, etc.), as described herein.

In an exemplary embodiment, the HVPDU 134 also distributes electrical energy from the high-voltage battery 132 to a power converter or DC to DC converter, shown as the DC/DC converter 160. As described herein, the DC/DC converter 160 may receive DC electrical energy at a first voltage (e.g., a high voltage) and convert the energy to DC electrical energy at a second voltage (e.g., a low voltage). Similarly, the DC/DC converter 160 may receive DC electrical energy at the second voltage (e.g., the low voltage) and convert the energy to DC electrical energy at the first voltage (e.g., the high voltage). The DC/DC converter 160 may permit energy communication between the high-voltage and low-voltage portions of the electrical system 130. By way of example, the DC/DC converter 160 may convert high-voltage electrical energy from the high-voltage battery 132 to low-voltage electrical energy to power one or more low-voltage components of the telehandler 10 (e.g., the controller 200, one or more fans 176 and/or 194, a component or system powered or driven by a low-voltage power or energy source, etc.), and/or to charge a low-voltage power or energy source (e.g., the low-voltage battery 136), as described herein.

The electrical system 130 is also shown to include the low-voltage battery 136. The low-voltage battery 136 may store and provide electrical energy to power other components of the telehandler 10. For example, the low-voltage battery 136 may provide direct current (DC) electrical energy at a relatively low voltage (e.g., 12V). The low-voltage battery 136 is electrically coupled to a power distribution unit or low-voltage bus, shown as the LVPDM 138. The LVPDM 138 distributes low-voltage electrical energy throughout the telehandler 10 (e.g., to or from the low-voltage battery 136). By way of example, the HVPDU 134 may distribute electrical energy from the low-voltage battery 136 to the controller 200 and/or another suitable component or system powered and/or driven by a low-voltage power or energy source, etc.

In an exemplary embodiment, the LVPDM 138 is also electrically coupled to the DC/DC converter 160. As described herein, the LVPDM 138 may distribute low-voltage electrical energy throughout the telehandler 10. For example, the LVPDM 138 may distribute low-voltage-electrical energy (e.g., from the DC/DC converter 160, from the high-voltage battery 132, etc.) to the controller 200 (e.g., the processor 202, the memory 204, the communications interface 206, etc.) and/or other suitable components of the telehandler 10, as described herein.

As shown in FIGS. 50-53, the disconnect system 800 also includes a low-voltage disconnect, shown as the low-voltage disconnect 140. The low-voltage disconnect 140 may be or include a switch, button, handle, lever, knob, key, on/off control, controller, dial, joystick, disk, contactor, and/or any other suitable connector. The low-voltage disconnect 140 may be or include an electrical switch or connector, shown as switch 802. The switch 802 may be electrically coupled to one or more components of the electrical system 130. For example, the switch 802 may be electrically coupled to the low-voltage battery 136 and/or the LVPDM 138. In other embodiments, the switch 802 is otherwise coupled and/or arranged (e.g., electrically coupled to the low-voltage disconnect 140, the DC/DC converter 160, etc.). As will be described herein, the switch 802 may be configurable between a plurality of configurations (e.g., a closed or “on” configuration, an open or “off” configuration, a start configuration, a stop configuration, etc.), for example to selectively and/or electrically couple one or more components of the telehandler 10 (e.g., the low-voltage battery 136, the LVPDM 138, components of a high-voltage system, for example the high-voltage battery 132, the HVPDU 134, the DC/DC converter 160, etc.).

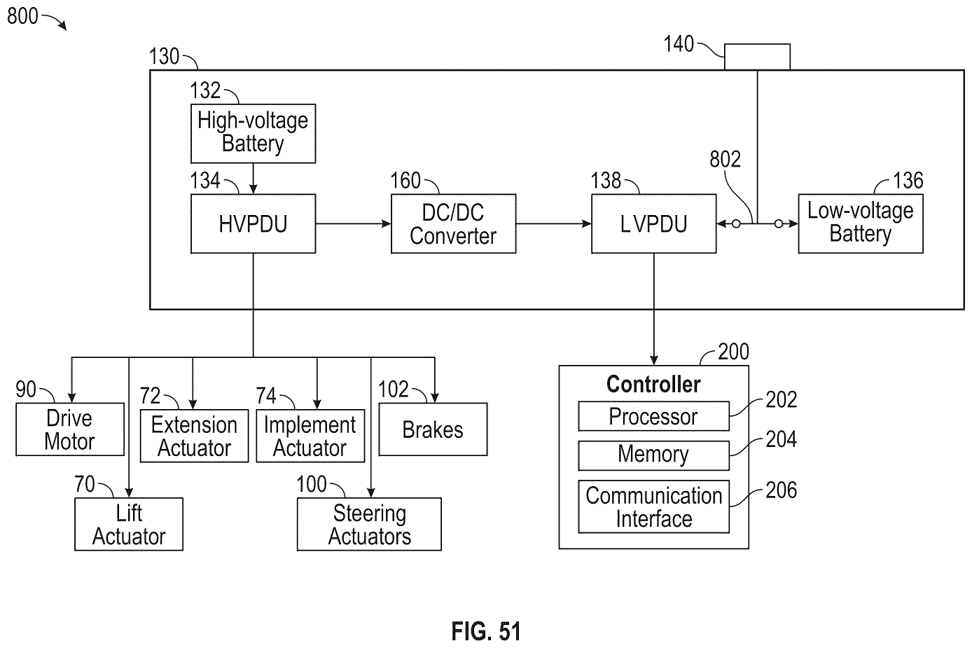

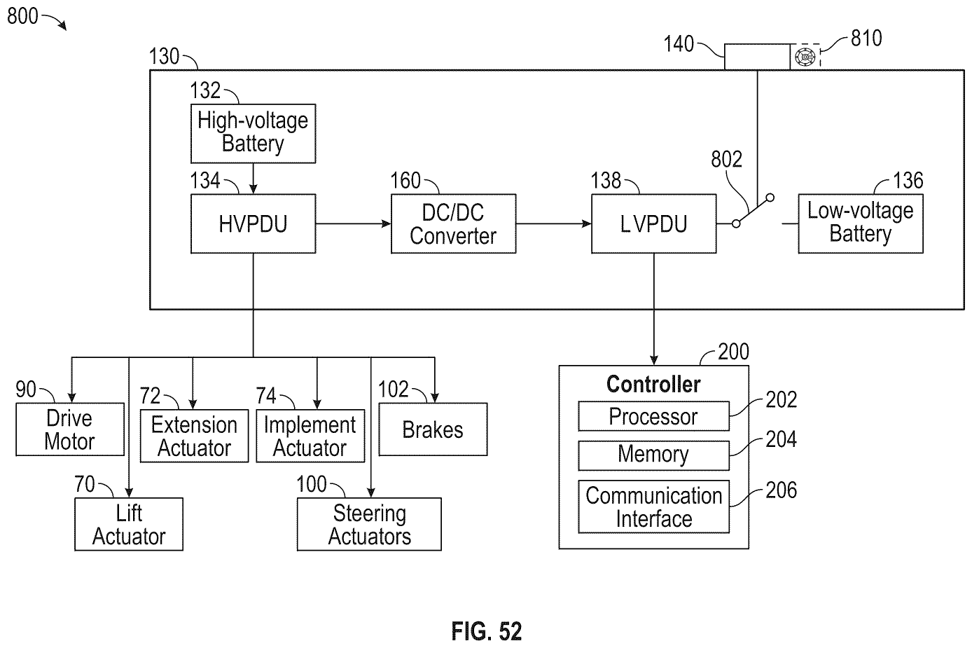

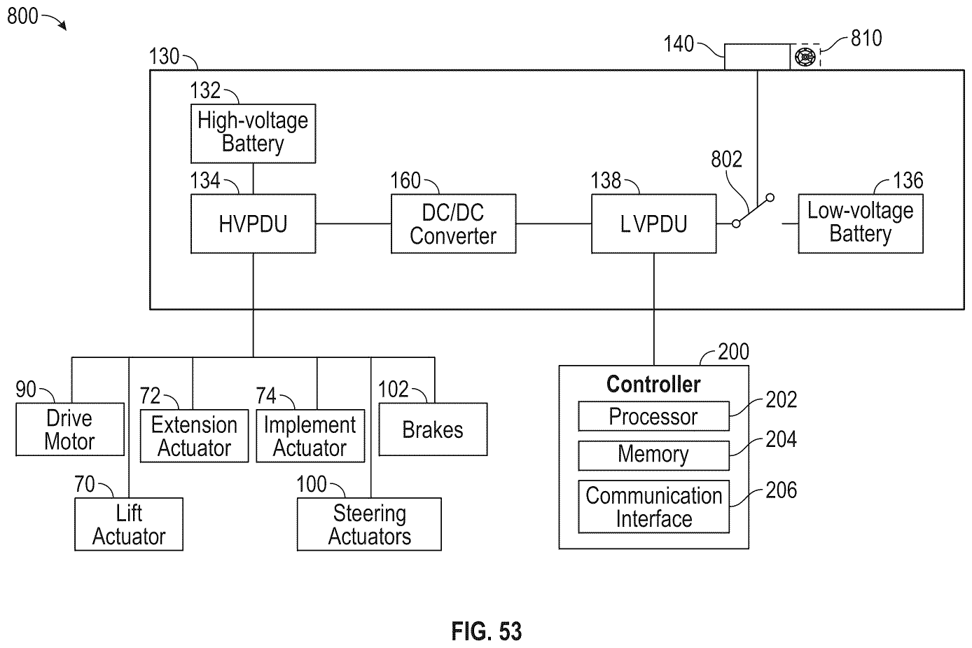

For example, the low-voltage disconnect 140 (e.g., the switch 802, etc.) may be selectively reconfigurable between a closed or “on” configuration and an open or “off” configuration. As shown in at least FIGS. 50-51, the low-voltage disconnect 140 may be selectively reconfigurable to a closed (e.g., “on,” etc.) configuration, in which the switch 802 electrically couples the low-voltage battery 136 to other components of the telehandler 10 (e.g., the controller 200, the LVPDM 138, etc.). Further, and as shown in at least FIGS. 52-53, the low-voltage disconnect 140 (e.g., the switch 802, etc.) may be selectively reconfigurable to an open (e.g., “off,” etc.) configuration, in which the switch 802 electrically disconnects or isolates (e.g., de-couples, disengages, detaches, etc.) the low-voltage battery 136 from other components of the telehandler 10 (e.g., the controller 200, the LVPDM 138, etc.).

As shown in FIGS. 52-53, in some embodiments the disconnect system 800 may also include a stop, control, or lock, shown as a lock 810. In an exemplary embodiment, the lock 810 is implemented to control (e.g., maintain, power, command, etc.) one or more configurations and/or positions of the low-voltage disconnect 140. For example, with the low-voltage disconnect 140 in an open configuration (e.g., an “off” configuration, etc.) the lock 810 may be engaged (e.g., activated, implemented, etc.), for example to lock or maintain the low-voltage disconnect 140 in the open configuration (e.g., the “off” configuration). Similarly, with the low-voltage disconnect 140 in a closed configuration (e.g., an “on” configuration, etc.) the lock 810 may be engaged (e.g., activated, implemented, etc.), for example to lock of maintain the low-voltage disconnect 140 in the closed configuration (e.g., the “on” configuration, etc.).

As described herein, the lock 810 may be or include a bolt, catch, fastener, clasp, bar, latch, padlock, and/or another suitable stop or control (e.g., interface, etc.). According to an exemplary embodiment, the lock 810 is reconfigurable between a plurality of configurations, for example a locked configuration and an un-locked configuration. The lock 810 may be selectively reconfigurable between the plurality of configurations, for example via manipulation and/or control of a supervisor, user, owner, and/or operator (e.g., a command, a key, etc.). In this regard, the lock 810 may be controllable via a user, owner, and/or operator, for example to maintain the low-voltage disconnect 140 in a desired configuration (e.g., an “off” configuration, etc.) in order to prevent, limit, and/or reduce unauthorized, unintended, and/or undesired uses of the vehicle (e.g., operations of the telehandler 10, etc.).

Referring still to FIGS. 50-53, exemplary configurations of the disconnect system 800 are shown, according to exemplary embodiments. As described herein, the exemplary configurations of the disconnect system 800 of FIGS. 50-53 may be implemented to, for example, selectively disconnect (e.g., isolate, etc.) a component of a low-voltage system (e.g., the low-voltage battery 136, etc.) from components of the telehandler 10 (e.g., a high-voltage system, etc.), for example to prevent and/or limit unauthorized, unintended, and/or undesired uses of one or more functionalities of the telehandler 10.

As shown in FIG. 50, a first configuration of the disconnect system 800 may be implemented. The exemplary configuration shown in FIG. 50 may be associated with a start-up configuration, for example prior to and/or during a start-up operation (e.g., powering on, powering up, turning on, activating, etc. the telehandler 10). According to an exemplary embodiment, prior to and/or during the start-up operation, one or more components of the telehandler 10 are in an inactive state (e.g., off, powered down, not powered, non-activated, etc.). For example, the high-voltage battery 132, the HVPDU 134, etc. may be inactive, for example not providing power and/or energy to, for example, the drive motor 90, the lift actuator 70, the extension actuator 72, etc.

According to an exemplary embodiment, and as shown in FIG. 50, prior to and/or during the start-up configuration the switch 802 may be configured to a closed or “on” configuration, for example electrically coupling the low-voltage battery 136 to other components of the telehandler 10 (e.g., the LVPDM 138, the controller 200, etc.). Similarly, and as described herein, the low-voltage disconnect 140 may be configured to a closed or “on” configuration. As shown in FIG. 50, with the low-voltage battery 136 coupled to the controller 200, the low-voltage battery 136 may supply power (e.g., low-voltage power, etc.) to the controller 200 (e.g., via the LVPDM 138, etc.). With the controller 200 being supplied power, the controller 200 may active (e.g., start, power up, power on, etc.) the telehandler 10 and/or one or more associated components. For example, and as will be discussed with reference to FIG. 51, the high-voltage battery 132, the HVPDU 134, etc. may be activated (e.g., turned on, powered up, powered on, etc.), for example to provide power to perform one or more functions of the telehandler 10.

As shown in FIG. 51, a second configuration of the disconnect system 800 may be implemented. The configuration shown in FIG. 51 may be associated with an operating or running configuration, for example while the telehandler 10 is activated (e.g., operating, running, powered on, powered up, etc.). According to an exemplary embodiment, during the operating or running configuration, one or more components of the telehandler 10 are in an active state (e.g., on, powered up, powered on, etc.). For example, and as shown in FIG. 51, the high-voltage battery 132 and/or the HVPDU 134 may be active, for example to provide power (e.g., high-voltage power, etc.) to, for example, the drive motor 90, the lift actuator 70, the extension actuator 72, the brakes 102, etc. Further, and as illustrated in FIG. 51, the high-voltage battery 132 (and/or the HVPDU 134) may also provide power to the DC/DC converter 160, which may further provide power (e.g., low-voltage power, etc.) to one or more components of the telehandler 10 (e.g., the LVPDM 138, the controller 200, etc.), as described herein.

As also shown in FIG. 51, during the operating or running configuration the switch 802 (and/or the low-voltage disconnect 140, etc.) may be configured to the closed or “on” configuration, for example electrically coupling the low-voltage battery 136 to other components of the telehandler 10 (e.g., the LVPDM 138, the DC/DC converter 160, etc.). For example, with the low-voltage battery 136 coupled to the DC/DC converter 160 (e.g., via the LVPDM 138, etc.), the low-voltage battery 136 may receive power (e.g., low-voltage power, etc.), for example to charge the low-voltage battery 136. In some implementations, the low-voltage battery 136 may also (e.g., simultaneously, in sequence, at predetermined times, etc.) supply power (e.g., low-voltage power, etc.), for example to one or more components of the telehandler 10 (e.g., the controller 200, other components that perform low-voltage power functionalities, etc.), as described herein.

As shown in FIG. 52, a third configuration of the disconnect system 800 may be implemented. The configuration shown in FIG. 52 may be associated with a disconnect configuration, for example while one or more components of the telehandler 10 is/are activated (e.g., operating, running, powered on, powered up, etc.) as described with reference to FIG. 51. For example, once the telehandler 10 is operating or running (e.g., one or more components of the telehandler 10 are in an active state, etc.), the low-voltage disconnect 140 may activated (e.g., implemented, etc.). In some embodiments, the low-voltage disconnect 140 is activated (e.g., via a supervisor, user, operator, owner, etc.), for example by manipulating a switch, button, handle, lever, knob, key, on/off control, controller, dial, joystick, disk, contactor, etc. associated with the low-voltage disconnect 140. As described herein, activating the low-voltage disconnect 140 may be or include configuring (e.g., reconfiguring, etc.) the low-voltage disconnect 140 to an open or “off” configuration.

As also shown in FIG. 52, with the low-voltage disconnect 140 activated, the switch 802 may be configured (e.g., reconfigured, etc.) to an open or “off” configuration. With the switch 802 in the open or “off” configuration, the low-voltage battery 136 may be electrically de-coupled (e.g., isolated, disconnected, etc.) from other components of the telehandler 10 (e.g., the LVPDM 138, the controller 200, etc.). In this sense, and as shown in FIG. 52, the low-voltage battery 136 may be disconnected (e.g., isolated, etc.) from other components of the telehandler 10 when the low-voltage disconnect 140 is activated and/or the switch 802 is in the open or “off” configuration.

As further shown in FIG. 52, with the low-voltage disconnect 140 activated (e.g., the switch 802 in the open or “off” configuration, the low-voltage battery 136 disconnected, etc.), one or more components of the telehandler 10 may be in an active state (e.g., on, powered up, powered on, etc.). For example, the high-voltage battery 132 and/or the HVPDU 134 may (continue to) be active, for example to provide power (e.g., high-voltage power, etc.) to, for example, the drive motor 90, the lift actuator 70, the extension actuator 72, the brakes 102, etc. Further, and as illustrated in FIG. 52, the high-voltage battery 132 (and/or the HVPDU 134) may also (continue to) provide power to the DC/DC converter 160, which may further provide power (e.g., low-voltage power, etc.) to one or more components of the telehandler 10 (e.g., the LVPDM 138, the controller 200, etc.), as described herein. In this sense, even with the low-voltage disconnect 140 activated (e.g., the switch 802 in the open configuration, the low-voltage battery 136 disconnected, etc.), the telehandler 10 may be configured to implement and/or perform certain function associated with the drive motor 90, the lift actuator 70, the extension actuator 72, the brakes 102, the controller 200, etc. (e.g., via power provided via the high-voltage battery 132, the DC/DC converter, etc.).

In some embodiments, with the low-voltage disconnect 140 activated (e.g., the switch 802 in the open or “off” configuration, the low-voltage battery 136 disconnected, etc.), the lock 810 may also be activated. As described herein, the lock 810 may be activated (e.g., via a supervisor, user, operator, owner, etc.), for example by manipulating and/or configuring the lock 810 via a bolt, catch, fastener, clasp, bar, latch, padlock, and/or another suitable stop or control. According to an exemplary embodiment, the lock 810 may be configured to a locked configuration. In the locked configuration, the lock 810 may maintain the low-voltage disconnect 140 in the activated configuration (e.g., the switch 802 in the open or “off” configuration, the low-voltage battery 136 disconnected, etc.). As will be described in further detail here, the lock 810 may maintain a configuration of the low-voltage disconnect 140 (and/or the switch 802, the low-voltage battery 136, etc.), for example to prevent, limit, and/or reduce unauthorized, unintended, and/or undesired uses of the telehandler 10 (e.g., once the telehandler 10 is eventually deactivated or powered off, etc.).

As shown in FIG. 53, a fourth configuration of the disconnect system 800 may be implemented. The configuration shown in FIG. 53 may be associated with a disconnect configuration, for example once one or more components of the telehandler 10 is/are inactive (e.g., not operating, not running, powered off, powered, down, etc.). For example, once operations and/or functions of the telehandler 10 is/are complete, the telehandler 10 may be powered down or turned off (e.g., via an instruction provided to the controller 200, etc.). According to an exemplary embodiment, once the telehandler 10 is powered down or turned off, one or more components of the telehandler 10 may be configured to an inactive state (e.g., off, powered down, not powered, non-activated, etc.). For example, the high-voltage battery 132, the HVPDU 134, etc. may be inactive, for example not providing power and/or energy to, for example, the drive motor 90, the lift actuator 70, the extension actuator 72, etc. Further, with the high-voltage battery 132 inactive, the DC/DC converter 160 (e.g., via the HVPDU 134) may not provide power and/or energy to, for example, the controller 200.

As also shown in FIG. 53, with the telehandler 10 powered down and/or turned off (e.g., the high-voltage battery 132 not providing power, etc.), the low-voltage disconnect 140 may (continue to) be activated. For example, with the lock 810 in the locked configuration, the lock 810 may maintain the low-voltage disconnect 140 in the activated state. Further, with the low-voltage disconnect 140 in the activated state, the switch 802 may be maintained in the open or “off” configuration, and the low-voltage battery 136 may (continue to) be electrically de-coupled (e.g., isolated, disconnected, etc.) from other components of the telehandler 10 (e.g., the LVPDM 138, the controller 200, etc.). As described herein, without the controller 200 being electrically coupled to a power source and/or supplied power (e.g., low-voltage power), the controller 200 cannot activate (e.g., start, power up, power on, etc.) the telehandler 10 and/or associated components (e.g., the high-voltage battery 132, etc.).

In this sense, with the low-voltage disconnect 140 activated and the telehandler 10 powered down and/or turned off, the telehandler 10 cannot be re-activated (e.g., restarted, powered up, powered on, etc.) until the lock 810 is unlocked and/or the low-voltage disconnect 140 is deactivated (e.g., the switch 802 is reconfigured to the closed or “on” configuration, the low-voltage battery 136 is connected to the controller 200, etc.). Advantageously, once the telehandler is started, the disconnect system may be engaged (e.g., activated, implemented, etc. to disconnect the low-voltage battery, etc.), for example allowing the telehandler to perform standard operations while running, but also preventing and/or limiting unauthorized, unintended, and/or undesired uses of the telehandler once the telehandler is eventually turned off.

It should be understood that the exemplary configurations illustrated in FIGS. 50-53 are intended to be illustrative, and the configurations of FIGS. 50-53 may be implemented using additional, fewer, and/or different configurations. For example, following the exemplary configuration illustrated in FIG. 53, the lock 810 may be deactivated (e.g., moved or reconfigured to an unlocked configuration, etc.), for example via manipulation and/or control by a supervisor, user, and/or operator. Once the lock 810 is deactivated (e.g., unlocked, etc.) the low-voltage disconnect 140 may be deactivated, for example to configure (e.g., reconfigure, etc.) the switch 802 to a closed or “on” configuration. Further, with the switch 802 configured in the closed or “on” configuration, the low-voltage battery 136 may be electrically coupled to one or more components of the telehandler 10 (e.g., the LVPDM 138, the controller 200), and the exemplary configuration illustrated in FIG. 50 may again be implemented.

As an illustrative example, the telehandler 10 includes the electrical system 130, which includes a low-voltage system and a high-voltage system (e.g., as shown in at least FIGS. 50-53). The telehandler 10 (e.g., the electrical system 130, etc.) may also include the disconnect system 800, which selectively disconnects (e.g., isolates, etc.) one or more components of the low-voltage system (e.g., the low-voltage battery 136, etc.) from one or more components of the high-voltage system.

During a start-up operation (e.g., as illustrated in at least FIG. 50), the low-voltage system (e.g., the low-voltage battery 136, etc.) may supply power (e.g., low-voltage power) to the controller 200, for example to start the telehandler 10 and associated components (e.g., the high-voltage battery 132, etc.). With the telehandler in an operating or running configuration (e.g., as shown in at least FIG. 51), the high-voltage system (e.g., the high-voltage battery 132, the HVPDU 134, etc.) may provide high-voltage power to one or more components of the telehandler 10 (e.g., the drive motor 90, the brakes 102, etc.), as well as low-voltage power to one or more components of the telehandler 10 (e.g., the low-voltage battery 136 to charge the battery, the controller 200 to perform low-voltage functions, etc.), for example through the DC/DC converter 160. In this sense, the low-voltage system (e.g., the low-voltage battery 136) may be used to start the telehandler 10 and associated systems (e.g., the high-voltage system, etc.), while the high-voltage system (e.g., the high-voltage battery 132, etc.) may be used to provide high-voltage power, as well as low-voltage power and/or functionalities (e.g., via the DC/DC converter 160, etc.) once the telehandler is operating and/or running.

With the telehandler 10 operating, one or more components of the disconnect system 800 may be engaged. For example, the low-voltage disconnect 140 may be activated, thereby reconfiguring the switch 802 to an open or “off” configuration (e.g., as shown in at least FIG. 52), for example to disconnect one or more components of the low-voltage system (e.g., the low-voltage battery 136, etc.) from other components of the telehandler 10 (e.g., the high-voltage system, etc.). While the low-voltage system (e.g., the low-voltage battery 136, etc.) is disconnected, the high-voltage system (e.g., the high-voltage battery 132, etc.) may continue to provide low-voltage power and/or functionalities (e.g., via the DC/DC converter 160, etc.), for example so long as the telehandler 10 is operating or running (e.g., as shown in at least FIG. 52).

However, once the telehandler is turned off, or non-operational or not running (e.g., as shown in at least FIG. 53), the telehandler 10 cannot be restarted or turned on, for example due to the low-voltage system (e.g., the low-voltage battery 136) being disconnected. In some situations, the low-voltage disconnect 140 may be locked (e.g., via the lock 810, etc.), for example to prevent certain users and/or operators from deactivating the low-voltage disconnect 140 (e.g., reconfiguring the switch 802 to the close or “on” configuration, electrically re-coupling the low-voltage battery 136 to other components of the telehandler 10, etc.). In this sense, once the telehandler is started, the disconnect system may advantageously be engaged (e.g., activated, implemented, etc. to disconnect the low-voltage battery, etc.), for example allowing the telehandler to perform standard operations while running, but also preventing and/or limiting unauthorized, unintended, and/or undesired uses of the telehandler once the telehandler is eventually turned off.

### Charger Housing

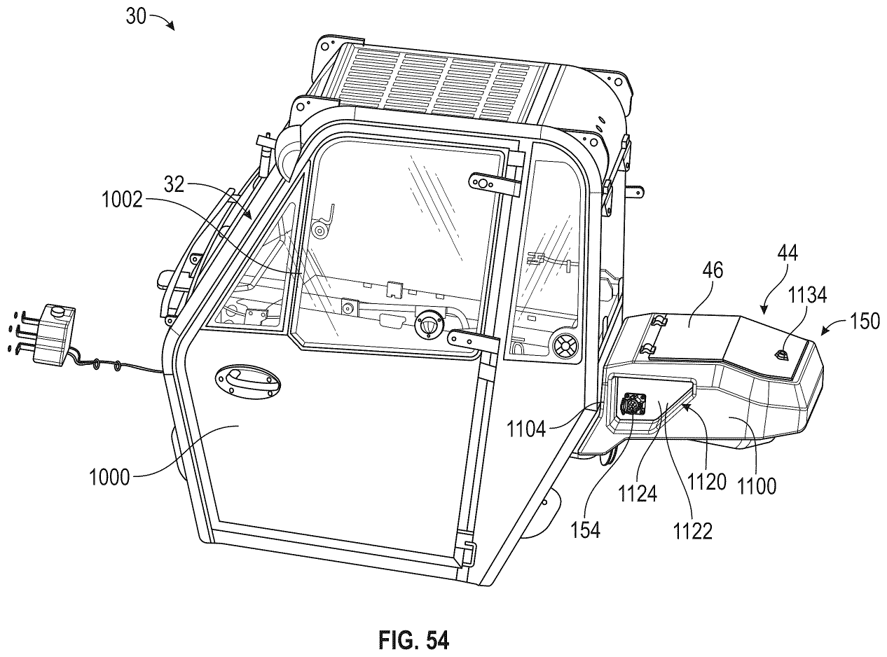

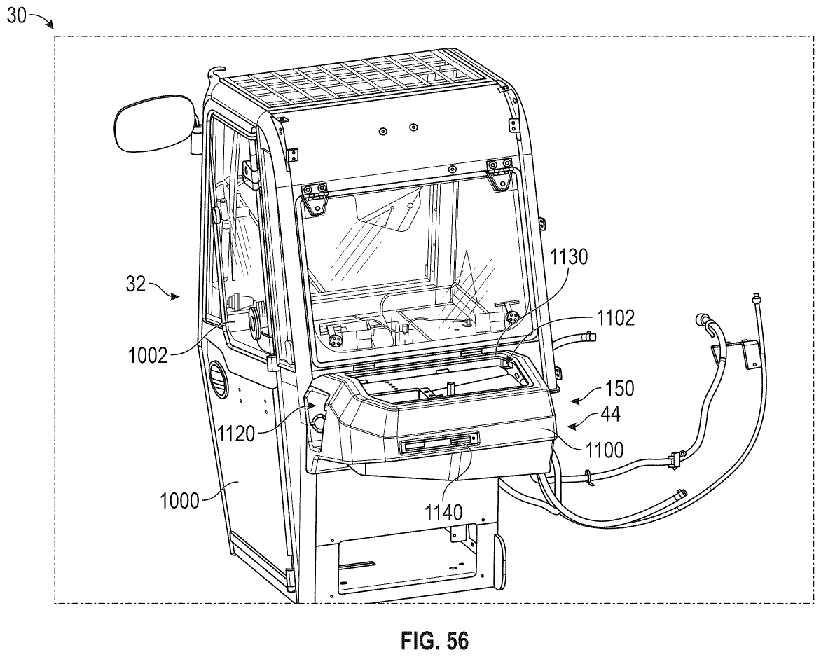

As shown in FIGS. 54-56, the door 32 includes a bottom portion, shown as bottom door portion 1000, pivotably coupled to a cabin frame of the cabin 30, and a top portion, shown as top door portion 1002, pivotably coupled to the cabin frame of the cabin 30. The bottom door portion 1000 and the top door portion 1002 are configured to be selectively pivoted between an open configuration to facilitate access into the internal volume of the cabin 30 and a closed configuration to facilitate access into the internal volume of the cabin 30. In some embodiments, the bottom door portion 1000 and the top door portion 1002 are configured to individually pivot between the open configuration and the closed configuration. For example, an operator of the telehandler 10 may pivot the top door portion 1002 from the closed configuration to the open configuration without pivoting the bottom door portion 1000 from the closed configuration to facilitate access into the internal volume through a portion of an area selectively covered by the door 32 (e.g., a window area etc.). When the top door portion 1002 is in the open configuration, the top door portion 1002 may be releasably coupled to the cabin frame of the cabin 30 and may extend rearward of the cabin frame of the cabin 30.

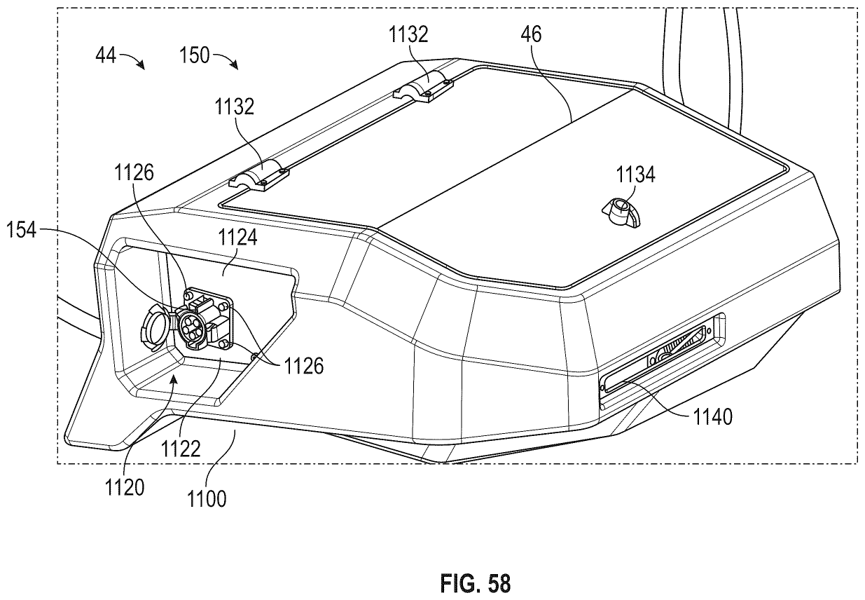

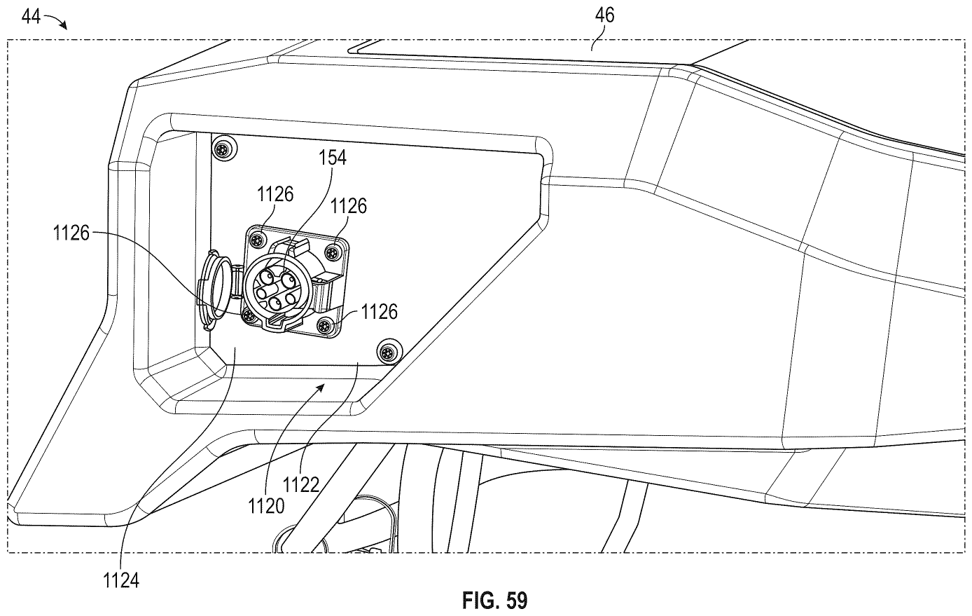

As shown in FIGS. 54-64, the charger housing 44 includes a housing body, shown as charger housing body 1100, coupled to the frame assembly 12. The charger housing body 1100 is positioned rearward of (e.g., behind) the cabin 30 and is coupled to one of the side plates 18 (e.g., an inner of the side plates 18, etc.), as shown in FIGS. 4, 18, 22, and 29. For example, the charger housing body 1100 may be cantilevered from one of the side plates 18 when the charger housing body 1100 is coupled to the one of the side plates 18. The charger housing body 1100 defines an opening, shown as housing opening 1102 (e.g., the inner volume of the charger housing 44, etc.), configured to receive at least a portion of the charging pod 150, such that the charging pod 150 is at least partially contained within the housing opening 1102. In some embodiments, the charger housing body 1100 may define drain apertures extending through a bottom surface of the charger housing body 1100 to facilitate liquids to drain from the housing opening 1102.

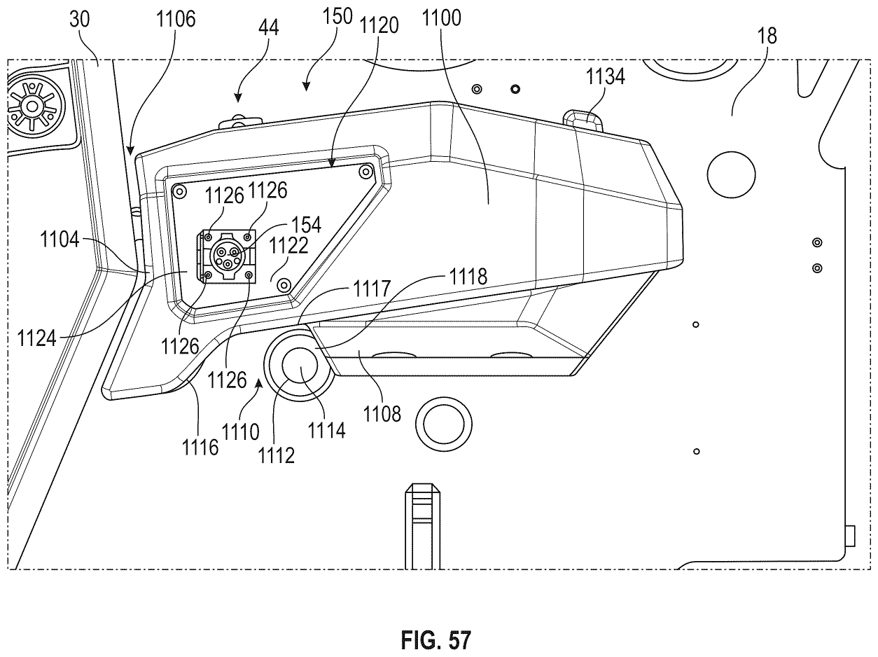

As shown in FIGS. 54 and 57, the charger housing body 1100 includes a first surface (e.g., a front profile, etc.), shown as forward surface 1104, configured to match (e.g., follow, receive, etc.) a rearward surface of the cabin 30. For example, the forward surface 1104 may follow the rearward surface of the cabin 30 such that the forward surface 1104 is evenly spaced from the rearward surface across the forward surface 1104. The forward surface 1104 is substantially concave. According to the embodiment shown in FIG. 57, there is a gap, shown as gap 1106, positioned between the forward surface 1104 and the cabin 30 such that the charger housing 44 does not contact the cabin 30. For example, the charger housing 44 may be spaced from the cabin 30 by the gap 1106 to prevent (e.g., limit, etc.) electricity from transferring from the charging pod 150 contained within the charger housing 44 to the cabin 30. In some embodiments, the gap 1106 may have a substantially equal (e.g., consistent, etc.) width between the forward surface 1104 and the rearward surface of the cabin 30 (e.g., when the forward surface 1104 is evenly spaced from the cabin 30, etc.). In other embodiments, the forward surface 1104 of the charger housing body 1100 is positioned on the rearward surface of the cabin 30 such that the gap 1106 is not defined between the cabin 30 and the charger housing body 1100.

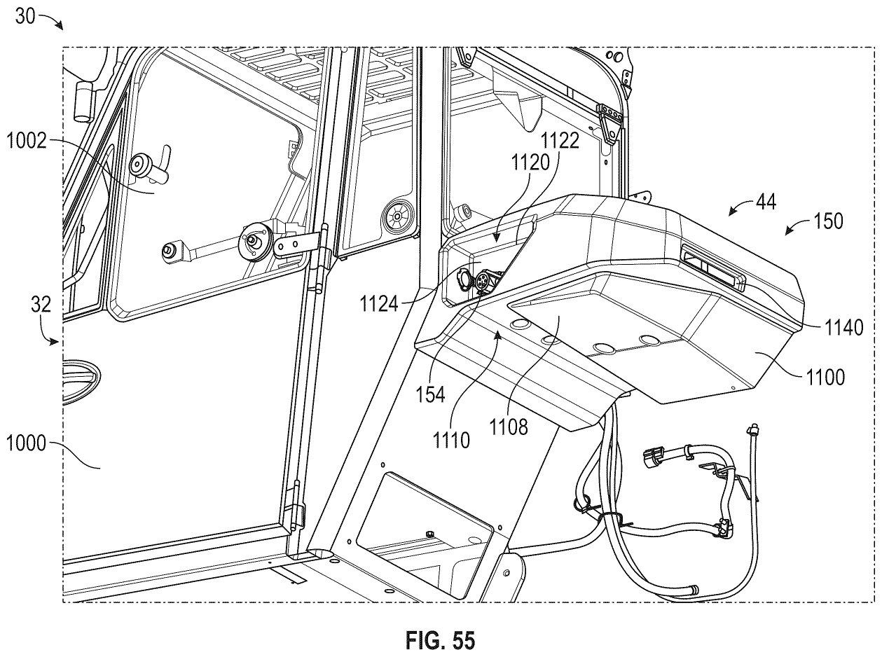

As shown in FIGS. 55 and 57, the charger housing body 1100 includes a second surface, shown as bottom surface 1108, configured to receive at least one of the wheels 84 of the rear axle assembly 82. At least one wheel 84 of the rear axle assembly 82 is located directly below the charger housing body 1100. In some embodiments, the at least one of the wheels 84 of the rear axle assembly 82 extend upwards above a lowermost point of the charger housing body 1100. For example, the bottom surface 1108 may be configured to facilitate at least one of the wheels 84 of the rear axle assembly 82 to extend up above the lowermost point of the charger housing body 1100 without contacting the charger housing body 1100. In some embodiments, at least a portion of the bottom surface 1108 slants downwards toward the side plate 18 such that at least a portion of the housing opening 1102 deepens as the housing opening 1102 extends toward the side plate 18. For example, a portion of the housing opening 1102 may have a first depth towards an outside of the telehandler 10 and a second depth deeper than the first depth towards an inside of the telehandler 10. The depth of the housing opening 1102 proximate the side plates 18 may facilitate the housing opening 1102 to receive multiple of the onboard chargers 152. For example, the housing opening 1102 proximate the side plates 18 may be deep enough to facilitate the housing opening 1102 to receive a first of the onboard chargers 152 stacked on top of a second of the onboard chargers 152.

As shown in FIGS. 55 and 57, the bottom surface 1108 defines a channel, shown as bottom channel 1110, configured to align with at least one pin of the boom assembly 50 facilitate the at least one pin of the boom assembly 50 to be removed under the charger housing body 1100 without having to remove the charger housing body 1100 (e.g., remove the pin without decoupling the charger housing body 1100 from the one of the side plate 18, etc.). For example, as shown in FIG. 57, the bottom channel 1110 may align with an aperture 1112 defined by the side plate 18 configured to receive a pin 1114 of the boom assembly 50 (e.g., a lift compensation cylinder mounting pin, etc.) that pivotably couples the lift actuator 70 to the side plate 18 such that the pin 1114 of the boom assembly 50 may be removed under the charger housing body 1100 without removing the charger housing body 1100. As another example, the bottom surface 1108 may include a first portion 1116 proximate the cabin 30, a second portion 1117 extending rearward and upward from the first portion 1116, and a third portion 1118 extending downward and rearward from the second portion 1117. Collectively, the first portion 1116, the second portion 1117, and the third portion 1118 of the bottom surface 1108 may define the bottom channel 1110.

As shown in FIGS. 54-59 and 26, the charger housing body 1100 defines a recess, shown as charger recess 1120, configured to receive the charging connector 154 of the charging pod 150. For example, the charger recess 1120 may extend towards the housing opening 1102 such that the charging connector 154 is positioned inside of an outer surface of the charger housing body 1100. As a result, contact may be prevented between the charging connector 154 and objects positioned outside of the charger housing body 1100. Preventing contact may also prevent the charging connector 154 from being damaged by the objects positioned outside of the charger housing body 1100.

The charger recess 1120 is configured to receive various sized of the charging connector 154 to facilitate the charging connector 154 to be swapped for other charging connectors 154 without changing the charger housing body 1100. For example, the charger recess 1120 may be configured to receive either a first of the charging connectors 154 being a KST charging connector, a second of the charging connectors 154 being a J1772 charging connector, or a third of the charging connectors 154 being a CSS1 charging connector, despite each of the first of the charging connectors 154, the second of the charging connectors 154, and the third of the charging connectors 154 being different sizes (e.g., diameter, width, height, depth, etc.). In some embodiments, the charger recess 1120 is configured to receive a single size of the charging connectors 154. The charger recess 1120 is configured to be positioned below the top door portion 1002 when the top door portion 1002 is in the open configuration. For example, the charger recess 1120 may be positioned below a bottom edge of the top door portion 1002 such that an operator may access the charging connector 154 positioned within the charger recess 1120 to couple the external power source 156 to the charging connector 154 when the top door portion 1002 is in the open configuration.

As shown in FIGS. 54, 20, 22-24, and 26, the charger housing body 1100 defines a first aperture, shown as charger aperture 1122, and the charger housing 44 includes a plate, shown as charger plate 1124. The charger plate 1124 is configured to cover the charger aperture 1122. The charger aperture 1122 extends through the charger housing body 1100 and is configured to enable access between the charger recess 1120 and the housing opening 1102 (e.g., the charger aperture 1122 extends between the charger recess 1120 and the housing opening 1102, etc.). For example, the charger aperture 1122 may receive the charging connector 154 and enables the charging connector 154 to extend between the charger recess 1120 and the housing opening 1102. To continue this example, an operator may couple the external power source 156 to the charging connector 154 within the charger recess 1120 and the charging connector 154 may extend into the housing opening 1102 through the charger aperture 1122 to couple to the onboard chargers 152 and provide the electrical energy received from external power source 156 to the onboard chargers 152.

The charger plate 1124 is coupled to the charging connector 154 and the charger housing body 1100, and is configured to cover the charger aperture 1122. For example, the charger plate 1124 may couple the charging connector 154 to the charger housing body 1100. In some embodiments, the charger plate 1124 is coupled to the charger housing body 1100 via a snap fit connection. For example, the charger plate 1124 may snap into the charger aperture 1122 to couple the accumulator 124 to the charger housing body 1100. In some embodiments, the charger housing 44 includes a plurality of the charger plates 1124 configured to couple to different charging connectors 154. For example, the charger housing 44 may include a first of the charger plates 1124 configured to couple to a first of the charging connectors 154 being a KST charging connector, a second of the charger plates 1124 configured to couple to a second of the charging connectors 154 being a J1772 charging connector, and/or a third of the charger plates 1124 configured to couple to a third of the charging connectors 154 being a CSS1 charging connector. In some embodiments, a sealing element is positioned between the charging connector 154 and the charger plate 1124 to form a seal (e.g., a water-tight seal, etc.) between the charging connector 154 and the charger plate 1124.

As shown in FIGS. 57-59, the charger plate 1124 and the charging connector 154 are configured to align to receive a plurality of fasteners, shown as charger fasteners 1126, configured to releasably couple the charging connector 154 to the charger plate 1124 to couple the charging connector 154 to the charger housing body 1100. For example, the charger plate 1124 may define a first plurality of apertures and the charging connector 154 may define a second plurality of apertures configured to align to receive the charger fasteners 1126 to releasably couple the charging connector 154 to the charger plate 1124. In other embodiments, the charging connector 154 is releasably coupled to the charger plate 1124 through other means (e.g., snap fit, etc.).

As shown in FIGS. 56, 25, 26, and 27 the charger housing body 1100 defines a second aperture, shown as door aperture 1130, extending through the charger housing body 1100. The door aperture 1130 may provide access into the housing opening 1102 through the charger housing body 1100. The door 46 may be pivotably coupled to the charger housing body 1100. The door 46 may be raised and lowered to selectively permit access to the housing opening 1102 through the door aperture 1130. For example, when the door 46 is in a lowered position, the door 46 may cover the door aperture 1130 to prevent access into the housing opening 1102 through the door aperture 1130 and when the door 46 is in a raised position, the door 46 may not cover the door aperture 1130 to facilitate access into the housing opening 1102 through the door aperture 1130.

As shown in FIGS. 58 and 60-27, the charger housing 44 includes a plurality of hinges, shown as door hinges 1132, coupled between the charger housing body 1100 and the door 46. The hinges are configured to pivotably couple the door 46 to the charger housing body 1100. In other embodiments, the door 46 includes a single of the door hinges 1132 to pivotably couple the door 46 to the charger housing body 1100. In some embodiments, the door hinges 1132 are constant tension hinges configured to hold the door 46 in place relative to the charger housing body 1100. For example, when an operator places the door 46 in the open configuration, the door hinges 1132 may hold the door 46 in the open configuration until the operator moves the door 46 away from the open configuration. As another example, when the operator places the door 46 in an intermediate position between the closed configuration and the open configuration, the door hinges 1132 may hold the door 46 in the intermediate configuration until the operator moves the door 46 away from the intermediate configuration (e.g., moves the door 46 toward the open configuration, moves the door 46 toward the closed configuration, etc.).

As shown in FIGS. 54, 22, and 23, the door 46 includes a handle, shown as locking handle 1134. When the door 46 is in the closed configuration, the locking handle 1134 may be alternated between a locked orientation that prevents the door 46 from being moved toward the open configuration and an unlocked orientation that facilitates the door 46 to be moved toward the open configuration. When the door 46 is in the closed configuration and the locking handle 1134 is in the locked configuration, the locking handle 1134 may engage the charger housing body 1100 to prevent the door 46 from pivoting relative to the charger housing body 1100.

As shown in FIGS. 55, 21, and 23, the charger housing body 1100 defines a third aperture, shown as rear light aperture 1140, extending through the charger housing body 1100 located along a rear surface of the charger housing body 1100. The rear light aperture 1140 may provide access into the housing opening 1102 through the charger housing body 1100. The rear light aperture 1140 may be configured to receive a road light assembly (e.g., a tail light assembly, a rear running light assembly, etc.) configured to provide illumination behind the telehandler 10. For example, the road light assembly may be configured to couple to the charger housing body 1100 by snap fitting into the rear light aperture 1140. In some embodiments, when the telehandler 10 does not include the road light assembly, the charger housing 44 include a cover plate configured to couple to the charger housing body 1100 to cover the rear light aperture 1140.

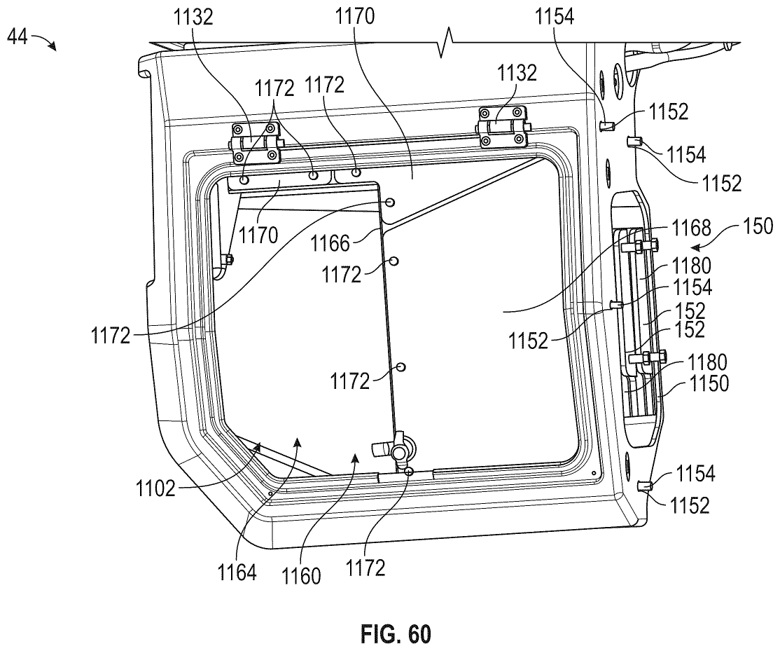

As shown in FIGS. 60-62, the charger housing body 1100 defines a fourth aperture, shown as onboard charger aperture 1150, extending through the charger housing body 1100. The onboard charger aperture 1150 provides access into the housing opening 1102 through the charger housing body 1100. The onboard charger aperture 1150 is configured to align with (e.g., laterally align with, etc.) the onboard chargers 152 positioned within the housing opening 1102 to facilitate the onboard chargers 152 to be coupled to the side plate 18 through the onboard charger aperture 1150. For example, the onboard charger aperture 1150 may extend through an inward surface (e.g., first side, etc.) of the charger housing body 1100 (e.g., a surface of the charger housing body 1100 adjacent to the side plate 18, etc.) such that the onboard chargers 152 may be coupled to the side plate 18 through the onboard charger aperture 1150. The onboard charger aperture 1150 is located along a surface of the charger housing body 1100 opposite the charger recess 1120 (e.g., the charger recess 1120 is located along an outward surface of the charger housing body 1100, etc.). In some embodiments, the charger housing body 1100 defines one of the onboard charger apertures 1150 for each of the onboard chargers 152. For example, a first of the onboard chargers 152 may be coupled to the side plate 18 through a first of the onboard charger apertures 1150 and a second of the onboard chargers 152 may be coupled to the side plate 18 through a second of the onboard charger apertures 1150.

As shown in FIGS. 60-62, the charger housing body 1100 defines a plurality of apertures, shown as mounting apertures 1152, extending through the charger housing body 1100. The mounting apertures 1152 may align with a plurality of apertures defined by one of the side plate 18 to receive a second plurality of fasteners, shown as mounting fasteners 1154, to releasably couple the charger housing 44 to the one of the side plate 18. The mounting apertures 1152 extend through a same surface of the charger housing body 1100 as the onboard charger aperture 1150 (e.g., the surface of the charger housing body 1100 adjacent to the side plate 18, etc.). In some embodiments, the charger housing body 1100 is releasably coupled to the side plates 18 through other means (e.g., a snap fit, etc.).

As shown in FIGS. 60-62, the charger housing 44 includes a divider system, shown as divider assembly 1160, positioned within the housing opening 1102. The divider assembly 1160 divides the housing opening 1102 into a first portion, shown as high voltage portion 1162, and a second portion, shown as low voltage portion 1164. The divider assembly 1160 encloses the high voltage portion 1162. The divider assembly 1160 separates the high voltage portion 1162 from the low voltage portion 1164 to electrically isolate the high voltage portion 1162 from the low voltage portion 1164 to prevent electrical energy from transferring between the high voltage portion 1162 and the low voltage portion 1164. For example, the portion of the charging pod 150 positioned within the housing opening 1102 may be positioned within the high voltage portion 1162 and low voltage electrical systems (e.g., third party electrical systems, the wall adapter 158, etc.) positioned within the housing opening 1102 may be positioned within the high voltage portion 1162. The divider assembly 1160 may prevent high voltage electrical energy within the charging pod 150 from transferring to the low voltage electrical systems. As another example, the onboard chargers 152 may be positioned within the high voltage portion 1162. In some embodiments, the low voltage portion 1164 is a storage component.

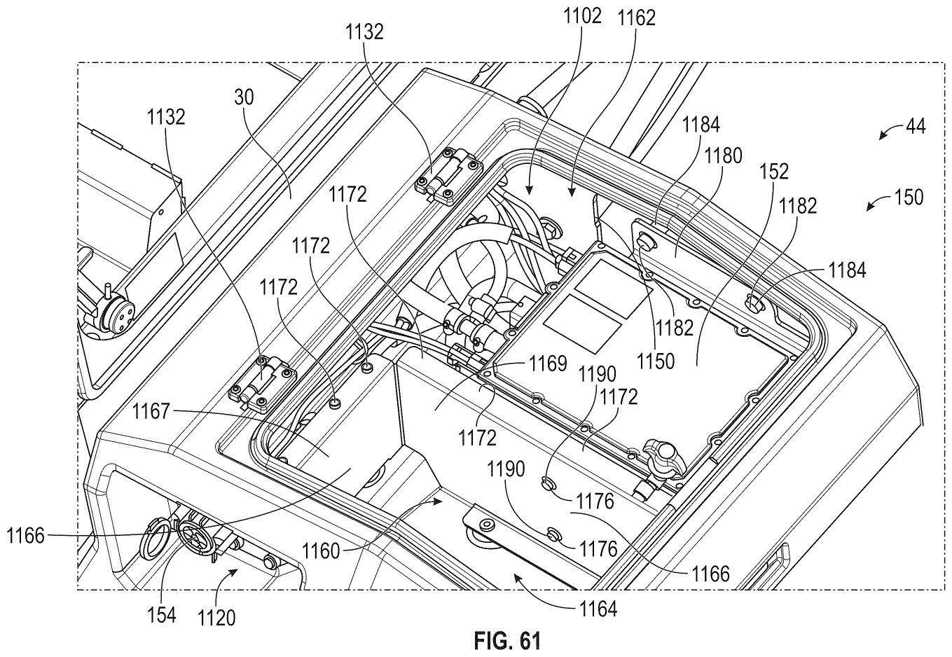

As shown in FIG. 61, the divider assembly 1160 includes a first divider member, shown as side divider plate 1166. The side divider plate 1166 is positioned within the housing opening 1102 and separates the housing opening 1102 into the high voltage portion 1162 and the low voltage portion 1164. A first end of the side divider plate 1166 is coupled to the charger housing body 1100 at a first location adjacent to the charger aperture 1122 such that wiring electrically coupling the charging connector 154 to the onboard chargers 152 is positioned behind the side divider plate 1166 and within the high voltage portion 1162. A second end of the side divider plate 1166 is coupled to the charger housing body 1100 at a second location proximate the rear light aperture 1140. A bottom edge of the side divider plate 1166 is coupled to a bottom portion of the charger housing body 1100 (e.g., a portion of the charger housing body 1100 defining the bottom channel 1110, etc.). The side divider plate 1166 includes a first portion 1167 and a second portion 1169. The first portion 1167 extends between a first end coupled to a first sidewall of the charger housing body 1100 and a second end. The second portion 1169 extends substantially perpendicularly from the first portion 1167 and extends perpendicularly from the first sidewall of the charger housing body 1100. The second portion 1169 extends between a first end coinciding with the second end of the first portion 1167 and a second end. The second end is coupled to a second sidewall of the charger housing body 1100.

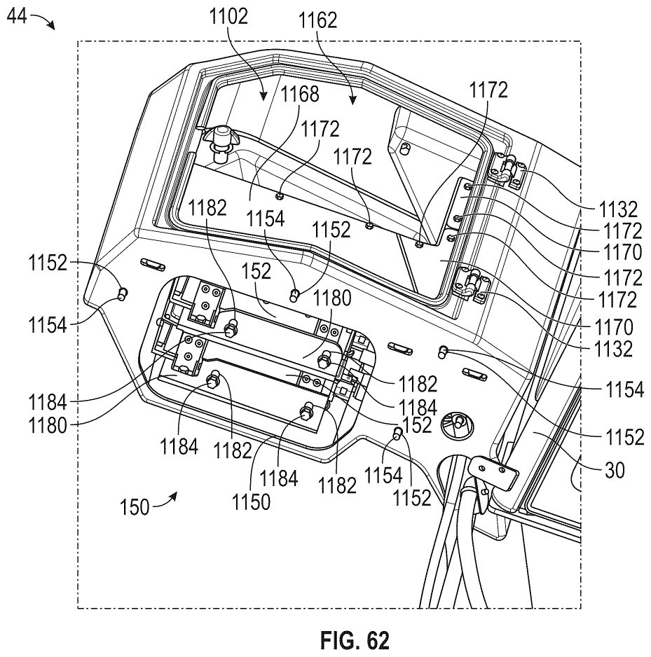

As shown in FIGS. 60 and 62, the divider assembly 1160 includes a second divider member, shown as top divider plate 1168, and a plurality of auxiliary divider plates, shown as auxiliary top divider plates 1170, releasably coupled to the side divider plate 1166. The top divider plate 1168 is positioned within the housing opening 1102. The top divider plate 1168 and the auxiliary divider plates 1170 are positioned within the housing opening 1102 and separate the housing opening 1102 into the high voltage portion 1162 and the low voltage portion 1164. The top divider plate 1168 is positioned above the onboard chargers 152 contained within the high voltage portion 1162. The auxiliary top divider plates 1170 extend over the wiring electrically coupling the charging connector 154 to the onboard chargers 152 to position the wiring within the high voltage portion 1162. The auxiliary divider plates 1170 are located closer to the cabin 30 than the top divider plate 1168.

As shown in FIGS. 60-62, (a) the side divider plate 1166 and the top divider plate 1168 and (b) the side divider plate 1166 and the auxiliary top divider plates 1170 are configured to receive a plurality of fasteners, shown as divider fasteners 1172. The divider fasteners 1172 are configured to releasably couple (a) the top divider plate 1168 to the side divider plate 1166 and (b) the auxiliary top divider plates 1170 to the side divider plate 1166. For example, the side divider plate 1166 may define a first plurality of apertures, the top divider plate 1168 may define a second plurality of apertures, and the auxiliary top divider plates 1170 may define a third plurality of apertures. The second plurality of apertures of the top divider plate 1168 may selectively align with a first portion of the first plurality of apertures of the side divider plate 1166 to receive a first portion of the divider fasteners 1172 to releasably couple the top divider plate 1168 to the side divider plate 1166. The third plurality of apertures of the auxiliary top divider plates 1170 may selectively align with a second portion of the first plurality of apertures of the side divider plate 1166 to receive a second portion of the divider fasteners 1172 to releasably couple the auxiliary top divider plates 1170 to the side divider plate 1166. In other embodiments, the auxiliary top divider plates 1170 and/or the top divider plate 1168 are coupled to the side divider plate 1166 through alternate means (e.g., snap fit, etc.).

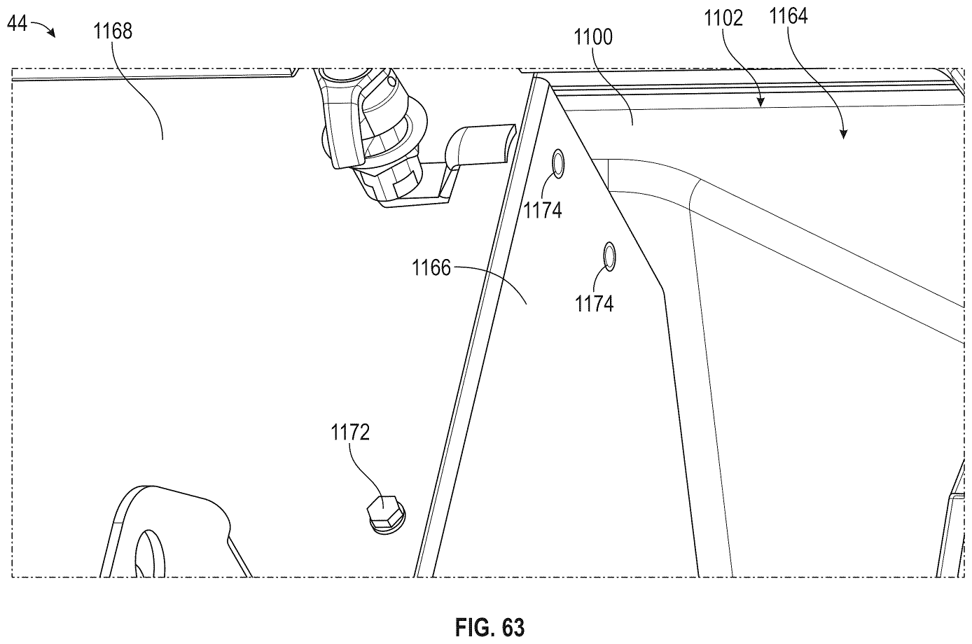

As shown in FIG. 63, the side divider plate 1166 defines a first plurality of apertures, shown as tail light bracket apertures 1174, configured to selectively align with a plurality of apertures of a road light bracket of the road light assembly to receive a plurality of fasteners to couple the road light bracket to the side divider plate 1166. The road light bracket may extend into the high voltage portion 1162 of the housing opening 1102 to cover the rear light aperture 1140 such that a road light of the road light assembly received by the rear light aperture 1140 is positioned within the high voltage portion 1162. As shown in FIG. 61, the side divider plate 1166 defines a second plurality of apertures, shown as charger bracket aperture 1176 extending through the side divider plate 1166.

As shown in FIGS. 60, 26, 27, and 29, the charger housing 44 includes a first plurality of brackets, shown as side panel brackets 1180, coupled between the onboard chargers 152 and the side plate 18. The side panel brackets 1180 may releasably couple the onboard chargers 152 to the side plate 18. For example, a first of the side panel brackets 1180 may releasably couple a first of the onboard chargers 152 to the side plate 18 and a second of the side panel brackets 1180 may releasably couple a second of the onboard chargers 152 to the side plate 18. As shown in FIGS. 61, 27, and 29, the side panel brackets 1180 define a plurality of apertures, shown as side panel bracket apertures 1182 configured to receive a plurality of fasteners, shown as slot bolts 1184. The slot bolts 1184 may be received within slots defined by the side plate 18 to releasably couple the onboard chargers 152 to the side plate 18. For example, the side plate 18 may define a first pair of slots and a second pair of slots. The first pair of slots may selectively receive the slot bolts 1184 coupled to a first of the side panel brackets 1180 coupled to a first of the onboard chargers 152 to couple the first of the onboard chargers 152 to the one of the side plate 18. The second pair of slots may selectively receive the slot bolts 1184 coupled to a second of the side panel brackets 1180 coupled to a second of the onboard chargers 152 to couple the second of the onboard chargers 152 to the one of the side plate 18.

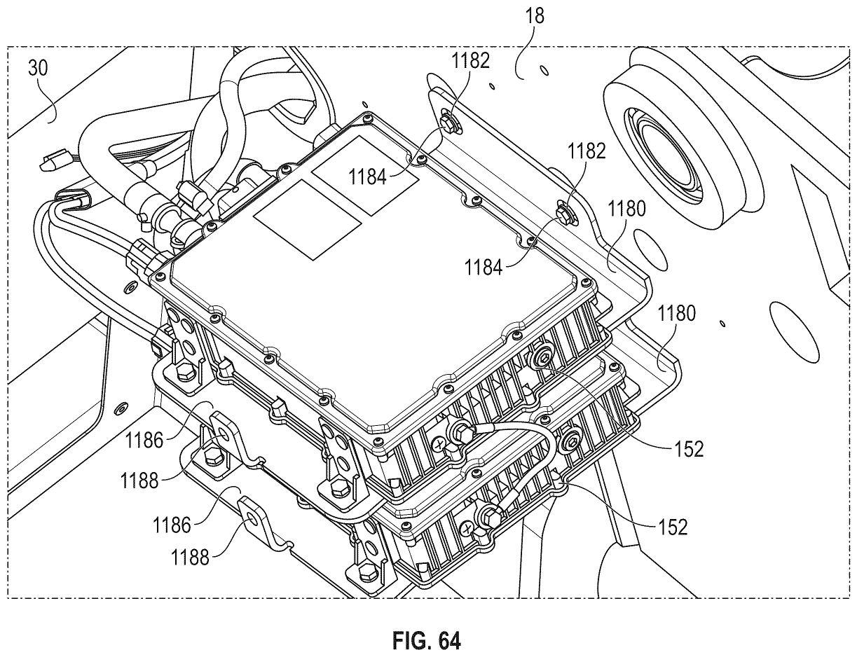

As shown in FIG. 64, the charger housing 44 includes a second plurality of brackets, shown as side divider brackets 1186. The side divider brackets 1186 are configured to couple between the onboard chargers 152 and the side divider plate 1166, as shown in FIG. 61. The side divider brackets 1186 releasably couple the onboard chargers 152 to the side divider plate 1166. For example, a first of the side divider brackets 1186 may releasably couple a first of the onboard chargers 152 to the side divider plate 1166 and a second of the side divider brackets 1186 may releasably couple a second of the onboard chargers 152 to the side divider plate 1166. The side divider brackets 1186 are coupled to a side of the onboard chargers 152 opposite the side panel brackets 1180. As shown in FIG. 64, the side divider brackets 1186 each define an aperture, shown as side wall bracket aperture 1188. As shown in FIG. 61, the side wall bracket aperture 1188 is configured to selectively align with the charger bracket aperture 1176 of the side divider plate 1166 to receive a plurality of fasteners, shown as side wall bracket fasteners 1190. The side wall bracket fasteners 1190 releasably couple the onboard chargers 152 to the side divider plate 1166. By way of example, a first of the side wall bracket fasteners 1190 may be received by one of the charger bracket aperture 1176 and the side wall bracket aperture 1188 of a first of the side divider brackets 1186 to releasably couple a first of the onboard chargers 152 to the side divider plate 1166 and a second of the side wall bracket fasteners 1190 may be received by one of the charger bracket aperture 1176 and the side wall bracket aperture 1188 of a second of the side divider brackets 1186 to releasably couple a second of the onboard chargers 152 to the side divider plate 1166. When the onboard chargers 152 are coupled to the side divider plate 1166 via the side divider brackets 1186 and the side plates 18 via the side panel brackets 1180, the onboard chargers 152 may be spaced apart. For example, when the onboard chargers 152 are coupled to the side divider plate 1166 and one of the side plates 18, there may be a gap between a first of the onboard chargers 152 and a second of the onboard chargers 152.

### Modular Onboard Chargers

As shown in FIGS. 54 and 62, the charger housing 44 includes a housing body, shown as charger housing body 1100, coupled to the frame assembly 12. According to an exemplary embodiment, the charger housing body 1100 is positioned rearward of the cabin 30 and is coupled to one of the side plates 18 (e.g., an inner of the side plates 18, etc.). For example, the charger housing body 1100 may be cantilevered from one of the side plates 18 when the charger housing body 1100 is coupled to the one of the side plates 18. The charger housing body 1100 defines an opening, shown as housing opening 1102 (e.g., the inner volume of the charger housing 44, etc.), configured to receive at least a portion of the charging pod 150, such that the charging pod 150 is at least partially contained within the housing opening 1102. In some embodiments, the charger housing body 1100 may define drain apertures extending through a bottom surface of the charger housing body 1100 to allow for liquids to drain from the housing opening 1102.

As shown in FIG. 62 the charger housing body 1100 defines a second aperture, shown as door aperture 1130, extending through the charger housing body 1100. The door aperture 1130 may provide access into the housing opening 1102 through the charger housing body 1100. The door 46 may be pivotably coupled to the charger housing body 1100. The door 46 may be raised and lowered to selectively permit access to the housing opening 1102 through the door aperture 1130. For example, when the door 46 is in a lowered position, the door 46 may cover the door aperture 1130 to prevent access into the housing opening 1102 through the door aperture 1130 and when the door 46 is in a raised position, the door 46 may not cover the door aperture 1130 to allow access into the housing opening 1102 through the door aperture 1130.

As shown in FIG. 62, the charger housing 44 includes a plurality of hinges, shown as door hinges 1132, coupled between the charger housing body 1100 and the door 46. The hinges 1132 are configured to pivotably couple the door 46 to the charger housing body 1100. In other embodiments, the door 46 includes a single of the door hinges 1132 to pivotably couple the door 46 to the charger housing body 1100. In some embodiments, the door hinges 1132 are constant tension hinges configured to hold the door 46 in place relative to the charger housing body 1100. For example, when an operator places the door 46 in the open configuration, the door hinges 1132 may hold the door 46 in the open configuration until the operator moves the door 46 away from the open configuration. As another example, when the operator places the door 46 in an intermediate position between the closed configuration and the open configuration, the door hinges 1132 may hold the door 46 in the intermediate configuration until the operator moves the door 46 away from the intermediate configuration (e.g., moves the door 46 toward the open configuration, moves the door 46 toward the closed configuration, etc.).

As shown in FIG. 62, the charger housing body 1100 defines a fourth aperture, shown as onboard charger aperture 1150, extending through the charger housing body 1100. The onboard charger aperture 1150 provides access into the housing opening 1102 through the charger housing body 1100. The onboard charger aperture 1150 is configured to align with (e.g., laterally align with, etc.) the onboard chargers 152 positioned within the housing opening 1102 to facilitate the onboard chargers 152 to be coupled to the side plate 18 through the onboard charger aperture 1150. For example, the onboard charger aperture 1150 may extend through an inward surface (e.g., first side, etc.) of the charger housing body 1100 (e.g., a surface of the charger housing body 1100 adjacent to the side plate 18, etc.) such that the onboard chargers 152 may be coupled to the side plate 18 through the onboard charger aperture 1150. The onboard charger aperture 1150 is located along a surface of the charger housing body 1100 opposite the charger recess 1120 (e.g., the charger recess 1120 is located along an outward surface of the charger housing body 1100, etc.). In some embodiments, the charger housing body 1100 defines one of the onboard charger apertures 1150 for each of the onboard chargers 152. For example, a first of the onboard chargers 152 may be coupled to the side plate 18 through a first of the onboard charger apertures 1150 and a second of the onboard chargers 152 may be coupled to the side plate 18 through a second of the onboard charger apertures 1150.

As shown in FIG. 62, the charger housing body 1100 defines a plurality of apertures, shown as mounting apertures 1152, extending through the charger housing body 1100. The mounting apertures 1152 may align with a plurality of apertures defined by one of the side plate 18 to receive a second plurality of fasteners, shown as mounting fasteners 1154, to releasably couple the charger housing 44 to the one of the side plate 18. The mounting apertures 1152 extend through a same surface of the charger housing body 1100 as the onboard charger aperture 1150 (e.g., the surface of the charger housing body 1100 adjacent to the side plate 18, etc.). In some embodiments, the charger housing body 1100 is releasably coupled to the side plates 18 through other means (e.g., a snap fit, etc.).

As shown in FIG. 62, the charger housing 44 includes a divider system, shown as divider assembly 1160, positioned within the housing opening 1102. The divider assembly 1160 divides the housing opening 1102 into a first portion, shown as high voltage portion 1162, and a second portion, shown as low voltage portion 1164. The divider assembly 1160 encloses the high voltage portion 1162. The divider assembly 1160 separates the high voltage portion 1162 from the low voltage portion 1164 to electrically isolate the high voltage portion 1162 from the low voltage portion 1164 to prevent electrical energy from transferring between the high voltage portion 1162 and the low voltage portion 1164. For example, the portion of the charging pod 150 positioned within the housing opening 1102 may be positioned within the high voltage portion 1162 and low voltage electrical systems (e.g., third party electrical systems, the wall adapter 158, etc.) positioned within the housing opening 1102 may be positioned within the high voltage portion 1162. The divider assembly 1160 may prevent high voltage electrical energy within the charging pod 150 from transferring to the low voltage electrical systems. As another example, the onboard chargers 152 may be positioned within the high voltage portion 1162. In some embodiments, the low voltage portion 1164 is a storage component.

As shown in FIG. 62, the divider assembly 1160 includes a first divider member, shown as side divider plate 1166 and a second divider member, shown as top divider plate 1168, releasably coupled to the side divider plate 1166. The side divider plate 1166 and the top divider plate 1168 may be positioned within the housing opening 1102 and may separate the housing opening 1102 into the high voltage portion 1162 and the low voltage portion 1164. A bottom edge of the side divider plate 1166 may be coupled to a bottom portion of the charger housing body 1100. According to an exemplary embodiment, the side divider plate 1166 includes a first portion coupled to a first sidewall of the charger housing body 1100 and a second portion extending substantially perpendicularly from the first portion and coupled to a second sidewall of the charger housing body 1100 extending perpendicularly from the first sidewall of the charger housing body 1100.

As shown in FIG. 62, the divider assembly 1160 includes a second divider member, shown as top divider plate 1168, and a plurality of auxiliary divider plates, shown as auxiliary top divider plates 1170, releasably coupled to the side divider plate 1166. The top divider plate 1168 is positioned within the housing opening 1102. The top divider plate 1168 and the auxiliary divider plates 1170 are positioned within the housing opening 1102 and separate the housing opening 1102 into the high voltage portion 1162 and the low voltage portion 1164. The top divider plate 1168 is positioned above the onboard chargers 152 contained within the high voltage portion 1162. According to the exemplary embodiment shown in FIG. 62, the divider assembly 1160 includes a plurality of auxiliary divider plates, shown as auxiliary top divider plates 1170 coupled to the side divider plate 1166. the auxiliary top divider plates 1170 may be positioned within the housing opening 1102 and may separate the housing opening 1102 into the high voltage portion 1162 and the low voltage portion 1164. The auxiliary top divider plates 1170 extend over the wiring electrically coupling the charging connector 154 to the onboard chargers 152 to position the wiring within the high voltage portion 1162. The auxiliary divider plates 1170 are located closer to the cabin 30 than the top divider plate 1168.

As shown in FIG. 62, (a) the side divider plate 1166 and the top divider plate 1168 and (b) the side divider plate 1166 and the auxiliary top divider plates 1170 are configured to receive a plurality of fasteners, shown as divider fasteners 1172. The divider fasteners 1172 are configured to releasably couple (a) the top divider plate 1168 to the side divider plate 1166 and (b) the auxiliary top divider plates 1170 to the side divider plate 1166. For example, the side divider plate 1166 may define a first plurality of apertures, the top divider plate 1168 may define a second plurality of apertures, and the auxiliary top divider plates 1170 may define a third plurality of apertures. The second plurality of apertures of the top divider plate 1168 may selectively align with a first portion of the first plurality of apertures of the side divider plate 1166 to receive a first portion of the divider fasteners 1172 to releasably couple the top divider plate 1168 to the side divider plate 1166. The third plurality of apertures of the auxiliary top divider plates 1170 may selectively align with a second portion of the first plurality of apertures of the side divider plate 1166 to receive a second portion of the divider fasteners 1172 to releasably couple the auxiliary top divider plates 1170 to the side divider plate 1166. In other embodiments, the auxiliary top divider plates 1170 and/or the top divider plate 1168 are coupled to the side divider plate 1166 through alternate means (e.g., snap fit, etc.).

As shown in FIGS. 62 and 64, the charger housing 44 includes a first plurality of brackets, shown as side panel brackets 1180, coupled between the onboard chargers 152 and the side plate 18. The side panel brackets 1180 may releasably couple the onboard chargers 152 to the side plate 18. For example, a first of the side panel brackets 1180 may releasably couple a first of the onboard chargers 152 to the side plate 18 and a second of the side panel brackets 1180 may releasably couple a second of the onboard chargers 152 to the side plate 18. As shown in FIGS. 62 and 64, the side panel brackets 1180 define a plurality of apertures, shown as side panel bracket apertures 1182 configured to receive a plurality of fasteners, shown as slot bolts 1184. The slot bolts 1184 may be received within slots defined by the side plate 18 to releasably couple the onboard chargers 152 to the side plate 18. For example, one of the side plate 18 may define a first pair of slots and a second pair of slots. The first pair of slots may selectively receive the slot bolts 1184 coupled to a first of the side panel brackets 1180 coupled to a first of the onboard chargers 152 to couple the first of the onboard chargers 152 to the side plate 18. The second pair of slots may selectively receive the slot bolts 1184 coupled to a second of the side panel brackets 1180 coupled to a second of the onboard chargers 152 to couple the second of the onboard chargers 152 to the one of the side plate 18.

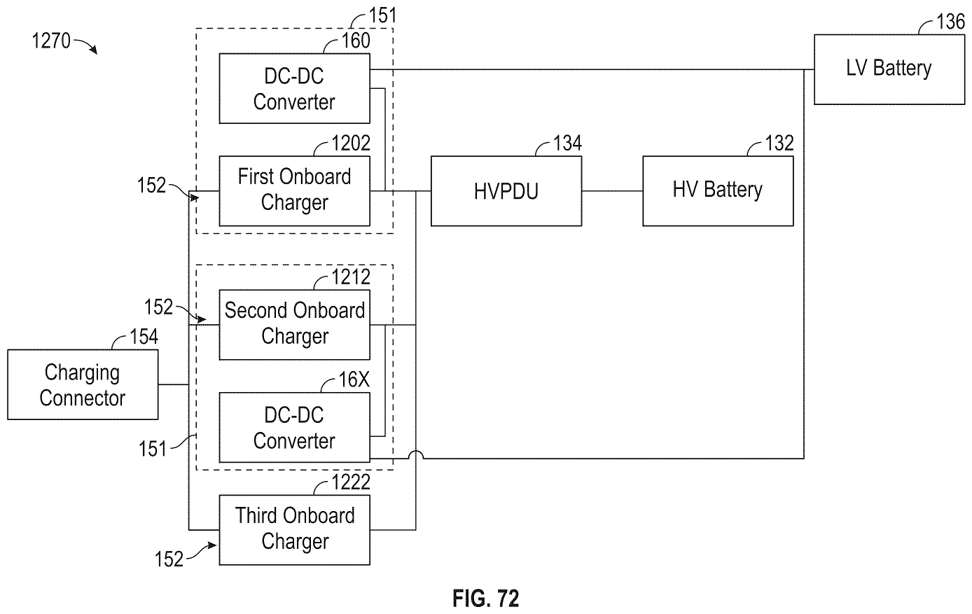

As shown in FIG. 64, the charger housing 44 includes a second plurality of brackets, shown as side divider brackets 1186. The side divider brackets 1186 are configured to couple between the onboard chargers 152 and the side divider plate 1166, as shown in FIG. 61. The side divider brackets 1186 releasably couple the onboard chargers 152 to the side divider plate 1166. For example, a first of the side divider brackets 1186 may releasably couple a first of the onboard chargers 152 to the side divider plate 1166 and a second of the side divider brackets 1186 may releasably couple a second of the onboard chargers 152 to the side divider plate 1166. The side divider brackets 1186 are coupled to a side of the onboard chargers 152 opposite the side panel brackets 1180. As shown in FIG. 72, the side divider brackets 1186 each define an aperture, shown as side wall bracket aperture 1188. As shown in FIG. 61, the side wall bracket aperture 1188 is configured to selectively align with the charger bracket aperture 1176 of the side divider plate 1166 to receive a plurality of fasteners, shown as side wall bracket fasteners 1190. The side wall bracket fasteners 1190 releasably couple the onboard chargers 152 to the side divider plate 1166. By way of example, a first of the side wall bracket fasteners 1190 may be received by one of the charger bracket aperture 1176 and the side wall bracket aperture 1188 of a first of the side divider brackets 1186 to releasably couple a first of the onboard chargers 152 to the side divider plate 1166 and a second of the side wall bracket fasteners 1190 may be received by one of the charger bracket aperture 1176 and the side wall bracket aperture 1188 of a second of the side divider brackets 1186 to releasably couple a second of the onboard chargers 152 to the side divider plate 1166. When the onboard chargers 152 are coupled to the side divider plate 1166 via the side divider brackets 1186 and the side plates 18 via the side panel brackets 1180, the onboard chargers 152 may be spaced apart. For example, when the onboard chargers 152 are coupled to the side divider plate 1166 and one of the side plates 18, there may be a gap between a first of the onboard chargers 152 and a second of the onboard chargers 152.

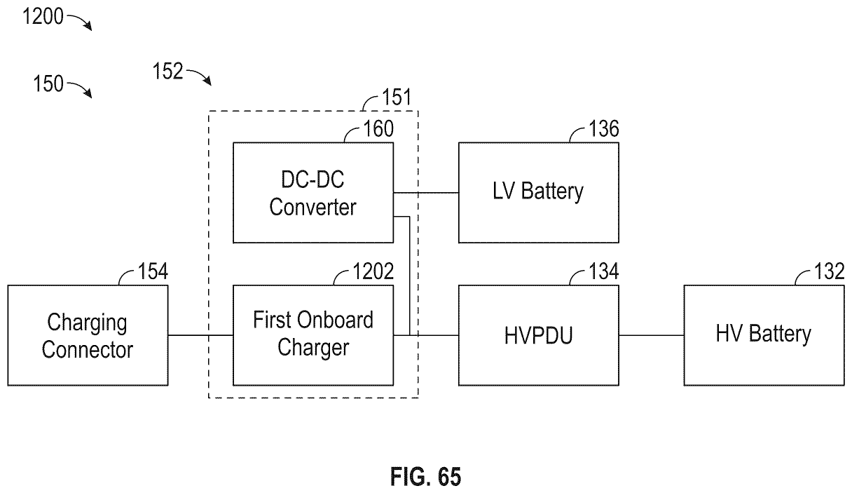

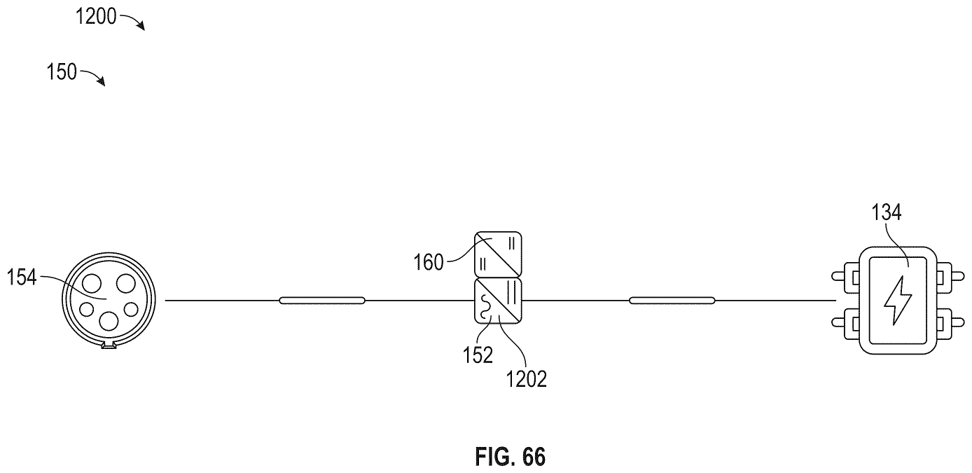

As shown in FIGS. 65 and 66, the charging pod 150 may be placed in a first configuration (e.g., a normal charging configuration, etc.), shown as first charging configuration 1200, that includes the charging connector 154, a first of the onboard chargers 152, shown as first onboard charger 1202, the HVPDU 134, and the High-voltage battery 132 arranged in series. In a parallel branch after the first onboard charger 1202 the DC/DC converter 160 is coupled to the LV battery 136. In the first charging configuration 1200 the first onboard charger 1202 and the DC/DC converter 160 are positioned in the same enclosure 151 such that the connections are internal and may not require external cabling. For example, in the first charging configuration 1200, electrical energy received by the charging connector 154 (e.g., from the external power source 156 via the wall adapter 158, etc.) may travel through the first onboard charger 1202 and into two parallel circuits. In a first circuit, the power passes through the HVPDU 134 then to the high-voltage battery 132 to charge the high-voltage battery 132. In the second branch power travels to the DC/DC converter 160 which converts the power from a first high voltage to a second low voltage, the low voltage being lower than the high voltage (e.g., substantially 12 V) and then to the LV battery 136 to charge the LV battery. In such an arrangement the DC/DC converter 160 operates is used similar to an alternator in a conventional internal combustion engine vehicle to charge the low-voltage system. In the first charging configuration 1200, the first onboard charger 1202 and the DC/DC converter 160 are positioned in the same charging pod 150. When the charging pod 150 is in the first charging configuration 1200, the first onboard charger 1202 may be positioned within the high voltage portion 1162.

When the charging pod 150 is arranged in the first charging configuration 1200, the charging pod 150 may receive a first maximum input current. The first maximum input current of the charging pod 150 in the first charging configuration 1200 may be limited by a conversion capacity (e.g., a current capacity, etc.) of the first onboard charger 1202 when converting the AC electrical energy received by the charging connector 154 into DC electrical energy for charging the high-voltage battery 132. For example, when the charging pod 150 is in the first charging configuration 1200, the AC electrical energy received by the charging connector 154 may be at 120 V AC or 240 V AC with the first maximum input current of 32 A. The first onboard charger 1202 may receive the first maximum input current of 32 A from the charging connector 154, convert the AC electrical energy to DC electrical energy, and provide the DC electrical energy to the DC/DC converter 160 at a first voltage and to the HVPDU 134 at the first voltage. The DC/DC converter 160 may convert the DC electrical energy or a portion thereof to a first converted DC electrical energy at a second voltage lower than the first voltage, and provide the DC electrical energy at the second voltage to the LV battery 136. The second voltage may be for example substantially 12 V for a low-voltage system. The first converted DC electrical energy may have a first charging power and provided to the HVPDU 134 to the High-voltage battery 132. The first converted DC electrical energy may be between 260 V DC to 480 V DC with a maximum 20 A DC current and/or a maximum 6.6 kW charging power. As shown in FIG. 66, the charging connector 154 is connected to the onboard charger 152 shown as the first onboard charger 1202, with the DC/DC converter 160 coupled internally with the onboard charger 1202. In some embodiments, the max input current may be between 32 A and 38 A. In some embodiments, the first onboard charger is has a charging capacity between 3.3 kW and 6.6 kW. In some embodiments, the DC/DC converter 160 has a 2 kW capacity. The first onboard charger 1202 is coupled to the HVPDU 134. In some embodiments, the max output current from the onboard charger 1202 is 20 A.

According to the exemplary embodiment shown in FIGS. 65 and 66, when the charging pod 150 is arranged in the first charging configuration 1200, the DC/DC converter 160 is coupled to the first onboard charger 1202 in parallel with the HVPDU 134. For example, the DC/DC converter 160 may be coupled to a top surface of the first onboard charger 1202. The charging connector 154 may receive AC electrical energy and provide the AC electrical energy to the first onboard charger 1202. The first onboard charger 1202 may convert the AC electrical energy into high voltage DC electrical energy and provide the high voltage electrical energy to the DC/DC converter 160 and the HVPDU 134. The DC/DC converter 160 may convert the high voltage DC electrical energy into low voltage DC electrical energy and provide the low voltage DC electrical energy to the low-voltage battery 136. The high voltage DC electrical energy may be passed to the HVPDU 134 to charge the high-voltage battery 132. In some embodiments, the DC/DC converter 160 may be built in to the first onboard charger 1202.

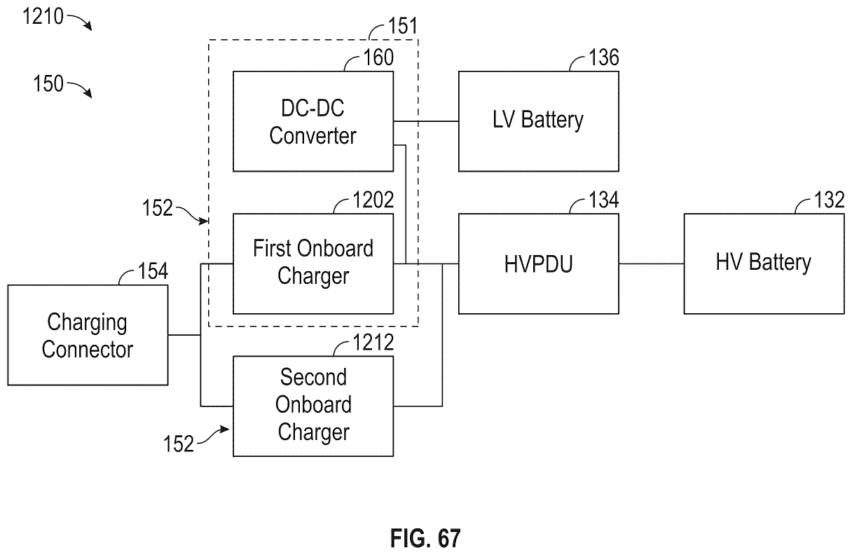

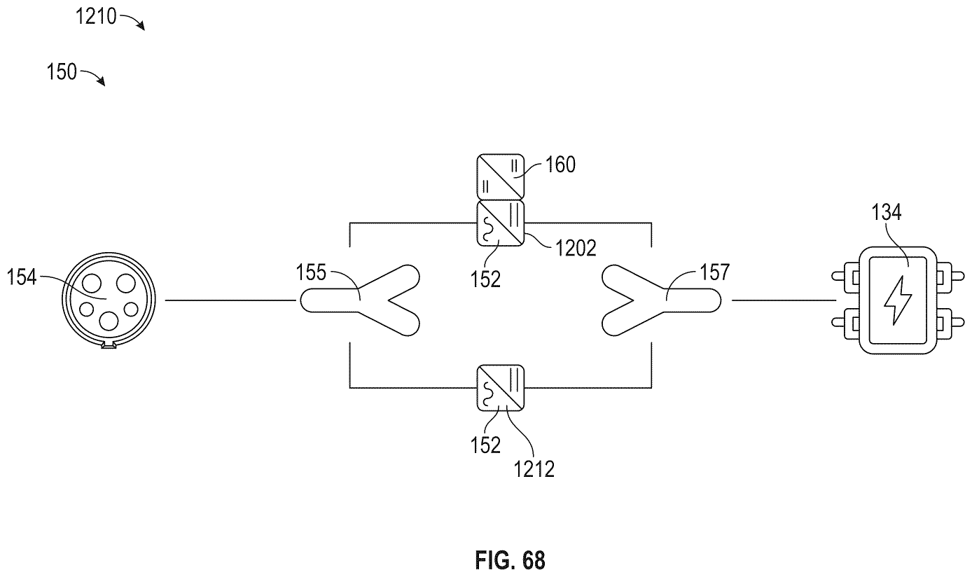

As shown in FIGS. 67 and 68, the charging pod 150 may be placed in a second configuration, shown as second charging configuration 1210, that includes the charging connector 154, the first onboard charger 1202, a second of the onboard chargers 152, shown as second onboard charger 1212, arranged in parallel to the first onboard charger 1202, the DC/DC converter 160, arranged in parallel with the first onboard charger 1202 and the second onboard charger 1212, the HVPDU 134, the LV battery 136, and the High-voltage battery 132. The onboard chargers 152 are arranged in parallel with the charging connector 154, but in some embodiments, the onboard chargers 152 may be arranged in series with the charging connector 154. In the second charging configuration 1210, the charging connector 154 is coupled to the first onboard charger 1202 and the second onboard charger 1212. The outputs of the first onboard charger 1202 and the second onboard charger 1212 are combined. A portion of the output DC electrical energy is passed to the DC/DC converter 160 which converts the DC electrical energy from a first high voltage to a second low voltage, and provides the second low voltage to the LV battery 136 for charging. The DC electrical energy at the first high voltage from both the first onboard charger 1202 and the second onboard charger 1212 is also passed to the HVPDU 134 which then provides it to the High-voltage battery 132. Electrical energy received by the charging connector 154 (e.g., from the external power source 156 via the wall adapter 158, etc.) may travel through the first onboard charger 1202 and/or the second charging configuration 1210 in parallel, (i) through the DC/DC converter 160 to the LV battery 136 and (ii) through the HVPDU 134 to the high-voltage battery 132 to charge the high-voltage battery 132. When the charging pod 150 is in the second charging configuration 1210, the first onboard charger 1202 and the second onboard charger 1212 may be positioned within the high voltage portion 1162. In some embodiments, the first onboard charger 1202 and the DC/DC converter 160 are positioned in the same enclosure 151 to reduce the need for external cabling.

When the charging pod 150 is arranged in the second charging configuration 1210, the charging pod 150 may receive a second maximum input current that is higher than the first maximum input current of the charging pod 150 in the first onboard charger 1202. The second maximum input current of the charging pod 150 in the second charging configuration 1210 may be limited by a combined conversion capacity (e.g., a sum of current capacities, etc.) of the first onboard charger 1202 and the second onboard charger 1212 when converting the AC electrical energy received by the charging connector 154 into DC electrical energy for charging the high-voltage battery 132. The combined conversion capacity of the first onboard charger 1202 and the second onboard charger 1212 may be higher than a first conversion capacity of the first onboard charger 1202 and/or a second conversion capacity of the second onboard charger 1212 individually. As a result, the second charging power received by the charging connector 154 when the charging pod 150 is in the second charging configuration 1210 may be higher than the first charging power received by the charging connector 154 when the charging pod 150 is in the first charging configuration 1200. For example, when the charging pod 150 is in the second charging configuration 1210, the AC electrical energy received by the charging connector 154 may be at 120 V AC or 240 V AC with the second maximum input current of 50 A. The first onboard charger 1202 may receive a first portion of the second maximum input current of 50 A (e.g., 25 A, less than 50 A, etc.) and the second onboard charger 1212 may receive a second portion of the second maximum input current of 50 A (e.g., 25 A, less than 50 A, etc.) from the charging connector 154, convert the AC electrical energy to DC electrical energy, and provide the DC electrical energy to the DC/DC converter 160 and the HVPDU 134 at a first voltage. The first onboard charger 1202 may output a first portion of the DC electrical energy to the DC/DC converter 160 and the HVPDU 134 with a first maximum current of 20 A and the second onboard charger 1212 may output a second portion of the DC electrical energy to the DC/DC converter 160 and the HVPDU 134 with a second maximum current of 20 A. The DC/DC converter 160 may convert the second combined DC electrical energy to a second converted DC electrical energy at a second voltage lower than the first voltage for charging the LV battery 136 The second combined DC electrical energy may have a second charging power that is higher than the first charging power of the first converted DC electrical energy from the charging pod 150 in the first charging configuration 1200. The second combined DC electrical energy may be between 260 V DC to 480 V DC with a maximum 40 A DC current (e.g., a sum of the first maximum current of 20 A outputted by the first onboard charger 1202 and the second maximum current of 20 A outputted by the second onboard charger 1212, etc.) and/or a maximum 13.2 kW charging power. Since the second combined DC electrical energy when the charging pod 150 is in the second charging configuration 1210 may have a higher current and/or a higher charging power than the first converted electrical energy when the charging pod 150 is in the first charging configuration 1200, the charging pod 150 may charge the high-voltage battery 132 and/or the low-voltage battery 136 at a faster rate when the charging pod 150 is in the second charging configuration 1210 than when the charging pod 150 is in the first charging configuration 1200.

According to the exemplary embodiment shown in FIGS. 67 and 68, when the charging pod 150 is arranged in the second charging configuration 1210, the DC/DC converter 160 is coupled to the output of first onboard charger 1202 internally within a housing or enclosure shown in dashed lines, meaning an additional connection in the HVPDU 134 is not required for the DC/DC converter 160. The output of the first onboard charger 1202 and the second onboard charger 1212 is then combined and provided to the HVPDU 134. In some embodiments, the DC/DC converter 160 may be coupled to a top surface of the first onboard charger 1202. The charging connector 154 may receive AC electrical energy and provide a first portion of the AC electrical energy to the first onboard charger 1202 and a second portion of the AC electrical energy to the second onboard charger 1212. The first onboard charger 1202 may convert the first portion of the AC electrical energy into a first portion of high voltage DC electrical energy and the second onboard charger 1212 may convert the second portion of the AC electrical energy into a second portion of the high voltage DC electrical energy which are combined together. A portion of the output high voltage is provided to the DC/DC converter 160 while another portion is provided to the HVPDU 134. The DC/DC converter 160 may convert the high voltage DC electrical energy (e.g., a combined high voltage DC electrical energy of the first portion of the high voltage DC electrical energy and the second portion of the high voltage DC electrical energy, etc.) into low voltage DC electrical energy and provide the low voltage DC electrical energy to the LV battery 136. In the second charging configuration 1210 a single DC/DC converter 160 is sufficient to cover the low voltage loads of the low-voltage battery 136 and the corresponding low-voltage system of the telehandler 10. The other portion of the combined high voltage DC electrical energy is provided to the HVPDU 134 to provide the high voltage DC electrical energy to the high-voltage battery 132 to charge the high-voltage battery 132. In some embodiments, the DC/DC converter 160 may be built in to the first onboard charger 1202.

According to an exemplary embodiment, the charging pod 150 is configured as a modular charging pod that is configurable between the first charging configuration 1200 and the first onboard charger 1202. For example, the charging pod 150 may be placed in the first charging configuration 1200 when the first onboard charger 1202 (e.g., a first onboard charger module, etc.) is positioned within the high voltage portion 1162 of the housing opening 1102 and/or coupled to one of the side panels 18 (e.g., via one of the side panel brackets 1180, etc.). The charging pod 150 may be placed in the second charging configuration 1210 when the first onboard charger 1202 and the second onboard charger 1212 (e.g., a second onboard charger module, etc.) are positioned within the high voltage portion 1162 of the housing opening 1102 and/or coupled to one of the side panels 18 (e.g., via the side panel brackets 1180, etc.). The charging pod 150 may be adjusted from the second charging configuration 1210 to the first charging configuration 1200 by decoupling the second onboard charger 1212 from the one of the side plates 18 and/or removing the second onboard charger 1212 from the housing opening 1102. When the charging pod 150 is in the first charging configuration 1200, the onboard chargers 152 may utilize a smaller amount of the housing opening 1102 of the charger housing body 1100 and/or the charging pod 150 may be simpler than when the charging pod 150 is in the second charging configuration 1210. When the charging pod 150 is in the second charging configuration 1210, the charging pod 150 may charge the high-voltage battery 132 and/or the low-voltage battery 136 at a faster rate than when the charging pod 150 is in the second charging configuration 1210.

As shown in FIG. 68, the charging connector 154 is connected to a high-voltage wire shown as a molded HV slice 155 which is coupled to the onboard charger 152 shown as the first onboard charger 1202, with the DC/DC converter 160 coupled internally with the onboard charger 1202 and a second onboard charger 152 shown as the second onboard charger 1212. In some embodiments, the max input current may be between 32 A and 38 A. In some embodiments, the first onboard charger is has a charging capacity between 3.3 kW and 6.6 kW. In some embodiments, the DC/DC converter 160 has a 2 kW capacity. In some embodiments, the second onboard charger 1212 has a charging capacity between 3.3 kW and 6.6 kW. The first onboard charger 1202 and the second onboard charger 1212 are coupled to the HVPDU 134 via second high-voltage connector shown as molded HV slice 157. In some embodiments, the max output current from the first onboard charger 1202 is 20 A, and the max output current from the second onboard charger 1212 is 20 A.

In some embodiments, the charging pod 150 may be configured into additional charging configurations with more onboard chargers 152 (e.g., a third onboard charger, a fourth onboard charger, etc.) positioned within the high voltage portion 1162 of the housing opening 1102. For example, the charging pod 150 may include three of the onboard chargers 152 arranged in parallel. The charging connector 154, the DC/DC converter 160, and the HVPDU 134 may be coupled with the three of the onboard chargers 152 arranged in parallel. As a result of the three of the onboard chargers 152, a combined conversion capacity of the three of the onboard chargers 152 may be higher than the combined conversion capacity of the first onboard charger 1202 and the second onboard charger 1212 to allow for the charging pod 150 to receive AC electrical energy with a higher current than the charging pod 150 in the second charging configuration 1210 such that the charging pod 150 may charge the high-voltage battery 132 and/or the low-voltage battery 136 and a faster rate when the charging pod 150 includes the three of the onboard chargers 152 than when the charging pod 150 is in the first charging configuration 1200 and/or the second charging configuration 1210.

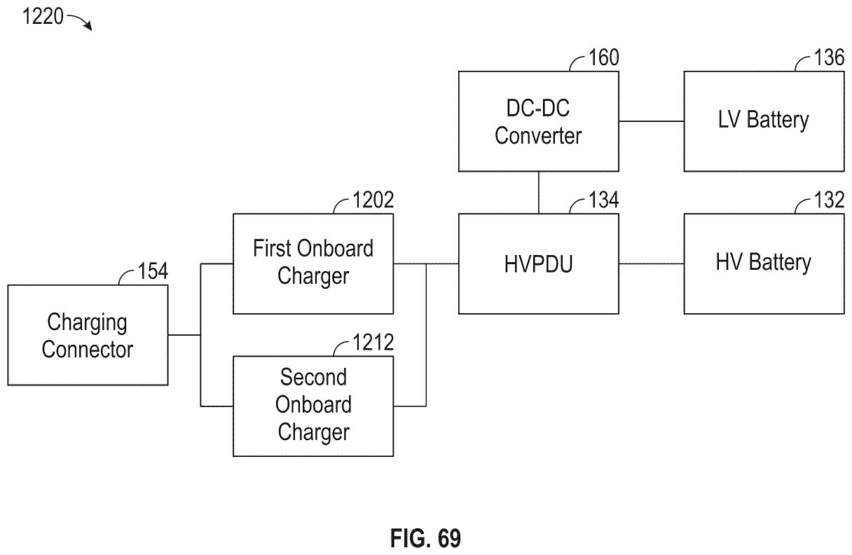

Referring now to FIG. 69, the charging pod 150 is shown in a third configuration 1220. The charging connector 154 is coupled to the first onboard charger 1202 and the second onboard charger 1212 in parallel. As compared to FIG. 67, second configuration 1210 shown in FIG. 67, the entire combined output of the first onboard charger 1202 and the second onboard charger 1212 is provided to the HVPDU 134 and the HVPDU 134 distributes the combined, high voltage output to the high-voltage devices in the telehandler 10. A portion of the DC electrical energy is sent to the DC/DC converter 160 from the HVPDU 134 via separate connection and connector of the HVPDU 134 specific to the DC/DC converter 160, which converts the DC electrical energy from a first high voltage to a second low voltage (e.g., substantially 12 V) for charging the LV battery 136. A portion of the DC electrical energy is also passed to the High-voltage battery 132 for charging. With the first onboard charger 1202 and the second onboard charger 1212 arranged in parallel, the charging power of the charging pod 150 is increased, as described above with reference to FIGS. 67 and 68. In such embodiments with multiple onboard chargers 152 like the third configuration 1220 with the first onboard charger 1202 and the second onboard charger 1212, the onboard chargers 152 may have the same power capacity, or the onboard chargers 152 may have different power capacities. For example, one of the onboard chargers 152 may be a 6.6 kW charger while the other may be a 3.3 kW charger.

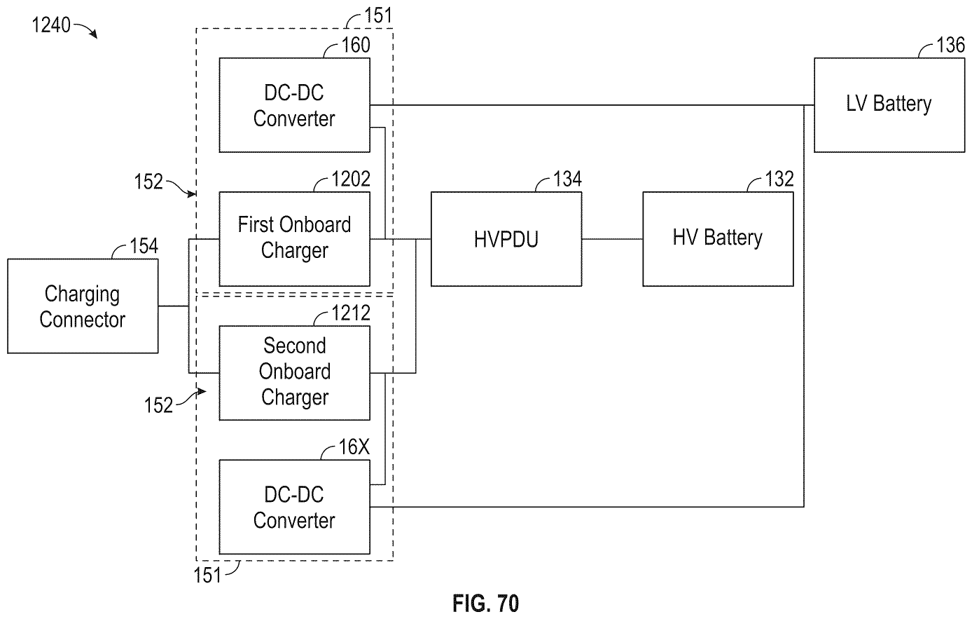

Referring now to FIG. 70, the charging pod 150 is shown in a fourth configuration 1240 with two DC converters 160. In the fourth configuration 1240, the charging connector 154 receives power and provides that power to the first onboard charger 1202 and the second onboard charger 1212 in parallel. Connected to the output of the first onboard charger 1202 is a first DC/DC converter 160 and connected to the output of the second onboard charger 1212 is a second DC/DC converter 160. The first and second DC converters convert the high voltage DC electrical energy to low-voltage DC electrical energy. The outputs of the first and second DC converters 160 are provided to the low-voltage battery 136. The outputs of the first onboard charger 1202 and the second onboard charger 1212, after the connections with the first and second DC/DC converter 160, are coupled and provided to the HVPDU 134. The HVPDU 134 provides the high voltage DC electrical energy to the high-voltage battery 132. In the fourth configuration 1240, the first onboard charger 1202 and the first DC/DC converter 160 are positioned in a first enclosure 151 and the second onboard charger 1212 and the second DC/DC converter 160 are positioned in a separate enclosure 151. In some embodiments, being positioned in the same enclosure means the electrical connections are internal and do not require external cabling. The fourth configuration 1240 may be used where the low voltage load is exceeds the capability of a single DC/DC converter 160, the telehandler 10 has more than one low-voltage battery 136, and/or redundancy is desired for the low voltage system.

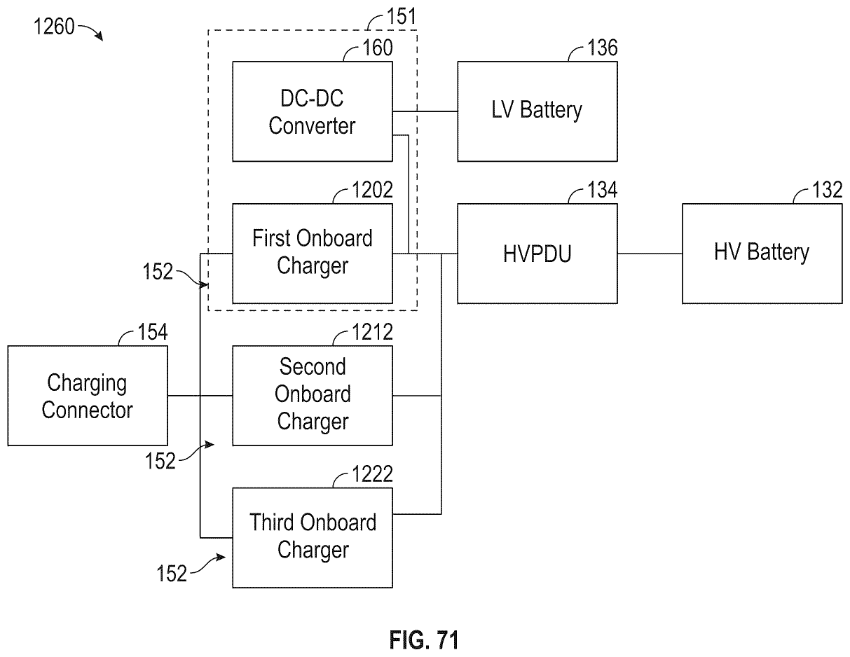

Referring now to FIG. 71, the charging pod 150 is shown in a fifth configuration 1260 with three onboard chargers 152. The fifth configuration 1260 includes the charging connector 154 connected to the first onboard charger 1202, the second onboard charger 1212 and a third onboard charger 1222 all in parallel. In some embodiments, one or more of the first onboard charger 1202, the second onboard charger 1212, or the third onboard charger 1222 are coupled to a DC/DC converter 160. As shown in FIG. 71, the first onboard charger 1202 is coupled to the DC/DC converter 160 and positioned in the same enclosure 151 as the DC/DC converter 160. The DC/DC converter 160 converts the high voltage from the first onboard charger 1202 to low voltage for the low-voltage battery 136. The output from the first onboard charger 1202, the second onboard charger 1212, and the third onboard charger 1222 is combined and provide to the HVPDU 134 and then provided at least in part to the high-voltage battery 132.

Referring now to FIG. 72 the charging pod 150 is shown in a sixth configuration 1270. The sixth configuration 1270 includes two enclosures 153 for housing two separate combinations of a an onboard charger 152 and a DC/DC converter 160: the first onboard charger 1202 and a first DC/DC converter 160 in a first same enclosure 151 and the second onboard charger 1212 and a second DC/DC converter 160 in the second same enclosure 151. Each enclosure contained a onboard chargers 152 and a DC/DC converter 160 can be referred to as a “2-in-1” arrangement. In this arrangement, the output from the given onboard chargers 152 (e.g., first onboard charger 1202, second onboard charger 1212, etc.) is provided in part to the corresponding DC/DC converter 160 which converts it to a low-voltage (e.g., 12 V) for the low voltage system (e.g., low-voltage battery 136, etc.) The sixth configuration 1270 also includes a third onboard charger 1222 to receive additional power, such that the sixth configuration 1270 has a greater power capacity than configurations with fewer onboard chargers 152. The combined output of the first onboard charger 1202, the second onboard charger 1212, and the third onboard charger 1222 is provided to the HVPDU 134 and then at least in part to the high-voltage battery 132 for charging. As described above, in each of the configurations with a plurality of onboard chargers 152, the onboard chargers 152 may have the same power capacity or one or more of the plurality of the onboard chargers 152 may have a different power capacity.

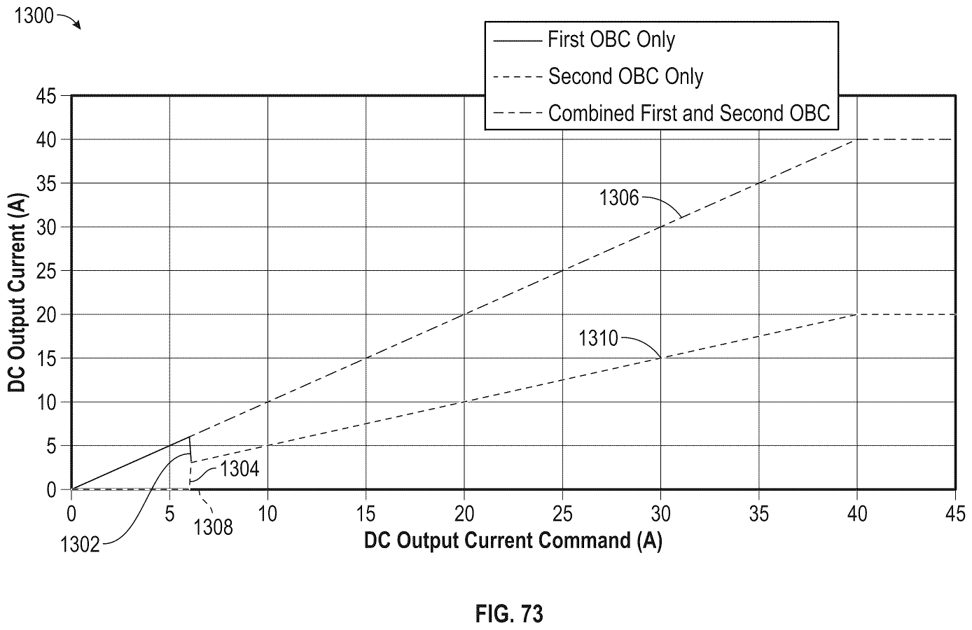

Referring now to FIG. 73, a chart 1300 is shown. The chart 1300 represents potential power coordination strategies in configurations of the charging pod 150 with two onboard chargers 152. The y-axis of the chart 1300 represents DC output current in amps. The x-axis of the chart 1300 represents DC Output Current Commands in amps. Three lines are shown on the chart 1300: line 1302 relates to the first OBC (e.g., onboard charger, such as first onboard charger 1202) only; line 1304 relates to the second OBC only (e.g., onboard charger such as second onboard charger 1212) and line 1306 shows the combined first and second OBC (e.g., first onboard charger 1202 and second onboard charger 1212). As shown, the strategy represented in chart 1300 includes using the first OBC only for a first time until first threshold, shown as point 1308, is met. The first threshold may be a output command or a output current of the OBC. In some embodiments, the threshold is a predetermined value. In some embodiments, the threshold is based on a battery state of charge, a power demand request from one or more components of the telehandler 10, a characteristic of the power from the external source (e.g., voltage, amperage, etc.). In some embodiments, the threshold is set by a user. The threshold therefore be a power demand command or requirement. For example, the threshold may be a DC current output command of 6 A. In operation, a controller (e.g., controller 200) may receive the a request for a first power demand. The controller may determine if the first power demand is less than or equal to or greater than the threshold. If the demand is less than the threshold, the controller may control one of the two OBCs, shown in FIG. 73 as 1302, to provide a power output to meet the power demand. If the demand or command is equal to or greater than the threshold, the controller may control both of the two OBCs, lines 1302 and 1304, to provide a combined power output (i.e., a sum of the power output of each OBC) to meet the demand. Thus, in response to meeting and/or exceeding the first threshold, the second OBC is activated. According to the control strategy of FIG. 73, the power output of the first onboard charger 1202 is reduced while the output of the second onboard charger 1212 is increased in a corresponding manner, after which both the first OBC and the second OBC produce the same output current per output current demand. Thus, line 1306 is the sum of the power output represented by lines 1302 and 1304. For example, at point 1310 the output current command is 30 A. The output current of line 1302 is 15 A and the output current of line 1304 is 15 A such that line 1306 is 30 A. In some embodiments, an onboard charger 152 is more efficient when operating at a higher power output. In the chart 1300, by operating each onboard chargers 152 at the same power output, the onboard chargers 152 are run to generally share the same burden.

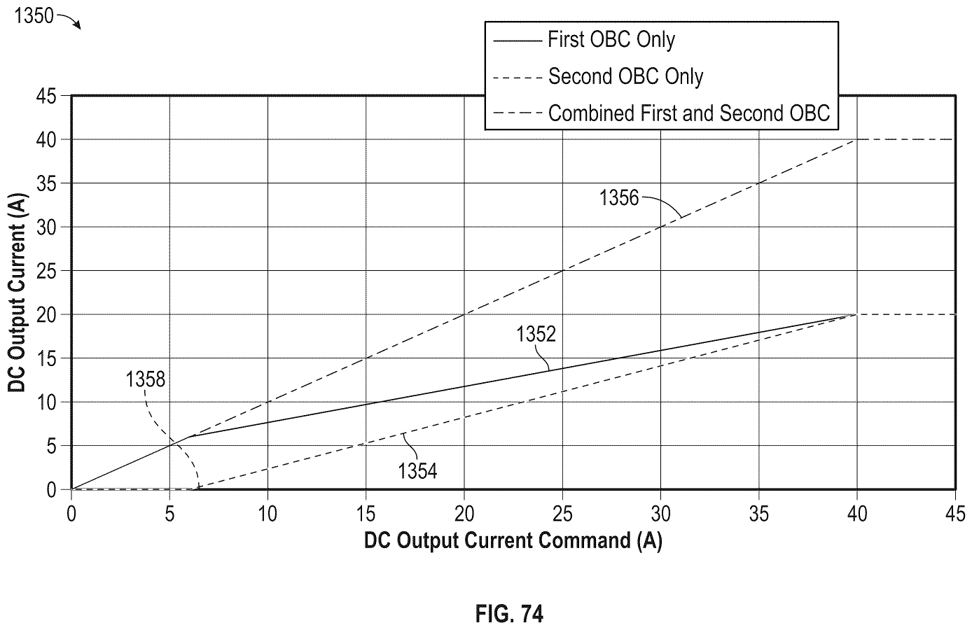

Referring now to FIG. 74, a chart 1350 is shown. The chart 1350 represents potential power coordination strategies in configurations of the charging pod 150 with two onboard chargers 152. The y-axis of the chart 1300 represents DC output current in amps. The x-axis of the chart 1300 represents DC Output Current Commands in amps. Three lines are shown on the chart 1300: line 1352 relates to the first OBC (e.g., onboard charger, such as first onboard charger 1202) only; line 1354 relates to the second OBC only (e.g., onboard charger such as second onboard charger 1212) and line 1356 shows the combined first and second OBC (e.g., first onboard charger 1202 and second onboard charger 1212). In operation, a controller (e.g., controller 200) of the telehandler 10 receives a power demand, requirement, or command, for a requested output power level. In response to the power demand, the controller controls one or both of the two OBCs. As shown, the strategy represented in chart 1350 includes using the first OBC only for a first time until a first threshold, shown as point 1308, is met. The first threshold may be a output command or a output current of the OBC, and may be a pre-determined value or a variable value based on one or more characteristics of the telehandler 10 and/or the input power to the telehandler 10. For example, the threshold may be a DC current output command of 6 A. In response to meeting and/or exceeding the first threshold, the second OBC is activated by the controller. As the DC output current command increases, both the first OBC of line 1352 and the second OBC of line 1354 share the burden of the increase. As shown in FIG. 74, the rate of increase of the first OBC line 1352 may be less than the rate of increase of the second OBC line 1354, but both may increase depending on the requested demand requirement. As compared to the strategy shown in chart 1350, the first OBC is not reduced in power after passing the threshold, such that for a time the first OBC of line 1352 has a power output greater than the power output of the second OBC of line 1354. As shown in chart 1350, at 20 A of power output each of the OBCs have reached their peak and do not exceed 20 A. However, while 20 A is shown as the max power output for this strategy, it should be understood that other maximums may be used. The line 1356 is the sum of the output current represented by lines 1302 and 1304.

### Onboard Chargers

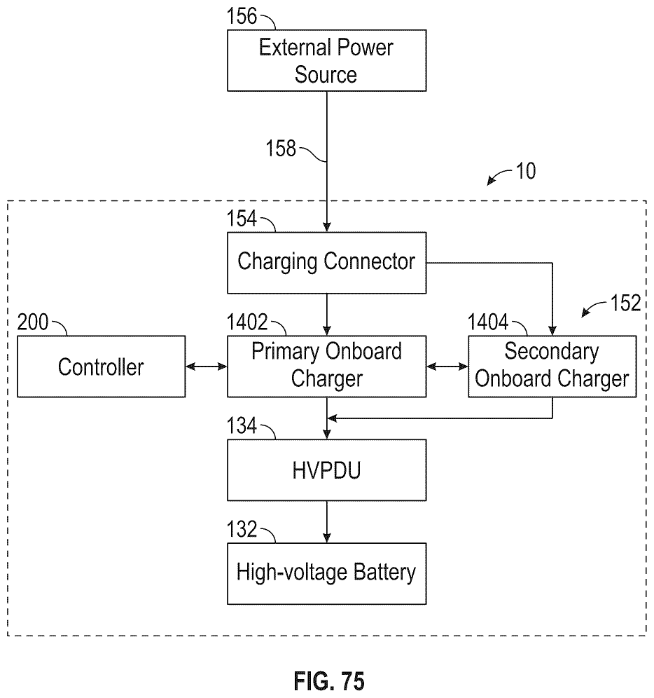

As shown in FIG. 75, the onboard chargers 152 include a first onboard charger, shown as a primary onboard charger 1402, and a second onboard charger, shown as a secondary onboard charger 1404. The primary onboard charger 1402 and the secondary onboard charger 1404 are configured to receive electrical energy from the external power source 156 (e.g., via the charging connector 154 and/or the wall adapter 158) and to provide the electrical energy to the high-voltage battery 132.

As shown in FIG. 75, each of the primary onboard charger 1402 and the secondary onboard charger 1404 are coupled to the high-voltage battery 132. More specifically, the primary onboard charger 1402 and the secondary onboard charger 1404 coupled to the HVPDU 134, and the HVPDU 134 is coupled to the high-voltage battery 132. By way of example, a first electrical harness (e.g., one or more electrical cables) coupled to the primary onboard charger 1402 and a second electrical harness coupled to the secondary onboard charger 1404 may be electrically coupled to each other and to the HVPDU 134.

The primary onboard charger 1402 and the secondary onboard charger 1404 are each configured to provide electrical energy to the high-voltage battery 132 (e.g., indirectly, via the HVPDU 134). By way of example, when only one of the onboard chargers 152 provides electrical energy to the high-voltage battery 132, the primary onboard charger 1402 provides the electrical energy to the high-voltage battery 132. By way of another example, when both onboard chargers 152 provide electrical energy to the high-voltage battery 132, the primary onboard charger 1402 provides the electrical energy to the high-voltage battery 132, and the primary onboard charger 1402 causes the secondary onboard charger 1404 to provide the electrical energy to the high-voltage battery 132.

As shown in FIG. 75, the controller 200 is coupled to the primary onboard charger 1402 (e.g., directly or indirectly, through the application of one or more control signals, etc.). Meanwhile, the primary onboard charger 1402 is coupled to the secondary onboard charger 1404. The controller 200 is communicatively coupled to the secondary onboard charger 1404 via the primary onboard charger 1402. That is, the controller 200 is not directly coupled to the secondary onboard charger 1404. In this way, operation of the secondary onboard charger 1404 is controlled by the primary onboard charger 1402 (e.g., through the application of one or more control signals, etc.). In some embodiments, the controller 200 provides one or more control signals to the primary onboard charger 1402, and the primary onboard charger 1402 in turn provides one or more control signals to the secondary onboard charger 1404. By way of example, the one or more control signals that the primary onboard charger 1402 provides to the secondary onboard charger 1404 originate from the controller 200. By way of another example, the one or more control signals that the primary onboard charger 1402 provides to the secondary onboard charger 1404 originate from the primary onboard charger 1402. In other embodiments, the primary onboard charger 1402 acts independently of the controller 200. By way of example, both the control signals used to operate the primary onboard charger 1402 and the control signals used to operate the secondary onboard charger 1404 originate from the primary onboard charger 1402.

During a charging operation, the primary onboard charger 1402 provides electrical energy to the high-voltage battery 132. Additionally, the primary onboard charger 1402 selectively causes the secondary onboard charger 1404 to provide the electrical energy to the high-voltage battery 132 (e.g., concurrently or partially concurrently with the primary onboard charger 1402). By way of example, the primary onboard charger 1402 may cause the secondary onboard charger 1404 to provide the electrical energy to the high-voltage battery 132 responsive to a current value of the electrical energy received from the external power source 156 being at or above a predetermined threshold, such as 25 amps (A). By way of another example, the primary onboard charger 1402 may cause the secondary onboard charger 1404 to cease providing the electrical energy to the high-voltage battery 132 responsive to a current value of the electrical energy received from the external power source 156 being below a predetermined threshold, such as 20 A. In this way, the primary onboard charger 1402 and the secondary onboard charger 1404 cooperate to facilitate parallel charging of the high-voltage battery 132.

During operation, the primary onboard charger 1402 and the secondary onboard charger 1404 are each operable between a first mode of operation (e.g., an “awake” mode, a “ready” mode, an “on” mode) and a second mode of operation (e.g., a “sleep” mode, a “stand-by” mode, an “off” mode, etc.). The primary onboard charger 1402 and the secondary onboard charger 1404 are operable to switch between the first mode of operation and the second mode of operation, as described in greater detail herein below.

In the first mode of operation, the primary onboard charger 1402 and the secondary onboard charger 1404 are configured to selectively receive electrical energy (e.g., from the external power source 156) and provide the electrical energy to the high-voltage battery 132. In the first mode of operation, the primary onboard charger 1402 and the secondary onboard charger 1404 are configured to selectively receiving a signal and, in response to receiving the signal, change from the first mode of operation to the second mode of operation. By way of example, the primary onboard charger 1402 may receive a signal from the controller 200 that causes the primary onboard charger 1402 to change from the first mode of operation to the second mode of operation. By way of another example, the secondary onboard charger 1404 may receive a signal from the primary onboard charger 1402 that causes the secondary onboard charger 1404 to change from the first mode of operation to the second mode of operation.

The second mode of operation is a low-power mode where the primary onboard charger 1402 and the secondary onboard charger 1404 consume a reduced amount of power and do not provide electrical energy to the high-voltage battery 132. In the second mode of operation the primary onboard charger 1402 and the secondary onboard charger 1404 are configured to selectively receiving a signal and, in response to receiving the signal, change from the second mode of operation to the first mode of operation. By way of example, the primary onboard charger 1402 may receive a signal from the controller 200 or another component of the telehandler 10 that causes the primary onboard charger 1402 to change from the second mode of operation to the first mode of operation. By way of another example, the secondary onboard charger 1404 may receive a signal from the primary onboard charger 1402 that causes the secondary onboard charger 1404 to change from the second mode of operation to the first mode of operation.

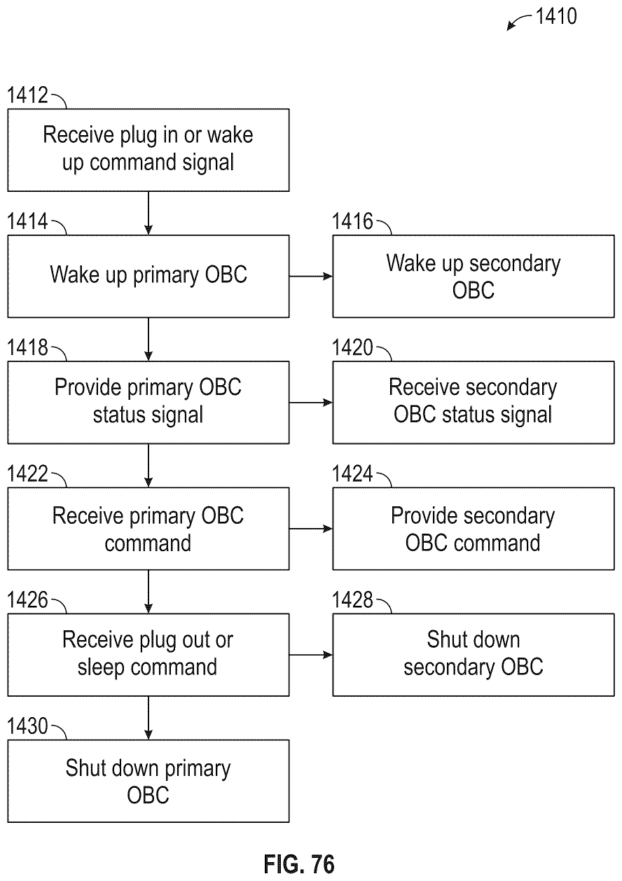

Referring to FIG. 76, a method 1410 of operating the onboard chargers 152 (e.g., the primary onboard charger 1402 and the secondary onboard charger 1404) is shown. The method 1410 is performed by a computing system, such as the controller 200 and/or a computing system associated with or embodied in the primary onboard charger 1402. By way of example, the method 1410 may be performed by the primary onboard charger 1402 with or without input from the controller 200. It should be understood that the order of the method 1410 is shown as an example only. That is, one or more processes may be performed concurrently partially concurrently, sequentially, and/or in a different order than as shown in FIG. 76. Additionally, certain processes of the method 1410 may be combined or deleted/omitted.

At process 1412, the primary onboard charger 1402 receives at least one of a plug in signal or a wake up command signal. The plug in signal indicates that the external power source 156 is coupled to the charging connector 154 (e.g., via the wall adapter 158). In some embodiments, the plug in signal is received from the charging connector 154, or, more specifically, processing circuitry associated with the charging connector 154. In other embodiments, the plug in signal is received from the controller 200. In any of the above-described embodiments, the plug in signal is received responsive to the external power source 156 being coupled to the charging connector 154. The wake up command signal is a command signal that is structure to cause the primary onboard charger 1402 to operate in the first mode of operation, referred to as “waking up” the primary onboard charger 1402. The wake up command signal is received from the controller 200. In some embodiments, the wake up command signal is received responsive to the external power source 156 being coupled to the charging connector 154.

At process 1414, the primary onboard charger 1402 wakes up, responsive to receiving at least one of the plug in signal or the wake up command signal at process 1412. At process 1416, the primary onboard charger 1402 causes the secondary onboard charger 1404 to wake up. By way of example, the primary onboard charger 1402 may provide a wake up command signal to the secondary onboard charger 1404, which, in turn, causes the secondary onboard charger 1404 to wake up. In some embodiments, the primary onboard charger 1402 provides the wake up command signal to the secondary onboard charger 1404 responsive to the primary onboard charger 1402 waking up (e.g., at process 1414).

At process 1418, the primary onboard charger 1402 provides a status signal (e.g., a first status signal, a primary onboard charger status signal). The primary onboard charger status signal is a data signal that includes information regarding a status of the primary onboard charger 1402. In some embodiments, the information regarding the status of the primary onboard charger 1402 includes an indication that the primary onboard charger 1402 has woken up. In other embodiments, the information regarding the status of the primary onboard charger includes information regarding the operation of the primary onboard charger 1402, such as an input voltage, an output voltage, an input current, an output current, an input AC phase or frequency, and so on.

At process 1420, the primary onboard charger 1402 receives a status signal (e.g., a second status signal, a secondary onboard charger status signal). In some embodiments, the primary onboard charger 1402 receives the secondary onboard charger status signal responsive to the secondary onboard charger 1404 waking up. In other embodiments, the primary onboard charger 1402 provides a command signal to the secondary onboard charger 1404, which causes the secondary onboard charger 1404 to provide the secondary onboard charger status signal to the primary onboard charger 1402. The secondary onboard charger status signal is a data signal that includes information regarding a status of the secondary onboard charger 1404. In some embodiments, the information regarding the status of the secondary onboard charger 1404 includes an indication that the secondary onboard charger 1404 has woken up. In other embodiments, the information regarding the status of the secondary onboard charger 1404 includes information regarding the operation of the secondary onboard charger 1404, such as an input voltage, an output voltage, an input current, an output current, an input AC phase or frequency, and so on.

At process 1422, the primary onboard charger 1402 receives a command signal (e.g., a first command signal, a primary onboard charger command signal). In some embodiments, the primary onboard charger 1402 receives the primary onboard charger command signal from the controller 200. The primary onboard charger command signal is a data signal that includes computer-readable instructions for operating the primary onboard charger 1402. The computer-readable instructions for operating the primary onboard charger 1402 includes one or more of a target output voltage, a target output current, and/or a charger enable signal. The charger enable signal causes the primary onboard charger 1402 to provide power to the high-voltage battery 132 (e.g., via the HVPDU 134).

Responsive to receiving the primary onboard charger command signal, at process 1422, the primary onboard charger 1402 is configured to provide electrical energy to charge the high-voltage battery 132. That is, the primary onboard charger 1402 is configured provide electrical energy to charge the high-voltage battery 132 according to the computer-readable instructions received at process 1422. By way of example, the primary onboard charger 1402 may provide energy to the high-voltage battery 132 at an output voltage and an output current included in the primary onboard charger command signal.

At process 1424, the primary onboard charger 1402 provides a command signal (e.g., a second command signal, a secondary onboard charger command signal) to the secondary onboard charger 1404. In some embodiments, the primary onboard charger 1402 provides the secondary onboard charger command signal based on the primary onboard charger command signal received from the controller 200. In some embodiments, the primary onboard charger 1402 provides secondary onboard charger command signal responsive to an input current value of the electrical energy received from the external power source 156 being at or above a predetermined threshold, such as 6 A and/or responsive to the input voltage value of the electrical energy received from the external power source 156 being at or below a predetermined threshold, such as 120 VAC. The secondary onboard charger command signal is a data signal that includes computer-readable instructions for operating the secondary onboard charger 1404. The computer-readable instructions for operating the secondary onboard charger 1404 includes one or more of a target output voltage, a target output current, and/or a charger enable signal. Based on the foregoing, when external power source 156 is limited to 6 A and/or 120 VAC, only the primary onboard charger 1402 is active, and, when the external power source 156 can provide greater than 6 A and/or 120 VAC, both the primary onboard charger 1402 and the secondary onboard charger 1404 are active. Beneficially, this strategy reduces power loss in converting AC to DC power.

Responsive to receiving the secondary onboard charger command signal, at process 1424, the secondary onboard charger 1404 is configured to provide electrical energy to charge the high-voltage battery 132. That is, the secondary onboard charger 1404 is configured to provide electrical energy to charge the high-voltage battery 132 according to the computer-readable instructions received at process 1424. By way of example, the secondary onboard charger 1404 may provide energy to the high-voltage battery 132 at an output voltage and an output current included in the secondary onboard charger command signal.

At process 1426, the primary onboard charger 1402 receives at least one of a plug out signal or a sleep command signal. The plug out signal indicates that the external power source 156 is disconnected from the charging connector 154. In some embodiments, the plug out signal is received from the charging connector 154, or, more specifically, processing circuitry associated with the charging connector 154. In other embodiments, the plug out signal is received from the controller 200. In any of the above-described embodiments, the plug out signal is received responsive to the external power source 156 being disconnected from the charging connector 154. The sleep command signal is a command signal that is structure to “sleep” (e.g., turn off) the primary onboard charger 1402. The sleep command signal is received from the controller 200. In some embodiments, the sleep command signal is received responsive to the external power source 156 being disconnected from the charging connector 154.

At process 1428, the primary onboard charger 1402 causes the secondary onboard charger 1404 to turn off. By way of example, the primary onboard charger 1402 may provide a sleep command signal to the secondary onboard charger 1404, which, in turn, causes the secondary onboard charger 1404 to turn off. In some embodiments, the primary onboard charger 1402 provides the sleep command signal responsive to receiving at least one of the plug out signal or the sleep command signal at process 1426. At process 1430, the primary onboard charger 1402 turns off, responsive to receiving at least one of the plug out signal or the sleep command signal at process 1426.

### Onboard Charger Activation

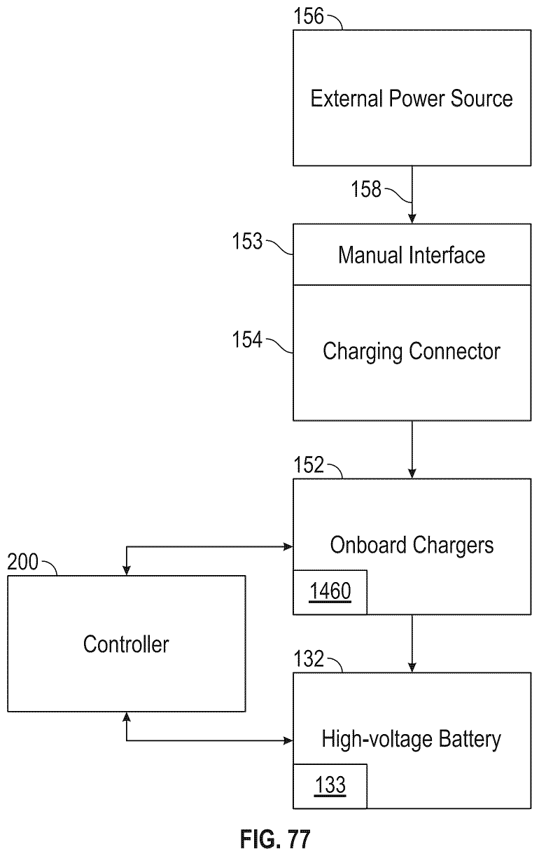

As shown in FIG. 77, the onboard chargers 152 are electrically coupled to the high-voltage battery 132. By way of this connection, the onboard chargers 152 are configured to send electrical energy for charging the high-voltage battery 132. The onboard chargers 152 are coupled to the controller 200 (e.g., directly or indirectly, through the application of one or more control signals, etc.). In some embodiments, the controller 200 provides one or more control signals to the onboard chargers 152.

As shown in FIG. 77, the controller 200 is coupled to each of the onboard chargers 152 and the high-voltage battery 132 such that the controller 200 can control and send and receive information between the onboard chargers 152 and the high-voltage battery 132. In some embodiments, communication between the onboard chargers 152 and the controller 200 includes the exchange of information regarding the operating status of the onboard chargers 152 (e.g., faulted, normal, function derate fault, non-function derate fault, etc.). In some embodiments, the controller 200 may receive information regarding the type of power (e.g., AC, DC, etc.) being received by the onboard chargers 152 via the external power source 156 and the charging connector 154. The controller 200 is configured to receive information regarding state of charge and operating status of the high-voltage battery 132. This received information allows the controller 200 to selectively activate and deactivate a charging operation. The controller 200 is also configured to determine a charging voltage (e.g., a voltage at which the onboard chargers 152 provide electrical energy to the high-voltage battery 132) and a charging current (e.g., the amperage at which the onboard chargers 152 provide electrical energy to the high-voltage battery 132) for the charging operation.

In some embodiments, and as shown in FIG. 77, the onboard chargers 152 include an onboard charger controller, shown as controller 1460. The controller 1460 is configured to facilitate certain operations of the onboard chargers 152. By way of example, one or both of the controller 1460 and the controller 200 may control the operation of the onboard chargers 152. It should be understood that, in any of the embodiments described herein where the controller 200 controls the operation of one or more of the onboard chargers 152, the controller 1460 may control the operation of one or more of the onboard chargers 152 instead of and/or in addition to the controller 200. In other embodiments, the onboard chargers 152 do not include the controller 1460.

The onboard chargers 152 are connected to an external power source 156 via a charging connector 154. The charging connector 154 is mechanically and electrically coupled to the external power source 156. In some embodiments, the charging connector 154 is selectively mechanically coupled to the external power source 156 by a manually actuated button, switch, latch, lever, or other manually actuated mechanism shown as manual interface 153. The manual interface 153 acts as a mechanical lock for connecting and disconnecting the external power source 156 from the charging connector 154. When connecting the external power source 156 to the charging connector 154, the manual interface 153 is first manually actuated to allow the mechanical and electrically connection. Once released, the manual interface 153 then locks the external power source 156 to the charging connector 154. To disconnect the external power source 156 from the charging connector 154 the manual interface 153 is manually actuated a second time, thereby releasing the coupling between the external power source 156 and the charging connector 154.

In some embodiments, the manual interface 153 further includes a sensor to monitor a status of the manual interface 153. The sensor of the manual interface 153 is communicably coupled to the controller 1460 allowing the manual interface 153 to act as a switch to start/stop charging.

In some embodiments, when a user first actuates the manual interface 153 to connect the external power source 156 to the charging connector 154, the controller 1460 receives a signal (e.g., a first signal) from the manual interface 153 indicating the connection has been established, and the controller 1460 causes one or more of the onboard chargers 152 to receive power (e.g., low-voltage power, high-voltage power, etc.) from the external power source 156. In turn, the onboard chargers 152 are configured to provide power to the high-voltage battery 132. Further actuation of the manual interface 153 is monitored by the controller 1460. When the user actuates the manual interface 153 to disconnect the external power source 156 from the charging connector 154, the controller 1460 receives a signal (e.g., a second signal) from the manual interface 153 indicating that the connection has been terminated, and the controller 1450 issues a stop command that causes the onboard chargers 152 to stop charging the high-voltage battery 132.

In other embodiments (e.g., when the onboard chargers 152 do not include the controller 1460), the sensor of the manual interface 153 is communicably coupled to the controller 200, and the controller 200 is configured to facilitate starting/stopping charging. Specifically, when a user first actuates the manual interface 153 to connect the external power source 156 to the charging connector 154 the controller 200 receives a signal from the manual interface 153 indicating the connection and allows the onboard chargers 152 to receive power (e.g., low-voltage power, high-voltage power, etc.) from the external power source 156. Further actuation of the manual interface 153 would be monitored by the controller 200 and result in a stop command to stop charging and disconnect the external power source 156 from the charging connector 154.

Prior to charging the High-voltage battery 132, the controller 200 monitors a temperature of the high-voltage battery 132 via a temperature sensors 133. The temperature sensor 133 is coupled to the high-voltage battery 132 and senses an internal temperature of the high-voltage battery 132. For example, the internal temperature may be a temperature of one or more battery cells included in the high-voltage battery 132. In some embodiments, multiple temperature sensors 133 are included in the high-voltage battery 132. By way of example, the high-voltage battery 132 may include a temperature sensor 133 for each battery cell. By way of another example, the high-voltage battery 132 may include a first amount of battery cells, such as one-hundred twelve battery cells, and the high-voltage battery 132 may include a temperature sensor for each battery cell, such that the high-voltage battery 132 includes one-hundred twelve temperature sensors.

The controller 200 compares the temperature of the high-voltage battery 132 with a predetermined temperature range. The predetermined temperature range represents a safe range for charging the high-voltage battery 132. In some embodiments, the range is or is between 0° C. and 65° C. In some embodiments, the range is between 20° C. and 65° C. If the temperature of the high-voltage battery 132 as indicated by the temperature sensors 133 is less than a minimum temperature as represented in the predetermined temperature range, prior to initiating charging of the high-voltage battery 132 the controller 200 causes a thermal management system to warm the high-voltage battery 132. For example, the high-voltage battery 132 and/or the external power source 156 may provide power to the thermal management system (e.g., heater) of the telehandler 10 to heat the high-voltage battery 132. In some embodiments, in addition to determining when to allow and disallow charging based on a temperature of the high-voltage battery 132 the controller 200 may determine a rate at which charge the high-voltage battery 132 (which, for example, may be measured in amps, watts, coulombs per second, or another suitable unit) based on the temperature of the high-voltage battery 132 and/or a state of charge (SOC) of the high-voltage battery 132. For example, between 0° C. and 10° C., the high-voltage battery 132 may charge at a first rate (e.g., a fust reduced rate). At 10° C. to 40° C., the high-voltage battery 132 may charge at a second rate (e.g., an optimal rate, a desired rate, etc.). Between 40° C. and 65° C. the high-voltage battery 132 may charge at a third rate (e.g., a second reduced rate). The fust rate and the third rate are less than the second rate. In another example, when the SOC of the high-voltage battery 132 is at or below a fust threshold (e.g., at or below 20%), the high-voltage battery 132 may charge at a fust rate (e.g., a fust reduced rate). When the SOC of the high-voltage battery 132 is above the first threshold and below a second threshold (e.g., above 20% and below 80%), the high-voltage battery 132 may charge at a second rate (e.g., an optimal rate, a desired rate, etc.). When the SOC of the high-voltage battery 132 is at or above the second threshold (e.g., at or above 80%), the high-voltage battery 132 may charge at a third rate (e.g., a second reduced rate). The fust rate and the third rate are less than the second rate.

To begin charging, the external power source 156 is coupled to the charging connector 154 via the manual interface 153. The onboard chargers 152 thereby receives power from the external power source 156. In some embodiments, the onboard chargers 152 automatically receive power and ‘wake’ when the external power source 156 is coupled to the charging connector 154. Once awake, the onboard chargers 152 receive power from the external power source 156 and provide power to one or more other components of the telehandler 10. The onboard chargers 152 may first provide low-voltage power to low-voltage components prior to providing high-voltage power to high-voltage components. For example, upon waking the onboard chargers 152 provide a control signal (e.g., a low-voltage control signal (e.g., 12 V at 100 mA) to the controller 200, thereby ‘waking’ the controller 200. After waking, the controller 200 provides a command to the high-voltage battery 132. For example, the controller 200 may provide a command to a battery management system (e.g., a battery control system) housed within the high-voltage battery 132. The command causes the battery management system to activate (e.g., close) one or more relays of the high-voltage battery 132. Closing the one or more relays allows for electrical energy to flow from the onboard chargers 152 to the high-voltage battery 132, such that charging of the high-voltage battery 132 may begin when the one or more relays are closed.

In some embodiments, the controller 200 may activate one or more high-voltage components and/or one or more low-voltage components after waking. The high-voltage components that may be activated prior to charging include the heater 182, a DC/DC converter, the onboard chargers 152, the high-voltage battery 132, and any battery management components or systems. In some embodiments, the DC/DC converter is a part of the onboard chargers 152. The low-voltage components may include a thermal management system, such as the cooling system 170.

In some embodiments, the onboard chargers 152 provides power from the external power source 156 to heat the high-voltage battery 132. In some embodiments, the high-voltage battery 132 includes an internal heating element to heat the high-voltage battery 132. In some embodiments, the controller 200 and/or the onboard chargers 152 determine if the onboard chargers 152 should use shore power from the external power source 156 or the power from the high-voltage battery 132 to heat the high-voltage battery 132 based on the battery 132 temperature. The controller 200 and/or the onboard chargers 152 may compare temperature of the high-voltage battery 132 with a second predetermined temperature range representing a safe discharge temperature range for the high-voltage battery 132. The safe discharge range may be different than the predetermined range for charging the high-voltage battery 132. For example, the safe discharge range may be between −20° C. and 55° C. If the temperature of the high-voltage battery 132 is within the safe discharge range, the power from the high-voltage battery 132 may be used. If the temperature of the high-voltage battery 132 falls outside the safe discharge range (e.g., below), then the controller 200 and/or onboard chargers 152 may determine shore power from the external power source 156 should be used. If the temperature of the high-voltage battery 132 is above the predetermined charging range, the controller 200 and/or the onboard chargers 152 determines not to begin charging of the high-voltage battery 132. In embodiments with a high-voltage battery 132 that is air-cooled, the charging process is delayed until the high-voltage battery 132 passively cools to a temperature within the predetermined charging range. In embodiments with a liquid cooled high-voltage battery 132, the controller 200 and/or the onboard chargers 152 may activate an HVAC system of the telehandler 10 (e.g., cooling system 170 and/or the compressor 186) to actively cool the high-voltage battery 132.

Whenever the charging process is paused (e.g., high-voltage battery 132 is too hot, high-voltage battery 132 is too cold, etc.) the status may be indicated on the user interface 34.

During the charging operation, the onboard chargers 152 provide electrical energy to the high-voltage battery 132. The onboard chargers 152 are configured to selectively receive electrical energy (e.g., from the external power source 156) and provide the electrical energy to the high-voltage battery 132. By way of example, the onboard chargers 152 may receive a signal from the controller 200 that causes the onboard chargers 152 to receive electrical energy and provide the electrical energy to the high-voltage battery 132. By way of another example, the onboard chargers 152 may receive a signal from the controller 200 or another component of the telehandler 10 that causes the onboard chargers 152 to not receive electrical energy, disallowing the charging operation.

During the charging operation, one or more components of the telehandler 10 may be inactivated. For example, the HVAC system for the cabin 30 may be inactive during charging. During charging, the controller 200 prevents the drive motor 90 and/or the implement motor 112 from operating. For example, the controller 200 may implement one or more controls that by prevent or limit operation of the drive motor 90 and/or the implement motor 112. During charging, one or more components of the user interface 34 may also be inactivated. In some embodiments, components of the user interface 34 which provide the user information remain active, while components which receive information from the user are inactive. For example, the user interface 34 may include a joystick. During charging, the joystick is disabled such that the user cannot control the telehandler 10 via the joystick.

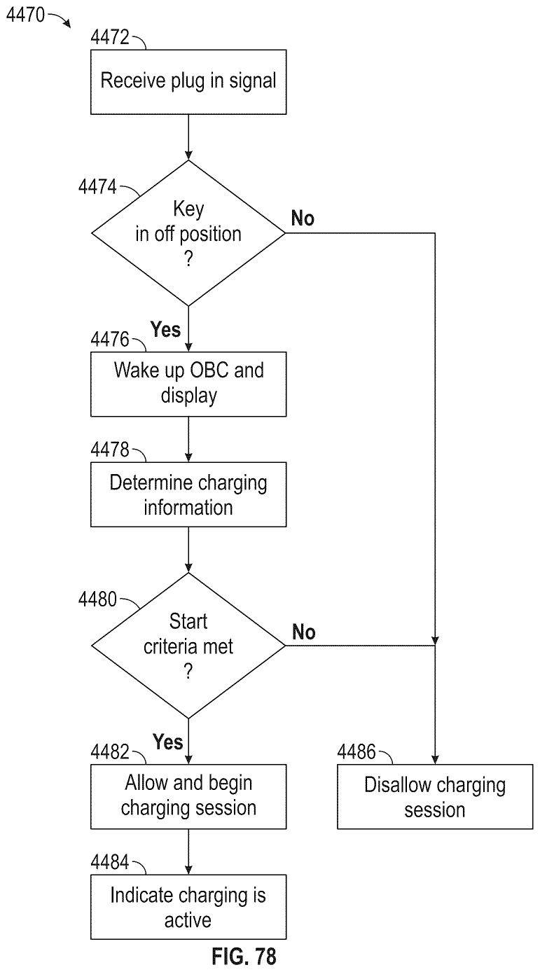

Referring to FIG. 78, a method 4470 of activating the charging operation of the onboard chargers 152 is shown. The method 4470 is performed by a computing system such as the controller 200 and/or a computing system associated with or embodied in the onboard chargers 152. It should be understood that the method 4470 is shown as an example only. That is, one or more processes may be performed concurrently, partially concurrently, sequentially, and/or in a different order than as shown in FIG. 78. Additionally, certain processes of the method 4470 may be combined or deleted/omitted. After step 4472, the method 4470 proceeds through a number of checks to ensure charging is appropriate.

At process 4472, the onboard chargers 152 receive a plug in signal. The plug in signal indicates that the external power source 156 is coupled to the charging connector 154 (e.g., via the wall adapter 158). In some embodiments, the plug in signal is received from the manual interface 153 in response to manual actuation of the manual interface 153 by a user.

At process 4474, the controller 200 determines whether the key is in the off position. If the key is determined to be in any position other than the off position, the controller 200 will disallow the charging session. If the key is determined to be in the off position, the controller 200 will allow the method 4470 to continue to process 4476.

At process 4476, the controller 200 provides one or more commands to wake up the onboard chargers 152 and the user interface 34 (e.g., at least one display of the user interface 34, a GUI of the user interface 34, etc.). In some embodiments, the process of waking up the onboard chargers 152 and the user interface 34 includes the controller 200 sending a wake up command signal, wherein the wake up command signal is structured to cause the receiving components to enter an operating mode. In some embodiments, the wake up command signal is provided automatically in response to the external power source 156 being coupled to the charging connector 154. In some embodiments, the onboard chargers 152 is activated when the external power source 156 is coupled to the charging connector 154 without the need for intervention from the controller 200. In some embodiments, the process of waking up the onboard chargers 152 includes at least a portion of the method 1410.

At process 4478, charging information (i.e., current level, voltage level, etc.) is determined and indicated to the controller 200. In some embodiments, the determination of the process 4478 is carried out by the onboard chargers 152, which send an indication of the charging information to the controller 200. In some embodiments, the sensors may be or include a current sensor configured to monitor the level of current being received and provide an indication to the controller 200 of the current level. The determination of the charging information allows the controller 200 to correctly configure parts of the onboard charging circuit shown in FIG. 77, based on the charging information. In some embodiments, a power level of the charging information is based on a temperature of the high-voltage battery 132. The charging speed (e.g., power level) may vary based on the temperature of the high-voltage battery 132, the SOC of the high-voltage battery 132, the SOH of the high-voltage battery 132, etc.

At process 4480, the controller 200 determines if a plurality of start criteria are met. If one or more of the plurality of start criteria are not met, the process proceeds to step 4486 and disallows the charging session at that time. The plurality of start criteria may include one or more of an activation status of one or more components of the telehandler 10, a temperature of the battery 132, a SOC of the battery 132, a time of day, and other similar criteria. For example the plurality of start criteria may include the status of an ignition of the telehandler 10, a parking brake of the telehandler 10, the transmission 94, the high-voltage battery 132, and the onboard chargers 152. The controller 200 will determine the start criteria to be met responsive to receiving indications indicating that the ignition is off, the parking brake is on, the transmission 94 is in neutral, the high-voltage battery 132 is not faulted, the state of charge for the high-voltage battery 132 is less than full (e.g., 100%), and the onboard chargers 152 are not faulted. Responsive to any one or more of these criteria being determined not be met, the controller 200 will continue to process 4486 and disallow the charging session. Responsive to determining all of the start criteria have been met, the controller 200 will continue to process 4482. In some embodiments, if the start criteria includes a temperature of the high-voltage battery 132 being within a predetermined charging range and the temperature of the high-voltage battery 132 is outside of that range, the controller 200 and/or the onboard chargers 152 may activate a heater to heat the high-voltage battery 132. In some embodiments, the high-voltage battery 132 is heated by controlling a discharge of the high-voltage battery 132. In some embodiments, if the start criteria includes a temperature of the high-voltage battery 132 being within a predetermined charging range and the temperature of the high-voltage battery 132 is outside of that range, the controller 200 and/or onboard chargers 152 may pause the method 4470 until the temperature of the high-voltage battery 132 drops to within the predetermined charging range. In some embodiments, the high-voltage battery 132 is actively cooled and step 4480 further includes activating a thermal management system to cool the high-voltage battery 132.

At process 4482, the controller 200 will allow the charging session and begin the charging operation. In response to allowing the charging session, the controller 200 will begin the charging operation. Upon beginning the charging operation, the onboard chargers 152 provide high-voltage electrical energy to the high-voltage battery 132.

At process 4484, the controller 200 indicates that the charging operation is active. In some embodiments, the controller 200 operates the user interface 34 to provide an indication that the charging operation is active. In some embodiments, the indication may be or include an LED being operated to provide a user an indication that charging is active. In other embodiments, the indication may be or include the operation of any user interface device (e.g., a screen, a display, a GUI, etc.) to alert users of active charging.

In some embodiments, at process 4484, the controller 200 indicates an amount of time until the SOC of the high-voltage battery 132 is at or above a predetermined threshold, such as 80% or 100%. For example, the controller 200 may operate the user interface 34 to provide an indication of the amount of time until the SOC of the high-voltage battery 132 is at or above the predetermined threshold. In some embodiments, the indication may include providing text or an image on a screen/display of the user interface 34.

In some embodiments, during DC charging, isolation monitoring on the vehicle 10 is disabled and isolation monitoring from the charger (e.g., external power source 156) is used instead. Isolation monitoring ensures that the high-voltage components of the telehandler 10 are isolated from the low-voltage components and/or the chassis of the telehandler 10. In some embodiments, it is preferable during DC charging to disable the onboard isolation monitoring and rely on isolation monitoring from the external power source 156.

### Ventilated Battery Compartment

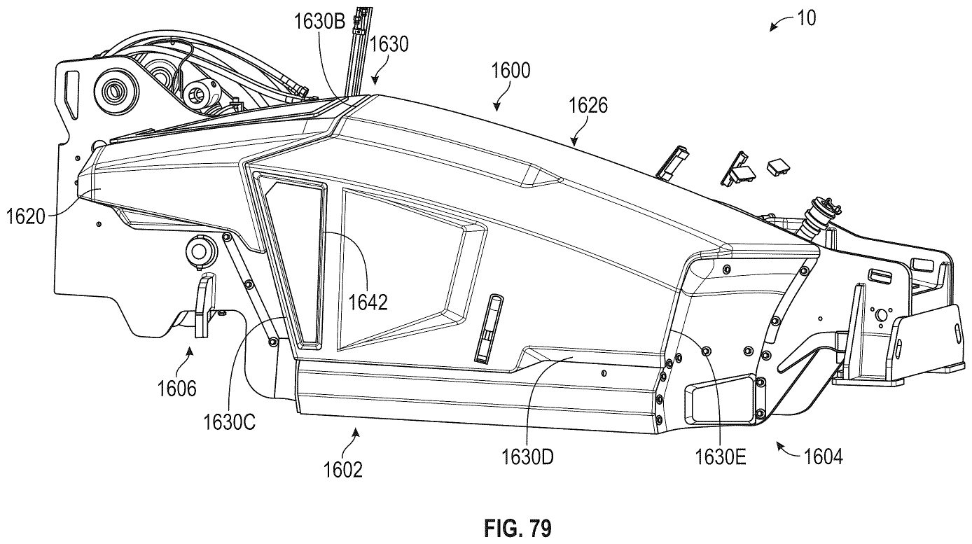

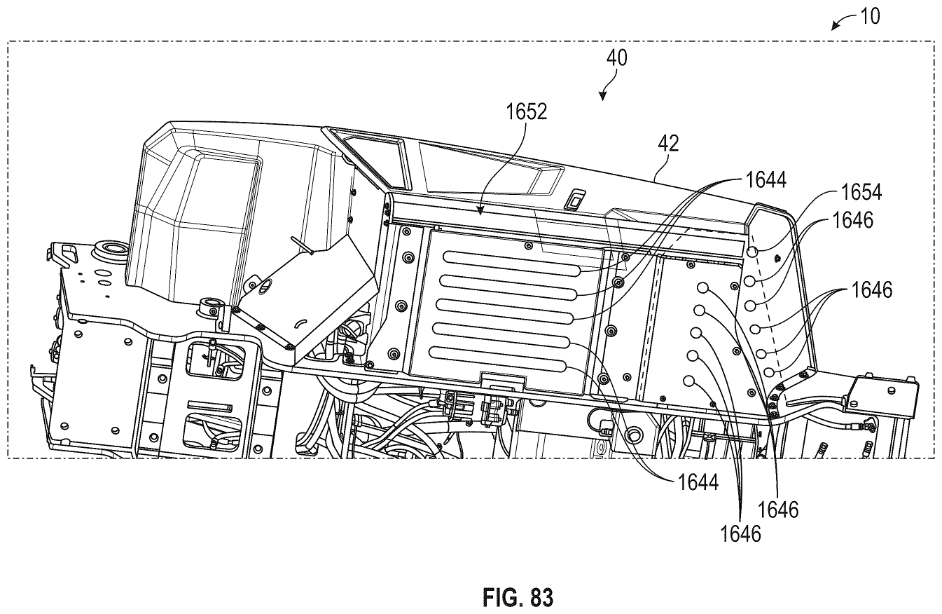

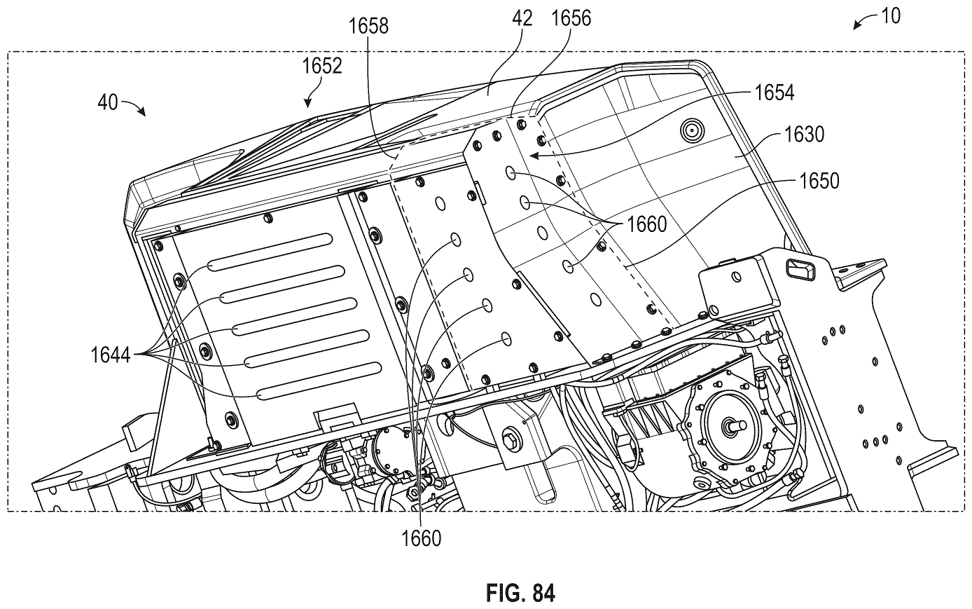

Referring to FIGS. 79-86, the battery housing 40 is shown according to an exemplary embodiment. The battery housing 40 contains the high-voltage battery 132 and includes features (e.g., vent apertures) that control the flow of air throughout the battery housing 40. Advantageously, these features may direct cool air to flow into the battery housing 40, contact the high-voltage battery 132, and exit the battery housing 40 once heated (e.g., the battery housing 40 acts as a ventilated battery compartment). Additionally, the battery housing 40 may include features (e.g., baffles, dividers) that separate hot components from the high-voltage battery 132, preventing those components from heating the high-voltage battery 132. In some embodiments, the battery housing 40 facilitates continuous operation of the high-voltage battery 132 (e.g., for an eight hour work day) without requiring liquid cooling of the high-voltage battery 132 (e.g., such that the high-voltage battery 132 is solely air-cooled).

As shown, the battery housing 40 generally includes a series of sides or faces. A top side 1600 of the battery housing 40 faces upward (e.g., away from a ground surface). A bottom side 1602 of the battery housing 40 faces downward (e.g., toward a ground surface). A front side 1604 of the battery housing 40 faces forward (e.g., in a forward longitudinal direction of travel of the telehandler 10). A rear side 1606 of the battery housing 40 faces rearward (e.g., opposite the forward direction of travel of the telehandler 10). An inner side 1608 of the battery housing 40 faces laterally inward (e.g., toward the frame assembly 12). An outer side 1610 of the battery housing 40 faces laterally outward (e.g., away from the frame assembly 12).

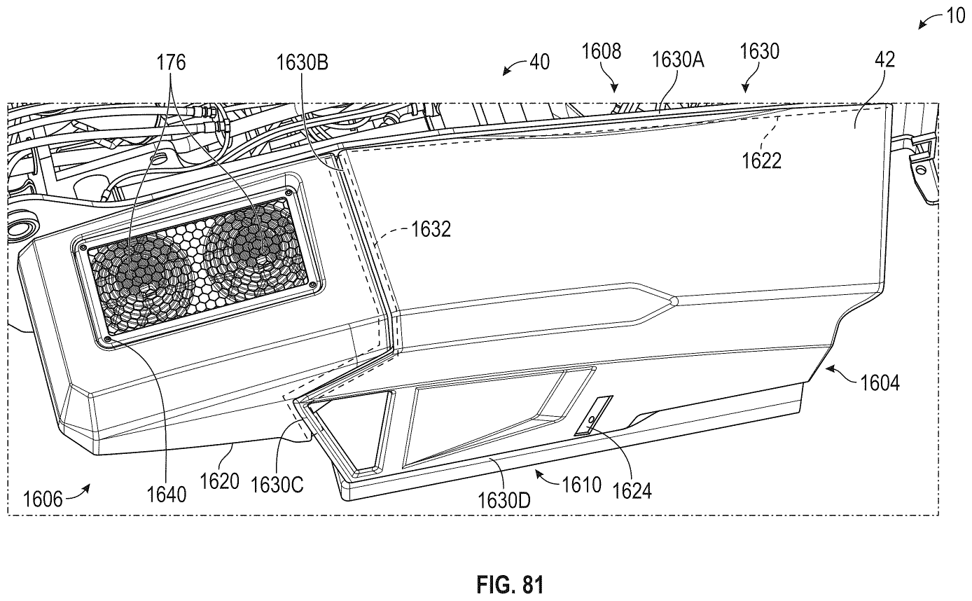

As shown in FIG. 81, the battery housing 40 includes a fust portion or fixed portion, shown as body 1620, that is fixedly coupled to the frame assembly 12. The door 42 is pivotably coupled to the body 1620. The door 42 is rotatable about an axis of rotation, shown as axis 1622, between a lowered or closed position (e.g., as shown in FIG. 81) and a raised or open position. The axis 1622 extends longitudinally along the top side 1600 of the battery housing 40. The door 42 includes a latch, catch, handle, or lock, shown as lock 1624, that selectively couples the door 42 to the body 1620 to hold the door 42 in the closed position. A user may interact with the lock 1624 and lift the door 42 to move the door 42 to the open position. Accordingly, the door 42 may act as a hood of the battery housing 40.

The battery housing 40 defines a volume or space, shown as internal volume 1626, within the battery housing 40. Specifically, the internal volume 1626 is defined between the body 1620 and the door 42. The internal volume 1626 contains various components of the telehandler 10, such as the implement motor 112, the implement pump 114, the control valves 122, the accumulator 124, the high-voltage battery 132, the HVPDU 134, the low-voltage battery 136, the LVPDM 138, the low-voltage disconnect 140, the radiators 172, the coolant pumps 174, and the fans 176. A user may lift the door 42 to the open position to access one or more of these components within the internal volume 1626 (e.g., for maintenance)

As shown in FIGS. 79-81, a boundary, gap, space, slit, opening, slit, or vent, shown as door gap 1630, extends between the body 1620 and the door 42 when the door 42 is in the closed position. The door gap 1630 includes a series of segments that are continuous with one another to surround a perimeter of the door 42. A first segment 1630A extends longitudinally along the top side 1600. A second segment 1630B extends laterally outward from the first segment 1630A, along the top side 1600. A third segment 1630C extends downward from the second segment 1630B, along the outer side 1610. A fourth segment 1630D extends longitudinally forward from the third segment 1630C, along the outer side 1610. A fifth segment 1630E extends upward from the fourth segment 1630D, along the front side 1604, and meets the first segment 1630A.

The door gap 1630 may serve as an inlet and/or an outlet to the internal volume 1626. When acting as an inlet, air from the surrounding environment may pass into the internal volume 1626 through the door gap 1630. As shown in FIG. 81, to control the locations where air passes into the internal volume 1626 (e.g., to limit where air is drawn into the internal volume 1626), the battery housing 40 may include one or more seals or weatherstripping segments, shown as seals 1632. The seals 1632 may extend across the door gap 1630, engaging both the body 1620 and the door 42 to seal that portion of the door gap 1630. In some embodiments, the seals 1632 are coupled to the body 1620 and positioned to engage the door 42 only when the door 42 is in the closed position, permitting the door 42 to move away from the seals 1632 when moving to the open position.

In some embodiments, the battery housing 40 includes seals 1632 along the second segment 1630B and the third segment 1630C of the door gap 1630. These portions of the door gap 1630 are the portions closest to the radiators 172. Accordingly, this placement of the seals 1632 may prevent hot air from exiting the radiators 172 and immediately being drawn back into the internal volume 1626 through the door gap 1630 (i.e., recirculating). Recirculating may be undesirable, as it may reduce the rate at which the high-voltage battery 132 is cooled.

As shown in FIG. 81, the body 1620 defines an exhaust port, radiator port, or outlet, shown as exhaust port 1640. The exhaust port 1640 is positioned along the top side 1600 near the rear side 1606 and faces upward. The exhaust port 1640 is in direct fluid communication with an assembly that includes the radiators 172 and the fans 176. During operation, the fans 176 direct air from the internal volume 1626 through the radiators 172 and out of the exhaust port 1640. Accordingly, heated air is rejected from the internal volume 1626 through the exhaust port 1640 and passes upward, away from the battery housing 40. Placing the exhaust port 1640 along the top side 1600 may minimize the potential for recirculation, as the heated air has a tendency to rise upward, away from the battery housing 40.

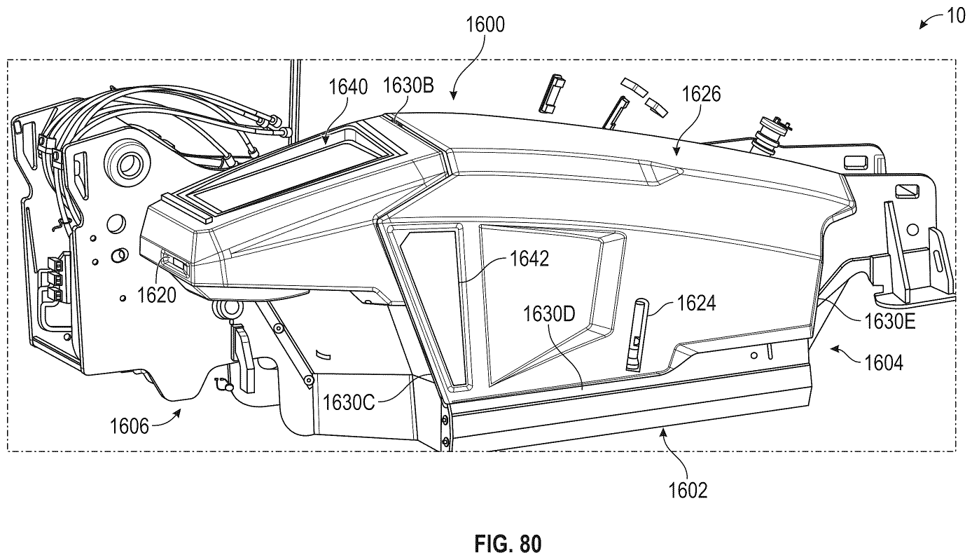

As shown in FIGS. 79 and 80, the door 42 defines an air inlet, cool air port, or ventilation aperture, shown as inlet 1642. The inlet 1642 is positioned along the outer side 1610 and extends along the third segment 1630C of the door gap 1630. The inlet 1642 faces laterally outward. The inlet 1642 permits cool air from the surrounding environment to pass laterally inward into the internal volume 1626. The inlet 1642 may be positioned such that the cool air flowing into the inlet 1642 contacts the high-voltage battery 132 to cool the high-voltage battery 132. In some embodiments, the inlet 1642 is covered with a mesh, screen, or shield to prevent ingress of debris through the inlet 1642.

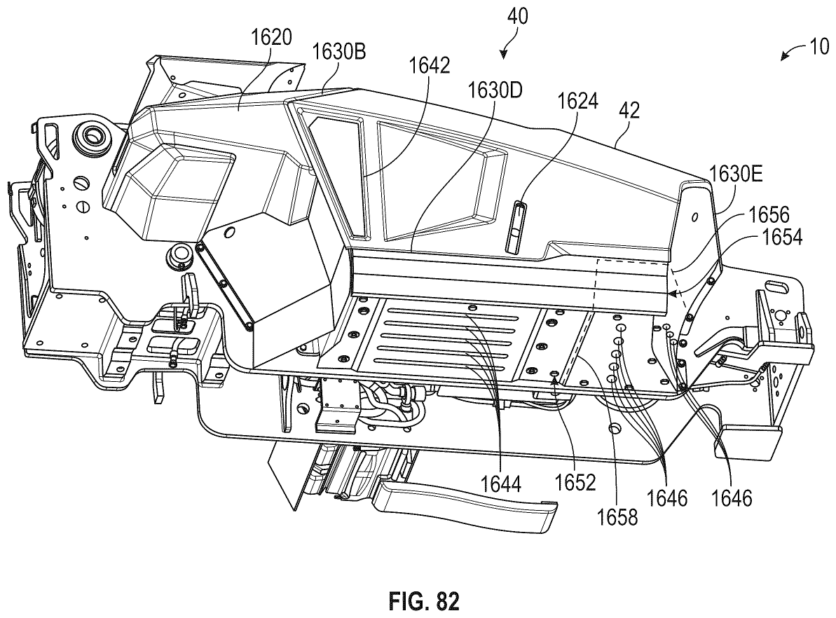

As shown in FIGS. 82-84, the body 1620 defines a series of air inlets, cool airports, or ventilation apertures, shown as inlets 1644. The inlets 1644 are positioned along the bottom side 1602 and extends along the fourth segment 1630D of the door gap 1630. The inlets 1644 face downward. The inlets 1644 permit cool air from the surrounding environment to pass upward into the internal volume 1626. The inlets 1644 are positioned such that the cool air flowing into the inlets 1644 contacts a bottom surface of the high-voltage battery 132 to cool the high-voltage battery 132. In some embodiments, the inlets 1644 are covered with a mesh, screen, or shield to prevent ingress of debris through the inlets 1644.

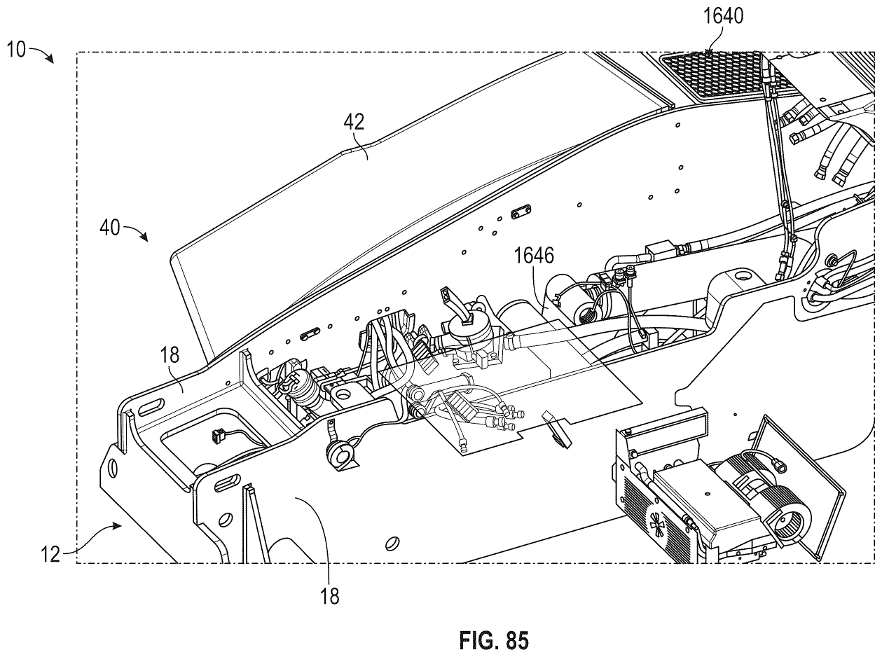

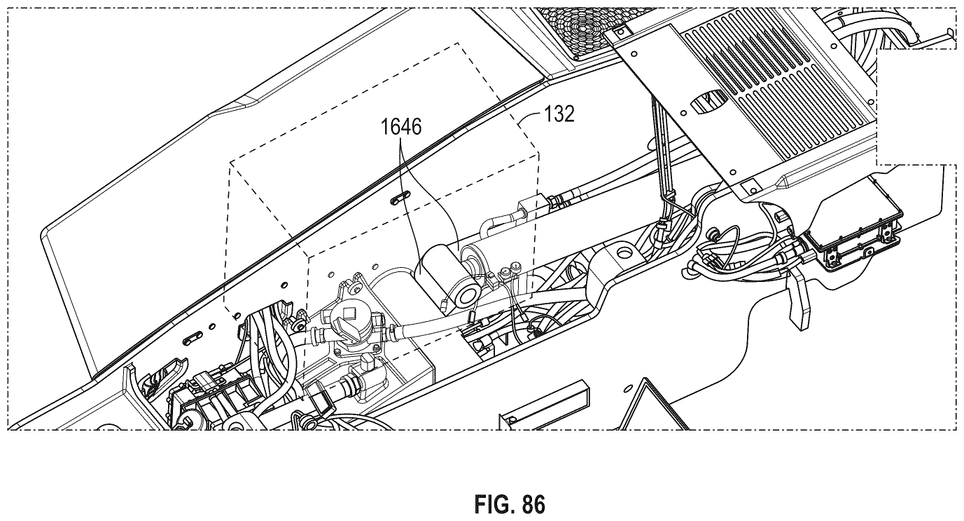

As shown in FIGS. 85 and 86, the frame assembly 12 and the body 1620 define an air inlet, cool air port, or ventilation aperture, shown as inlet 1646. The inlet 1646 is positioned along the inner side 1608. The inlet 1646 extends laterally through a side plate 18 of the frame assembly 12 and the body 1620, such that the inlet 1646 fluidly couples the internal volume 1626 to the central area 22. The inlet 1646 permits cool air from the central area 22 to pass laterally outward into the internal volume 1626. The inlet 1646 may be positioned such that the cool air flowing into the inlet 1646 contacts the inner side 1608 of the high-voltage battery 132 to cool the high-voltage battery 132. In some embodiments, the inlet 1646 is covered with a mesh, screen, or shield to prevent ingress of debris through the inlet 1646.

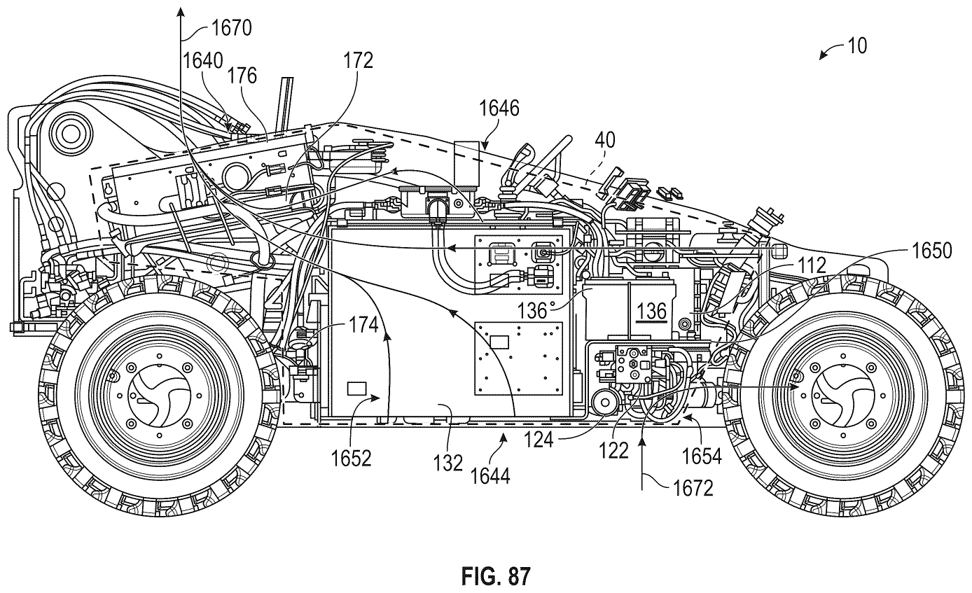

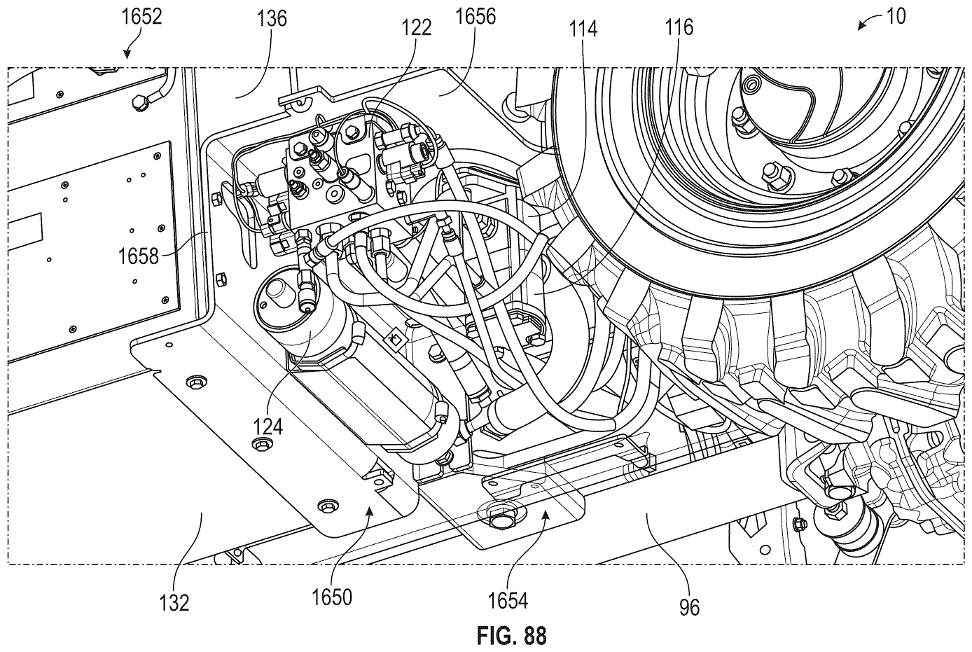

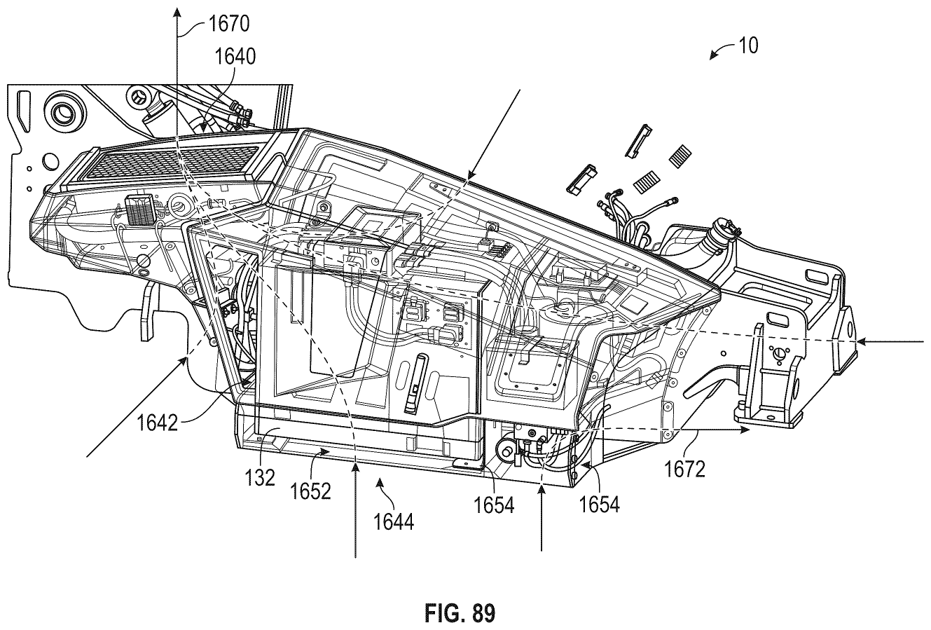

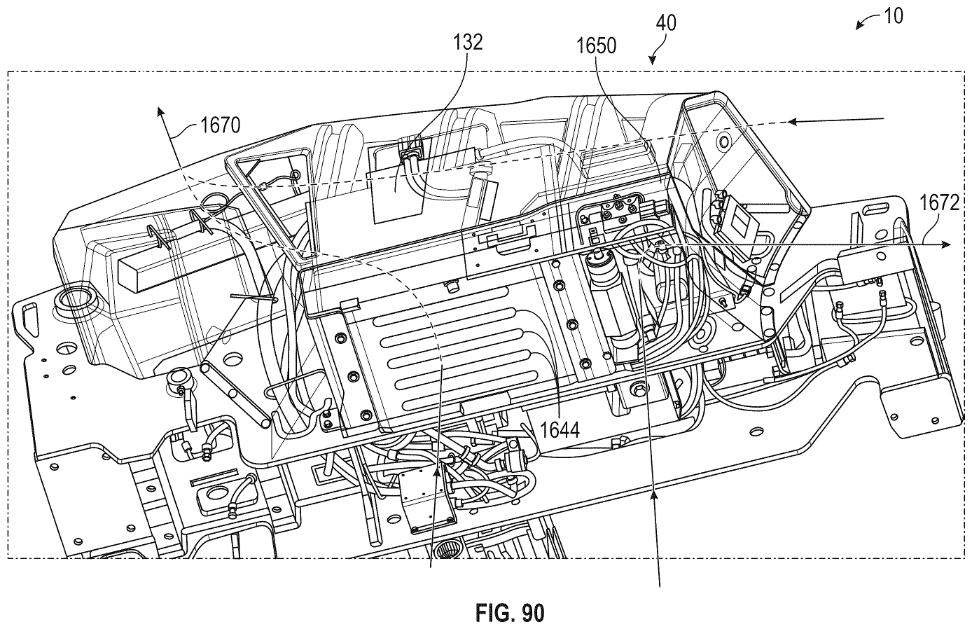

Referring to FIGS. 87-90, the battery housing 40 includes a baffle, divider, shelf, support, or separator, shown as shelf 1650. The shelf 1650 is positioned within the internal volume 1626 and fixedly coupled to the body 1620. The shelf 1650 divides the internal volume 1626 into a first portion, shown as battery area 1652, and a second portion, shown as hydraulics area 1654. The shelf 1650 includes a first panel, portion, or member, shown as horizontal panel 1656, fixedly coupled to a second panel, portion, or member, shown as vertical panel 1658.

The battery area 1652 contains the implement motor 112, the high-voltage battery 132, the HVPDU 134, the low-voltage battery 136, the LVPDM 138, the low-voltage disconnect 140, the radiators 172, the coolant pumps 174, and the fans 176. The hydraulics area 1654 contains various hydraulic components, including the implement pump 114, the steering pump 116, the control valves 122, and the accumulator 124.

The shelf 1650 provides structure to support various components of the telehandler 10. The low-voltage battery 136 and the implement motor 112 rest atop the horizontal panel 1656. The implement pump 114, the steering pump 116, and the control valves 122 hang downward from the horizontal panel 1656. The accumulator 124 is fixedly coupled to a first side of the vertical panel 1658. The high-voltage battery 132 is fixedly coupled to an opposing second side of the vertical panel 1658.

The battery area 1652 contains a first continuous volume of air that is permitted to pass freely between the components of the battery area 1652. The hydraulics area 1654 contains a second continuous volume of air that is permitted to pass freely between the components of the hydraulics area 1654. In some embodiments, the shelf 1650 acts as a barrier or baffle to fluidly decouple the battery area 1652 from the hydraulics area 1654 and prevent air from the hydraulics area 1654 from passing directly into the battery area 1652.

The hydraulic system 110 may generate heat during operation. This may increase the temperature of the hydraulic components within the hydraulics area 1654, heating the air within the hydraulics area 1654. Beneficially, by separating the hydraulics area 1654 from the battery area 1652, the shelf 1650 prevents the generated heat from passing into the battery area 1652 and heating the high-voltage battery 132. The components within the battery area 1652 may either (a) only generate a small amount of heat, such that they do not materially contribute to heating the high-voltage battery 132 (e.g., such as the LVPDM 138), or (b) be actively cooled by the cooling system 170 (e.g., such as the implement motor 112). Accordingly, the air passing through the battery area 1652 may primarily work to air cool the high-voltage battery 132, then subsequently cool the radiators 172.

As shown in FIGS. 82-84, the body 1620 defines a series of inlets and/or outlets or ventilation ports, shown as ventilation ports 1660. The ventilation ports 1660 are positioned along the bottom side 1602 and the front side 1604 (e.g., a first subset of the ventilation ports 1660 extend along the bottom side 1602, and a second subset of the ventilation ports 1660 extend along the front side 1604). The ventilation ports 1660 face downward and/or forward. The ventilation ports 1660 are in fluid communication with the hydraulics area 1654. The ventilation ports 1660 may permit air to pass into and out of the hydraulics area 1654 to cool the implement pump 114, the steering pump 116, the control valves 122, and the accumulator 124. In some embodiments, the ventilation ports 1660 are covered with a mesh, screen, or shield to prevent ingress of debris through the ventilation ports 1660.

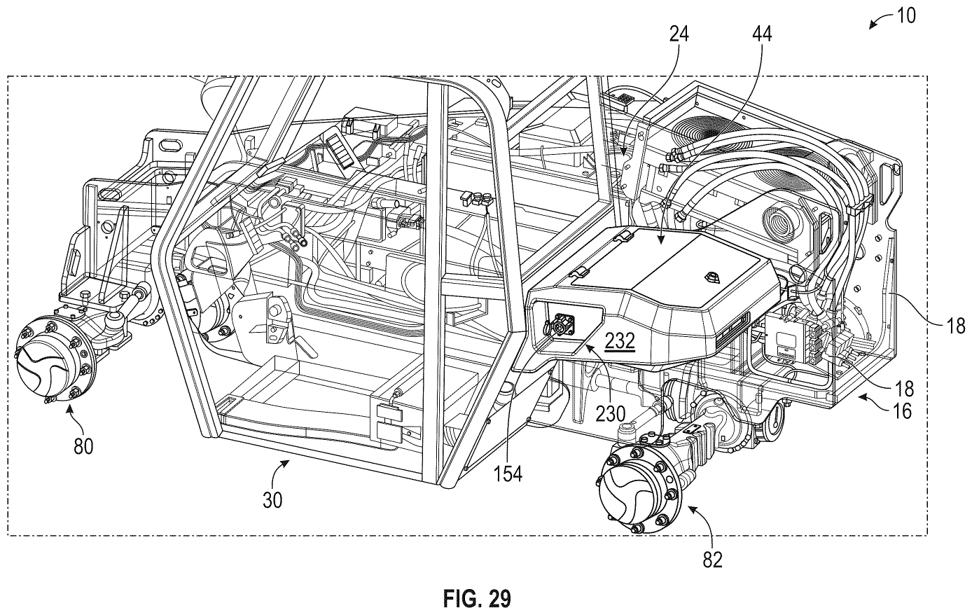

Referring to FIGS. 87, 29, and 30, airflow through the battery housing 40 is shown according to an exemplary embodiment. First airflow, shown as airflow 1670, passes through the battery area 1652. The airflow 1670 enters the battery area 1652 through (a) the unblocked portions of the door gap 1630, (b) the inlet 1642, (c) the inlets 1644, and (d) the inlet 1646. The airflow 1670 flows around the high-voltage battery 132, removing thermal energy from the high-voltage battery 132 and heating the airflow 1670. The airflow 1670 then passes through the radiators 172, removing thermal energy from the cooling system 170 and further heating the airflow 1670. The airflow 1670 then exits through the exhaust port 1640 and passes upward. Movement of the airflow 1670 is driven through convection of the heated airflow 1670, as well as the active operation of the fans 176. Accordingly, due to the arrangement of the battery housing 40, the fans 176 both (a) remove thermal energy from the radiators 172 and (b) provide active air cooling of the high-voltage battery 132.

Second airflow, shown as airflow 1672, passes through the ventilation ports 1660 and into the hydraulics area 1654. The airflow 1672 removes thermal energy from the implement pump 114, the steering pump 116, the control valves 122, and the accumulator 124, heating the airflow 1672. The heated airflow 1672 then exits the hydraulics area 1654 through the ventilation ports 1660.

Beneficially, the layout of the battery housing 40 facilitates air cooling of the high-voltage battery 132. By way of example, the battery housing 40 provides several ventilation apertures, through which cool air may enter the battery housing 40 and cool the high-voltage battery 132. The heated air is then actively drawn away from the high-voltage battery 132. The shelf 1650 of the battery housing 40 separates various heated components from the high-voltage battery 132, preventing the heat from those components from being transferred to the high-voltage battery 132. Without the enhanced air cooling arrangement of the battery housing 40, the high-voltage battery 132 may otherwise be unable to achieve sufficient temperature regulation through air cooling alone, such that the high-voltage battery 132 would require liquid cooling.

In some aspects, a vehicle includes: a chassis; a tractive element rotatably coupled to the chassis; a drive motor coupled to the chassis and configured to drive the tractive element to propel the vehicle; a battery configured to supply electrical energy to the drive motor, a component configured to become heated during operation of the vehicle; a housing coupled to the chassis and having an internal volume containing the battery and the component; and a divider fixedly coupled to the housing and dividing the internal volume into a first area containing the battery and a second area containing the battery, wherein the divider extends between the component and the battery to resist thermal energy from the component being transferred to the battery.

In some aspects, the component is at least one of a pump, a control valve, or an accumulator.

In some aspects, the housing defines an inlet and an outlet each in fluid communication with the first area, and the vehicle further includes a fan positioned to move air from a surrounding atmosphere through the inlet, to the battery, and through the outlet to cool the battery.

In some aspects, the vehicle further includes a radiator coupled to the housing. The fan is positioned to move the air through the radiator after the air contacts the battery.

In some aspects, the vehicle further includes a pump and a motor configured to drive the pump. The motor is positioned within the first area and the pump is positioned within the second area, and the radiator is fluidly coupled to the motor by a coolant circuit.

In some aspects, the housing includes a door that is repositionable from a closed position to an open position to facilitate access to the battery, and the divider separates the component from the door.

### High Voltage Interlock Loop Pass Through System

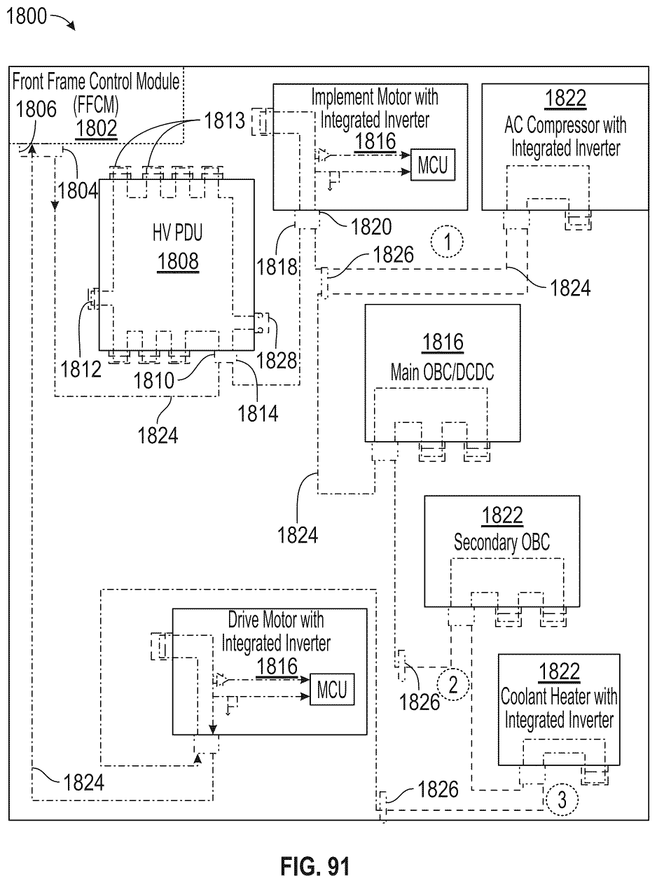

Referring to FIGS. 91-98, depicted are embodiments, processes, and methods relating to a high voltage (HV) interlock loop (e.g., HV interlock loop, HVIL) pass through system. The HVIL pass through system may be included in the telehandler 10 or may be included in a different work machine including a plurality of high voltage components. Although the configurations described herein refer to the telehandler 10, it is implied that other configurations may refer to other work machines/vehicles. The HVIL pass through system may be implemented in the telehandler 10 when the telehandler 10 has a variable configuration. For example, when a desired operation of the telehandler 10 does not include all the high voltage components of the telehandler 10, the HVIL pass through system may be implemented to temporarily (e.g., not permanently) omit or disconnect components from the high voltage circuit.

Referring to FIG. 91, depicted is a block diagram of an HVIL pass through system 1800, according to an exemplary embodiment. The HVIL pass through system 1800 can include a front frame control module (FFCM) 1802. The FFCM 1802 may be configured to receive low voltage (LV) electricity from a battery (e.g., low-voltage battery 136, high-voltage battery 132 and DC-DC converter 160). The FFCM 1802 may be configured to convert the LV electricity into an LV signal (e.g., sinusoid, square wave, etc.) or may not convert the LV electricity. The FFCM 1802 may be configured to transmit the LV signal via an HVIL source 1804. The FFCM 1802 may be configured to receive an LV signal via an HVIL sink 1806. The LV signal from the HVIL source 1804 passes through one or more electronic couplings or ports of one or more high voltage components in the high voltage circuit of the telehandler 10 before returning to the FFCM 1802 via the HVIL sink 1806. The FFCM 1802 monitors the difference between the LV signal sent at the HVIL source 1804 and the HVIL sink 1806 to determine a status of the integrity and/or continuity of the high voltage circuit. When the LV signal is changed, degraded, or otherwise altered outside of a threshold range, the FFCM 1802 determines a fault has occurred in the high voltage circuit and may perform an automatic control action in response to detecting the fault.

The HVIL source 1804 is wired or otherwise electronically coupled to an HV power distribution unit (e.g., HVPDU) 1808, which may be the same as or similar to the HVPDU 134. The HVPDU 1808 may include components or features of the HVPDU 134. The HVPDU 1808 includes an HVIL inlet port 1810 configured to receive the LV signal from the HVIL source 1804. The HVPDU 1808 includes an HV inlet port 1812 configured to receive HV electricity from the battery. The HVPDU 1808 includes a plurality of other inlet/outlet high voltage ports 1813. Each of the ports of the HVPDU 1808 include a part of an HVIL connector 1824 for carrying the LV signal. Specifically, each of the ports of the HVPDU 1808 include both an HVIL input and an HVIL output connection. Each coupler at the HVPDU 1808 includes a corresponding wire to receive the LV signal at the HVIL output connection and provide the LV signal back at the HVIL input connection. If a port of the HVPDU has a faulty connection, for instance if a cap for the port or an electronic coupling to the port is missing, one of or both of the HVIL input and the HVIL output may not be electrically connected to the corresponding wire in the corresponding coupler to complete the HVIL circuit. The HVIL circuit would be broken and the FFCM 1802 may receive no LV signal at the LV sink 1806 or an LV signal at the sink 1806 that is outside the allowable range, thus indicating that a fault has occurred in the corresponding high voltage circuit. In some embodiments, the HV inlet port 1812 and the HVIL inlet port 1810 are the same port. In alternate embodiments, the HV inlet port 1812 and the HVIL inlet port 1810 are separate ports. The HVPDU 1808 may have a control switch 1828 configured to physically disable the HVPDU 1808 from forming a complete circuit. The control switch 1828 may be a manual switch (e.g., requires physical operation), or an automatic switch (e.g., controlled by the FFCM 1802). The HVPDU 1808 includes an HVIL outlet port 1814 configured to transmit the LV signal and the HV electricity from the HVPDU 1808 to various system components. Transmitting both the LV signal and the HV electricity from the HVIL outlet port 1814 may serve to allow similar connection between the HVPDU 1808 and other system components for the LV signal and the HV electricity, thereby enabling (e.g., allowing, facilitating) active monitoring of HV connections using LV signal.

The HVIL outlet port 1814 may be wired or otherwise electronically coupled to a main component 1816, shown as implement motor with integrated inverter. As referred to herein, a main component is an HV component of the telehandler 10 that is essential for telehandler 10 operation (e.g., active in all useful configurations). The main component 1816 may be a different component of the telehandler 10 (e.g., main OBC/DCDC, drive motor with integrated inverter). The LV signal may be received by the main component 1816 via an inlet port 1818. The inlet port 1818 may be configured to receive a single electrical plug. The inlet port 1818 includes a first terminal configured to receive the LV signal. The main component 1816 includes an outlet port 1820 configured to transmit and/or receive the LV signal and the HV electricity to or from other telehandler 10 components. The outlet port 1820 includes a first terminal configured to transmit and receive the LV signal. The outlet port 1820 may be wired or otherwise electronically coupled to other main components 1816 and/or to an optional component 1822. As referenced herein, an optional component 1822 is a telehandler 10 component that may not be essential for all telehandler 10 operations and/or configurations. For example, the AC compressor, the coolant heater, and other components may be optional components 1822.

HV electricity may be supplied from the outlet high voltage ports 1813 to the main components 1816 via high voltage ports 1819. The coupling of a connector (e.g., a plug) to the high voltage port 1819 may electrically connect the inlet port 1818 to the outlet port 1820.

The main components 1816, optional components 1822, HVPDU 1808, and FFCM 1802 may be wired or otherwise electronically coupled via a series circuit (with reference to the LV signal). Coupling components into a series circuit may serve to allow for active monitoring of system connections. At each port of a component, the HVIL both passes into the component and leaves the component. At each port of a component, the HVIL circuit may have a break that is filled by a plug that bridges the break to maintain the continuity of the HVIL circuit. For example, if one or more plugs of a component do not bridge the break, the FFCM 1802 may determine that the HVIL sink 1806 is not receiving any signal, indicating that there is a break (e.g., loss of connectivity) in the circuit. In some embodiments, upon determining that there is a break in the circuit (e.g., HVIL circuit), the FFCM 1802 transmits an instruction to the battery to disable HV transmission. In some embodiments, the FFCM 1802 transmits an instruction to change the operation of one or more other components of the telehandler 10 and/or provide an alert to a user.

HV components of the telehandler 10 (e.g., main components 1816, optional components 1822) may be electronically coupled via HVIL connectors 1824. The HVIL connector 1824 includes a wire configured to carry the LV signal. The HVIL connectors 1824 each includes a plug at each end configured to interact with (e.g., couple with) the inlet port 1818 and the outlet port 1820. The LV signal passes through the plug, into the HV component, into the high voltage ports 1819 to the high voltage connector, back into the main component 1816, and back into the HVIL plug. The LV signal thus passes through each port of an HV component (e.g., one of the main components 1816 or the optional components 1822, etc.) to ensure each port is either capped or coupled to a high-voltage connector. If capped, the cap may be similar to an HV connector plug and receive the LV signal from the HVIL circuit internal to the component and pass the LV signal directly back to the internal HVIL circuit of the component to maintain the continuity of the HVIL circuit.

In some embodiments, it is desirable for one or more optional components 1822 to be omitted (e.g., removed) from the circuit. A jump wire 1826 may be placed between two connectors 1824 of an optional component 1822 to create a short circuit between the connectors 1824, thereby removing the optional component 1822 from the circuit. The jump wire 1826 may be physically placed on the connectors 1824 by a user, or the jump wire 1826 may be placed by an actuator of the telehandler 10. The jump wire may be placed such that only optional components 1822 are removed from the circuit, and main components 1816 are not removed. When there are multiple adjacent optional components 1822 in the circuit, and both optional components 1822 are to be omitted, one jump wire 1826 may be used to bypass both optional components 1822.

Although the jump wires 1826 of system 1800 may allow for the removal of optional components 1822 from the circuit, there may be limitations to this approach in the context of active monitoring. For example, if the jump wire 1826 removes an optional component 1822 from the circuit, there is an unmonitored connection between the connector 1824 and the optional component 1822. If the connector 1824 were to come into contact (e.g., electronically couple) with a different electrified component (e.g., battery, other LV system, etc.), unmonitored connections may exist in the system 1800, which may cause damage or other issues.

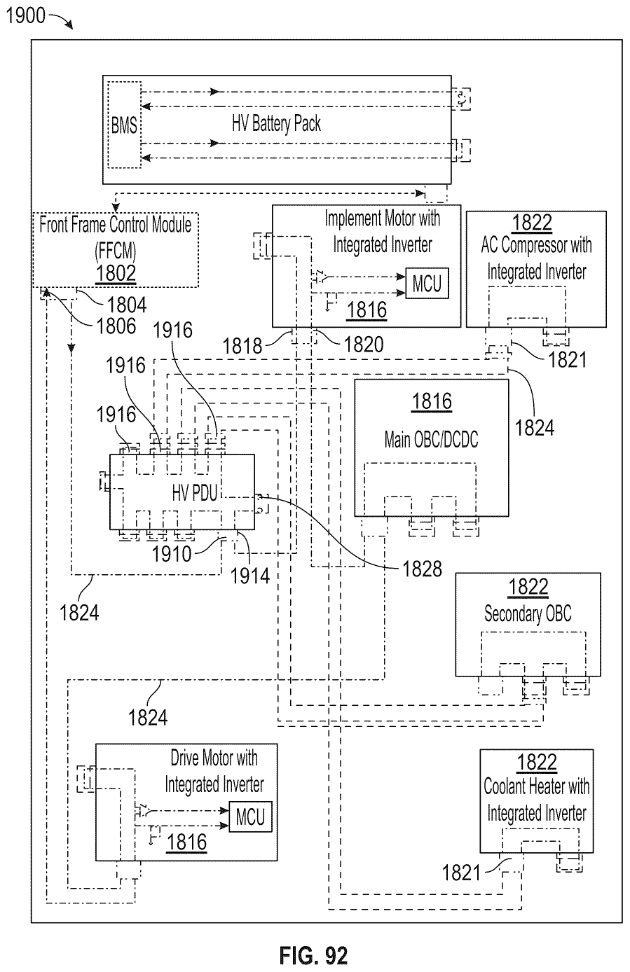

Referring to FIGS. 91 and 92, due to potential erroneous connections between electrical components, it is desirable, in some embodiments, to not only remove an optional component 1822 from the HVIL circuit, but to ensure that the optional component 1822 is unable to connect (e.g., electrically couple) with any other electrical component of the telehandler 10. In alternate embodiments, it may be desirable to manufacture the telehandler 10 without certain optional components 1822, but still using the same FFCM 1802, HVPDU 1808, and/or main components 1816. For example, if one embodiment of the telehandler 10 should be manufactured with air conditioning and another embodiment of the telehandler 10 should be manufactured with no air conditioning, the air conditioning components can be omitted from manufacture without impacting other components of the telehandler 10.

Referring to FIG. 92, depicted is a block diagram of an HVIL system 1900 with variable power distribution, according to an exemplary embodiment. HVIL system 1900 may have any components described in HVIL system 1800, including but not limited to FFCM 1802, main components 1816, optional components 1822, connectors 1824, inlet port 1818, outlet port 1820, or other telehandler 10 components. In the HVIL system 1900, the optional components 1822 are coupled to the HV circuit and to the HVIL circuit by the same connectors at the HVPDU 1908. Thus, rather than the LV signal being provided to the inlet port 1818 and passing into and out of the connector at the high voltage port 1819, the LV signal travels through the same connector as the HV electricity (e.g., through separate wires) to the optional component 1822 and then back to the HVPDU 1908 to complete the connection in the HVIL circuit. This connection may eliminate the jump wires 1826 used to isolate the optional components 1822 from the HVIL circuit. Instead, the optional components 1822 can be disconnected at the HVPDU 1908 directly and replaced with a jump cap 1926 to maintain the continuity of the HVIL system 1900. In this manner, no jump wires 1826 are required to isolate optional components 1822 from the HVIL circuit and when the optional components 1822 are omitted or isolated, they are at the same time disconnected from the HV circuit and are thus rendered safe. For example, referring first to FIG. 91, in the HVIL pass through system 1800, an optional component 1822 is coupled in series between two main components 1816. Jump wires 1826 are shown bypassing the connectors 1824 to bypass the optional component 1822. Referring now to FIG. 92, in the HVIL system 1900 the main components 1816 are connected directly to each other in series, and each of the series connections to the optional components 1822 are located at the HVPDU 1808. The connectors 1824 are shown in dashed lines to indicate they are optional and are present if and/or when the optional component 1822 is present.

The FFCM 1802 may receive or otherwise accept LV electricity from an HV battery pack 1902. The HV battery pack 1902 includes converters or other devices to convert HV DC electricity into LV electricity that the FFCM 1802 can process. The FFCM 1802 may receive the LV electricity from the HV battery pack 1902 and generate an LV signal to be transmitted through the system 1900. The LV signal can be a DC signal, AC sinusoidal signal, AC square wave, or other AC signal. The FFCM 1802 may transmit the LV signal from the HVIL source 1804 to an HVIL inlet port 1910 of an HV power distribution unit 1908 (e.g., PDU, HVPDU). The HVPDU 1908 can include any components or functionalities of the HVPDU 1808, such as the control switch 1828, as well as other components and functionalities.

The HVPDU 1908 includes multiple optional combined outlets 1916 configured to provide the LV signal and HV electricity to combined inlets 1821 of optional components 1822. The optional combined outlets 1916 may be configured so that a plug of a connector 1824 can removably couple the HVPDU 1908 to the optional component 1822. If the optional component 1822 corresponding to the optional combined outlet 1916 is omitted, a jump cap 1926 is coupled to the optional combined outlet 1916 to allow the HVIL circuit to still pass through the optional combined outlet 1916 and keep the HVIL circuit intact. The optional combined outlets 1916 thus have an active state and a pass through state. During the active state, the optional combined outlet 1916 is a part of a series circuit connecting the HVPDU 1908, the main components 1816, the FFCM 1802, and a connected optional component 1822. During the pass through state, the optional combined outlet 1916 is covered by a jump cap 1926 and therefore is a part of a series circuit connecting the HVPDU 1908, the main components 1816, the FFCM 1802, and jump cap 1926. The jump cap 1926 is configured to short circuit the optional combined outlet 1916 and to keep the series circuit even though the optional component 1822 is omitted. The number of optional combined outlets 1916 may be based on a number of optional components 1822 of the telehandler 10 or may be based on a maximum number of optional components 1822 for the telehandler 10 so that the HVPDU 1908 can be utilized across multiple embodiments.

Each individual optional combined outlet 1916 may be configured to connect to one optional component 1822 or may be configured to connect to multiple optional components 1822 connected in series. The optional combined outlet 1916 and/or the connector 1924 may include a sensor (e.g., multimeter, current sensor, voltage sensor, etc.) configured to determine whether a connection is established between the optional combined outlet 1916 and the optional component 1822. For example, the optional combined outlet 1916 can send a test current through a connector to determine a resistance value of the optional component, thereby determining if the circuit is open. Upon determining that the optional combined outlet 1916 is open (e.g., no established circuit), the HVPDU 1908 may be configured to disable HV transmission from the battery 1902.

The HVPDU 1908 includes an HVIL outlet port 1914 configured to transmit the LV signal and HV electricity from the HVPDU 1908 to the main component 1816. The HVIL outlet port 1914 includes features of the HVIL outlet port 1814. The HVIL outlet port 1914 is connected to the combined inlet port 1818 of the main component 1816. The main component 1816 includes the combined outlet port 1820 configured to transmit the LV signal and HV electricity from the main component 1816 to a different main component 1816. In some embodiments, all of the main components 1816 are connected in series with the HVPDU 1908 and the FFCM 1802.

Once all connections are established, the FFCM 1802, any present optional components 1822, any present jump caps 1926, and the main components 1816 are configured to form a series circuit for transmitting the LV signal. The HVPDU 1908 includes a sensing circuit (e.g., HVIL circuit) configured to adjust the arrangement of the main components 1816 and the optional components 1822 in the series circuit relative to the FFCM 1802. For example, the HVPDU 1908 includes switches (e.g., gates, wires, etc.) configured to rewire the circuit. In some embodiments, the main components include sensors (e.g., multimeters, voltage sensors, current sensors) configured to determine the status of connections within the circuit. For example, if there is a break in the circuit, the FFCM 1802 is configured to process the sensor data to determine an approximate location of the break within the circuit.

The FFCM 1802 may be configured to receive the LV signal from the last main component 1816 via the HVIL sink 1806. The FFCM 1802 may be configured to compare the LV signal to a predetermined threshold based on the LV signal at the time of generation. Based on the comparison, the FFCM 1802 may determine that there is a break in the circuit, or that there is an undesired connection of components within the telehandler 10 causing an error in the circuit. The FFCM 1802 may then transmit an instruction to the battery 1902 to disable HV transmission until the FFCM 1802 determines that the error is resolved.

In some embodiments, when the telehandler 10 is started (e.g., turned on, battery powered on, etc.), there is a delay in the beginning of HV transmission relative to LV transmission. By transmitting the LV signal before HV electricity, the FFCM 1802 can determine that the circuit is connected properly before any HV components are powered. Once the FFCM 1802 determines that the LV signal is properly transmitted throughout the HVIL circuit, the FFCM 1802 may send an instruction to the battery 1902 to begin HV transmission. This delay may mitigate damage caused by improper connections within the circuit and add an extra layer of monitoring in the HVIL circuit.

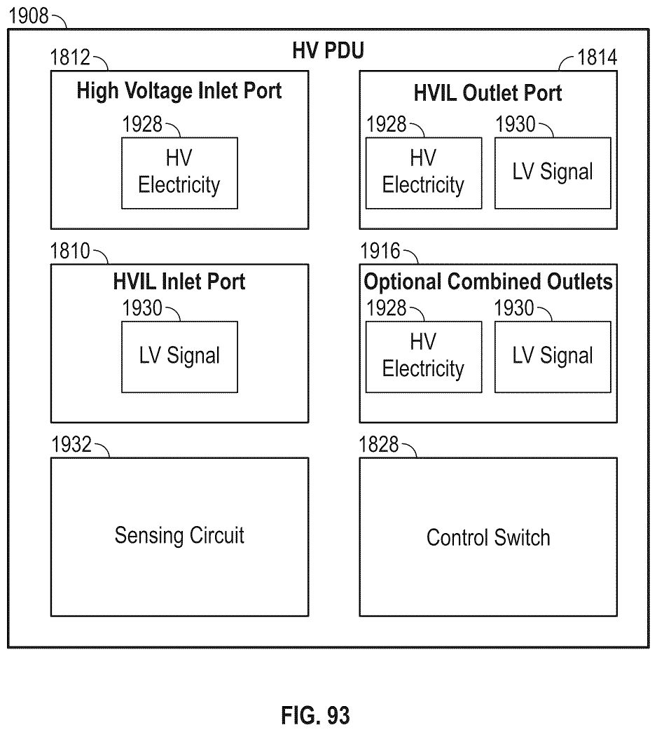

Referring to FIG. 93, depicted is a block diagram of the HVPDU 1908, according to an exemplary embodiment. The HVPDU 1908 is shown to include the high voltage inlet port 1812 (e.g., HV inlet port). The HV inlet port 1812 is configured to receive HV direct current (DC) electricity 1928 directly from the battery (e.g., battery 1902). The HV inlet port may include a sensor (e.g., voltage sensor) or other processor configured to determine that the battery is transmitting HV electricity 1928 at the proper voltage. For example, if the battery is transmitting HV electricity 1928 above the HVPDU 1908 rated voltage, the HV inlet port 1812 may be configured to transmit an instruction to a battery management system (BMS) to disable HV transmission and avoid damage to the HVPDU 1908.

The HVPDU 1908 includes the HVIL inlet port 1810. The HVIL inlet port 1810 may be configured to receive an LV signal 1930 from a control module (e.g., FFCM 1802). The LV signal 1930 may be a DC signal, AC sinusoidal signal, AC square wave, or other waveform. The HVIL inlet port 1810 may include a sensor or other processor to determine whether the HVPDU 1908 is receiving the LV signal 1930. In the event that the HVIL inlet port 1810 is not receiving an LV signal, the HVPDU 1908 may transmit an instruction to the battery to disable HV electricity 1928 transmission.

The HVPDU 1908 is shown to include the HVIL outlet port 1814. The HVIL outlet port 1814 may be configured to be coupled with a connector (e.g., connector 1824). The connector may be configured to include a first set of wires, one for LV signal 1930 transmission and one for LV signal 1930 receipt, and a second wire for HV electricity 1928 transmission and/or receipt. The connector may be configured such that the connection between the first set of wires and the HVIL outlet port 1814 and the connection between the second wire and the HVIL outlet port 1814 are substantially the same. As such, the HVIL outlet port 1814 may be electrically coupled to the main components (e.g., main components 1816) for LV 1930 and HV 1928 electricity transmission.

The HVPDU 1908 is shown to include the plurality of optional combined outlets 1916. The optional combined outlets 1916 may be configured to be coupled with a connector (e.g., connector 1824). The optional combined outlets 1916 each include an HV coupling and two LV couplings for the HVIL system. The two LV couplings for the HVIL system allow the LV signal to pass out of the optional combined outlet 1916 and then back into the optional combined outlet 1916. The connector may be configured to include a first set of wires, one for LV signal 1930 transmission and one for LV signal 1930 receipt and a second wire for HV electricity 1928 transmission. The connector may be configured such that the connection between the first set of wires and the optional combined outlet 1916, and the connection between the second wire and the optional combined outlet 1916 are substantially the same. As such, the optional combined outlets 1916 may be electrically coupled to the optional components (e.g., optional components 1822) for LV 1930 and HV electricity 1928 transmission.

The HVPDU 1908 is shown to include a sensing circuit 1932 (e.g., HVIL circuit). The sensing circuit 1932 is configured to connect the HV inlet port 1812, the HVIL inlet port 1810, the HVIL outlet port 1814, and the optional combined outlets 1916 in series. In some embodiments, the sensing circuit 1932 is configured to rearrange the circuit components such that the order of the circuit components is adjustable. By rearranging the circuit components, the sensing circuit 1932 can allow for improved active monitoring, as the sensing circuit 1932 can control where the connection sensors are in the circuit.

In some embodiments, the sensing circuit 1932 includes sensors or other measuring tools to determine a potential break in the circuit. For example, the sensing circuit 1932 may place a multimeter in between outlets of the HVPDU 1908 to determine where the break in the circuit is located. In some embodiments, if the break in the circuit is caused by an optional component 1822, the sensing circuit 1932 can be configured to rearrange circuit components so that the optional component 1822 is omitted from the circuit. In alternate embodiments, if the break in the circuit is caused by an optional component 1822, the entire circuit may be disabled to cease HV electricity 1928 transmission.

The HVPDU 1908 is shown to include the control switch 1828 configured to physically disable the HVPDU 1808 from forming a complete circuit. The control switch 1828 may be a manual switch (e.g., requires physical operation), or an automatic switch (e.g., controlled by the FFCM 1802). In some embodiments, the control switch 1828 is operated responsive to a determination that there is an error in the circuit, or that there is an error associated with a circuit component.

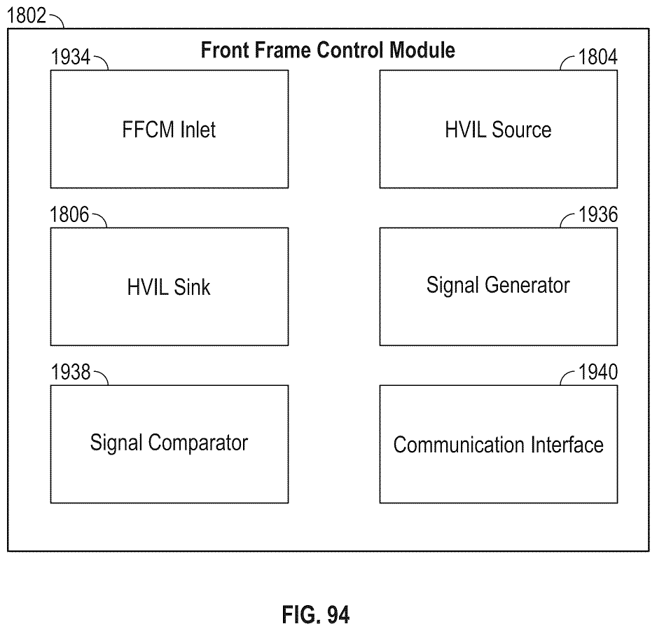

Referring to FIG. 94, the FFCM 1802 includes an FFCM inlet 1934 configured to receive or otherwise accept LV electricity from the battery. The FFCM 1802 includes a signal generator 1936 configured to generate an LV signal to be transmitted through the HVIL circuit. The FFCM 1802 includes the HVIL source 1804 configured to transmit or otherwise send the LV signal to the circuit (e.g., HVPDU 1908). The FFCM 1802 includes the HVIL sink 1806 configured to receive or otherwise accept the LV signal from the circuit (e.g., the main component 1816). The FFCM 1802 includes a signal comparator 1938 configured to compare the accepted signal (e.g., from the HVIL sink 1806) to a predetermined threshold. The FFCM 1802 includes a communication interface 1940 configured to communicate with the circuit components (e.g., HVPDU 1908, battery 1902, sensors, etc.).

The FFCM inlet 1934 may be configured to receive low voltage electricity from the battery. The FFCM inlet 1934 may include circuitry or other sensing components configured to determine the voltage of the received electricity. Depending on the received voltage, the FFCM 1802 may determine that the received voltage is above or below a threshold voltage, and send an instruction to the battery (e.g., battery management system) to disable low voltage transmission. In some embodiments, the FFCM 1802 includes a converter or other component configured to ramp the voltage up/down to a desired voltage.

The signal generator 1936 is configured to transform the received LV electricity from the FFCM inlet 1934 and convert the LV electricity into an LV signal to be distributed through the HVIL circuit. In some embodiments, the signal generator 1936 is configured to convert the electricity into an AC sinusoidal signal, AC square wave, DC signal, or other waveform. The signal generator 1936 includes sensors or other measuring components to determine that the generated LV signal is at the desired amplitude and frequency.

The HVIL source 1804 is configured to transmit or otherwise send the LV signal to the rest of the HVIL circuit (e.g., the HVPDU 1908). The HVIL source 1804 may determine the amplitude and frequency of the LV signal and store the values in memory for comparison. The HVIL sink 1806 is configured to receive or otherwise accept the returned LV signal from the HVIL circuit (e.g., the main component 1816). The HVIL sink 1806 may determine the amplitude and frequency of the returned LV signal and store the values in memory for comparison.

The signal comparator 1938 is configured to retrieve the stored amplitude and frequency values of the HVIL source 1804 and the HVIL sink 1806 from memory. In some embodiments, the signal comparator 1938 compares the amplitude and/or frequency values to determine that the amplitude and/or frequency values are substantially the same at the HVIL source 1804 and the HVIL sink 1806. In alternate embodiments, the signal comparator 1938 is configured to compare the amplitude and/or frequency values of the HVIL sink 1806 to a predetermined threshold to determine whether the returned LV signal is at a desired amplitude and/or frequency.

The communication interface 1940 is configured to communicate with various components, responsive to a determination that the FFCM 1802 is not performing properly. For example, the communication interface 1940 may communicate directly or indirectly with the battery to cease or otherwise terminate HV transmission to system components. In some embodiments, the communication interface 1940 is configured to communicate with the battery responsive to a determination that the LV signal at the HVIL source 1804 is not substantially the same as the LV signal at the HVIL sink 1806. In some embodiments, the communication interface 1940 is configured to communicate with the battery responsive to a determination that the received LV electricity (from the battery) is not at a desired voltage. In some embodiments, the communication interface 1940 is configured to communicate with the PDU (e.g., HVPDU 1908).

In some embodiments, the communication interface 1940 is communicatively coupled to a user interface (e.g., user interface 34). The communication interface 1940 may transmit an instruction to the user interface to display information relating to the HVIL circuit. For example, the communication interface 1940 may cause the user interface to display an approximate location of an error in the HVIL circuit. As another example, the communication interface 1940 may display graphs or other visuals portraying the LV signal at the HVIL source 1804 and the HVIL sink 1806. As such, the user can visually compare the signals and determine if any errors have occurred.

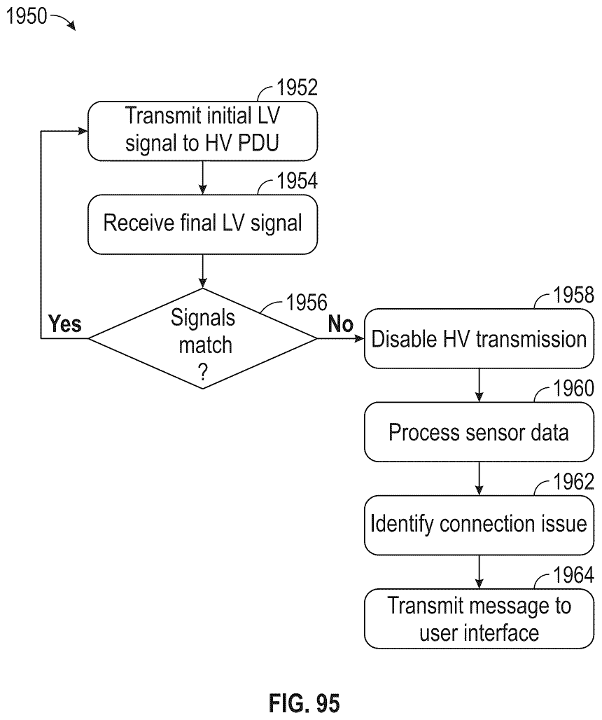

Referring to FIG. 95, depicted is a process 1950 for active monitoring of the HVIL circuit. At step 1952, the LV signal is transmitted from the FFCM (e.g., FFCM 1802) to the HVPDU. The LV signal may be an unconverted (e.g., unprocessed, unaltered, etc.) DC signal, a pulsed DC signal (low and high), an AC sinusoidal signal, an AC square wave, or other waveform generated by the FFCM. The HVPDU may then transmit the LV signal to the various components of the HVIL circuit (e.g., main components 1816, optional components 1822). Beneficially, a converted LV signal of more than one voltage allows for detecting if the HVIL circuit is shorted to power or to ground. If the signal is unconverted and, for example, always high, and the FFCM is therefore only monitoring for if a voltage is received at the HVIL sink, then if the circuit is shorted to power the FFCM may still receive the signal it expects from the LV signal and falsely determine that the HVIL circuit is safe and without fault. By varying the LV signal, if shorted to power, when the FFCM would expect to receive the lower voltage pulse of the LV signal, it would instead continue to receive the high voltage, allowing the FFCM to determine that the circuit is faulted to power (e.g., the battery).

At step 1954, the FFCM receives the final (e.g., returned, circulated, etc.) LV signal from the HVIL circuit (e.g., the main component 1816). The final LV signal refers to the signal returned to the FFCM after being distributed to the HVIL circuit by the HVPDU. At step 1956, the FFCM analyzes or otherwise processes the final LV signal to determine whether the HVIL circuit is functioning properly. In some embodiments, the FFCM compares the amplitude and/or frequency of the final LV signal to a predetermined threshold. In alternate embodiments, the FFCM compares the amplitude and/or frequency of the final LV signal to the amplitude and/or frequency of the initial LV signal. In alternate embodiments, the FFCM compares the shape of the initial and final LV waveforms to determine whether they match (or substantially match within a threshold).

If the final LV signal matches the initial LV signal, the steps 1952 and 1954 are repeated to achieve active monitoring until the signals no longer match. In the event that the signals do not match, at step 1958 the FFCM instructs the battery to disable HV transmission to the HVPDU, or the FFCM instructs the HVPDU to stop accepting HV electricity from the battery. The FFCM blocks HV transmission to mitigate damage to HVIL circuit components while the source of the error is handled. At step 1958, the FFCM may determine, based on the LV signal, if the circuit fault is an open circuit or if the circuit is shorted to ground.

At step 1960, the FFCM processes sensor data of the HVIL system. The HVIL system includes sensors or other measuring equipment in the main components, optional components, connectors, or HVPDU configured to test connections between components to determine an approximate location of the break/error in the HVIL circuit. At step 1962, the FFCM uses the processed sensor data to identify the connection issue. For example, the FFCM may determine that there is a break in the circuit at an optional component due to a sensor showing a resistance value above a threshold at the optional component. As another example, the FFCM may determine that a connector of an optional component has wired to the battery, as the voltage at the optional component is above a threshold.

At step 1964, the FFCM may transmit an instruction to a user interface (e.g., user interface 34) to display a message notifying the user of the error. The message may include a location of the error, and other information relating to the error. The user interface may be configured to require the user to acknowledge or otherwise handle the error in order for the HV transmission to be resumed.

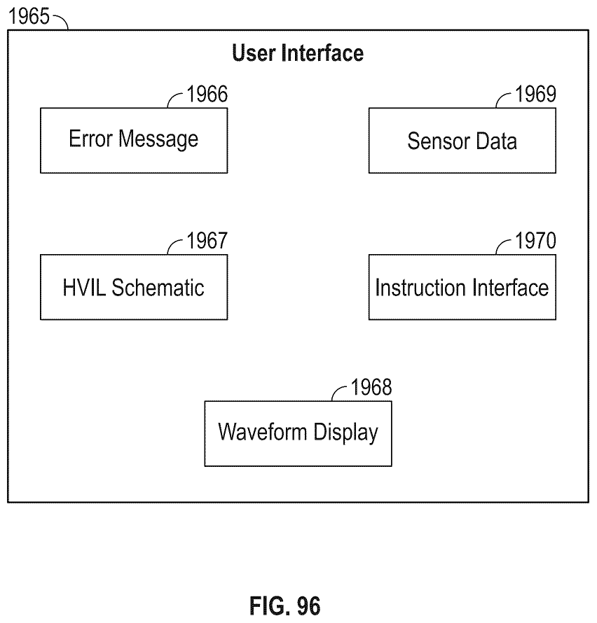

Referring to FIG. 96, depicted is a block diagram of a display of a user interface 1965, according to an exemplary embodiment. The user interface 1965 may be configured to display an error message 1966 including information regarding an error in the HVIL circuit. For example, the error message 1966 may describe that there was a break in the circuit and/or that HV transmission has been disabled until the error is resolved. The error message may provide 1966 instructions for resolving the error.

The user interface 1965 may include a schematic of the HVIL system, shown as HVIL schematic 1967. The HVIL schematic may be configured to display a schematic of the components of the HVIL and point out a location associated with the error. For example, if the error is determined to be at a connector between the HVPDU and an optional component, the schematic may highlight the connector. The user interface 1965 may include a waveform display 1968 configured to display a first waveform corresponding to the LV signal at the time of generation, and a second waveform corresponding to the LV signal at the time of return to the FFCM. The waveform display 1968 may display data corresponding to the waveforms, such as the amplitude and/or frequency. The waveform display 1968 may provide an overlay of the first and second waveforms, so that the user can visually compare the waveforms.

The user interface 1965 may include a report of current and/or historical sensor data 1969 for the HVIL system. The sensor data 1969 may allow the user to view and analyze data related to errors associated with the HVIL system. This may allow the user to track causes of errors in the system for reference during troubleshooting. The user interface 1965 may include an instruction interface 1970. The instruction interface 1970 may include a plurality of selectable elements that allow the user to transmit instructions to the HVIL system. For example, the user can transmit an instruction via the instruction interface 1970 to control the FFCM, the HVPDU, and/or the battery.

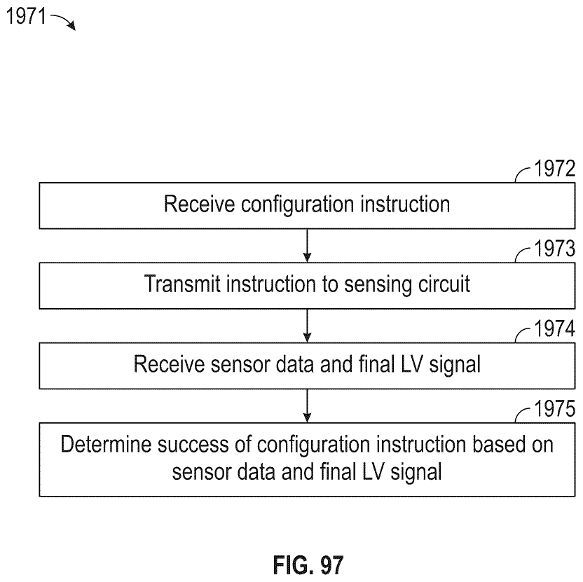

Referring to FIG. 97, depicted is a method 1971 for reconfiguring the sensing circuit (e.g., sensing circuit 1932). In some embodiments, the sensing circuit includes circuitry or other components that allow the configuration of the series circuit to change (e.g., omit optional components without removing connectors, rewire circuit to change arrangement of components). At step 1972, the user interface (e.g., user interface 34, user interface 1965) receives a configuration instruction from the user. The configuration instruction may include an arrangement of circuit components and/or one or more optional components to be omitted from the sensing circuit.

At step 1973, the user interface transmits the configuration instruction to the sensing circuit. The sensing circuit may include a processor configured to receive the instruction. After receiving the instruction, the sensing circuit may operate any of a switch, an actuator, a controller, or other component configured to execute the configuration instruction. At step 1974, after reconfiguring the sensing circuit, the HVIL system is powered on and the LV signal is passed from the FFCM through the sensing circuit (e.g., HVIL circuit). The FFCM then receives sensor data and a final (e.g., returned, circulated, etc.) LV signal from the HVIL circuit.

At step 1975, the FFCM processes the sensor data and the final LV signal to determine the performance of the sensing circuit. If the final LV signal and the sensor data are within predetermined thresholds, the FFCM can determine that the configuration instruction was executed properly. If the FFCM processes the final LV signal and sensor data and determines that an error occurred, the FFCM can initiate an error procedure (e.g., steps 1958-2335 of FIG. 95).

### High Voltage Interlock Loop Detection System

As discussed above with respect to FIGS. 91, 92, and 93, the LV signal can provide information to the FFCM 1802 regarding the connectivity of the HVIL circuit. In some embodiments, the LV signal is a DC signal at a specific magnitude. If there is a break in the circuit, the FFCM 1802 will not get a returned LV signal, so the FFCM 1802 can determine that there is an error (e.g., break) in the circuit. However, if there is an error in the circuit that is not caused by a break (e.g., connector 1824 shorts to battery, connector 1824 is damaged, connector 1824 wire is touching an external component, etc.), the returned LV signal to the FFCM may still show a signal similar to the initial LV signal generated by the FFCM 1802.

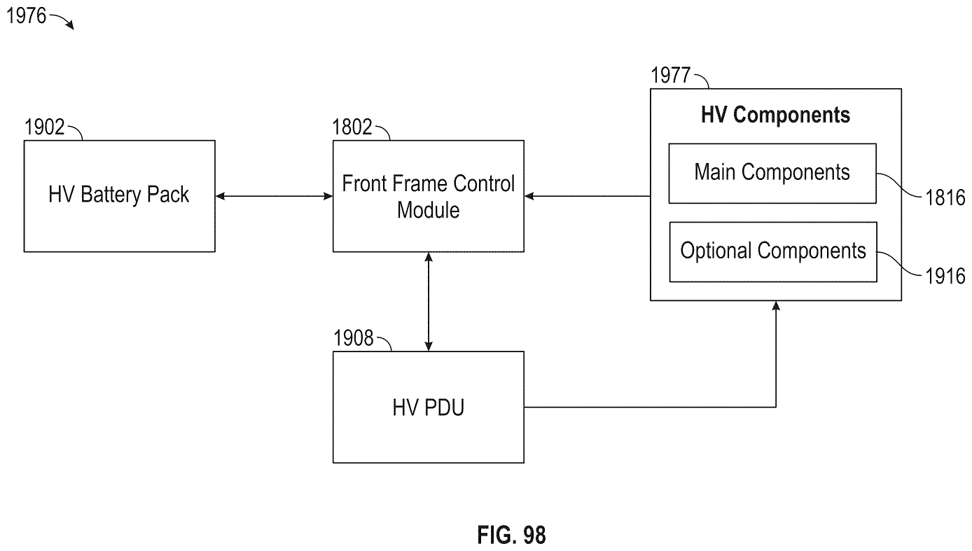

Referring generally to FIGS. 98-101, to improve robustness and active monitoring capabilities of the HVIL circuit, the FFCM 1802 may convert the LV electricity it receives from the battery and into an LV DC waveform. The FFCM 1802 can include switches or other components capable of generating a DC waveform at a predetermined amplitude, frequency, and/or duty cycle. Some embodiments described herein relate to the FFCM 1802 generating an LV DC rectangular pulse wave (e.g., DC rectangular wave, rectangular wave, pulse wave). However, other embodiments can include other LV DC waveforms, such as a sawtooth or triangular waveform.

Referring to FIG. 98, depicted is an HVIL detection system 1976 for a work machine. The FFCM 1802 is configured to receive LV electricity from the HV battery pack 1902. The HV battery pack 1902 may be configured to convert HV electricity to LV electricity (e.g., via a DC/DC converter). Upon receiving the LV electricity from the battery pack, the FFCM is configured to convert the LV electricity into an LV DC rectangular pulse wave (e.g., rectangular wave). The rectangular wave may be generated by a switch (e.g., transistor, logic gate, etc.) configured to allow the DC electricity to block/pass-through at a constant rate.

The generated rectangular wave may be at any reasonable amplitude, frequency, and/or magnitude for monitoring purposes. In some embodiments, the FFCM 1802 generates the rectangular wave at a predetermined DC offset. By implementing a DC offset into the rectangular wave, it may be easier for the FFCM 1802 to determine whether the circuit is broken, or if the wave is in a negative half cycle. The rectangular wave may be configured to have a variable duty cycle (e.g., the ratio of positive to negative half cycles).

After generating the rectangular wave, the FFCM 1802 transmits the rectangular wave to the HVPDU 1908. The HVPDU 1908, upon receiving the rectangular wave, transmits the rectangular wave (along with HV electricity) to the HV components 1977 of the system 1976. The HV components 1977 are shown to include the main components 1816 and the optional components 1916. The HV components 1977 are connected in series with the FFCM 1802 and the HVPDU 1908, so that the FFCM 1802 can monitor the rectangular wave, and thereby indirectly monitor the HV electricity (e.g., due to connections between the HV components 1977 being the same for the rectangular wave and the HV electricity).

After the rectangular wave passes from the HVPDU 1908 and through the HV components 1977, the HV components 1977 are configured to transmit the rectangular wave back to the FFCM 1802. Upon receiving the rectangular wave from the HV components 1977, the FFCM 1802 is configured to process the rectangular wave to determine whether the rectangular wave was altered (e.g., changed, interrupted, offset, weakened, strengthened) while being transmitted through the circuit.

In some embodiments, the FFCM 1802 compares the magnitude (e.g., maximum value) of the generated rectangular wave to the magnitude of the returned rectangular wave. In some embodiments, the FFCM 1802 compares the amplitude (e.g., difference between the maximum and minimum values) of the generated rectangular wave to the amplitude of the returned rectangular wave. In some embodiments, the FFCM 1802 compares the frequency of the generated rectangular wave to the frequency of the returned rectangular wave. In some embodiments, the FFCM 1802 compares the duty cycle of the generated rectangular wave to the duty cycle of the returned rectangular wave. In some embodiments, the FFCM 1802 compares the DC offset (e.g., a difference between the minimum value and zero) of the generated rectangular wave to the DC offset of the returned rectangular wave. The FFCM 1802 may be configured to compare other characteristics of the generated rectangular wave to the returned rectangular wave.

In some embodiments, upon determining that there is a substantial difference (e.g., a difference greater than a threshold difference) between the generated rectangular wave and the returned rectangular wave, the FFCM 1802 is configured to initiate a troubleshooting process to determine a potential cause of the difference between the generated rectangular wave and the returned rectangular wave. The difference between the generated rectangular wave and the returned rectangular wave may provide an indication of the potential cause of the error. For example, if the returned rectangular wave is at a constant high voltage (relative to the LV magnitude), the FFCM 1802 may determine that there is an undesired interaction between the circuit and an external component. As another example, if the returned rectangular wave is at a constant zero voltage, the FFCM 1802 may determine that there is a break in the circuit. The FFCM 1802 may process sensor data from a plurality of sensors located throughout the circuit to determine a location of a break or other error in the circuit.

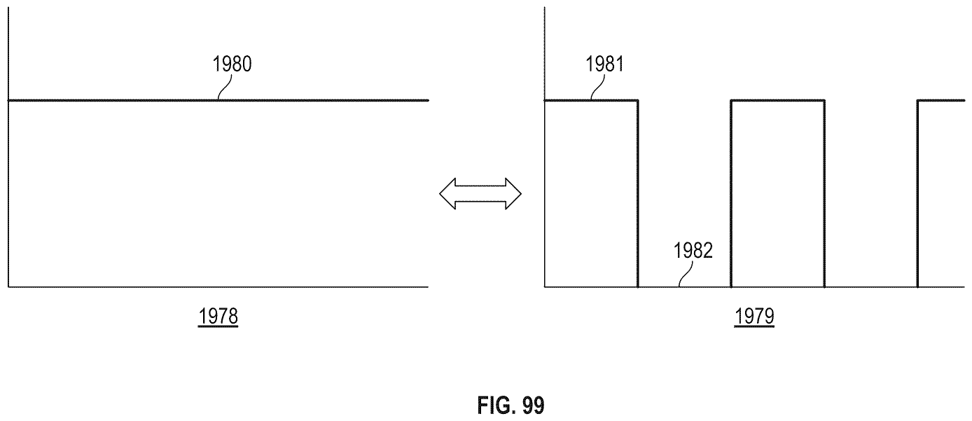

Referring to FIG. 99, depicted are graphs 1978, 1979 respectively showing the LV DC electricity provided by the battery and the rectangular waveform generated by the FFCM, according to an exemplary embodiment. Graph 1978 shows the LV DC electricity 1980 transmitted from the battery (e.g., HV battery 1902) to the FFCM (e.g., FFCM 1802). The LV DC electricity 1980 may be transmitted at a predetermined low-voltage magnitude.

Upon receiving the LV DC electricity 1980 from the battery, the FFCM may be configured to convert the LV DC electricity 1980 into the rectangular waveform, shown in graph 1979. In some embodiments, the FFCM is configured to accept/block the LV DC electricity 1980 at a constant frequency, creating a positive half-cycle 1981 and a negative half-cycle 1982. The positive half-cycle 1981 may be at the same magnitude as the LV DC electricity 1980. The negative half-cycle may be at zero (e.g., fully blocked LV electricity 1980).

In some embodiments, the positive and negative half-cycles can be shifted with a predetermined DC offset. The DC offset may be configured to shift the positive and negative half-cycles without altering the amplitude of the rectangular wave. The DC offset may allow the FFCM to better distinguish between the negative half-cycle 1982 and a break in the circuit. In some embodiments, the positive half-cycle 1981 and the negative half-cycle 1982 can be operational for a different amount of time within a single cycle. For example, the positive half-cycle may be operational for 75% of the cycle, and the negative half-cycle may be operational for 25% of the cycle. This ratio (e.g., duty cycle) may be adjusted by the FFCM to determine whether switching between the positive half-cycle 1981 and the negative half-cycle 1982 is due to the FFCM switching or due to faulty equipment (e.g., connectors and/or other components).

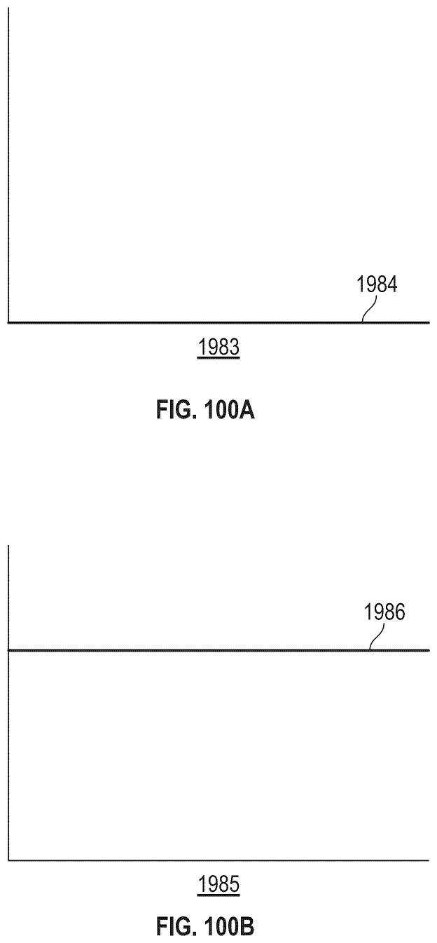

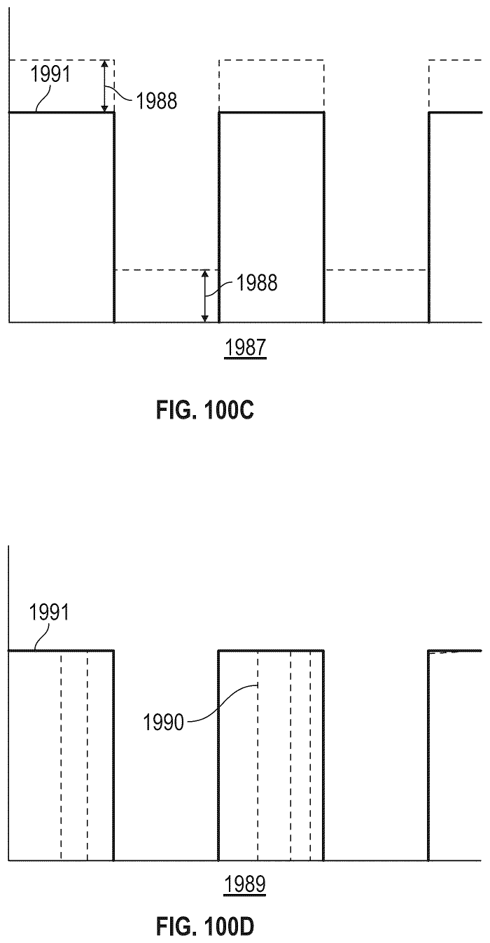

Referring to FIGS. 99 and 100A-100D, the FFCM (e.g., FFCM 1802) may receive a signal from the HV components that differs from the generated rectangular wave shown in graph 1979. This difference may indicate that there is an error occurring somewhere in the low voltage circuit, thereby indicating that there is an error occurring somewhere in the high voltage circuit. The FFCM may process the returned signal to determine a potential cause of the error. The FFCM may process the returned signal itself, or the returned signal along with sensor data received from a plurality of sensors located throughout the circuit. The sensor data may indicate a location of the error within the circuit, and the sensor data may be processed based on the determined cause of the error.

Referring to FIG. 100A, depicted is a graph 1983 showing no returned signal 1984. If the FFCM identifies that there is no returned signal 1984, the FFCM may determine that there is a break in the circuit that is stopping the signal from returning to the FFCM. Once the FFCM determines that there is a break in the circuit, the FFCM may process sensor data from the plurality of sensors to determine a location of the break in the circuit. For example, each connector (e.g., connector 1824) between HV components (e.g., HV components 1977) and/or the HVPDU (e.g., HVPDU 1908) may include a sensor (e.g., voltage sensor, current sensor, resistance sensor, etc.) configured to detect whether the connector is receiving the signal. The FFCM can process the sensor data to determine one or more connectors that are not receiving the signal, thereby determining a potential location of the break in the circuit.

Referring to FIG. 100B, depicted is a graph 1985 showing a constant high signal 1986. The constant high signal 1986 may be a signal at a constant magnitude. The constant high signal 1986 may be at the same magnitude as the generated rectangular wave or may be at a different magnitude. If the FFCM identifies that there is a constant high (e.g., nonzero, high voltage, fixed magnitude) signal 1986, the FFCM may determine that there is an undesired interaction between circuit components and external components. For example, a constant high signal 1986 may indicate that there is a short between a connector of the circuit and the battery pack (e.g., battery pack 1902). If the FFCM determines that there is an undesired interaction between circuit components and external components, the FFCM may retrieve sensor data from the plurality of sensors to determine a location of the interaction. For example, each connector may include a sensor that determines the magnitude of the signal. If the magnitude of the constant high signal 1986 in the connector is higher than the magnitude of the generated rectangular wave, then the FFCM may determine that the interaction occurred in the connector.

Referring to FIG. 100C, depicted is a graph 1987 showing an overlay of the generated rectangular wave 1991 and the returned rectangular wave with a DC offset 1988. If the FFCM identifies that the returned rectangular wave has a DC offset 1988 relative to the generated rectangular wave 1991, the FFCM may determine that there is an unwanted interaction between the circuit and an external component. For example, if the returned rectangular wave has a DC offset 1988, the FFCM may determine that a component besides the FFCM is providing signal to the circuit. The FFCM may process sensor data to determine a location of the DC offset 1988. For example, the FFCM may process sensor data to determine the voltage during the positive half-cycle at various parts of the circuit, thereby determining a location where the DC offset occurred.

In some embodiments, differences between the generated rectangular wave 1991 and a returned rectangular wave are caused by faults within connections between components of the circuit and/or within the components themselves. For example, as connectors between components age, the circuit may occasionally break due to connector failures (e.g., connection errors). If the circuit breaks and then reconnects at a non-constant interval, the returned rectangular wave may show a variable (e.g., inconsistent, non-constant) frequency.

Referring to FIG. 100D, depicted is a graph 1989 showing an overlay of the generated rectangular wave 1991 and the returned rectangular wave with a variable frequency 1990. If the FFCM identifies that the returned rectangular wave has a variable (e.g., non-constant) frequency 1990 relative to the generated rectangular wave 1991, the FFCM may determine that there is a failure in a component and/or a connector that is causing intermittent breaks in the circuit. For example, if a connector has a frayed wire that is causing breaks at an inconsistent rate, the FFCM may determine that there is a failure somewhere in the circuit. The FFCM may process sensor data to determine the location of the component/connector failure.

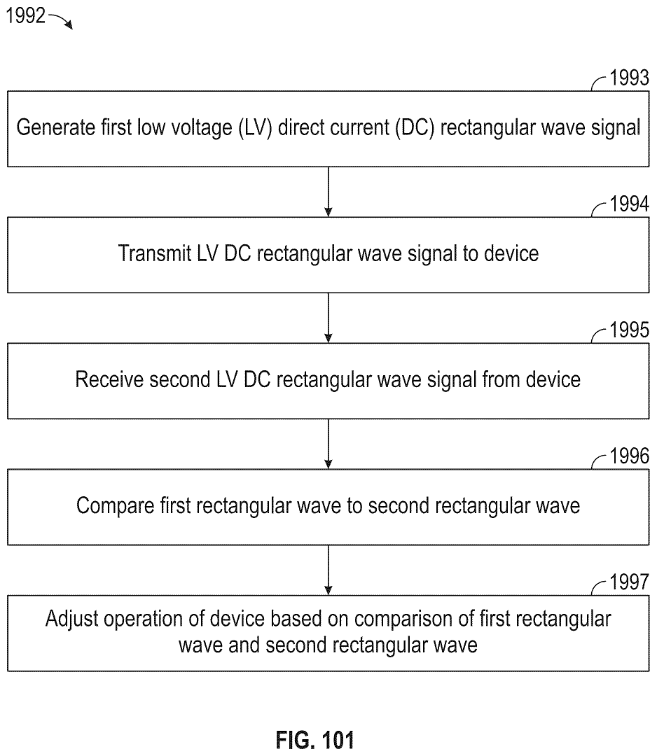

Referring to FIG. 101, depicted is a flow diagram of a method 1992 for active monitoring of an HV circuit using an LV circuit. At step 1993, a first LV DC rectangular wave signal is generated (e.g., by the FFCM 1802). The rectangular wave may be generated to a predetermined amplitude, frequency, and/or DC offset. At step 1994, the rectangular wave is transmitted to a device (e.g., HV components 1977). In some embodiments, the rectangular wave is transmitted to the device via a PDU (e.g., HVPDU 1908). The device may be one of a plurality of HV devices connected in a series circuit, and the rectangular wave may be configured to be transmitted through the series circuit.

At step 1995, the FFCM receives a second LV DC rectangular wave from the device (or the series circuit including the plurality of devices). If the circuit including the FFCM and the device is operating properly, the second rectangular wave will substantially match the first rectangular wave. If the circuit is not operating properly, the second rectangular wave may not match the first rectangular wave. At step 1996, the FFCM compares the first rectangular wave to the second rectangular wave. The FFCM may compare any of the amplitude, magnitude (e.g., maximum value), DC offset, frequency, duty cycle, and/or other features of the first rectangular wave and the second rectangular wave to determine whether the circuit is operating properly.

At step 1997, the FFCM may adjust operation of the device (and/or other devices) based on the comparison of the first rectangular wave and the second rectangular wave. If the FFCM determines that the second rectangular wave is different from the first rectangular wave, the FFCM may process sensor data to determine a location of the error (e.g., break, short, damage) to the circuit. Once a location of the error is determined, the FFCM may adjust operation of the device to address the error. For example, the FFCM may disable HV transmission to the device so that the error can be resolved.

### Oversized Passively-Cooled Battery

In some embodiments, a battery (e.g., the high-voltage battery 132, the low-voltage battery 136, etc.) can be considered oversized when an energy capacity of the battery is larger than expected or predicted energy consumption. For example, the telehandler 10 can include an expected energy consumption of 5 kilowatt-hours. In this example, the telehandler 10 can have an expected duration of use (minutes, hours, etc.) of 4 hours. The overall predicted or expected energy consumption, in this example, would be 20 kilowatt-hours. The value or amount of the energy capacity (e.g., nameplate capacity, usable capacity, etc.) for the battery can be selected such that the energy capacity is larger than the overall predicted energy consumption. For example, an energy capacity of 25 kilowatt-hours can be selected. In this example, the battery can be oversized as the energy capacity (e.g., 25 kilowatt-hours) is larger than the overall predicted energy consumption (e.g., 20 kilowatt-hours). Additionally, or alternatively, the total energy capacity or energy storage amount can be selected to be larger than or otherwise exceed an expected discharge amount of energy.

As an example, the telehandler 10 may be operated or utilized over an 8-hour workday. In this example, the telehandler 10 may actually only be operated for total of 2 hours (e.g., a 25% utilization rate). Operation of the telehandler 10 may include actions such as, load and carry, drive, or load stacking (e.g., actions associated with a normal operation). In this example, the telehandler 10 can be sized or fitted with a battery having an energy capacity associated with a daily operation time of 4 hours. To continue this example, the battery (e.g., the energy capacity) would be oversized as the energy capacity would be double the expected usage.

In some embodiments, as the battery of the telehandler 10 is discharging energy, the ambient or internal temperature of the battery can rise (e.g., a temperature rise). Stated otherwise, a discharge of energy (by the battery) can result in a temperature rise of one or more battery cells of the battery. To maximize performance of the battery, the maximum ambient temperature of the battery should be capped at 55 degrees Celsius. If the ambient temperature of the battery were to exceed 55 degrees Celsius, the C-rate of the battery may be derated which can cause the overall performance of the battery to decrease. By oversizing the battery of the telehandler 10, the maximum ambient temperature is likely to not exceed 55 degrees Celsius. Additionally, by oversizing the battery, the battery can be passively cooled as the ambient temperature of the battery can return to a default value during an overnight inactive state. Stated otherwise, the oversizing of the battery can limit the maximum temperature that the battery reaches, during operation, such that the battery can return to a default value passively (e.g., without coolant systems, without fans, etc.). In some embodiments, passive cooling or passively cooling of a battery, batteries, or battery cells may refer to or include the exclusion or omission of an active means or process to cool the batteries.

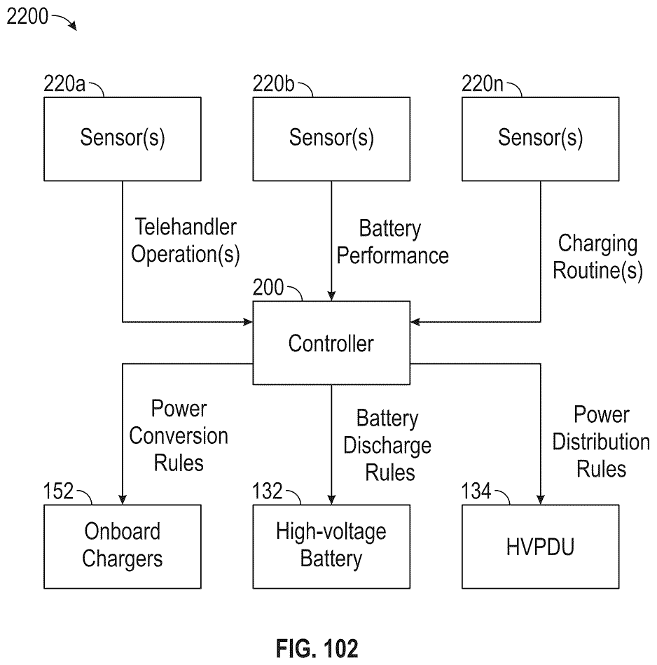

FIG. 102 is a block diagram of a system 2200, according to some embodiments. The system 2200 may refer to or include at least one of a system architecture, a control scheme, or a schematic diagram. In some embodiments, the systems, devices, components, elements, or assemblies of the system 2200 may be communicably coupled with one another via one or more networks. For example, a first component and a second component of the system 2200 may be communicably coupled with one another via a controller area network (CAN). In some embodiments, the system 2200 may include one or more systems, devices, components, elements, or assemblies described herein. For example, as shown in FIG. 102, the system 2200 includes the controller 200, the sensors 220, the onboard chargers 152, the high-voltage battery 132, and the HVPDU 134.

In some embodiments, the controller 200 may receive one or more sets of information from the sensors 220. For example, a sensor 220a may be disposed on the boom base 60. The sensor 220a may include a gyroscope to monitor changes to in position, location, arrangement, or placement of the boom base 60. The sensor 220a may provide information (shown as Telehandler Operation(s) in FIG. 102) that corresponds to operation of the telehandler 10. For example, the sensor 220a may provide information associated with operation of the drive motor 90 (e.g., runtime, power consumption, rotation speed, etc.). As another example, the sensor 220a may provide information associated with the implement pump 114.

In some embodiments, the controller 200 may receive information (shown as Battery Performance in FIG. 102) from a sensor 220b that corresponds to one or more batteries of the telehandler 10. For example, the sensor 220b may include a temperature sensor disposed within the battery assembly 60. The sensor 220b can monitor or collect data regarding an ambient temperature within the battery assembly 60. As another example, the sensor 220b may monitor or collect information associated with charging or discharging of the high-voltage battery 132 (e.g., monitor changes to a state of charge). As another example, the sensor 220b may monitor a voltage level and/or current level of a voltage bus between the high-voltage battery 132 and the HVPDU 134. Stated otherwise, the sensor 220b may monitor how many watts the high-voltage battery 132 is providing.

In embodiments, the controller 200 may receive information (shown as Charging Routine(s) in FIG. 102) from a sensor 220n that corresponds to charging of the telehandler 10. For example, the sensor 220n may be disposed proximate to the door 46 to detect a number of times for which the door 46 is opened or closed. The sensor 220n may record timestamps associated with a given instance of opening or closing the door 46. As another example, the sensor 220n may include a voltage or current sensor that can measure voltage levels of the charging connector 154. Stated otherwise, the sensor 220n may collect information to determine when power is being provided to the charging connector 154 (e.g., to charge one or more batteries).

In some embodiments, the controller 200 may determine one or more setpoints for the telehandler 10 based on the information provided by the sensors 220. For example, the controller 200 may determine a power setpoint for the telehandler 10. In some embodiments, the power setpoint may refer to or include a maximum amount of power for which the battery can discharge. For example, the controller 200 may determine a setpoint which dictates how much power the high-voltage battery 132 may discharge. The power setpoint of the battery may cause the battery to be oversized. For example, the battery may have a nameplate capacity or usable capacity. In this example, the power setpoint may be an energy amount that is less than the capacity of the battery. Stated otherwise, the capacity of the battery is larger (e.g., oversized) than the power setpoint.

In some embodiments, the controller 200 may determine a runtime setpoint for the telehandler 10. For example, the controller 200 may determine how many hours for which the telehandler 10 may be in operation. Stated otherwise, the controller 200 may set a maximum duration for which the telehandler 10 may be in operation for a given amount of time. As another example, the controller 200 may determine a runtime setpoint based on an expected usage of the telehandler 10.

In some embodiments, the controller 200 may implement or otherwise dictate the setpoints based on one or more rules. For example, the controller 200 may define rules that dictate operation of one or more components of the telehandler 10. As shown in FIG. 102, the controller 200 defines rules for the onboard chargers 152 (shown as Power Conversion Rules), the high-voltage batter 132 (shown as battery discharge rules), and the HVPDU 134 (shown as Power Distribution Rules). In some embodiments, the Power Conversion Rules may dictate or define a maximum voltage amount for which the onboard chargers 152 may convert. For example, the Power Conversion Rules may set how much voltage the onboard chargers 152 may provide to a battery of the telehandler 10. In some embodiments, the Battery Discharge Rules may dictate or define a discharge rate for the high-voltage battery 132. For example, the Battery Discharge Rules may set how much voltage the high-voltage battery 132 may provide to the HVPDU 134. As another example, the Battery Discharge Rules may set a duration regarding how long the high-voltage battery 132 may provide a given voltage amount. In some embodiments, the Power Distribution Rules may dictate or define how much power can be requested from batteries of the telehandler 10. For example, the Power Distribution Rules may set a maximum load for the HVPDU 134. As another example, the Power Distribution Rules may set a maximum number of devices, components, or elements that may receive power from the HVPDU 134.

In some embodiments, the controller 200 may determine an expected usage of the telehandler 10. For example, the controller 200 can generate one or more predictions, based on information from the sensors 220, regarding how the telehandler 10 may be used. As another example, the controller 200 may monitor usage of the telehandler 10 over a given period of time (e.g., days, weeks, months, etc.). The controller 200 may determine an expected usage by averaging or otherwise factoring in the previous usage of the telehandler 10.

In some embodiments, the controller 200 may configure or otherwise set one or more batteries of the telehandler 10. For example, the controller 200 may set a discharge rate of the high-voltage battery 132 to cap or configure the wattage (e.g., how many watts) that is discharged by the high-voltage battery 132. In some embodiments, the controller 200 may configured the batteries of the telehandler 10 such that a maximum amount of power, provided by the batteries, is less than the capacity (e.g., nameplate capacity, usable capacity, etc.). Stated otherwise, the controller 200 may configure the batteries such that the batteries are oversized. In some embodiments, the controller 200 may configure the batteries by adjusting, controlling, or otherwise modifying how much current is provided by the batteries. For example, the controller 200 may cap or otherwise limit the amount of current that is output by the batteries.

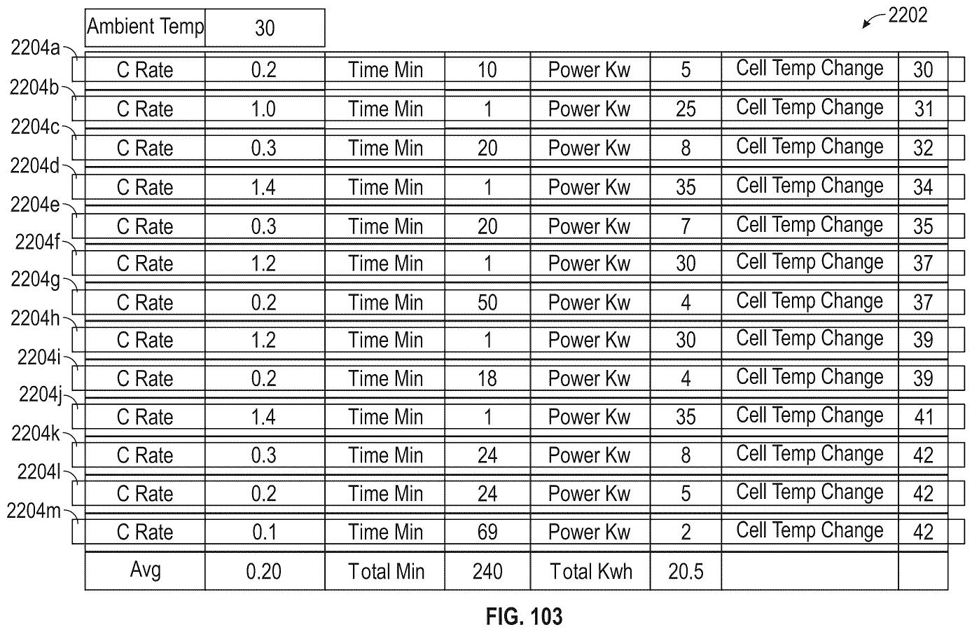

FIG. 103 depicts a table 2202, according to some embodiments. As shown in FIG. 103, the table 2202 includes entries 2204. In some embodiments, the entries 2204 may refer to or represent information associated with operation of the telehandler 10. For example, the entries 2204 may include information produced or collected as a result of operation of the telehandler 10. In some embodiments, the information included in a given entry may be collected by the sensors 220. For example, entry 2204a is shown to include information associated with a C-rate, a duration of operation, a power consumption, and a cell temperature change or value. In this example, the information included in the entry 2204a may be collected by the sensors 220.

In some embodiments, the entries 2204 may correspond to operation of the telehandler 10 during a workday. For example, as shown in FIG. 103, the total operation of the telehandler 10 is indicated as 240 minutes (e.g., 4 hours). In some embodiments, the controller 200 may determine the power consumption (e.g., kilowatt-hours) of the telehandler 10 based on the entries 2204. As shown in FIG. 103, the table 2202 includes a temperature rise of the batteries and/or battery cells that resulted from a corresponding operation of the telehandler 10. Entry 2204b illustrates that the ambient temperature of the battery rose from 30 degrees Celsius to 31 degrees Celsius. Additionally, entry 2204m illustrates that a maximum ambient temperature of the batteries (which was reached as a result of usage of the telehandler 10) is 42 degrees Celsius.

In some embodiments, the telehandler 10 has been implemented with, provided with, or selected as having a 25 kilowatt-hour battery during the operations illustrated in FIG. 103. Stated otherwise, the battery of the telehandler 10 was oversized as the consumed energy, as shown in FIG. 103, is 20.5 kilowatt-hours and yet the capacity is 25 kilowatt-hours. The oversizing of the battery is shown to have prevented the ambient temperature of the battery from reaching 55 degrees Celsius. Moreover, the oversizing of the battery is shown to resulted in a C-rate that is less than 0.5C.

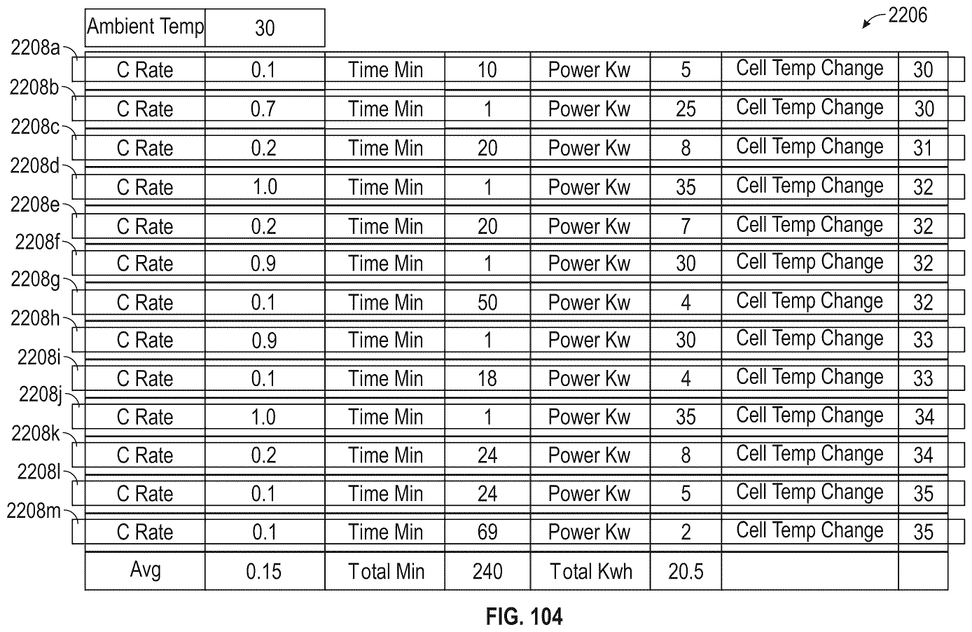

FIG. 104 depicts a table 2206, according to some embodiments. As shown in FIG. 104, the table 2206 includes entries 2208. In some embodiments, the entries 2208 may refer to or represent information associated with operation of the telehandler 10. For example, the entries 2208 may include information produced or collected as a result of operation of the telehandler 10. In some embodiments, the information included in a given entry may be collected by the sensors 220. For example, entry 2208a is shown to include information associated with a C-rate, a duration of operation, a power consumption, and a cell temp change or value. In this example, the information included in the entry 2208a may be collected by the sensors 220.

In some embodiments, the telehandler 10 has been implemented with, provided with, or selected as having a 35 kilowatt-hour battery during the operations illustrated in FIG. 104. In comparing the information between the table 2202 and the table 2206, the utilization of the 35 kilowatt-hour battery is shown to have reduced the overall temperature rise of the battery from 42 degrees Celsius to 35 degrees Celsius even though the operations for each of the table 2202 and the table 2206 are the same. Stated otherwise, by increasing the percentage or amount by which the battery is oversized, the overall rise in ambient temperature of the batteries can be further decreased. Additionally, or alternatively, as the difference between battery capacity and battery usage is increased the overall rise in ambient temperature of the battery will decrease. In some embodiments, the difference between the energy capacity of the battery may be larger than the amount of energy consumed during operation. For example, the difference may be 15% or fifteen percent. As another example, the difference may be 20%. Stated otherwise, by selectively oversizing the energy capacity of the battery, the battery temperature rise (which results from operation or utilization of the telehandler 10) can be reduced, limited, or otherwise minimized.

### Onboard Charger to Precondition High Voltage Battery

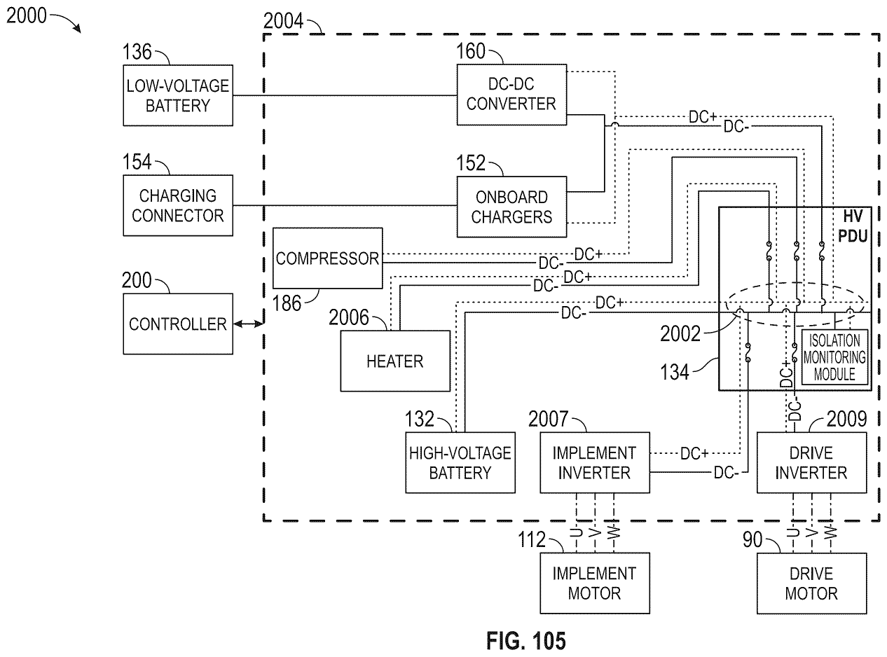

FIG. 105 depicts a block diagram of a system 2000, according to some embodiments. The system 2000 may refer to or include at least one system, device, component, element, or assembly described herein. For example, as shown in FIG. 105, the system 2000 includes the charging connector 154, the DC/DC converter 160, the onboard chargers 152, the HVPDU 134, the compressor 186, a heater or heating element (shown as heater 2006), the high-voltage battery 132, the implement motor 112, the drive motor 90, the controller 200, an implement inverter 2007, and a drive inverter 2009. In some embodiments, the system 2000 or one or more portions thereof may refer to or include a power distribution system. For example, the system 2000 may distribute power to one or more components of the telehandler 10.

In some embodiments, the controller 200 may be communicably coupled with one or more systems, devices, components, elements, or assemblies of the system 2000. For example, dashed line 2004 represents an example of the controller 200 communicably coupled with the elements included within the dashed line 2004. While the system 2000 is shown to include certain systems, devices, components, elements, or assemblies, this is for illustrative purposes only and is in no way limiting. For example, one or more elements may be added to the system 2000. As another example, one or more components may be removed from the system 2000.

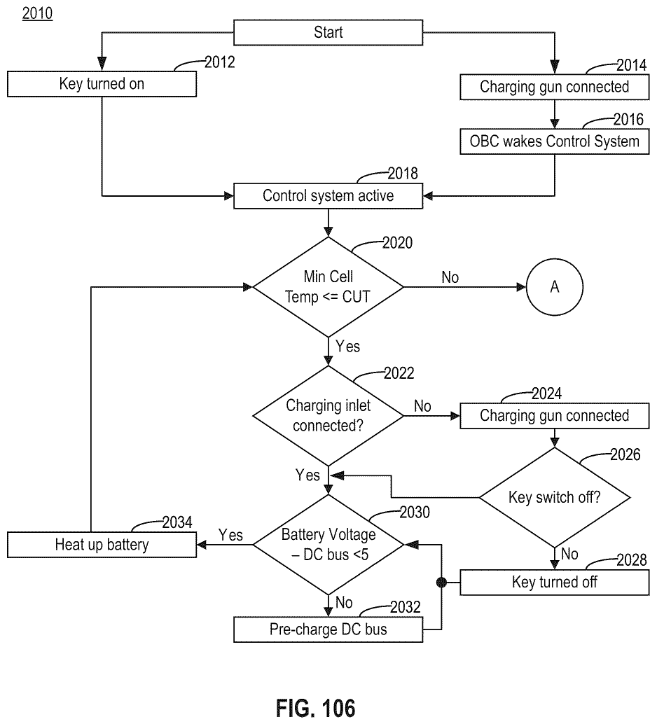

In some embodiments, the HVPDU 134 may electrically couple one or more elements together. For example, the HVPDU 134 may electrically couple the drive motor 90 with the high-voltage battery 132 such that the drive motor 90 may receive power from the high-voltage battery 132. As shown in FIG. 106, the HVPDU includes a bus 2002. In some embodiments, the bus 2002 may refer to or include a DC bus or a DC link. For example, the bus 2002 may provide, carry, transmit, or otherwise provide voltage to one or more components electrically coupled with the bus 2002.

In some embodiments, the controller 200 may receive information associated with one or more systems, devices, components, elements, or assemblies of the system 2000. For example, the controller 200 may receive ambient temperature readings from the sensors 220. The ambient temperature readings may refer to or include a temperature of the high-voltage battery 132. As another example, the controller 200 may receive voltage levels which indicate a SoC of the high-voltage battery 132. In some embodiments, the controller 200 may determine a state or status of the high-voltage battery 132. For example, the controller 200 may determine that the voltage level of the high-voltage battery 132 is a CUV value. As another example, the controller 200 may determine that the temperature of the high-voltage battery 132 is a CUT value. In some embodiments, the controller 200 may determine a state or status of the bus 2002. For example, the controller 200 may determine a difference between the voltage level of the bus 2002 and the high-voltage battery 132.

In some embodiments, the controller 200 may generate or determine one or more control strategies for the system 2000. For example, the controller 200 may determine to precondition the bus 2002. In some embodiments, the controller 200 may determine to precondition the bus 2002 based on a difference between the voltage level of the bus 2002 and the high-voltage battery 132 exceeding a predetermined threshold. For example, the controller 200 may determine to precondition the bus 2002 based on the voltage level of the high-voltage battery 132 being 20% larger. In some embodiments, the controller 200 may identify or determine a component or element to precondition the bus 2002. For example, the controller 200 may determine to precondition the bus 2002 using the high-voltage battery 132. As another example, the controller 200 may determine to precondition the bus 2002 using the onboard chargers 152. As another example, the controller 200 may determine one or more bus conditions via an isolation monitoring module included in the HVPDU 134.

As an example, the controller 200 may determine to utilize the high-voltage battery 132 to precondition the bus 2002. In this example, the ambient temperature of the high-voltage battery 132 may be larger than the CUT value for the high-voltage battery 132. The CUT value may be −20 degrees Celsius. Given that the ambient temperature is larger than the CUT value, the controller 200 may determine that the high-voltage battery 132 may be used (e.g., discharged) to precondition the bus 2002. Stated otherwise, the controller 200 may control the high-voltage battery 132 to discharge power such that the voltage level of the bus 2002 is increased.

As another example, the controller 200 may determine to utilize the high-voltage battery 132, based on an SoC of the high-voltage battery 132, to precondition the bus 2002. In this example, the high-voltage battery 132 may have a Soc threshold or value for which the high-voltage battery 132 may be used to precondition the bus 2002. To continue this example, the SoC threshold may be 5% SoC (e.g., the SoC of the battery is greater than or equal to 5%). In this example, the controller 200 may determine that the high-voltage battery 132 has a voltage level of 350 volts, which may correspond to a 5% SoC. To continue this example, the controller 200 may determine to discharge the high-voltage battery 132 to precondition the bus 2002. In this example, the controller 200 may continue to have the high-voltage battery 132 discharge power until the voltage level of the bus 2002 reached a predetermined value. To continue this example, the predetermined value may be a voltage level for the bus 2002. The predetermined value may be 350 volts.

As another example, the controller 200 may determine to utilize the onboard chargers 152, based on an ambient temperature of the high-voltage battery 132, to precondition the bus 2002. In this example, the ambient temperature of the high-voltage battery 132 may be between −40 degrees Celsius and −20 degrees Celsius. Stated otherwise, the ambient temperature of the high-voltage battery 132 exceeds (e.g., is colder than) the CUT for the high-voltage battery 132. In this example, given the ambient temperature of the high-voltage battery 132, the high-voltage battery 132 is unable to discharge power to precondition the bus 2002. To continue this example, the controller 200 may utilize the onboard chargers 152 to precondition the bus 2002. For example, the onboard chargers 152 may receive electrical energy, from the grid or the charging connector 159, to increase the voltage level of the bus 2002.

As another example, the controller 200 may determine to utilize the onboard chargers 152, based on a SoC of the high-voltage battery 132, to precondition the bus 2002. In this example, the SoC of the high-voltage battery 132 may be less than 5%. To continue this example, given the SoC of the high-voltage battery 132, the high-voltage battery 132 may be unable to discharge power. In this example, the controller 200 may utilize the onboard chargers 152 to discharge or otherwise provide power to the bus 2002 such that the voltage level of the bus 2002 is increased.

As another example, the controller 200 may determine to heat or otherwise increase the temperature of one or more battery cells (e.g., cell temp) of the high-voltage battery 132. In this example, the controller 200 may determine to heat the high-voltage battery 132 such that the cell temperature of the high-voltage battery 132 is warming than at least one of the CUT value or the CUTC value for the high-voltage battery 132. Stated otherwise, the controller 200 may warm the high-voltage battery 132 such that cell temperature is adequate for the high-voltage battery 132 to discharge power and/or receive power (e.g., charged). In this example, the controller 200 may utilize the onboard chargers 152 to warm or otherwise increase the cell temperature of the high-voltage battery 132. The controller 200 may cause the onboard chargers 152 to provide power or energy to one or more heaters or heating elements (disposed within the battery area 26 or battery assembly) to provide heat or otherwise warm the one or more battery cells. For example, the one or more battery cells may have filament and/or strips that are affixed on an outside surface to provide heat directly to the cells which may cause the cell temperature (e.g., the temperature of one or more battery cells) of the high-voltage battery 132 to increase. In this example, the controller 200 may control the onboard chargers 152 urtil the cell temperature of the high-voltage battery 132 exceeds the CUT value and/or the CUTC value.

As another example, one or more battery cells may have a cell temp (e.g., battery temperature, aggregate temperature of the battery cells, an ambient temperature, etc.) or 20 degrees Celsius. In this example, the battery cells may have a voltage level of 350 volts. To continue this example, a battery management function or battery management routine may be initiated once a charging gun is plugged in (e.g., once the telehandler 10 is connected to or coupled with a power source). In this example, the onboard chargers 152 and one or more VCUs of the telehandler 10 may wake up or otherwise be activated. To continue this example, the VCUs may send one or more signals to the onboard chargers 152 to cause the onboard chargers 152 to execute a charging routine. To continue this example, given the voltage level of the battery cells, the battery cells may be pre-charge the bus 2002 to increase the voltage level at the bus 2002. In this example, the battery cells may pre-charge the bus 2002 until the voltage level at the bus 2002 is 350 volts. To continue this example, the onboard chargers 152 may charge or otherwise provide power to the battery cells responsive to the completion of pre-charging the bus 2002. The charging of the battery cells may halt or otherwise end once the battery cells reach 100% SoC or once the charging cord is disconnected or otherwise decoupled from a power supply. In some embodiments, the onboard chargers 152 may perform one or more simultaneous operations. For example, the onboard chargers 152 may simultaneously adjust a voltage level of a DC bus and adjust a temperature of one or more battery cells.

As another example, one or more battery cells may have a cell temp of −15 degrees Celsius. In this example, the battery cells may have a voltage level of 350 volts. To continue this example, a battery management function or battery management routine may be initiated once a charging gun is plugged in (e.g., once the telehandler 10 is connected to or coupled with a power source). In this example, the onboard chargers 152 and one or more VCUs (e.g., the controller 200) of the telehandler 10 may wake up or otherwise be activated. To continue this example, the VCUs may send one or more signals to the onboard chargers 152 to cause the onboard chargers 152 to execute a charging routine. To continue this example, given the voltage level of the battery cells, the battery cells may be pre-charge the bus 2002 to increase the voltage level at the bus 2002. In this example, once the bus 2002 has been pre-charged, the onboard chargers 152 may provide power to the heater 2006. To continue this example, the heater 2006 may provide warm air to heat or otherwise increase the cell temp of the battery cells. In this example, the battery cells may be heated until the cell temp reaches 0 degrees Celsius. To continue this example, once the battery cells reach a temperature of 0 degrees Celsius (e.g., a CUTC value), the onboard chargers 152 may provide power or electrical energy to charge the battery cells. The onboard chargers 152 may halt or otherwise stop the charging of the battery cells once the battery cells reach 100% SoC or once the charging cord is disconnected or otherwise decoupled from a power supply.

As another example, one or more battery cells may have a cell temp of −40 degrees Celsius and a voltage level of 350 volts. To continue this example, a battery management function or battery management routine may be initiated once a charging gun is plugged in (e.g., once the telehandler 10 is connected to or coupled with a power source). In this example, the onboard chargers 152 and one or more VCUs (e.g., the controller 200) of the telehandler 10 may wake up or otherwise be activated. To continue this example, the VCUs may send one or more signals to the onboard chargers 152 to cause the onboard chargers 152 to execute a charging routine. Given that the cell temp of the battery cells is −40 degrees Celsius (e.g., the cells are colder than the CUT value), the battery cells may be unable to discharge power. In this example, the onboard chargers 152 may pre-charge the bus 2002 to increase the voltage level at the bus 2002. To continue this example, once the bus 2002 has been pre-charged, the onboard chargers 152 may provide power to the heater 2006 such that the heater 2006 produces or otherwise provides heat to increase the cell temperature of the battery cells. Once the battery cells reach a temperature of 0 degrees Celsius (e.g., a CUTC value), the onboard chargers 152 may provide power or electrical energy to charge the battery cells. The onboard chargers 152 may halt or otherwise stop the charging of the battery cells once the battery cells reach 100% SoC or once the charging cord is disconnected or otherwise decoupled from a power supply.

As another example, one or more battery cells may have a cell temp of 20 degrees Celsius and a voltage level of 286 volts. To continue this example, a battery management function or battery management routine may be initiated once a charging gun is plugged in (e.g., once the telehandler 10 is connected to or coupled with a power source). In this example, the onboard chargers 152 and one or more VCUs (e.g., the controller 200) of the telehandler 10 may wake up or otherwise be activated. To continue this example, the VCUs may send one or more signals to the onboard chargers 152 to cause the onboard chargers 152 to execute a charging routine. In this example, the onboard chargers 152 may pre-charge the bus 2002 until the voltage level at the bus 2002 is 286 volts. Once the bus 2002 is pre-charged, the onboard chargers 152 may provide power or electrical energy to charge the battery cells. The onboard chargers 152 may halt or otherwise stop the charging of the battery cells once the battery cells reach 100% SoC or once the charging cord is disconnected or otherwise decoupled from a power supply.

As another example, one or more battery cells may have a cell temp of −40 degrees Celsius and a voltage level of 286 volts. To continue this example, a battery management function or battery management routine may be initiated once a charging gun is plugged in (e.g., once the telehandler 10 is connected to or coupled with a power source). In this example, the onboard chargers 152 and one or more VCUs (e.g., the controller 200) of the telehandler 10 may wake up or otherwise be activated. To continue this example, the VCUs may send one or more signals to the onboard chargers 152 to cause the onboard chargers 152 to execute a charging routine. In this example, the onboard chargers 152 may pre-charge the bus 2002 until the voltage level at the bus 2002 is 286 volts. Once the bus 2002 is pre-charged, the onboard chargers 152 may provide power to the heater 2006 such that the heater 2006 produces or otherwise provides heat to increase a cell temperature of the battery cells. Once the battery cells reach a temperature of 0 degrees Celsius (e.g., a CUTC value), the onboard chargers 152 may provide power or electrical energy to charge the battery cells. The onboard chargers 152 may halt or otherwise stop the charging of the battery cells once the battery cells reach 100% SoC or once the charging cord is disconnected or otherwise decoupled from a power supply.

In some embodiments, the controller 200 may charge or otherwise increase the voltage level of the high-voltage battery 132. For example, the controller 200 may transmit one or more control signals, to the onboard chargers 152, which cause the onboard chargers to provide power to the high-voltage battery 132. In some embodiments, the controller 200 may charge the high-voltage battery 132 if the voltage level of the high-voltage battery 132 is an CUV level. For example, the controller 200 may charge the high-voltage battery 132 responsive to a detection that the voltage level of the high-voltage battery 132 is 286 volts. In this example, the normal operation for the high-voltage battery 132 may be between 297 volts and 395 volts. In some embodiments, the controller 200 may prevent the high-voltage battery 132 from reaching an CUV value. For example, the controller 200 may automatically trigger execution of a charging cycle, by the onboard chargers 152, based on the SoC of the high-voltage battery 132 such that the voltage level of the high-voltage battery 132 does not drop below a predetermined threshold.

FIG. 106 is a flow diagram of a process 2010, according to some embodiments. In some embodiments, at least one system, device, component, element, or assembly as described herein, may implement, or execute the process 2010 or one or more portions thereof. For example, the controller 200 may implement the process 2010. As another example, the onboard chargers 152 may execute at least one step of the process 2010. In some embodiments, the process 2010 or one or more portions thereof may be modified or changed such that one or more steps may be added, removed, separated, combined, omitted, skipped, or otherwise repeated. For example, a first step and a second step of the process 2010 may be combined into a single step. As another example, the process 2010 may be executed or implemented in conjunction with one or more second processes.

In some embodiments, the process 2010 may begin or start responsive to a change of state or a change of status of the telehandler 10. For example, the process 2010 may start responsive to telehandler 10 being turned on (Step 2012). As another example, the process 2010 may start responsive to a charging cord or charging gun being connected to a port or inlet of the telehandler 10 (Step 2014).

In some embodiments, at step 2016, the onboard chargers 152 may wake or otherwise activate a control system. For example, the onboard chargers 152 may transmit one or more interrupts to the controller 200. As another example, the onboard chargers 152 may transmit one or more activation signals to cause the controller 200 to become active. In some embodiments, at step 2016, the onboard chargers 152 may wake the control system to cause the control system to determine a status of one or more batteries of the telehandler 10.

In some embodiments, at step 2018, the control system may be active. For example, the control system may transmit or otherwise provide one or more signals to the onboard chargers 152. The signals may establish or otherwise generate a communication session between the control system and the onboard chargers 152. For example, the communication session may include a pathway for which the control system may transmit one or more control signals to the onboard chargers 152.

In some embodiments, at step 2020, a determination as to whether the cell temperature of one or more batteries is less than a CUT value may be made. For example, the control system may prompt, responsive to the control system becoming active, the sensors 220 for information. The information may include temperature readings or temperature measurements of the high-voltage battery 132. Stated otherwise, the control system may receive information that indicates a temperature of one or more battery cells of the high-voltage battery 132. In some embodiments, the process 2010 may proceed to element A, responsive to a determination that the cell temperature exceeds the CUT value. Additionally, or alternatively, the process 2010 may proceed to step 2022 responsive to a determination that the cell temperature is less than the CUT value. For example, the control system may determine that the cell temperature is less than −20 degrees Celsius.

In some embodiments, at step 2022, a determination as whether a charging inlet is connected may be made. For example, the control system may determine if the charging connector 159 is electrically coupled with a power supply or power source. (e.g., the external power source 156, the wall adapter 158, etc.). The process 2010 may proceed to step 2024 responsive to a determination that the charging inlet is not connected to telehandler 10. In son embodiments, the process 2010 may proceed to step 2030 responsive to a determination that the charging inlet is connected to the telehandler.

In some embodiments, at step 2024, a charging gun may be connected. For example, the charging gun or plug may be connected to the charging connector 159. In some embodiments, the control system may detect that connection based on voltage or current being present at the charging connector 159.

In some embodiments, at step 2026, a determination as to whether a key switch is off may be made. For example, the control system may determine if the ignition is turned on or off. Stated otherwise, the control system may determine if the telehandler 10 is on or otherwise running. The process 2010 may proceed to step 2028 responsive to a determination that the key switch is not off. In some embodiments, the process 2010 may proceed to the step 2030 responsive to a determination that the key switch is off.

In some embodiments, at step 2028, the key may be turned off. For example, an operator of the telehandler 10 may turn the key switch to an off position. Stated otherwise, the operator may turn off the telehandler 10.

In some embodiments, at step 2030, a determination as to whether a difference between the DC bus voltage and a battery voltage is less than a threshold may be made. For example, the control system may compare the voltage level of the high-voltage battery 132 with the voltage level of the bus 2002. The process 2010 may proceed to step 2032 responsive to a determination that the battery voltage is not within 5 volts of DC bus voltage (e.g., the difference between battery voltage and DC bus voltage is not less than 5). The process 2010 may proceed to step 2034 responsive to a determination that the difference between the battery voltage and the DC bus voltage is less than 5.

In some embodiments, at step 2032, the DC bus may be pre-charged. For example, the control system may control or otherwise utilize the high-voltage battery 132 to discharge power to increase the voltage level of the bus 2002. As another example, the control system may cause the onboard chargers 152 to discharge power to charge the bus 2002. In some embodiments, the process 2010 may return to step 2030 responsive to pre-charging the bus 2002 for a predetermined amount of time. Additionally, and/or alternatively, the DC bus may be pre-charged (e.g., altered) prior to activation of a heating element. Stated otherwise, the DC bus may be pre-charge before the battery cells are heated.

In some embodiments, at step 2034, the battery may be heated. For example, the control system may cause the onboard chargers 152 to provide power to the heater 2006. The heater 2006 may produce or otherwise provide heat (e.g., a heating element, a filament, etc.) to the high-voltage battery 132 to warm or otherwise increase the cell temperature of the high-voltage battery 132. In some embodiments, the process 2010 may return to step 2020 responsive to heating the batteries for a predetermined amount of time. The process 2010 may be repeated or replicated, starting with step 2020, until the cell temp of the batteries exceeds the CUT value. Stated otherwise, the batteries may be heated until the cell temp reaches a level for which the batteries may begin to discharge power.

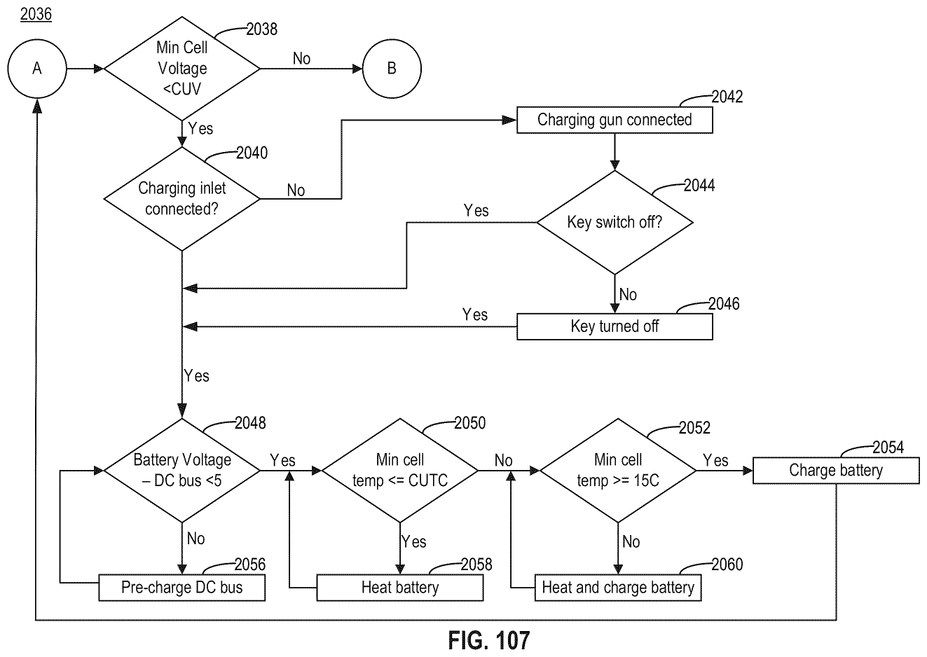

FIG. 107 is a flow diagram of a process 2036, according to some embodiments. In some embodiments, at least one system, device, component, element, or assembly as described herein, may implement, or execute the process 2036 or one or more portions thereof. For example, the controller 200 may implement the process 2036. As another example, the onboard chargers 152 may execute at least one step of the process 2036. In some embodiments, the process 2036 or one or more portions thereof may be modified or changed such that one or more steps may be added, removed, separated, combined, omitted, skipped, or otherwise repeated. For example, a first step and a second step of the process 2036 may be combined into a single step. As another example, the process 2036 may be executed or implemented in conjunction with one or more second processes. In some embodiments, the process 2036 may be executed or implemented in conjunction with or along with the process 2010.

In some embodiments, the process 2036 may be initiated or otherwise executed responsive to a determination, in step 2020, that the cell temp of one or more batteries exceeds the CUT value. For example, the control system may determine that the ambient temperature of one or more battery cells is warmer than a CUT value.

In some embodiments, at step 2038, a determination as whether a minimum battery voltage level is less than a threshold value may be made. For example, as shown in FIG. 107, the minimum battery voltage level may be compared to a CUV value. As another example, the battery voltage level may be compared to one or more voltage levels or thresholds. In some embodiments, the control system may compare the voltage level of the high-voltage battery 132 with one or more thresholds. The process 2036 may proceed to element B responsive to a determination that the battery voltage level exceeds the threshold value. In some embodiments, the process 2036 may proceed to step 2040 responsive to a determination that the battery voltage level is less than a threshold value.

In some embodiments, at step 2040, a determination as to whether a charging inlet is connected may be made. For example, the control system may determine if the charging connector 159 is electrically coupled with a power supply or power source. (e.g., the external power source 156, the wall adapter 158, etc.). The process 2036 may proceed to step 2044 responsive to a determination that the charging inlet is not connected to telehandler 10. In some embodiments, the process 2010 may proceed to step 2048 responsive to a determination that the charging inlet is connected to the telehandler. In some embodiments, at step 2042, a charging gun may be connected. For example, the charging gun or plug may be connected to the charging connector 159. In some embodiments, the control system may detect that connection based on voltage or current being present at the charging connector 159.

In some embodiments, at step 2044, a determination as to whether a key switch is off may be made. For example, the control system may determine if the ignition is turned on or off. Stated otherwise, the control system may determine if the telehandler 10 is on or otherwise running. The process 2036 may proceed to step 2046 responsive to a determination that the key switch is not off. In some embodiments, the process 2036 may proceed to the step 2048 responsive to a determination that the key switch is off.

In some embodiments, at step 2046, the key may be turned off. For example, an operator of the telehandler 10 may turn the key switch to an off position. Stated otherwise, the operator may turn off the telehandler 10.

In some embodiments, at step 2048, a determination as to whether a difference between the DC bus voltage and a battery voltage is less than a threshold may be made. For example, the control system may compare the voltage level of the high-voltage battery 132 with the voltage level of the bus 2002. The process 2036 may proceed to step 2056 responsive to a determination that the difference is larger than a threshold. For example, the threshold is shown as five volts in FIG. 107. The process 2036 may proceed to step 2050 responsive to a determination that the difference is less than the threshold.

In some embodiments, at step 2056, the DC bus may be pre-charged. For example, the control system may control or otherwise utilize the high-voltage battery 132 to discharge power to increase the voltage level of the bus 2002. As another example, the control system may cause the onboard chargers 152 to discharge power to charge the bus 2002. In some embodiments, the process 2036 may return to step 2048 responsive to pre-charging the bus 2002 for a predetermined amount of time.

In some embodiments, at step 2050, a determination as to whether the cell temp of one or more batteries is less than a CUTC value may be made. For example, the control system may prompt, responsive to the control system becoming active, the sensors 220 for information. The information may include temperature readings or temperature measurements of the high-voltage battery 132. Stated otherwise, the control system may receive information that indicates a temperature of the high-voltage battery 132. In some embodiments, the process 2036 may proceed to step 2052, responsive to a determination that the cell temperature exceeds the CUTC value. Additionally, or alternatively, the process 2036 may proceed to step 2058 responsive to a determination that the cell temperature is less than the CUTC value. For example, the control system may determine that the cell temperature is less than 0 (e.g., zero) degrees Celsius.

In some embodiments, at step 2058, the battery may be heated. For example, the control system may cause the onboard chargers 152 to provide power to the heater 2006. The heater 2006 may produce or otherwise provide heat to the high-voltage battery 132 to warm or otherwise increase the cell temperature of the high-voltage battery 132. In some embodiments, the process 2036 may return to step 2050 responsive to heating the batteries for a predetermined amount of time. The process 2036 may be repeated or replicated, starting with step 2050, until the cell temp of the batteries exceeds the CUTC value. Stated otherwise, the batteries may be heated until the cell temp reaches a level for which the batteries may begin to be charged (e.g., receive power).

In some embodiments, at step 2052, a determination as to whether the cell temp exceeds a threshold may be made. For example, as shown in FIG. 107, the cell temp may be compared to a threshold of 15 degrees Celsius. In some embodiments, the process 2036 may proceed to step 2054 responsive to a determination that the cell temp exceeds the threshold. The process 2036 may proceed to step 2060 responsive to a determination that cell temp does not exceed the threshold.

In some embodiments, at step 2054, the battery may be charged. For example, the control system may cause the onboard chargers 152 to provide power to the battery such that the voltage level or SoC of the battery is increased. The process 2036 may return to step 2038 responsive to charging the batteries for a predetermined amount of time.

In some embodiments, at step 2060, the battery may be heated and charged. For example, the onboard chargers 152 may provide electrical energy to the heater 2006 to cause the heater 2006 to warm or otherwise increase a cell temperature of the high-voltage battery 132. As another example, the onboard chargers 152 may provide electrical energy to the high-voltage battery 132 such that the voltage level of the high-voltage battery 132 is increased. The process 2036 may return to step 2052 responsive to heating and charging the battery for a predetermined amount of time.

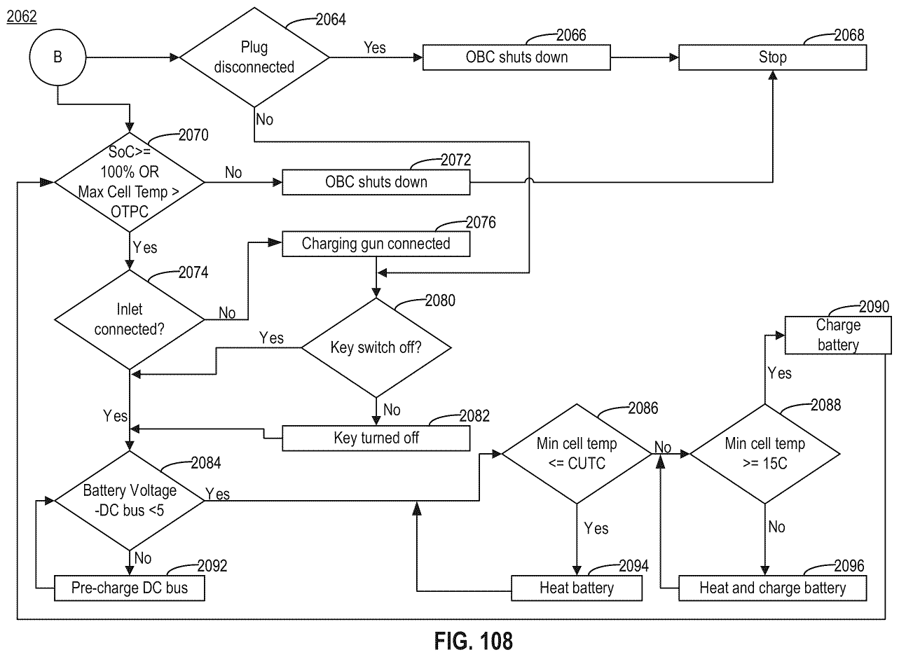

FIG. 108 is a flow diagram of a process 2062, according to some embodiments. In some embodiments, at least one system, device, component, element, or assembly as described herein, may implement, or execute the process 2062 or one or more portions thereof. For example, the controller 200 may implement the process 2062. As another example, the onboard chargers 152 may execute at least one step of the process 2062. In some embodiments, the process 2062 or one or more portions thereof may be modified or changed such that one or more steps may be added, removed, separated, combined, omitted, skipped, or otherwise repeated. For example, a first step and a second step of the process 2062 may be combined into a single step. As another example, the process 2062 may be executed or implemented in conjunction with one or more second processes. In some embodiments, the process 2062 may be executed or implemented in conjunction with or along with the process 2010 and/or the process 2036.

In some embodiments, the process 2062 may be initiated or otherwise executed responsive to a determination, in step 2038, that the battery voltage is larger than 286 volts. For example, the control system may determine that the voltage level of the high-level battery 132 exceeds the threshold established in step 2038.

In some embodiments, in step 2064, a determination as to whether a plug is disconnected may be made. For example, the controller 200 may determine if the charging connector 154 is still coupled with or plugged into power. The process 2062 may proceed to step 2066 responsive to a determination that the plug is disconnected. The process 2062 may proceed to step 2080 responsive to a determination that the plug is not disconnected (e.g., still connected).

In some embodiments, at step 2066, the onboard chargers 152 may shut down. For example, the onboard chargers 152 may switch to an idle mode or an inactive mode. As another example, the onboard chargers 152 may halt or otherwise stop providing power to one or more components of the telehandler 10. In some embodiments, the process 2062 may terminate or otherwise stop at step 2068 responsive to the onboard chargers 152 having been shut down.

In some embodiments, step 2070, a determination as to whether the SoC of a battery or a cell temp of one or more batteries is less than a threshold may be determined. For example, as shown in FIG. 108, the SoC of the battery may be compared to an SoC of 100% or a cell temperature may be compared to a maximum cell temperature. In some embodiments, a SoC of 100% may refer to battery being at or nearly at a full charge. The process 2062 may proceed to step 2072 responsive to a determination that the SoC or the cell temp is larger than the threshold. The process 2062 may proceed to step 2074 responsive to a determination that the SoC or the cell temp is less than the threshold.

In some embodiments, at step 2072, the onboard chargers 152 may shut down. For example, the onboard chargers 152 may switch to an idle mode or an inactive mode. As another example, the onboard chargers 152 may halt or otherwise stop providing power to one or more components of the telehandler 10. In some embodiments, the process 2062 may terminate or otherwise stop at step 2068 responsive to the onboard chargers 152 having been shut down.

In some embodiments, at step 2074, a determination as to whether a charging inlet is connected may be made. For example, the control system may determine if the charging connector 159 is electrically coupled with a power supply or power source. (e.g., the external power source 156, the wall adapter 158, etc.). The process 2062 may proceed to step 2076 responsive to a determination that the charging inlet is not connected to telehandler 10. In some embodiments, the process 2062 may proceed to step 2084 responsive to a determination that the charging inlet is connected to the telehandler.

In some embodiments, at step 2076, a charging gun may be connected. For example, the charging gun or plug may be connected to the charging connector 159. In some embodiments, the control system may detect that connection based on voltage or current being present at the charging connector 159.

In some embodiments, at step 2080, a determination as to whether a key switch is off may be made. For example, the control system may determine if the ignition is turned on or off. Stated otherwise, the control system may determine if the telehandler 10 is on or otherwise running. The process 2062 may proceed to step 2082 responsive to a determination that the key switch is not off. In some embodiments, the process 2062 may proceed to the step 2084 responsive to a determination that the key switch is off.

In some embodiments, at step 2082, the key may be turned off. For example, an operator of the telehandler 10 may turn the key switch to an off position. Stated otherwise, the operator may turn off the telehandler 10.

In some embodiments, at step 2084, a determination as to whether the DC bus voltage is larger than a battery voltage may be made. For example, the control system may compare the voltage level of the high-voltage battery 132 with the voltage level of the bus 2002. The process 2062 may proceed to step 2092 responsive to a determination that the DC bus voltage does not exceed the battery voltage. The process 2062 may proceed to step 2086 responsive to a determination that the DC bus voltage exceeds the battery voltage.

In some embodiments, at step 2086, a determination as to whether the cell temp of one or more batteries is less than a CUTC value may be made. For example, the control system may prompt, responsive to the control system becoming active, the sensors 220 for information. The information may include temperature readings or temperature measurements of the high-voltage battery 132. Stated otherwise, the control system may receive information that indicates a temperature of the high-voltage battery 132. In some embodiments, the process 2062 may proceed to step 2088, responsive to a determination that the cell temperature exceeds the CUTC value. Additionally, or alternatively, the process 2062 may proceed to step 2094 responsive to a determination that the cell temperature is less than the CUTC value. For example, the control system may determine that the cell temperature is less than 0 degrees Celsius.

In some embodiments, at step 2088, a determination as to whether the cell temp exceeds a threshold may be made. For example, as shown in FIG. 108, the cell temp may be compared to a threshold of 15 degrees Celsius. In some embodiments, the process 2062 may proceed to step 2090 responsive to a determination that the cell temp exceeds the threshold. The process 2062 may proceed to step 2096 responsive to a determination that the cell temp does not exceed the threshold.

In some embodiments, at step 2090, the battery may be charged. For example, the control system may cause the onboard chargers 152 to provide power to the battery such that the voltage level or SoC of the battery is increased. The process 2062 may return to step 2070 responsive to charging the batteries for a predetermined amount of time.

In some embodiments, at step 2092, the DC bus may be pre-charged. For example, the control system may control or otherwise utilize the high-voltage battery 132 to discharge power to increase (e.g., adjust, alter, change, etc.) the voltage level of the bus 2002. As another example, the control system may cause the onboard chargers 152 to discharge power to charge the bus 2002. In some embodiments, the process 2062 may return to step 2084 responsive to pre-charging the bus 2002 for a predetermined amount of time.

In some embodiments, at step 2094, the battery may be heated. For example, the control system may cause the onboard chargers 152 to provide power to the heater 2006. The heater 2006 may produce or otherwise provide heat to the high-voltage battery 132 to warm or otherwise increase the cell temperature of the high-voltage battery 132. In some embodiments, the process 2062 may return to step 2086 responsive to heating the batteries for a predetermined amount of time. The process 2062 may be repeated or replicated, starting with step 2086, until the cell temp of the batteries exceeds the CUTC value. Stated otherwise, the batteries may be heated until the cell temp reaches a level for which the batteries may begin to be charged (e.g., receive power).

In some embodiments, at step 2096, the battery may be heated and charged. For example, the onboard chargers 152 may provide electrical energy to the heater 2006 to cause the heater 2006 to warm or increase a cell temperature of the high-voltage battery 132. As another example, the onboard chargers 152 may provide electrical energy to the high-voltage battery 132 such that the voltage level of the high-voltage battery 132 is increased. The process 2062 may return to step 2088 responsive to heating and charging the battery for a predetermined amount of time.

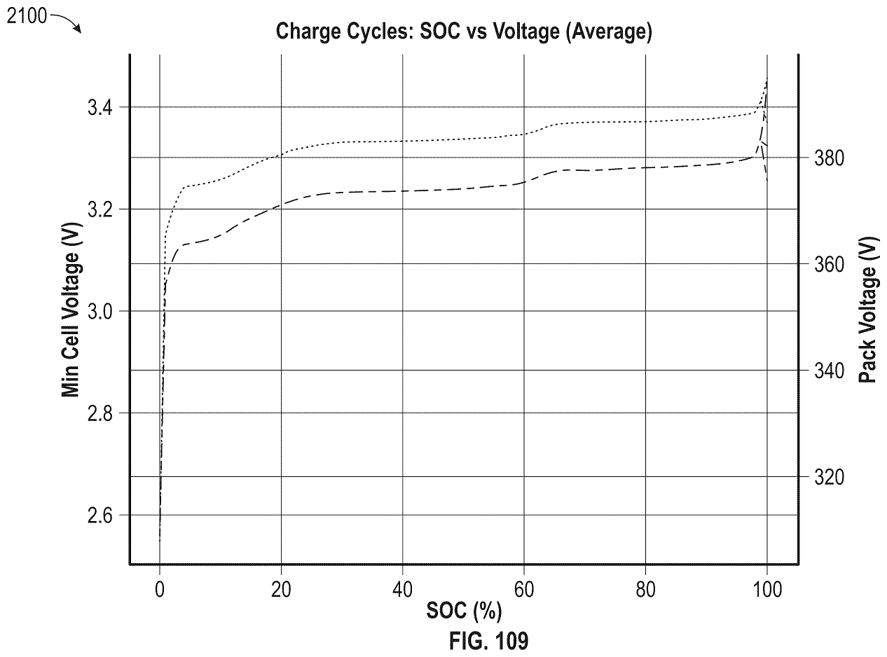

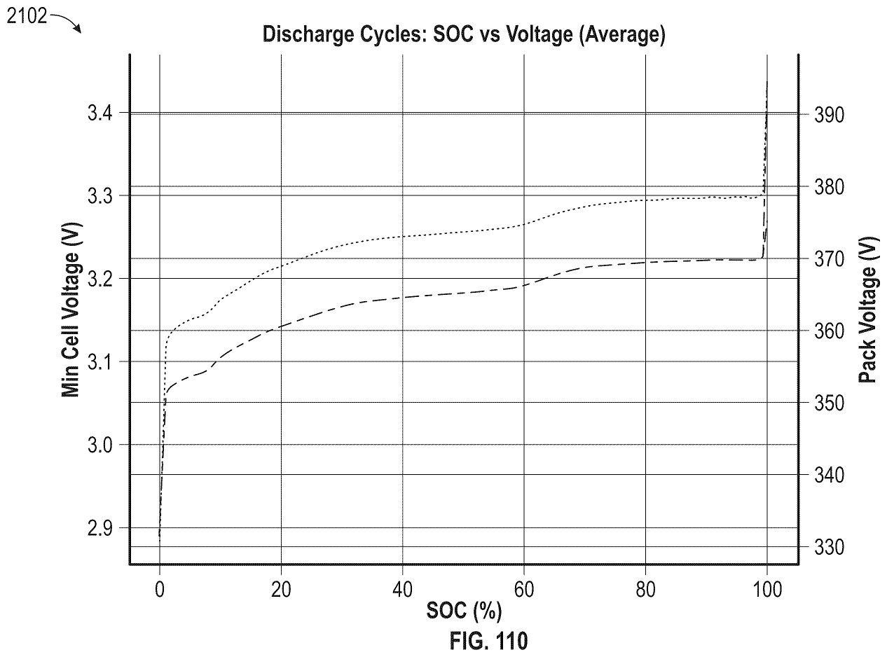

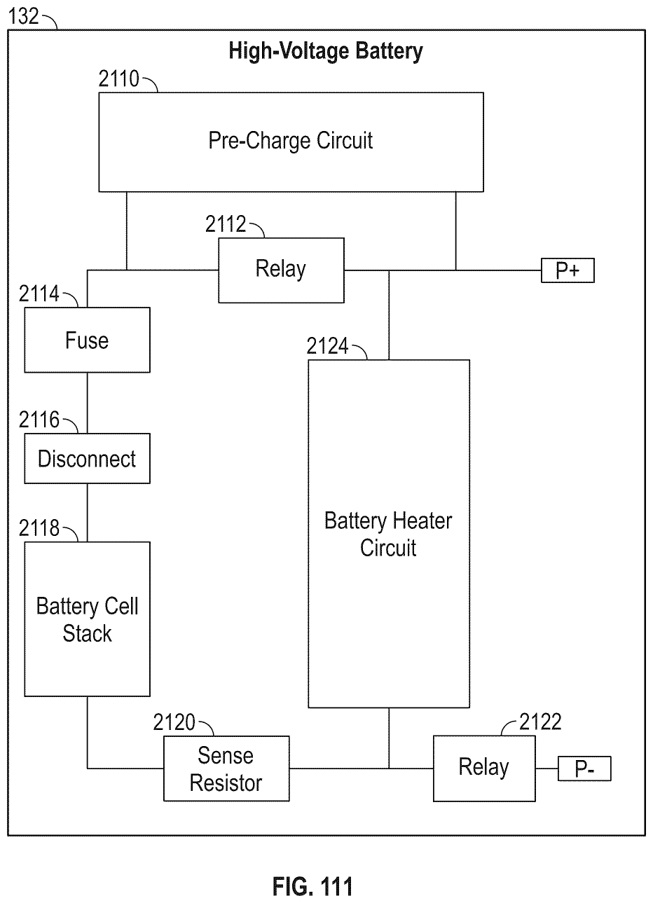

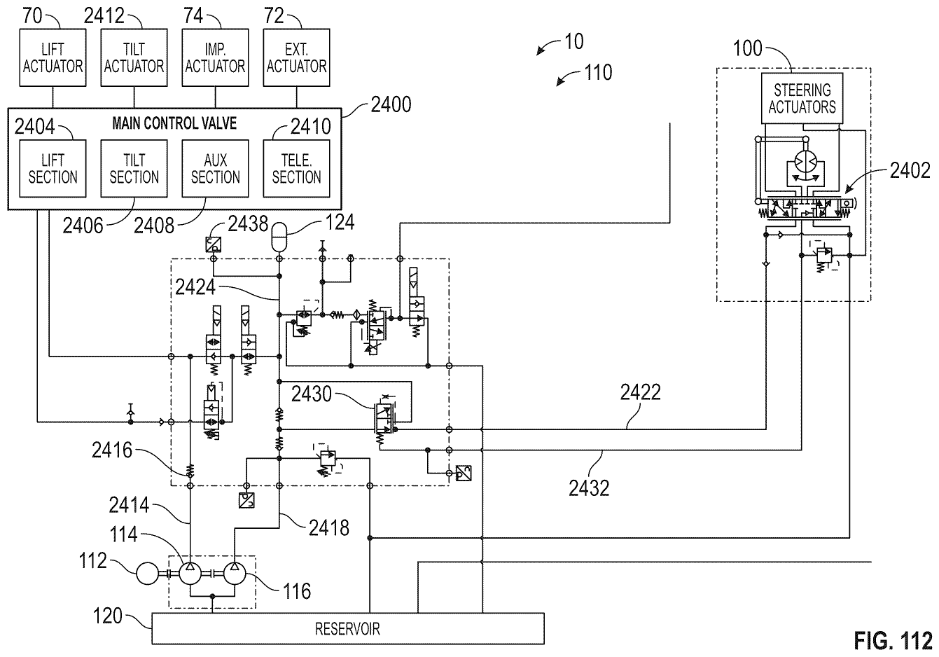

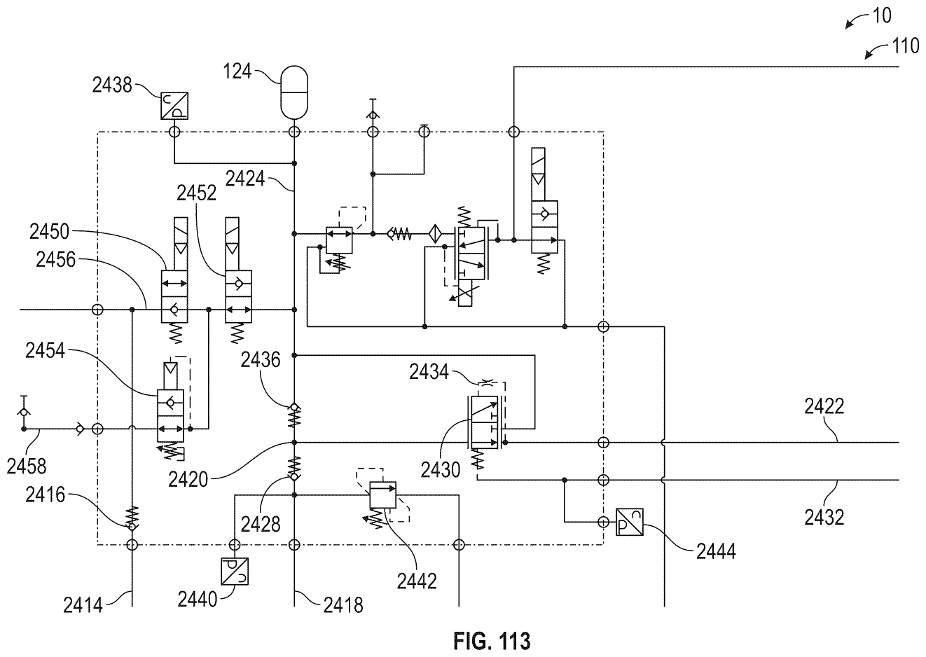

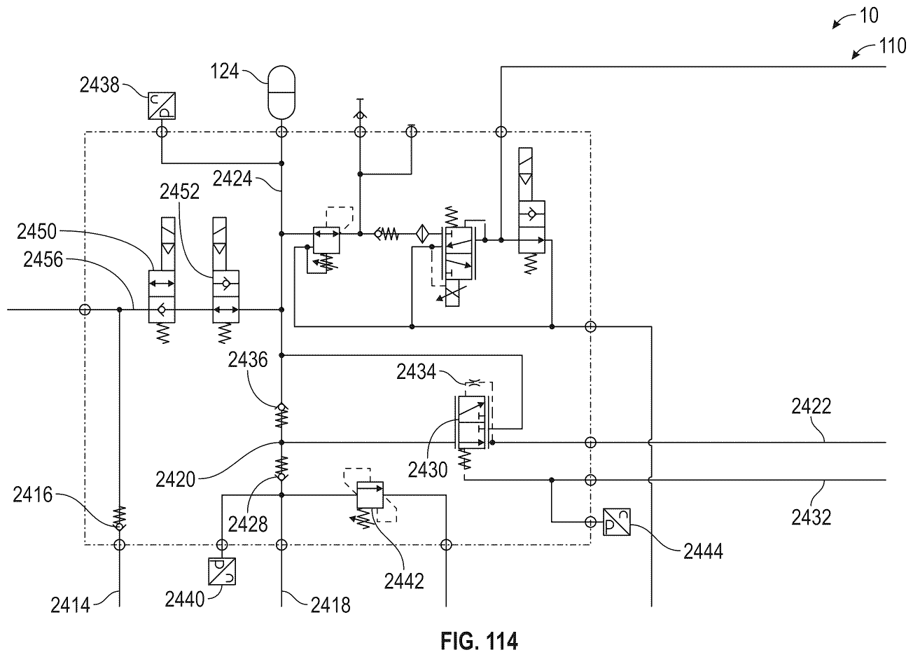

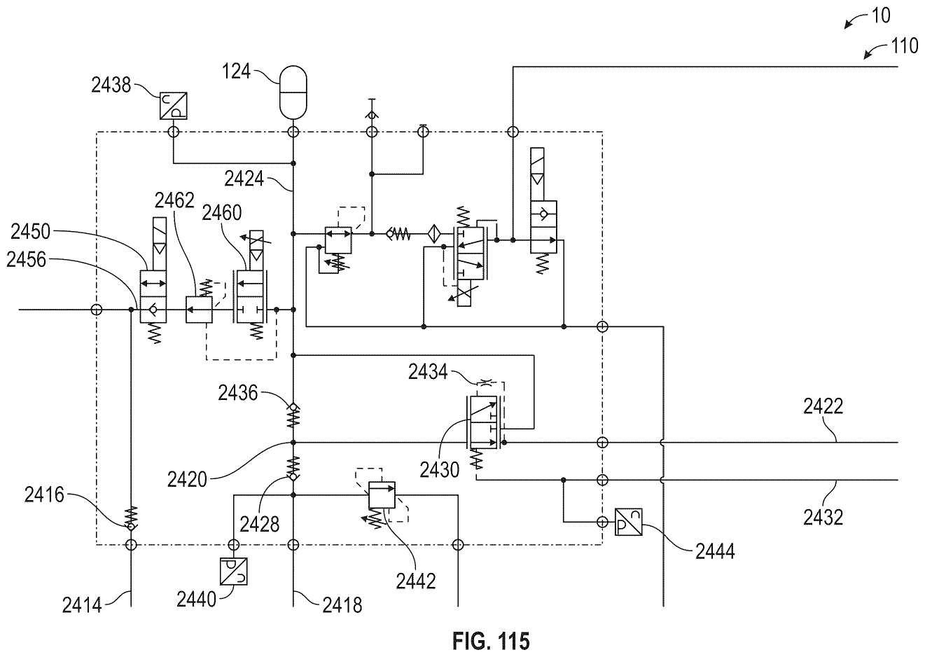

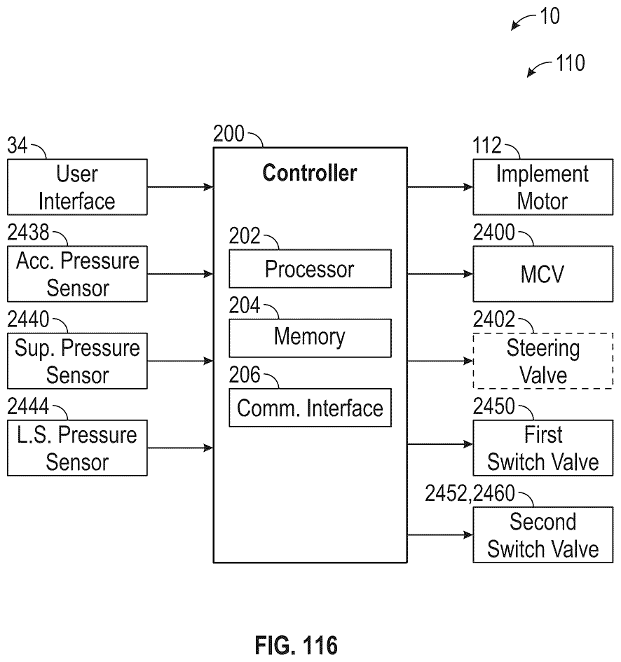

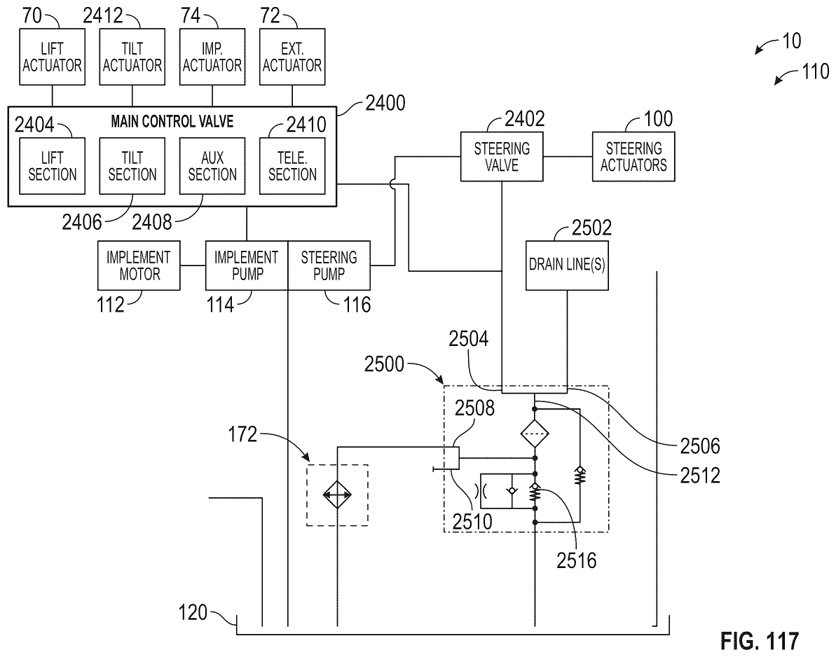

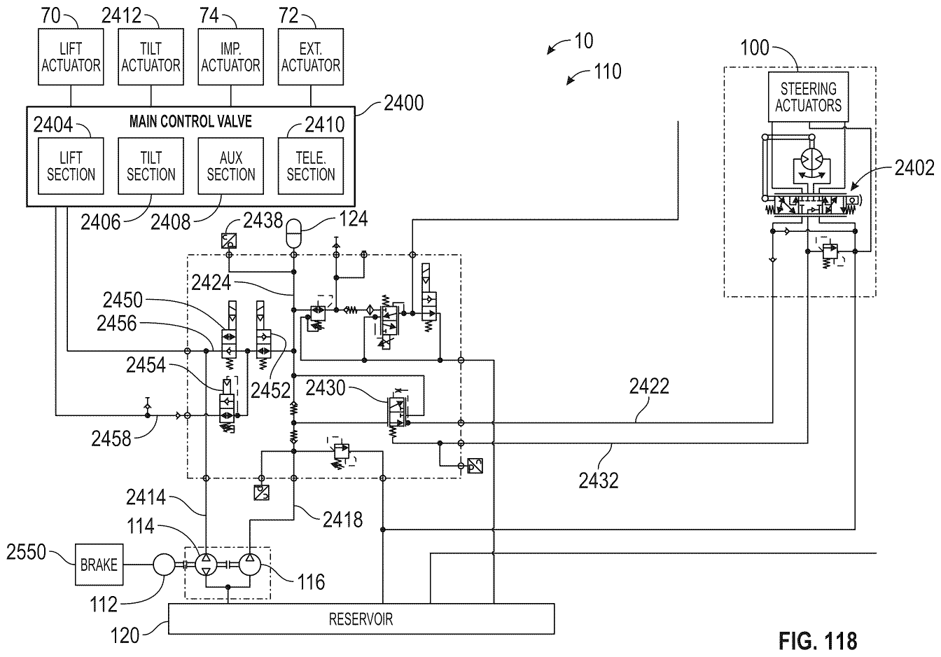

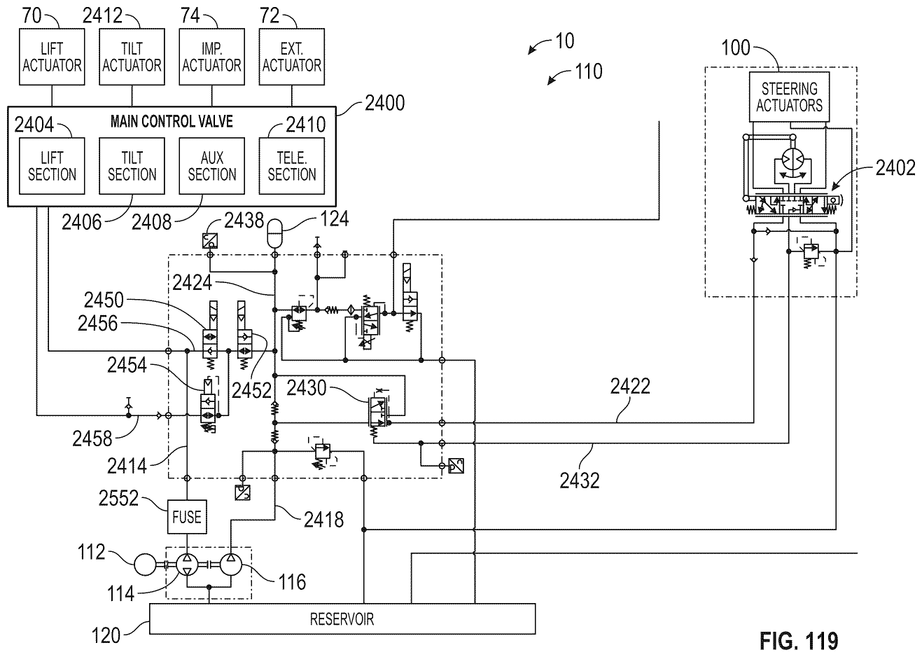

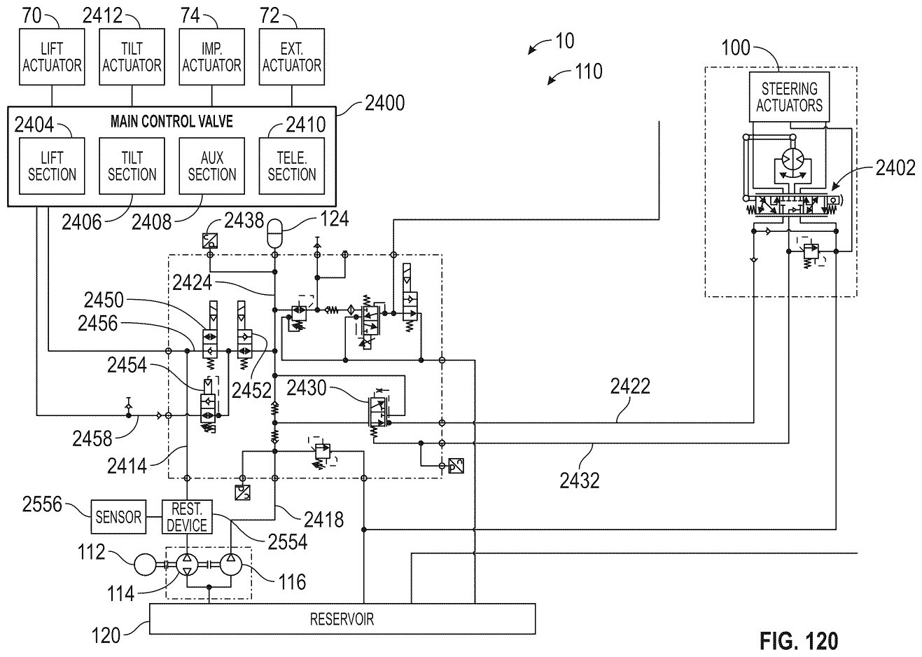

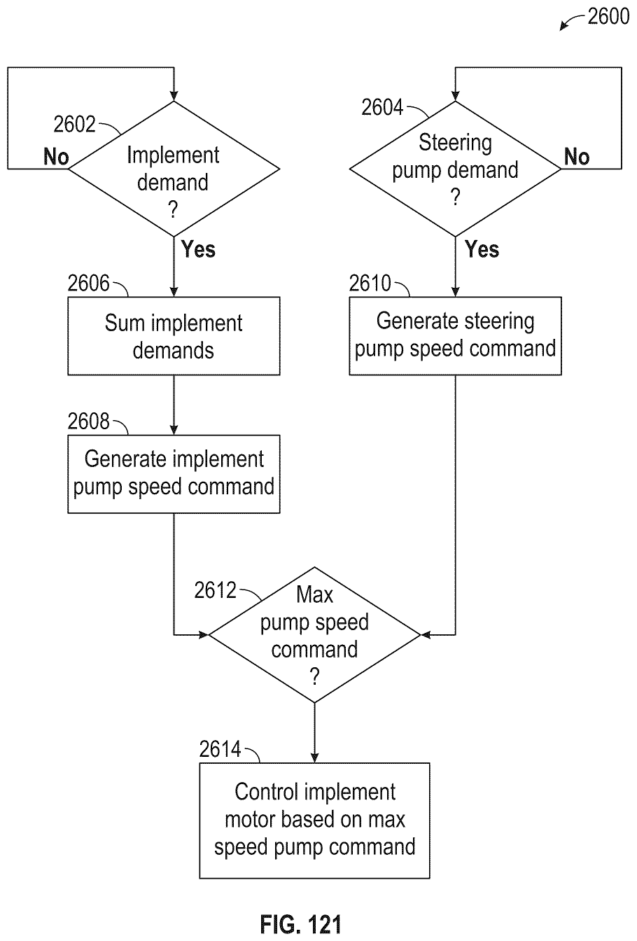

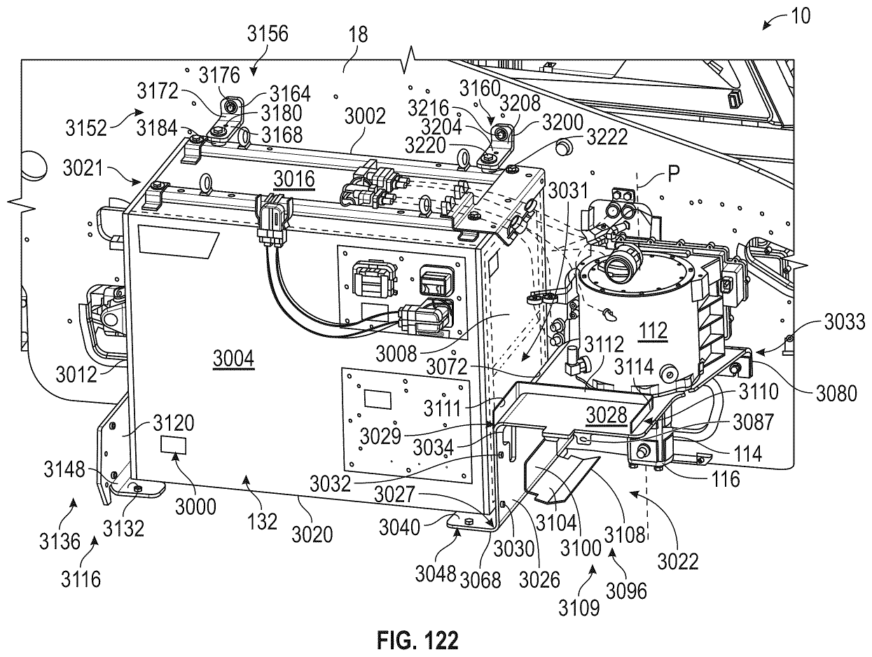

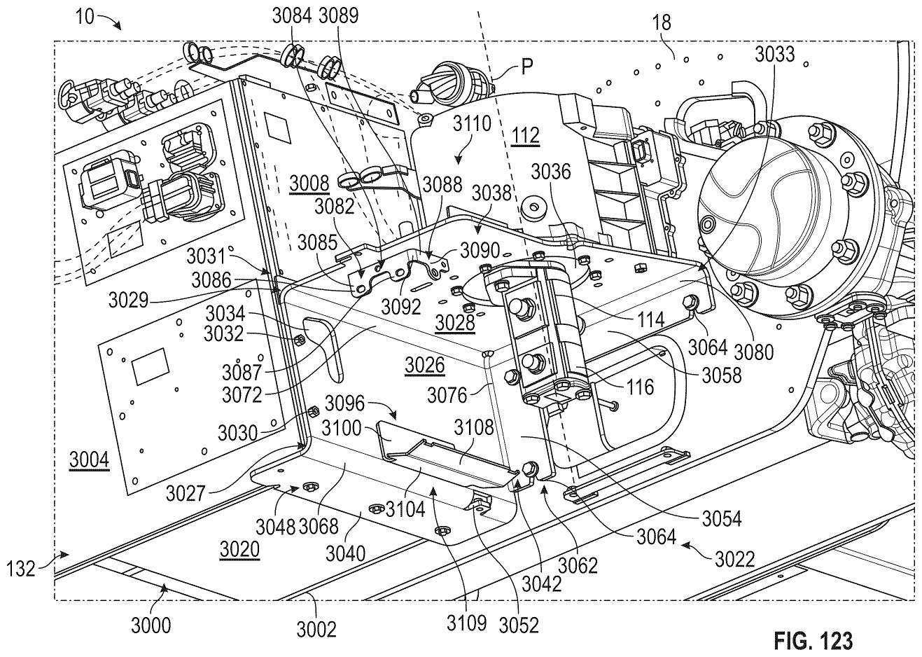

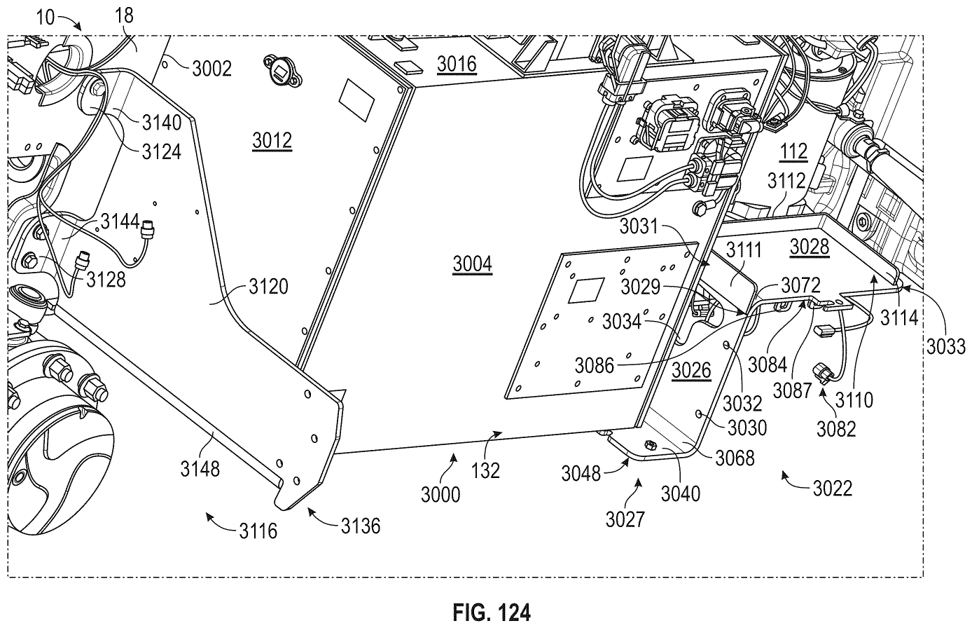

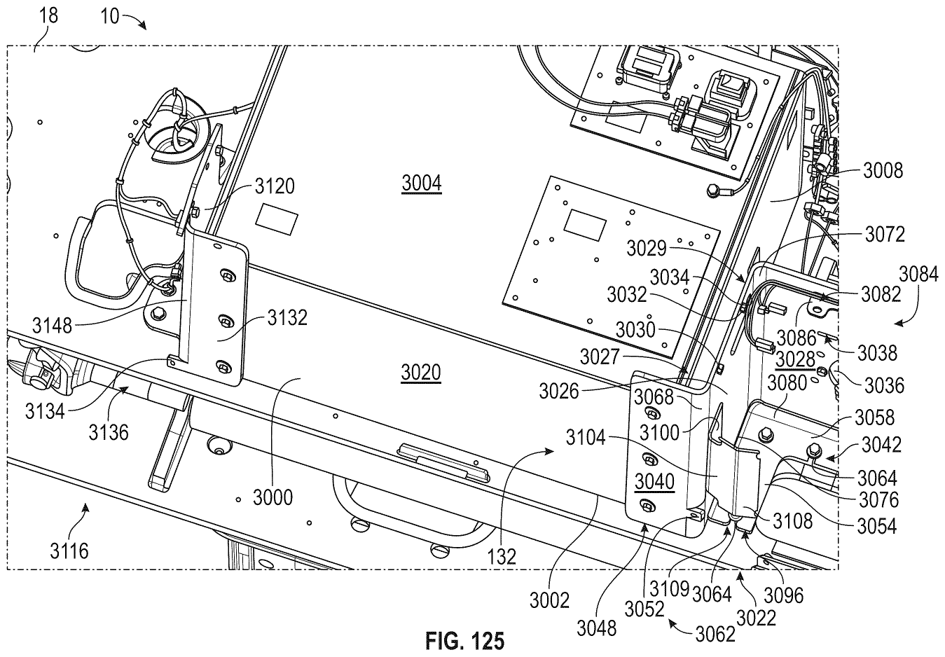

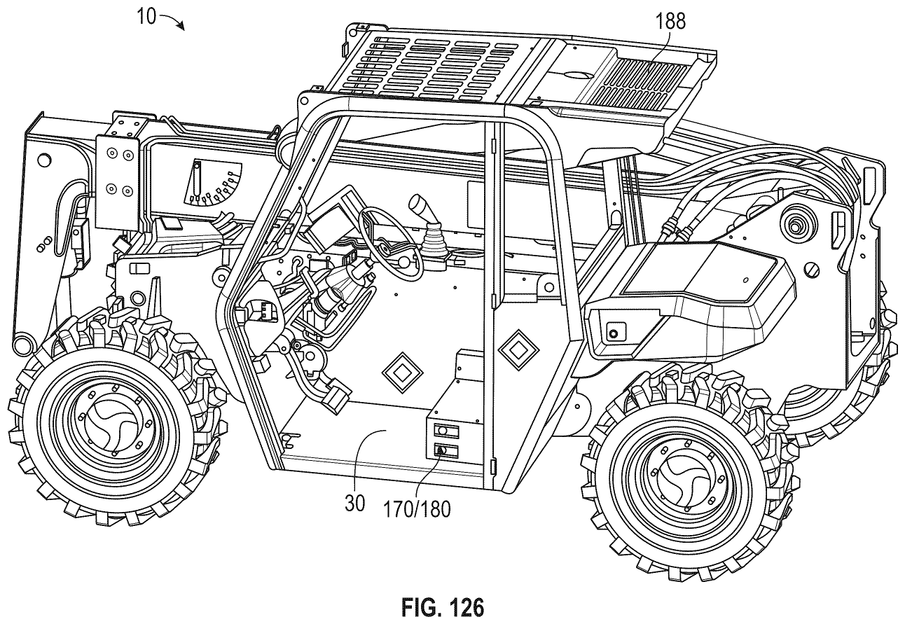

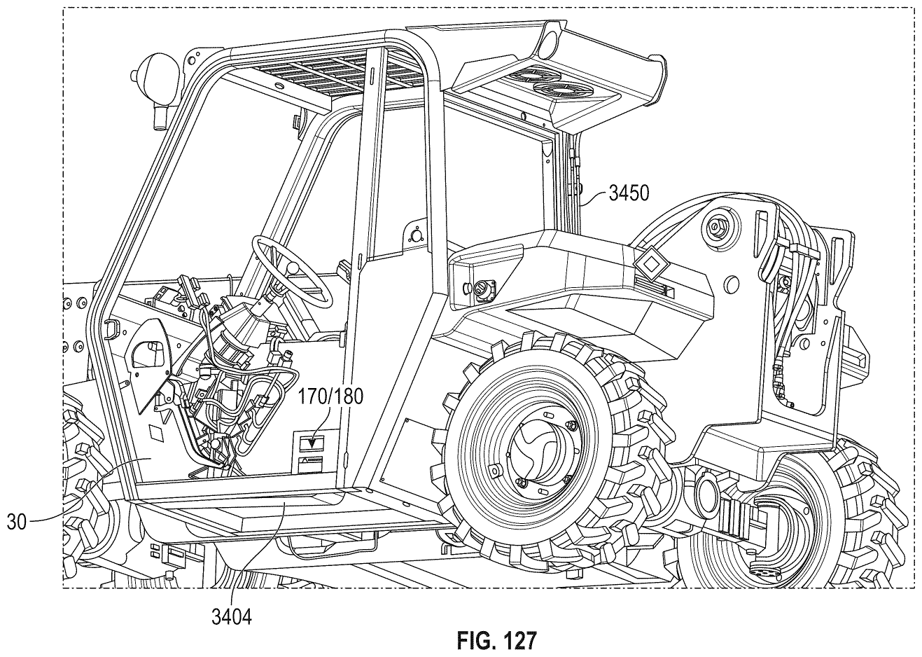

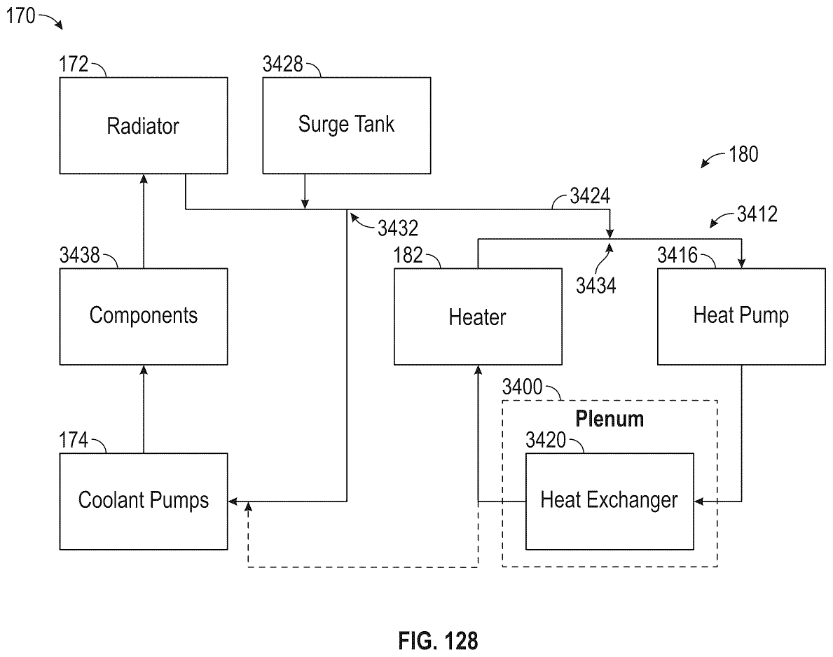

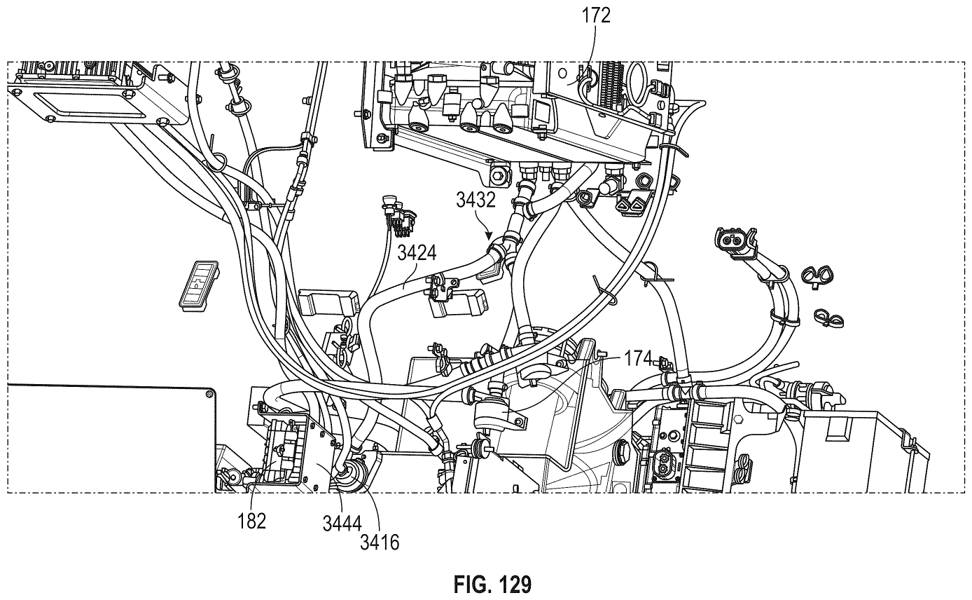

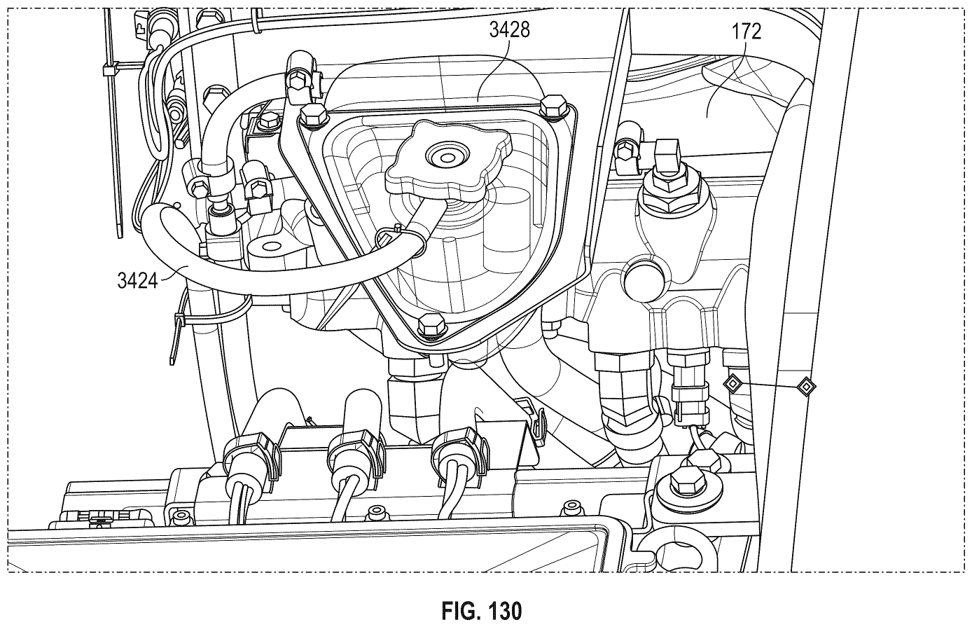

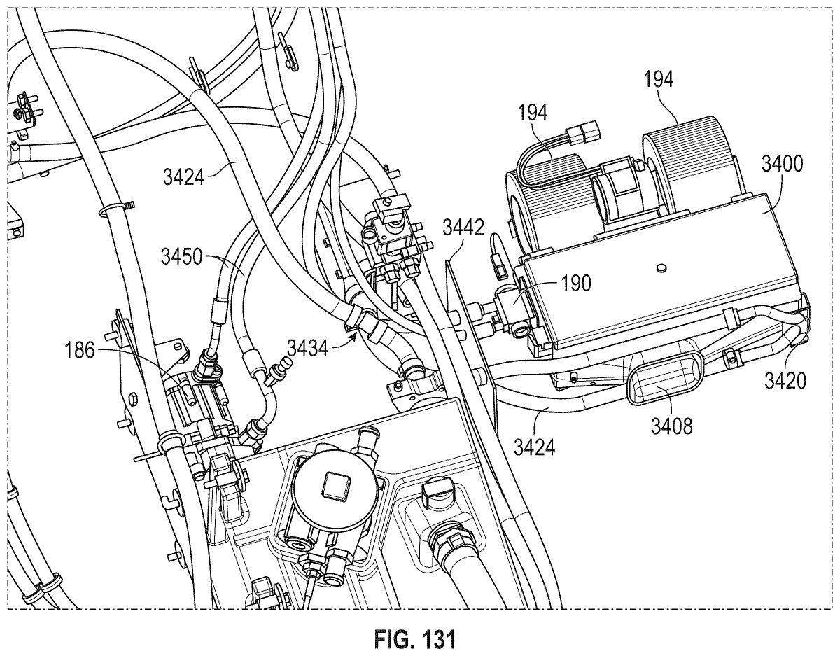

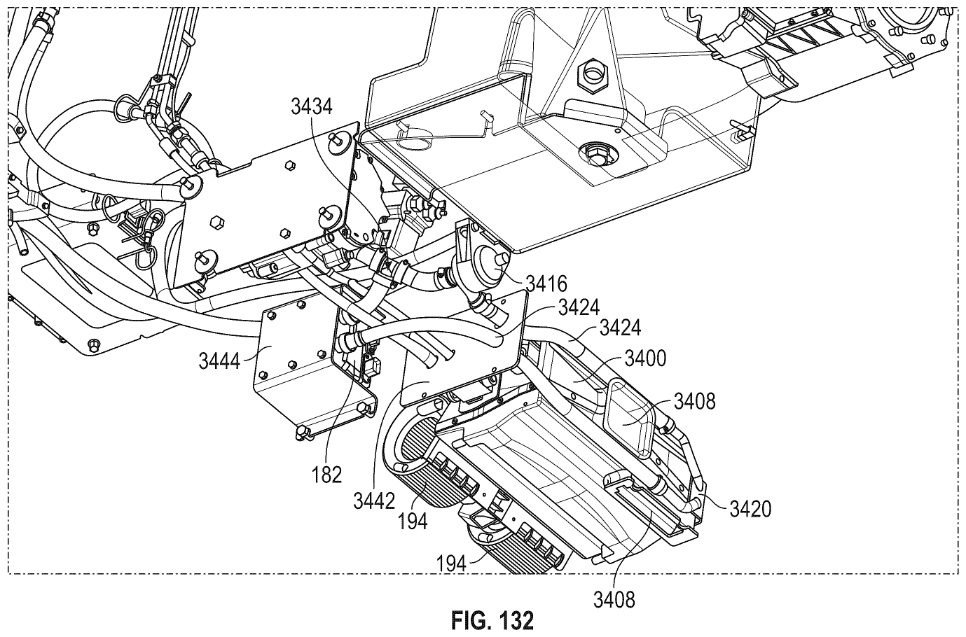

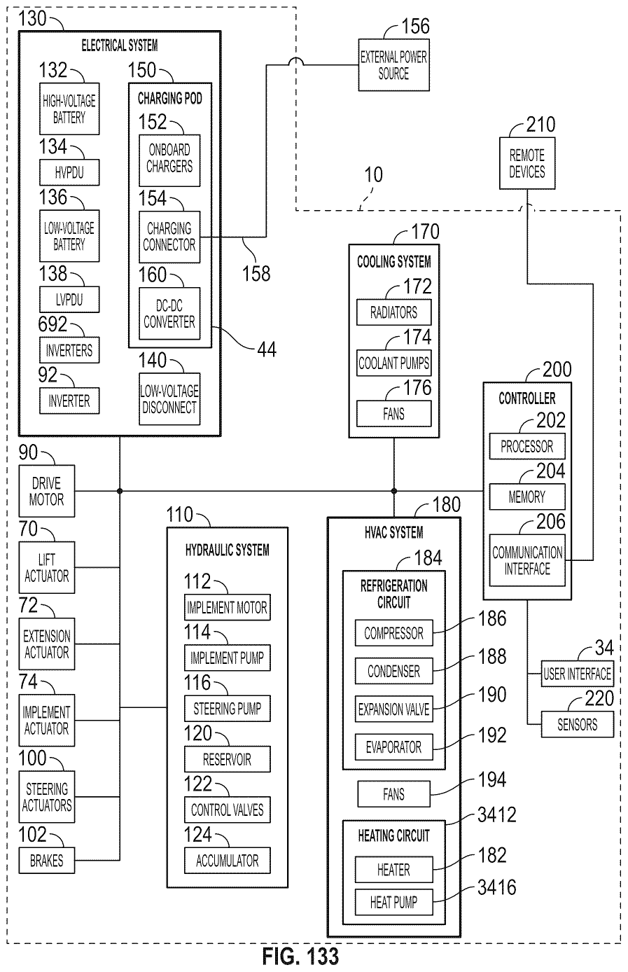

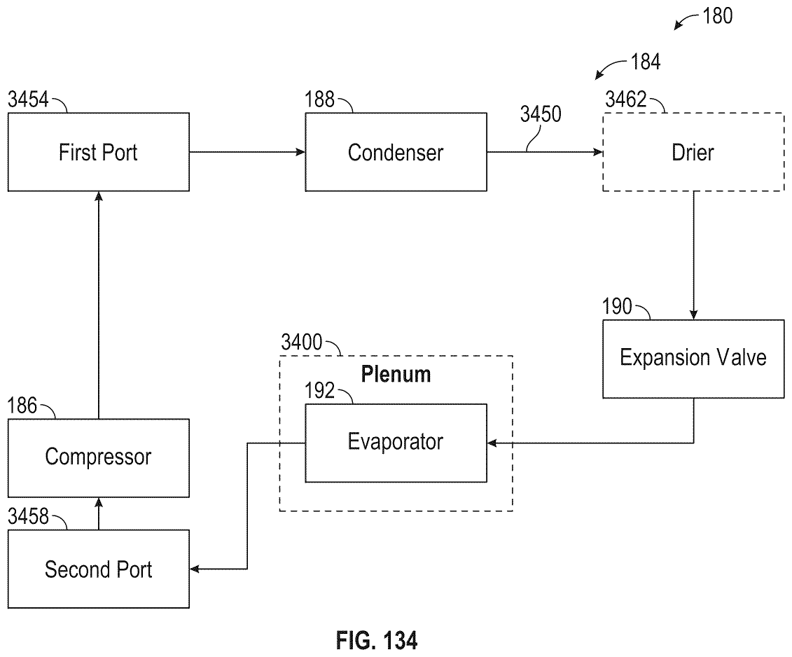

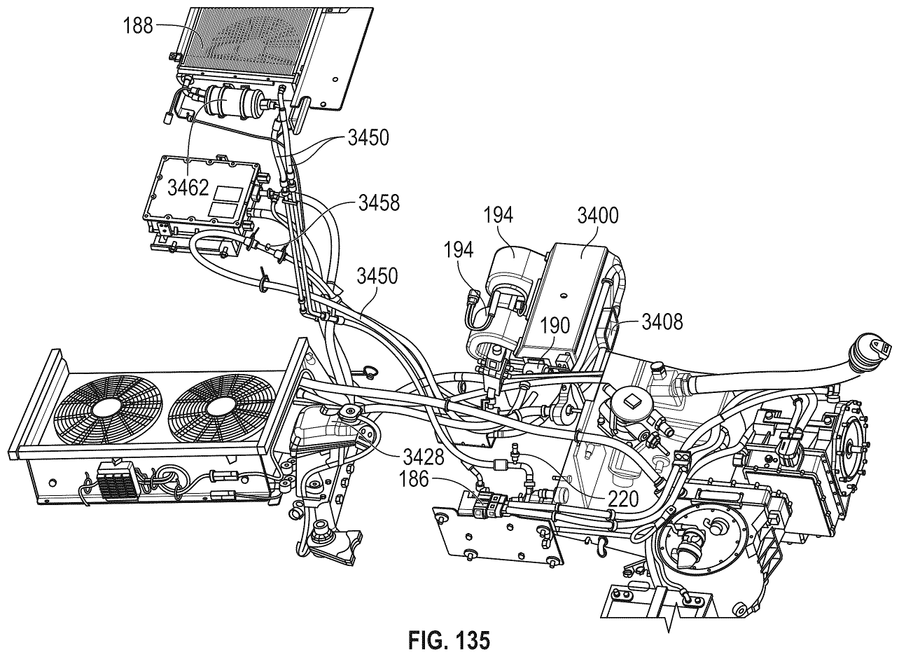

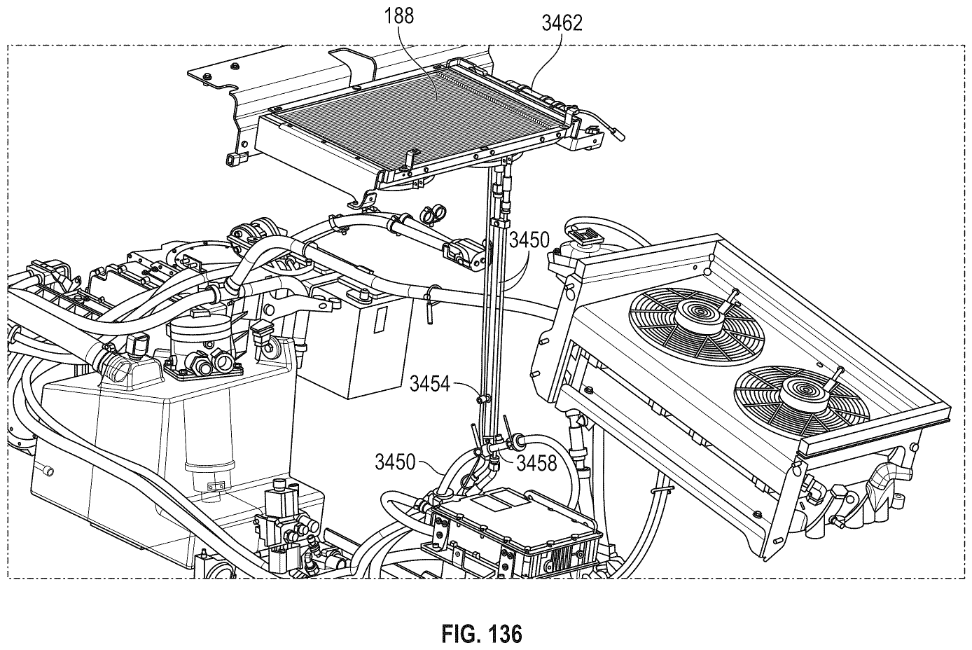

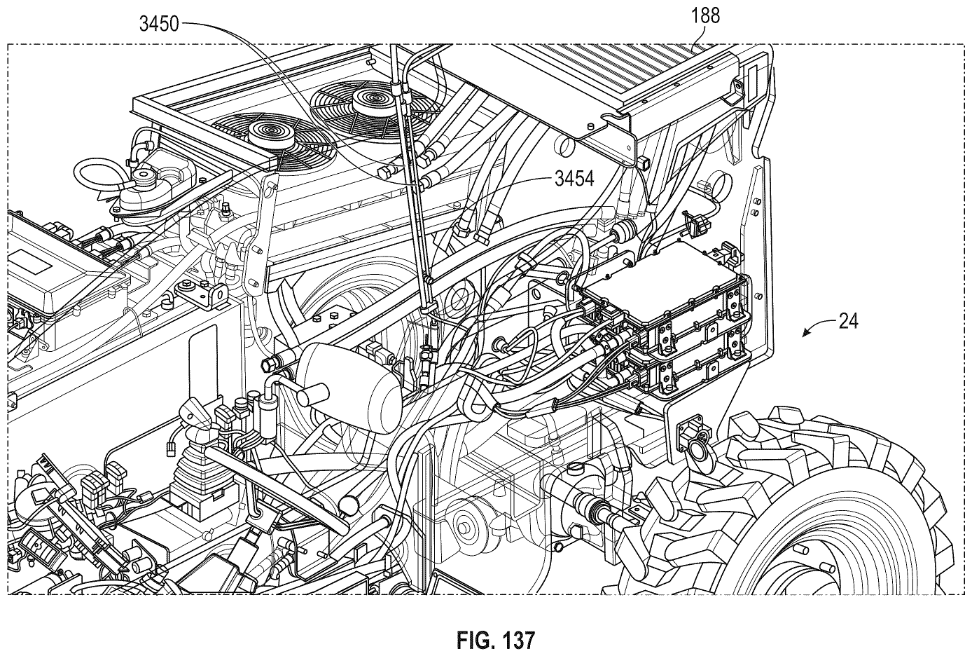

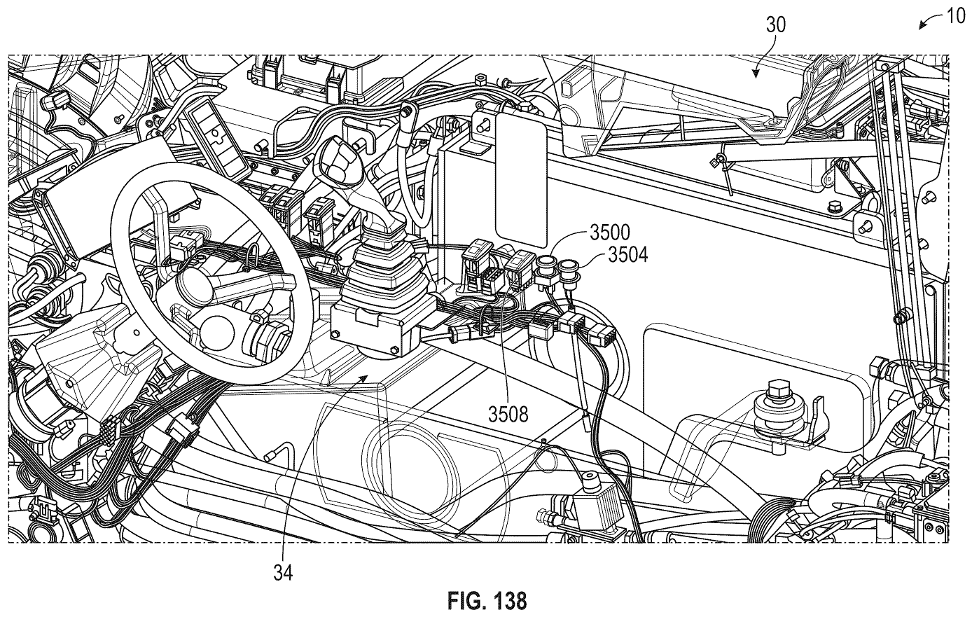

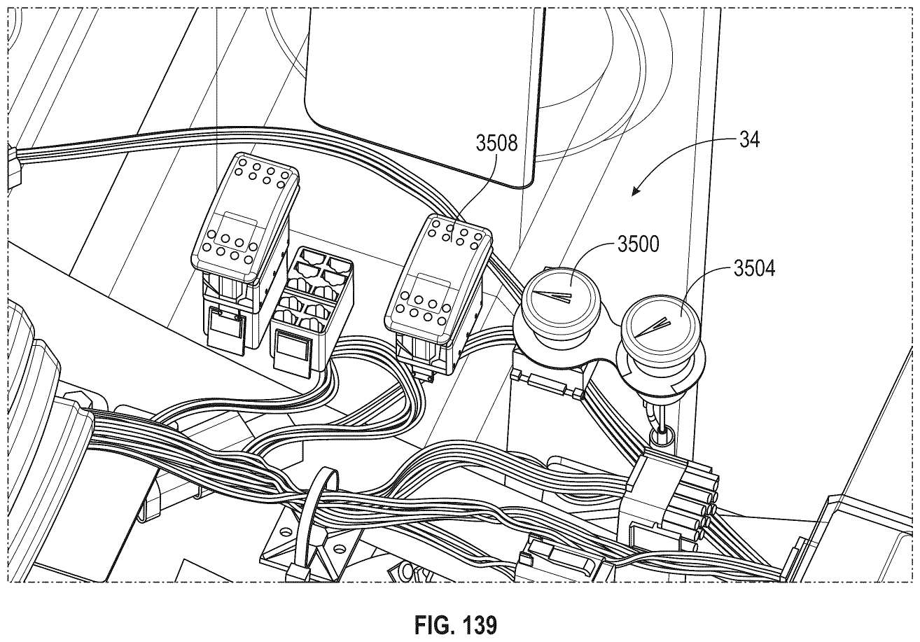

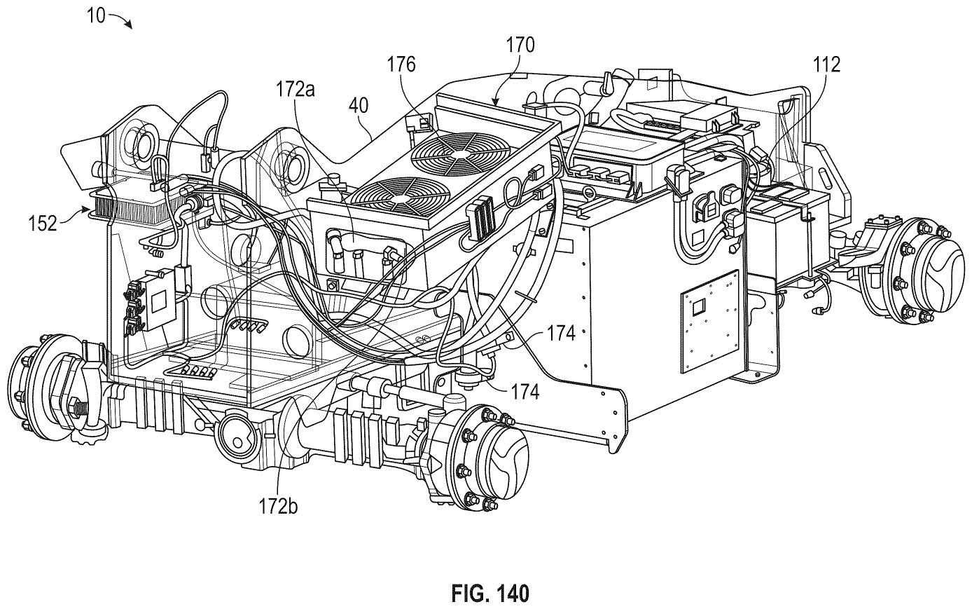

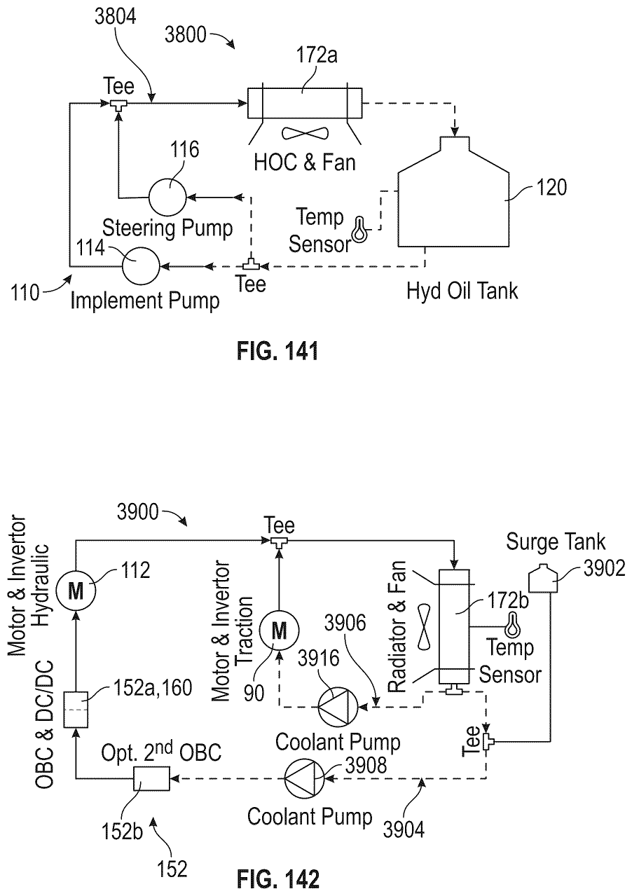

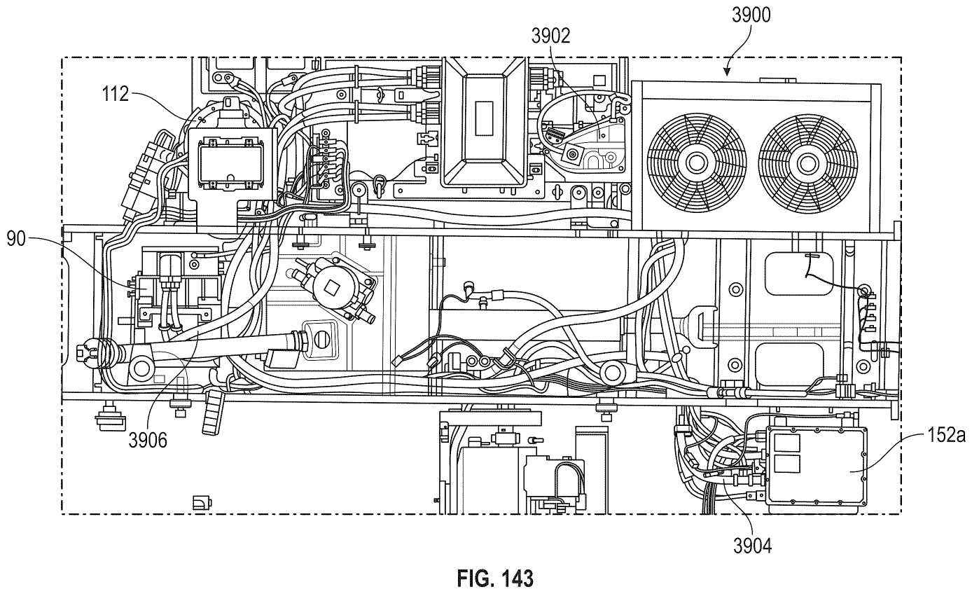

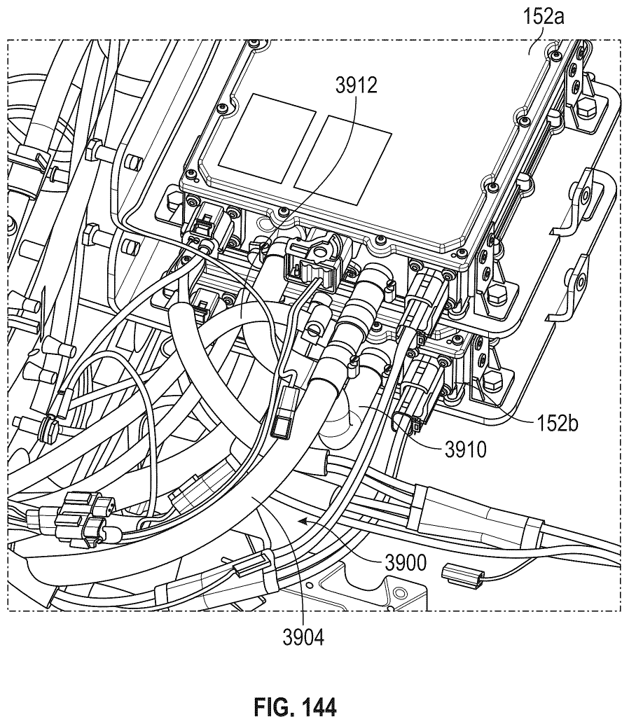

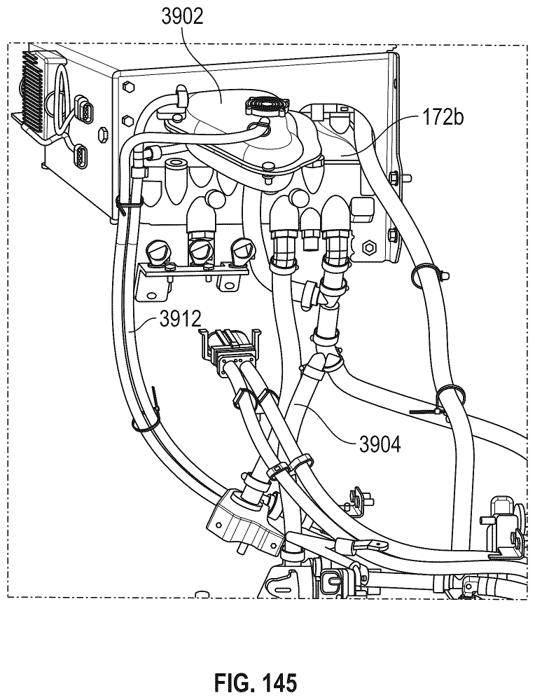

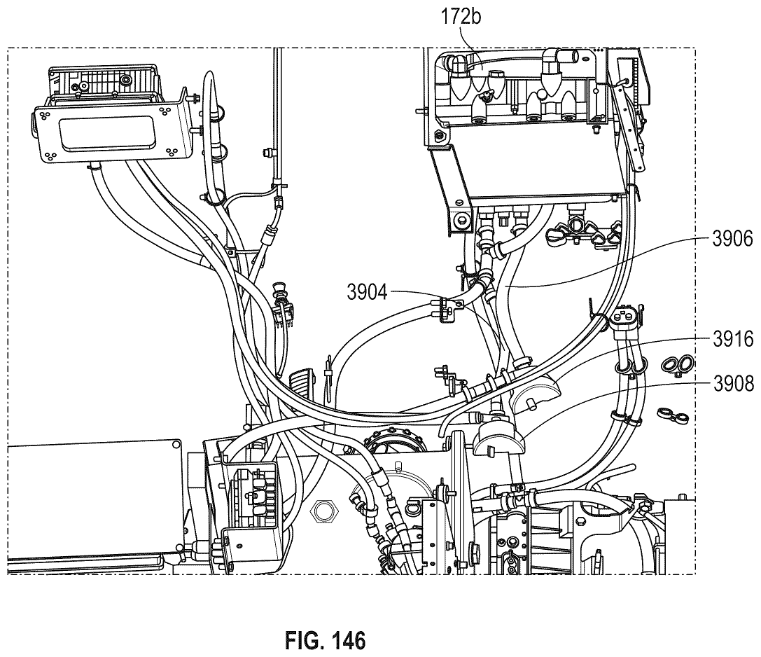

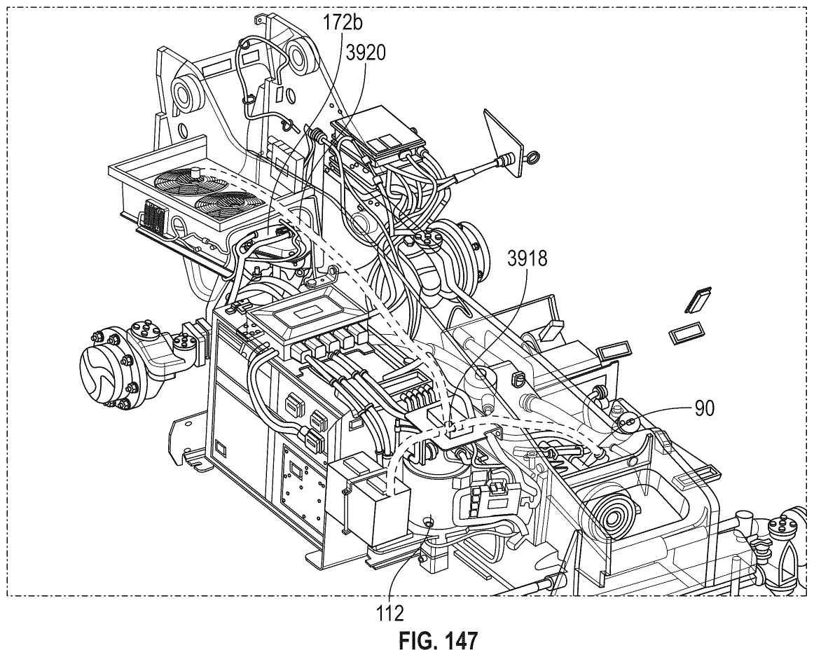

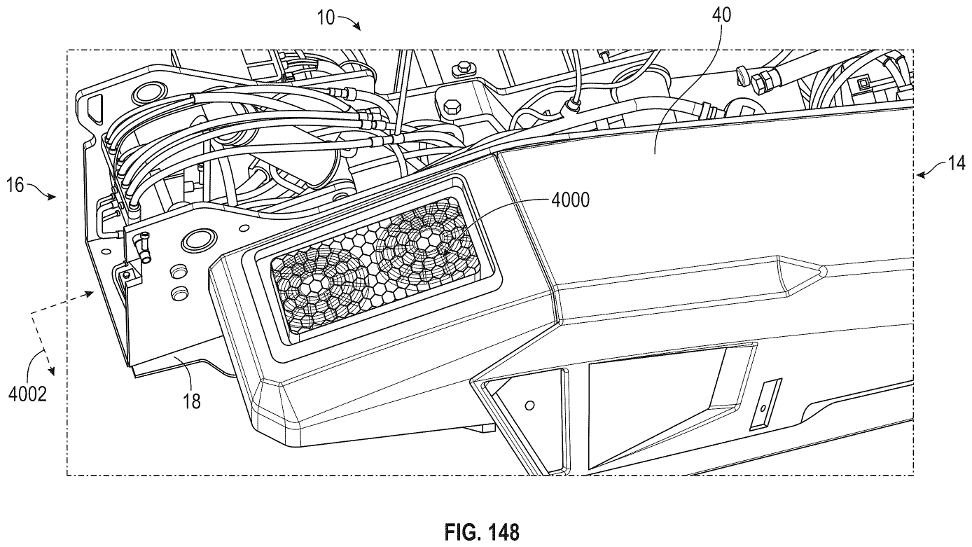

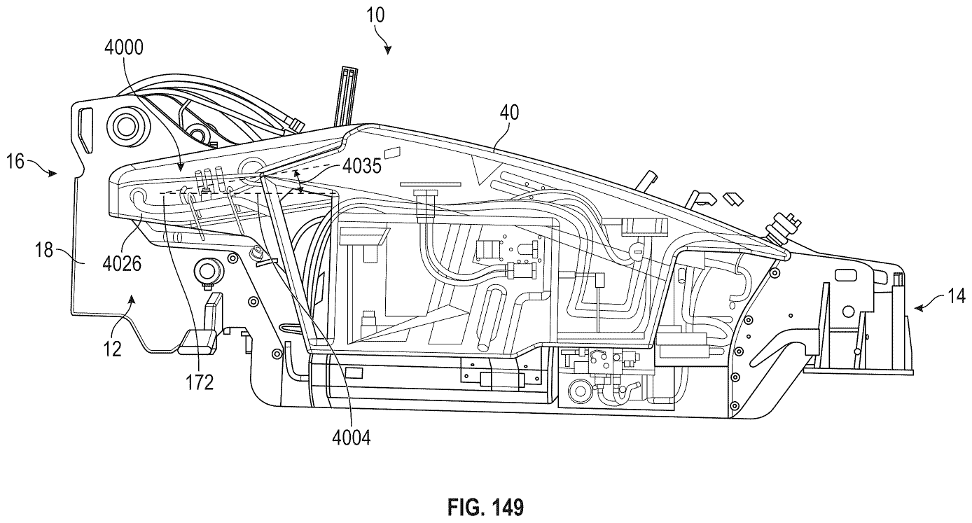

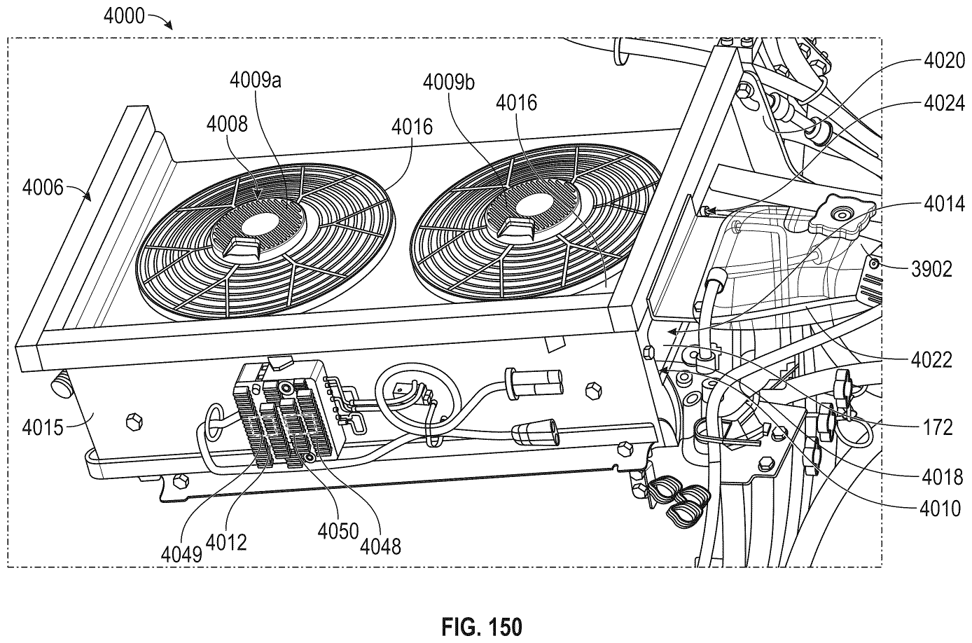

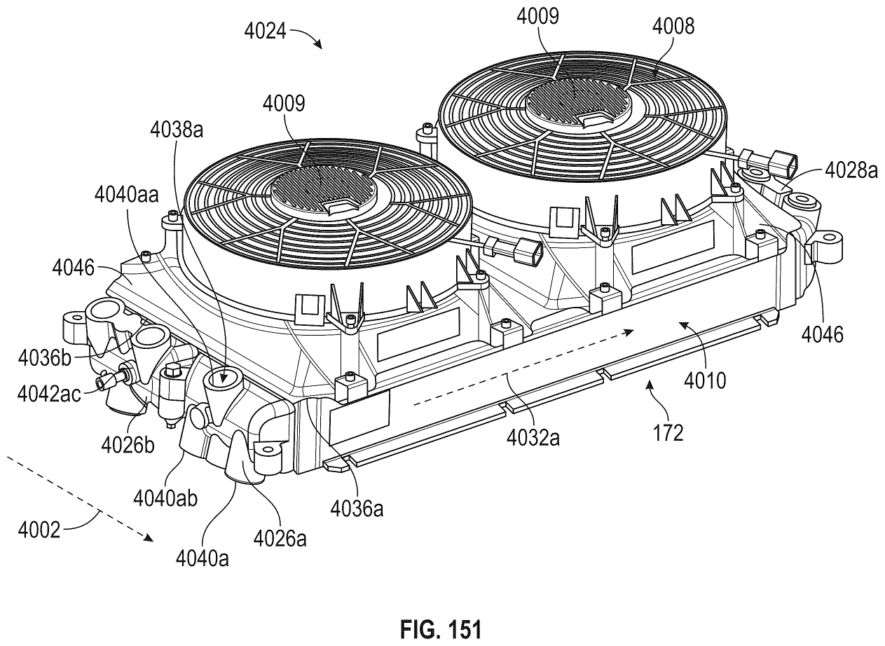

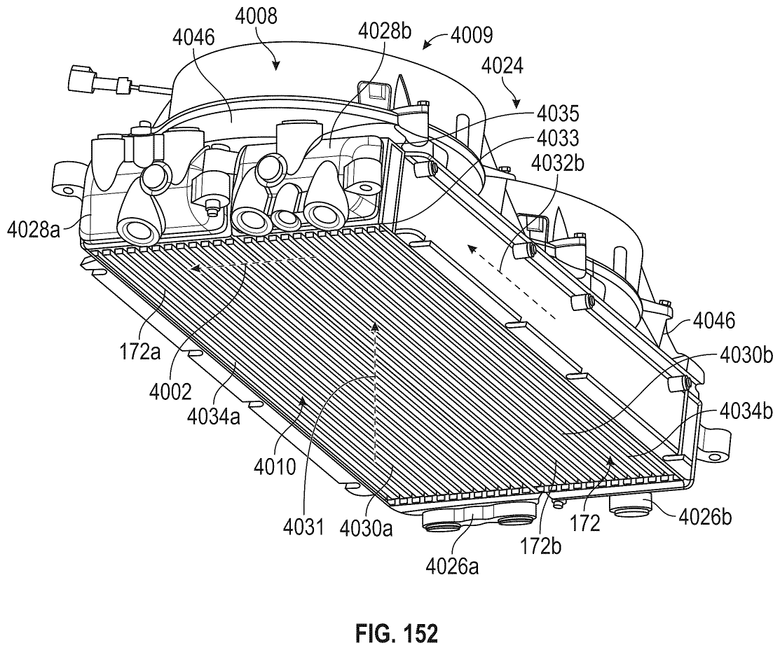

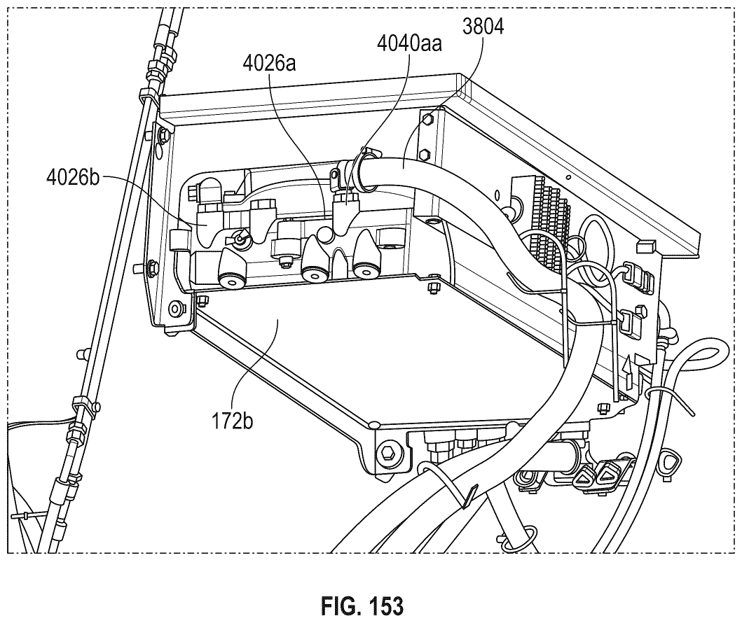

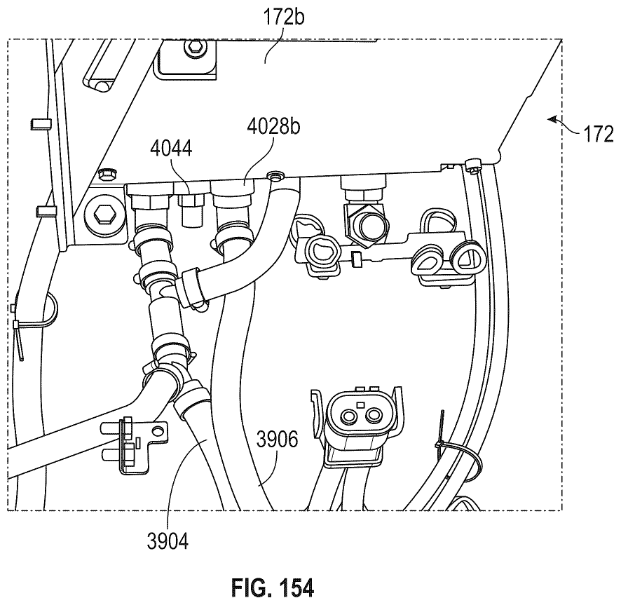

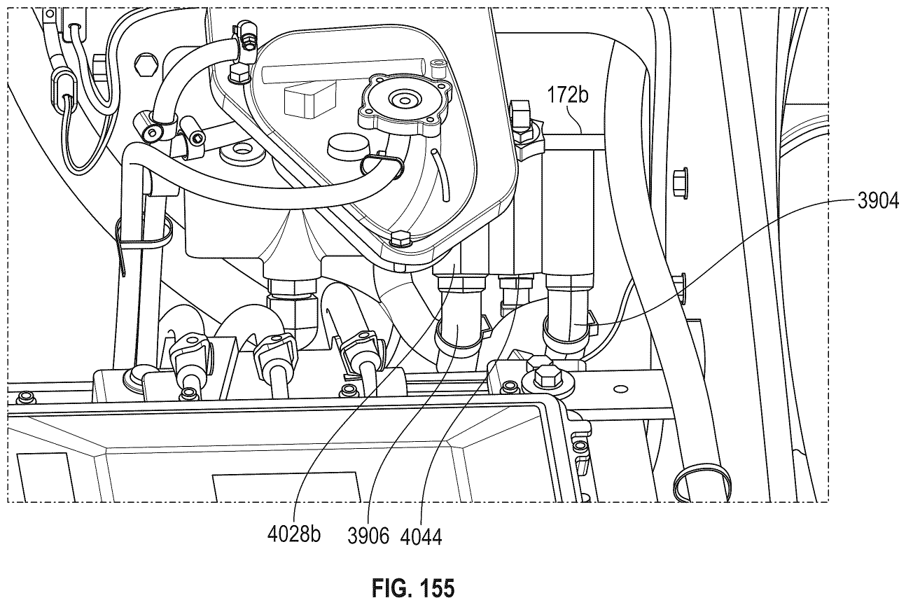

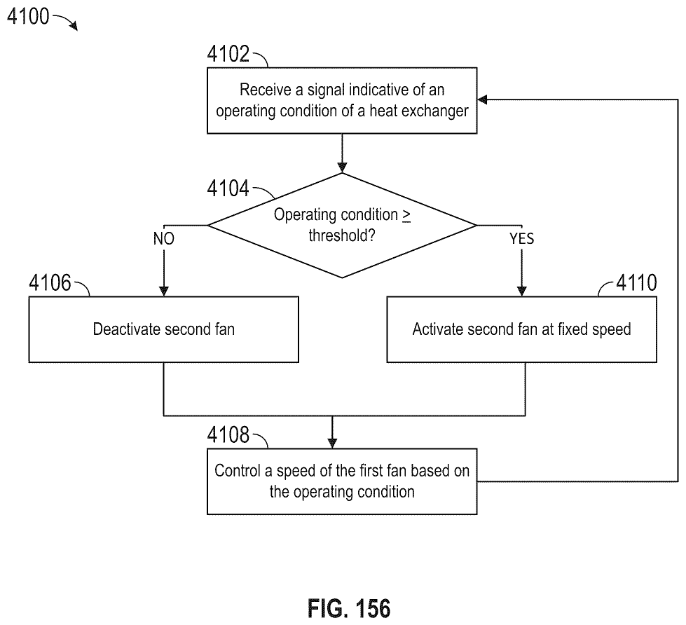

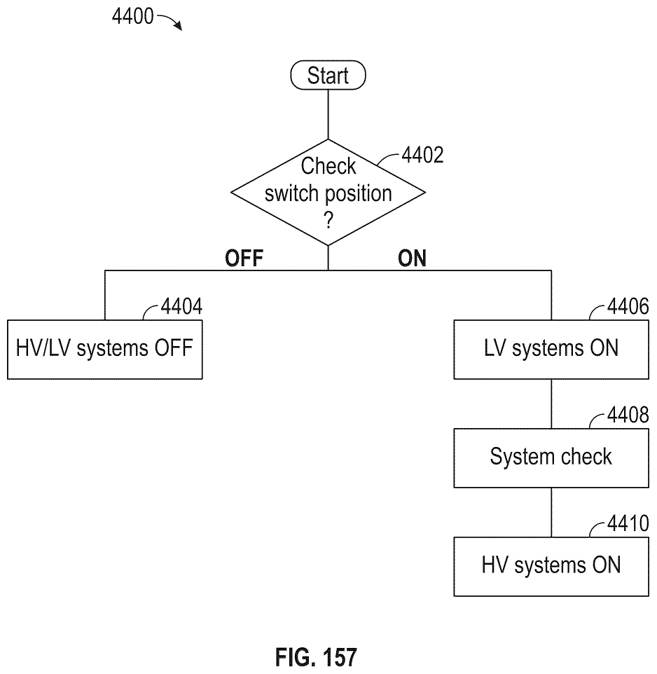

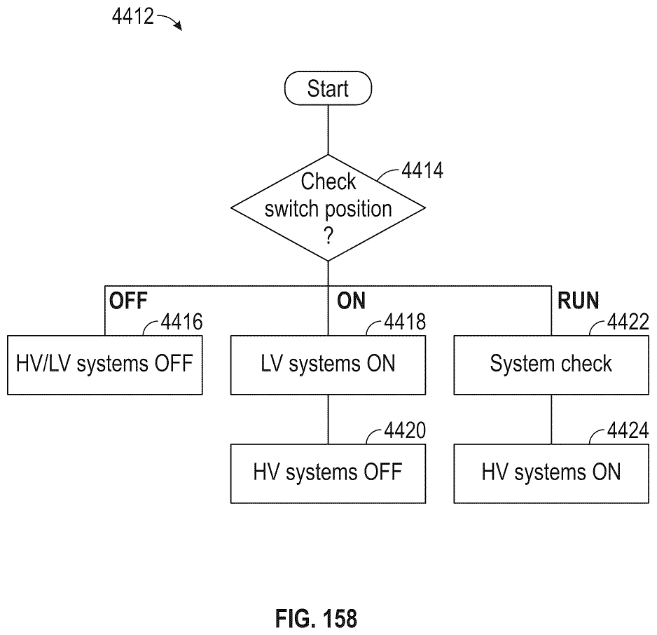

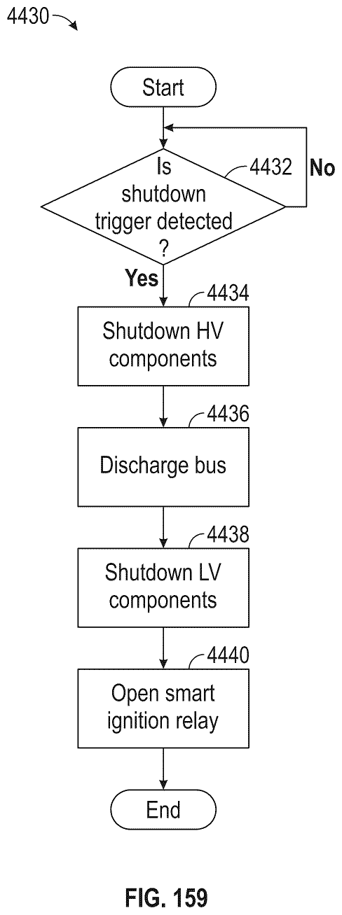

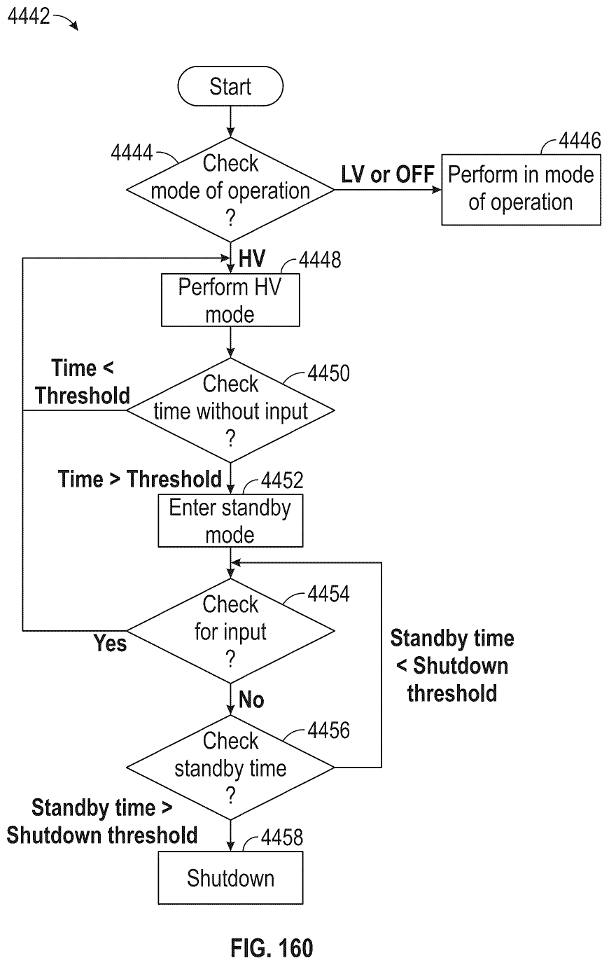

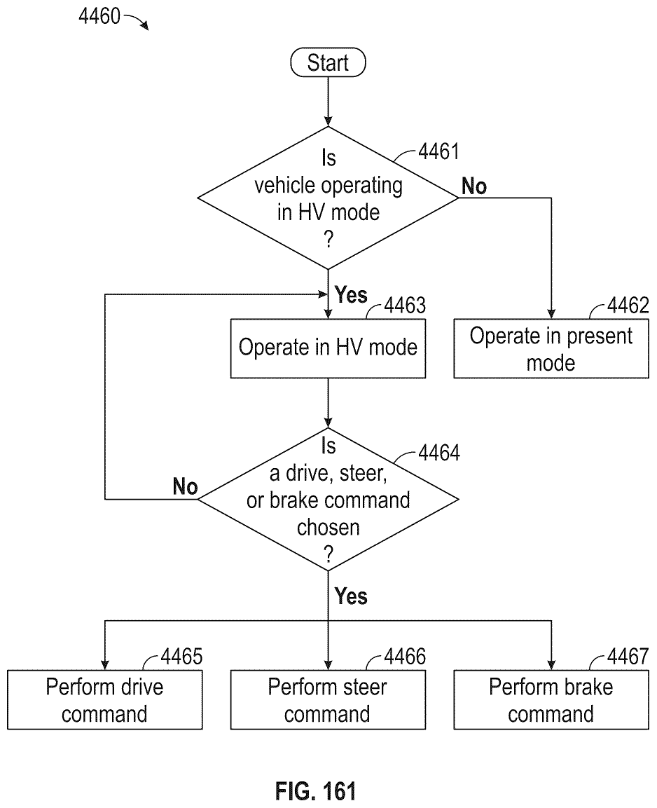

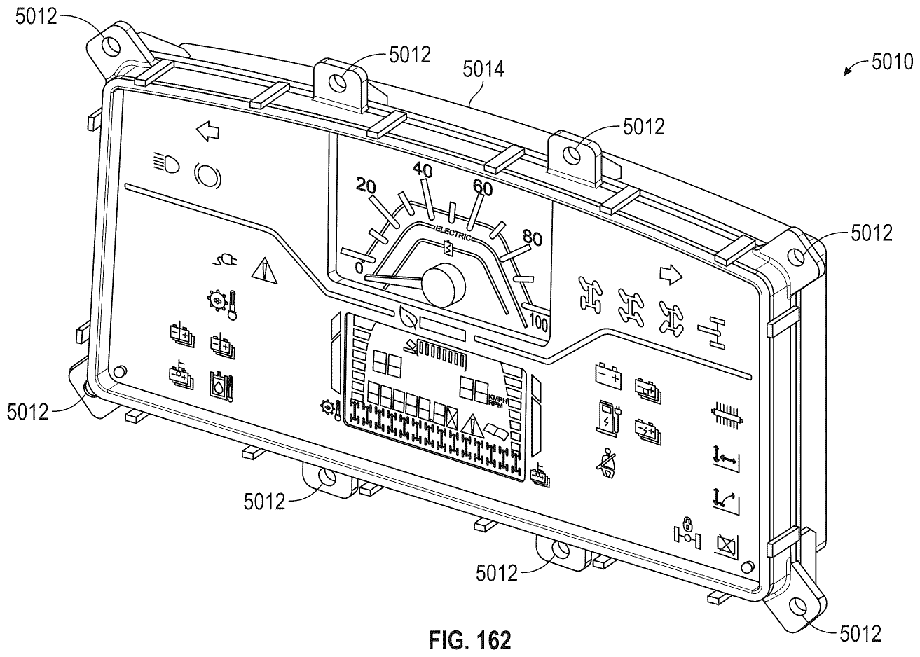

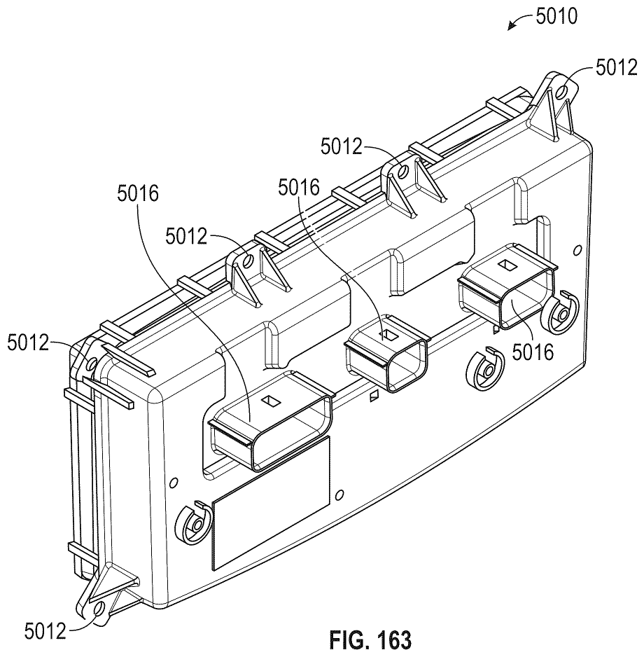

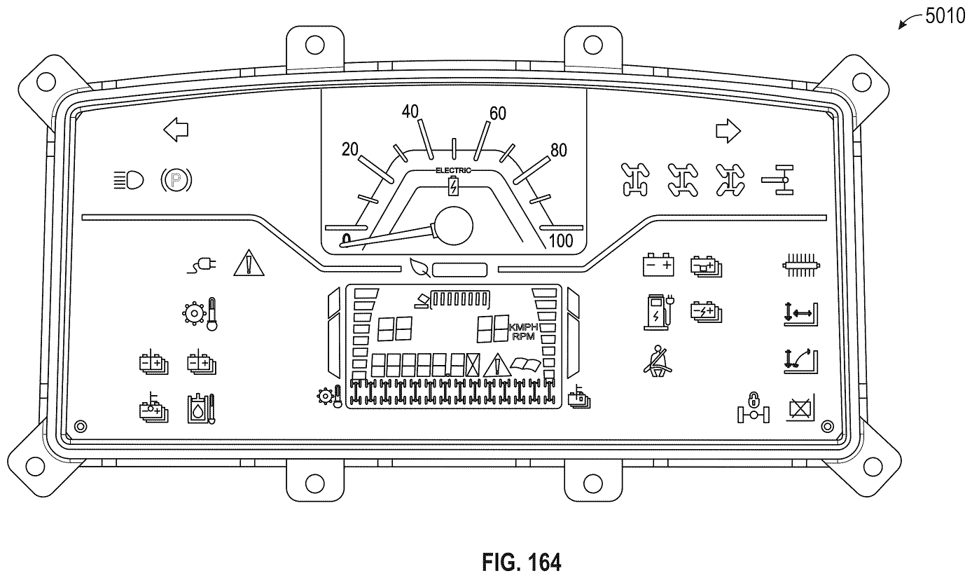

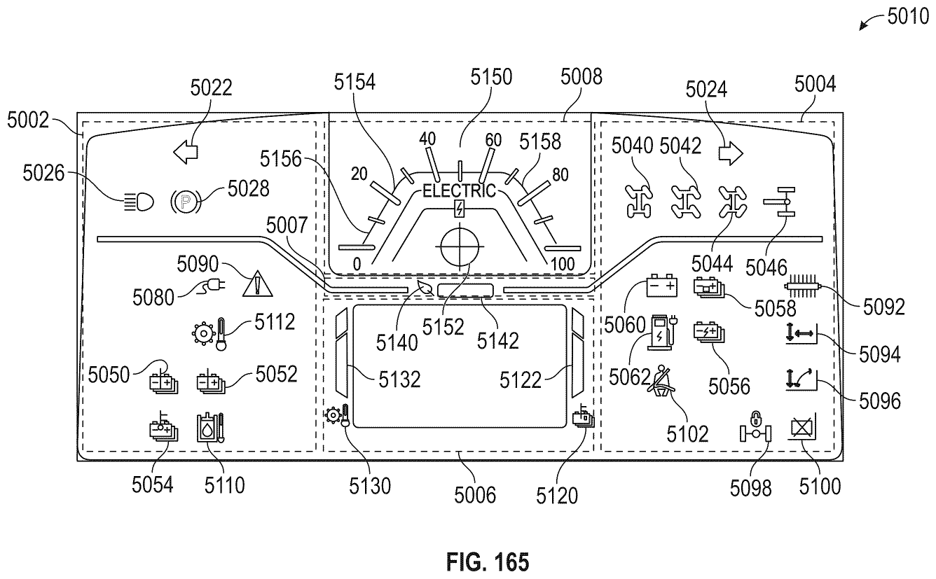

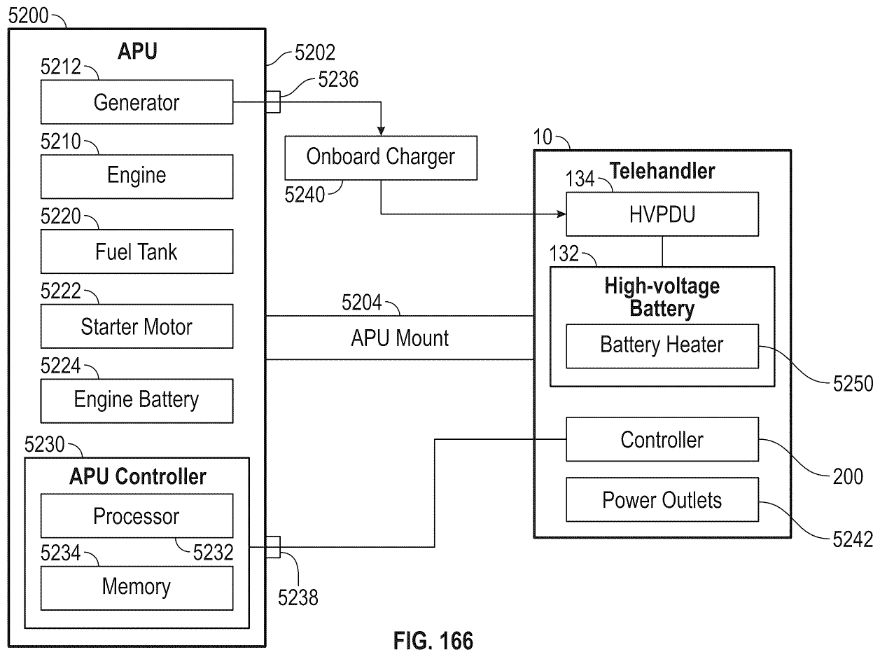

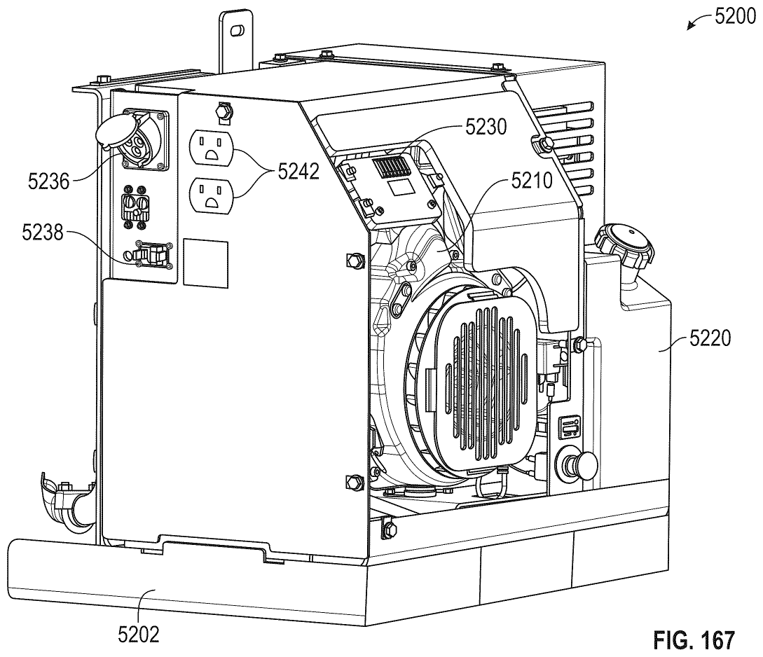

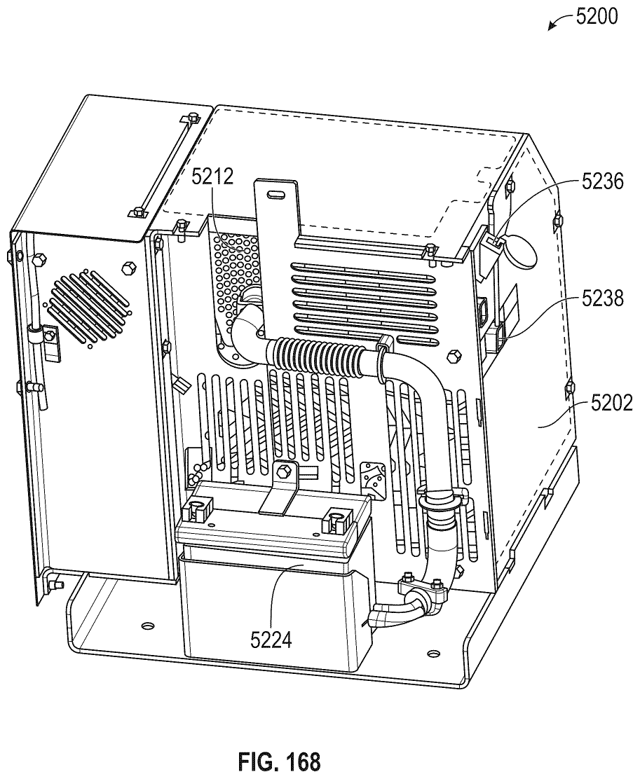

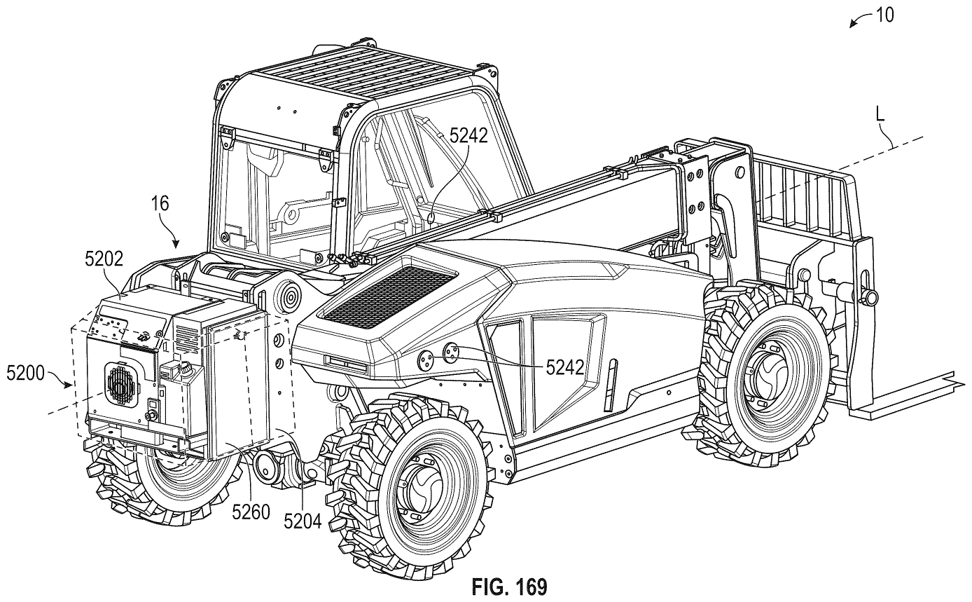

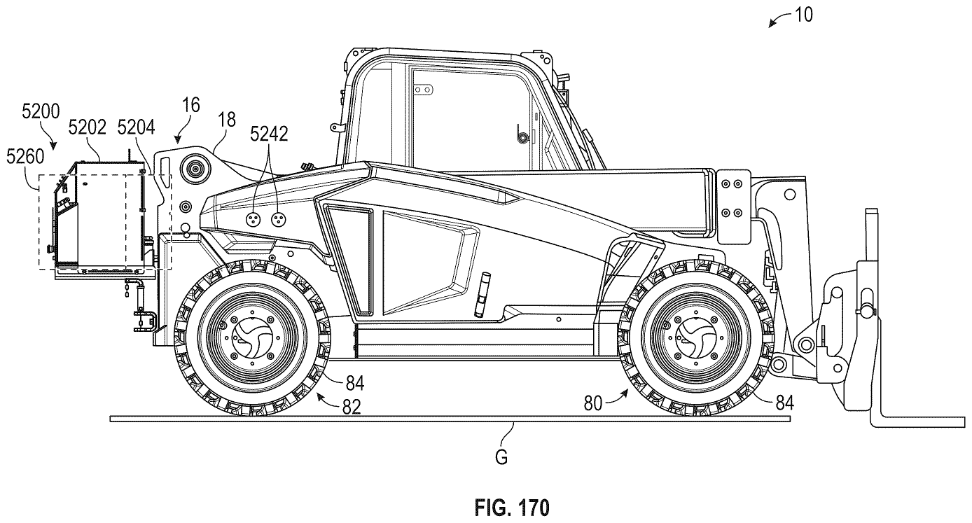

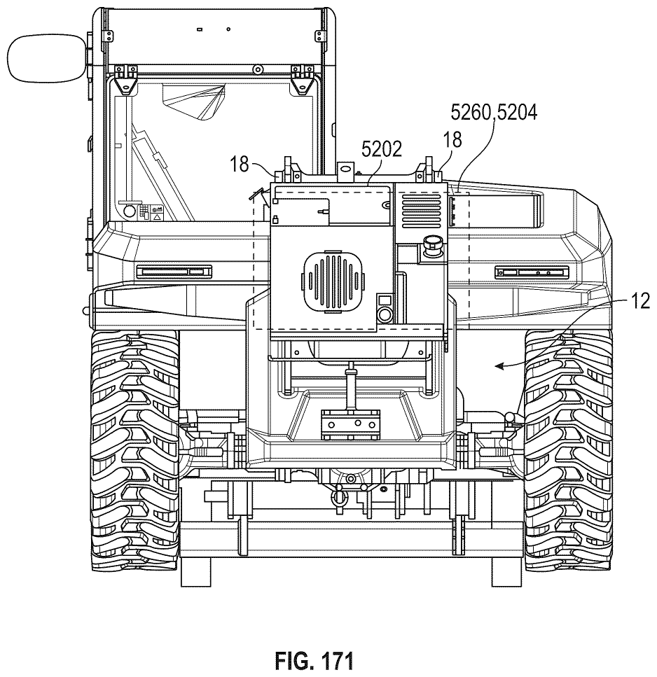

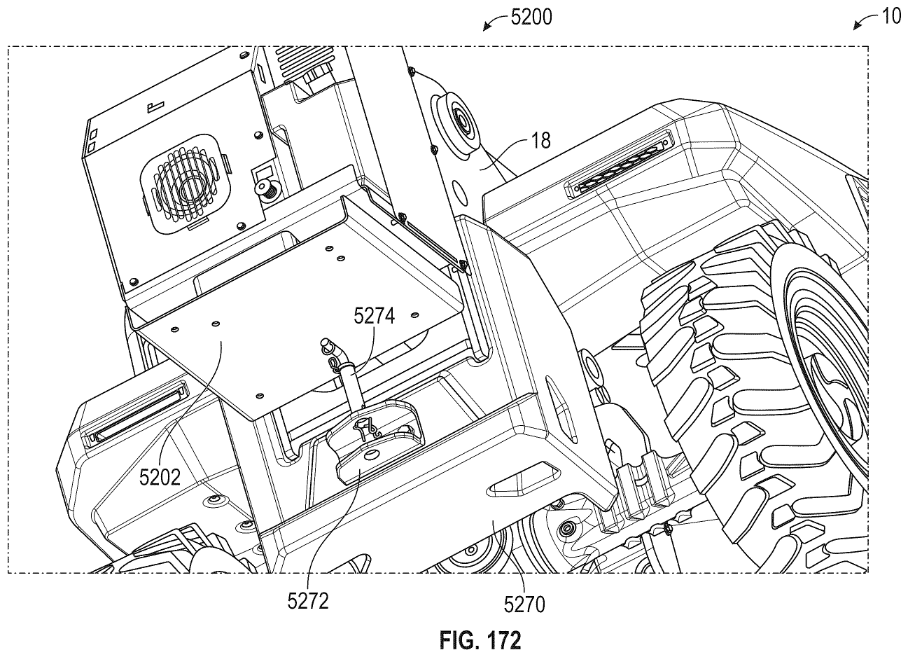

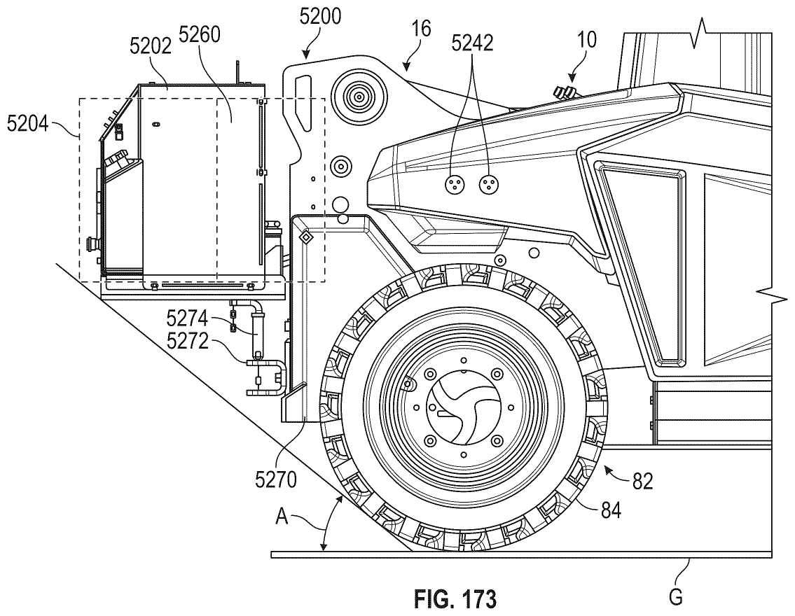

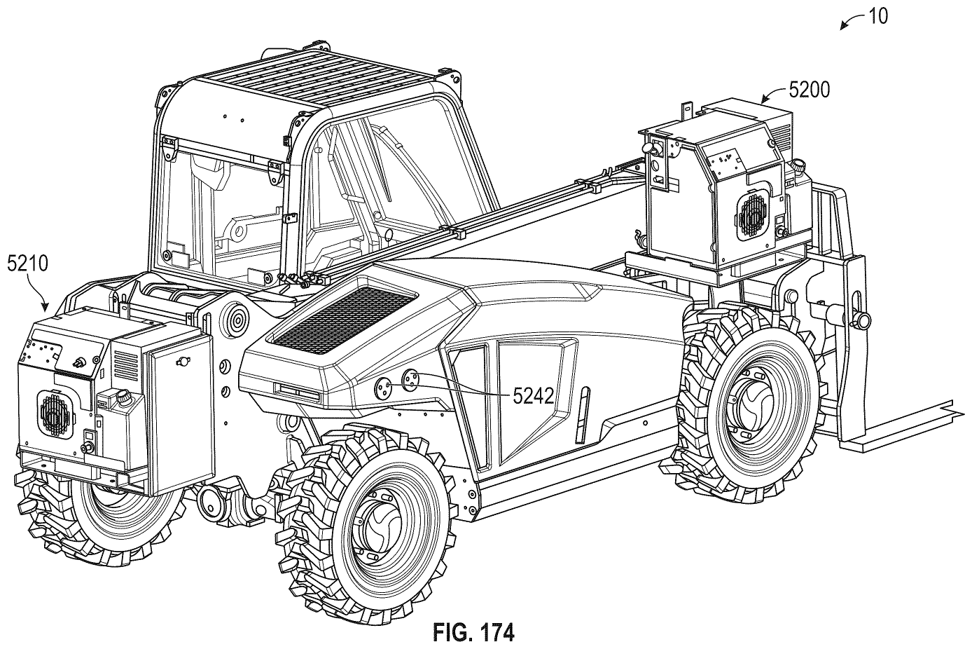

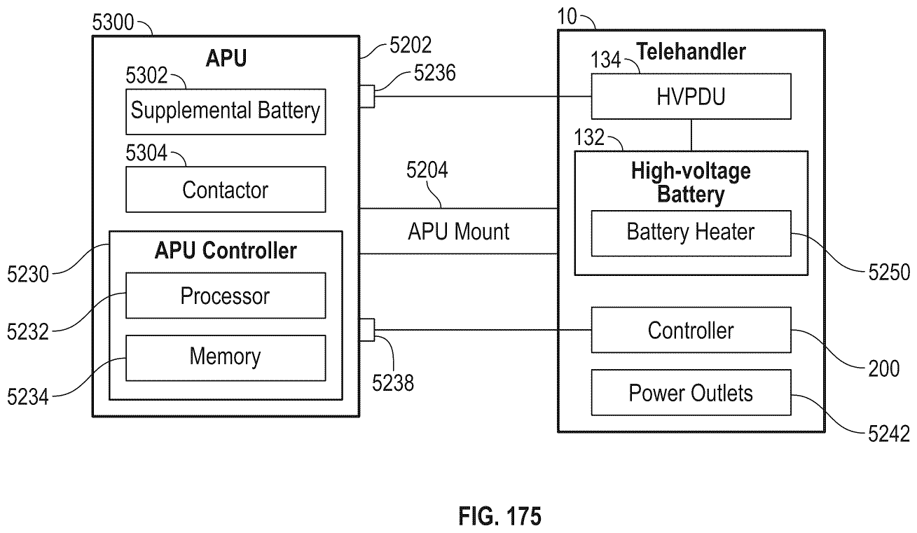

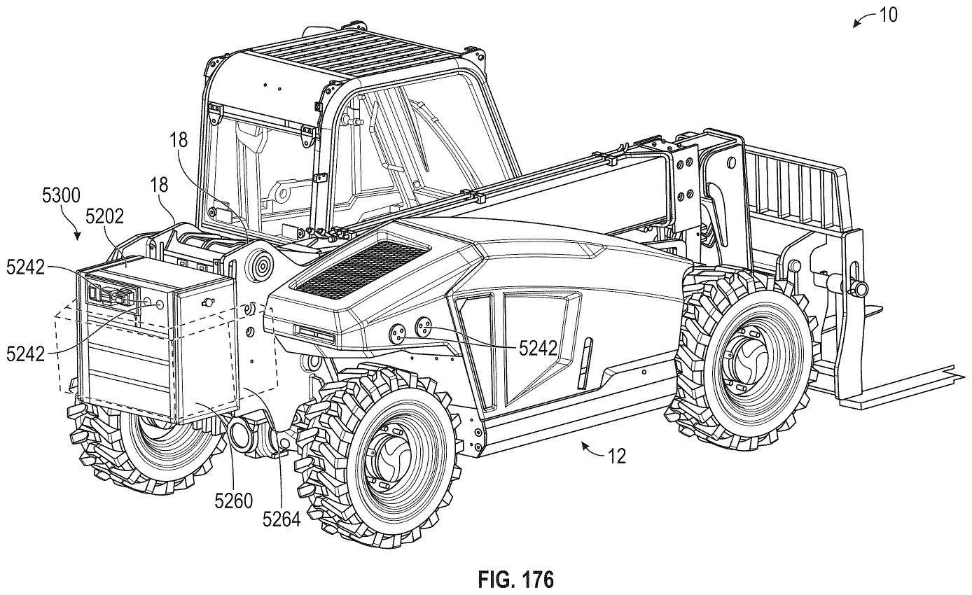

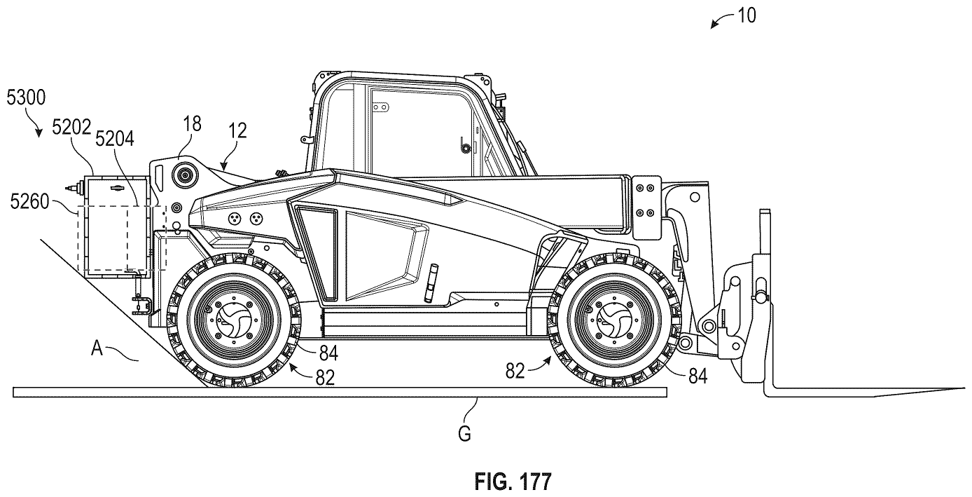

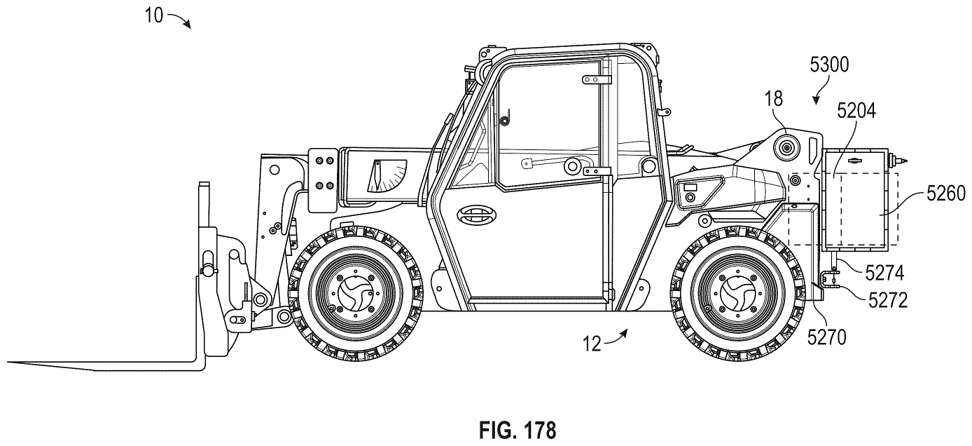

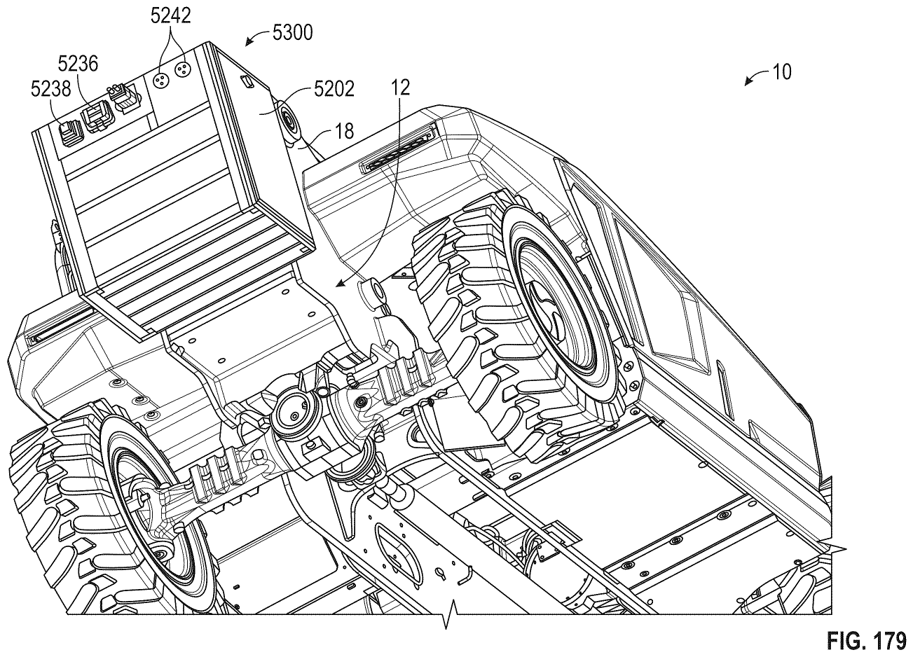

FIGS. 109-110 depict respective graphs that illustrate one or more characteristics of battery cells, according to some embodiments. As shown in FIG. 109, a graph 2100 (which corresponds to charging cycles) includes two vertical axes and one horizontal axis. The leftmost vertical axis is shown to correspond to minimum cell voltages (e.g., a voltage level for respective cells of a battery). The rightmost vertical axis is shown to correspond to pack voltage (e.g., a voltage level of the battery). The horizontal axis is shown to correspond to respective SoC values. The line with the small dashes (as shown in FIG. 109) may refer to or represent SoC vs cell voltage and the line with the larger dashes (as shown in FIG. 109) may refer to or represent SoC vs pack voltage.

As shown in FIG. 110, a graph 2102 (which corresponds to discharging cycles) includes two vertical axes and one horizontal axis. The leftmost vertical axis is shown to correspond to minimum cell voltages (e.g., a voltage level for respective cells of a battery). The rightmost vertical axis is shown to correspond to pack voltage (e.g., a voltage level of the battery). The horizontal axis is shown to correspond to respective SoC values. The line with the small dashes (as shown in FIG. 110) may refer to or represent SoC vs cell voltage and the line with the larger dashes (as shown in FIG. 110) may refer to or represent SoC vs pack voltage.

FIG. 111 depicts a block diagram of the high-voltage battery 132, according to some embodiments. As shown in FIG. 111, the high-voltage battery 132 includes a pre-charge circuit 2110, a relay 2112, a fuse 2114, a disconnect 2116, one or more battery cells (shown as battery cell stack 2118), a sense resistor 2120, a relay 2122, and a battery heater circuit 2124. In some embodiments, one or more components or elements of the high-voltage battery 132 may control or otherwise direct current to one or more of the pre-charge circuit 2110, the battery cell stack 2118, or the battery heater circuit 2124. For example, the disconnect 2116 may decouple or otherwise isolate the battery cell stack 2118 from one or more loads of the telehandler 10. As another example, the relay 2112 may couple or decouple the pre-charge circuit 2110. As another example, the relay 2122 may couple or decouple the battery heater circuit 2124.

In some embodiments, one or more of the relay 2112, the fuse 2114, the disconnect 2116, the sense resistor 2120, or the relay 2122 may drive operation of the battery heater circuit 2124. For example, an opening or closing the relay 2122 may result in the battery heater circuit 2124 providing heat to or otherwise warming the battery cell stack 2118. In some embodiments, at least one of the onboard chargers 152 or the battery cell stack 2118 may power or otherwise provide electrical energy for the battery heater circuit 2124. For example, the relay 2112 may electrically couple the battery heater circuit 2124 with the battery cell stack 2118 such that current flows from the battery cell stack 2118 to the battery heater circuit 2124. As another example, the relay 2122 may electrically couple the battery heater circuit 2124 with the onboard chargers 152 such that current may flow from the onboard chargers 152 and to the battery heater circuit 2124.

In some embodiments, the controller 200 may implement or otherwise execute one or more rules or rules based logic to facilitate operation or utilization of one or more power sources to provide energy to the battery heater circuit 2124. Stated otherwise, the controller 200 may implement logic to determine whether to (i) operate the battery heater circuit 2124 (e.g., produce heat) or (ii) utilize the onboard chargers 152 or the battery cell stack 2118 to power the battery heater circuit 2124. In some embodiments, the battery heater circuit 2124 may include one or more heating elements or filaments to produce or otherwise provide heat to the battery cell stack 2118. An exemplary table (shown below) is provided to illustrate some logic rules (which the controller 200 may implement) to control operation of the battery heater circuit 2124 and/or the onboard chargers 152.

| Temp. | SOC | | | | |
|---|---|---|---|---|---|
| (° C.) | 0% < SoC ≤ 5% | 5% < SoC < 10% | 10% < SoC < 20% | 10% < SoC < 20% | 10% < SoC < 20% |
| T ≤ −40 | Do not conduct charging or discharging | | | | |
| −40 < | Charger supplies heaters | | | | Cells supply heaters |
| T ≤ −25 | | | | | |
| −25 < | Charger supplies heaters | | | Cells supply heaters | |
| T ≤ −15 | | | | | |
| −15 < T ≤ 0 | Charger supplies heaters | | Cells supply heaters | | |
| 10 < T ≤ 15 | Charger supplies | Cells supply heaters | | | |
| | heaters | | | | |

| | |
|---|---|
| T ≥ 15 | No need to heat the cells |

In some embodiments, the pre-charge circuit 2110 may adjust the voltage level of the DC bus 2002. For example, the pre-charge circuit 2110 may provide voltage (to the DC bus 2002) to pre-charge or otherwise increase the voltage level of the DC bus 2002. In some embodiments, the pre-charge circuit 2110 may pre-charge the DC bus 2002 such that a voltage difference between the DC bus 2002 and the high-voltage battery 132 is decreased. Stated otherwise, the pre-charge circuit 2110 may increase the voltage level at the DC bus 2002 to prepare the DC bus 2002 to distribute power to one or more components or elements of the telehandler 10. As an example, the pre-charge circuit 2110 may increase the voltage level at the DC bus 2002 to prepare the DC bus 2002 to distribute power to one or more of the implement inverter 2007 or the drive inverter 2009.

### Stored Energy Response Steering System

As shown in FIGS. 5, 112, and 113, the hydraulic system 110 includes the implement motor 112, the implement pump 114, the steering pump 116, the reservoir 120, the control valves 122, and the accumulator 124. According to an exemplary embodiment, a pump displacement (e.g., volume per revolution) defined by the implement pump 114 is greater than a pump displacement defined by the steering pump 116. In the illustrated embodiment, the control valves 122 include a main control valve 2400 and a steering valve 2402. In general, the main control valve 2400 is configured to control a flow of fluid to and from various hydraulic functions on the telehandler 10. For example, the main control valve 2400 may include one or more valve sections, with each valve section including a control valve or spool valve that controls a flow of fluid to and from one or more hydraulic functions on the telehandler 10. The main control valve 2400 includes a lift section 2404, a tilt section 2406, an auxiliary section 2408, and a telescoping section 2410. The lift section 2404 is configured to control fluid flow to and from the lift actuator 70, the tilt section 2406 is configured to control fluid flow to and from a tilt actuator 2412, the auxiliary section 2408 is configured to control fluid flow to and from the implement actuator 74, and the telescoping section 2410 is configured to control fluid flow to and from the extension actuator 72. The steering valve 2402 is configured to control a flow of fluid to and from the steering actuators 100 and the reservoir 120, which controls a steering direction of the front axle assembly 80 and/or the rear axle assembly 82.

An implement supply pipe, conduit, or passageway, shown as implement supply line 2414 provides fluid communication between an outlet of the implement pump 114 and the main control valve 2400. In the illustrated embodiment, a supply check valve 2416 is arranged on the implement supply line 2414 between the implement pump 114 and the main control valve 2400. The supply check valve 2416 is configured to only allow fluid to flow in a direction from the implement pump 114 toward the main control valve 2400.

A steering supply pipe, conduit, or passageway, shown as steering supply line 2418 provides fluid communication between an outlet of the steering pump 116 and a steering node 2420. A check valve 2428 is arranged on the steering supply line 2418 between the steering pump 116 and the steering node 2420. The check valve 2428 is configured to only allow fluid flow in a direction from the steering pump 116 to the steering node 2420, which prevents fluid flow in a direction from the accumulator 124 to the steering pump 116. The steering node 2420 is formed at an intersection between the steering supply line 2418, a steering pipe, conduit, or passageway, shown as steering line 2422, and an accumulator pipe, conduit, or passageway, shown as accumulator line 2424. The steering line 2422 provides fluid communication between the steering node 2420 and the steering valve 2402.

A priority valve 2430 is arranged on the steering line 2422 between the steering node 2420 and the steering valve 2402. In some embodiments, the priority valve 2430 is a proportional valve that is movable between a first position where fluid communication is provided between the steering node 2420 and the steering valve 2402 (position shown in FIG. 113), a second position where fluid communication is provided between the steering node 2420 and the accumulator line 2424 (actuated down from the position shown in FIG. 113), and an infinite number of positions between the fust position and the second position. The priority valve 2430 is biased into the first position by a spring, and is selectively movable between the first position and the second position, so that the steering valve 2402 is prioritized with fluid flow and then excess fluid flow is provided to the accumulator line 2424, which charges the accumulator 124 (e.g., increases a charge pressure of the accumulator 124). The balance between providing fluid flow to the steering valve 2402 or the accumulator 124 is achieved by a pressure differential between a pressure in a steering load sense line 2432 that acts on a first side of the priority valve 2430 and a pressure in a pilot line 2434 that acts on a second side of the priority valve 2430. The steering load sense line 2432 is in fluid communication with the steering valve 2402. The pilot line 2434 communicates a pressure downstream of the priority valve 2430 to the second side of the priority valve 2430. If there is a steering demand, e.g., communicated from the user interface 34 (e.g., a joystick, a steering wheel, etc.), the pressure in the steering load sense line 2432 increases and the priority valve 2430 is biased toward the fust position. Alternatively, when there is no steering demand (e.g., no input to the steering valve 2402 from the user interface 34), the pressure in the pilot line 2434 may overcome the force of the spring bias and move the priority valve 2430 toward the second position, which provides fluid communication between the steering supply line 2418 (and the steering pump 116) and the accumulator line 2424 (and the accumulator 124). In this way, for example, the steering pump 116 may be used to both supply fluid flow to the steering valve 2402 and to the accumulator 124, depending on the steering demand and the state of the priority valve 2430.

During operation, both the steering pump 116 and the accumulator 124 may be used to supply fluid flow to the priority valve 2430 and then to the steering valve 2402 to ensure that the steering valve 2402 is prioritized during operation and receives fluid flow quickly in response to an operator steering demand. For example, when a charge pressure within the accumulator 124 is above a pressure threshold, the accumulator 124 may provide fluid flow along the accumulator line 2424, through a check valve 2436, to an inlet side of the priority valve 2430, and the priority valve 2430 provides fluid communication to the steering valve 2402 to facilitate steering operation of the telehandler 10. The check valve 2436 is configured to only allow fluid flow in a direction along the accumulator line 2424 from the accumulator 124 toward the steering node 2420. Accordingly, the combination of the check valve 2428 and the check valve 2436 forces fluid flow from the steering pump 116 through the priority valve 2430, prior to reaching the accumulator 124, and forces fluid flow from the accumulator 124 through the priority valve 2430, which maintains the priority of the steering valve 2402 regardless of what is supplying fluid flow to the steering valve 2402.

By having the fluid energy stored in the accumulator 124, the hydraulic system 110 is able to quickly service the steering demand, for example, by not having to wait for the steering pump 116 to ramp up and supply fluid flow to the steering valve 2402. And the inclusion of the accumulator 124 allows a speed of the implement motor 112 to be modulated or even turned off during some operating conditions, which prevents having to continuously run the implement motor 112 and reduces the overall power demand from the steering operation in the hydraulic system 110. For example, once the accumulator 124 is fully charged by the steering pump 116, the accumulator 124 is above the pressure threshold and able to quickly provide fluid flow to the steering valve 2402, in response to a steering demand, so the speed of the implement motor 112 may be modulated (e.g., reduced) or even turned off (e.g., if there is no demand from the main control valve 2400). In instances where the charge pressure of the accumulator 124 is below the pressure threshold, or when the charge pressure within the accumulator 124 is lower than a steering demand required by the steering valve 2402, the implement motor 112 drives the steering pump 116 to supply fluid flow to the priority valve 2430 and then to the steering valve 2402. Once the steering demand is removed, the steering pump 116 may continue to run and increase the charge pressure of the accumulator 124.

As shown in FIGS. 5 and 112, 113, and 116, the hydraulic system 110 includes one or more sensors that are configured to sense one or more operating pressures within the hydraulic system 110, which may be used to control the implement motor 112 and both the implement pump 114 and the steering pump 116 coupled thereto. For example, the hydraulic system 110 includes an accumulator pressure sensor 2438 in fluid communication with accumulator line 2424. In some embodiments, the accumulator pressure sensor 2438 is connected to the accumulator line 2424 in between the accumulator 124 and the check valve 2436. Regardless of the particular position of the accumulator pressure sensor 2438, the accumulator pressure sensor 2438 is configured to sense the charge pressure within the accumulator 124.

A supply pressure sensor 2440 is in fluid communication with the steering supply line 2418 and is configured to sense a supply pressure within the steering supply line 2418. In general, the supply pressure provided by the steering pump 116 within the steering supply line 2418 is governed by a supply relief valve 2442, which limits the maximum pressure within the steering supply line 2418 to be below a supply pressure threshold. The supply pressure threshold set by the supply relief valve 2442 is greater than a pre-charge pressure of the accumulator 124, so that braking and parking brake circuits within the hydraulic system 110 receive fluid immediately upon delivery of fluid from the implement pump 114 or the steering pump 116 when starting from a completely discharged state. A steering load sense pressure sensor 2444 is in fluid communication with the steering load sense line 2432 and is configured to sense a steering load sense pressure within the steering load sense line 2432.

The accumulator pressure sensor 2438, the supply pressure sensor 2440, and the steering load sense pressure sensor 2444 are in communication with the controller 200 (see, e.g., FIG. 116). The controller 200 is further in communication with the user interface 34 (e.g., a joystick that generates signals, which are received by the controller 200 and control operation of the main control valve 2400 in response to movement by an operator), the implement motor 112, the main control valve 2400, and the steering valve 2402. For example, each of the lift section 2404, the tilt section 2406, the auxiliary section 2408, the telescoping section 2410, and the steering valve 2402 may include or be in the form of an electrohydraulic or solenoid-operated control valve that is selectively movable in response to the controller 200 energizing or deenergizing one or more solenoids coupled to the control valves, which controls a flow of fluid to and from the respective actuators fluidly coupled thereto.

In some embodiments, the steering valve 2402 may be electronically controlled by the controller 200. In some embodiments, the steering valve 2402 is manually controlled via a steering wheel of the user interface 34, and the controller 200 controls the implement motor 112 based on signals from the accumulator pressure sensor 2438 and the steering load sense pressure sensor 2444. The signal from the accumulator pressure sensor 2438 may be sensed by the controller 200 and used to control a speed and/or operational state (e.g., on/off) of the implement motor 112. For example, when the accumulator pressure sensor 2438 measures a pressure that is below the threshold pressure, the controller 200 may instruct the implement motor 112 to rotate at a particular speed to provide fluid flow from the steering pump 116 to the accumulator 124 and increase the charge pressure of the accumulator 124. While the steering pump 116 is charging the accumulator 124, the priority valve 2430 allows the steering demand to remain prioritized by allowing fluid flow from the steering pump 116 to the steering valve 2402 in response to the pressure in the steering load sense line 2432 increasing and moving the priority valve 2430 toward the first position. Once the accumulator 124 is charged above the pressure threshold, the accumulator 124 may remain as the primary fluid source for the steering demand, until the charge pressure again drops below the pressure threshold, which enables the speed of the implement motor 112 to be modulated (e.g., not remain permanently on to service the steering demand) or shut down without sacrificing the flow priority required by the steering valve 2402.

In some embodiments, the controller 200 may sense the pressure from the steering load sense pressure sensor 2444 and compare that pressure to the pressure sensed by the accumulator pressure sensor 2438 to determine when to instruct the implement motor 112 to drive the steering pump 116 and supply fluid flow from the steering pump 116 to the steering line 2422. For example, if a pressure of the accumulator pressure sensor 2438 drops below a pressure of the steering load sense pressure sensor 2444, that may be an indication that the steering demand is increasing and the charge pressure of the accumulator 124 is falling below the pressure threshold. In response, the controller 200 may instruct the implement motor 112 to drive the steering pump 116 and supply fluid flow to supplement fluid flow from the accumulator 124 and satisfy the steering demand to the steering valve 2402. The steering pump 116 may continue to supply fluid flow to the steering valve 2402 until the steering demand is removed, and then the priority valve 2430 may move toward the second position so that the accumulator 124 is charged above the pressure threshold.

As described herein, in some embodiments, the steering pump 116 may include a dedicated electric motor that drives the steering pump 116 independent of the implement pump 114 (e.g., the steering pump 116 and the implement pump 114 are independently driven by separate electric motors). In these embodiments, the electric motor driving the steering pump 116 may be shutdown independent of the implement motor 112 and, therefore, the implement pump 114 is not required to be driven when the steering pump 116 supplies fluid flow to the steering valve 2402 or to the accumulator 124, which may further reduce the energy savings of the hydraulic system 110 via incorporation of the accumulator 124.

### Combined Steering and Implement Flow

In general, the hydraulic system 110 may include one or more switching valves that enable the implement pump 114 to provide fluid flow to the steering circuit (e.g., to the accumulator 124 and to the steering valve 2402) and the steering pump 116 to provide fluid flow to the implement circuit (e.g., to the main control valve 2400). As shown in FIGS. 112 and 113, the hydraulic system 110 may include a first switching valve 2450, a second switching valve 2452 arranged in series with the fust switching valve 2450, and a load sense valve 2454 (as described herein, in some embodiments, the load sense valve 2454 may be omitted as shown in FIG. 114). The first switching valve 2450 and the second switching valve 2452 are arranged on a connecting line 2456 that extends between and is in fluid communication with the implement supply line 2414 (and the implement pump 114), the main control valve 2400, and the accumulator line 2424. According to the embodiment illustrated in FIGS. 112 and 113, the load sense valve 2454 is arranged on an implement load sense line 2458 that provides fluid communication from a location between the first switching valve 2450 and the second switching valve 2452 to the main control valve 2400.

According to an exemplary embodiment, the first switching valve 2450 is selectively movable between a first position and a second position by a solenoid. In the first position, the first switching valve 2450 allows fluid flow in a direction from the implement supply line 2414 to the second switching valve 2452 and prevents fluid flow in a direction from the second switching valve 2452 to the implement supply line 2414 (e.g., fluid flow is inhibited between the accumulator 124 and the main control valve 2400 via a check valve arranged within the first switching valve 2450). In the second position, the first switching valve 2450 allows fluid flow bi-directionally through the first switching valve 2450. According to an exemplary embodiment, the second switching valve 2452 is selectively movable between a first position and a second position by a solenoid. In the first position, the second switching valve 2452 allows fluid flow bi-directionally through the second switching valve 2452. In the second position, the second switching valve 2452 allows fluid flow in a direction from the accumulator line 2424 to the first switching valve 2450, and prevents fluid flow in a direction from the fust switching valve 2450 to the accumulator line 2424 (e.g., fluid flow is inhibited between the implement pump 114 and the accumulator 124 via a check valve within the second switching valve 2452). Accordingly, the first switching valve 2450 allows fluid flow toward the second switching valve 2452 in both the first position and the second position, so the state of the second switching valve 2452 determines when fluid flow is allowed between the implement supply line 2414 and the accumulator line 2424. For example, if the second switching valve 2452 is energized and the solenoid actuates the second switching valve 2452 into the second position, fluid flow is blocked between the implement supply line 2414 and the accumulator line 2424, which blocks fluid flow between the implement pump 114 and the accumulator 124. If the second switching valve 2452 is deenergized and is therefore biased into the first position, fluid flow is allowed between the implement supply line 2414 and the accumulator line 2424, which allows fluid flow between the implement pump 114 and the accumulator 124, when a pressure within the main control valve 2400 and the implement supply line 2414 is greater than or equal to a pressure within the accumulator 124. In this way, for example, the implement pump 114 may be used to charge the accumulator 124 and thereby supply fluid flow to the steering valve 2402 and maintain steering functionality of the telehandler 10.

According to the exemplary embodiment shown in FIGS. 112 and 113, the load sense valve 2454 is configured to generate a load sense signal in the implement load sense line 2458, which is communicated to the main control valve 2400 and increases a pressure within the main control valve 2400 whenever the pressure within the accumulator 124 is lower than a load sense pressure threshold. For example, when the second switching valve 2452 is in the first position and fluid communication is provided between the implement supply line 2414 and the accumulator line 2424, a pilot line connected upstream of the load sense valve 2454 is configured to overcome a spring force and bias the load sense valve 2454 into a first or closed position when the pressure within the accumulator 124 is above the load sense pressure threshold. In the closed position, fluid flow is prevented between the connecting line 2456 and the main control valve 2400 along the implement load sense line 2458. When the pressure of the accumulator 124 is less than the load sense pressure threshold, the spring force overcomes the force of the pressure within the pilot line and the second switching valve 2452 moves to a second or open position, where fluid flow is provided between the connecting line 2456 and the load sense valve 2454, which provides fluid communication between the implement supply line 2414 and the implement load sense line 2458. The fluid communication between the implement supply line 2414 and the implement load sense line 2458 provides fluid communication between the implement pump 114 and the implement load sense line 2458, which generates the signal in the implement load sense line 2458 that results in increased pressure output from the implement pump 114 and increases the pressure within the main control valve 2400 and the implement supply line 2414. The increased pressure within the implement supply line 2414, provided by the implement pump 114, supplies fluid flow to the accumulator 124 (e.g., to charge the accumulator 124) and to the steering valve 2402 (e.g., fluid communication is provided between the implement supply line 2414 and the steering node 2420). According to an exemplary embodiment, the load sense pressure threshold defined by the load sense valve 2454 may be greater than a pre-charge pressure of the accumulator 124 by a predefined margin.

With continued reference to FIGS. 112 and 113, the first switching valve 2450 and the second switching valve 2452 may also be used to allow fluid flow between the steering pump 116 and/or the accumulator 124, and the main control valve 2400. For example, when the second switching valve 2452 is deenergized and in the first position and the first switching valve 2450 is energized and in the second position, fluid communication is provided between the accumulator line 2424 and the connecting line 2456, and thereby to the main control valve 2400. Accordingly, the fluid energy stored within the accumulator 124 may be used to operate the main control valve 2400 and the implement functions controlled thereby, and/or to supplement the fluid flow provided by the implement pump 114. The steering pump 116 may also provide fluid flow to the accumulator line 2424 and the connecting line 2456, and thereby to the main control valve 2400, via the priority valve 2430 moving to the second position (e.g., when there is no steering demand applied to the steering valve 2402).

The first switching valve 2450 and the second switching valve 2452 enable the different circuits within the hydraulic system 110 (e.g., the steering circuit and the implement circuit) to supply fluid flow to each other in addition to their primary functions, which adds redundancy to the hydraulic system 110. According to an exemplary embodiment, the first switching valve 2450 and the second switching valve 2452 are in communication with the controller 200, and the controller 200 is configured to selectively energize and deenergize the solenoids of the first switching valve 2450 and the second switching valve 2452. For example, if a pressure measured by the accumulator pressure sensor 2438 is less than a low pressure threshold, and the controller 200 does not see the pressure measured by the accumulator pressure sensor 2438 increase within a predetermined period of time, the controller 200 may instruct the second switching valve 2452 to deenergize and move to the first position, so that the implement pump 114 is allowed to quickly charge the accumulator 124 and maintain steering functionality. Alternatively, if there is no steering demand and the charge pressure of the accumulator 124 is above the threshold pressure or is full, the controller 200 may instruct the first switching valve 2450 to energize and move to the second position and the second switching valve 2452 to deenergize and move to the first position, so that the accumulator 124 and/or the steering pump 116 are allowed to provide fluid flow to the main control valve 2400.

As shown in FIG. 114, the hydraulic system 110 may not include the load sense valve 2454 and the functionality provided thereby may be removed from the system.

As shown in FIG. 115, the hydraulic system 110 includes the first switching valve 2450 and the second switching valve is in the form of a proportional valve (e.g., movable to an infinite number of positions). Specifically the hydraulic system 110 includes a second switching valve 2460 arranged on the connecting line 2456 in series with the first switching valve 2450, and a pressure compensation element 2462 arranged on the connecting line 2456 between the first switching valve 2450 and the second switching valve 2452. In the illustrated embodiment, the second switching valve 2460 is selectively movable between a first position, a second position, and an infinite number of positions between the first position and the second position by a solenoid (e.g., a proportional solenoid). In the first position, the second switching valve 2460 prevents fluid flow through the second switching valve 2460 (e.g., fluid communication is inhibited between the implement supply line 2414 (and the main control valve 2400) and the accumulator line 2424). In the second position, the second switching valve 2460 allows fluid flow between the accumulator line 2424 and the first switching valve 2450 (e.g., fluid flow through the second switching valve 2452 and along the connecting line 2456 in either direction). According to an exemplary embodiment, the second switching valve 2460 includes a spool that increases a flow area through the second switching valve 2460 as the second switching valve 2460 is moved from the first position toward the second position. In the illustrated embodiment, the second switching valve 2460 is biased into the first position by a spring.

According to an exemplary embodiment, the pressure compensation element 2462 is in the form of a spool or variable orifice that varies a flow area through the pressure compensation element 2462 and stabilizes a pressure drop across the second switching valve 2460. Specifically, a first pilot line is connected between a first side of the pressure compensation element 2462 a location between the second switching valve 2460 and the pressure compensation element 2462. A second pilot line is connected between a second side of the pressure compensation element 2462 and a location between the second switching valve 2460 and the accumulator line 2424. In this way, for example, the first pilot line and the second pilot line are connected to opposing sides of the second switching valve 2460 so that the pressure drop across the second switching valve 2460 acts on the pressure compensation element 2462. A spring is biased against the first side of the pressure compensation element 2462. With the pressure drop of the second switching valve 2460 acting on the pressure compensation element 2462, the pressure compensation element 2462 adjusts the flow area along the connecting line 2456 to maintain (e.g., keep approximately constant) the pressure drop across the second switching valve 2460, which stabilizes the flow rate along the connecting line 2456, for example, in response to changes in flow demand from the main control valve 2400.

In general, including the second switching valve 2460 and the pressure compensation element 2462 in the hydraulic system 110 enables proportional flow control that includes pressure compensation. The second switching valve 2460 is in communication with the controller 200 (e.g., with the solenoid of the second switching valve 2460), and the proportional flow control provided by the second switching valve 2460 enables the controller 200 to regulate the flow delivery from the steering pump 116 portion of the circuit (e.g., fluid flow from the steering pump 116 and/or the accumulator 124) into the main control valve 2400 portion of the circuit. For example, the controller 200 may regulate (e.g., control a position between the first position and the second position) the second switching valve 2460 to maintain the charge pressure of the accumulator 124 by opening the second switching valve 2460 (e.g., actuating toward the second position) to deliver a particular amount of fluid flow being generated by the steering pump 116 at any given time. Additionally, the controller 200 may regulate the second switching valve 2460 to provide more or less fluid flow therethrough and thereby regulate the charge pressure of the accumulator 124 between variable discharge, constant charge, or increase of charge rate. In the illustrated embodiment, the pressure compensation of the second switching valve 2460 is achieved through a discrete hydromechanical device (i.e., the pressure compensation element 2462). In some embodiments, the controller 200 may include active control system algorithms using pressure feedback and variable opening of the second switching valve 2460 to achieve pressure compensation. Further, the inclusion of the second switching valve 2460 and the pressure compensation element 2462 improve the practical ability of the hydraulic system 110 to save energy by ensuring the stored energy within the accumulator 124 is not unnecessarily ‘dumped’ over the main control valve 2400 when implement functions (e.g., the implement actuator 74) are in use.

In some embodiments, the proportional flow and pressure compensation provided by the second switching valve 2460 and the pressure compensation element 2462 may be achieved at a different location within the hydraulic system 110. For example, the first switching valve 2450 may be in the form of a proportional valve and the pilot lines of the pressure compensation element 2462 may sense the pressure drop across the first switching valve 2450. Alternatively, a proportional valve (e.g., similar to the second switching valve 2460) may be added to the hydraulic system 110 to a location between the accumulator 124 and the main control valve 2400, and the design of the first switching valve 2450 and the second switching valve 2452 may be similar to the embodiment shown in FIGS. 112 and 113.

### Back Pressure Valve for Heat Exchanger

As shown in FIGS. 5, 10, 11, 17, 21, 22, 28, and 117, the hydraulic system 110 further includes a filter and return assembly 2500 arranged on a return line or passage that provides fluid communication between the main control valve 2400, the steering valve 2402, and/or one or more drain lines 2502 within the hydraulic system 110. According to an exemplary embodiment shown in FIG. 119, the filter and return assembly 2500 includes a body or a housing with a first inlet port 2504, a second inlet port 2506, a first cooling outlet port 2508, and a second cooling outlet port 2510. The first inlet port 2504 is in fluid communication with the main control valve 2400 and/or the steering valve 2402, and receives return flow therefrom intended to flow into the reservoir 120. The second inlet port 2506 is in fluid communication with the one or more drain lines 2502. It should be appreciated that the inclusion of both the first inlet port 2504 and the second inlet port 2506 is not meant to be limiting and the filter and return assembly 2500 may be configured to receive return flow via any connection.

The filter and return assembly 2500 includes a return line 2512 in fluid communication with both the first inlet port 2504 and the second inlet port 2506 and extending between the first inlet port 2504, the second inlet port 2506, and the reservoir 120. A filter 2514 is arranged on the return line 2512 downstream of the first inlet port 2504 and the second inlet port 2506, and a back pressure valve 2516 is arranged on the return line 2512 downstream of the filter 2514. The first cooling outlet port 2508 is in fluid communication with the return line 2512 at a location between the filter 2514 and the back pressure valve 2516 (e.g., downstream of the filter 2514 and upstream of the back pressure valve 2516). According to an exemplary embodiment, the second cooling outlet port 2510 is plugged and fluid communication is prevented between the return line 2512 and the second cooling outlet port 2510. In some embodiments, the second cooling outlet port 2510 is not included on the filter and return assembly 2500.

In conventional hydraulic systems on a telehandler (e.g., engine-driven telehandlers), the first cooling outlet port 2508 and the second cooling outlet port 2510 are connected to a pump that is configured to supply return flow to the cooling system. But the inclusion of a dedicated pump to feed the cooling system increases the energy demand of the hydraulic system. According to the exemplary embodiment of FIG. 117, the first cooling outlet port 2508 is in fluid communication with the radiators 172 (e.g., the first radiator 172) and the back pressure valve 2516 is configured to generate a back pressure upstream of the back pressure valve 2516 and downstream of the filter 2514 so that hydraulic fluid is forced into the radiator 172 after being filtered through the filter 2514. In other words, the back pressure valve 2516 raises the pressure downstream of the filter 2514 so that hydraulic fluid is forced to flow through the radiator 172 prior to entering the reservoir 120. In some embodiments, the back pressure valve 2516 is configured to generate a pressure downstream of the filter 2514 that is above a back pressure threshold. In some embodiments, the back pressure valve 2516 is in the form of a spring-biased valve (e.g., a spring-biased check valve, a spring-biased poppet valve, etc.) where the spring force determines the back pressure threshold.

In general, the back pressure threshold is greater than an amount of pressure required for the hydraulic fluid to flow through the radiator 172 to the reservoir 120 (e.g., a pressure drop between the first cooling outlet port 2508 and the reservoir 120), which ensures that the hydraulic fluid downstream of the filter 2514 is forced through the radiator 172. In general, the arrangement of the filter 2514 and the back pressure valve 2516 enables efficient filtering and cooling of the hydraulic fluid. For example, the hydraulic fluid provided to the filter and return assembly 2500 is heated by the operation of the main control valve 2400 and/or the steering valve 2402. This heated oil, which is less viscous than cooled oil and has better filterability, is then filtered by the filter 2514 and then cooled by the radiator 172. In other words, the hydraulic oil is first filtered within the filter and return assembly 2500 and then cooled by the radiator 172, which makes efficient use of the heated hydraulic fluid prior to cooling it within the radiator 172.

### Energy Recovery

In general, the hydraulic system 110 and/or the electrical system 130 may harvest energy from components of the telehandler 10 to facilitate energy recovery and/or hybrid-like operations. For example, the drive motors 90 may be configured to operate in a regenerative braking mode, where the kinetic travel energy from the telehandler 10 is converted into electrical energy by converting the drive motors 90 into generators. The electrical energy generated during regenerative braking may be harvested and stored within the high-voltage battery 132, where it may be used to drive, for example, the implement motor 112 and charge the accumulator 124, and/or supply fluid flow to the main control valve 2400 and/or the steering valve 2402.

According to an exemplary embodiment, the hydraulic system 110 may be used to consume electrical energy in response to the high-voltage battery 132 reaching a regeneration current limit. For example, if the controller 200 detects that the high-voltage battery 132 is receiving or approaching a regeneration current limit, the controller 200 may instruct the implement motor 112 to drive the implement pump 114 and the steering pump 116, which consumes electrical energy from the high-voltage battery 132 and aids in preventing the high-voltage battery 132 from overcharging. In some embodiments, the implement motor 112 may be driven to charge the accumulator 124, if the accumulator 124 is below the pressure threshold or not at a fully charged state. In some embodiments, the implement motor 112 may be driven to cycle hydraulic fluid from the implement pump 114 and the steering pump 116 to the reservoir 120. In any case, the controller 200 may selectively drive the implement motor 112 to consume electrical energy from the high-voltage battery 132, in response to the controller 200 detecting that the high-voltage battery 132 is receiving or approaching the regeneration current limit.

As shown in FIG. 118, the hydraulic system 110 may be configured to generate electrical energy from the retraction or descent of one of the actuators controlled by the main control valve 2400. For example, when the boom assembly 50 is retracted via the lift actuator 70, the force of gravity on the boom assembly 50 and the weight supported by the boom assembly 50 may act on the lift actuator 70 to force hydraulic fluid from the main control valve 2400 back through the implement pump 114. The implement pump 114 may be configured as a bi-directional pump to allow the implement pump 114 to spin in a first direction to supply pressurized hydraulic fluid at the pump outlet, and in a second direction opposite to the first direction to allow fluid to flow through the implement pump 114 and to the reservoir 120. The supply check valve 2416 may be removed from the implement supply line 2414 to enable the fluid flow back through the implement pump 114 from the main control valve 2400, which spins the implement pump 114 in the second direction. With the implement motor 112 being mechanically coupled to the implement pump 114, when the implement pump 114 spins in the second direction, the implement motor 112 is also spun in the second direction, which turns the implement motor 112 into a generator and generates electrical energy that is stored by the high-voltage battery 132.

In general, the hydraulic system 110 may include one or more speed control components that are provided to control and/or limit a speed of the implement motor 112 while spinning in the second direction and generating electrical energy. The one or more speed control components may be in the form of a mechanical brake, a hydraulic flow limiting device, or an equivalent component. According to the exemplary embodiment of FIG. 118, a brake 2550 is coupled to the implement motor 112. The brake 2550 is configured to limit a rotational speed of the implement motor 112 and apply a mechanical braking force to the implement motor 112 in response to the rotational speed of the implement motor 112 being greater than or equal to a speed threshold. In some embodiments, the brake 2550 may be in the form of a centrifugal brake that is mechanically coupled to a drive shaft of the implement motor 112.

According to the exemplary embodiment of FIG. 119, the hydraulic system 110 includes a hydraulic velocity fuse 2552 arranged between the implement pump 114 and the main control valve 2400. The hydraulic velocity fuse 2552 is configured to prevent or restrict fluid communication between the main control valve 2400 and the implement pump 114 in response to a fluid flow rate across the hydraulic velocity fuse 2552 exceeding a threshold flow rate.

According to the exemplary embodiment of FIG. 120, the hydraulic system 110 includes a valve or a variable orifice, shown as flow restricting device 2554 that is arranged between the implement pump 114 and the main control valve 2400. A flow restriction provided between the main control valve 2400 and the implement pump 114 may be controlled in response to a descent sensor 2556 (e.g., an angle sensor) that measures a rate of descent for the boom assembly 50. For example, the descent sensor 2556 may be in communication with the controller 200 and the controller 200 may be configured to control the device 2554 based on the rate of descent measured by the descent sensor 2556.

### Hydraulic Control

In general, the hydraulic system 110 may be controlled so that a speed of the implement motor 112 is based on a total fluid flow demand from the implement functions (e.g., fluid flow demanded through each section of the main control valve 2400) or a steering pump demand, depending on which value is greater. As shown in FIGS. 5 and 112, 113, 115, and 116, the controller 200 is configured to receive inputs from the user interface 34 (e.g., a joystick that generates signals, which are received by the controller 200, and controls operation of the main control valve 2400) that are related to a flow demand through the main control valve 2400. For example, the user interface 34 may control operation of each section of the main control valve 2400 (e.g., the lift section 2404, the tilt section 2406, the auxiliary section 2408 and the telescoping section 2410), which controls operation of each of the implement functions (e.g., the lift actuator 70, the extension actuator 72, the implement actuator 74, and the tilt actuator 2412). And the user interface 34 may command multiple sections of the main control valve 2400 simultaneously. The fluid flow demand through each section of the main control valve 2400 (e.g., percent demand times an equivalent flow rate through each section) may be summed to generate a total implement fluid flow demand (e.g., flow rate), and this total implement fluid flow demand is correlated to a speed command of the implement pump 114 that provides the required flow rate to meet the implement fluid flow demand.

As described herein, the speed command of the implement pump 114 is compared to a steering pump demand (e.g., a speed command for the steering pump 116), and a greater value of the speed command of the implement pump 114 and a speed command of the steering pump 116 is used to determine and control a speed of the implement motor 112, which ensures that all function demands are met by both the implement pump 114 and the steering pump 116. FIG. 121 shows an exemplary embodiment of a method 2600 for controlling operation of the hydraulic system 110 and the speed of the implement motor 112. In some embodiments, the method 2600 is performed by the controller 200. The method 2600 initiates by determining an implement demand at step 2602 and determining a steering pump demand at step 2604. In general, the implement demand and the steering pump demand may be used to generate an implement pump speed command and a steering pump speed command in parallel. For example, if the controller 200 detects an implement demand at step 2602, the controller 200 may sum the fluid flow demand through each section of the main control valve 2400 (e.g., percent demand times an equivalent flow rate through each section) to generate a total implement fluid flow demand at step 2606. The summed value for the total implement fluid flow demand generated at step 2606 is used to generate an implement pump speed command of the implement pump 114 at step 2608, which provides the required flow rate to meet the implement fluid flow demand. For example, the memory 204 may include a map or correlation that relates the total implement fluid flow demand to a required speed of the implement pump 114, and this map or correlation may be used to generate the implement pump speed command at step 2608.

If the controller 200 detects a steering pump demand at step 2602, the controller 200 may generate a steering pump speed command at step 2610. In some embodiments, the steering pump 116 is demanded in response to the controller 200 detecting that the charge pressure within the accumulator 124, measured by the accumulator pressure sensor 2438, is below the pressure threshold. Alternatively or additionally, the steering pump 116 may be demanded in response to a steering demand from the user interface 34 provided to the steering valve 2402, which requires that the steering pump 116 supplement the fluid flow from the accumulator 124 to the steering valve 2402. Regardless of the particular source of the demand for the steering pump 116, if the steering pump 116 is demanded, the demand generates a steering pump speed command at step 2612, which provides the required flow rate to meet the steering pump demand.

The implement pump speed command generated at step 2608 and the steering pump speed command generated at step 2610 may be provided to the controller 200 in parallel, and the controller 200 may determined a maximum value between the implement pump speed command and the steering pump speed command at step 2612, which is used to control a speed of the implement motor 112 at step 2614. In other words, the controller 200 is configured to compare the steering pump speed command to the implement pump speed command at step 2612 and determine which value is greater. Then the speed the steering pump 116 is controlled at step 2614 based on which value is greater between the steering pump speed command and the implement pump speed command. In this way, for example, the total fluid flow demanded from the implement pump 114 and the steering pump 116 is met.

In operating conditions where there is no implement demand at step 2602 and there is a steering demand determined at step 2604, the steering pump speed command generated at step 2610 is used to control the speed of the implement motor 112 at step 2614. Similarly, if there is no steering demand determined at step 2604 and there is an implement demand determined at step 2602, the implement pump speed command generated at step 2608 is used to control the speed of the implement motor 112 at step 2614. In operating conditions where the total system fluid flow demand (e.g., combined demand from the implement pump 114 and the steering pump 116) is greater than or equal to a maximum demand threshold or one of the implement pump 114 or the steering pump 116 is greater than or equal to an individual maximum demand threshold, the operation of the steering valve 2402 is prioritized and the commanded implement functions are de-rated (e.g., fluid flow through the main control valve 2400 is restricted and an operating speed of the commanded implement functions is reduced).

According to an exemplary embodiment, if the controller 200 does not detect an input from the user interface 34 for a predetermined amount of time, the controller 200 may instruct the implement motor 112 to enter an idle window, where the implement motor 112 decreases speed down to an idle speed for a predetermined amount of time. If the controller 200 detects an input to the user interface 34 during the idle window, the controller 200 may instruct the implement motor 112 to drive the implement pump 114 and the steering pump 116 (e.g., according to the method 2600 described herein). If the controller 200 does not detect an input to the user interface 34 during the ide window, the controller 200 may shut down the implement motor 112. In some embodiments, the telehandler 10 may include an operator presence sensor (e.g., a camera, a switch that detects a weight within a seat of the cabin 30, or an equivalent sensor), and the controller 200 may disable operation of the main control valve 2400 and the steering valve 2402 when an operator is not detected by the operator presence sensor.

### Battery, Motor, and Pump Mounting

Referring to FIGS. 122-125, the telehandler 10 of FIGS. 1-18, the high-voltage battery 132 includes a plurality of sides, faces, or surfaces, shown as walls 3000. The walls 3000 include a first side or inner side wall, shown as first wall 3002, a second side or exterior side wall, shown as second wall 3004, a third side or front wall, shown a third wall 3008, a fourth side or rear wall, shown as fourth wall 3012, a fifth side or top wall, shown as fifth wall 3016, and a sixth side or bottom wall, shown as sixth wall 3020. The first wall 3002 is positioned to face one of the side plates 18, and is spaced laterally outward from the side plate 18. The second wall 3004 is opposite and substantially parallel to the first wall 3002. The third wall 3008 extends between the first wall 3002 and the second wall 3004 and faces longitudinally forward. The fourth wall 3012 extends between the first wall 3002 and the second wall 3004 and faces longitudinally rearward. The third wall 3008 is opposite and substantially parallel to the fourth wall 3012. The third wall 3008 and the fourth wall 3012 extend substantially perpendicular to the side plate 18. The fifth wall 3016 extends between the first wall 3002, the second wall 3004, the third wall 3008, and the fourth wall 3012 and faces upward. The sixth wall 3020 extends between the first wall 3002, the second wall 3004, the third wall 3008, and the fourth wall 3012 and faces downward. The fifth wall 3016 is opposite and substantially parallel to the sixth wall 3020. The high-voltage battery 132 forms a rectangular prism. In some embodiments, the high-voltage battery 132 forms an alternate shape (e.g., a cube, a hexagonal prism, etc.). In some embodiments, the high-voltage battery 132 includes more or less than six walls 3000 (e.g., 7 sides, 8 sides, etc.). In some embodiments the high-voltage battery 132 includes curved walls 3000.

The telehandler 10 further includes a series of first brackets, shown as lifting brackets 3021, extending along the fifth wall 3016 of the high-voltage battery 132. The lifting brackets 3021 are fixedly coupled to the fifth wall 3016 and extend above the fifth wall 3016. The lifting brackets 3021 extend substantially parallel to the sixth wall 3020 of the high-voltage battery 132 and are laterally offset from one another. The lifting brackets 3021 provide interface points to permit connection to a lifting element (e.g., a hook, a harness, etc.) to facilitate repositioning the high-voltage battery 132.

The telehandler 10 further includes a second bracket, shown as motor bracket 3022 fixedly coupled to the side plate 18 and the high-voltage battery 132. The motor bracket 3022 is configured to receive and at least partially support the high-voltage battery 132, the implement motor 112, the implement pump 114, the steering pump 116, and the accumulator 124 (e.g., portions of an electrical system and a hydraulic system, etc.). The motor bracket 3022 is also configured to prevent translation of the high-voltage battery 132 along a first direction (e.g., limit movement towards a rear or a front of the telehandler 10, prevent movement of the high-voltage battery 132 towards or away from a surface the telehandler 10 traverses, etc.). The motor bracket 3022 is also configured to isolate the hydraulic system 110 (e.g., the implement motor 112, etc.) from high voltage areas (e.g., separate hydraulic fluids from the high-voltage battery 132, act as a barrier to separate heat of hydraulics from high voltage areas, etc.) The separation provided by the motor bracket 3022 may reduce the potential of a leak of hydraulic fluid to cause hydraulic oil in come in contact with electrical components, such as the high-voltage battery 132. The motor bracket 3022 also inhibits thermal energy transfer between the hydraulic system 110 (e.g., the implement motor 112, etc.) and the high-voltage battery 132. The separation from the motor bracket 3022 permits access to the hydraulic system 110 without requiring direct access to the electrical components, permitting targeted repair of the hydraulic system 110 or the high-voltage battery 132.

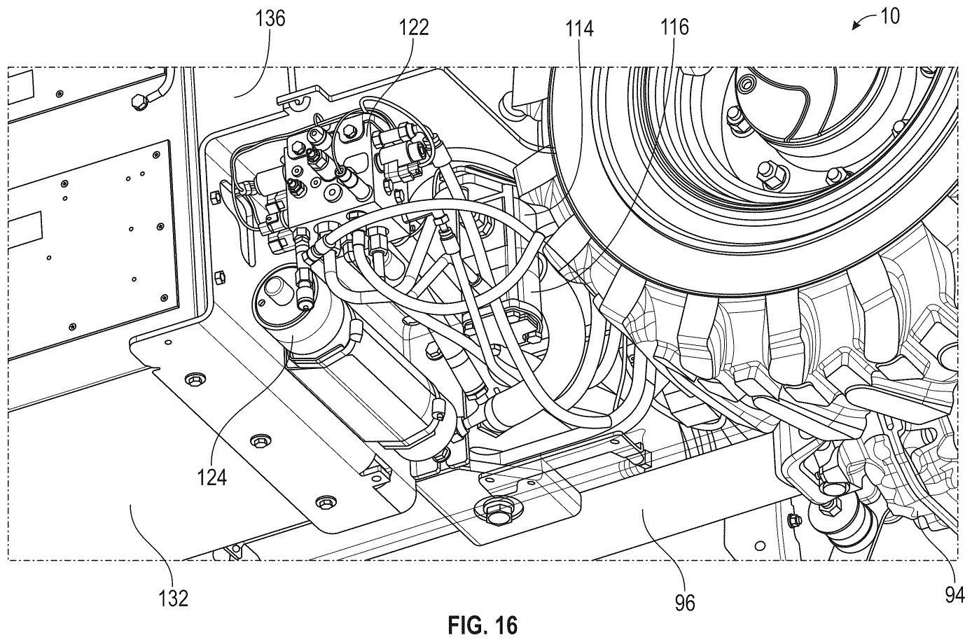

The motor bracket 3022 includes a vertical portion, shown as lateral portion 3026 and a horizontal portion, shown as longitudinal portion 3028 to efficiently utilize space within the battery housing 40. The lateral portion 3026 engages the third wall 3008 of the high-voltage battery 132, limiting forward and rearward movement of the high-voltage battery 132 relative to the frame assembly 12. The lateral portion 3026 extends vertically between a first end 3027 (e.g., a lower end) and a second end 3029 (e.g., an upper end), the first end 3027 being opposite the second end 3029. The lateral portion 3026 defines a lower fastener aperture, shown as first aperture 3030, an upper fastener aperture, shown as second aperture 3032, and a third aperture 3034. The first aperture 3030 and the second aperture 3032 are configured to receive fasteners to couple the lateral portion 3026 to the third wall 3008 of the high-voltage battery 132, and are located closer to the second wall 3004 than the side plate 18. The third aperture 3034 forms a curvilinear cross-sectional area. The third aperture 3034 is located closer to the second end 3029 than the first end 3027. The third aperture 3034 provides space for components of the control valves 122 (e.g., clearance for wires extending from the control valves 122, etc.), as shown in FIG. 16. In some embodiments, the third aperture 3034 forms an alternate cross-sectional area (e.g., a polygon, etc.). In some embodiments, the lateral portion 3026 includes more or fewer than three apertures (e.g., four, five, etc.).

The longitudinal portion 3028 extends substantially perpendicular to the lateral portion 3026. The longitudinal portion 3028 extends between a first end 3031 (e.g., a rear end) and a second end 3033 (e.g., a front end), the first end 3031 opposite the second end 3033. The first end 3031 coincides with the second end 3029 of the lateral portion 3026. The longitudinal portion 3028 extends forward, away from the high-voltage battery 132. The longitudinal portion 3028 defines a motor aperture 3036 and a series of apertures 3038. The motor aperture 3036 receives the implement motor 112. The motor aperture 3036 is located closer to the side plate 18 than the second wall 3004, and closer to the second end 3033 of the longitudinal portion 3028 than the first end 3031 of the longitudinal portion 3028. The series of apertures 3038 are spaced radially from the motor aperture 3036, and are configured to receive fasteners to couple the implement motor 112 to the longitudinal portion 3028.

As shown in FIG. 123, the implement motor 112 is coupled to the longitudinal portion 3028. The steering pump 116 is coupled to the implement pump 114, and the implement pump 114 is coupled to the implement motor 112. Accordingly, the implement motor 112, the implement pump 114, and the steering pump 116 are each coupled to the longitudinal portion 3028. The implement pump 114, the steering pump 116, and the implement motor 112 extend along a pump axis P (e.g., a vertical axis, etc.). In some embodiments, the implement motor 112, the implement pump 114, and the steering pump 116 are centered about the pump axis P. In some such embodiments, a rotating portion of the implement motor 112 (e.g., an output shaft) is centered about the pump axis P. The pump axis P is substantially perpendicular to and offset from the longitudinal axis L. The pump axis P is also substantially parallel to the lateral portion 3026 of the motor bracket 3022. Providing the hydraulic system 110 along a vertical pump axis P also facilitates a compact placement of components within the battery housing 40. The implement pump 114 and the steering pump 116 extend substantially parallel to the lateral portion 3026, between the longitudinal portion 3028 and the lateral portion 3026.

The motor bracket 3022 further includes a first flange 3040 and a second flange 3042. The first flange 3040 is fixedly coupled to the sixth wall 3020, extends substantially perpendicular to the lateral portion 3026, and extends substantially parallel to the longitudinal portion 3028. The first flange 3040 is configured to limit (e.g., prevent) downward movement of the high-voltage battery 132 in a direction substantially parallel to the lateral portion 3026 of the motor bracket 3022 (e.g., towards or away from a surface the telehandler 10 traverses, etc.). The first flange 3040 extends a first lateral distance from the side plate 18, and the high-voltage battery 132 extends a second lateral distance from the side plate 18, and the first lateral distance is greater than the second lateral distance. The first flange 3040 defines a series of apertures 3048 configured to receive fasteners to couple the first flange 3040 to the sixth wall 3020. In the illustrated embodiment, the apertures 3048 defines three apertures 3048. In other embodiments the first flange 3040 defines more or fewer than three apertures 3048 (e.g., two apertures 3048, four apertures 3048, etc.). The first flange 3040 includes an extension portion 3052 extending from a location closer to the side plate 18 than the second wall 3004. The extension portion 3052 also defines one of the apertures 3048. The extension portion 3052 is configured to be mounted to an underside of the battery housing 40.

The second flange 3042 includes a first portion 3054 and a second portion 3058. The first portion 3054 and the second portion 3058 form a substantially L-shaped section. The first portion 3054 extends from the lateral portion 3026 of the motor bracket 3022 away from the third wall 3008 of the high-voltage battery 132. The second portion 3058 extends from the longitudinal portion 3028 away from the implement motor 112. The first portion 3054 and the second portion 3058 extend substantially perpendicular to the lateral portion 3026 and the longitudinal portion 3028. The first portion 3054 is located closer to the third wall 3008 than the second portion 3058. The first portion 3054 and the second portion 3058 extend substantially parallel to first wall 3002 and the second wall 3004. The second flange 3042 is configured to couple to the side plate 18. The second flange 3042 further defines a series of apertures 3062. The first portion 3054 defines two of the apertures 3062 and the second portion 3058 defines one of the apertures 3062. The first portion 3054 and the second portion 3058 each define a slot 3064 configured to receive a fastener. The slot 3064 on the first portion 3054 is located closer to the sixth wall 3020 than the fifth wall 3016. The slot 3064 on the second portion 3058 is located farther from the third wall 3008 than the lateral portion 3026. In some embodiments, there are more than two slots 3064 and/or more than three apertures 3062 (e.g., three slots 3064 and four apertures 3062, etc.). In some embodiments, the slots 3064 are omitted. In some embodiments, there are less than two slots 3064 and/or less than three apertures 3062 (e.g., one slot 3064 and two apertures 3062, etc.).

The motor bracket 3022 further includes a series of connection portions, curved portions, or bends, shown as a first curved portion 3068, a second curved portion 3072, a third curved portion 3076, and a fourth curved portion 3080. The first curved portion 3068 extends between the first flange 3040 and the lateral portion 3026. The second curved portion 3072 extends between the lateral portion 3026 and the longitudinal portion 3028. The third curved portion 3076 extends between the lateral portion 3026 and the first portion 3054 of the first flange 3040. The fourth curved portion 3080 extends between the longitudinal portion 3028 and the second portion 3058 of the first flange 3040. Accordingly, the sections of the motor bracket 3022 may be integrally formed from a single, continuous piece of material. In some embodiments, the first curved portion 3068, the second curved portion 3072, the third curved portion 3076, and the fourth curved portion 3080 are omitted (e.g., the first flange 3040 extends from the lateral portion 3026 at a substantially 90 degree angle, the lateral portion 3026 extends from the longitudinal portion 3028 at a substantially 90 degree angle, etc.).

The telehandler 10 further includes a second bracket, shown as control valve bracket 3082 coupled to the longitudinal portion 3028 of the motor bracket 3022. The control valve bracket 3082 also enables systems of the telehandler 10 to be contained within the limited space of the battery housing 40 while maintaining separation with the high-voltage battery 132. The control valve bracket 3082 extends downward (e.g., towards a surface the telehandler 10 traverses, etc.) from the longitudinal portion 3028 and is located closer to the second wall 3004 than the side plate 18. The control valve bracket 3082 receives the control valves 122 and couples the control valves 122 to the motor bracket 3022. The control valve bracket 3082 includes a first portion 3084, a second portion 3088, and a curved portion 3092. The first portion 3084 extends substantially parallel to the second wall 3004 and substantially perpendicular to the longitudinal portion 3028 of the motor bracket 3022. The first portion 3084 defines a first body 3085, a first prong 3086, and a second prong 3087. The first body 3085 is coupled to the longitudinal portion 3028 of the motor bracket 3022 and the first prong 3086 and the second prong 3087 extend from the first body 3085. The first prong 3086 is spaced from the second prong 3087. The second portion 3088 extends substantially parallel to the lateral portion 3026 of the motor bracket 3022 and substantially perpendicular to the longitudinal portion 3028 of the motor bracket 3022. The second portion 3088 includes a second body 3089 and a third prong 3090. The third prong 3090 is centered on the second body 3089 and extends from the second body 3089. The curved portion 3092 extends between the first portion 3084 and the second portion 3088.

The telehandler 10 further includes a third bracket or cradle, shown as accumulator bracket 3096, coupled to the lateral portion 3026 of the motor bracket 3022 and extending forward. The accumulator bracket 3096 also enables systems of the telehandler 10 to be contained within the limited space of the battery housing 40 while maintaining separation with the high-voltage battery 132. The accumulator bracket 3096 is configured to receive and support (e.g., cradle) the accumulator 124. The accumulator bracket 3096 includes a first portion 3100, a second portion 3104, and a third portion 3108. The first portion 3100 is fixedly coupled to the lateral portion 3026 of the motor bracket 3022. The second portion 3104 extends from the first portion 3100 at an obtuse angle (e.g., extends forward and downward from the first portion 3100 away from the lateral portion 3026 of the motor bracket 3022 and away from the longitudinal portion 3028 of the motor bracket 3022, etc.). The second portion 3104 extends away from the third wall 3008. The third portion 3108 extends from the second portion 3104 at an obtuse angle with respect to the second portion 3104 (e.g., extends upward and forward away from the lateral portion 3026 of the motor bracket 3022 and toward the longitudinal portion 3028 of the motor bracket 3022, etc.). The third portion 3108 extends away from the third wall 3008. By sloping the second portion 3104 and the third portion 3108 toward one another, the second portion 3104 and the third portion 3108 form an upward-facing recess that receives and cradles the accumulator 124. The second portion 3104 and the third portion 3108 each defines a series of slots 3109. Each of the slots 3109 is configured to receive a tie to couple the accumulator 124 to the accumulator bracket 3096, as seen in FIG. 16. In the illustrated embodiment, the third portion 3108 includes two slots 3109 and the second portion 3104 includes two slots 3109. In other embodiments, the second portion 3104 and the third portion 3108 each include more than two slots 3109. For example, when three ties couple the accumulator 124 to the accumulator bracket 3096, the second portion 3104 and the third portion 3108 each include three slots 3109.

The telehandler 10 further includes a fourth bracket, shown as first battery bracket 3110 coupled to the longitudinal portion 3028 of the motor bracket 3022. The first battery bracket 3110 also enables systems of the telehandler 10 to be contained within the limited space of the battery housing 40 while maintaining separation with the high-voltage battery 132. The first battery bracket 3110 is configured to receive and support the low-voltage battery 136 and prevent longitudinal translation (e.g., restrict movement, etc.) of the low-voltage battery 136 towards or away from the high-voltage battery 132 (e.g., restrict translation of the low-voltage battery 136 toward a front or a rear of the telehandler 10, etc.) or lateral movement towards the implement motor 112. The first battery bracket 3110 extends from the longitudinal portion 3028. The first battery bracket 3110 includes a first portion 3111, a second portion 3112, and a third portion 3114. The first portion 3111 and the third portion 3114 extend parallel to the third wall 3008. The first portion 3111 and the third portion 3114 extend from a location closer to the second wall 3004 than the first wall 3002 to an edge of the longitudinal portion 3028 of the motor bracket 3022. The second portion 3112 extends between the first portion 3111 and the third portion 3114. The second portion 3112 is substantially perpendicular to the third wall 3008 of the high-voltage battery 132.

Referring to FIGS. 122, 124, and 125, the telehandler 10 further includes a fifth bracket, shown as second battery bracket 3116 coupled to the fourth wall 3012 of the high-voltage battery 132 and the side plate 18. The second battery bracket 3116 at least partially supports the high-voltage battery 132 (e.g., limiting downward movement of the high-voltage battery 132). The second battery bracket 3116 is also configured to limit (e.g., prevent) translation of the high-voltage battery 132 along a second, rearward direction (e.g., towards a rear of the telehandler 10, etc.) opposite the first direction. The second battery bracket 3116 includes a lateral portion 3120, a first flange 3124, a second flange 3128, and a third flange 3132. The lateral portion 3120 extends substantially parallel to the fourth wall 3012 and to the lateral portion 3026 of the motor bracket 3022. The lateral portion 3120 of the second battery bracket 3116 confronts and is offset from the fourth wall 3012 of the high-voltage battery 132. The lateral portion 3120 extends along a first distance and the fourth wall 3012 extends along a second distance. The first distance is greater than the second distance.

The first flange 3124 and the second flange 3128 are fixedly coupled to the side plate 18, and are substantially parallel to the first wall 3002 of the high-voltage battery 132 and substantially perpendicular to the lateral portion 3120 of the second battery bracket 3116. The first flange 3124 defines a first width and the second flange 3128 defines a second width. The second width is greater than the first width. The first flange 3124 is located closer to the fifth wall 3016 than the second flange 3128.

The third flange 3132 is substantially perpendicular to the lateral portion 3120 of the second battery bracket 3116 and extends substantially parallel to the sixth wall 3020 (e.g., extends along the sixth wall 3020) of the high-voltage battery 132. The third flange 3132 is fixedly coupled to the sixth wall 3020 of the high-voltage battery 132. The third flange 3132 extends a first lateral distance from the side plate 18, and the high-voltage battery 132 extends a second lateral distance from the side plate 18. The first lateral distance is greater than the second lateral distance. The first lateral distance that the third flange 3132 extends along is less than the first lateral distance the lateral portion 3120 extends along. The third flange 3132 includes an extension portion 3134 extending away from the fourth wall 3012. The extension portion 3134 is configured to couple to the bottom portion of the battery housing 40. Each of the first flange 3124, the second flange 3128, and the third flange 3132 define a series of apertures 3136. The apertures 3136 are configured to receive fasteners to couple the first flange 3124 and the second flange 3128 to the side plate 18 and the third flange 3132 to the high-voltage battery 132. In the illustrated embodiment, the first flange 3124 defines a single aperture 3136 and the second flange 3128 defines two apertures 3136. In other embodiments, the first flange 3124 includes more than a single aperture 3136 and the second flange 3128 includes more than or fewer than two apertures 3136.

The second battery bracket 3116 further includes one or more connection portions, curved portions, or bends, shown as a first curved portion 3140, a second curved portion 3144, and a third curved portion 3148. The first curved portion 3140 extends between the first flange 3124 and the lateral portion 3120 of the second battery bracket 3116. The second curved portion 3144 extends between the second flange 3128 and the lateral portion 3120 of the second battery bracket 3116. The third curved portion 3148 extends between the lateral portion 3120 and the third flange 3132 of the second battery bracket 3116. In some embodiments, the first curved portion 3140, the second curved portion 3144, and the third curved portion 3148 are omitted (e.g., the first flange 3124 extends from the lateral portion 3120 at a substantially 90 degree angle, the second flange extends from the lateral portion 3120 at a substantially 90 degree angle, etc.).

Referring now to FIG. 122, telehandler 10 further includes a series of clips or isolator mounts, shown as tabs 3152. The tabs 3152 couple the high-voltage battery 132 to the side plate 18 and are configured to allow relative movement between the high-voltage battery 132 and the side plate 18. The tabs 3152 reduce vibrations transferred to the high-voltage battery 132 from the side plate 18. The tabs 3152 include a first tab 3156 and a second tab 3160 located closer to the fifth wall 3016 than the sixth wall 3020. Placing tabs 3152 above the high-voltage battery 132 as opposed to below the high-voltage battery 132 permits the high-voltage battery 132 to be placed lower in the battery housing 40 (e.g., closer to the ground the telehandler 10 traverses, etc.) and prevents a higher level of vibrations than if placed below the high-voltage battery 132. Coupling the tabs 3152 above the high-voltage battery 132 instead of below the high-voltage battery 132 further reduces vibrations transferred to the high-voltage battery 132. The configuration of the motor bracket 3022, the second battery bracket 3116, and the tabs 3152 allows the high-voltage battery 132 to be contained within the limited space constraints of the battery housing 40 and be mounted lower on the telehandler 10 (e.g., closer to the surface the telehandler 10 traverses, etc.).

The first tab 3156 is located closer to the fourth wall 3012 than the third wall 3008 and the second tab 3160 is located closer to the third wall 3008 than the fourth wall 3012. The first tab 3156 includes a first portion 3164, a second portion 3168, and a curved portion 3172. The first portion 3164 is substantially parallel to the side plate 18 and couples to the side plate 18. The first portion 3164 defines an aperture 3176 configured to receive a fastener to couple the first tab 3156 to the side plate 18. The second portion 3168 extends substantially perpendicular to the first portion 3164 away from the side plate 18. The second portion 3168 defines an aperture 3180 configured to receive a fastener to couple the first tab 3156 to the fifth wall 3016 of the high-voltage battery 132. The curved portion 3172 extends between the first portion 3164 and the second portion 3168. In some embodiments, the curved portion 3172 is omitted.

The first tab 3156 includes an isolator 3184 (e.g., a compliant member, a rubber member, a rubber spacer, etc.). The isolator 3184 is coupled between the second portion 3168 and the fifth wall 3016 of the high-voltage battery 132. The isolator 3184 permits relative movement between the high-voltage battery 132 and the side plate 18. For example, the isolator 3184 may permit movement between the high-voltage battery 132 and the side plate 18 along the first direction and the second direction. The isolator 3184 prevents deformation of the low-voltage battery 136 and absorbs vibrations from the frame assembly 12 (e.g., reduces the transfer of vibrations between the high-voltage battery 132 and the side plate 18). In the illustrated embodiment, the isolator 3184 is rubber. In other embodiments, the isolator 3184 is formed from an alternate material (e.g., silicone, thermoplastic elastomers, etc.).

The second tab 3160 includes a first portion 3200, a second portion 3204, and a curved portion 3208. The first portion 3200 is substantially parallel to the side plate 18 and couples to the side plate 18. The first portion 3200 defines an aperture 3216 configured to receive a fastener to couple the second tab 3160 to the side plate 18. The second portion 3204 extends substantially perpendicular to the first portion 3200 away from the side plate 18. The second portion 3204 defines an aperture 3220 configured to receive a fastener to couple the second tab 3160 to the fifth wall 3016 of the high-voltage battery 132. The curved portion 3208 extends between the first portion 3200 and the second portion 3204. In some embodiments, the tabs 3152 include more than two tabs 3152 (e.g., three tabs 3152, four tabs 3152, etc.). In some embodiments, the curved portion 3208 is omitted.

The second tab 3160 includes an isolator 3222. The isolator 3222 is coupled between the second portion 3204 and the fifth wall 3016 of the high-voltage battery 132. The isolator 3222 permits relative movement between the high-voltage battery 132 and the side plate 18. For example, the isolator 3222 permits movement between the high-voltage battery 132 and the side plate 18 along the first direction and the second direction. The isolator 3222 prevents deformation of the low-voltage battery 136 and absorbs vibrations from the frame assembly 12. In the illustrated embodiment, the isolator 3222 is rubber. In other embodiments, the isolator 3222 is formed from an alternate material (e.g., silicone, thermoplastic elastomers, etc.).

In some embodiments, the tabs 3152 extend between the side plate 18 and the sixth wall 3020 of the high-voltage battery 132. In some embodiment, the tabs 3152 further include tabs 3152 extending between the side plate 18 and the sixth wall 3020 of the high-voltage battery 132.

Referring now to FIGS. 19-28, the telehandler 10 may be substantially similar to the telehandler 10 of FIGS. 1-18 and 122-125, except as otherwise described. The pump axis P is substantially perpendicular to the side plate 18 (e.g., parallel to the first flange 3040 of the motor bracket 3022, etc.). The pump axis P, and therefore the implement motor 112, the implement pump 114, and the steering pump 116, are located below the longitudinal portion 3028 of the motor bracket 3022 (e.g., the implement pump 114 is located between the lateral portion 3026 and the longitudinal portion 3028 of the motor bracket 3022, etc.).

The longitudinal portion 3028 of the motor bracket 3022 is a first longitudinal portion 3028, and the lateral portion 3026 of the motor bracket 3022 is a first lateral portion 3026. The motor bracket 3022 includes a second lateral portion 3224 and a second longitudinal portion 3326. The second lateral portion 3224 extends substantially parallel and offset from first lateral portion 3026 and the second longitudinal portion 3326 extends substantially parallel and offset from the first longitudinal portion 3028. The second lateral portion 3224 extends between the first longitudinal portion 3028 and the second longitudinal portion 3326.

The motor bracket 3022 includes a vertical portion 3328 extending between the first longitudinal portion 3028 and the first lateral portion 3026. The vertical portion 3328 is substantially perpendicular to the first longitudinal portion 3028 and the first lateral portion 3026. The pump axis P is substantially perpendicular to the vertical portion 3328. The motor aperture 3036 that receives the implement motor 112 is centered on the vertical portion 3328.

The telehandler 10 includes a sixth bracket, shown as third battery bracket 3330, coupled to the second longitudinal portion 3326 of the motor bracket 3022. The third battery bracket 3330 includes a first longitudinal portion 3332, a first lateral portion 3334, and a flange 3336. The first longitudinal portion 3332 is coupled to the second longitudinal portion 3326 and substantially parallel to the second longitudinal portion 3326. The first lateral portion 3334 extends from the first longitudinal portion 3332 is substantially perpendicular to the first longitudinal portion 3332. The flange 3336 extends from the first lateral portion 3334 and is coupled to the second wall 3004. The flange 3336 is substantially perpendicular to the first lateral portion 3334. The low-voltage battery 136 is coupled to the first lateral portion 3334 and the first longitudinal portion 3332, facilitating the low-voltage battery 136 to be located above the implement motor 112 and be located farther from the high-voltage battery 132 than the implement motor 112 (e.g., the low-voltage battery 136 is located forward of the implement motor 112, etc.).

The telehandler 10 includes a seventh bracket, shown as inverter bracket 3338. The inverter bracket 3338 is coupled to the third battery bracket 3330 and the motor bracket 3022, and is configured to receive the invertor. The inverter bracket 3338 includes a lateral portion 3340, a longitudinal portion 3342, and a flange 3344. The lateral portion 3340 is configured to confront the high-voltage battery 132. The longitudinal portion 3342 and the flange 3344 each extend from the lateral portion 3340 and are substantially perpendicular to the lateral portion 3340. The longitudinal portion 3342 is configured to confront an upper surface of the invertor, and the flange 3344 is configured to confront a lower surface of the inverter. The flange 3344 is configured to confront the longitudinal portion 3028 of the motor bracket 3022. The inverter bracket 3338 enables the invertor to be located between the high-voltage battery 132 and the low-voltage battery 136, and above the implement motor 112.

One embodiment relates to a vehicle, including: a chassis extending along a longitudinal axis, the chassis including a pair of longitudinal frame members each offset from the longitudinal axis; an implement pump extending along a pump axis substantially perpendicular to and offset from the longitudinal axis; a steering pump extending along the pump axis; a motor having an outlet coupled to the implement pump and the steering pump, the motor extending along the pump axis; and a motor bracket extending from one of the longitudinal frame members, the motor bracket including: a longitudinal portion configured to support the motor, and a lateral portion extending from the longitudinal portion, the lateral portion substantially parallel to the pump axis.

In one aspect, which is combinable with any of the above embodiments, the vehicle further includes: a plurality of actuators; control valves configured to control flow of fluid between the implement pump, the steering pump, and the actuators; and a control valve bracket extending from the longitudinal portion of the motor bracket, the control valve bracket coupled to the control valves.

In one aspect, which is combinable with any of the above embodiments and aspects, the vehicle further includes: an accumulator in fluid communication with the control valves; and an accumulator bracket extending from the lateral portion of the motor bracket, the accumulator bracket coupled to the accumulator.

In one aspect, which is combinable with any of the above embodiments and aspects, the vehicle further includes: a battery supported by the motor bracket; and a battery bracket extending from the longitudinal portion of the motor bracket opposite the control valve bracket, the battery bracket configured to restrict translation of the battery toward the motor.

In one aspect, which is combinable with any of the above embodiments and aspects, the control valve bracket extends from the longitudinal portion of the motor bracket in a first direction and the battery bracket extends from the longitudinal portion of the motor bracket in a second direction, the first direction opposite the second direction.

In one aspect, which is combinable with any of the above embodiments and aspects, the vehicle, further includes: an accumulator in fluid communication with the control valves; and an accumulator bracket extending from the lateral portion of the motor bracket, the accumulator bracket coupled to the accumulator.

In one aspect, which is combinable with any of the above embodiments and aspects, the control valve bracket includes a first portion substantially perpendicular to the lateral portion of the motor bracket, the first portion including: a first body coupled to the longitudinal portion; a first prong extending from the first body; and a second prong extending from the first body and spaced from the first prong.

In one aspect, which is combinable with any of the above embodiments and aspects, the control valve bracket includes a second portion substantially parallel to the lateral portion of the motor bracket, the second portion including: a second body coupled to the longitudinal portion; and a third prong extending from the second body, the third prong substantially centered along the second body.

In one aspect, which is combinable with any of the above embodiments and aspects, the vehicle further includes: a battery bracket extending from the longitudinal portion of the motor bracket, the battery bracket including: a first portion extending substantially parallel to the lateral portion of the motor bracket; a second portion extending substantially parallel to the first portion; and a third portion extending between the first portion and the second portion; and a battery supported by the longitudinal portion of the motor bracket. The battery bracket restricts translation of the battery in a first direction, a second direction, and a third direction, the first direction opposite the second direction, the first direction towards a front of the vehicle, the second direction towards a rear of the vehicle, the third direction towards the motor.

In one aspect, which is combinable with any of the above embodiments and aspects, the vehicle, further includes an accumulator, and an accumulator bracket coupled to the accumulator and configured to support the accumulator, the accumulator bracket including: a first portion coupled to the lateral portion of the motor bracket, a second portion extending from the first portion away from the lateral portion and the longitudinal portion of the motor bracket; and a third portion extending from the second portion away from the lateral portion of the motor bracket and toward the longitudinal portion of the motor bracket.

In one aspect, which is combinable with any of the above embodiments and aspects, the motor bracket further includes: a first flange extending from the lateral portion of the motor bracket; and a second flange coupled to the longitudinal frame member, the second flange forming an L-shape, the second flange including: a first portion extending from the lateral portion of the motor bracket; and a second portion extending from the longitudinal portion of the motor bracket away from the motor.

In one aspect, which is combinable with any of the above embodiments and aspects, the vehicle further includes a battery coupled to the first flange and the lateral portion of the motor bracket, the first flange configured to restriction translation of the battery towards a surface the vehicle traverses, the lateral portion configure to restrict translation of the battery towards the motor.

In one aspect, which is combinable with any of the above embodiments and aspects, a side of the battery is coupled to the lateral portion of the motor bracket; the side of the battery extends along a first distance from the longitudinal frame member, and the first flange extends along a second distance from the longitudinal frame member, and the second distance is greater than the first distance.

In one aspect, which is combinable with any of the above embodiments and aspects, the vehicle further includes a battery bracket extending from the longitudinal frame member, and a battery extending between the battery bracket and the motor bracket, the battery bracket and the motor bracket configured to restrict movement of the battery, the motor bracket configured to restrict movement of the battery towards the motor.

In one aspect, which is combinable with any of the above embodiments and aspects, the vehicle further includes a plurality of tabs extending form the longitudinal frame member, the tabs configured to permit relative movement between the battery and the longitudinal frame member.

In one aspect, which is combinable with any of the above embodiments and aspects, the vehicle further includes a battery coupled to the motor bracket, the battery separated from the steering pump, the implement pump, and the motor by the lateral portion of the motor bracket.

In one aspect, which is combinable with any of the above embodiments and aspects, the longitudinal portion of the motor bracket extends between a first end and a second end, the first end opposite the second end; the lateral portion of the motor bracket extends between a first end and a second end, the first end opposite the second end; and the first end of the longitudinal portion coincides with the second end of the lateral portion.

In one aspect, which is combinable with any of the above embodiments and aspects, the longitudinal portion of the motor bracket defines: a motor aperture configured to receive the motor, the motor aperture located closer to the second end of the longitudinal portion than the first end of the longitudinal portion; and a plurality of apertures spaced radially from the motor aperture, the apertures configured to receive fasteners to couple the motor to the motor bracket.

In some embodiments the vehicle, includes: a chassis extending along a longitudinal axis, the chassis including a pair of longitudinal frame members each offset from the longitudinal axis; and a battery housing coupled to the longitudinal frame member, the battery housing enclosing: an implement pump extending along a pump axis offset from the longitudinal axis; a steering pump extending along the pump axis; a motor having an outlet coupled to the implement pump and the steering pump, the motor extending along the pump axis; and a motor bracket extending from one of the longitudinal frame members, the motor bracket including: a longitudinal portion configured to support the motor, and a lateral portion extending from the longitudinal portion.

In yet another embodiment a work machine, includes: a chassis extending along a longitudinal axis, the chassis including a pair of longitudinal frame members each offset from the longitudinal axis; an implement pump extending along a pump axis substantially perpendicular to and offset from the longitudinal axis; a steering pump extending along the pump axis; a motor having an outlet coupled to the implement pump and the steering pump, the motor extending along the pump axis; a plurality of actuators; control valves configured to control flow of fluid between the implement pump, the steering pump, and the actuators; an accumulator in fluid communication with the control valve; a motor bracket extending from one of the longitudinal frame members, the motor bracket including: a longitudinal portion configured to support the motor, and a lateral portion extending from the longitudinal portion, the lateral portion substantially parallel to the pump axis; a control valve bracket extending from the longitudinal portion of the motor bracket, the control valve bracket coupled to the control valves; an accumulator bracket extending from the lateral portion of the motor bracket, the accumulator bracket coupled to the accumulator, a battery supported by the motor bracket; and a battery bracket extending from the longitudinal portion of the motor bracket opposite the control valve bracket, the battery bracket configured to restrict translation of the battery in a first direction, a second direction, and a third direction, the first direction opposite the second direction, the first direction towards a front of the work machine, the second direction towards a rear of the work machine, the third direction towards the motor.

### Cabin Thermal Management

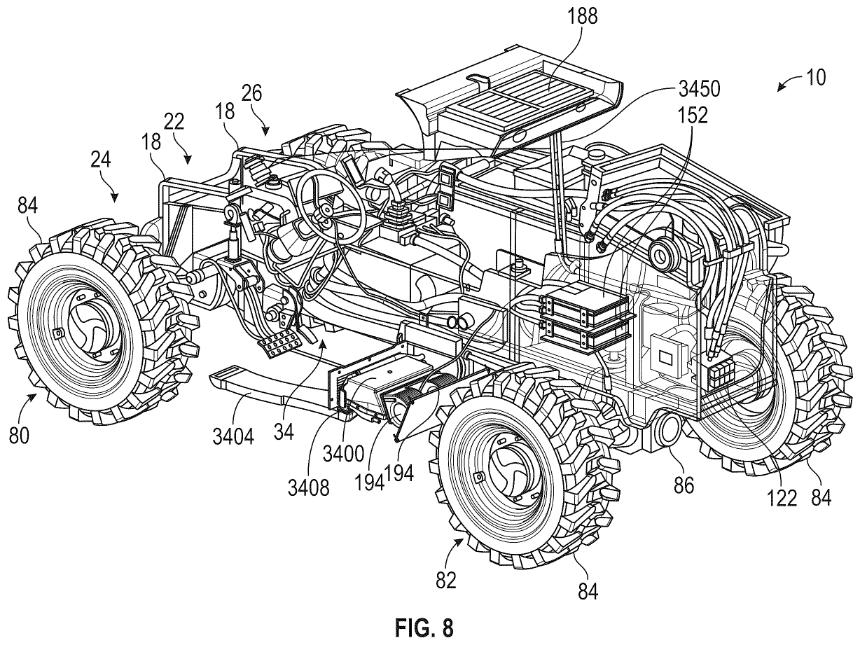

As shown in FIGS. 8-10, 14, 17-18, 126-128, 134, and 135, the HVAC system 180 includes a heat box, cooling box, mixing box, etc., shown as plenum 3400, and an air conduit, shown as duct 3404. The plenum 3400 is coupled with the air handler of the HVAC system 180 (e.g., the fans 194, the evaporator 192, a heat exchanger 3420, etc.) and is configured to mix heated air (e.g., air heated by the heater 182 and/or the heat exchanger 3420) and/or cooled air (e.g., air cooled by the refrigeration circuit 184) and facilitate distributing the air throughout the cabin 30.

As shown, the plenum 3400 includes one or more openings 3408 configured to fluidly couple the plenum 3400 with the cabin 30, for example to direct the air into the cabin 30. As shown in FIGS. 8, 14, 18, 131, 132, and 135, the plenum 3400 includes a first opening 3408 and a second opening 3408. The duct 3404 may include one or more straight or bent sections configured to fluidly couple the second opening 3408 with the cabin 30. The plenum 3400 is positioned within the cabin 30 along a rear end of the cabin 30, for example under a seat within the cabin 30. The plenum 3400 is positioned such that the first opening 3408 is directly fluidly coupled with the cabin 30 such that air is directed through the first opening 3408 in a direction towards the feet and legs of an operator within the cabin 30. The duct 3404 is positioned below the cabin 30 and coupled to a bottom surface of a floor of the cabin 30. The duct 3404 directs air from the second opening 3408 of the plenum 3400 to a front end of the cabin 30. In some embodiments, the duct 3404 routes the air upwards and through vents in a dash of the cabin 30 such that air is directed in a direction towards the operator (e.g., face, hands, torso, etc.). In some embodiments, the plenum 3400 includes more or fewer openings coupled to more or fewer ducts 3404 to direct air into the cabin 30 at various other locations.

As shown in FIGS. 128-133, the HVAC system 180 includes a heating system, shown as heating circuit 3412, fluidly coupled with the cooling circuit of the cooling system 170. The heating circuit 3412 may add thermal energy to the air within the cabin 30 to heat the cabin 30. The heating circuit 3412 includes the heater 182 (e.g., an electric resistance heater), a pump, shown as heat pump 3416, and a heater core, shown as heat exchanger 3420. The heating circuit 3412 includes a coolant conduit (e.g., pipe, hose, tube, channel, etc.), shown as conduit 3424, including one or more straight or bent sections of conduit. The conduit 3424 is configured to facilitate the flow of coolant throughout the heating circuit 3412 to perform the heating. As shown in FIG. 128, the flow of fluid (e.g., coolant, etc.) is represented by lines (e.g., the conduit 3424) with arrows representing the direction of the flow of the fluid. The lines shown in FIG. 128 may represent the flow of the fluid through, adjacent to, across, etc. a component of the heating circuit 3412 (e.g., through the heat pump 3416, across the heat exchanger 3420, etc.).

The heat pump 3416 is configured to drive the circulation of the coolant throughout the heating circuit 3412. The heat pump 3416 may receive electrical energy from the HVPDU 134 to power an electric motor within the heat pump 3416. In some embodiments, the electric motor within the heat pump 3416 is an AC electric motor, and the heat pump 3416 includes an inverter that converts DC electrical energy from the HVPDU 134 to AC electrical energy for the electric motor. The heat pump 3416 may receive, via the conduit 3424, a supply of the coolant from the heater 182, the radiators 172 (e.g., the second radiator 172), and/or a coolant supply tank (e.g., surge tank 3428), as discussed in greater detail below. The heat pump 3416 may supply, via the conduit 3424, the coolant to the heat exchanger 3420. The heat pump 3416 may be positioned within the central area 22 and forward of the heater 182.

The heat exchanger 3420 is configured to transfer thermal energy from the heated coolant (e.g., coolant heated by the heater 182) to the air passing over the heat exchanger 3420. By way of example, the fans 194 are configured to direct airflow across the heat exchanger 3420 to heat the air within the cabin 30. In some embodiments, the heat exchanger 3420 is positioned, at least partially, within the plenum 3400. In other embodiments, the heat exchanger 3420 is positioned outside of plenum 3400.

As shown in at least FIG. 128, after passing across the heat exchanger 3420, the conduit 3424 returns the coolant to the heater 182 to heat the coolant. The heated coolant is then driven by the heat pump 3416 back to the heat exchanger 3420 to complete the heating circuit 3412. It should be understood that it is contemplated that in other embodiments, the components of the heating circuit 3412 may be otherwise arranged and/or configured. For example, in some embodiments, the heater 182 receives, via the conduit 3424, a supply of coolant from the radiators 172 (e.g., the second radiator 172) and/or the surge tank 3428. The heater 182 may heat the coolant, and/or supply, via the conduit 3424, the coolant to the heat exchanger 3420. The heat exchanger 3420 may transfer thermal energy from the heated coolant to the air, and the conduit 3424 may pass the coolant to the heat pump 3416, for example to be driven back to the heater 182 to complete the heating circuit 3412. In this sense, it is contemplated that the arrangement and/or configuration of the heat pump 3416 and/or the heater 182 may, in some embodiments, be reversed compared to what is illustrated in FIG. 128. All such combinations and variations are contemplated herein.

As shown in FIG. 133, the controller 200 may control the operation of the heater 182 and/or the heat pump 3416. The controller 200 may control the power output from the heater 182 to control the amount of thermal energy transferred to the coolant passing through the heater 182. By way of example, based on an input from on operator within the cabin 30 (e.g., to the user interface 34), the controller 200 may increase or decrease the power output from the heater 182 to increase or decrease the temperature of the air within the cabin 30. The controller 200 may control the heat pump 3416 to control a flow rate of the coolant through the heating circuit 3412, power the heat pump 3416 “on” or “off,” etc. By way of example, the controller 200 may increase the rate of the heat pump 3416 to increase the flow rate (e.g., the circulation) of the coolant throughout the heating circuit 3412 to increase the temperature of the air within the cabin 30. By way of another example, responsive to an input by the operator to heat the cabin 30, the controller 200 may power the heat pump 3416 “on.” Although these additional features may have been omitted from FIG. 5 to avoid overcrowding the image, it should be understood that FIGS. 5 and 133 may all represent a single embodiment. It should also be understood that the position and combination of features shown in FIGS. 5 and 133 is exemplary only, and not intended to be limiting.

In other vehicles including an internal combustion engine (ICE), coolant is configured to receive thermal energy generated by the ICE to cool the ICE. These other vehicles may include a mixing valve coupled along a portion of a conduit supplying and delivering the coolant. The mixing valve may be used to regulate the flow of hot coolant from the ICE to components such as a heater used to heat the coolant to allow for selective pulling of hot coolant based on heat requirements (e.g., based on an input to a heat input device from an operator). The mixing valve controls whether hot coolant enters the heater core and mixes with cooler coolant. By way of example, the mixing valve may operate (e.g., actuate) to mix a first volume of hot coolant with cooler coolant to heat the cabin to a first temperature and mix a second volume of hot coolant less than the first volume with cooler coolant to heat the cabin to a second temperature less than (e.g., cooler than) the first temperature. The systems of the present disclosure omits a mixing valve, such that the coolant flowing through the heating circuit 3412 is heated by the heater 182 to control the temperature of the air in the cabin 30 as opposed to a volume of pre-heated coolant (e.g., pre-heated by one or more other components of the telehandler 10) being diverted from the coolant circuit to control the temperature of the air in the cabin 30.

As shown in FIGS. 128-132, the conduit 3424 fluidly couples the second radiator 172 with the heating circuit 3412. The coolant may be cooled by the second radiator 172 and supplied to the heating circuit 3412 to be heated to heat the cabin 30. The conduit 3424 extending from the second radiator 172 may be fluidly coupled with a coolant storage tank (e.g., reservoir), shown as the surge tank 3428. The surge tank 3428 is configured to store coolant for use throughout the coolant circuit (e.g., throughout the heating circuit 3412, throughout the coolant circuit to cool one or more components of the telehandler 10, etc.). In some embodiments, the heat pump 3416 is configured to draw coolant from the surge tank 3428 and supply the coolant to the heat exchanger 3420. In other embodiments, and as described elsewhere herein, other components of the heating circuit 3412 (e.g., the heater 182, etc.) are configured to receive coolant from the surge tank 3428 and/or supply the coolant to the heat exchanger 3420.

As shown in FIGS. 128 and 129, the conduit 3424 includes a plurality of Y-joints (e.g., a diverter joint, a joint shaped like the letter “Y”, etc.), shown as first split joint 3432 and second split joint 3434. According to an exemplary embodiment, the split joints 3432, 3434 are configured to direct one or more portions of fluid (e.g., coolant, liquid, air, gas, etc.) to and/or through the diverted ends of the Y-joint. For example, the first split joint 3432 may be configured to direct a first volume (e.g., portion) of the coolant within a first section of the conduit 3424 and a second volume (e.g., portion) of the coolant within a second section of the conduit 3424. The first split joint 3432 is positioned after the surge tank 3428 fluidly couples with the conduit 3424 and before the second split joint 3434. The first split joint 3432 is configured to direct a first volume of the coolant to the heating circuit 3412 and a second volume of the coolant to the coolant pumps 174.

As described in greater detail above, the coolant pumps 174 are configured to drive the circulation of the coolant throughout the cooling circuit to one or more components of the telehandler 10 (e.g., the drive motor 90, the implement motor 112, the onboard chargers 152, the DC/DC converter 160, other components of the telehandler 10, etc.), shown as components 3438, to cool the components 3438. After cooling the components 3438, the conduit 3424 returns the coolant to the second radiator 172 to be cooled thereby. In some embodiments, the conduit 3424 includes a section fluidly coupling the heat exchanger 3420 with the coolant pumps 174. In such embodiments, after the coolant passes through the heat exchanger 3420 (and before the coolant is heated by the heater 182), the conduit 3424 directs at least a portion of the coolant to the coolant pumps 174, which are configured to drive the circulation of the coolant to cool the components 3438.

The second split joint 3434 is positioned after the first split joint 3432 and before the heat pump 3416. The second split joint is configured to facilitate (i) supplying the coolant from the second radiator 172 and/or the surge tank 3428 to the heating circuit 3412 (e.g., to the heat pump 3416) and (ii) permitting the flow of the coolant from the heater 182 to the heat pump 3416 (e.g., permitting the coolant to recirculate through the heating circuit 3412).

According to an exemplary embodiment, the arrangement and/or configuration of the components of the HVAC system 180 are configured such that fluid may pool (e.g., flood) and/or be purged from one or more portions of the HVAC system 180. For example, the arrangement of the surge tank 3428 relative to the heat pump 3416 may result in an inlet of the heat pump 3416 being flooded with coolant (e.g., due to the configuration of the conduit 3424, the split joints 3432, 3434, and/or gravity, etc.). Further, the arrangement of the conduit 3424 and/or the split joints 3432, 3434 may divert air within the HVAC system 180 away from a flow of fluid (e.g., away from the inlet of the heat pump 3416, etc.) and/or collect air, for example to enable purging of the air from the HVAC system 180. In some embodiments, one or more vents are added along the conduit 3424, for example to further enable purging. Advantageously, the arrangement of the components of the HVAC system 180 (e.g., the surge tank 3428, the conduit 3424, the split joints 3432, 3434, the heat pump 3416, etc.) allow for the inlet of the heat pump 2416 to be flooded with fluid (e.g., coolant, etc.), while also diverting air away from the inlet of the heat pump 2416, for example to simultaneously facility purging the HVAC system 180.

As shown in FIGS. 131 and 132, the HVAC system 180 further includes a insulative element (e.g., an insulator), shown as seal 3442, configured to provide thermal insulation between the interior of the cabin 30 and the exterior of the cabin 30. The seal 3442 is positioned within the cabin 30 along a wall of the cabin 30 closest to the central area 22 and proximate the floor of the cabin 30. In some embodiments, the seal 3442 is positioned outside of the cabin 30. The seal 3442 includes one or more openings to permit the conduit 3424 to pass therethrough (e.g., between the interior of the cabin 30 and the exterior of the cabin 30).

As shown in FIGS. 14 and 132, the heater 182 is coupled to the frame assembly 12 by a bracket 3444. The bracket 3444 is coupled to the side plate 18 that is closest to the cabin 30 to position the heater 182 within the central area 22. As shown in FIG. 14, the bracket 3444 and the heater 182 are positioned closer to the cabin 30 than the driveshaft 96. The bracket 3444 extends longitudinally and vertically and is configured to protect the heater 182 from contacting the driveshaft 96. In this manner, during operation of the telehandler 10 (e.g., as the driveshaft rotates 96), the bracket 3444 is configured to limit damage to the heater 182 and/or the driveshaft 96 that would otherwise be caused by contact therebetween.

As shown in FIGS. 134-137, the refrigeration circuit 184 includes the compressor 186, the condenser 188, the expansion valve 190, and the evaporator 192 fluidly coupled with each other by a refrigerant conduit, shown as conduit 3450. As described herein, the compressor 186 may include an inverter that converts DC electrical energy (e.g., from the high-voltage battery 132, the HVPDU 134) to AC electrical energy, and/or allows for control of fluid characteristics within the refrigeration circuit 184 (e.g., speed, flow, pressure, etc.). In other embodiments, the compressor 186 receives other suitable energy (e.g., from the low-voltage battery 136, the LVPDM 138, etc.) and/or is otherwise configured (e.g., does not allow for speed or flow control, etc.).

As shown, the conduit 3450 includes one or more straight or bent sections of conduit and is configured to facilitate the flow of fluid (e.g., refrigerant, lubricant, etc.) throughout the refrigeration circuit 184 to perform the cooling. As shown in FIG. 134, the flow of fluid (e.g., refrigerant, etc.) is represented by lines (e.g., the conduit 3450) with arrows representing the direction of the flow of the fluid. The lines shown in FIG. 134 may represent the flow of the fluid through, adjacent to, across, etc. a component of the refrigeration circuit 184 (e.g., through the compressor 186, through the expansion valve 190, across the evaporator 192, etc.).

It should be understood that it is contemplated that in other embodiments, the refrigeration circuit 184 includes additional and/or different components, which may be otherwise arranged or configured. For example, the refrigeration circuit 184 may include additional conduits (e.g., similar to the conduit 3450, etc.), valves (e.g., refrigerant valves, etc.), evaporators (e.g., auxiliary evaporators, etc.), chillers (e.g., coolant chillers, etc.), and/or other suitable components. In this sense, it is contemplated that in some embodiments the refrigeration circuit 184 includes a refrigerant valve (e.g., integrated into the expansion valve 190, etc.) and/or a heat exchanger (e.g., a refrigerant heat exchanger between the condenser outlet and the evaporator outlet, etc.), for example to provide increased efficiencies and/or performance. All such variations and combinations are contemplated herein.

As shown in FIGS. 134-137, the refrigeration circuit 184 includes a first charge port (e.g., service port, access port, fitting, inlet/outlet manifold, etc.), shown as first port 3454, and a second charge port (e.g., service port, access port, fining, inlet/outlet manifold, etc.), shown as second port 3458, fluidly coupled with the conduit 3450. The first port 3454 and the second port 3458 are configured to provide external access to an interior volume defined by the conduit 3450. By way of example, fluid (e.g., refrigerant, lubricant, such as oil, etc.) may be added or removed from the refrigeration circuit 184 through the first port 3454 and/or the second port 3458. By way of another example, a sensor (e.g., pressure sensor, flow rate sensor, sensors 220, etc.) may be coupled with the first port 3454 and/or the second port 3458 to monitor one or more characteristics (e.g., pressure, flow rate, etc.) of the refrigerant circulating through the refrigeration circuit 184. In such an example, data acquired from the sensors may be used by the controller 200 to determine if the refrigeration circuit 184 has leaks, blockages, low refrigerant levels, etc. By way of still another example, air in the conduit 3450 may be evacuated therefrom through the first port 3454 and/or the second port 3458.

As shown in FIGS. 134, 29, and 30, the first port 3454 is positioned along a portion of the conduit 3450 extending between the compressor 186 and the condenser 188. In other words, the first port 3454 is positioned at a first, high pressure side (e.g., the outlet) of the compressor 186. The condenser 188 is positioned along a top and rear side of the cabin 30 within the cabin area 24. The compressor 186 is positioned vertically below the condenser 188 positioned in the central area 22 and coupled to the side plate 18 that is farthest from the cabin 30 such that the first port 3454 is positioned vertically between the compressor 186 and the condenser 188. As shown in FIGS. 135-137, the conduit 3450 fluidly couples with the condenser 188 at an inlet and an outlet thereof positioned along a side of the condenser 188 positioned closest to the central area 22.

As shown in FIGS. 134-136, the second port 3458 is positioned along a portion of the conduit 3450 extending between the compressor 186 and the evaporator 192. In other words, the second port 3458 is positioned at a second, low pressure side (e.g., the inlet, the second side at a relatively lower pressure compared to the pressure at the first side, etc.) of the compressor 186. According to an exemplary embodiment, and as shown in FIG. 134, the compressor 186 is configured to be positioned level with, or below, the evaporator 192, for example to encourage reclamation of fluid within the refrigeration circuit 184 (e.g., reclamation of lubricant by the compressor 186, etc.).

It should be understood that it is contemplated that the components of the refrigeration circuit 184 may be otherwise arranged or configured, and/or may include additional or different components. For example, in some embodiments, the refrigeration circuit 184 includes more or fewer charge ports than the first port 3454 and the second port 3458. For example, the refrigeration circuit 184 may include any suitable number of ports variously positioned along the refrigeration circuit 184, for example to allow for fluid filling, fluid evacuation, and/or installation of any of the components described herein (e.g., sensors, switches, valves, etc.). By way of example, the refrigeration circuit 184 may include a third charge port positioned between the condenser 188 and the expansion valve 190 and/or a fourth charge port positioned between the expansion valve 190 and the evaporator 192.

According to an exemplary embodiment shown in FIG. 135, the refrigeration circuit 184 includes a sensor 220 positioned along a portion of the conduit 3450 extending between the evaporator 192 and the compressor 186 (e.g., at the second, low pressure side of the compressor 186). The sensor 220 may include a pressure transducer configured to monitor the pressure within the conduit 3450. In some embodiments, the refrigeration circuit 184 includes more or fewer sensors 220 positioned along the conduit 3450 (e.g., at the first port 3454, at the second port 3458, etc.). In some embodiments, the sensor 220 is another type of sensor configured to monitor one or more characteristics other than the pressure within the conduit 3450.

The evaporator 192 receives thermal energy from the cabin 30. By way of example, air from the cabin 30 may pass through the evaporator 192 and transfer thermal energy into the refrigerant within the evaporator 192. The fans 194 direct airflow across the evaporator 192 to cool the air within the cabin 30. According to an exemplary embodiment shown in FIG. 134, the evaporator 192 is positioned, at least partially, within the plenum 3400. In other embodiments, the evaporator 192 is positioned outside of plenum 3400.

According to an exemplary embodiment shown in FIGS. 136, the refrigeration circuit 184 includes a filter-drier, shown as drier 3462, positioned along the conduit 3450 between the condenser 188 (e.g., an outlet of the condenser 188) and the expansion valve 190 (e.g., an inlet of the expansion valve 190). The drier 3462 is configured to filter (e.g., remove) contaminants from the refrigerant as the refrigerant passes through the drier 3462. Removing the contaminants may help prevent damage to the various components of the refrigeration circuit 184 and may help improve the efficiency of the refrigeration circuit 184.

### Control of HVAC System

As shown in FIGS. 5, 19, and 139, the user interface 34 includes at least one fust input device (e.g., a first user interface, etc.), shown as fan switch 3500, at least one second input device (e.g., a second user interface, etc.), shown as temperature switch 3504, and at least one third input device (e.g., a third user interface, etc.), shown as air conditioning (AC) switch 3508. In some embodiments, the user interface 34 and/or one or more components thereof (e.g., the fan switch 3500, the temperature switch 3504, the AC switch 3508, etc.) communicate with the controller 200 to exchange information. By way of example, the fan switch 3500, the temperature switch 3504, and the AC switch 3508 may provide one or more inputs to the controller 200 to indicate interactions with the user interface 34. In other words, the fan switch 3500, the temperature switch 3504, and the AC switch 3508 may receive inputs (e.g., from an operator of the telehandler 10) and provide the inputs to the controller 200.

As shown in FIGS. 138 and 139, the fan switch 3500 includes a knob or a dial, the temperature switch 3504 includes a knob or a dial, and the AC switch 3508 includes a switch (e.g., an “on/off” switch). In some embodiments, the fan switch 3500, the temperature switch 3504, and/or the AC switch 3508 include one or more buttons, switches, knobs, levers, dials, keypads, touchscreens, joysticks, etc. As shown in FIGS. 138-139, the fan switch 3500, the temperature switch 3504, and the AC switch 3508 are positioned within the cabin 30 along a wall of the cabin 30 closest to the central area 22. In some embodiments, the fan switch 3500, the temperature switch 3504, and the AC switch 3508 are otherwise positioned within the cabin 30 (e.g., along a dash, on the steering wheel, on an armrest of a seat, etc.).

According to an exemplary embodiment, the fan switch 3500, the temperature switch 3504, and the AC switch 3508 are configured to provide the operator with the ability to control one or more functions of and/or provide commands to the telehandler 10 and the components thereof. Specifically, the fan switch 3500, the temperature switch 3504, and the AC switch 3508 are configured to provide the operator with the ability to control operation of the HVAC system 180 to control the climate within the cabin 30.

According to an exemplary embodiment, the fan switch 3500 is configured to receive an input from the operator indicative of a fan speed of the fans 194 (e.g., a desired fan speed, a volumetric flow rate of the air supplied into the cabin 30, etc.). The fan switch 3500 is configured to provide a signal to the controller 200 indicative of the received input (e.g., the fan speed), and the controller 200 is configured to control the fans 194 (e.g., increase or decrease the rotational speed of the fans 194, provide no power to the fans 194, etc.) in accordance with the received input. By way of example, the operator may provide an input to the fan switch 3500 to power the fans 194 “off,” to power the fans 194 at a maximum speed (e.g., maximum airflow), and/or any other speed of the fans 194 therebetween.

In some embodiments, the fan switch 3500 is coupled with a sensor 220 (e.g., a linear displacement sensor, a linear potentiometer, an encoder, etc.) configured to monitor a position (e.g., a linear displacement, a rotation, etc.) of the fan switch 3500 and provide a signal to the controller 200 indicative of the position. In such embodiments, the sensor 220 is configured to provide (i) a first signal (e.g., a first voltage level) when the fan switch 3500 in a first position associated with a first fan speed and (ii) a second signal (e.g., a second voltage level) when the fan switch 3500 in a second position associated with a second fan speed. By way of example, the fan switch 3500 may be positioned at a first position to turn the fans 194 “off,” a second position to power the fans 194 at a maximum speed, and a third position between the first position and the second position to power the fans 194 at a speed between maximum speed and being powered “off.” In some embodiments, the fan switch 3500 includes buttons associated with a speed of the fans 194 such as a first button associated with the fans 194 being powered “off,” a second button associated with the fans 194 operating at a first speed, a third button associated with the fans 194 operating at a second speed greater than the first speed, etc. In some embodiments, the fan switch 3500 includes a visual indication (e.g., markers, numbers (e.g., “0” through “4”), words (e.g., “off,” “low,” “high,” “maximum,” etc.), symbols, lights, etc.) indicative of the fan speed set by the fan switch 3500.

According to an exemplary embodiment, the temperature switch 3504 is configured to receive an input from the operator indicative of a temperature (e.g., a desired temperature) of the air supplied by the HVAC system 180 into the cabin 30. The temperature switch 3504 is configured to provide a signal to the controller 200 indicative of the received input (e.g., the temperature), and the controller 200 is configured to control the HVAC system 180 in accordance with the received input. In some embodiments, responsive to receiving a signal from the temperature switch 3504 indicative of an input to increase the temperature within the cabin 30, the controller 200 commands the heater 182 to increase the thermal energy transferred to the coolant (e.g., in a coolant-heating system) or increase the thermal energy transferred to the air blown over the heater 182 (e.g., by increasing the voltage and/or current supplied to the heater 182 by the HVPDU 134). In some embodiments, responsive to receiving a signal from the temperature switch 3504 indicative of an input to increase the temperature within the cabin 30, the controller 200 commands the compressor 186 to power “off.” Similarly, in some embodiments, responsive to receiving a signal from the temperature switch 3504 indicative of an input to decrease the temperature within the cabin 30, the controller 200 commands the heater 182 to decrease the thermal energy transferred to the coolant (e.g., in a coolant-heating system) or decrease the thermal energy transferred to the air blown over the heater 182 (e.g., by decreasing the voltage and/or current supplied to the heater 182 by the HVPDU 134). In some embodiments, responsive to receiving a signal from the temperature switch 3504 indicative of an input to decrease the temperature within the cabin 30, the controller 200 commands the compressor 186 to power “on.” By way of example, the HVPDU 134 may increase the voltage and/or current supplied to the compressor 186 (e.g., to drive the compressor 186 faster) to increase the thermal energy removed from the air within the cabin 30 (e.g., to cool the cabin). In some embodiments, the temperature switch 3504 facilitates the user selecting a cabin temperature setpoint such that the controller 200 dynamically controls the HVAC system 180 to maintain or adjust the temperature of the air in the cabin 30 at or to reach the cabin temperature setpoint. By way of example, the controller 200 may power the heater 182 “on” or “off”, vary the voltage and/or current supplied to the heater 182 by the HVPDU 134, power the compressor 186 “on” or “off”, vary the voltage and/or current supplied to the compressor 186 by the HVPDU 134, vary a speed of the fans 194, vary a position of blend doors (e.g., to change the amount of air flowing over the heater 182, a heat exchanger, the evaporator 192, etc.), etc. to maintain or adjust the temperature of the air in the cabin 30 (e.g., based on data collected from a temperature sensor in the cabin 30) at or to reach the cabin temperature setpoint indicated by the temperature switch 3504.

In other vehicles including an internal combustion engine (ICE), coolant is configured to receive thermal energy generated by the ICE to cool the ICE. These other vehicles may include a mixing valve coupled along a portion of a conduit supplying and delivering the coolant. The mixing valve may be used to regulate the flow of hot coolant from the ICE to components such as a heater used to heat the coolant to allow for selective pulling of hot coolant based on heat requirements (e.g., based on an input to a heat input device from an operator). The mixing valve controls whether hot coolant enters the heater core and mixes with cooler coolant. By way of example, the mixing valve may operate (e.g., actuate) to mix a first volume of hot coolant with cooler coolant to heat the cabin to a first temperature and mix a second volume of hot coolant less than the first volume with cooler coolant to heat the cabin to a second temperature less than (e.g., cooler than) the first temperature. In some embodiments, the telehandler 10 of the present disclosure omits a mixing valve such that the coolant flowing through a heating circuit is heated by the heater 182 to control the temperature of the air in the cabin 30 as opposed to a volume of pre-heated coolant (e.g., pre-heated by one or more other components of the telehandler 10) being diverted from the coolant circuit to control the temperature of the air in the cabin 30.

In some embodiments, the temperature switch 3504 is coupled with a sensor 220 (e.g., a linear displacement sensor, a linear potentiometer, an encoder, etc.) configured to monitor a position (e.g., a linear displacement, a rotation, etc.) of the temperature switch 3504 and provide a signal to the controller 200 indicative of the position. In such embodiments, the sensor 220 is configured to provide (i) a first signal (e.g., a first voltage level) when the temperature switch 3504 in a first position associated with a first temperature and (ii) a second signal (e.g., a second voltage level) when the temperature switch 3504 in a second position associated with a second temperature. By way of example, the temperature switch 3504 may be positioned at the first position associated with a minimum cabin temperature (e.g., maximum compressor 186 speed), the second position associated with a maximum cabin temperature (e.g., maximum heater 182 output), and a third position between the first position and the second position associated with a cabin temperature between the minimum and maximum cabin temperatures. In some embodiments, the temperature switch 3504 includes buttons associated with a cabin temperature such as a first button associated with the minimum cabin temperature, a second button associated with a second cabin temperature greater (e.g., warmer) than the minimum cabin temperature, a third cabin temperature greater (e.g., warmer) than the second cabin temperature, etc. In some embodiments, the temperature switch 3504 includes a visual indication (e.g., markers (e.g., blue corresponding with relatively cooler cabin temperatures, red corresponding with relatively warmer cabin temperatures, etc.), numbers (e.g., degrees Fahrenheit, degrees Celsius, etc.), words (e.g., “cold,” “warm,” etc.), symbols, lights, etc.) indicative of the cabin temperature set by the temperature switch 3504.

According to an exemplary embodiment, the AC switch 3508 is configured to receive an input from the operator to power the compressor 186 “on” or “off” (e.g., activate or deactivate air conditioning). The AC switch 3508 is configured to provide a signal to the controller 200 indicative of the received input (e.g., a state of the compressor 186), and the controller 200 is configured to control the HVAC system 180 in accordance with the received input. In some embodiments, responsive to receiving a signal from the AC switch 3508 indicative of an input to activate the air conditioning, the controller 200 commands the compressor 186 to power “on.” By way of example, the controller 200 may electrically isolate the HVPDU 134 from the compressor 186 (e.g., to prevent the HVPDU 134 from providing power to the compressor 186). Similarly, in some embodiments, responsive to receiving a signal from the AC switch 3508 indicative of an input to deactivate the air conditioning, the controller 200 commands the compressor 186 to power “off.” By way of example, the controller 200 may electrically couple the HVPDU 134 with the compressor 186 (e.g., to permit power transfer from the HVPDU 134 to the compressor 186).

In some embodiments, the AC switch 3508 is coupled with a sensor 220 (e.g., a linear displacement sensor, a linear potentiometer, an encoder, etc.) configured to monitor a position (e.g., a linear displacement, a rotation, etc.) of the AC switch 3508 and provide a signal to the controller 200 indicative of the position. In such embodiments, the sensor 220 is configured to provide (i) a first signal (e.g., a first voltage level) when the AC switch 3508 in a first position associated with deactivating the air conditioning and (ii) a second signal (e.g., a second voltage level) when the AC switch 3508 in a second position associated with activating the air conditioning. By way of example, the operator may transition the AC switch 3508 from the first position to the second position to power the compressor 186 “on” or from the second position to the first position to power the compressor 186 “off.” In some embodiments, the AC switch 3508 includes buttons to activate or deactivate the air conditioning. In some embodiments, the AC switch 3508 includes a visual indication (e.g., markers (e.g., blue corresponding with the air conditioning being active, red corresponding with the air conditioning not being active, etc.), numbers, words (e.g., “AC ON,” “AC OFF,” etc.), symbols, lights, etc.) indicative of the status of the compressor 186/air conditioning set by the AC switch 3508.

In some embodiments, the operator provides an input to the AC switch 3508 and the temperature switch 3504 to operate both the compressor 186 (e.g., activate the air conditioning) and the heater 182, respectively, simultaneously. Powering the compressor 186 “on” causes the refrigeration circuit 184 to remove humidity from the air supplied to the cabin 30, and operating the heater 182 heats the air supplied to cabin. Accordingly, in such embodiments, the dehumidified and heated air is supplied to the cabin 30 and may be directed at a window (e.g., a windshield) to clear frost, ice, and/or fog accumulated thereon. In some embodiments, the user interface 34 includes a “defrost” switch, button, knob, etc., configured to receive an input from the operator to operate both the compressor 186 and the heater 182 simultaneously to clear frost, ice, and/or fog (e.g., such that the operator can provide an input to one switch as opposed to providing an input to both the AC switch 3508 and the temperature switch 3504). In some embodiments, the controller 200 is configured to deactivate the air conditioning (e.g., power the compressor 186 “off”) responsive to an input to the temperature switch 3504 corresponding to a temperature greater than a threshold temperature. By way of example, when the compressor 186 is running, and the operator provides an input to the temperature switch 3504 to increase the temperature in the cabin 30 to a temperature that is greater than the threshold temperature, the controller 200 may power the compressor 186 “off.” In some embodiments, the threshold temperature is a temperature associated with a position of the temperature switch 3504 about halfway between a position associated with the minimum cabin temperature and a position associated with the maximum cabin temperature. In some embodiments, the threshold temperature is a temperature that is 50% of the maximum cabin temperature. In other embodiments, the threshold temperature is a temperature greater than or less than 50% of the maximum cabin temperature (e.g., 30%, 40%, 45%, 55%, 60%, 65%, etc.). Operating the compressor 186 and the heater 182 simultaneously when the temperature indicated by the temperature switch 3504 is greater than the threshold temperature may use additional power than is needed to clear frost, ice, and/or fog from the cabin 30. Accordingly, powering the compressor 186 “off” when the temperature indicated by the temperature switch 3504 is greater than the threshold temperature helps to extend the charge duration of the high-voltage battery 132 and/or the low-voltage battery 136 (e.g., by avoiding unnecessary use of the compressor 186 beyond what is needed to clear frost, ice, and/or fog from the cabin 30).

### Thermal Management System

Referring to FIGS. 140-147, a thermal management system for cooling hydraulic and electrical equipment onboard a telehandler is shown, according to at least one exemplary embodiment. The thermal management system includes two cooling circuits including a hydraulic cooling circuit for cooling a hydraulic fluid, and an electrical equipment cooling circuit for cooling electrical equipment (e.g., for cooling a coolant that is circulated through the electrical equipment). Flow through the electrical equipment cooling circuit is powered by electric coolant pumps in an arrangement that does not require the use of any flow control valves. The electrical equipment cooling circuit also includes at least one cooling loop that is shared between an onboard charger and an electric motor, and which are disposed in an end-to-end (e.g., series) arrangement along the at least one cooling loop. Beneficially, arranging the onboard charger and electric motor in series along the at least one cooling loop can reduce the number of connections and pumps required for the electrical equipment cooling system to operate and without substantially reducing cooling performance. In some embodiments, the system may also be equipped with multiple onboard chargers, which may be arranged in series flow arrangement with one another along the at least one cooling loop.

Referring to FIG. 140, the cooling system 170 is configured to cool and control an amount of cooling provided to various electrical and hydraulic equipment onboard the telehandler 10, including the onboard chargers 152, the implement motor 112, the drive motor 90, the implement pump 114, and the steering pump 116. The cooling system 170 includes the radiators 172, the coolant pumps 174, and the fans 176. In some embodiments, the cooling system 170 also includes a surge tank (e.g., a surge reservoir, etc.) that is configured to store a volume of coolant for the cooling system 170, as will be further described.

The first radiator 172a is configured to provide cooling to hydraulic equipment onboard the telehandler 10, and the second radiator 172b is configured to provide cooling to electrical equipment onboard the telehandler 10. The first radiator 172a and the second radiator 172b are co-located in the battery housing 40.

Referring to FIG. 141, a hydraulic cooling system, shown as first cooling system 3800, for cooling the hydraulic system 110 is shown, according to an exemplary embodiment. The first cooling system 3800 is configured to cool hydraulic oil flowing through the hydraulic system 110. The first cooling system 3800 includes the first radiator 172a, the reservoir 120, the implement pump 114, and the steering pump 116. The first cooling system 3800 also includes a temperature sensor, shown as a sensor 3802 that is coupled to the reservoir 120.

The first cooling system 3800 includes a cooling loop 3804 that fluidly couples the first radiator 172a, the reservoir 120, the implement pump 114, and the steering pump 116. The cooling loop 3804 includes hydraulic lines (e.g., conduit, hose, etc.) that fluidly couple the components of the first cooling system 3800 together. In the embodiment of FIG. 141, the cooling loop 3804 couples the implement pump 114 and the steering pump 116 in parallel flow arrangement downstream from the reservoir 120 and upstream from the first radiator 172a. Such an arrangement enables cooling of both the implement pump 114 and the steering pump 116 using at similar temperature ranges and can provide more uniform cooling performance.

Referring to FIGS. 142-143, an electronic cooling system, shown as a second cooling system 3900 is shown, according to an exemplary embodiments. The second cooling system 3900 is configured to cool the onboard chargers 152, the implement motor 112, and the drive motor 90. In some embodiments, and as shown in FIGS. 142-143, the second cooling system 3900 also includes a surge tank, shown as surge reservoir 3902, that is configured to store coolant (e.g., water, ethylene glycol, propylene glycol, etc.) for the second cooling system 3900. In other embodiments, the second cooling system 3900 may include additional, fewer, and/or different components.

In the embodiment of FIGS. 142-143, the second cooling system 3900 includes multiple cooling loops, shown as a fust cooling loop 3904 and a second cooling loop 3906, that fluidly couple various components of the electrical system to the second radiator 172b and the surge reservoir 3902. The first cooling loop 3904 delivers low temperature coolant, from an outlet of the second radiator 172b to the onboard chargers 152 and the implement motor 112. In some embodiments, and as shown in FIG. 142-143, the first cooling loop 3904 fluidly couples the second radiator 172b to the onboard chargers 152 and the implement motor 112 (e.g., a first motor) in series flow arrangement such that coolant flows end to end between the onboard chargers 152 and the implement motor 112.

Referring to FIG. 144, the onboard chargers 152 include a fust onboard charger 152a and an optional second onboard charger 152b that is disposed upstream of the first onboard charger 152a in series flow arrangement with the first onboard charger 152a. Such an arrangement can eliminate the need to operate more than one cooling loop to cool both onboard chargers 152.

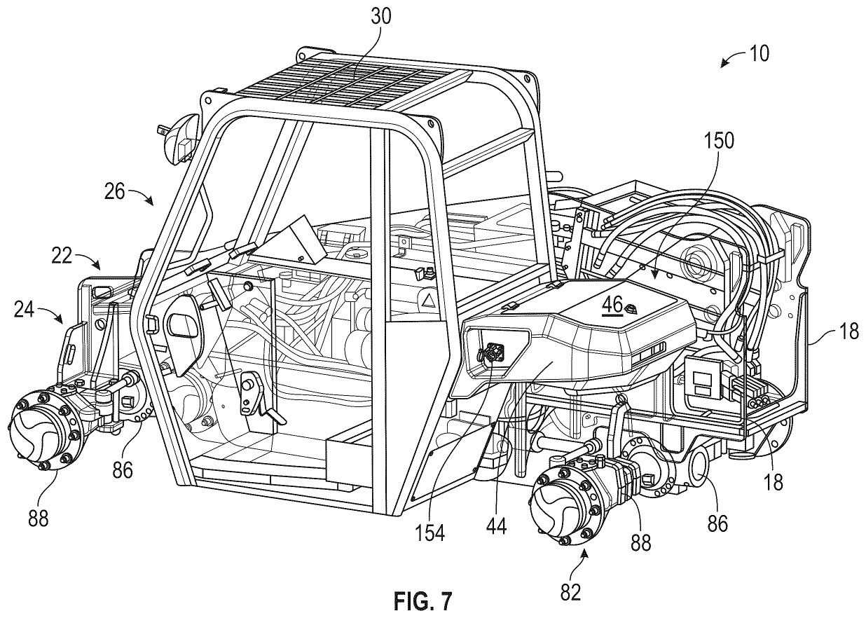

Beneficially, the use of two onboard chargers 152 can increase a maximum supply power that can be provided from the external power source 156 (e.g., via the charging connector 154) the high-voltage battery 132 (see FIG. 7 and FIG. 12). For example, the use of two onboard chargers 152 can provide electrical energy at 240V AC in some embodiments, while a single onboard charger may be limited to 120V AC power.

As shown in FIG. 144, the second onboard charger 152b is disposed vertically below the first onboard charger 152a. In some embodiments, the second onboard charger 152b is coupled to a lower surface of the first onboard charger 152a and/or a mounting panel disposed between the first onboard charger 152a and the second onboard charger 152b. The arrangement of the first onboard charger 152a relative to the second onboard charger 152b can, beneficially, facilitate venting of any air from the first cooling loop 3904 during operation by pushing any air entering the second onboard charger 152b along a natural flow direction for the air within the coolant stream (e.g., by purging any air uphill along the second cooling system 3900). In some embodiments, and as shown in FIG. 144, an outlet of the second onboard charger 152b is fluidly coupled to an inlet of the first onboard charger 152a by a cross-over conduit 3910 (e.g., an intermediate conduit, a jumper hose, etc.).

In some embodiments, the second cooling system 3900 also includes a vent conduit 3912 extending from an outlet of the first onboard charger 152a. The vent conduit 3912 is configured to vent air leaving the first onboard charger 152a and away from the remainder of the first cooling loop 3904. Referring to FIGS. 144-145, the vent conduit 3912 is fluidly coupled to the outlet of the first onboard charger 152a at a first end of the vent conduit 3912, and is fluidly coupled to the surge reservoir 3902 at a second end of the vent conduit 3912. In some embodiments, as shown in FIG. 145, the vent conduit 3912 is also fluidly coupled to an outlet manifold of the second radiator 172b to facilitate venting of (e.g., purging of air from) the second radiator 172b during operation. The first cooling loop 3904 is also fluidly coupled to the surge reservoir 3902 proximate to an outlet of the second radiator 172b.

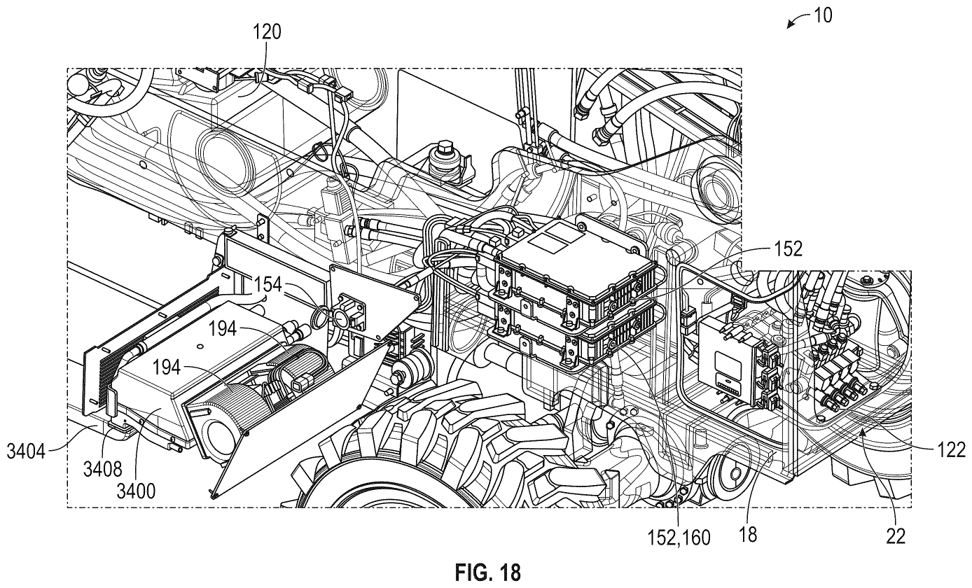

Referring again to FIG. 142, the first onboard charger 152a also includes a DC to DC converter, shown as DC/DC converter 160, integrated therewith. The DC/DC converter 160 is configured to provide energy communication between the high-voltage and low-voltage portions of the electrical system 130 (see FIG. 18). In some embodiments, the DC/DC converter 160 is configured to operate at least partially independently of the first onboard charger 152a and can provide low-voltage power (e.g., power at 12V DC, 24V DC, etc.) to electrical components onboard the telehandler (e.g., display and/or user interface components, etc.).

Referring to FIGS. 142-143, the implement motor 112 is fluidly coupled to the first cooling loop 3904 downstream from the first onboard charger 152a and is configured to receive coolant from the first onboard charger 152a. The DC/DC converter 160 has a much lower cooling requirement as compared to the implement motor 112, which enables co-locating the DC/DC converter 160 and the implement motor 112 in series along the first cooling loop 3904. For example, the DC/DC converter 160 may provide a heat load within a range between approximately 100-300 W (e.g., 150 W, 200 W, 250 W, etc.) whereas the implement motor 112 may provide a heat load within a range between approximately 3000-5000 W (e.g., 3500 W, 4000 W, 4500 W, etc.). The lower cooling requirement of the DC/DC converter 160 as compared to the implement motor 112 enables simultaneous operation of the DC/DC converter 160 and the implement motor 112 without significantly impacting overall cooling performance.

Referring to FIG. 5, the electrical system 130 (e.g., the controller 200) is configured to prevent simultaneous operation of the onboard chargers 152 with the implement motor 112. For example, the controller 200 may be configured to prevent operation of, and/or transmission of command signals to, the implement motor 112 during charging (e.g., when the charging connector 154 is engaged, when power is being received from an external power source 156, etc.). Such an arrangement enables placement of the implement motor 112 and the onboard chargers 152 in series flow arrangement along the first cooling loop 3904 (e.g., see FIG. 142), and eliminates the need for a separate cooling loop in parallel with the first cooling loop 3904 to ensure adequate cooling to the onboard chargers 152 and the implement motor 112. The series flow arrangement can, beneficially, reduce the number of components (e.g., fluid connections, coolant pumps, etc.) that are required to provide cooling to the onboard chargers 152 and the implement motor 112.

Referring to FIGS. 142-143, the second cooling system 3900 also includes a second cooling loop 3906 disposed in parallel flow arrangement with the first cooling loop 3904 (e.g., in a parallel flow arrangement between an inlet and an outlet to the second radiator 172b, etc.) such that both the first cooling loop 3904 and the second cooling loop 3906 receive low temperature coolant (e.g., coolant at approximately the same temperature) from the outlet of the second radiator 172b. The second cooling loop 3906 fluidly couples the second radiator 172b to the drive motor 90 (e.g., a second motor). In other embodiments, the arrangement of the drive motor 90 and the implement motor 112 within the second cooling system 3900 may be reversed.

Referring again to FIG. 142, the second cooling system 3900 also includes a pair of coolant pumps, shown as a first coolant pump 3908 and a second coolant pump 3916, that are each configured to control a flow of coolant through a respective one of the first cooling loop 3904 and the second cooling loop 3906.

Referring to FIG. 146, the first coolant pump 3908 is fluidly coupled to the first cooling loop 3904 and configured to direct coolant through the first cooling loop 3904. The first coolant pump 3908 is disposed in the first cooling loop 3904 between the second radiator 172b and the onboard chargers 152 (e.g., the second onboard charger 152b).

The second coolant pump 3916 is fluidly coupled to the second cooling loop 3906 and is configured to direct coolant through the second cooling loop 3906. The second coolant pump 3916 is disposed in the second cooling loop 3906 between the second radiator 172b and the drive motor 90.

In the embodiment of FIG. 146, both the first coolant pump 3908 and the second coolant pump 3916 proximate to an outlet of the second radiator 172b. The first coolant pump 3908 and the second coolant pump 3916 are each disposed at a location adjacent to a connecting between a respective one of the first cooling loop 3904 and the second cooling loop 3906 and an outlet manifold of the second radiator 172b at an outlet to the second radiator 172b. The first coolant pump 3908 and the second coolant pump 3916 may each include an electric water pump, which can enable independent control of the flow rate through each of the first cooling loop 3904 and the second cooling loop 3906. Such an arrangement, including pumps in each of the cooling loops, can also eliminate the need for flow control valves along the second cooling system 3900.

Referring to FIG. 142, coolant leaving the first cooling loop 3904 and the second cooling loop 3906 (e.g., from the implement motor 112 and the drive motor 90) is directed back to an inlet manifold of the second radiator 172b at an inlet of the second radiator 172b. Referring to FIG. 147, coolant leaving the implement motor 112 and the drive motor 90 is guided back through a shared connection (e.g., a Tee 3918) and a single outlet flow conduit 3920 to the second radiator 172b.

### Cooling Pack Assembly

Referring to FIGS. 148-149, the telehandler 10 includes a cooling pack assembly (e.g., a cooling module), shown as a cooling pack 4000, that includes the cooling equipment for both the first cooling system 3800 (FIG. 141) and the second cooling system 3900 (FIG. 142). The cooling pack 4000 is a disposed (e.g., located and/or positioned) within the battery housing 40. The cooling pack 4000 is structured to move air through at least a portion of the battery housing 40 and across the cooling equipment (e.g., radiators) for both the first cooling system 3800 and the second cooling system 3900.

The cooling pack 4000 is coupled to the frame assembly 12 and extends in a lateral direction 4002 away from the frame assembly 12. Such an arrangement can improve the structural stability of the cooling pack 4000 during operation. In other embodiments, the cooling pack 4000 may be coupled to another part of the telehandler (e.g., the battery housing 40, the cabin 30, etc.). In some embodiments, the cooling pack 4000 is coupled to the side plate 18 of the frame assembly 12. The cooling pack 4000 extends at an angle relative to a longitudinal direction 4004 (e.g., a horizontal direction as shown in FIG. 149) between the front end 14 and the rear end 16 of the telehandler 10. Such an arrangement can facilitate venting of the radiators 172 housed within the cooling pack 4000 during operation, as will be further described.

Referring to FIG. 150, the cooling pack 4000 includes a cooler housing 4006; a fan assembly 4008 including multiple fans 4009, which may be the same as the cooling fans 176 described with reference to FIGS. 5 and 140; and a heat exchanger assembly 4010. In some embodiments, the cooling pack 4000 also includes a fan controller 4012 and the surge reservoir 3902.

The cooler housing 4006 is configured to house the fan assembly 4008 and the heat exchanger assembly 4010, and to couple the cooling pack 4000 to the frame assembly 12 (see FIG. 149). The cooler housing 4006 includes sidewall panels, shown as panels 4015, defining an interior cavity 4014 that is sized to receive the fan assembly 4008 and the heat exchanger assembly 4010 therein. An upper panel of the sidewall panels also defines a pair of fan openings 4016 that are sized to receive at least a portion of the fans 4009 of the fan assembly 4008 therein (e.g., the fan shroud). The fan openings 4016 allow airflow to pass out of the cooler housing 4006 and battery housing 40 (see also FIG. 149). The panels 4015 also define conduit openings 4018 at opposing longitudinal ends of the cooler housing 4006 to facilitate routing of flow connections to/from the heat exchanger assembly 4010.

In the embodiment of FIG. 150, the cooler housing 4006 also includes mounting flanges 4020 defining fastener openings that facilitate mounting of the cooler housing 4006 to the frame assembly 12 (e.g., to the side plate 18 as shown in FIG. 149).

In some embodiments, the cooler housing 4006 also includes a tank support flange 4022 extending away from one of the panels 4015 along the longitudinal direction 4004. The tank support flange 4022 defines an opening that is configured to receive the surge reservoir 3902 therein. The tank support flange 4022 also defines fastener openings to facilitate mounting of the surge reservoir 3902 to the cooler housing 4006. In some embodiments, and as shown in FIG. 150, at least one of the panels 4015 is configured to couple to the fan controller 4012 and supports the fan controller 412 on the cooler housing 4006.

The fan assembly 4008 and the heat exchanger assembly 4010 are both coupled to the cooler housing 4006. The fan assembly 4008 and the heat exchanger assembly 4010 are disposed within the interior cavity 4014 of the cooler housing 4006. In some embodiments, the fan assembly 4008 and the heat exchanger assembly 4010 may be directly connected to one another such that at least a portion of the fan assembly 4008 and the heat exchanger assembly 4010 are engaged with one another. The fan assembly 4008 and the heat exchanger assembly 4010 together form a modular cooling unit 4024 that is removable from the cooler housing 4006 (e.g., that is removably coupled to the cooler housing 4006).

Referring to FIGS. 151-152, the modular cooling unit 4024 including the fan assembly 4008 and the heat exchanger assembly 4010 is shown, according to an exemplary embodiment. The heat exchanger assembly 4010 includes the radiators 172 used for both the hydraulic cooling system (e.g., the first cooling system 3800 of FIG. 141) and the electronic equipment cooling system (e.g., the second cooling system 3900 of FIG. 142). The heat exchanger assembly 4010 includes the first radiator 172a for the hydraulic cooling system and the second radiator 172b for the electronic equipment cooling system.

The first radiator 172a and the second radiator 172 are arranged alongside one another. The first radiator 172a and the second radiator 172b are coupled to one another in a side by side arrangement along the lateral direction 4002. In the embodiment of FIGS. 151-152 (and also referring to FIG. 148), the first radiator 172a is disposed farther away from the frame assembly of the telehandler than the second radiator 172b. In other embodiments, the arrangement of the first radiator 172a and the second radiator 172b may be reversed.

In some embodiments, the cooling pack assembly includes a heat exchanger that is reconfigurable to accommodate various numbers of connections, cooling circuits, and/or sensor arrangements onboard the telehandler. The heat exchanger includes manifolds at opposite ends of the heat exchanger that each include multiple fluid connection ports to enable access by different components to coolant flowing through the heat exchanger core. According to an exemplary embodiment, the cooling pack assembly also includes a second heat exchanger oriented parallel to the first heat exchanger, and configured to provide cooling to a different type of fluid than the first heat exchanger (e.g., hydraulic oil). The second heat exchanger may be configured in a similar manner as the first heat exchanger and may include similar combinations of ports to facilitate different hydraulic system hardware configurations onboard the telehandler.

For example, referring still to FIGS. 151-152, the first radiator 172a and the second radiator 172b each include an inlet manifold 4026, shown as a first inlet manifold 4026a and a second inlet manifold 4026b; an outlet manifold 4028, shown as a first outlet manifold 4028a and a second outlet manifold 4028b; and a heat exchanger core 4030, shown as a first heat exchanger core 4030a and a second heat exchanger core 4030b. The design of the inlet manifolds, the outlet manifolds, and the heat exchanger cores may be similar to (e.g., the same as) one another or different in various embodiments.

The heat exchanger cores are liquid-to-air heat exchangers that are configured to transfer heat from liquid passing therethrough to air passing through the heat exchangers. In some embodiments, the heat exchanger cores include a finned tube or finned coil heat exchanger having tubes that extend at least partially along the longitudinal direction 4004 (see FIG. 149) and that are configured to guide liquid across the heat exchanger cores, and fins extending away from the tubes that conduct heat away from the tubes and into air passing through the heat exchanger core. In other embodiments, the heat exchanger cores may be another type of liquid-to-air heat exchanger design.

Referring to FIGS. 151-152, the second heat exchanger core 4030b is coupled to the first heat exchanger core 4030a in a side by side arrangement along the lateral direction 4002. In some embodiments, the second heat exchanger core 4030b engages the first heat exchanger core 4030a along the lateral direction 4002. Referring to FIG. 148, in some embodiments, the second heat exchanger core 4030b may be spaced laterally apart from the frame assembly 12 by the first heat exchanger core 4030a. In some embodiments, the first heat exchanger core 4030a and the second heat exchanger core 4030b may be of similar size. In some embodiments, the first heat exchanger core 4030a and the second heat exchanger core 4030b together form the shape of a rectangular prism.

The second heat exchanger core 4030b is aligned with the first heat exchanger core 4030a along the longitudinal direction 4004 (e.g., a flow direction) and so that a first liquid flow direction 4032a of liquid passing through the first heat exchanger core 4030a is substantially parallel to a second liquid flow direction 4032b of liquid passing through the second heat exchanger core 4030b.

In some embodiments, and as shown in FIGS. 151-152, a liquid inlet of each of the heat exchanger cores are aligned with one another such that they lie along approximately the same plane. Similarly, a liquid outlet of each of the heat exchangers may lie along approximately the same plane. Such an arrangement can improve distribution of airflow between the first heat exchanger core 4030a and the second heat exchanger core 4030b due to more uniform geometry and positioning of the heat exchangers.

In some embodiments, and as shown, an airflow direction 4031 through each of the first heat exchanger core 4030a and the second heat exchanger core 4030b are substantially parallel to one another. The airflow direction 4031 is perpendicular to both the lateral direction and the liquid flow direction through each heat exchanger core. In the embodiment of FIGS. 151-152, a first air inlet face 4034a of the first heat exchanger core 4030a is substantially parallel to a second air inlet face 4034b of the second heat exchanger core 4030b such that the first air inlet face 4034a and the second air inlet face 4034b together define an inlet plane 4033 that extends across the heat exchanger assembly 4010. Similarly, a first air outlet face 4036a of the first heat exchanger core 4030a is substantially parallel to a second air outlet face 4036b of the second heat exchanger core 4030b such that the first air outlet face 4036a and the second air outlet face 4036b together define an outlet plane that extends across the heat exchanger assembly 4010 on an opposing side of the heat exchanger assembly 4010 as the inlet face.

The flow manifolds of each of the radiators 172 are configured to guide a flow of hydraulic oil or coolant toward or away from the heat exchanger cores. The inlet manifolds are each coupled to a first end (e.g., an inlet end) of a respective one of the heat exchanger cores. The outlet manifolds are each coupled to a second end (e.g., an outlet end) of a respective one of the heat exchanger cores opposite the first end. Referring to FIG. 149, the cooling pack 4000 is oriented at an angle 4035 relative to the longitudinal direction 4004 (e.g., relative to the chassis) such that the outlet manifolds of the radiators are disposed vertically above the inlet manifolds of the radiators. Such an arrangement can facilitate venting of air from the hydraulic and electrical equipment cooling systems by forcing air through the systems during operation along a natural flow direction of air within the hydraulic oil and coolant streams.

Referring to FIGS. 151-152, each of the flow manifolds (including the first inlet manifold 4026a, the first outlet manifold 4028a, the second inlet manifold 4026b, and the second outlet manifold 4028b) includes a manifold body defining an inner volume and/or fluid plena that is configured to guide the flow of liquid (e.g., oil or coolant) into or away from the heat exchanger cores 4030. The first inlet manifold 4026a is coupled (e.g., fastened via bolt or other mechanical fastener) to the second inlet manifold 4026b along the lateral direction between the first inlet manifold 4026a and the second inlet manifold 4026b. Similarly, the first outlet manifold 4028a is coupled to the second outlet manifold 4028b.

Additionally, each of the flow manifolds defines multiple ports that enable different numbers of fluid connections to/from the radiators 172 in different applications. For example, and referring to FIG. 151, a manifold body of the first inlet manifold 4026a defines a first inlet manifold inner volume 4038a and at least three first inlet manifold ports 4040a that are each fluidly coupled to the first inlet manifold inner volume 4038a. The first inlet manifold ports 4040a are oriented at an angle relative to a flow direction through the first heat exchanger core 4030a. At least one of the ports, shown as a first port 4040aa, is disposed on an upper end of the first inlet manifold body and faces at least partially vertically upward and away from the first manifold body. A second port 4040ab is disposed on a lower end of the first inlet manifold body and faces at least partially vertically downward and away from the first manifold body. Beneficially, such an arrangement can enable a greater number of ports along a single manifold body.

In some embodiments, the manifold body also defines fluid ports extending at other angles relative to the flow direction through the heat exchanger cores. For example, as shown in FIG. 151, a manifold body of the second inlet manifold 4026b defines at least one port, shown as a third port 4042ac that extends along a flow direction through the second heat exchanger core 4030b. The size, number, and arrangement of ports may be different in various embodiments.

The ports provide fluid connections between the radiators 172 and other components of the hydraulic and electrical equipment cooling systems (e.g., the first cooling system 3800 shown in FIG. 141, the second cooling system 3900 shown in FIG. 142). In some embodiments, the ports provide fluid connections for cooling loops of the hydraulic and electrical equipment cooling systems. For example, and referring to FIG. 153, an outlet conduit of the cooling loop 3804 for the hydraulic component cooling system is fluidly coupled to the first inlet manifold 4026a through a single port (e.g., the first port 4040aa) in the first inlet manifold 4026a. The remaining ports of the first inlet manifold 4026a are capped off, and can facilitate different (e.g., additional) arrangements of cooling loops in different applications. Similarly, the cooling loops of the second radiator 172b are both fluidly coupled to a single port in the second inlet manifold 4026b.

In some embodiments, the ports facilitate fluid connections for at least one cooling loop as well as at least one sensor for monitoring conditions within or at an inlet/outlet of the radiators 172. For example, referring to FIGS. 154-155, the second outlet manifold 4028b of the second radiator 172b includes separate ports for each cooling loop in the second cooling system (e.g., the first cooling loop 3904 and the second cooling loop 3906 of the electronic equipment cooling system). The second outlet manifold 4028b also includes a port, shown as sensor port 4044 that fluidly couples a sensor (e.g., a temperature sensor) to the outlet end of the second radiator 172b. Such an arrangement enables monitoring of fluid conditions at the inlet of the cooling loops for the second cooling system.

Returning to FIGS. 151-152, the fan assembly 4008 includes at least two air drivers, shown as fans 4009, that are configured to move air through the radiators 172. The fans 4009 may be electric fans powered by an electric motor, or another type of fan, blower, or air moving device. Each of the two fans 4009 also includes an air shroud 4046 coupled between the electric motor and the heat exchanger cores 4030. In some embodiments, the air shroud 4046 for each of the two fans 4009 is engaged with and/or extends from an upper face of both the first heat exchanger core 4030a (e.g., the first air inlet face 4034a) and the second heat exchanger core 4030b (e.g., the second air inlet face 4034b). In some embodiments, the air shrouds 4046 may be coupled to flanges that are substantially parallel with and extend laterally away from the upper face on either lateral side of the heat exchanger assembly 4010.

As shown in FIGS. 151-152, the two fans 4009 (e.g., the air shrouds 4046) are positioned in a side by side arrangement along the liquid flow direction through the heat exchanger cores 4030. Additionally, the two fans 4009 (e.g., the air shrouds 4046) each extend in the lateral direction 4002 across an upper face of both the first heat exchanger core 4030a (e.g., the first air inlet face 4034a) and the second heat exchanger core 4030b (e.g., the second air inlet face 4034b) such that each of the two fans 4009 provides airflow to an approximately one half portion (e.g., an upstream portion or a downstream portion) of both the first heat exchanger core 4030a and the second heat exchanger core 4030b. In such an arrangement, (i) the fans 4009; and (ii) the first heat exchanger core 4030a, and the second heat exchanger core 4030b, form a hashtag coverage profile (e.g., a hashtag arrangement when viewed from above the fans and the heat exchanger cores), with the heat exchanger cores extending in a first direction, and the fans 4009 extending across both of the heat exchanger cores 4030 is a second direction that is substantially perpendicular to the first direction. In such embodiments, the at least two fans each extend in the lateral direction 4002 across an upper face of both the first heat exchanger core 4030a and the second heat exchanger core 4030b in an approximately hashtag profile when viewed substantially perpendicular to the lateral direction 4002 and the first liquid flow direction 4032a. Such an arrangement can improve uniformity of airflow through the heat exchanger cores 4030. Such an arrangement can also provide operational redundancy in case one of the fans malfunctions. In such instances, because the fans provides air to an approximately equal portions of the heat exchanger cores, the risk of overheating is reduced. In other embodiments, the number of fans along the radiators 172 may be different.

Cooling Pack Assembly with Continuously Variable Flow Control

Referring again to FIG. 150, the cooling pack 4000 includes a fan controller 4012 that is configured to control operation of the fans 4009 based on at least one operating condition of the cooling system 170. In some embodiments, the fan controller 4012 forms part of the controller 200. In other embodiments, as shown in FIG. 150, the fan controller 4012 includes a dual fan variable speed controller 4048 that is configured to control the speed of both fans 4009 simultaneously based on inputs from the controller 200. In such embodiments, the dual fan variable speed controller 4048 may include multiple input connections.

In some embodiments, the controller 200 is configured to transmit the same control signal to each input of the dual fan variable speed controller 4048 to coordinate the operating speed of the fans 4009. In other embodiments, and as an alternative to the dual fan variable speed controller 4048, the fan controller 4012 may include a combination of a single variable speed fan controller 4049 and a single fixed speed fan controller 4050. Beneficially, such an arrangement can provide continuous fan speed control while reducing the number, and complexity associated with, multiple variable speed fan controllers.

The variable speed fan controller 4049 may be a pulse-width modulated controller that is configured to vary a frequency of activation of the fan 4009 to control a speed of the fan 4009 to any speed within a range between 0 RPM and a maximum operating speed of the fan 4009. In other embodiments, such as for AC motor-driven fans, the variable speed fan controller 4049 may include a variable frequency drive that is configured to control the speed of the AC motor by varying the frequency and voltage of the electric supply to the fan. In other embodiments, another form of variable speed fan controller may be used (e.g., a triac-based controller, a resistor-based speed controller, etc.).

In some embodiments, the fixed speed fan controller 4050 includes a relay (e.g., an on/off switch) that is configured to actuate the electric fan motor between a deactivated state and an activated state at a fixed operating speed (e.g., a maximum operating speed, a rated operating speed, etc.). In some embodiments, the fixed speed fan controller 4050 is integrated with the variable speed fan controller 4049. In other embodiments, the fixed speed fan controller 4050 is a separate unit and/or switch from the variable speed fan controller 4049.

According to an exemplary embodiment, the variable speed fan controller 4049 and the fixed speed fan controller 4050 are communicably coupled to a respective one of the cooling fans 4009. By way of example, the variable speed fan controller 4049 may be communicably coupled to a first fan 4009a of the pair of fans. The first fan 4009a is disposed across, and in air providing communication with, a first half portion of the radiators 172 (e.g., an upstream portion of the radiators). In the embodiment of FIG. 150, the variable speed fan controller 4049 is communicably coupled to a first fan 4009a that is disposed proximate to an inlet of the radiators 172 along a liquid flow direction through the radiators 172.

The fixed speed fan controller 4050 may be communicably coupled to a second fan 4009b of the pair of fans. The second fan 4009b is disposed across, and in air providing communication with, a second half portion of the radiators 172 (e.g., a downstream portion of the radiators). In the embodiment of FIG. 150, the fixed speed fan controller 4050 is communicably coupled to a second fan 4009b that is disposed proximate to an outlet of the radiators 172 along the liquid flow direction through the radiators 172. In other embodiments, the arrangement of the variable speed fan controller 4049 and the fixed speed fan controller 4050 may be reversed.

The controller 200 is configured to provide command signals to the fixed speed fan controller 4050 and the variable speed fan controller 4049 to control an airflow rate provided by the fans 4009 to the radiators 172. Referring to FIG. 5, the controller 200 is configured to generate command signals based on an operating condition of the cooling system 170. The operating conditions may be based on sensor data from sensors 220 that are disposed along the cooling system 170 (e.g., based on sensor data from sensor(s) 220 disposed along the first cooling system 3800 of FIG. 141 and/or from sensor(s) 220 disposed along the second cooling system 3900 of FIG. 142). For example, the sensor(s) may include at least one of (e.g., one or any combination of) a temperature sensor, a flow rate sensor, or a pressure sensor.

As used herein, “operating condition(s)” may refer to one, or a combination of, a temperature, a pressure, a heat load, a flow rate (e.g., a flow rate of the air or liquid streams through the radiators 172), and/or another condition indicative of thermal performance of the cooling system 170 (e.g., either one or both of the radiators 172). By way of example, the operating condition may refer to a temperature determined from sensor data generated by a temperature sensor at an outlet of the second radiator 172b. In other embodiments, the operating condition may refer to a heat load or another metric that is determined by the controller 200 based on sensor data (e.g., signals) received from multiple sensors 220. For example, the operating condition may refer to a heat flux determined based on a change in temperature across at least one radiator 172, or a combination of both radiators 172, and/or a flow rate of liquid through the at least one radiator 172.

The controller 200 may also be configured to determine various control parameters (e.g., control signals) based on data from the sensors 220 and/or based on control parameters stored in memory 204. For example, the controller 200 may be configured to control operation of the variable speed fan controller 4049 and the fixed speed fan controller 4050 by comparing the operating condition(s) to at least one threshold operating condition stored in memory 204.

Referring to FIG. 156, a method 4100 for controlling operation of a thermal management system including a combination of fixed and variable speed fans is shown, according to an exemplary embodiment. The method 4100 may be performed using the cooling system 170 and cooling pack 4000 described with reference to FIG. 150 and, as such, will be described with reference to components of the cooling system 170 and cooling pack 4000 of FIG. 150. In other embodiments, the method 4100 may include additional, fewer, and/or different operations.

In some embodiments, the method 4100 includes receiving, from a sensor fluidly coupled to one of a first heat exchanger and a second heat exchanger, a first signal that is indicative of a first operating condition at least one of the first heat exchanger or the second heat exchanger, controlling a speed of a first fan that is configured to move air through the first heat exchanger and the second heat exchanger responsive to the first signal based on the first operating condition; receiving, from the sensor, a second signal that is indicative of a second operating condition having a greater cooling requirement than the first condition; and responsive to the second signal: controlling the speed of the first fan based on the second operating condition; and activating a second fan that is configured to move air through the first heat exchanger and the second heat exchanger at a fixed operating speed of the second fan that is independent of the second operating condition.

For example, at operation 4102, the controller (e.g., the controller 200 of FIG. 5, one or more processing circuits, etc.) receives a signal indicative of an operating condition of a heat exchanger. Operation 4102 may include receiving sensor data from any of the sensors that are associated with the cooling system 170 (e.g., the sensors 220, etc.). In some embodiments, operation 4102 may include receiving sensor data from a temperature sensor that is coupled to one of the radiators 172 of the cooling pack 4000.

In some embodiments, operation 4102 also includes determining the operating condition from the sensor data from one or more sensors 220. For example, operation 4102 may include determining a temperature corresponding to the sensor data using a lookup table stored in memory. In other embodiments, operation 4102 may include determining a head load or another parameter from multiple sensor measurements, as described with reference to FIG. 5 above.

In some embodiments, operation 4102 includes determining a desired airflow rate based on the operating conditions. In such embodiments, operation 4102 may include iterating through a lookup table in memory that includes a list of airflow rates corresponding to different operating conditions. In yet other embodiments, operation 4102 includes determining a desired airflow rate and/or airflow command signal using an algorithm stored in memory and/or a user-specified algorithm or correlation.

At operation 4104, the controller compares the operating condition to a threshold operating condition. The threshold operating condition may be stored in memory (e.g., a predefined operating condition), and/or may be determined based on empirical data (e.g., historical data of cooling system 170 operation at different airflow rates, etc.). In other embodiments, the threshold operating condition(s) may be determined based on user inputs. In some embodiments, the threshold operating condition corresponds with an operating condition at which the airflow provided by a single fan is insufficient to satisfy the heat load of the cooling pack assembly (and/or a desired airflow rate through the battery housing 40 as shown in FIG. 149).

If the controller determines that the operating condition does not satisfy (e.g., is less than, is less than a bounding threshold below, or otherwise does not achieve) the threshold operating condition, the method 4100 deactivates the second fan or maintains the second fan in a deactivated state, at 4106. Operation 4106 may include transmitting a first control signal to the fixed speed fan controller 4050 to deactivate the second fan, or ceasing the control signal provided by the controller to the fixed speed fan controller 4050 (e.g., if using a normally open relay configuration).

At operation 4108, the controller controls a speed of the first fan based on the operating condition. In some embodiments, operation 4108 includes determining a desired flow rate and/or fan speed to be provided by the fan, such as using a lookup table or algorithm, as described above with respect to operation 4102. Operation 4108 may also include transmitting a second control signal to the variable speed fan controller 4049 based on the desired flow rate and/or desired fan speed to adjust the speed of the fan. In some embodiments, controlling the speed of the first fan includes controlling the speed of the first fan proportional to the operating condition and/or scaling the speed of the fan based on based on the operating condition (e.g., where the speed of the first fan between 0 RPM and a maximum or rated operating speed may be scaled proportionally to a ratio of (i) a difference between the operating condition and the threshold operating condition and (ii) a difference between an operating condition that requires maximum cooling power and the threshold operating condition, etc.).

Referring back to operation 4104, if the operating condition satisfies (e.g., is greater than or equal to the threshold operating condition or otherwise achieves the threshold operating condition), the method 4100 proceeds to operation 4110. In some embodiments, operation 4104 includes receiving, from the sensor, a signal that is indicative of a second operating condition having a greater cooling requirement than the first condition. At operation 4110, the controller generates a first control signal to activate the second fan at a fixed speed that is the same regardless of the operating condition. For example, operation 4110 may include transmitting a control signal to a relay to switch on the fan to a maximum speed and/or rated operating condition of the fan. In some embodiments, the maximum speed and/or the rated operating condition of the fan may be the same as the maximum or rated operating condition of the first fan. Such arrangements can enable a continuously variable control of overall flow rates of air through the radiators. Operation 4110 may include maintaining operation of the fan at a fixed operating speed regardless of how the operating condition changes above the threshold operating condition. The method 4100 then proceeds to operation 4108 as described above, to control operation of the variable speed fan based on the operating condition, and up to a maximum flow rate of the variable speed fan.

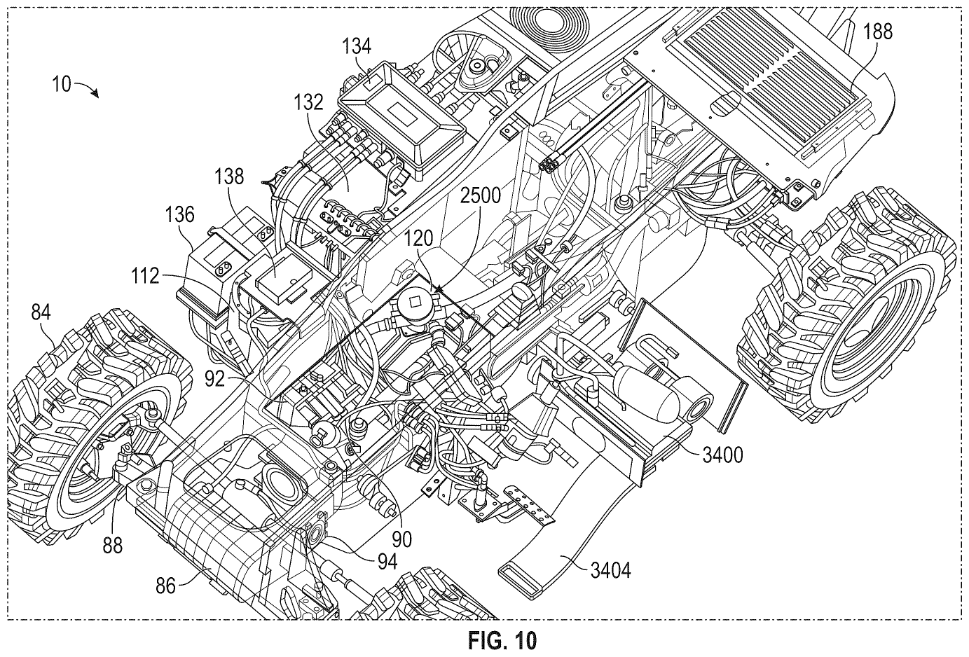

Beneficially, the method 4100 of FIG. 10 enables continuous ramp up of air flow provided to the heat exchanger(s) by the fans without requiring two separate variable speed fan controllers. Such an approach can reduce the complexity of the cooling system, reduce overall energy requirements (by matching airflow rates to heat loads), and reduce noise levels as compared to using multiple fixed speed fans.

### Transition Between Off, Low-Voltage, and High-Voltage Modes

Referring now to FIGS. 157-158, the controller 200 of the telehandler 10 can be configured to selectively transition the telehandler 10 between a plurality of modes of operation. In some embodiments, the telehandler 10 can be configured to transition between an off mode, a low-voltage mode, and a high-voltage mode. The off mode may refer to an operation mode of the telehandler 10 in which both the HVPDU 134 and the LVPDM 138 remain in an uncharged state, and the telehandler 10 is unable to operate (e.g., components or systems of the telehandler 10 are configured to not operate). The low-voltage mode may refer to a mode of operation in the telehandler 10 in which the LVPDM 138 is in a charged state, and the telehandler 10 may operate to perform actions by systems that are powered by the LVPDM 138. For example, when the telehandler 10 is operating in the low-voltage mode, actions may be performed by the HVAC system 180, assuming the HVAC system 180 is a low-voltage system configured to receive power from the LVPDM 138. These low-voltage actions may include operation of the heater 182 or operation of the fans 194, among others. The low-voltage mode may be beneficial during routine vehicle servicing. For example, some sensors 220 may require power to operate, and so must be powered in order to be serviced. The high-voltage mode may refer to a mode of the telehandler 10 in which the HVPDU 134 is in a charged state, and the telehandler 10 may operate to perform actions by systems that are powered by the HVPDU 134. For example, when the telehandler 10 is operating in the high-voltage mode, the controller 200 may selectively operate various components on the telehandler 10, such as the drive motor 90, the lift actuator 70, and the steering actuators 100, among others. Generally, the high-voltage mode is employed to permit most operations of the telehandler 10.

In some embodiments, the telehandler 10 may transition between off, low-voltage, and high-voltage modes through an input received on the user interface 34. By way of example, the user interface 34 may include a switch. The position of the switch may be manually adjustable and correspond to the mode of the telehandler 10. The switch may be configured to open the contactors of at least one of the low-voltage battery 136 or the high-voltage battery 132. In some embodiments, the switch may be a two-position switch. The two-position switch may have two positions, such as an OFF position and an ON position. In other embodiments, the switch may be a three-position switch. The three-position switch may have three positions, such as an OFF position, an ON position, and a RUN position. In some other embodiments, the mode of the telehandler 10 may be adjusted with an alternative input. For example, the mode may be changed through an input on a screen on the user interface 34 or a plurality of buttons, among others. In some embodiments, the mode is adjusted by the controller automatically based on alternative inputs such as an operator presence signal, an inactivity signal, etc.

Referring now to FIG. 157, a flow diagram of a process 4400 of transitioning between the off, low-voltage, and high-voltage modes of the telehandler 10 is shown according to one embodiment. The process 4400 may be performed by a computing system, such as the controller 200 and/or a computing system associated with or embodied in the electrical system 130. By way of example, the process 4400 may be performed by the electrical system 130 with input from the controller 200, which may be prompted by an input from the user interface 34. In this embodiment, the telehandler 10 utilizes a two-position switch on the user interface 34 to transition between modes. For example, the switch may be a rotary switch such as a key switch that has two positions. The switch may also be another type of two-position switch. It should be understood that the order of the process 4400 is shown as an example only. That is, one or more steps of the process 4400 may be performed concurrently, partially concurrently, sequentially, and/or in a different order than as shown in FIG. 157. Additionally, certain steps of the process 4400 may be combined or deleted/omitted.

At step 4402 of the process 4400, the position of the switch is checked. For example, the controller 200 may transmit a signal to the user interface 34 to check the position of the switch. As another example, the controller 200 may receive a signal from the user interface 34 in response to the position of the switch being adjusted. The controller 200 may then determine the position of the switch. For example, the controller 200 may receive an indication that the switch is in the OFF position. In this instance, the process 4400 proceeds to step 4404. In another example, the controller 200 may receive an indication that the switch is in the ON position. In this instance, the process 4400 proceeds to step 4406.

As discussed above, upon determination that the switch is in the OFF position, the process 4400 may proceed to step 4404. At step 4404, the controller 200 may confirm that all the systems of the telehandler 10 are off (i.e., both high-voltage systems and low-voltage systems). To confirm the status of the systems, the controller 200 may communicate with the electrical system 130. For example, the controller 200 may send and/or transmit one or more signals to confirm that the HVPDU 134 and the LVPDM 138 are not charged. In the instance that at least one of the systems of the telehandler is not off, the controller 200 may initiate a shutoff sequence to turn off the systems.

Upon determination that the switch is in the ON position, the process 4400 may proceed to step 4406. At step 4406, the low-voltage systems may be powered on. For example, when the switch is in the ON position, all controllers on the telehandler 10 may be activated. Upon activation, a low-voltage system health check may be performed by a controller on the telehandler 10, such as the controller 200. Upon a successful low-voltage system health check, the telehandler 10 may now be enabled to operate low-voltage components, such as the sensors 220, a radio on the user interface 34, and the battery management system, among others. At this step, the LVPDM 138 may be charged by the low-voltage battery 136. In some embodiments, the telehandler 10 uses a deep-cycle battery as the low-voltage battery 136, such as a lead-acid battery or a lithium-ion battery. As such, the low-voltage battery 136 is equipped to store energy and provide power over a long period of time. This may be beneficial for the low-voltage systems, as the low-voltage systems may be active and/or inactive over an extended period of time.

At step 4408 of the process 4400, following the determination that the switch is in the ON position, the controller 200 may perform a system check. In some embodiments, the system check relates to a process for checking one or more parameters relating to the high-voltage systems. For example, the controller 200 may send and/or transmit one or more signals to one or more high-voltage components or systems (e.g., the drive motor 90) on the telehandler 10 to confirm that proper parameters are being met. Upon a successful system check, the high-voltage components may become available for operation. That is, once the proper parameters are met, the HVPDU 134 may be configured to allow for the receipt of power and the process 4400 may proceed to step 4410. In some embodiments, the system check may also include checking one or more parameters relating to the low-voltage systems. In some embodiments, the operator may produce an input on the user interface 34 to automatically engage the high-voltage system. For example, the operator may move a joystick or a pedal present on the user interface 34. In this instance, the process 4400 may immediately begin at step 4408 to check the health of the high-voltage and/or the low-voltage systems. In other embodiments, operator actions may only be detectable or acted upon only after successful completion of the system check. That is, if the operator moves the joystick on the user interface 34, this input may not be detected or may be ignored if the systems check has not been completed, and the actions associated with the movement of the joystick (e.g., lifting the implement 52) may not occur.

At step 4410 of the process 4400, following the determination that the switch is in the ON position, the high-voltage systems may be powered on. To activate the high-voltage systems, the HVPDU 134 may be pre-charged. For example, the controller 200 may transmit one or more signals to the onboard chargers 152 and/or the high-voltage battery 132 to initiate voltage transmission to the HVPDU 134. The high-voltage main contactors on the high-voltage battery 132 may then be closed for pre-charging of the HVPDU 134. Once the HVPDU 134 is pre-charged, one or more of the other high-voltage components may be enabled. For example, the electrical system 130 may send one or more signals providing an indication to the controller 200 that the high-voltage components may be enabled. The high-voltage components may include the cooling system 170, the hydraulic system 110, the drive motor 90, and the lift actuator 70, among others. In some embodiments, the implement motor 112 of the hydraulic system 110 may be activated to bring the charge pressure, or other important pressure parameters in the telehandler 10, to a preset level. In some embodiments, the display on the user interface 34 may provide an indication that the telehandler is in high-voltage mode (i.e., the high-voltage systems are active). For example, the display may generate a text box with a message, a light, or a symbol to indicate the activation of high-voltage mode. In some embodiments, the telehandler 10 may be configured with a high-voltage cut loop. For instance, while operating in high-voltage mode, the controller 200 may detect a fault within at least one of the high-voltage components or systems. In response, the high-voltage cut loop may automatically disconnect the high-voltage systems or otherwise terminate operation.

Referring now to FIG. 158, a flow diagram of a process 4412 of transitioning between the off, low-voltage, and high-voltage modes of the telehandler 10 is shown, according to one embodiment. The process 4412 may be performed by a computing system, such as the controller 200 and/or a computing system associated with or embodied in the electrical system 130. By way of example, the process 4412 may be performed by the electrical system 130 with input from the controller 200, which may be prompted by an input from the user interface 34. In this embodiment, the telehandler 10 utilizes a three-position switch on the user interface 34 to transition between modes. For example, the switch may be a rotary switch such as a key switch that has three positions. The switch may be any kind of three-position switch. It should be understood that the order of the process 4412 is shown as an example only. That is, one or more steps of the process 4412 may be performed concurrently, partially concurrently, sequentially, and/or in a different order than as shown in FIG. 158. Additionally, certain steps of the process 4412 may be combined or deleted/omitted.

At step 4414 of the process 4412, the position of the switch is checked. For example, the controller 200 may transmit a signal to the user interface 34 to check the position of the switch. As another example, the controller 200 may receive a signal from the user interface 34 in response to the position of the switch being adjusted. The controller 200 may then determine the position of the switch. For example, the controller 200 may receive an indication that the switch is in the OFF position. In this instance, the process 4412 proceeds to step 4416. In another example, the controller 200 may receive an indication that the switch is in the ON position. In this instance, the process 4412 proceeds to step 4418. In another example, the controller 200 may receive an indication that the switch is in the RUN position. In this instance, the process 4412 proceeds to step 4422.

Upon determination that the switch is in the OFF position, the process 4412 may proceed to step 4416. At step 4416, the controller 200 may confirm that all the systems of the telehandler 10 are off (i.e., both high-voltage systems and low-voltage systems). To confirm the status of the systems, the controller 200 may communicate with the electrical system 130. For example, the controller 200 may send and/or transmit one or more signals to confirm that the HVPDU 134 and the LVPDM 138 are not charged. In the instance that at least one of the systems of the telehandler are not off, the controller 200 may initiate a shutoff sequence to turn off the systems. At this step, the controller 200 may also confirm that the low-voltage disconnect 140 is off or disengaged.

Upon determination that the switch is in the ON position, the process 4412 may proceed to step 4418. At step 4418, the low-voltage systems may be turned on. In some embodiments, when the switch is in the ON position, all controllers on the telehandler 10 may be activated. For example, the controllers and/or other modules on the telehandler 10 may wake up to a predetermined power level (e.g., 12 V power). This may be done through a smart ignition relay system. A systems check may then be performed to check the health of the low-voltage systems. For example, the controller 200 may send and/or transmit one or more signals to one or more low-voltage systems (e.g., the HVAC system 180) on the telehandler 10 to confirm that proper parameters are being met. Upon a successful systems check, the low-voltage components may become available for operation. These low-voltage components may include components within the HVAC system 180 (e.g., the fans 194), one or more sensors 220 (e.g., lights), and the user interface 34, among others. In some embodiments, an initial high-voltage systems check may also be performed at this step. For example, the controller 200 may send and/or transmit one or more signals to one or more high-voltage systems (e.g., the drive motor 90, the lift actuator 70, etc.) on the telehandler 10 to confirm that proper parameters are being met based on feedback from those systems. For example, the controller 200 may determine the temperature of the high-voltage battery 132 by querying a temperature sensor associated with the high-voltage battery 132. If the controller 200 determines that the temperature is too high, the process 4412 may be prevented from entering steps 4422 or 4424 until the battery reaches a desirable temperature.

At step 4420 of the process 4412, while the switch remains in the ON position, the high-voltage systems may remain off, with only the low-voltage systems active. That is, the high-voltage operations of the telehandler 10 are not available, such as activation of the drive motor 90. At this step, an indication of the status of the telehandler 10 may be generated to provide an indication that the high-voltage systems are off. For example, a display on the user interface 34 may indicate that the high-voltage main contactors are not closed. In another example, a display on the user interface 34 may include a flashing indicator. To continue this example, the flashing indicator may be a slowly flashing light to indicate to an operator and/or a bystander that the telehandler is in low-voltage mode. The flashing indicator may also indicate that the high-voltage systems check was successful, and the telehandler 10 is ready to pre-charge the HVPDU 134. The flashing indicator may be beneficial to persons in a surrounding environment of the telehandler 10, as it serves as an indication that the telehandler 10 may soon be in motion. Essentially, step 4420 may serve as an indicator to an operator of the telehandler 10 that the systems of the telehandler 10 may proceed to activation of the high-voltage components. In some embodiments, the process 4412 may not activate the high-voltage systems until the low-voltage systems are activated. For example, the low-voltage battery 136 may be required to activate the high-voltage systems.

Upon determination that the switch is in the RUN position, the process 4412 may proceed to step 4422. At step 4422, a system check may be performed. In some embodiments, where an initial high-voltage systems check was not performed at a previous step (i.e., step 4418 or 4420), the controller 200 may perform the initial high-voltage systems check at this step. Upon successful completion of the initial high-voltage systems check, the process 4412 proceeds to perform an additional system check. In some embodiments, the additional system check may include checking specific components of the telehandler 10. For example, the controller 200 may transmit and/or receive one or more signals to or from the brakes 102 to confirm that the brakes 102 are engaged. As another example, the controller 200 may transmit and/or receive one or more signals to or from the user interface 34 to check the position of the joystick (e.g., to confirm that the position of the joystick is in neutral). As another example, the controller 200 may transmit and/or receive one or more signals to or from the user interface 34 to confirm that an operator is present within the telehandler 10 (e.g., confirming that an operator presence switch is on, confirming that a seatbelt engagement sensor detects seatbelt engagement, etc.). In some embodiments, if the requirements of the additional system check are not met, the process 4412 may not proceed further. In this case, the controller 200 may provide an indication to return the switch to the OFF position, thereby restarting the process 4412. Returning to the start of the process 4412 may allow for the systems health checks to be restarted. If the requirements of the additional system check are successfully met, the process 4412 may proceed to step 4424.

At step 4424, the high-voltage systems may be turned on. To activate the high-voltage systems, the HVPDU 134 may be pre-charged. For example, the controller 200 may transmit one or more signals to the high-voltage battery 132 to initiate voltage transmission to the HVPDU 134. The high-voltage main contactors may then be closed upon completion of charging of the HVPDU 134. In some embodiments, where the display on the user interface 34 includes the flashing indicator to indicate low-voltage mode, the flashing indicator may turn off in response to the high-voltage main contactors being closed. Once the HVPDU 134 is pre-charged, the high-voltage components may be enabled. For example, the electrical system 130 may send one or more signals providing an indication to the controller 200 that the high-voltage components may be enabled. The high-voltage components may include the cooling system 170, the hydraulic system 110, the drive motor 90, and the lift actuator 70, among others. In some embodiments, the display on the user interface 34 may provide an indication that the telehandler is in high-voltage mode (i.e., the high-voltage systems are active). For example, the display may generate a text box with a message, a light, or a symbol to indicate the activation of high-voltage mode. In some embodiments, upon activation of the high-voltage systems, the switch may automatically return to the ON position (e.g., by activation of a spring in the switch) but the telehandler 10 may remain in the high-voltage mode. In some embodiments, the telehandler 10 may be configured with a high-voltage cut loop. For instance, while operating in high-voltage mode, the controller 200 may detect a fault within at least one of the high-voltage components or systems. In response, the high-voltage cut loop may automatically disconnect the high-voltage systems or otherwise terminate operation.

In some embodiments, the telehandler 10 may be equipped with a smart ignition relay system. Utilization of the smart ignition relay system may be included as part of the high-voltage system startup sequence. For example, the controller 200 may be equipped with one or more components, such as a smart relay, that may assist in the activation and/or deactivation of the systems on the telehandler 10. In some embodiments, when the controller 200 receives an indication to initiate high-voltage mode, the smart ignition relay system may transmit one or more signals to one or more electric modules on the telehandler 10, such as the DC/DC converter 160. The signals transmitted by the smart ignition relay system may wake up or otherwise activate the electric modules, thereby allowing for the high-voltage startup sequence to begin.

In some embodiments, a beacon (e.g., a light) may be engaged to indicate that the telehandler 10 is in high-voltage mode. For example, upon activation of the high-voltage systems, the controller 200 may transmit a signal to a beacon to turn on. The activation of the beacon may alert bystanders that the telehandler 10 is active and may be in motion. The activation of the beacon may also serve as an additional indicator to the operator that the telehandler 10 is active. In some embodiments, while the telehandler 10 is in low-voltage mode or in the process of entering high-voltage mode, the beacon may flash at a predetermined frequency (e.g., once per second, or 1 Hz). Once high-voltage mode is active, the beacon may transition to displaying a solid light. In some embodiments, a source of noise (e.g., a buzzer) may be implemented in combination with or instead of the beacon to indicate the activity of the telehandler. Utilization of the beacon to indicate high-voltage mode is beneficial, as the electric telehandler 10 does not produce any engine noise as a traditional telehandler would when active. In some embodiments, one or more sensors 220 may be activated upon activation of the high-voltage systems. For example, the sensors may be used to detect pedestrians and other objects in the vicinity of the telehandler 10 when the telehandler 10 is movable.

In some embodiments, the telehandler 10 may transition from the high-voltage mode to a low-voltage mode in response to one or more alternative inputs. In some embodiments, the alternative input includes a measured period of inactivity. For example, if the telehandler 10 is in high-voltage mode but no high-voltage components have been utilized for a predetermined time (e.g., five minutes), the controller 200 may automatically transition the telehandler 10 to low-voltage mode. As another example, the telehandler 10 may automatically transition to low-voltage mode in response to an alternate input including not detecting an operator for a predetermined time. This may be done by communication with the one or more sensors 220, such as a seatbelt engagement sensor or operator presence sensor. The automatic transition to low-voltage mode may prevent unnecessary draining of the high-voltage battery 132. In some embodiments, the operating mode of the vehicle may depend on an input from the charging pod 150. For example, in the instance that the charging connector 154 is connected to the external power source 156, the activation of the low-voltage systems and/or the high-voltage systems may not be permitted.

### Vehicle Shutdown

In some embodiments, the telehandler 10 can be configured to transition into a shutdown sequence. The shutdown sequence can be initiated both manually by a user and automatically. The shutdown sequence refers to a sequence of operations to transition the telehandler 10 from a mode of operation or a safe mode into an off mode. In some embodiments, the telehandler 10 is configured to transmit power to its various systems in such a way that each system has an independent shutdown procedure. For example, the motors (e.g., the drive motor 90) on the telehandler 10 may receive permanent unswitched power from the batteries (e.g., through the HVPDU 134). In this example, the motors may have an independent shutdown procedure from other systems on the telehandler 10, such as low-voltage systems. That is, a shutdown trigger detected by the telehandler 10 may not shut down every system simultaneously, instead activating a sequence of independent system signals to trigger independent shutdowns. In some embodiments, the shutdown sequence must be fully executed upon initiation. That is, once the shutdown sequence begins, the sequence is configured to continue until completion under all circumstances. For example, if an operator initiates shutdown by turning a key switch to an OFF position, the telehandler 10 may enter the shutdown sequence. If the operator then turns the key switch to an ON position while the shutdown sequence is still in progress, the telehandler 10 will not respond to the input and will continue the shutdown. In some embodiments, the shutdown is a phased shutdown. For example, if the operator initiates shutdown by turning a key switch, the vehicle 10 may wait to initiate shutdown until one or more shutdown conditions are met, such as that the drive motor and the implement of the machine are inactive.

Referring now to FIG. 159, a flow diagram of a process of initiating a shutdown sequence of the telehandler of FIG. 1 is shown, according to one embodiment. The process 4430 may be performed by a computing system, such as the controller 200 and/or a computing system associated with or embodied in the electrical system 130. By way of example, the process 4430 may be performed by the electrical system 130 with input from the controller 200, which may be prompted by an input from the user interface 34. In this embodiment, the telehandler 10 utilizes a switch on the user interface 34 to initiate the shutdown sequence. In other embodiments, the shutdown sequence may be initiated as a result of a charger being disconnected from the telehandler 10. It should be understood that the order of the process 4430 is shown as an example only. That is, one or more steps of the process 4430 may be performed concurrently, partially concurrently, sequentially, and/or in a different order than as shown in FIG. 159. Additionally, certain steps of the process 4430 may be combined or deleted/omitted.

At step 4432 of the process 4430, the controller checks for a shutdown trigger. For example, the controller 200 may continuously monitor the systems of the telehandler 10 for a shutdown trigger. In some embodiments, the shutdown trigger may be caused by an input from an operator via the user interface 34. For example, the input may be received from a key switch on the user interface 34. In this example, the shutdown trigger may be received when the key switch is moved to an OFF position. In other embodiments, the shutdown trigger may be caused by an interrupt in the vehicle charging process. For example, the shutdown trigger may be received when the charging connector 154 is disconnected from the external power source 156. If a shutdown trigger is not detected, the process 4430 will return to the beginning of step 4432. If a shutdown trigger is detected, the process 4430 will proceed to step 4434. The shutdown trigger acts as a signal to the controller 200 to begin shutdown procedures but does not, on its own, cut power to all components of the telehandler 10. Beneficially, this allows the telehandler 10 to properly and safely shut down and deenergize the low-voltage and high-voltage systems. In some embodiments, some components of the telehandler 10 are deactivated in response to the shutdown trigger, such as the user interface 34, lights of the telehandler 10, and others. In such embodiments, the other components of the telehandler 10 may remain active.

At step 4434 of the process 4430, the high-voltage components are shut down. For example, the controller 200 may perform a series of actions to shut down the active high-voltage components of the telehandler 10. In some embodiments, the controller 200 may check and neutralize all of the high-voltage functions of the telehandler 10. In some embodiments, the controller 200 may then disable the high-voltage components. For example, the controller 200 may transmit one or more signals to the hydraulic system 110 to disable the operation of the components within the system. The controller 200 may also bring the drive motor 90 and the implement motor 112 to a stop and then depower each of the drive motor 90 and the implement motor 112. Once the high-voltage components are disabled, the controller 200 may then shut down (e.g., cut power to) the high-voltage components. In some embodiments, a display on the user interface 34 may be generated to indicate that the high-voltage components are shutting down. For example, the user interface 34 may display a flashing icon to indicate the shutdown to the operator. In some embodiments, the controller 200 will open the main contactors (i.e., the contactors of the high-voltage battery 132) after successfully shutting down the high-voltage components. In other embodiments, the main contactors may be opened at the end of the process 4430. In some embodiments, step 4434 may include deactivating the cooling system 170.

In some embodiments, a DC/DC converter (such as in the onboard chargers 152) remains active despite being referred to herein as an HV component. The DC/DC converter of the onboard chargers 152 provides low-voltage power to the low-voltage circuit from the high-voltage circuit. The DC/DC converter is kept active to ensure that proper vehicle shutdown can be performed even in the absence of the low-voltage battery 136. When performing vehicle shutdown, each of the component controllers (e.g., controller 200 and any other controllers such as for the drive motor 90, the implement motor 112, a BMS, etc.) remain active to assist with the shutdown of the HV components, including unloading and discharge of the HV bus of the HVPDU 134 as well as opening of main contactors. The controllers such as controller 200 are low-voltage components that require a source of low-voltage power. In embodiments where the low-voltage battery 136 is missing, inoperable, or disconnected from the low-voltage bus (i.e., via a low-voltage battery disconnect), if the DC/DC converter does not remain active, the controllers would not have a source of low-voltage power and would shut down prematurely without safely completing the shutdown procedure. Accordingly, by keeping the DC/DC converter of the onboard chargers 152 active until the end of the process 4430, the telehandler 10 can safely shut down the HV components and discharge the HVPDU 134 even in the absence of the low-voltage battery 136.

At step 4436 of the process 4430, the high-voltage bus of the HVPDU 134 is discharged. For example, the controller 200 may execute a series of actions to discharge the HVPDU 134. In some embodiments, the controller 200 will open the contactors of the high-voltage battery 132 after successfully shutting down the high-voltage components. With the main contactors open, the HVPDU 134 is then actively discharged. In some embodiments, the HVPDU 134 is discharged through the drive motor 90. In some embodiments, the HVPDU 134 is discharged through a steering motor. In some embodiments, the HVPDU 134 is discharged through the implement motor 112. In some embodiments, the HVPDU 134 is discharged through the DC/DC converter of the onboard chargers 152. In some embodiments, the HVPDU 134 is discharged through a combination of one or more of the drive motor 90, the implement motor 112, and the onboard chargers 152. In some embodiments, discharging the HVPDU 134 may be conducted by the inverter 92 or another inverter on the telehandler. In some embodiments, discharging the HVPDU 134 is done within a predetermined time. For example, step 4436 may be executed within a predetermined time (e.g., five seconds). In some embodiments, discharging the HVPDU 134 within the predetermined time may be accomplished with passive measures. For example, the HVPDU 134 can be configured with a desired resistance and/or capacitance of the physical components to allow the HVPDU 134 to discharge at a desired rate. Discharge of the bus during step 4436 proceeds until the HVPDU 134 is at or below a threshold voltage. The threshold voltage may be between 0V and 5V.

At step 4438 of the process 4430, the low-voltage components are shut down. For example, the controller 200 may execute a series of actions to shut down the low-voltage components. For example, the controller 200 may communicate with the HVAC system 180 to shut off the components within the system. In some embodiments, the telehandler 10 may be equipped with a battery management system. Alternatively, the controller 200 may be configured to control and manage the components of the electrical system 130. At this step, the battery management system may also be shut down.

At step 4440 of the process 4430, the smart ignition relay is opened. In some embodiments, the telehandler 10 is equipped with a smart ignition relay system. The smart ignition relay system may assist in the activation and/or deactivation of the systems on the telehandler 10. For example, during operation, signals transmitted by the smart ignition relay system may wake up or otherwise activate the electric modules, thereby allowing for operation of the low-voltage and/or high-voltage systems. At this step, the controller 200 may receive a signal to disconnect the smart ignition relay. Once the smart ignition relay is disconnected, it is no longer able to communicate with the systems and is therefore unable to wake up the systems.

In some embodiments, the telehandler 10 may execute the shutdown sequence of process 4430 in response to being in a normal shutdown scenario. One example of a normal shutdown scenario may relate to a key switch on the user interface 34 being positioned to an OFF position (e.g., from a high-voltage mode to OFF, from a low-voltage mode to OFF, etc.). In some embodiments, a normal shutdown scenario may be achieved when the telehandler 10 is not in active motion. For example, the controller 200 may communicate with one or more high-voltage components, such as the drive motor 90 or the implement motor 112, to determine that the high-voltage components are not in an active state. In some embodiments, in response to receiving an indication of a normal shutdown trigger, some components of the telehandler 10 may automatically shut down. For example, in response to the key switch being transitioned to the OFF position, one or more components on the user interface (e.g., a gauge cluster, lights, etc.) may automatically shut off. In this instance, the other systems of the telehandler 10 (i.e., the low-voltage systems and the high-voltage systems) may remain powered until the HVPDU 134 and/or the LVPDM 138 is discharged.

In some embodiments, the telehandler 10 may execute the shutdown sequence of process 4430 in response to being in an abnormal shutdown scenario. In one exemplary embodiment, the abnormal shutdown scenario may relate to a battery disconnect. For example, if the telehandler 10 is operating in either a high-voltage mode or a low-voltage mode and at least one of the batteries in the electrical system 130 becomes disconnected, the telehandler 10 may enter the shutdown sequence. In other embodiments, an abnormal shutdown scenario may generally refer to shutting down the telehandler 10 in response to various vehicle failures. For example, the controller 200 may continuously monitor a temperature of at least one of the batteries in the electrical system 130. In the instance that the temperature of the battery drops below a predetermined threshold, the controller 200 may initiate the shutdown sequence. As another example, the electrical system 130 may include a high-voltage interlock loop. In the instance that a failure of the high-voltage interlock loop is detected, the controller 200 may initiate the shutdown sequence. In some embodiments, an abnormal shutdown scenario may refer to the shutdown sequence being initiated while the telehandler 10 is in motion. For example, the shutdown sequence may begin when the telehandler 10 is moving downhill, or an operator turns the key switch to the OFF position while traveling at a high speed, among others. In the case of a vehicle failure such as in the above presented examples, the telehandler 10 may be equipped to maintain operations of the active systems for a predetermined amount of time (e.g., the telehandler 10 may continue to operate for five minutes after a vehicle failure has been detected). The telehandler 10 may operate for the predetermined time to allow an operator to safely move the telehandler 10 to a desired location before the shutdown sequence begins. In some embodiments, the telehandler 10 may employ a cut loop to shut down the systems in response to an abnormal shutdown scenario.

In some embodiments, the shutdown sequence of process 4430 may be initiated by a disruption in a charging process. For example, the charging process may wake up the systems of the telehandler 10 in a manner similar to a key switch on the user interface 34. In this instance, when the charging connector 154 is connected to the external power source 156, at least one of the low-voltage systems or the high-voltage systems may be activated. When the controller 200 receives an indication that the connection between the charging connector 154 and the external power source is disconnected, the controller 200 may initiate process 4430. As another example, when the controller 200 receives an indication that the charging process has been completed, the controller 200 may initiate process 4430.

In some embodiments, the telehandler 10 may be equipped with a fault logging system. For example, the controller 200 may be configured to monitor for faults occurring in the systems of the telehandler 10. The fault logging system may detect faults such as abnormal voltage levels, abnormal battery temperatures, abnormal battery states of charge, abnormal motor performance, abnormal inverter operation, among others. While operating in a high-voltage mode or a low-voltage mode, the fault logging system may be used as a safety feature to inform an operator of a potential operation failure. Alternatively, the fault logging system may be used to trigger the shutdown sequence to avoid any further system issues. In some embodiments, the process 4430 may involve disengaging the fault logging system during the shutdown sequence. Disengaging the fault logging system may prevent spurious faults from being detected as a result of the various systems shutting down.

The shutdown sequence of the process 4430 may include braking. In some embodiments, the brakes may be applied automatically. For example, upon receiving a shutdown trigger and initiating the shutdown process, the controller 200 may automatically engage a parking brake, or regenerative braking may be engaged using the drive motor 90. The utilization of automatic braking may be beneficial in order to ensure that the telehandler 10 is not moving while it is shutting down. This may ensure proper shutdown of the systems of the telehandler 10, as well as ensure that the shutdown is executed safely for persons who may be on or near the telehandler 10. In other embodiments, the brakes may not be applied automatically. For example, upon receiving a shutdown trigger while the telehandler 10 is in motion and initiating the shutdown process, the controller 200 may control the implement pump 114 and the steering pump 116 to begin slowly winding down before applying the brakes. In this embodiment, the controller 200 may be configured to control the braking in such a way due to a potential loss of pressure in the accumulator 124. Then, once the implement pump 114 and the steering pump 116 are properly deactivated, the controller 200 may activate the brakes (e.g., the parking brake on the user interface 34 or regenerative braking) as desired. This alternative braking process may be beneficial, as otherwise sudden braking of the telehandler 10 may result in a loss of steering.

In some embodiments, the telehandler 10 may include a manual service disconnect. For example, the user interface 34 may include a feature, such as an icon on a screen, a button, or a removable component with an integrated fuse to manually disconnect the systems from receiving power. In the shutdown sequence, the high-voltage contactor on the high-voltage battery 132 opens to terminate voltage flow to the high-voltage systems. In some instances, in a machine fault, the contactor may become welded shut, thereby preventing proper shutting down of the high-voltage systems. Therefore, the manual service disconnect may allow for an operator to manually initiate shutdown of the high-voltage systems.

### Standby Mode

The telehandler 10 can be configured to transition into a standby mode. The standby mode may refer to an idle state of operation. In some embodiments, standby mode may refer to a mode that is an intermediate mode in between a high-voltage mode of operation and a low-voltage mode of operation. For example, in standby mode, the HVPDU 134 may be charged to a high-voltage or active state (e.g., the telehandler 10 is operating in a high-voltage mode), but the HV components of the telehandler 10 are not being used beyond being in that state. In this instance, the standby mode refers to an idle state of the HVPDU 134 or other HV components of the telehandler 10, rather than the entire telehandler 10 (i.e., other components such as the DC/DC converter 160 may still receive power while in standby mode). In some embodiments, standby mode may be entered after the telehandler 10 has been in high-voltage mode but not active (e.g., no input has been received from the user interface 34) for a predetermined time threshold. In some embodiments, standby mode may be initiated in response to a SOC of the battery 132 falling below a predetermined threshold value. While in standby mode, the telehandler 10 may not receive active commands, such as a drive command or an implement command. In some embodiments, the standby mode may be configured to maintain operation of certain creature comfort features, such as HVAC features and sound systems (e.g., radio).

Referring now to FIG. 160, a flow diagram of a process 4442 of initiating a standby mode on the telehandler of FIG. 1 is shown, according to one embodiment. The process 4442 may be performed by a computing system, such as the controller 200 and/or a computing system associated with or embodied in the electrical system 130. By way of example, the process 4442 may be performed by the electrical system 130 with input from the controller 200, which may be prompted via communication with various systems of the telehandler 10.

At step 4444 of the process 4442, the mode of operation of the telehandler 10 is checked. For example, the controller 200 may receive at least one signal from at least one component or system on the telehandler 10 to indicate the mode of operation (e.g., HVAC system 180, hydraulic system 110, etc.). In some embodiments, the telehandler 10 may be configured to operate in a plurality of modes, such as an off mode, a low-voltage mode, and a high-voltage mode. Based on the communication between the systems on the telehandler 10, the controller 200 may determine the mode of operation. For example, the controller 200 may determine that the telehandler 10 is either operating in a low-voltage mode or is off. In this instance, the process 4442 proceeds to step 4446. In another example, the controller 200 may determine that the telehandler 10 is operating in the high-voltage mode. In this instance, the process 4442 proceeds to step 4448. In some embodiments, the telehandler 10 is configured to enter standby mode based on being idle while in high-voltage mode or based on an SOC of the battery 132 falling below a predetermined threshold level. This may require an ignition switch/key switch on the user interface 34 to be maintained in an ON position.

Upon determination that the telehandler 10 is operating in either low-voltage mode or off, the process 4442 proceeds to step 4446. At step 4446, the telehandler 10 performs in the current mode of operation (i.e., low-voltage mode or off). For example, the telehandler 10 may continue to operate in the low-voltage mode. Low-voltage mode may relate to a mode of operation in which the low-voltage components of the telehandler 10 are available for operation, but the high-voltage components are not available (i.e., the HVPDU 134 is not charged). For example, in low-voltage mode, the telehandler 10 may be able to perform operations performed by the HVAC system 180. In the instance that the telehandler 10 is determined to be off, it will remain in the off position.

Upon determination that the telehandler 10 is operating in high-voltage mode, the process 4442 proceeds to step 4448. At step 4448, the telehandler 10 performs in the current mode of operation (i.e., high-voltage mode). For example, the telehandler 10 may continue to operate in high-voltage mode. High-voltage mode may relate to a mode of operation in which all the components, including high-voltage components, are available for operation (i.e., the HVPDU 134 is charged and configured to transmit power to the high-voltage components). For example, in high-voltage mode, the telehandler 10 may be configured to operate the drive motor 90 and the lift actuator 70, among others.

At step 4450 of the process 4442, the telehandler 10 will determine a time that has elapsed since an input has been received. Based on the input received, the controller 200 may determine a time that has elapsed. For example, the controller 200 may determine that a predetermined time has elapsed (e.g., two minutes) since the telehandler 10 has received an input and/or performed an action. The predetermined time may be preprogrammed into the controller 200 and represent a time that must elapse in order for the telehandler 10 to enter standby mode. In this instance, the process 4442 may proceed to step 4452. In another example, the controller 200 may determine that the predetermined time has not elapsed. In this instance, the process 4442 may go back to step 4448 and the telehandler 10 may remain in high-voltage mode. In other embodiments, the process 4442 may go back to the beginning of step 4450. In some embodiments, step 4450 may be replaced by receiving a trigger from the electrical system 130. For example, the process 4442 may proceed to step 4452 in response to at least one of the high-voltage battery 132 or the low-voltage battery 136 reaching a minimum state of charge.

In some embodiments at step 4450 the controller 200 additionally and/or alternatively checks a SOC level of the battery 132. If the SOC level falls below a predetermined threshold level, the process 4442 proceeds to step 4452. As long as the SOC level is above the predetermined threshold (e.g., above a minimum SOC) the process 4442 can revert back to step 4448.

At step 4452 of the process 4442, the telehandler 10 will enter standby mode. For example, the controller 200 may transmit a series of signals to various systems of the telehandler 10 to activate the standby mode. For example, the controller 200 may be configured to communicate with various high-voltage components to terminate further action and/or disconnect the components from power. For example, the controller 200 may transmit one or more signals to cease all commands to the drive motor 90, the lift actuator 70, or the brakes 102, among others. In the standby mode, the HV components (e.g., the drive motor 90, the lift actuator 70, the implement motor 112, etc.) may still be electrically coupled to the HVPDU 134, but the controller 200 will limit/stop any operation of the components. For example, the standby mode of the telehandler 10 may be preconfigured to allow for only certain high-voltage components to be available while in the standby mode. In some embodiments, the HVAC system 180 may be configured to receive power from the high-voltage battery 132 (i.e., through the HVPDU 134). In this embodiment, while in standby mode, the telehandler 10 may still have the ability to perform operations on the HVAC system 180. In some embodiments, some charging processes that typically require high-voltage mode may be available in standby mode. For example, the charging process for the low-voltage battery 136 may require utilization of one or more high-voltage components. In this instance, in standby mode, the telehandler 10 may be configured to continue and/or begin the charging process of the low-voltage battery 136. In some embodiments, when standby mode has been entered, a timer may be started. For example, the controller 200 may initiate a timer in order to determine the amount of time that elapses while the telehandler 10 is in standby mode.

In some embodiments, the telehandler 10 may be equipped to provide an indication that the telehandler 10 is in standby mode. For example, the telehandler 10 may be equipped with a beacon (e.g., a light) on the user interface 34. In some embodiments, the controller 200 may communicate with the beacon to operate the beacon in different modes in accordance with the mode of the telehandler 10. For example, the beacon may be configured to flash at a predetermined frequency (i.e., standby beacon frequency) to indicate that the telehandler 10 is in standby mode (e.g., 1 flash per second and/or 1 Hz). In some embodiments, the beacon may be configured to display a different color light to indicate standby mode. As an example, the beacon may display a red light during normal operation modes and display a yellow light during standby mode. The beacon may also be configured to flash at a second predetermined frequency to differentiate between standby mode and low-voltage mode. For example, when the telehandler 10 is operating in low-voltage mode, the beacon may be configured to flash at a second, faster predetermined frequency (i.e., low-voltage beacon frequency) to indicate the operation of low-voltage mode (e.g., 10 flashes per second and/or 10 Hz). In the instance that the beacon is flashing at the standby beacon frequency and the telehandler 10 receives an input to resume operation in high-voltage mode, the beacon may execute a flashing sequence indicating the change in mode. In the instance that the beacon is flashing at the standby beacon frequency and the telehandler 10 initiates a shutdown sequence, the beacon may also execute the same or a different flashing sequence indicating the change in mode. The controller 200 may then transmit one or more signals to the beacon to terminate the flashing of the beacon. Utilization of the beacon may permit increased safety in the work environment, as it may serve to warn workers in the area of potential machine movement.

At step 4454 of the process 4442, the telehandler 10 will check for an input (e.g., from the user interface 34). For example, the controller 200 may be configured to continuously monitor for an input from a high-voltage component while in standby mode. In some embodiments, the controller 200 may only monitor for an input relating to a predetermined selection of high-voltage components, such as an input from the user interface 34 to request operation of the drive motor 90. In this example, a key switch on the user interface 34 may be turned to a position that correlates with high-voltage mode. For example, if the standby mode is configured to allow for the operation of the HVAC system 180, as described in step 4452, the controller 200 may not monitor for an input from the HVAC system 180. In some scenarios, the controller 200 may receive an input at this step. In this instance, the process 4442 may return to step 4448. This may also include resetting the timer to indicate that standby mode has been terminated. In some other scenarios, the controller 200 may not receive an input. In this instance, the process 4442 may proceed to step 4456.

At step 4456, the telehandler 10 will determine a time that has elapsed since the telehandler 10 has entered standby mode. For example, the controller 200 may check a timer that began at the start of standby mode to determine a time that has elapsed since standby mode began. In some embodiments, the telehandler 10 may be configured to operate in standby mode for a predetermined time period. For example, the controller 200 may be configured to detect a shutdown threshold, which may be an amount of time that the timer may reach while in standby mode (e.g., the shutdown threshold may be reached after five minutes in standby mode has elapsed). The controller 200 may be able to determine if the shutdown threshold has been reached based on receiving information from the timer. For example, the controller 200 may determine that the standby time is less than the shutdown threshold. In this instance, the process 4442 may return to step 4454. In other embodiments, upon determining that the standby time is less than the shutdown threshold, the process 4442 may return to the beginning of step 4456. In another example, the controller 200 may determine that the standby time has met or exceeded the shutdown threshold. In this instance, the process 4442 may proceed to step 4458.

At step 4458, the telehandler 10 may shut down. For example, the controller 200 may send one or more signals to one or more components on the telehandler 10 to initiate a shutdown sequence. The shutdown sequence may be initiated in response to the telehandler 10 operating in standby mode for an extended time (i.e., the shutdown threshold was exceeded). In some embodiments, the telehandler 10 may shut down based on one or more parameters of one or more components of the electrical system 130. For example, in standby mode, the HVPDU 134 may begin discharging in order to de-energize the systems of the telehandler 10. This may be done in order to reduce unnecessary power loss. In this instance, the shutdown sequence may be activated when the HVPDU 134 reaches a predetermined level of charge. For example, the shutdown sequence may be activated when the HVPDU 134 reaches a state of charge of 8%. In this shutdown sequence, the controller 200 may initiate shutdown of all components in the telehandler 10, followed by disengaging a high-voltage contactor within the high-voltage battery 132 to ensure that all components can complete a successful shutdown. In some embodiments, the telehandler 10 may be shut down in response to receiving a manual input from an operator. For example, the operator may turn a key switch on the user interface 34 to initiate the shutdown sequence. In some embodiments, during the shutdown sequence, some operations may stay active and available to the operator. For example, the features within the user interface 34 (e.g., a gauge cluster) that may be powered by the low-voltage battery 136 may remain powered during the shutdown sequence. The user interface 34 may be equipped with one or more features to indicate mode of operation, such as a light mounted on the user interface 34. In some embodiments, the light may flash to indicate that the telehandler 10 is shutting down. In other embodiments, the light may shut off to indicate that the high-voltage systems are shutting off. In some embodiments, the shutdown sequence may not be interrupted once initiated.

In some embodiments, the shutdown sequence involves automatically engaging the brakes 102 and performing regen with the drive motor 90 and/or the implement motor 112 to slow the telehandler 10. Further, the shutdown sequence may include automatically shutting down the telehandler 10 including discharging the HVPDU 134 within a predetermined time period, such as 5 seconds. This allows an operator time to make the telehandler 10 safe before shutdown.

### Drive, Steer, and Brake

In some embodiments, the telehandler 10 may be configured to perform drive, steer, and/or brake commands. In some embodiments, the commands may be performed in response to receiving an indication or request to perform the command. For example, the telehandler 10 may receive an indication in the form of an input received from an operator via the user interface 34. In some embodiments, the telehandler 10 may be configured to perform the commands while operating in a high-voltage mode. For example, the telehandler 10 may be configured to operate in a plurality of modes of operation, such as an off mode, a low-voltage mode, and a high-voltage mode. The off mode may refer to a mode of the telehandler 10 in which both the HVPDU 134 and the LVPDM 138 remain in an uncharged state, and the telehandler 10 is unable to operate. The low-voltage mode may refer to a mode of the telehandler 10 in which the LVPDM 138 is in a charged state, and the telehandler 10 may operate to perform actions using systems that are powered by the LVPDM 138. For example, when the telehandler 10 is operating in the low-voltage mode, actions may be performed by the HVAC system 180, assuming the HVAC system 180 is configured to receive power from the LVPDM 138. These actions may include operation of the heater 182 or operation of the fans 194, among others. The high-voltage mode may refer to a mode of the telehandler 10 in which the HVPDU 134 is in a charged state, and the telehandler 10 may operate to perform actions using systems that are powered by the HVPDU 134. For example, when the telehandler 10 is operating in the high-voltage mode, the controller 200 may selectively operate various components on the telehandler 10, such as the drive motor 90 or the lift actuator 70, among others.

Referring now to FIG. 161, a flow diagram of a process 4460 of transitioning between drive, steer, and brake commands in the telehandler 10 of FIG. 1, according to one embodiment. The process 4460 may be performed by a computing system, such as the controller 200 and/or a computing system associated with or embodied in the electrical system 130. By way of example, the process 4460 may be performed by the electrical system 130 with input from the controller 200, which may be prompted by an input from the user interface 34. In this embodiment, the user interface 34 may include a plurality of input components, including a joystick, a parking brake, a switch, a button, among others. It should be understood that the order of the process 4460 is shown as an example only. That is, one or more steps of the process 4460 may be performed concurrently, partially concurrently, sequentially, and/or in a different order than as shown in FIG. 161.

At step 4461, the operating mode of the telehandler 10 is determined. For example, the controller 200 may receive at least one signal from at least one component or system on the telehandler 10 to indicate the mode of operation (e.g., HVAC system 180, hydraulic system 110, etc.). In some embodiments, the telehandler 10 may be configured to operate in a plurality of modes, such as an off mode, a low-voltage mode, and a high-voltage mode. Based on the communication between the systems and the telehandler 10, the controller 200 may determine the mode of operation. For example, the controller 200 may determine that the telehandler 10 is either off or operating in a low-voltage mode. In this instance, the process 4460 may proceed to step 4462. In another example, the controller 200 may determine that the telehandler 10 is operating in the high-voltage mode. In this instance, the process 4460 may proceed to step 4463.

Upon determination that the telehandler 10 is either off or operating in the low-voltage mode, the process 4460 proceeds to step 4462. At step 4462, the telehandler 10 may operate in the determined operating mode. For example, the telehandler 10 may continue to operate in the low-voltage mode. Low-voltage mode may refer to a mode of operation in which the low-voltage components of the telehandler 10 are available for operation, but the high-voltage components are not available (i.e., the HVPDU 134 is not charged). For example, in low-voltage mode, the telehandler 10 may be able to perform operations performed by the HVAC system 180. In the instance that the telehandler 10 is determined to be off, it will remain off.

Upon determination that the telehandler 10 is operating in the high-voltage mode, the process 4460 proceeds to step 4463. At step 4463, the telehandler 10 may operate in the determined operating mode. For example, the telehandler 10 may continue to operate in high-voltage mode. High-voltage mode may refer to a mode of operation in which all the components, including high-voltage components, are available for operation (i.e., the HVPDU 134 is charged and configured to transmit power to the high-voltage components). For example, in high-voltage mode, the telehandler 10 may be configured to operate the drive motor 90 or the lift actuator 70, among others.

At step 4464, the telehandler 10 may determine that at least one of a drive, steer, or brake command is chosen. For example, the controller 200 may receive an indication/input that indicates that an operator of the telehandler 10 is requesting to perform either the drive, steer, or brake command. In some embodiments, the input may be received from one or more components on the user interface 34. In some embodiments, the controller 200 may determine that the drive command performance has been requested. For example, the controller 200 may receive an indication that a parking brake on the user interface 34 has been released by the operator. As another example, the controller 200 may receive an indication that a joystick on the user interface 34 has been shifted to a drive position. In this embodiment, upon determination that the drive command performance has been requested, the process 4460 may proceed to step 4465. In some embodiments, the controller 200 may determine that the steer command has been requested. For example, the controller 200 may receive an indication that a steering wheel on the user interface 34 has been shifted. In this embodiment, upon determination that the steer command performance has been requested, the process 4460 may proceed to step 4466. In some embodiments, the controller 200 may determine that the brake command has been requested. For example, the controller 200 may receive an indication that a brake pedal on the user interface 34 has been pressed by the operator. In this embodiment, upon determination that the brake command performance has been requested, the process 4460 may proceed to step 4467. In some embodiments, at this step, the controller 200 may not receive an input or an indication to perform any of the described commands. In this instance, the process 4460 may return to step 4463. Alternatively, the process 4460 may return to the beginning of step 4464.

At step 4465, the drive command may be performed. In some embodiments, the controller 200 may communicate with at least one component and/or system of the telehandler 10 in order to initiate driving. For example, the controller 200 may communicate with the drive motor 90 to provide a torque to the wheels 84. In some embodiments, the controller 200 may perform a series of systems checks in order to allow for the performance of the drive command. For example, the controller 200 may communicate with the electrical system 130 to confirm that the contactors associated with the HVPDU 134 and the high-voltage battery 132 are closed. As another example, the controller 200 may communicate with a steering system and/or a braking system on the telehandler 10 to confirm that they are ready to be operated. As another example, the controller 200 may communicate with the brakes 102, such as a brake pressure sensor, to indicate that the pressure in the brakes is at an optimal level. As another example, the controller 200 may communicate with the user interface 34 to indicate that the telehandler 10 is ready for the drive command, such as communicating with a parking brake or a joystick on the user interface 34. In some embodiments, the drive command may be prohibited until a parking brake is released.

While the telehandler 10 is successfully performing the drive command, the wheels 84 are supplied torque to move the telehandler 10. In some embodiments, the controller 200 may receive (or the drive command may include) a speed command indicating the desired speed of the telehandler 10. For example, the user interface 34 may be configured to receive an input from the operator which indicates the desired speed. In some embodiments, the speed of the telehandler 10 may be reduced based on the speed command. For example, if the speed command is reduced, the controller 200 may respond by initiating regenerative braking. In other embodiments, the speed command may be used to increase the speed of the telehandler 10. For example, the user interface 34 may include an accelerator pedal to allow the operator to request acceleration of the vehicle. In the instance that the accelerator pedal has been moved out of the neutral position (i.e., the operator has requested to accelerate the telehandler 10), the speed command may be gradually increased to allow for the telehandler 10 to safely gain speed. In some embodiments, the performance of the drive command may have an inversely proportional relationship to brake pressure. For example, the controller 200 may monitor a pressure related to a brake coupled to the user interface 34. In this example, when the operator applies pressure to the brake, the drive command may be configured to reduce the speed of the telehandler 10. In this example, the telehandler 10 may still drive to an extent of reduced speed. The relationship between the drive command and brake pressure may be beneficial for use in driving uphill. For example, the use of the braking system may assist with managing speed while traveling uphill by maintaining control, preventing rollback, and maintaining stability.

In some embodiments, the drive command may be controlled with an accelerator input. For example, the user interface 34 may include an accelerator pedal that may receive an input from the operator. When the operator presses or otherwise applies pressure to the accelerator pedal, the controller 200 may ramp up the speed command. Based on the speed command, the drive motor 90 may produce a corresponding torque to transmit to the wheels 84. In some embodiments, the accelerator pedal may be configured with a spring to spring-return to a neutral position after being pressed. In some embodiments, the accelerator input may be received from a throttle on the user interface 34. For example, the user interface 34 may include a lever or a knob to adjust the throttle position, which thereby may correspond to a desired level of speed. In some embodiments, the drive command performance may require input from the sensors 220. For example, the sensors 220 may include an operator presence sensor, such as a seatbelt engagement sensor. In this example, if the controller 200 receives an indication from the sensors 220 that the operator is no longer present and/or the seatbelt is no longer engaged, the drive command performance may be terminated.

In some embodiments, the speed command provided by a user via the user interface 34 may be treated as a command for a proportion of a maximum allowable speed. In such embodiments, the controller 200 sets a maximum allowable speed. In some embodiments, the maximum allowable speed is determined automatically by the controller based on one or more conditions of the road or surface on which the telehandler 10 is positioned, one or more conditions of the telehandler 10, or one or more operating instructions. In some embodiments, the maximum allowable speed is determined based at least in part on a condition of a surface on which the telehandler 10 is positioned. For example, the maximum allowable speed may be lower on a wet road than on a dry road, and the maximum allowable speed may be lower on gravel than on asphalt. In some embodiments, the maximum allowable speed is determined based at least in part on a condition of the telehandler 10. For example, the maximum allowable speed may be lower when the boom assembly 50 is extended than when it is retracted, and the maximum allowable speed may be lower when the telehandler 10 is carrying a heavy load than when carrying a lighter load or unloaded. In some embodiments, the maximum allowable speed is received by the controller 200 from a remote source, such as a GPS mapping or routing system.

Pedal inputs provided through the user interface 34 may be interpreted as proportional commands for the maximum allowable speed. For example, fully depressing the accelerator pedal may correspond to the speed command provided from the controller 200 to the drive motor 90 causing the drive motor 90 to drive the telehandler 10 at the maximum allowable speed. Depressing the accelerator pedal 80% of the maximum depressed distance may correspond to 80% of the allowable speed, etc. In such embodiments, 80% of the pedal may correspond to different actual vehicle speeds if the maximum allowable speed changes from a first maximum allowable speed to a second maximum allowable speed. The maximum allowable speed may be variable and may change automatically as the telehandler 10 moves from a first position to a second position, from a first road surface to a second road surface, based on the position of the implement 52, etc. In some embodiments, the user interface 34 further includes a user-actuated button, switch, or control to allow a user to override the maximum allowable speed.

In some embodiments, the speed command is further based on a slope of the surface under the telehandler 10. In some embodiments, the controller 200 may be configured to receive sensor data from one or more of the sensors 220 (e.g., accelerometers) and to determine the slope of the surface based on the sensor data. The speed command is based on the slope to compensate for the telehandler 10 traveling up and down hills. When the slope is a positive slope (i.e., uphill) the speed command may be increased, and when the slope is a negative slope (i.e., downhill) the speed command may be decreased. In some embodiments, the speed command is adjusted such that, when the input from the user interface 34 is the same, the speed of the telehandler remains the same regardless of the slope. In some embodiments, the controller 200 may further monitor if the drive motor 90 is operating according to the speed command. The controller 200 may determine the drive motor 90 is not operating according to the speed command when the drive motor 90 is currently turning in the opposite direction than the direction commanded by the speed command. In such embodiments, the telehandler 10 is likely on a negative slope and rolling downhill. The controller 200 can compensate for the slope by increasing the drive/speed command until the telehandler 10 stops rolling (i.e., the drive motor 90 no longer turns in the direction opposite of the speed command).

At step 4466, the steer command may be performed. In some embodiments, the controller 200 may communicate with at least one component and/or system of the telehandler 10 in order to initiate steering of the telehandler 10. For example, the controller 200 may receive an input from a steering wheel on the user interface 34 to initiate steering. The input from the steering wheel may cause the controller 200 to adjust the position of the wheels 84. As a result, the direction of motion of the telehandler 10 may be adjusted. In some embodiments, a typical startup sequence of the telehandler 10 may include raising a steering pressure to a desired pressure for operation of the steer command. The steering pressure may be detected by the controller 200 with input from at least one of the sensors 220. For example, the sensors 220 may include a pressure sensor to detect a pressure in the accumulator 124. In the instance that the pressure is lower than a desired pressure level, the implement pump 114 may be engaged to regulate the pressure. In some embodiments, the steering pump 116 and the implement pump 114 may be engaged simultaneously. For example, the steering pump 116 and the implement pump 114 may be operated by a common motor (i.e., the implement motor 112). In some embodiments, the configuration of the steer command may eliminate the need for a steering angle sensor on the telehandler 10.

At step 4467, the brake command may be performed. In some embodiments, the controller 200 may communicate with at least one component and/or system of the telehandler 10 in order to initiate braking of the telehandler 10. For example, the controller 200 may receive an input from a brake pedal on the user interface 34 (e.g., from a brake pedal position sensor, a brake pedal pressure sensor, among others). In some embodiments, the telehandler 10 is in a state of motion (i.e., the drive command is being performed) before the brake command begins. For example, an operator may be driving the telehandler 10. In this example, the operator may press or otherwise activate the brake pedal on the user interface 34 to end the drive command. Upon activation of the brake pedal (i.e., an increased detected pressure on the brake pedal), the controller 200 may reduce the speed command, thereby slowing the telehandler 10. In some embodiments, the brake command is sent only when the detected pressure on the brake pedal is above a predetermined threshold, such as 30 psi. In this example, the drive motor 90 may be configured to operate proportionally to the speed command. That is, the drive motor 90 may supply a lower torque to the wheels 84 based on the lower speed command. In some embodiments, the speed command may be lowered in response to an input from the sensors 220. For example, the sensors 220 may include an operator presence sensor, such as a seatbelt engagement sensor. In this example, if the controller 200 receives an indication from the sensors 220 that the operator is no longer present and/or the seatbelt is no longer engaged, the brake command performance may be initiated, which may include reducing the speed command. In some embodiments, the brake command may include engaging the brakes 102. For example, the controller 200 may engage the brakes 102 when the pressure of the brake pedal reaches a pressure threshold (e.g., 30 psi).

In some embodiments, the telehandler 10 may be configured to apply regenerative braking while performing the brake command. For example, when the accelerator pedal is released, the speed command may be reduced, and regenerative braking may be implemented to slowly reduce the speed of the telehandler 10. For example, when the telehandler 10 is accelerating or maintaining speed, the drive motor 90 drives the front axle assembly 80 and the rear axle assembly 82 to propel the telehandler 10. This flow of rotational mechanical energy may be executed in reverse order to perform regenerative braking using the drive motor 90 and provide power to charge the high-voltage battery 132. Utilization of regenerative braking during the brake command performance may serve to limit the need for mechanical friction brakes. The utilization of regenerative braking may also serve to mimic hydrostatic transmission operation of a traditional telehandler. In some embodiments, during regenerative braking, an operator input such as a brake command may increase the level of regenerative braking and/or increase the decelerate command to slow the telehandler 10 more quickly.

In some embodiments, the brake command may utilize a parking brake. For example, the user interface 34 may include a parking brake that is configured to receive an input from an operator. In some embodiments, the parking brake may be separate from the accelerator pedal/accelerator input. In this embodiment, the separate parking brake may serve as a dedicated input to further imply the desire to park the telehandler 10, rather than merely slowing the telehandler 10. In some embodiments, the parking brake may be a component on the user interface 34 configured to receive an input from the operator. For example, the parking brake may be in the form of a two-position switch. As another example, the parking brake may be in the form of a two-position switch or button. In some embodiments, the controller 200 may only release the parking brake when the operator is detected in the telehandler 10 (e.g., with the seatbelt engagement sensor). That is, the drive command may not be performed if the operator is not detected. However, the telehandler 10 may be configured with a manual override to allow for the drive command without the presence of the operator. This may be beneficial for applications including routine services or towing, among others.

In some embodiments, the parking brake may be automatically applied. For example, the telehandler 10 may be configured with a hydrostatic transmission stopshifting feature. In this instance, when stopshifting is applied, the parking brake may be automatically applied. As another example, the telehandler 10 may be configured with an SAHR (spring applied, hydraulic released) brake. In this instance, when the SAHR brake is applied, the parking brake may be automatically applied. In some embodiments, the position of the parking brake may determine the operation of the high-voltage components of the telehandler 10. For example, in order to charge the HVPDU 134, the controller 200 may need to verify that the parking brake is applied. As another example, in order to activate the drive motor 90, the controller 200 may need to verify that the parking brake is applied. The requirement of the parking brake may serve as a safety feature to mitigate unwanted vehicular movement. For example, when parked in an uphill configuration, the implement pump 114 may accumulate excess pressure. In the absence of the parking brake, the pressure in the implement pump 114 may release the brakes 102, thereby causing unwanted downhill motion of the telehandler 10. The inclusion of the parking brake may be useful in mitigating these unwanted movements. In some embodiments, the parking brake is prevented from releasing until an operator is detected in the seat by one or more operator presence sensors coupled to the controller 200 (e.g., proximity sensors, weight sensors, etc.).

### Display

As shown in FIGS. 162-164, the user interface 34 includes a display assembly, output device, or interface display, shown as display 5010, is shown, according to an exemplary embodiment. The display assembly includes a display housing, shown as housing 5014. The housing 5014 is configured to protect the display 5010 and facilitate the connection of the display 5010 to the telehandler 10. The housing 5014 includes a plurality of mounting points, shown as mounting points 5012, the mounting points 5012 configured to receive a fastener (e.g., screws, bolts, rivets, etc.) to couple the display 5010 to a mounting site (e.g., case, dashboard, etc.) of the telehandler 10. The display 5010 is further shown to include a plurality of indicators throughout the display, each of the indicators configured to provide an operator an indication regarding the current state of the telehandler 10 and the components thereof. The rear of the display 5010 includes a plurality of connectors, shown as connectors 5016, the connectors 5016 configured to interface with the controller 200, the HVPDU 134, the LVPDM 138, or any other component of the telehandler 10. The connectors 5016 may be configured to exchange power signals with any of the power components of the telehandler 10 (e.g., the high-voltage battery 132, the low-voltage battery 136, external power source 156, electrical system 130, etc.) in order to provide power to at least one of the display 5010 or any of the indicators of the display 5010. These connectors may be further configured to communicably couple with any component of the control system of the telehandler 10. The connection between the control system and the display 5010 may facilitate any communications of controlled or sensed values containing information relevant to any number of the indicators of the display 5010. In some embodiments, at least one of the connections 5016 may be or include a series of headers configured to mate into an automotive connector (e.g., Molex Connector 33472-1206, etc.). In some other embodiments, one or more of the connections 5016 may be configured to act as a female connector and receive a connector (e.g., pin, plug, blade, jack, etc.) of an automotive connector.

Referring now to FIG. 165, the display 5010 of the telehandler 10 is shown, according to an exemplary embodiment. In some embodiments, the display 5010 may be or include a graphical user interface, an LED display, an LCD display, a digital cluster, an OLED display, or any other type of display. The display 5010 includes a plurality of sections. Each of the plurality of sections may be of a different display type (e.g., LED display, LCD display, digital cluster, OLED, etc.). Referring still to FIG. 165, the display 5010 includes five sections: a left section 5002, a right section 5004, a lower middle section 5006, a middle section 5007, and an upper middle section 5008. Each of the sections are configured to include various unique indicators displaying different indications regarding relevant monitored parameters of the telehandler 10.

In a first, leftmost section, shown as section 5002, the display 5010 includes a plurality of indicators. The indicators may be of one or more colors and may be in one of a plurality of states (e.g., activated, inactivated, illuminated, unilluminated, etc.). For example, in the activated state, an indicator may be illuminated, and in deactivated state, the indicator may be unilluminated. The plurality of indicators in the section 5002 include a left turn signal indicator, shown as left turn signal 5022, the left turn signal 5022 illuminates to provide an indication that a left turn signal of the telehandler 10 is being operated. The section 5002 also includes a high beam indicator, shown as high beam indicator 5026, the high beam indicator 5026 configured to illuminate to provide an indication that the high beams of the telehandler 10 are being operated; a parking brake indicator, shown as parking brake indicator 5028, the parking brake indicator 5028 configured to illuminate to provide an indication that the parking brake is being operated; a charging active indicator, shown as charging active indicator 5080, the charging active indicator 5080 configured to illuminate to provide an indication that the charging operation is in process, a vehicle system distress indicator, shown as vehicle system distress indicator 5090, the vehicle system distress indicator 5090 configured to illuminate to provide an indication that there is a problem with one or more components or systems of the telehandler 10, a high motor temperature indicator, shown as high motor temperature indicator 5112, the high motor temperature indicator 5112 configured to illuminate to provide an indication that the temperature of the drive motor 90 is at or above a predetermined threshold, a high-voltage warning indicator, shown as a high-voltage warning indicator 5050, the high-voltage warning indicator 5050 configured to illuminate to provide an indication that one or more components of the HV system (e.g., HVPDU 134, high-voltage battery 132, drive motor 90, implement motor 112, charging pod 150, etc.) is experiencing at least one non-critical (i.e., function derate, one or more functions of the telehandler 10 are derated to act at a reduced level) error in its operation, a high-voltage critical indicator, shown as high-voltage critical indicator 5052, the high-voltage critical indicator 5052 configured to illuminate to provide an indication that one or more components of the HV system (e.g., HVPDU 134, high-voltage battery 132, drive motor 90, implement motor 112, charging pod 150, etc.) is experiencing a critical (i.e., function cutout, one or more functions of the telehandler 10 are terminated) error in its operation, a high-voltage temperature warning indicator, shown as high-voltage temperature warning indicator 5054, high-voltage temperature warning indicator 5054 configured to illuminate to indicate that the temperature of at least one component of the HV system (e.g., HVPDU 134, high-voltage battery 132, drive motor 90, implement motor 112, charging pod 150, etc.) is at or above a predetermined threshold, and a high hydraulic oil temperature indicator, shown as high hydraulic oil temperature indicator 5110, the high hydraulic oil temperature indicator 5110 configured to illuminate to provide an indication that the hydraulic oil of the hydraulic system 110 is at or above a predetermined threshold.

In the upper middle section 5008, the display 5010 includes a state of charge gauge, shown as state of charge gauge 5150, the state of charge gauge 5150 configured to provide a real-time or near real-time indication of the state of charge for the electrical system 130. The state of charge gauge 5150 includes a needle gauge with a scale from 0% to 100% representing the SOC of the High-voltage battery 132, shown as needle gauge 5152. The needle gauge 5152 provides a real-time or near real-time indication of the state of charge of the HV electrical system, and includes a low charge section, shown as low charge section 5154, the low charge section 5154 indicating that the state of charge for the electrical system (e.g., electrical system 130) is below a predetermined threshold value (e.g., 20%). The low charge section 5154 is primarily a first color (e.g., amber). A critically low charge section, shown as critically low charge section 5156, is below the low charge section 5154 of the needle gauge 5152 and indicates that the state of charge for the electrical system 130 is below a predetermined threshold (e.g., 10%). The low charge section 5154 is a second color different than the first color (e.g., red). An adequate charge section, shown as adequate charge section 5158, provides an indication that the state of charge of the electrical system 130 is at or above a predetermined threshold (e.g., 20%). The adequate charge section 5158 is a third color (e.g., white) the third color being different from the first color and the second color. The needle gauge 5152 moves between the critically low charge section 5156, the low charge section 5154, and the adequate charge section 5158 based on the current SOC of the battery 132. In some embodiments, the state of charge gauge 5150, including components thereof such as the needle gauge 5152 may be a physical display such that the needle gauge 5152 is a physical needle. In some embodiments, the state of charge gauge 5150, including components thereof such as the needle gauge 5152, is a digital representation of a needle gauge include a digital needle gauge 5152, etc.

The middle section 5007 includes a power usage gauge indicator, shown as power usage gauge indicator 5140, which provides an indication if power is being drawn from the battery 132, and a power usage gauge, shown as power usage gauge 5142. The power usage gauge 5142 provides an indication of real-time power usage of the telehandler 10, such as the amount of electrical power being consumed by the telehandler 10 at that moment. The power usage gauge 5142 is shown as a gradient which transitions from a first color (e.g., blue) to a second color (e.g., green) to a third color (e.g., white). The power usage gauge 5142 displays one or more of the first color, the second color, and/or the third color based on the power usage of the telehandler 10. In some embodiments, the first, second, and third colors are different colors. In some embodiments, the power usage gauge indicator 5140 is a physical gauge with moving parts. In some embodiments, the power usage gauge indicator 5140 is a digital representation.

The lower middle section 5006 includes a motor temperature gauge indicator, shown as motor temperature gauge indicator 5130, and a motor temperature gauge, shown as motor temperature gauge 5132. The motor temperature gauge 5132 provides a real-time or near real-time indication of the temperature of the drive motor 90. The motor temperature gauge 5132 includes a first section in a first color and a second section in a second color. The ratio of the first color and the second color may change depending on the motor temperature value represented by the motor temperature gauge 5132. The lower middle section 5006 includes a battery temperature gauge indicator, shown as battery temperature gauge indicator 5120, and a battery temperature gauge, shown as battery temperature gauge 5122. The battery temperature gauge 5122 provides a real-time or near real-time indication of the temperature of the high-voltage battery 132. The battery temperature gauge 5122 also includes a first section of a first color and a second section of a second color, with one of the section (e.g., green section) indicating a normal operating temperature and the second section (e.g., red section) indicating a critical, low, or high temperature, depending on the position of the second section relative to the first section. In some embodiments, motor temperature gauge 5130, the battery temperature gauge 5122, and/or the other gauges referred to herein are physical gauges with moving parts. In some embodiments, the motor temperature gauge 5130, the battery temperature gauge 5122, and/or the other gauges referred to herein are digital representations.

The right section 5004 includes a right turn signal indicator, shown as right turn signal 5024. The right turn signal 5024 illuminates to provide an indication that a right turn signal of the telehandler 10 is being operated. The right section 5004 includes a two-wheel steer indicator, shown as two-wheel steer indicator 5040, the two-wheel steer indicator 5040 illuminates to provide an indication that the telehandler 10 is in two-wheel steer mode, a crab steer indicator, shown as crab steer indicator 5042, the crab steer indicator 5042 illuminates to provide an indication that the telehandler 10 is in crab steer mode, an all-wheel steer indicator, shown as all-wheel steer indicator 5044, the all-wheel steer indicator 5044 illuminates to provide an indication that the telehandler 10 is in all-wheel steer mode, a rear axle center indicator, shown as rear axle center indicator 5046, the rear axle center indicator 5046 illuminates to provide an indication that the center differential has been locked, a low-voltage battery low indicator, shown as low-voltage battery low indicator 5060, the low-voltage battery low indicator 5060 illuminates to provide an indication that the state of charge of the low-voltage battery 136 is below a predetermined threshold, a battery pack critical temperature indicator, shown as battery pack critical temperature indicator 5058, the battery pack critical temperature indicator 5058 illuminates to indicate that the temperature of the battery 132 and/or the battery housing 40 is at or above a predetermined threshold, and a charging required indicator, shown as charging required indicator 5062. The charging required indicator 5062 indicating that the state of charge of the electrical system 130 is below a predetermined threshold and needs to be coupled to the external power source 156. When the battery 132 is below a predetermined threshold (e.g., SOC level), the charging required indicator 5062 is continuously illuminated. When the battery 132 is below a second threshold less than the first threshold, the charging required indicator 5062 may flash at a first rate or frequency. The flashing charging required indicator 5062 at the first rate may also indicate one or more operations of the telehandler 10 are being derated at the moment (e.g., within a predetermined period of time such as 1 second, 2 seconds, 5, seconds, 1 minute, 2 minutes, 5 minutes, etc.). When the battery 132 is below a third level less than the second level, the charging required indicator 5062 may flash at a second rate faster than the first rate. When the battery 132 is below the third level the charging required indicator 5062 thus represents that an emergency shutdown is imminent. In some embodiments, the charging required indicator 5062 can flash at a plurality of different rates according to a state or condition of the telehandler 10. Each of the indicators on the display 5010 can flash at one or more rates in the same manner as the charging require indicator 5062.

The right section 5004 further includes a high-voltage battery low indicator, shown as high-voltage battery low indicator 5056, the high-voltage battery low indicator 5056 illuminates to provide an indication that the state of charge of the high-voltage battery 132 is below a predetermined threshold, a seatbelt unlocked indicator, shown as seatbelt unlocked indicator 5102, the seatbelt unlocked indicator 5102 illuminates to provide an indication that the seatbelt of the telehandler 10 is unlocked, a continuous aux indicator, shown as continuous aux indicator 5092, the continuous aux indicator 5092 configured to provide an indication that the continuous auxiliary hydraulics are active, a loader mode indicator, shown as loader mode indicator 5094, the loader mode indicator 5094 indicating that the telehandler 10 is in loader mode, a framer mode indicator, shown as framer mode indicator 5096, the framer mode indicator 5096 indicating that the telehandler 10 is in framer mode, a rear axle stabilization indicator, shown as rear axle stabilization indicator 5098, the rear axle stabilization indicator 5098 indicating that the telehandler 10 is operating a stability control system, and a Load Stability Indication (LSI) passive mode indicator, shown as LSI passive mode indicator 5100, the LSI passive mode indicator 5100 indicating that the telehandler 10 is operating in LSI passive mode.

The sensors 220 may include one or more battery sensors configured to monitor the state of charge of at least one of the high-voltage battery 132 and/or the low-voltage battery 136, or any other component of the electrical system 130. In some embodiments, the battery sensors may be or include voltage sensors configured to measure voltage of the high-voltage battery 132 and/or the low-voltage battery 136. In some other embodiments, the battery sensors may be or include current sensors configured to measure the current of the high-voltage battery 132 and/or the low-voltage battery 136. The battery sensors are communicably coupled to the controller 200 such that the battery sensors send signals to the controller 200 regarding their current state of charge. The state of charge signals received by the controller 200 are used to determine the status of and control at least one of the high-voltage battery low indicator 5056, the low-voltage battery low indicator 5060, the charging active indicator 5080, the state of charge gauge 5150, the charging required indicator 5062, the power usage gauge 5142, and any other indicator configured to provide an operator an indication of the state of charge of any components of the electrical system 130. For example, in response to receiving a state of charge value regarding the high-voltage battery 132 that is below a predetermined threshold, the controller 200 may engage the high-voltage battery low indicator 5056. In response to receiving a state of charge value regarding the low-voltage battery 136 that is below a predetermined threshold, the controller 200 may engage the low-voltage battery low indicator 5060. In response to receiving a state of charge value for the electrical system 130 that is below a predetermined threshold, the controller 200 may engage the charging required indicator 5062, indicating that the telehandler 10 needs to be connected to the external power source 156. Upon receiving an indication that the state of charge value of the electrical system 130 is increasing, the controller 200 may engage the charging active indicator 5080. The controller 200 may use a received state of charge value for the electrical system 130 to operate the power usage gauge 5142 and the state of charge gauge 5150. Responsive to receiving a state of charge value regarding the electrical system 130, the controller 200 may operate the needle gauge 5152 of the state of charge gauge 5150 to provide an operator with an indication of the state of charge of the electrical system 130.

The power usage gauge indicator 5140 is configured to provide an operator with an indication regarding the function of the power usage gauge 5142 which is positioned next to the power usage gauge indicator 5140. Power usage gauge 5142 is configured to provide real-time indication regarding power usage of the telehandler 10. In some embodiments, the power usage gauge 5142 may include a gradient used to show the power usage of the telehandler 10. The gradient includes a first, leftmost section configured to display blue, indicating that the telehandler 10 is consuming an amount of power below a first predetermined threshold. The gradient includes a second, center section configured to display green, indicating that the telehandler 10 is consuming an amount of power at or above the first predetermined threshold, but below a second predetermined threshold. The gradient includes a third, rightmost section configured to display white, indicating that the telehandler 10 is consuming an amount of power at or above the second predetermined threshold. The controller 200 may use received values regarding the state of charge of the electrical system 130 to operate the power usage gauge 5142. For example, in response to receiving an indication that the telehandler 10 is using an amount of power below the first threshold, the controller 200 will operate the power usage gauge to display blue. In response to receiving an indication that the telehandler 10 is using an amount of power at or above the first threshold and below the second predetermined threshold, the controller 200 will operate the power usage gauge 5142 to display blue and white. In response to receiving an indication that an amount of power at or above the second predetermined threshold, the controller 200 will operate the power usage gauge 5142 to display blue, green, and white.

The sensors 220 may include one or more temperature sensors configured to monitor the temperature of at least one of the implement motor 112, the drive motor 90, the lift actuator 70, the extension actuator 72, the implement actuator 74, the steering actuators 100, the HVPDU 134 and/or any component thereof, the LVPDM 138 and/or any component thereof, the electrical system 130, and the hydraulic system 110 and/or any component thereof. The one or more temperature sensors of the telehandler 10 are communicably coupled to the controller 200 such that the temperature sensors send signals regarding a real-time or near real-time indication of the temperature of a number of components of the telehandler 10. The received temperature signals are used by the controller 200 to determine the status of and control at least one of the high motor temperature indicator 5112, the high hydraulic oil temperature indicator 5110, the high voltage temperature warning indicator 5054, the battery temperature gauge 5122, the battery pack critical temperature indicator 5058, and the motor temperature gauge 5132. In response to receiving an indication that the temperature of the HVPDU 134 is at or above a predetermined threshold, the controller 200 may engage the high-voltage temperature warning 5054, providing an operator with an indication that there is or may be an issue in the high-voltage battery for operation or charging. In response to receiving an indication that the temperature of the high-voltage battery 132 is at or above a second predetermined threshold, the controller 200 may engage the battery pack critical temperature indicator 5058, providing an operator with an indication that the high-voltage battery 132 is experiencing a critical (i.e., function cutout) error due to temperature. Upon receiving an indication that the hydraulic oil temperature is at or above a predetermined threshold, the controller 200 may engage the high hydraulic oil temperature indicator 5110. The controller 200 may engage the high motor temperature indicator 5112 in response to receiving an indication that the temperature of the drive motor 90 is at or above a predetermined threshold.

The motor temperature gauge indicator 5130 is configured to provide an operator with an indication regarding the function of the motor temperature gauge 5132 which is positioned above the motor temperature gauge indicator 5130. The motor temperature gauge 5132 is configured to provide a real-time or near real-time indication regarding the temperature of the drive motor 90. The motor temperature gauge 5132 includes a first and a second section. The first section of the motor temperature gauge 5132 is configured to display green, indicating that the temperature of the drive motor 90 is below a predetermined threshold. The second section of the motor temperature gauge 5132 is configured to display red, indicating that the temperature of the drive motor 90 is at or above a predetermined threshold.

The battery temperature gauge indicator 5120 is configured to provide an operator with an indication regarding the function of the battery temperature gauge 5122 which is positioned above the battery temperature gauge indicator 5120. The battery temperature gauge 5122 is configured to provide a real-time or near real-time indication regarding the temperature of the high-voltage battery 132 of the telehandler 10. The battery temperature gauge 5122 includes a first and a second section. The first section of the battery temperature gauge 5122 is configured to display green, indicating that the temperature of the high-voltage battery 132 is below a predetermined threshold. The second section of the battery temperature gauge 5122 is configured to display red, indicating that the temperature of the high-voltage battery 132 is at or above a predetermined threshold.

The user interface 34 may include at least one user interface device configured to receive at least one user input regarding the steering mode of the telehandler 10. The user interface device may be any number of buttons, switches, knobs, or any other device configured to receive a user input. The at least one user input received at the user interface 34 may be or include a signal indicating a steering mode for the telehandler 10 to operate under. Responsive to a receiving a first indication, the controller 200 will engage the two-wheel steer indicator 5040 and operate the telehandler 10 in a two-wheel steer mode, whereby the front axle assembly 80 steers the telehandler 10. Responsive to receiving a second indication, the controller 200 will engage the crab steer indicator 5042 and operate the telehandler 10 in a crab steer mode, whereby the front axle assembly 80 and the rear axle assembly 82 drive all of the wheels 84 to the same angle to steer the telehandler 10. Responsive to receiving a third indication, the controller 200 will engage the all-wheel steer indicator 5044 and operate the telehandler 10 in an all-wheel steer mode, whereby the front axle assembly 80 rotates in a first direction and the rear axle assembly 82 rotates in a second, opposite direction to help the telehandler 10 rotate into a turn.

The user interface 34 may include at least one user interface device configured to receive at least one user input regarding the operation of the center differential of the telehandler 10. The at least one user interface device may be any number of buttons, switches, knobs, or any other device configured to receive a user input. The at least one user input received at the user interface 34 may be or include a signal indicating the operating state of the center differential. Responsive to receiving an indication operating the center differential to be locked, the controller 200 will engage the rear axle center indicator 5046 and lock the center differential of the telehandler 10.

The user interface 34 may include at least one user interface device configured to receive at least one user input regarding a lift mode of the telehandler 10. The at least one user interface device may be any number of buttons, switches, knobs, or any other device configured to receive a user input. The at least one user input received at the user interface 34 may be or include a signal indicating a selected lift mode of the telehandler 10. Responsive to receiving a first indication, the controller 200 will engage the continuous aux indicator 5092 and operate the continuous auxiliary hydraulics of the telehandler 10. Responsive to receiving a second indication, the controller 200 will engage the loader mode indicator 5094 and operate the telehandler 10 in the loader mode. Responsive to receiving a third indication, the controller 200 will engage the framer mode indicator 5096 and operate the telehandler 10 in the framer mode.

The user interface 34 may include at least one user interface device configured to receive at least one user input regarding a mode of operation of the telehandler 10. The at least one user interface device may be any number of buttons, switches, knobs, or any other device configured to receive a user input. The at least one user input received at the user interface 34 may be or include a signal indicating a selected mode of the telehandler 10. Responsive to receiving a first indication, the controller 200 will engage the rear axle stabilization indicator 5098 and operate the stability control system of the telehandler 10. Responsive to receiving a second indication, the controller 200 will engage the LSI passive mode indicator 5100 and operate the telehandler 10 in LSI passive mode.

The sensors 220 may include one or more power distribution unit monitors, the power distribution unit monitors configured to monitor the function of the HVPDU 134. In some embodiments, the power distribution monitors may be or include current sensors (e.g., hall effect sensors, Rogowski coils, etc.) configured to measure current throughout a power distribution unit. In some other embodiments, the power distribution monitors may be or include voltage sensors configured to measure voltage throughout a power distribution unit. The sensors 220 are communicably coupled to the controller 200 such that they can send signals to the controller 200 regarding the operation of the HVPDU 134. In response to receiving an indication that the HVPDU 134 is operating outside of a preset threshold (e.g., an operating voltage range, an operating current range, etc.), the controller 200 may engage the high voltage warning indicator 5050 and/or the high voltage critical indicator 5052 based on the value received by the controller 200. For example, if the current and/or voltage value is within ten percent of the operating range, the controller 200 may engage the high voltage warning indicator 5050, and if the current and/or voltage value is more than ten percent above or below the operating range, the controller 200 may engage the high voltage critical indicator 5052.

### Auxiliary Power Unit

Referring to FIG. 166, the telehandler 10 may utilize an auxiliary power unit (APU), portable generator, range extender, power booster, supplemental energy source, removable energy source, backup energy source, or removable power unit, shown as APU 5200. The APU 5200 may be removably coupled to the telehandler 10. The APU 5200 may supply electrical energy to the telehandler 10 to charge the high-voltage battery 132 and/or power one or more components of the telehandler 10. The powered components may include any electrical energy consumers of the telehandler 10, such as the drive motor 90, the implement motor 112, the control valves 122, the coolant pumps 174, the fans 176, the heater 182, the compressor 186, the fans 194, the controller 200, the user interface 34, the sensors 220, or other components of the telehandler 10 that consume electrical energy during operation. In some embodiments, the APU 5200 may be added or removed on a daily, weekly, or monthly basis as desired or required for a given workload of the telehandler 10. In other embodiments, the APU 5200 is added to the telehandler 10 when the telehandler 10 is manufactured (e.g., to remain onboard the telehandler 10 indefinitely).

FIG. 166 illustrates the APU 5200 coupled to the telehandler 10, and FIGS. 167 and 168 illustrate an arrangement of the APU 5200, according to an exemplary embodiment. The APU 5200 includes a frame or enclosure, shown as housing 5202, that supports the other components of the APU 5200. In some embodiments, the housing 5202 defines or includes pockets for lift forks, eyes for attaching lift hooks, or other coupling interfaces, through which the housing 5202 may be lifted or otherwise manipulated. The housing 5202 may be coupled to the frame assembly 12 of the telehandler 10 by a coupler or attachment assembly, shown as APU mount 5204. The APU mount 5204 may removably and fixedly couple the housing 5202 to the frame assembly 12. In other embodiments, the APU mount 5204 permanently couples the housing 5202 to the frame assembly 12.

APU with Generator

As shown in FIGS. 166-168, the APU 5200 is configured as a generator that receives a fuel (e.g., diesel, gasoline, natural gas, hydrogen, etc.) and consumes the fuel to produce electrical energy that is supplied to the telehandler 10. In some embodiments, the APU 5200 is capable of supplying at least 3 kW of electrical energy during operation.

The APU 5200 includes an internal combustion engine (e.g., a diesel engine, a gasoline engine, a natural gas engine, a hydrogen engine, a propane engine, etc.), shown as engine 5210, and a power generator (e.g., an AC generator), shown as generator 5212. The engine 5210 and the generator 5212 are each coupled to the housing 5202 and at least partially contained within the housing 5202. During operation, the engine 5210 consumes fuel and provides rotational mechanical energy to drive the generator 5212. In response to receiving the rotational mechanical energy, the generator 5212 generates electrical energy. In some embodiments, the generator 5212 generates AC electrical energy, which is subsequently converted to DC electrical energy for use by the telehandler 10. In other embodiments, the AC electrical energy from the generator 5212 is used directly by one or more components of the telehandler 10. In yet other embodiments, the generator 5212 generates DC electrical energy. In some embodiments, the engine 5210 and the generator 5212 are air-cooled.

The APU 5200 includes a container, shown as fuel tank 5220. The fuel tank 5220 is coupled to the housing 5202 and fluidly coupled to the engine 5210. The fuel tank 5220 is configured to contain a volume of fuel. The fuel tank 5220 may supply the fuel to the engine 5210 in response to a demand for fuel from the engine 5210.

The APU 5200 further includes a motor or starter, shown as starter motor 5222, coupled to the engine 5210. In some embodiments, the starter motor 5222 is an electric motor. The starter motor 5222 may consume electrical energy and provide rotational mechanical energy to the engine 5210. The rotational mechanical energy from the starter motor 5222 may crank or otherwise turn the engine 5210 to start the engine 5210.

The APU 5200 further includes an energy storage device, shown as battery 5224, coupled to the housing 5202. The battery 5224 may be a lead-acid battery, a lithium-ion battery, or another type of battery. The battery 5224 is configured to store energy (e.g., chemically) and supply the stored energy as electrical energy to power the engine 5210 and/or the starter motor 5222. By way of example, the starter motor 5222 may draw electrical energy from the battery 5224 when starting the engine 5210. In some embodiments, the battery 5224 is recharged using electrical energy from the generator 5212.

The APU 5200 further includes an APU controller 5230 including a processor 5232 and a memory 5234. The processor 5232 may issue commands to and process information from other components. The processor 5232 may be implemented as a specific purpose processor, an application specific integrated circuit (ASIC), one or more field programmable gate arrays (FPGAs), a group of processing components, or other suitable electronic processing components. The memory 5234 may include one or more devices (e.g., RAM, ROM, flash memory, hard disk storage) for storing data and computer code for completing and facilitating the various user or client processes, layers, and modules described in the present disclosure. The memory 5234 may be or include volatile memory or non-volatile memory and may include database components, object code components, script components, or any other type of information structure for supporting the various activities and information structures of the inventive concepts disclosed herein. The memory 5234 may be communicably connected to the processor 5232 and include computer code or instruction modules for executing one or more processes described herein.

The APU controller 5230 is operatively coupled to the engine 5210, the generator 5212, the starter motor 5222, and the battery 5224. The APU controller 5230 may provide control signals to control the engine 5210 (e.g., vary the speed of the engine 5210, turn the engine 5210 off, etc.). The APU controller 5230 may provide control signals to control the generator 5212 (e.g., to vary the current and/or voltage of the electrical energy output by the generator 5212, etc.). The APU controller 5230 may provide control signals to control the starter motor 5222 (e.g., to run the starter motor 5222 to start the engine 5210). The APU controller 5230 may receive electrical energy from the battery 5224. The APU controller 5230 may utilize sensors 220 to monitor operation of the engine 5210, the generator 5212, the fuel tank 5220, the starter motor 5222, and/or the battery 5224.

Positioned along an exterior surface of the housing 5202 are a first electrical port or connector, shown as power connector 5236, and a second electrical port or connector, shown as data connector 5238. The power connector 5236 is electrically coupled to the generator 5212 and configured to transfer electrical energy from the generator 5212 to the telehandler 10. The data connector 5238 is configured to transfer data (e.g., commands, sensor data, etc.) between the controller 200 of the telehandler 10 and the APU controller 5230. As shown in FIG. 166, the APU controller 5230 is operatively coupled to the controller 200 through the data connector 5238.

As shown in FIG. 166, the generator 5212 is electrically coupled to the HVPDU 134 through the power connector 5236 and a charger or power converter, shown as onboard charger 5240. The onboard charger 5240 may convert AC electrical energy from the generator 5212 to DC electrical energy for use by the HVPDU 134 and/or otherwise convert or modify the electrical energy for use by the HVPDU 134. In some embodiments, the onboard charger 5240 is positioned onboard the telehandler 10. In some such embodiments, the onboard charger 5240 is one of the onboard chargers 152. In other embodiments, the onboard charger 5240 is coupled to the housing 5202 of the APU 5200, such that the APU 5200 outputs DC electrical energy.

As shown in FIGS. 166, 167, and 169, the telehandler 10 and/or the APU 5200 may include one or more power take-offs, electrical connectors, accessory connectors, or outlets, shown as power outlets 5242. The power outlets 5242 may be selectively connected to one or more external electrical energy consumers or accessories, such as tools (e.g., drills, saws, etc.), portable battery chargers, electronic devices (e.g., smartphones, laptops, tablets, etc.), or implements (e.g., lights or actuators coupled to the telehandler 10). By way of example, the power outlets 5242 may provide a female connector configured to receive a corresponding male connector of an accessory. As shown, the onboard charger 5240 may be positioned on the APU 5200 and/or the telehandler 10, such that a user may connect an accessory at multiple different locations. In some embodiments, one or more of the power outlets 5242 are positioned within the cabin 30, such that the power outlets 5242 may be accessed directly by a user operating the telehandler 10.

The power outlets 5242 may be configured to supply electrical energy from the telehandler 10 and/or the APU 5200 to the accessories to power the accessories. The supplied electrical energy may be provided by the APU 5200 and/or by the telehandler 10 (e.g., by the high-voltage battery 132). The electrical energy may be conditioned or converted by the onboard charger 5240, the DC/DC converter 160, or other components of the telehandler 10. In some embodiments, the power outlets 5242 supply electrical energy. By way of example, the power outlets 5242 may function as household outlets delivering 110V AC energy. In other embodiments, the power outlets 5242 may supply electrical energy that is otherwise conditioned.

During operation of the telehandler 10, the controller 200 and the APU controller 5230 cooperate to control the APU 5200 to enhance the operation of the telehandler 10. By way of example, the controller 200 may provide a request for the APU 5200 to supply electrical energy, and in response to such a request, the APU controller 5230 may start the engine 5210 to initiate generation of power. While certain functions may be described as being performed by the APU controller 5230, in some embodiments, those functions are performed by the controller 200 or split between the controller 200 and the APU controller 5230. Similarly, while certain functions may be described as being performed by the controller 200, in some embodiments, those functions are performed by the APU controller 5230 or split between the controller 200 and the APU controller 5230.

### A. APU as Range Extender

In some embodiments, the APU 5200 operates in a range extension mode, in which the APU 5200 acts as a range extender for the telehandler 10. The high-voltage battery 132 may have a fixed capacity, such that the high-voltage battery 132 may only operate for a limited period of time before becoming depleted and unable to power the telehandler 10. In such a situation, it may be advantageous to continue operating the telehandler 10 after the high-voltage battery 132 would normally be depleted.

To accomplish this, the APU 5200 may supply electrical energy to the telehandler 10 to power functions of the telehandler 10 without drawing from the high-voltage battery 132. Accordingly, the range of the telehandler 10 (e.g., the distance the telehandler 10 is capable of traveling, the amount of time the telehandler 10 is capable of operating, the amount of actions that the telehandler 10 is capable of performing, etc.) may be extended.

By way of example, the controller 200 may submit a request to the APU 5200 (e.g., the APU controller 5230) to switch to the range extension mode and begin supplying power to the telehandler 10. The APU controller 5230 may control the starter motor 5222 to start the engine 5210, such that the generator 5212 begins generating electrical energy. The controller 200 may reduce the amount of energy being supplied by the high-voltage battery 132 (e.g., stop drawing from the high-voltage battery 132 entirely), such that the energy required to perform one or more functions (e.g., the drive motor 90, the implement motor 112, etc.) is supplied by the APU 5200 instead of the high-voltage battery 132. If the APU 5200 supplies more power than is being consumed by the functions of the telehandler 10, the HVPDU 134 and/or the onboard chargers 152 may use the remaining, unused energy to charge the high-voltage battery 132.

In some embodiments, the controller 200 is configured to request for the APU 5200 to switch to the range extension mode in response to a state of charge of the high-voltage battery 132 falling below a threshold charge level. By way of example, the controller 200 may automatically switch the APU 5200 to the range extension mode in response to the state of charge of the high-voltage battery 132 falling below a predetermined state of charge (e.g., 50% charged, 30% charged, etc.). The controller 200 may monitor the charge level using one or more sensors 220. Additionally or alternatively, the controller 200 may request the APU 5200 to switch to the range extension mode in response to a command from a user (e.g., through the user interface 34).

In some embodiments, the controller 200 is configured to request for the APU 5200 to switch to the range extension mode in response to a temperature of the high-voltage battery 132 falling outside of a predetermined or desired temperature range (e.g., exceeding a first threshold temperature, falling below a second threshold temperature, etc.). As the high-voltage battery 132 is depleted, the high-voltage battery 132 may generate heat, increasing the temperature of the high-voltage battery 132. It may be undesirable to operate the high-voltage battery 132 above a certain temperature, as such operation may decrease the efficiency of the high-voltage battery 132 or cause damage to the high-voltage battery 132. By switching the APU 5200 to the range extension mode, the controller 200 may reduce the power consumption from the battery (e.g., partially lower the power consumption, stop consuming power completely) to reduce the heat generation within the high-voltage battery 132. Accordingly, high-voltage battery 132 may be permitted to cool down without requiring the telehandler 10 to stop operation.

The APU 5200 may supply power to the telehandler 10 to continue extending the range until the fuel within the fuel tank 5220 is depleted. The fuel tank 5220 may be refilled to continue operating the telehandler 10. Beneficially, the APU 5200 may permit the telehandler 10 to operate indefinitely, as long as a user continues to refuel the fuel tank 5220. The APU 5200 may be used in situations where an external power source 156 is unavailable, or situations where an operator wishes to operate the telehandler 10 continuously without having to stop and wait for the high-voltage battery 132 to charge.

### B. APU Supplements Power Output of Battery

In some embodiments, the APU 5200 operates in a supplemental power mode or boost mode, in which the APU 5200 supplements the power from the high-voltage battery 132 to increase the total power output of the telehandler 10. The high-voltage battery 132 may have a peak power output that gradually decreases as the high-voltage battery 132 is depleted. By way of example, the high-voltage battery 132 may be a 35 kWh battery that is capable of outputting approximately 50 kW when fully charged, but that quickly (e.g., within a minute of peak power operation) to 30 kW. In such a situation, it may be advantageous to supplement the power of the high-voltage battery 132 with additional electrical energy from the APU 5200 to make up for the gradual decrease in peak power output as the high-voltage battery 132 is depleted.

By way of another example, the drive motor 90 may be a 40 kW motor, and the implement motor 112 may be a 30 kW motor, for a total maximum power draw of 70 kW for both motors. Even at peak charge, the 35 kWh battery may only be able to supply 50 kW of the 70 kW of potential demand. In one such example, the telehandler 10 may reach this peak demand when lifting while driving, such as when driving into a pile of material while attempting to lift a bucket full of the material. In a situation where the high-voltage battery 132 is incapable of supplying the peak demand, it may be advantageous to supplement the power of the high-voltage battery 132 with additional electrical energy from the APU 5200 to avoid a decrease in performance of the telehandler 10.

To accomplish this, the APU 5200 may supply electrical energy to the telehandler 10 to power functions of the telehandler 10 in addition to the power from the high-voltage battery 132. By way of example, the controller 200 may submit a request to the APU 5200 (e.g., the APU controller 5230) to switch to the boost mode and begin supplying power to the telehandler 10. The APU controller 5230 may control the starter motor 5222 to start the engine 5210, such that the generator 5212 begins generating electrical energy. The controller 200 may control the high-voltage battery 132 to continue supplying power and supplement that power with the received electrical energy from the APU 5200. The total available power for operating the telehandler 10 may be the sum of (a) the power from the high-voltage battery 132 and (b) the power from the APU 5200. Beneficially, by adding the power from the APU 5200, the telehandler 10 may be more responsive in high-load scenarios.

While in the boost mode, if the total available power is greater than the power demand of the telehandler 10, the controller 200 may reduce the power supplied by the high-voltage battery 132 to conserve the state of charge of the high-voltage battery 132. If the APU 5200 alone supplies more power than is being consumed by the functions of the telehandler 10 (e.g., if the operator briefly pauses movement of the telehandler 10 in between operations), the HVPDU 134 and/or the onboard chargers 152 may use the remaining, unused energy to charge the high-voltage battery 132. Accordingly, the boost mode may conserve or increase the state of charge of the high-voltage battery 132 when the load on the telehandler 10 is reduced.

In some embodiments, the controller 200 is configured to request for the APU 5200 to switch to the boost mode in response to a power demand of the telehandler 10 exceeding the power output capabilities of the high-voltage battery 132. By way of example, the controller 200 may monitor the current power demand of each component of the telehandler 10 (e.g., using one or more sensors 220, based on a predetermined relationship between a user input and an associated power demand). The controller 200 may also monitor the current power output capabilities of the high-voltage battery 132. By way of example, the controller 200 may store a predetermined relationship between the state of charge of the high-voltage battery 132 and the power output capability of the high-voltage battery 132. The controller 200 may automatically switch the APU 5200 to the boost mode in response to the power demand exceeding the power output capability of the high-voltage battery 132. Additionally or alternatively, the controller 200 may request the APU 5200 to switch to the boost mode in response to a command from a user (e.g., through the user interface 34). By way of example, a user may request the boost mode when the user knows that they are going to be performing a high-power task, such as moving a heavy load or navigating through muddy terrain.

### C. APU to Operate Accessories

In some embodiments, the APU 5200 operates in an accessory mode, in which the APU 5200 supplies power to operate one or more accessories of the telehandler 10 without drawing power from the high-voltage battery 132. The high-voltage battery 132 may be prevented from operating (e.g., unable to operate, controlled to prevent operation, etc.) under certain conditions. In some embodiments, the high-voltage battery 132 is prevented from supplying electrical energy to the electrical system 130 while the high-voltage battery 132 is being charged. In some embodiments, the high-voltage battery 132 is prevented from supplying electrical energy to the electrical system 130 while the high-voltage battery 132 is below a threshold temperature (e.g., to protect the high-voltage battery 132 from damage). In some embodiments, the high-voltage battery 132 is prevented from supplying electrical energy to the electrical system 130 when the high-voltage battery 132 is below a threshold state of charge. In some embodiments, the high-voltage battery 132 is manually prevented from supplying electrical energy to the electrical system 130 when a user wishes to avoid draining the high-voltage battery 132.

In these situations, it may still be desirable to operate one or more functions of the telehandler 10, even when the high-voltage battery 132 is prevented from supplying power to the electrical system 130. By way of example, it may be advantageous to operate the HVAC system 180 (e.g., the heater 182, the compressor 186, the fans 194, etc.) to facilitate climate control of the cabin 30. In one example, a user may wish to operate the HVAC system 180 while the high-voltage battery 132 is charging from the external power source 156. By way of another example, it may be advantageous to operate the cooling system 170 (e.g., the coolant pumps 174, the fans 176) to cool the telehandler 10. By way of another example, it may be advantageous to charge the low-voltage battery 136.

The APU 5200 may be used to supply power to operate these functions without requiring operation of the high-voltage battery 132. By way of example, the controller 200 may determine that the high-voltage battery 132 is currently disabled from dispensing electrical energy (e.g., when charging, when below a threshold temperature, when below a threshold state of charge, when specified by a user through the user interface 34, etc.). In response to receiving a request for a function of the telehandler 10 (e.g., from a user, automatically in response to sensor data, etc.) while the high-voltage battery 132 is disabled, the controller 200 may request for the APU 5200 to switch into the accessory mode and begin supplying power to the telehandler 10. The APU controller 5230 may control the starter motor 5222 to start the engine 5210, such that the generator 5212 begins generating electrical energy. The HVPDU 134 may then direct the generated electrical energy to power the requested function. If the APU 5200 supplies more power than is being consumed by the requested function of the telehandler 10, the HVPDU 134 and/or the onboard chargers 152 may use the remaining, unused energy to charge the high-voltage battery 132.

### D. APU for Preconditioning

In some embodiments, the APU 5200 operates in a preconditioning mode, in which the APU 5200 supplies power to prepare the telehandler 10 for operation of the electrical system 130. Certain components of the electrical system 130 may require a preconditioning operation to be performed before they are able to operate. These preconditioning operations may require the application of electrical energy, and the APU 5200 may supply the required electrical energy for the preconditioning operation.

By way of example, the high-voltage battery 132 may have a desired temperature range for operation. Charging or discharging the high-voltage battery 132 below this desired temperature range may reduce the efficiency of the high-voltage battery 132 or cause damage to the high-voltage battery 132. Accordingly, it may be desirable to warm the high-voltage battery 132 to within the desired temperature range before charging or discharging the high-voltage battery 132. As shown in FIG. 166, the high-voltage battery 132 may include a heating element or resistive heater, shown as battery heater 5250. The battery heater 5250 may consume electrical energy and supply thermal energy to heat the high-voltage battery 132.

The APU 5200 may be used to supply power to the battery heater 5250 to heat the high-voltage battery 132 until the high-voltage battery 132 is within the desired temperature range. By way of example, the controller 200 may determine (e.g., through a sensor 220 configured as a temperature sensor) that the high-voltage battery 132 is below the desired temperature range (e.g., below a predetermined threshold temperature). In response to this determination, the controller 200 may request for the APU 5200 to switch into the preconditioning mode and begin supplying power to the telehandler 10. The APU controller 5230 may control the starter motor 5222 to start the engine 5210, such that the generator 5212 begins generating electrical energy. The HVPDU 134 may then direct the generated electrical energy to the battery heater 5250. When the temperature of the high-voltage battery 132 is within the desired temperature range, the controller 200 may command the APU 5200 to end the preconditioning mode (e.g., to shut off the engine 5210) and begin charging or discharging the high-voltage battery 132.

Without the APU 5200 the telehandler 10 may be required to be connected to the external power source 156 in order to precondition the high-voltage battery 132. By way of example, the telehandler 10 may otherwise be required to be plugged into an outlet or other stationary external power source 156 run the battery heater 5250 until the high-voltage battery 132 is within the desired temperature range. Such a connection may prevent use of the telehandler 10 until the high-voltage battery 132 has been heated. By using the APU 5200 in the preconditioning mode, the telehandler 10 may be operated while the high-voltage battery 132 is still warming.

By way of another example, when initially starting up the electrical system 130 it may be desirable to gradually raise the voltage being supplied to the HVPDU 134. If the voltage supplied to the HVPDU 134 raises too quickly, the HVPDU 134 or other components of the electrical system 130 may experience damage. The APU 5200 may be used to supply electrical energy that gradually increases the voltage being applied to the HVPDU 134. By way of example, the controller 200 may receive a startup request to initiate operation of the telehandler 10 (e.g., from a user interaction with the user interface 34). In response to this determination, the controller 200 may request for the APU 5200 to switch into the preconditioning mode and begin supplying power to the telehandler 10. The APU controller 5230 may control the starter motor 5222 to start the engine 5210, such that the generator 5212 begins generating electrical energy. The APU controller 5230 may control the engine 5210, the generator 5212, and/or the onboard charger 5240 such that the voltage supplied to the HVPDU 134 starts low and gradually increases (e.g., at or below an allowable rate of change of the voltage). When the HVPDU 134 has reached the desired operating voltage or within an allowable range of a desired operating voltage, the controller 200 may connect the high-voltage battery 132 to the HVPDU 134 without a rapid change in voltage. The controller 200 may then command the APU 5200 to end the preconditioning mode (e.g., to shut off the engine 5210).

### E. APU Placement on Telehandler

Referring to FIGS. 169-173, the APU 5200 is shown coupled to the telehandler 10, according to an exemplary embodiment. As shown, the APU 5200 is coupled to the rear end 16 of the frame assembly 12. The APU 5200 is positioned longitudinally rearward of the frame assembly 12. The APU 5200 is substantially centered about the longitudinal centerline L (e.g., the APU 5200 is centered between the side plates 18). In some embodiments, the sides of the APU 5200 are coplanar with the outer surfaces of the side plates 18.

The APU mount 5204 may removably couple the APU 5200 to the frame assembly 12. As shown in FIGS. 169-173, the telehandler 10 includes two APU mounts 5204, one on each side of the central area 22 of the frame assembly 12. A first APU mount 5204 extends along an outer surface of one of the side plates 18 and across a first side surface of the housing 5202. A second APU mount 5204 extends along an outer surface of the other side plate 18 and across a second side surface of the housing 5202 opposite the first side surface. Each APU mount 5204 may include, for example, a plate that extends between the side plates 18 and the housing 5202 and a series of fasteners that extend through the plate and into either the housing 5202 or the frame assembly 12 to fixedly couple the housing 5202 to the frame assembly 12. In such an example, the fasteners may be removed to remove the APU 5200 from the telehandler 10.

A shield, frame, support structure, cage, or crash mitigation assembly, shown as cage 5260, extends around the APU 5200. The cage 5260 may protect the APU 5200 from a collision with an object behind the telehandler 10. As shown, the cage 5260 is fixedly coupled to the frame assembly 12 (e.g., through the APU mounts 5204). The cage 5260 extends along the left and right sides of the APU 5200 and behind the APU 5200. Accordingly, if the telehandler 10 collides with an object behind the telehandler 10 (e.g., the telehandler 10 backs into the object, the object rear ends the telehandler 10, etc.), the cage 5260 may absorb the impact and direct the impact forces around the APU 5200 and into the frame assembly 12. Accordingly, the cage 5260 may shield the APU 5200 in the event of a rear collision.

As shown in FIGS. 170-173, the telehandler 10 further includes a weight, block, or mass, shown as counterweight 5270, fixedly coupled to the frame assembly 12. The counterweight 5270 may have a relatively large mass that counteracts a load on the boom assembly 50 to maintain a center of gravity of the telehandler 10 in a stable position while lifting. As shown, the counterweight 5270 is coupled to the rear end 16 of the frame assembly 12 and extends lower than the APU 5200. The counterweight 5270 extends along the outer surfaces of the side plates 18 and below the side plates 18. The counterweight 5270 is substantially centered about the longitudinal centerline L (e.g., between the side plates 18).

As shown in FIGS. 172 and 173, a trailer attachment point, shown as hitch 5272, is fixedly coupled to the counterweight 5270. As shown, the hitch 5272 is offset below the APU 5200. The hitch 5272 is configured to receive a shear member, shown as hitch pin 5274, to couple a trailed implement (e.g., a trailer) to the frame assembly 12. To remove the hitch pin 5274 in preparation for connecting or disconnecting a trailed implement, the hitch pin 5274 may be raised upward until free of the hitch 5272. Accordingly, a vertical offset distance between the housing 5202 and the hitch 5272 may be greater than the length of the hitch pin 5274 to provide clearance for removing the hitch pin 5274.

Referring to FIGS. 170 and 173, the telehandler 10 has a ramp angle, shown as departure angle A. The departure angle A may represent the steepest angle that the telehandler 10 can descend to a level ground G without the rear of the telehandler 10 contacting (e.g., scraping on) the ground. As shown, due to the rearward projection of the APU 5200 beyond the frame assembly 12, the housing 5202 defines the departure angle A of the telehandler 10. When the APU 5200 is removed, the counterweight 5270 or the hitch 5272 may define the departure angle A. By raising the APU 5200 above the hitch 5272, the departure angle A may be maximized (e.g., to provide the most clearance). In some embodiments, the departure angle A is at least 30 degrees. In some embodiments, the departure angle A is at least 35 degrees. In some embodiments, the departure angle A is at least 40 degrees.

In other embodiments, the APU 5200 is positioned elsewhere on the telehandler 10. By way of example, FIG. 174 illustrates an embodiment in which the APU 5200 is positioned above the front right wheel 84. In other embodiments, the APU 5200 may be positioned above the front left wheel 84, above the rear right wheel 84, or above the rear left wheel 84. These alternative positions may suffer from certain disadvantages relative to the position of FIG. 169. By way of example, these other positions may limit access to components (e.g., the charger housing 44), limit visibility, or require additional support structure to connect to the frame assembly 12.

APU with Supplemental Battery

As shown in FIG. 175, the telehandler 10 may alternatively be configured for use with a range extender, power booster, supplemental energy source, removable energy source, backup energy source, or removable power unit, shown as APU 5300. The APU 5300 may be substantially similar to the APU 5200 except as otherwise specified. Additionally, the APU 5300 may perform similar functions to the APU 5200. Accordingly, any description of the APU 5200 may also apply to the APU 5300, except as otherwise specified.

The APU 5300 omits the generator 5212, the engine 5210, the fuel tank 5220, the starter motor 5222, the battery 5224, and the onboard charger 5240. Instead, the APU 5200 includes an energy storage device, shown as supplemental battery 5302, contained within a housing 5202. The supplemental battery 5302 may store energy (e.g., chemically) and supply the stored energy as electrical energy. The supplemental battery 5302 may have similar current and voltage outputs to the high-voltage battery 132. In some embodiments, the supplemental battery 5302 is a 25 kWh battery. The supplemental battery 5302 may be air-cooled.

Operation of the supplemental battery 5302 may be controlled by an APU controller 5230 of the APU 5300. The APU controller 5230 may control the current and voltage supplied by the supplemental battery 5302, whether the supplemental battery 5302 is charging or discharging, and other aspects of operation of the supplemental battery 5302. In some embodiments, the APU 5300 includes a switch or disconnect, shown as contactor 5304, operatively coupled to the APU controller 5230. The contactor 5304 may close to connect the supplemental battery 5302 to the telehandler 10. Similarly, the contactor 5304 may open to isolate the supplemental battery 5302. The APU controller 5230 may open and close the contactor 5304 to control operation of the supplemental battery 5302.

As shown in FIG. 175, the APU 5300 includes a power connector 5236 and a data connector 5238 positioned along an exterior surface of the housing 5202. The power connector 5236 is electrically coupled to the supplemental battery 5302 and configured to transfer electrical energy between the supplemental battery 5302 and the telehandler 10. The data connector 5238 is configured to transfer data (e.g., commands, sensor data, etc.) between the controller 200 of the telehandler 10 and the APU controller 5230. As shown in FIG. 175, the APU controller 5230 is operatively coupled to the controller 200 through the data connector 5238. The APU 5300 may include one or more power outlets 5242 and/or may supply electrical energy to one or more power outlets 5242 onboard the telehandler 10.

As shown in FIG. 175, the supplemental battery 5302 is electrically coupled to the HVPDU 134 through the power connector 5236. The HVPDU 134 may control the flow of electrical energy to and from the supplemental battery 5302 (e.g., similar to controlling the flow of electrical energy to and from the high-voltage battery 132). In some embodiments, the supplemental battery 5302 is charged by the onboard chargers 152. In some embodiments, the supplemental battery 5302 is charged by an external power source 156 that connects directly to the supplemental battery 5302 (e.g., without passing energy through the telehandler 10).

During operation of the telehandler 10, the controller 200 and the APU controller 5230 cooperate to control the APU 5300 to enhance the operation of the telehandler 10. By way of example, the controller 200 may provide a request for the APU 5300 to supply electrical energy, and in response to such a request, the APU controller 5230 may control the supplemental battery 5302 to transfer stored energy from the supplemental battery 5302 to the telehandler 10. This electrical energy may then supplement or replace the electrical energy from the high-voltage battery 132. Additionally, this electrical energy may be used to charge the high-voltage battery 132.

When compared with the APU 5200, the APU 5300 may be less suited to operate continuously. By way of example, the APU 5200 may quickly be refueled after the fuel tank 5220 is depleted, requiring only a short period of downtime. In contrast, the APU 5300 may require an extended period of inactivity while the supplemental battery 5302 is recharged.

However, the APU 5300 may be more readily activated and deactivated than the APU 5200, and the APU 5300 does not require fuel to operate or produce any exhaust during operation. Each time the APU 5200 is activated, the starter motor 5222 is operated to start up the engine 5210. This starting process may introduce a delay between the activation command for the APU 5200 and when the APU 5200 begins supplying electrical energy. In order to eliminate this delay, the engine 5210 may be started prior to the demand for electrical energy. However, if the engine 5210 is started before electrical energy is needed, the engine 5210 will still consume fuel and produce exhaust, regardless of whether the energy from the generator 5212 is being consumed. Accordingly, the APU 5200 may be desirable for applications where the APU 5200 will be utilized for an extended period of time and applications with minimal fluctuations in demand for electrical energy.

In contrast, the APU 5300 may be activated and deactivated (e.g., the supplemental battery 5302 may start and stop supplying electrical energy) without any significant delay. Accordingly, the APU 5300 may more readily and quickly respond to changes in demand by the telehandler 10 for electrical energy than the APU 5200. Additionally, the APU 5300 may not drain the supplemental battery 5302 unless electrical energy is being consumed by the telehandler 10. Accordingly, the APU 5300 may be desirable for applications where the APU 5300 will experience frequent changes in demand for electrical energy.

Similar to the APU 5200, the controller 200 may command the APU 5300 to operate in various modes of operation. The APU 5300 may have similar modes of operation to the APU 5200 (e.g., a range extension mode, a boost mode, an accessory mode, a preconditioning mode, etc.). Any description of these modes with respect to the APU 5200 may apply to the corresponding modes of the APU 5300.

In some embodiments, the boost mode is modified based on which of the APU 5200 or the APU 5300 is used. The APU 5200 may enter the boost mode and remain in the boost mode for an extended period of time. By way of example, a user may manually enter and exit the boost mode. By way of another example, the controller 200 may automatically enter the boost mode in response to the power demand of the telehandler 10 exceeding the power output capabilities of the high-voltage battery 132, and the APU 5200 may remain in the boost mode for at least a predetermined period of time (e.g., 5 minutes). By operating in the boost mode for an extended period of time, the APU 5200 may avoid the delay and component wear caused by repeatedly stopping and starting the engine 5210. The APU 5300 may automatically enter the boost mode whenever the power demand of the telehandler 10 exceeds the power output capabilities of the high-voltage battery 132, and the APU 5300 may automatically exit the boost mode whenever the power demand again falls within the power output capabilities of the high-voltage battery 132. Because the APU 5300 can be rapidly activated and deactivated, the APU 5300 may automatically adjust to meet the power demands of the telehandler 10.

Referring to FIGS. 176-179, the APU 5300 is shown coupled to the telehandler 10, according to an exemplary embodiment. The arrangement of the APU 5300 may be similar to the arrangement of the APU 5200 on the telehandler 10. The APU 5300 has a similar arrangement relative to the frame assembly 12, the APU mounts 5204, the cage 5260, the counterweight 5270, the hitch 5272, and the hitch pin 5274 as the APU 5200. The APU 5300 has a similar impact on the departure angle A as the APU 5200. The APU 5300 may also be repositioned over the front left wheel 84, the front right wheel 84, the rear left wheel 84, or the rear right wheel 84.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the telehandler 10 as shown in the various exemplary embodiments is illustrative only. Additionally, any element disclosed in one embodiment may be incorporated or utilized with any other embodiment disclosed herein. For example, the implement 52 of the exemplary embodiment shown in at least FIG. 1 may be incorporated in the telehandler 10 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

1. A telehandler, comprising:
a chassis defining a first side area, a second side area, and a central area between the first side area and the second side area;
a boom assembly coupled to the chassis and configured to raise an implement relative to the chassis;
an axle assembly coupled to the chassis and including a tractive element;
an electric motor coupled to the chassis and positioned within the central area, the electric motor being configured to drive the axle assembly to propel the telehandler;
a cabin coupled to the chassis, positioned within the first side area, and configured to support an operator; and
a battery coupled to the chassis and positioned within the second side area, the battery being configured to supply electrical energy to the electric motor.

2. The telehandler of claim 1, wherein the chassis includes a first side panel laterally offset from a second side panel, wherein the first side panel defines the first side area, wherein the second side panel defines the second side area, and wherein the first side panel and the second side panel define the central area.

3. The telehandler of claim 2, wherein the boom assembly extends between the first side panel and the second side panel.

4. The telehandler of claim 3, further comprising:
a hydraulic cylinder configured to control the boom assembly to reposition the implement relative to the chassis; and
a pump configured to supply pressurized hydraulic fluid to the hydraulic cylinder, wherein the pump is positioned within the second side area.

5. The telehandler of claim 4, wherein the electric motor is a first electric motor, further comprising a second electric motor positioned within the second side area and configured to drive the pump.

6. The telehandler of claim 5, further comprising a reservoir coupled to the chassis and fluidly coupled to the pump, wherein the reservoir is positioned within the central area.

7. The telehandler of claim 6, wherein the reservoir is positioned rearward of the first electric motor.

8. The telehandler of claim 7, further comprising a charger configured to receive external electrical energy from an external energy source and charge the battery, wherein the charger is positioned within the first side area.

9. The telehandler of claim 8, further comprising a power distribution unit electrically coupled to the battery, the charger, the first electric motor, and the second electric motor and positioned within the second side area.

10. The telehandler of claim 9, wherein the battery is a high-voltage battery configured to supply electrical energy at a first voltage, further comprising a low-voltage battery configured to supply electrical energy at a second voltage lower than the first voltage, and wherein the low-voltage battery is positioned within the second side area.

11. The telehandler of claim 10, further comprising a battery housing coupled to the second side panel and containing the high-voltage battery, the low-voltage battery, the pump, the second electric motor, and the power distribution unit.

12. The telehandler of claim 1, wherein the tractive element is a first tractive element positioned within the first side area, and wherein the axle assembly further includes a second tractive element positioned within the second side area.

13. A telehandler, comprising:
a chassis including a pair of side plates defining a first side area, a second side area, and a central area between the first side area and the second side area;
a tractive element rotatably coupled to the chassis;
a boom assembly coupled to the chassis and positioned within the central area;
a cabin coupled to the chassis, positioned within the first side area, and configured to support an operator;
a battery coupled to the chassis; and
a charging port configured to receive electrical energy and supply the received electrical energy to the battery, wherein the charging port is positioned within the first side area.

14. The telehandler of claim 13, wherein the battery is positioned within the second side area.

15. The telehandler of claim 13, wherein the charging port is positioned between the cabin and a rear end of the chassis.

16. The telehandler of claim 15, wherein the tractive element is a rear wheel positioned within the first side area, further comprising a front wheel rotatably coupled to the chassis and positioned within the first side area, wherein the cabin is positioned between the front wheel and the rear wheel, and wherein the charging port is positioned above the rear wheel.

17. The telehandler of claim 16, wherein a height of the charging port relative to a ground surface is between 36.1 inches and 43.9 inches.

18. The telehandler of claim 17, wherein the height of the charging port relative to the ground surface is approximately 40 inches.

19. The telehandler of claim 13, wherein the charging port faces laterally outward and away from the side plates.

20. A vehicle, comprising:
a chassis including a side plate;
a lift assembly configured to raise an implement relative to the chassis, wherein the lift assembly is positioned on a first side of the side plate;
an axle assembly coupled to the chassis and including a tractive element;
a cabin coupled to the chassis and configured to support an operator;
a battery coupled to the chassis; and
a charging port configured to receive electrical energy and supply the received electrical energy to the battery,
wherein the cabin and the charging port are positioned on a second side of the side plate.

21-441. (canceled)
